(19) United States
(12) Patent Application Publication
(10) Pub. No.: US 2026/0359759 A1
(43) Pub. Date: Nov. 12, 2026

(54) SOFTWARE DEFINED VEHICLE AND AI-CONVERGENCE SYSTEM OF SYSTEMS

(71) Applicant: Strong Force TP Portfolio 2022, LLC, Fort Lauderdale, FL (US)

(72) Inventors: Charles Howard Cella, Pembroke, MA (US); Brent Bliven, Austin, TX (US); Andrew Bunin, Lakewood Ranch, FL (US); Andrew Cardno, San Diego, CA (US); Anthony Cascio, Lutz, FL (US); Taylor Charon, Troy, MI (US); Joshua Dobrowitsky, Birmingham, MI (US); Teymour S. El-Tahry, Denver, CO (US); Andrew S. Locke, Farmington, MI (US); Jenna Parenti, Denver, CO (US); Richard A. Spitz, Franklin, TN (US); David Stein, Fairfax, VA (US); Eric P. Vetter, Cary, NC (US)

(21) Appl. No.: 19/277,180

(22) Filed: Jul. 22, 2025

Related U.S. Application Data
(63) Continuation of application No. PCT/US25/12973, filed on Jan. 24, 2025.
(60) Provisional application No. 63/625,609, filed on Jan. 26, 2024.
(60) Provisional application No. 63/638,591, filed on Apr. 25, 2024.
(60) Provisional application No. 63/639,912, filed on Apr. 29, 2024.

(51) Int. Cl. G06Q 10/0633; G05B 13/02; G06Q 50/40

(52) U.S. Cl. CPC G06Q 10/06334; G05B 13/027; G06Q 50/40

(57) ABSTRACT

The present disclosure relates to transportation and related methods and systems including software-defined vehicles, vehicle operating states, an identity management system, an intelligent digital twin system that creates, manages, and provides digital twins for transportation systems using sensor and other data, and the integration of a transportation system with an AI convergence system of systems, providing a multi-layered system for intelligent automation and data-driven decision making across operational aspects of a transportation system.

### CROSS-REFERENCE TO RELATED APPLICATIONS

This application is a continuation of International Application No. PCT/US25/12973, filed 24 Jan. 2025, which claims the benefit of priority to the following U.S. patent applications: Ser. No. 63/625,609, filed 26 Jan. 2024; Ser. No. 63/638,591, filed 25 Apr. 2024; and Ser. No. 63/639,912, filed 29 Apr. 2024.

Each patent application referenced above is hereby incorporated by reference as if fully set forth herein in its entirety.

### TECHNICAL FIELD

The present disclosure relates to transportation and related methods and systems including the integration of a transportation system with an AI convergence system of systems, representing a multi-layered system for intelligent automation and data-driven decision making across operational aspects of a transportation system.

### BACKGROUND

Traditional enterprise operations in transportation often rely on separate, disconnected layers of technology infrastructure. Governance is largely manual, requiring significant human oversight to enforce policies, monitor compliance, and manage digital rights. Organizations struggle to maintain consistent oversight across different operational domains of a transportation system and often faced challenges in adapting to changing regulatory requirements.

Transportation systems typically operate with rigid, predefined offerings that lack the ability to dynamically adapt to user needs or environmental conditions. Such operations suffer from fragmented management of AI systems and technological resources. Organizations lack sufficient capabilities for AI system generation, training, verification, and deployment. The absence of coordinated operations modules means that AI systems were developed and deployed in isolation, without proper governance or optimization across the enterprise.

The lack of intelligent integration between different technological layers of a transportation system creates significant inefficiencies in operations. This fragmented approach limits the ability to leverage emerging technologies effectively and restricts the potential for innovation in transportation services delivery. These limitations in traditional transportation systems create a clear need for a more integrated, intelligent approach to technology infrastructure.

### SUMMARY

In some aspects, the techniques described herein relate to a computer-implemented system, the system including: an AI convergence system of systems.

In some aspects, the techniques described herein relate to a computer-implemented method, the method including: managing AI convergence system of systems.

In some aspects, the techniques described herein relate to an AI convergence system of systems substantially as shown and described.

In some aspects, the techniques described herein relate to a method for providing AI convergence system of systems substantially as shown and described.

In some aspects, the techniques described herein relate to a transportation AI convergence system of systems for optimizing powertrain performance, including: a vehicle having a continuously variable powertrain; a hybrid neural network configured to optimize an operating state of the continuously variable powertrain, wherein: a first portion of the hybrid neural network is configured to classify a state of the vehicle; and a second portion of the hybrid neural network is configured to optimize at least one operating parameter of a transmission portion of the continuously variable powertrain based on the classified state of the vehicle.

In some aspects, the techniques described herein relate to a system, wherein the first portion of the hybrid neural network is configured to classify at least one of: a vehicle maintenance state, a vehicle health state, a vehicle operating state, a vehicle energy utilization state, a vehicle charging state, a vehicle satisfaction state, a vehicle component state, a vehicle sub-system state, a vehicle powertrain system state, a vehicle braking system state, a vehicle clutch system state, or a vehicle lubrication system state.

In some aspects, the techniques described herein relate to a system, wherein at least one of the first portion or the second portion of the hybrid neural network includes a convolutional neural network.

In some aspects, the techniques described herein relate to a system, further including a sensor system configured to provide sensor data to the hybrid neural network, wherein the sensor data includes at least one of: LIDAR data, RADAR data, vision-based system data, or temperature sensing data.

In some aspects, the techniques described herein relate to a system, wherein the second portion of the hybrid neural network optimizes the at least one operating parameter in real-time responsive to the classified state of the vehicle.

In some aspects, the techniques described herein relate to a system, wherein the hybrid neural network includes a plurality of connected nodes that form a directed cycle facilitating bi-directional flow of data among the connected nodes.

In some aspects, the techniques described herein relate to a system, wherein the at least one operating parameter affects at least one of: a speed of the vehicle, an acceleration of the vehicle, or a deceleration of the vehicle.

In some aspects, the techniques described herein relate to a system, wherein the hybrid neural network is configured to predict a future state of the vehicle based on the classified state.

In some aspects, the techniques described herein relate to a system, wherein the first portion of the hybrid neural network includes a structure-adaptive network configured to adapt its structure responsive to operational results.

In some aspects, the techniques described herein relate to a system, further including a feedback loop configured to provide operational feedback to the hybrid neural network for refining the optimization of the operating parameter.

In some aspects, the techniques described herein relate to a system, wherein the hybrid neural network is configured to process social data from social media sources to classify the state of the vehicle.

In some aspects, the techniques described herein relate to a transportation system having an AI convergence system of systems including: a sensor system configured to detect an environmental condition; an artificial intelligence system configured to: receive sensor data from the sensor system; classify a plurality of operational states of a vehicle based on the sensor data; process an input descriptive of the vehicle and at least one detected condition associated with an occupant of the vehicle; and optimize at least one operating parameter of a powertrain based on the classified operational states and processed input.

In some aspects, the techniques described herein relate to a transportation AI convergence system of systems for transportation including: a vehicle having a powertrain system; a hybrid neural network configured to: classify a vehicle maintenance state, a vehicle health state, and a vehicle operating state; optimize powertrain operating parameters based on the classified states; and predict a future state of the vehicle based on the classified states and optimized operating parameters.

In some aspects, the techniques described herein relate to a system, wherein the hybrid neural network includes a convolutional neural network.

In some aspects, the techniques described herein relate to a system, wherein the hybrid neural network is configured to process sensor data from a plurality of vehicle-mounted sensors.

In some aspects, the techniques described herein relate to a system, wherein the hybrid neural network is configured to track conditions proximal to the vehicle using vehicle mounted sensors.

In some aspects, the techniques described herein relate to a system, wherein the hybrid neural network is configured to process data feeds from remote sensors contemporaneous to vehicle operation.

In some aspects, the techniques described herein relate to a system, wherein the hybrid neural network employs a workflow that involves decision-making and automated optimization.

In some aspects, the techniques described herein relate to a system, wherein the hybrid neural network is configured to optimize the powertrain operating parameters based on a correlation between vehicle operating state and rider emotional state.

In some aspects, the techniques described herein relate to a system, wherein the hybrid neural network is configured to optimize the powertrain operating parameters in real-time responsive to detected changes in vehicle state.

In some aspects, the techniques described herein relate to a system, wherein the hybrid neural network includes a plurality of connected nodes that form a directed cycle.

In some aspects, the techniques described herein relate to a system, wherein the hybrid neural network is configured to process social media data to classify the vehicle states.

In some aspects, the techniques described herein relate to a system, wherein the hybrid neural network is configured to optimize the powertrain operating parameters based on predicted traffic conditions.

In some aspects, the techniques described herein relate to a method for optimizing vehicle powertrain operation, including: executing a first network of a hybrid neural network to classify a plurality of operational states of a vehicle; executing a second network of the hybrid neural network to process inputs descriptive of the vehicle and at least one detected condition associated with an occupant; and optimizing at least one operating parameter of a continuously variable powertrain based on the classified operational states and processed inputs.

In some aspects, the techniques described herein relate to a method, wherein classifying the operational states includes processing sensor data from vehicle-mounted sensors.

In some aspects, the techniques described herein relate to a method, wherein at least one of the first network or second network includes a convolutional neural network.

In some aspects, the techniques described herein relate to a method, further including tracking conditions proximal to the vehicle using vehicle-mounted sensors.

In some aspects, the techniques described herein relate to a method, further including processing data feeds from remote sensors contemporaneous to vehicle operation.

In some aspects, the techniques described herein relate to a method, wherein optimizing the operating parameter includes applying deep learning to optimize a margin of vehicle operational safety.

In some aspects, the techniques described herein relate to a method, wherein optimizing the operating parameter includes processing feedback from controlling the vehicle through machine learning.

In some aspects, the techniques described herein relate to a method, further including adapting the optimization based on detected emotional states of the occupant.

In some aspects, the techniques described herein relate to a method, wherein optimizing includes adjusting at least one of: vehicle speed, acceleration, or deceleration.

In some aspects, the techniques described herein relate to a method, further including predicting future operational states based on the classified states.

In some aspects, the techniques described herein relate to a method, wherein classifying includes processing social media data related to vehicle operation.

In some aspects, the techniques described herein relate to AI convergence system of systems for transportation including: a sensor system configured to detect vehicle operating conditions; an artificial intelligence system configured to: process sensor data to identify a vehicle operational state; optimize a powertrain parameter based on the identified operational state; and implement structured variation in the powertrain parameter through machine learning feedback processing.

In some aspects, the techniques described herein relate to a system, wherein the artificial intelligence system includes a hybrid neural network.

In some aspects, the techniques described herein relate to a system, wherein the sensor system includes at least one of: LIDAR, RADAR, or vision-based sensors.

In some aspects, the techniques described herein relate to a system, wherein the artificial intelligence system is configured to process environmental data contemporaneous with vehicle operation.

In some aspects, the techniques described herein relate to a system, wherein the artificial intelligence system optimizes the powertrain parameter in real-time.

In some aspects, the techniques described herein relate to a system, wherein the artificial intelligence system implements the structured variation based on detected emotional states of vehicle occupants.

In some aspects, the techniques described herein relate to a system, wherein the artificial intelligence system includes a plurality of connected nodes forming a directed cycle.

In some aspects, the techniques described herein relate to a system, wherein the artificial intelligence system processes social media data to identify operational states.

In some aspects, the techniques described herein relate to a system, wherein the artificial intelligence system predicts future operational states.

In some aspects, the techniques described herein relate to a system, wherein the artificial intelligence system optimizes powertrain parameters based on weather conditions.

In some aspects, the techniques described herein relate to a system, wherein the artificial intelligence system adapts optimization based on traffic conditions.

In some aspects, the techniques described herein relate to AI convergence system of systems for optimizing vehicle performance including: a hybrid neural network including: a structure-adaptive network configured to adapt its structure responsive to an operational result; and an optimization network configured to optimize a powertrain operating parameter based on the adapted structure.

In some aspects, the techniques described herein relate to a system, wherein the hybrid neural network includes a convolutional neural network.

In some aspects, the techniques described herein relate to a system, wherein the structure-adaptive network processes sensor data from vehicle-mounted sensors.

In some aspects, the techniques described herein relate to a system, wherein the optimization network processes environmental data.

In some aspects, the techniques described herein relate to a system, wherein the hybrid neural network optimizes parameters in real-time.

In some aspects, the techniques described herein relate to a system, wherein the hybrid neural network adapts based on detected emotional states of vehicle occupants.

In some aspects, the techniques described herein relate to a system, wherein the hybrid neural network includes nodes forming a directed cycle.

In some aspects, the techniques described herein relate to a system, wherein the hybrid neural network processes social media data.

In some aspects, the techniques described herein relate to a system, wherein the hybrid neural network predicts future operational states.

In some aspects, the techniques described herein relate to a system, wherein the hybrid neural network optimizes based on weather conditions.

In some aspects, the techniques described herein relate to a system, wherein the hybrid neural network adapts based on traffic conditions.

In some aspects, the techniques described herein relate to a transportation AI convergence system of systems including: a sensor system configured to detect an environmental condition; an artificial intelligence system configured to: classify a weather or traffic condition based on sensor data; adjust a powertrain operating parameter based on the classified condition; and optimize the adjusted parameter through machine learning to maintain a safety margin.

In some aspects, the techniques described herein relate to a system, wherein the artificial intelligence system includes a hybrid neural network.

In some aspects, the techniques described herein relate to a system, wherein the sensor system includes vision-based sensors.

In some aspects, the techniques described herein relate to a system, wherein the artificial intelligence system processes real-time environmental data.

In some aspects, the techniques described herein relate to a system, wherein the artificial intelligence system optimizes parameters in real-time.

In some aspects, the techniques described herein relate to a system, wherein the artificial intelligence system adapts based on occupant emotional states.

In some aspects, the techniques described herein relate to a system, wherein the artificial intelligence system includes directed cycle nodes.

In some aspects, the techniques described herein relate to a system, wherein the artificial intelligence system processes social media data.

In some aspects, the techniques described herein relate to a system, wherein the artificial intelligence system predicts future conditions.

In some aspects, the techniques described herein relate to a system, wherein the artificial intelligence system maintains safety margins based on road conditions.

In some aspects, the techniques described herein relate to a system, wherein the artificial intelligence system adapts to changing traffic patterns.

In some aspects, the techniques described herein relate to a transportation AI convergence system of systems for vehicle operation including: a vehicle having a continuously variable powertrain; a hybrid neural network configured to: process social data from a social media source to classify a vehicle operational state; optimize a powertrain operating parameter based on the classified state from social data processing.

In some aspects, the techniques described herein relate to a system, wherein the hybrid neural network includes a convolutional neural network.

In some aspects, the techniques described herein relate to a system, wherein the hybrid neural network processes sensor data.

In some aspects, the techniques described herein relate to a system, wherein the hybrid neural network processes environmental data.

In some aspects, the techniques described herein relate to a system, wherein the hybrid neural network optimizes in real-time.

In some aspects, the techniques described herein relate to a system, wherein the hybrid neural network adapts to occupant states.

In some aspects, the techniques described herein relate to a system, wherein the hybrid neural network includes directed cycle nodes.

In some aspects, the techniques described herein relate to a system, wherein the hybrid neural network predicts future states.

In some aspects, the techniques described herein relate to a system, wherein the hybrid neural network optimizes for weather conditions.

In some aspects, the techniques described herein relate to a system, wherein the hybrid neural network adapts to traffic conditions.

In some aspects, the techniques described herein relate to a system, wherein the hybrid neural network maintains safety margins.

In some aspects, the techniques described herein relate to the method for optimizing vehicle powertrain operation including: receiving sensor data indicating a vehicle operating condition; processing the sensor data through a first neural network to classify a vehicle state; processing environmental data through a second neural network to identify an external condition; optimizing a powertrain operating parameter based on the classified state and identified condition.

In some aspects, the techniques described herein relate to a method, wherein at least one neural network is a convolutional network.

In some aspects, the techniques described herein relate to a method, further including processing social media data.

In some aspects, the techniques described herein relate to a method, wherein optimizing occurs in real-time.

In some aspects, the techniques described herein relate to a method, further including adapting to occupant emotional states.

In some aspects, the techniques described herein relate to a method, wherein the neural networks include directed cycle nodes.

In some aspects, the techniques described herein relate to a method, further including predicting future conditions.

In some aspects, the techniques described herein relate to a method, further including optimizing for weather conditions.

In some aspects, the techniques described herein relate to a method, further including adapting to traffic conditions.

In some aspects, the techniques described herein relate to a method, further including maintaining safety margins.

In some aspects, the techniques described herein relate to a method, further including processing feedback through machine learning.

In some aspects, the techniques described herein relate to a transportation AI convergence system of systems for transportation including: a hybrid neural network configured to: classify a vehicle operating state based on sensor data; predict a future operating condition based on the classified state; optimize a powertrain parameter based on the predicted condition; and adapt the optimized parameter through machine learning feedback.

In some aspects, the techniques described herein relate to a system, wherein the hybrid neural network includes a convolutional network.

In some aspects, the techniques described herein relate to a system, wherein the hybrid neural network processes social media data.

In some aspects, the techniques described herein relate to a system, wherein the hybrid neural network optimizes in real-time.

In some aspects, the techniques described herein relate to a system, wherein the hybrid neural network adapts to occupant states.

In some aspects, the techniques described herein relate to a system, wherein the hybrid neural network includes directed cycle nodes.

In some aspects, the techniques described herein relate to a system, wherein optimization maintains safety margins.

In some aspects, the techniques described herein relate to a system, wherein the hybrid neural network optimizes for weather.

In some aspects, the techniques described herein relate to a system, wherein the hybrid neural network adapts to traffic.

In some aspects, the techniques described herein relate to a system, wherein the hybrid neural network processes environmental data.

In some aspects, the techniques described herein relate to a system, wherein adaptation occurs through structured variation. AI convergence system of systems ecosystem to optimize a vehicle charging system.

In some aspects, the techniques described herein relate to a transportation AI convergence system of systems for optimizing vehicle charging operations, including: a network-enabled vehicle information ingestion port configured to gather operational state and energy consumption information from a plurality of network-enabled vehicles; a charging infrastructure control system including cloud-based computing and local charging infrastructure systems; an artificial intelligence system configured to: determine at least one charging plan parameter upon which a charging plan for the plurality of network-enabled vehicles is dependent; and optimize the charging plan based on the operational state and energy consumption information.

In some aspects, the techniques described herein relate to a system, wherein the operational state information includes battery charge states of the plurality of vehicles.

In some aspects, the techniques described herein relate to a system, wherein the charging infrastructure control system is configured to adapt charging rates based on accumulated vehicles at charging locations.

In some aspects, the techniques described herein relate to a system, wherein the artificial intelligence system includes a hybrid neural network.

In some aspects, the techniques described herein relate to a system, wherein the artificial intelligence system is configured to predict vehicle geolocations within geographic regions.

In some aspects, the techniques described herein relate to a system, wherein the artificial intelligence system is configured to automate negotiation of charging duration, quantity, and pricing.

In some aspects, the techniques described herein relate to a system, wherein the charging plan parameter impacts vehicle routing to charging infrastructure.

In some aspects, the techniques described herein relate to a system, wherein the artificial intelligence system optimizes electricity usage for vehicles and charging infrastructure.

In some aspects, the techniques described herein relate to a system, wherein the artificial intelligence system processes market value indicators for charging.

In some aspects, the techniques described herein relate to a system, wherein the artificial intelligence system processes available supply capacity data.

In some aspects, the techniques described herein relate to a system, wherein the artificial intelligence system processes recharge demand data.

In some aspects, the techniques described herein relate to a transportation AI convergence system of systems for transportation, including: a plurality of network-enabled vehicles; a cloud-based artificial intelligence system configured to: receive inputs relating to the plurality of vehicles; determine at least one parameter of a charging plan for the plurality of vehicles based on the inputs; and optimize charging infrastructure operations based on the determined parameter.

In some aspects, the techniques described herein relate to a system, wherein the inputs include route plans for the plurality of vehicles.

In some aspects, the techniques described herein relate to a system, wherein the inputs include indicators of charging value.

In some aspects, the techniques described herein relate to a system, wherein the inputs include predicted traffic conditions.

In some aspects, the techniques described herein relate to a system, wherein the artificial intelligence system includes a hybrid neural network.

In some aspects, the techniques described herein relate to a system, wherein the artificial intelligence system predicts near-term charging needs.

In some aspects, the techniques described herein relate to a system, wherein the artificial intelligence system optimizes charging time allocation.

In some aspects, the techniques described herein relate to a system, wherein the artificial intelligence system optimizes charging location selection.

In some aspects, the techniques described herein relate to a system, wherein the artificial intelligence system optimizes charging amounts.

In some aspects, the techniques described herein relate to a system, wherein the artificial intelligence system processes environmental data.

In some aspects, the techniques described herein relate to a system, wherein the artificial intelligence system processes marketplace factors.

In some aspects, the techniques described herein relate to a method for optimizing vehicle charging operations, including: receiving operational state information from a plurality of network-enabled vehicles; processing the operational state information through a first neural network to predict target energy renewal regions; processing infrastructure usage information through a second neural network to optimize charging infrastructure operations within the target energy renewal regions.

In some aspects, the techniques described herein relate to a transportation AI convergence system of systems including: a plurality of vehicles having charging systems; a hybrid neural network including: a first neural network configured to process vehicle route and stored energy state information to predict target energy renewal regions; and a second neural network configured to process vehicle energy renewal infrastructure usage and demand information to determine charging infrastructure operational parameters.

In some aspects, the techniques described herein relate to a system, wherein the hybrid neural network includes a convolutional neural network.

In some aspects, the techniques described herein relate to a system, wherein the hybrid neural network processes real-time vehicle data.

In some aspects, the techniques described herein relate to a system, wherein the hybrid neural network optimizes charging infrastructure allocation.

In some aspects, the techniques described herein relate to a system, wherein the hybrid neural network processes marketplace factors.

In some aspects, the techniques described herein relate to a system, wherein the hybrid neural network predicts vehicle locations.

In some aspects, the techniques described herein relate to a system, wherein the hybrid neural network optimizes charging rates.

In some aspects, the techniques described herein relate to a system, wherein the hybrid neural network processes environmental data.

In some aspects, the techniques described herein relate to a system, wherein the hybrid neural network optimizes energy efficiency.

In some aspects, the techniques described herein relate to a system, wherein the hybrid neural network processes traffic data.

In some aspects, the techniques described herein relate to a system, wherein the hybrid neural network adapts to charging demand.

In some aspects, the techniques described herein relate to a method for optimizing vehicle charging operations, including: receiving battery status information from a plurality of vehicles; determining at least one charging plan parameter based on the battery status information; optimizing anticipated battery usage of the plurality of vehicles based on the charging plan parameter; and adapting charging infrastructure operations based on the optimized anticipated battery usage.

In some aspects, the techniques described herein relate to a method, wherein determining the charging plan parameter includes processing route plans.

In some aspects, the techniques described herein relate to a method, wherein determining includes processing traffic predictions.

In some aspects, the techniques described herein relate to a method, wherein optimizing includes predicting charging needs.

In some aspects, the techniques described herein relate to a method, wherein adapting includes adjusting charging rates.

In some aspects, the techniques described herein relate to a method, wherein optimizing includes processing environmental data.

In some aspects, the techniques described herein relate to a method, wherein optimizing includes processing market data.

In some aspects, the techniques described herein relate to a method, wherein adapting includes coordinating multiple charging stations.

In some aspects, the techniques described herein relate to a method, wherein optimizing includes predicting vehicle locations.

In some aspects, the techniques described herein relate to a method, wherein adapting includes managing charging capacity.

In some aspects, the techniques described herein relate to a method, wherein optimizing includes processing feedback data.

In some aspects, the techniques described herein relate to a transportation AI convergence system of systems including: a vehicle charging infrastructure; an artificial intelligence system configured to: apply a vehicle recharging facility utilization optimization algorithm to vehicle-specific inputs; evaluate impacts of recharging plan parameters on the charging infrastructure; optimize energy usage based on the evaluation.

In some aspects, the techniques described herein relate to a system, wherein the artificial intelligence system processes operational status data.

In some aspects, the techniques described herein relate to a system, wherein the artificial intelligence system predicts charging needs.

In some aspects, the techniques described herein relate to a system, wherein the artificial intelligence system optimizes charging time.

In some aspects, the techniques described herein relate to a system, wherein the artificial intelligence system optimizes charging location.

In some aspects, the techniques described herein relate to a system, wherein the artificial intelligence system processes environmental data.

In some aspects, the techniques described herein relate to a system, wherein the artificial intelligence system processes market data.

In some aspects, the techniques described herein relate to a system, wherein the artificial intelligence system coordinates charging stations.

In some aspects, the techniques described herein relate to a system, wherein the artificial intelligence system predicts vehicle locations.

In some aspects, the techniques described herein relate to a system, wherein the artificial intelligence system manages capacity.

In some aspects, the techniques described herein relate to a system, wherein the artificial intelligence system processes feedback.

In some aspects, the techniques described herein relate to a transportation AI convergence system of systems for optimizing vehicle charging including: a charging infrastructure control system; an artificial intelligence system configured to: predict geolocation of vehicles within a geographic region; optimize charging infrastructure allocation based on predicted vehicle locations; and adapt charging operations based on the optimization.

In some aspects, the techniques described herein relate to a system, wherein predicting includes processing route data.

In some aspects, the techniques described herein relate to a system, wherein predicting includes processing traffic data.

In some aspects, the techniques described herein relate to a system, wherein optimizing includes processing demand data.

In some aspects, the techniques described herein relate to a system, wherein adapting includes adjusting charging rates.

In some aspects, the techniques described herein relate to a system, wherein optimizing includes processing environmental data.

In some aspects, the techniques described herein relate to a system, wherein optimizing includes processing market data.

In some aspects, the techniques described herein relate to a system, wherein adapting includes coordinating charging stations.

In some aspects, the techniques described herein relate to a system, wherein optimizing includes managing capacity.

In some aspects, the techniques described herein relate to a system, wherein adapting includes processing feedback.

In some aspects, the techniques described herein relate to a system, wherein predicting includes processing historical data.

In some aspects, the techniques described herein relate to a method for vehicle charging optimization including: receiving inputs relating to charging states of vehicles within a geolocation range; predicting geolocations of the vehicles; optimizing at least one charging plan parameter based on the predicted geolocations; and implementing automated negotiation of charging parameters based on the optimization.

In some aspects, the techniques described herein relate to a method, wherein receiving includes processing route data.

In some aspects, the techniques described herein relate to a method, wherein predicting includes processing traffic data.

In some aspects, the techniques described herein relate to a method, wherein optimizing includes processing demand data.

In some aspects, the techniques described herein relate to a method, wherein implementing includes adjusting charging rates.

In some aspects, the techniques described herein relate to a method, wherein optimizing includes processing environmental data.

In some aspects, the techniques described herein relate to a method, wherein optimizing includes processing market data.

In some aspects, the techniques described herein relate to a method, wherein implementing includes coordinating stations.

In some aspects, the techniques described herein relate to a method, wherein optimizing includes managing capacity.

In some aspects, the techniques described herein relate to a method, wherein implementing includes processing feedback.

In some aspects, the techniques described herein relate to a method, wherein predicting includes processing historical data.

In some aspects, the techniques described herein relate to a transportation AI convergence system of systems including: a charging infrastructure; a recharging plan update facility configured to: apply adjustment values to charging plan parameters; adjust the adjustment values based on feedback; and optimize charging operations based on adjusted values.

In some aspects, the techniques described herein relate to a system, wherein applying includes processing route data.

In some aspects, the techniques described herein relate to a system, wherein adjusting includes processing traffic data.

In some aspects, the techniques described herein relate to a system, wherein optimizing includes processing demand data.

In some aspects, the techniques described herein relate to a system, wherein optimizing includes adjusting charging rates.

In some aspects, the techniques described herein relate to a system, wherein optimizing includes processing environmental data.

In some aspects, the techniques described herein relate to a system, wherein optimizing includes processing market data.

In some aspects, the techniques described herein relate to a system, wherein optimizing includes coordinating stations.

In some aspects, the techniques described herein relate to a system, wherein optimizing includes managing capacity.

In some aspects, the techniques described herein relate to a system, wherein adjusting includes processing feedback.

In some aspects, the techniques described herein relate to a system, wherein optimizing includes processing historical data.

In some aspects, the techniques described herein relate to an AI convergence system of systems for transportation including: a charging infrastructure control system; an artificial intelligence system configured to: optimize electricity usage for vehicles and charging infrastructure; optimize charging infrastructure-specific recharging time, location, and amount; and adapt charging operations based on the optimizations.

In some aspects, the techniques described herein relate to a system, wherein optimizing includes processing route data.

In some aspects, the techniques described herein relate to a system, wherein optimizing includes processing traffic data.

In some aspects, the techniques described herein relate to a system, wherein optimizing includes processing demand data.

In some aspects, the techniques described herein relate to a system, wherein adapting includes adjusting charging rates.

In some aspects, the techniques described herein relate to a system, wherein optimizing includes processing environmental data.

In some aspects, the techniques described herein relate to a system, wherein optimizing includes processing market data.

In some aspects, the techniques described herein relate to a system, wherein adapting includes coordinating stations.

In some aspects, the techniques described herein relate to a system, wherein optimizing includes managing capacity.

In some aspects, the techniques described herein relate to a system, wherein adapting includes processing feedback.

In some aspects, the techniques described herein relate to a system, wherein optimizing includes processing historical data. AI convergence system of systems ecosystem to perform data analysis and modeling related to the routing and navigation characteristics of a software-defined vehicle.

In some aspects, the techniques described herein relate to a transportation AI convergence system of systems for analyzing vehicle routing, including: a data processing system configured to process data from multiple sources including social media data, weather data, road profile data, and traffic data; an artificial intelligence system configured to: analyze a transportation network using a machine learning algorithm; predict traffic conditions using graph neural networks; optimize a routing decision using reinforcement learning; and generate a routing parameter based on an analysis and prediction.

In some aspects, the techniques described herein relate to a system, wherein the artificial intelligence system implements clustering algorithms to segment data based on traffic patterns.

In some aspects, the techniques described herein relate to a system, wherein the artificial intelligence system implements time-series forecasting to predict future traffic conditions.

In some aspects, the techniques described herein relate to a system, wherein the data processing system is configured to extract, transform, and load data to enable queries.

In some aspects, the techniques described herein relate to a system, wherein the artificial intelligence system processes weather condition data to optimize routing.

In some aspects, the techniques described herein relate to a system, wherein the artificial intelligence system processes road profile data.

In some aspects, the techniques described herein relate to a system, wherein the artificial intelligence system implements cognitive engagement for routing behavior analysis.

In some aspects, the techniques described herein relate to a system, wherein the artificial intelligence system optimizes routes based on user satisfaction data.

In some aspects, the techniques described herein relate to a system, wherein an artificial intelligence system coordinates with infrastructure elements.

In some aspects, the techniques described herein relate to a system, wherein the artificial intelligence system implements digital twins for simulating traffic patterns.

In some aspects, the techniques described herein relate to a system, wherein the artificial intelligence system adapts routing based on real-time conditions.

In some aspects, the techniques described herein relate to the transportation system having an AI convergence system of systems including: a cognitive system configured to: facilitate negotiation among designated sets of vehicles; process inputs relating to value attributed by riders to route parameters; and optimize route selection based on multiple factors including traffic conditions and weather conditions.

In some aspects, the techniques described herein relate to a system, wherein the cognitive system implements game-based interfaces.

In some aspects, the techniques described herein relate to a system, wherein the cognitive system provides rewards for routing actions.

In some aspects, the techniques described herein relate to a system, wherein the cognitive system processes user preference data.

In some aspects, the techniques described herein relate to a system, wherein a cognitive system coordinates with traffic infrastructure.

In some aspects, the techniques described herein relate to a system, wherein the cognitive system analyzes congestion patterns.

In some aspects, the techniques described herein relate to a system, wherein the cognitive system optimizes fleet routing.

In some aspects, the techniques described herein relate to a system, wherein the cognitive system processes environmental data.

In some aspects, the techniques described herein relate to a system, wherein the cognitive system implements predictive modeling.

In some aspects, the techniques described herein relate to a system, wherein the cognitive system adapts to real-time conditions.

In some aspects, the techniques described herein relate to a system, wherein the cognitive system processes feedback data.

In some aspects, the techniques described herein relate to a method for analyzing vehicle routing, including: processing transportation network data using graph neural networks; implementing clustering algorithms to segment data based on traffic patterns; applying time-series forecasting to predict future traffic conditions; and optimizing routing decisions using reinforcement learning based on the predictions.

In some aspects, the techniques described herein relate to a method, wherein processing includes analyzing social media data.

In some aspects, the techniques described herein relate to a method, wherein processing includes analyzing weather data.

In some aspects, the techniques described herein relate to a method, wherein processing includes analyzing road profile data.

In some aspects, the techniques described herein relate to a method, wherein implementing includes analyzing congestion patterns.

In some aspects, the techniques described herein relate to a method, wherein applying includes predicting infrastructure utilization.

In some aspects, the techniques described herein relate to a method, wherein optimizing includes processing user preferences.

In some aspects, the techniques described herein relate to a method, wherein optimizing includes coordinating multiple vehicles.

In some aspects, the techniques described herein relate to a method, wherein optimizing includes processing environmental data.

In some aspects, the techniques described herein relate to a method, wherein optimizing includes analyzing real-time conditions.

In some aspects, the techniques described herein relate to a method, wherein optimizing includes processing feedback data.

In some aspects, the techniques described herein relate to a transportation AI convergence system of systems for transportation routing including: a digital twin system configured to: create virtual representations of traffic patterns; simulate vehicle movements in real-time; predict congestion points; and optimize routing based on simulations and predictions.

In some aspects, the techniques described herein relate to a system, wherein the digital twin system processes sensor data.

In some aspects, the techniques described herein relate to a system, wherein the digital twin system analyzes infrastructure utilization.

In some aspects, the techniques described herein relate to a system, wherein the digital twin system processes weather data.

In some aspects, the techniques described herein relate to a system, wherein the digital twin system coordinates multiple vehicles.

In some aspects, the techniques described herein relate to a system, wherein the digital twin system processes environmental data.

In some aspects, the techniques described herein relate to a system, wherein the digital twin system analyzes user preferences.

In some aspects, the techniques described herein relate to a system, wherein the digital twin system implements predictive modeling.

In some aspects, the techniques described herein relate to a system, wherein the digital twin system adapts to real-time conditions.

In some aspects, the techniques described herein relate to a system, wherein the digital twin system processes feedback data.

In some aspects, the techniques described herein relate to a system, wherein the digital twin system simulates future states.

In some aspects, the techniques described herein relate to a transportation AI convergence system of systems for analyzing vehicle routing including: an artificial intelligence system configured to: process graph data representing transportation networks; analyze traffic patterns using machine learning; optimize network efficiency through adaptive routing; and provide real-time routing suggestions based on an analysis.

In some aspects, the techniques described herein relate to an AI convergence system of systems for transportation routing including: an operations layer configured to: implement routing and control capabilities; monitor traffic patterns and resource utilization; optimize navigation based on real-time conditions; and coordinate with infrastructure elements for routing efficiency.

In some aspects, the techniques described herein relate to a system, wherein the operations layer processes sensor data.

In some aspects, the techniques described herein relate to a system, wherein the operations layer analyzes congestion patterns.

In some aspects, the techniques described herein relate to a system, wherein the operations layer processes weather data.

In some aspects, the techniques described herein relate to a system, wherein the operations layer coordinates multiple vehicles.

In some aspects, the techniques described herein relate to a system, wherein the operations layer processes environmental data.

In some aspects, the techniques described herein relate to a system, wherein the operations layer analyzes user preferences.

In some aspects, the techniques described herein relate to a system, wherein the operations layer implements predictive modeling.

In some aspects, the techniques described herein relate to a system, wherein the operations layer adapts to real-time conditions.

In some aspects, the techniques described herein relate to a system, wherein the operations layer processes feedback data.

In some aspects, the techniques described herein relate to a system, wherein the operations layer simulates future states.

In some aspects, the techniques described herein relate to a method for analyzing vehicle routing including: processing graph data representing transportation networks; implementing machine learning algorithms to analyze traffic patterns; predicting congestion using clustering algorithms; and optimizing routes based on predictions and real-time conditions.

In some aspects, the techniques described herein relate to a method, wherein processing includes analyzing sensor data.

In some aspects, the techniques described herein relate to a method, wherein implementing includes analyzing weather data.

In some aspects, the techniques described herein relate to a method, wherein predicting includes analyzing road conditions.

In some aspects, the techniques described herein relate to a method, wherein optimizing includes coordinating multiple vehicles.

In some aspects, the techniques described herein relate to a method, wherein processing includes analyzing environmental data.

In some aspects, the techniques described herein relate to a method, wherein implementing includes analyzing user preferences.

In some aspects, the techniques described herein relate to a method, wherein predicting includes using time-series forecasting.

In some aspects, the techniques described herein relate to a method, wherein optimizing includes real-time adaptation.

In some aspects, the techniques described herein relate to a method, wherein processing includes analyzing feedback data.

In some aspects, the techniques described herein relate to a method, wherein implementing includes simulating future states.

In some aspects, the techniques described herein relate to an AI convergence system of systems for transportation routing including: a data layer configured to: process sensor and operations data; analyze market and environmental data; implement context-aware sensor fusion; and optimize routing based on analyzed data.

In some aspects, the techniques described herein relate to a system, wherein the data layer processes traffic pattern data.

In some aspects, the techniques described herein relate to a system, wherein the data layer analyzes weather conditions.

In some aspects, the techniques described herein relate to a system, wherein the data layer processes infrastructure data.

In some aspects, the techniques described herein relate to a system, wherein the data layer coordinates multiple vehicles.

In some aspects, the techniques described herein relate to a system, wherein the data layer processes environmental factors.

In some aspects, the techniques described herein relate to a system, wherein the data layer analyzes user preferences.

In some aspects, the techniques described herein relate to a system, wherein the data layer implements predictive modeling.

In some aspects, the techniques described herein relate to a system, wherein the data layer adapts to real-time conditions.

In some aspects, the techniques described herein relate to a system, wherein the data layer processes feedback data.

In some aspects, the techniques described herein relate to a system, wherein the data layer simulates future states.

In some aspects, the techniques described herein relate to an AI convergence system of systems for transportation routing including: an artificial intelligence system configured to: analyze transportation network spatial structure; predict traffic conditions using neural networks; optimize routing using reinforcement learning; and adapt routes based on real-time conditions.

In some aspects, the techniques described herein relate to a system, wherein analyzing includes processing sensor data.

In some aspects, the techniques described herein relate to a system, wherein predicting includes analyzing weather data.

In some aspects, the techniques described herein relate to a system, wherein optimizing includes analyzing road conditions.

In some aspects, the techniques described herein relate to a system, wherein adapting includes coordinating multiple vehicles.

In some aspects, the techniques described herein relate to a system, wherein analyzing includes processing environmental data.

In some aspects, the techniques described herein relate to a system, wherein predicting includes analyzing user preferences.

In some aspects, the techniques described herein relate to a system, wherein optimizing includes time-series forecasting.

In some aspects, the techniques described herein relate to a system, wherein adapting includes real-time modification.

In some aspects, the techniques described herein relate to a system, wherein analyzing includes processing feedback data.

In some aspects, the techniques described herein relate to a system, wherein predicting includes simulating future states.

In some aspects, the techniques described herein relate to an AI convergence system of systems for transportation routing including: a hybrid neural network configured to: process transportation network graph data; analyze traffic patterns and congestion; predict future traffic conditions; and optimize routing based on predictions.

In some aspects, the techniques described herein relate to a system, wherein processing includes analyzing sensor data.

In some aspects, the techniques described herein relate to a system, wherein analyzing includes processing weather data.

In some aspects, the techniques described herein relate to a system, wherein predicting includes analyzing road conditions.

In some aspects, the techniques described herein relate to a system, wherein optimizing includes vehicle coordination.

In some aspects, the techniques described herein relate to a system, wherein processing includes environmental analysis.

In some aspects, the techniques described herein relate to a system, wherein analyzing includes user preference processing.

In some aspects, the techniques described herein relate to a system, wherein predicting uses time-series forecasting.

In some aspects, the techniques described herein relate to a system, wherein optimizing includes real-time adaptation.

In some aspects, the techniques described herein relate to a system, wherein processing includes feedback analysis.

In some aspects, the techniques described herein relate to a system, wherein analyzing includes future state simulation. AI convergence system of systems ecosystem to perform data analysis and modeling related to the characteristics of a software-defined vehicle.

In some aspects, the techniques described herein relate to an AI convergence system of systems for analyzing vehicle characteristics, including: a data processing system configured to process data from multiple sources including social media data, weather data, road profile data, traffic data, and sensor data; an artificial intelligence system configured to: analyze vehicle operational states using machine learning algorithms; predict vehicle performance using neural networks; and optimize vehicle parameters using reinforcement learning.

In some aspects, the techniques described herein relate to a system, wherein the artificial intelligence system implements hybrid neural networks to optimize distinct vehicle components.

In some aspects, the techniques described herein relate to a system, wherein the artificial intelligence system implements time-series forecasting to predict future vehicle states.

In some aspects, the techniques described herein relate to a system, wherein the data processing system is configured to extract, transform, and load data to enable queries.

In some aspects, the techniques described herein relate to a system, wherein the artificial intelligence system processes environmental condition data.

In some aspects, the techniques described herein relate to a system, wherein the artificial intelligence system processes vehicle diagnostic data.

In some aspects, the techniques described herein relate to a system, wherein the artificial intelligence system implements cognitive engagement for behavior analysis.

In some aspects, the techniques described herein relate to a system, wherein the artificial intelligence system optimizes based on user satisfaction data.

In some aspects, the techniques described herein relate to a system, wherein an artificial intelligence system coordinates with vehicle subsystems.

In some aspects, the techniques described herein relate to a system, wherein the artificial intelligence system implements digital twins for simulating vehicle operations.

In some aspects, the techniques described herein relate to a system, wherein the artificial intelligence system adapts based on real-time conditions.

In some aspects, the techniques described herein relate to a transportation system having an AI convergence system of systems including: a data layer configured to: implement context-aware sensor fusion; process sensor and energy operations data; analyze market and environmental data; and optimize vehicle operations based on analyzed data.

In some aspects, the techniques described herein relate to a system, wherein the data layer processes vehicle state data.

In some aspects, the techniques described herein relate to a system, wherein the data layer analyzes operational conditions.

In some aspects, the techniques described herein relate to a system, wherein the data layer processes performance metrics.

In some aspects, the techniques described herein relate to a system, wherein the data layer coordinates multiple vehicle systems.

In some aspects, the techniques described herein relate to a system, wherein the data layer analyzes usage patterns.

In some aspects, the techniques described herein relate to a system, wherein the data layer optimizes energy efficiency.

In some aspects, the techniques described herein relate to a system, wherein the data layer processes environmental data.

In some aspects, the techniques described herein relate to a system, wherein the data layer implements predictive modeling.

In some aspects, the techniques described herein relate to a system, wherein the data layer adapts to real-time conditions.

In some aspects, the techniques described herein relate to a system, wherein the data layer processes feedback data.

In some aspects, the techniques described herein relate to a method for analyzing vehicle characteristics, including: processing vehicle operational data using neural networks; implementing clustering algorithms to segment data based on usage patterns; applying time-series forecasting to predict future vehicle states; and optimizing vehicle parameters using reinforcement learning based on the predictions.

In some aspects, the techniques described herein relate to a method, wherein processing includes analyzing sensor data.

In some aspects, the techniques described herein relate to a method, wherein processing includes analyzing environmental data.

In some aspects, the techniques described herein relate to a method, wherein processing includes analyzing diagnostic data.

In some aspects, the techniques described herein relate to a method, wherein implementing includes analyzing usage patterns.

In some aspects, the techniques described herein relate to a method, wherein applying includes predicting maintenance needs.

In some aspects, the techniques described herein relate to a method, wherein optimizing includes processing user preferences.

In some aspects, the techniques described herein relate to a method, wherein optimizing includes coordinating vehicle systems.

In some aspects, the techniques described herein relate to a method, wherein optimizing includes processing environmental data.

In some aspects, the techniques described herein relate to a method, wherein optimizing includes analyzing real-time conditions.

In some aspects, the techniques described herein relate to a method, wherein optimizing includes processing feedback data.

In some aspects, the techniques described herein relate to an AI convergence system of systems for vehicle analysis including: a digital twin system configured to: create virtual representations of vehicle components; simulate vehicle operations in real-time; predict maintenance needs; and optimize performance based on simulations and predictions.

In some aspects, the techniques described herein relate to a system, wherein the digital twin system processes sensor data.

In some aspects, the techniques described herein relate to a system, wherein the digital twin system analyzes component wear.

In some aspects, the techniques described herein relate to a system, wherein the digital twin system processes environmental data.

In some aspects, the techniques described herein relate to a system, wherein the digital twin system coordinates multiple systems.

In some aspects, the techniques described herein relate to a system, wherein the digital twin system processes usage patterns.

In some aspects, the techniques described herein relate to a system, wherein the digital twin system analyzes user preferences.

In some aspects, the techniques described herein relate to a system, wherein the digital twin system implements predictive modeling.

In some aspects, the techniques described herein relate to a system, wherein the digital twin system adapts to real-time conditions.

In some aspects, the techniques described herein relate to a system, wherein the digital twin system processes feedback data.

In some aspects, the techniques described herein relate to a system, wherein the digital twin system simulates future states.

In some aspects, the techniques described herein relate to a transportation AI convergence system of systems for analyzing vehicle characteristics including: an artificial intelligence system configured to: process vehicle operational data; analyze performance patterns using machine learning; optimize efficiency through adaptive control; and provide real-time operational suggestions based on an analysis.

In some aspects, the techniques described herein relate to a system, wherein processing includes analyzing sensor data.

In some aspects, the techniques described herein relate to a system, wherein analyzing includes processing diagnostic data.

In some aspects, the techniques described herein relate to a system, wherein optimizing includes analyzing usage patterns.

In some aspects, the techniques described herein relate to a system, wherein providing includes coordinating vehicle systems.

In some aspects, the techniques described herein relate to a system, wherein processing includes environmental analysis.

In some aspects, the techniques described herein relate to a system, wherein analyzing includes user preference processing.

In some aspects, the techniques described herein relate to a system, wherein optimizing includes predictive modeling.

In some aspects, the techniques described herein relate to a system, wherein providing includes real-time adaptation.

In some aspects, the techniques described herein relate to a system, wherein processing includes feedback analysis.

In some aspects, the techniques described herein relate to a system, wherein analyzing includes future state simulation.

In some aspects, the techniques described herein relate to a transportation AI convergence system of systems for vehicle analysis including: an operations layer configured to: implement control and optimization capabilities; monitor performance patterns and resource utilization; optimize operations based on real-time conditions; and coordinate with vehicle subsystems for operational efficiency.

In some aspects, the techniques described herein relate to a system, wherein implementing includes processing sensor data.

In some aspects, the techniques described herein relate to a system, wherein monitoring includes analyzing usage patterns.

In some aspects, the techniques described herein relate to a system, wherein optimizing includes processing diagnostic data.

In some aspects, the techniques described herein relate to a system, wherein coordinating includes system integration.

In some aspects, the techniques described herein relate to a system, wherein implementing includes environmental analysis.

In some aspects, the techniques described herein relate to a system, wherein monitoring includes user preference processing.

In some aspects, the techniques described herein relate to a system, wherein optimizing includes predictive modeling.

In some aspects, the techniques described herein relate to a system, wherein coordinating includes real-time adaptation.

In some aspects, the techniques described herein relate to a system, wherein implementing includes feedback analysis.

In some aspects, the techniques described herein relate to a system, wherein monitoring includes future state simulation.

In some aspects, the techniques described herein relate to a method for analyzing vehicle characteristics including: processing operational data representing vehicle states; implementing machine learning algorithms to analyze performance patterns; predicting maintenance needs using clustering algorithms; and optimizing parameters based on predictions and real-time conditions.

In some aspects, the techniques described herein relate to a method, wherein processing includes analyzing sensor data.

In some aspects, the techniques described herein relate to a method, wherein implementing includes analyzing usage patterns.

In some aspects, the techniques described herein relate to a method, wherein predicting includes analyzing component wear.

In some aspects, the techniques described herein relate to a method, wherein optimizing includes system coordination.

In some aspects, the techniques described herein relate to a method, wherein processing includes environmental analysis.

In some aspects, the techniques described herein relate to a method, wherein implementing includes preference processing.

In some aspects, the techniques described herein relate to a method, wherein predicting includes time-series forecasting.

In some aspects, the techniques described herein relate to a method, wherein optimizing includes real-time adaptation.

In some aspects, the techniques described herein relate to a method, wherein processing includes feedback analysis.

In some aspects, the techniques described herein relate to a method, wherein implementing includes state simulation.

In some aspects, the techniques described herein relate to a transportation AI convergence system of systems for vehicle analysis including: a hybrid neural network configured to: process vehicle operational data; analyze performance patterns and efficiency; predict future operational states; and optimize parameters based on predictions.

In some aspects, the techniques described herein relate to a system, wherein processing includes sensor analysis.

In some aspects, the techniques described herein relate to a system, wherein analyzing includes usage pattern processing.

In some aspects, the techniques described herein relate to a system, wherein predicting includes maintenance forecasting.

In some aspects, the techniques described herein relate to a system, wherein optimizing includes system coordination.

In some aspects, the techniques described herein relate to a system, wherein processing includes environmental analysis.

In some aspects, the techniques described herein relate to a system, wherein analyzing includes preference processing.

In some aspects, the techniques described herein relate to a system, wherein predicting includes time-series forecasting.

In some aspects, the techniques described herein relate to a system, wherein optimizing includes real-time adaptation.

In some aspects, the techniques described herein relate to a system, wherein processing includes feedback analysis.

In some aspects, the techniques described herein relate to a system, wherein analyzing includes state simulation.

In some aspects, the techniques described herein relate to a transportation AI convergence system of systems for vehicle analysis including: an enterprise layer configured to: implement executive digital twins for vehicle operations; create vehicle digital twins for design and simulation; analyze fleet operations data; and optimize vehicle parameters based on analysis.

In some aspects, the techniques described herein relate to a system, wherein implementing includes sensor processing.

In some aspects, the techniques described herein relate to a system, wherein creating includes component modeling.

In some aspects, the techniques described herein relate to a system, wherein analyzing includes usage pattern processing.

In some aspects, the techniques described herein relate to a system, wherein optimizing includes system coordination.

In some aspects, the techniques described herein relate to a system, wherein implementing includes environmental analysis.

In some aspects, the techniques described herein relate to a system, wherein creating includes preference processing.

In some aspects, the techniques described herein relate to a system, wherein analyzing includes predictive modeling.

In some aspects, the techniques described herein relate to a system, wherein optimizing includes real-time adaptation.

In some aspects, the techniques described herein relate to a system, wherein implementing includes feedback analysis.

In some aspects, the techniques described herein relate to a system, wherein creating includes state simulation.

In some aspects, the techniques described herein relate to a transportation AI convergence system of systems for vehicle analysis including: an artificial intelligence system configured to: process feature vectors of vehicle operational data; determine operational states using pattern recognition; optimize vehicle parameters to improve operational states; and adapt parameters through machine learning feedback.

In some aspects, the techniques described herein relate to a system, wherein processing includes sensor analysis.

In some aspects, the techniques described herein relate to a system, wherein determining includes pattern processing.

In some aspects, the techniques described herein relate to a system, wherein optimizing includes efficiency analysis.

In some aspects, the techniques described herein relate to a system, wherein adapting includes system coordination.

In some aspects, the techniques described herein relate to a system, wherein processing includes environmental analysis.

In some aspects, the techniques described herein relate to a system, wherein determining includes preference processing.

In some aspects, the techniques described herein relate to a system, wherein optimizing includes predictive modeling.

In some aspects, the techniques described herein relate to a system, wherein adapting includes real-time modification.

In some aspects, the techniques described herein relate to a system, wherein processing includes feedback analysis.

In some aspects, the techniques described herein relate to a system, wherein determining includes state simulation. AI convergence system of systems ecosystem to perform simulations or predictions related to the characteristics of a software-defined vehicle or its usage.

In some aspects, the techniques described herein relate to a transportation AI convergence system of systems for simulating vehicle operations, including: a digital twin system configured to: create a digital replica of a vehicle; process substantially real-time sensor data to provide virtual representation of the vehicle; simulate possible future states of the vehicle; and predict vehicle behavior and performance under various conditions based on the simulations.

In some aspects, the techniques described herein relate to a system, wherein the digital twin system simulates physical elements and properties of the vehicle.

In some aspects, the techniques described herein relate to a system, wherein the digital twin system simulates vehicle dynamics throughout its lifecycle.

In some aspects, the techniques described herein relate to a system, wherein the digital twin system provides hypothetical simulations during vehicle design phases.

In some aspects, the techniques described herein relate to a system, wherein the digital twin system simulates high stress conditions.

In some aspects, the techniques described herein relate to a system, wherein the digital twin system simulates component wear scenarios.

In some aspects, the techniques described herein relate to a system, wherein the digital twin system simulates maximum throughput operation.

In some aspects, the techniques described herein relate to a system, wherein the digital twin system simulates planned improvements.

In some aspects, the techniques described herein relate to a system, wherein the digital twin system processes environmental data.

In some aspects, the techniques described herein relate to a system, wherein the digital twin system processes marketplace factors.

In some aspects, the techniques described herein relate to a system, wherein the digital twin system adapts to real-time conditions.

In some aspects, the techniques described herein relate to a transportation AI convergence system of systems for transportation analysis including: an artificial intelligence system configured to: train predictive models using vehicle-related data; process vehicle specifications, environmental data, sensor data, and operational information; generate predictions regarding remaining vehicle life; and optimize vehicle operations based on predictions.

In some aspects, the techniques described herein relate to a system, wherein the artificial intelligence system implements classification models.

In some aspects, the techniques described herein relate to a system, wherein the artificial intelligence system implements regression models.

In some aspects, the techniques described herein relate to a system, wherein the artificial intelligence system predicts failure within time windows.

In some aspects, the techniques described herein relate to a system, wherein the artificial intelligence system predicts remaining useful life.

In some aspects, the techniques described herein relate to a system, wherein the artificial intelligence system processes feedback data.

In some aspects, the techniques described herein relate to a system, wherein the artificial intelligence system updates models based on outcomes.

In some aspects, the techniques described herein relate to a system, wherein the artificial intelligence system processes environmental data.

In some aspects, the techniques described herein relate to a system, wherein the artificial intelligence system implements supervised learning.

In some aspects, the techniques described herein relate to a system, wherein the artificial intelligence system implements unsupervised learning.

In some aspects, the techniques described herein relate to a system, wherein the artificial intelligence system implements reinforcement learning.

In some aspects, the techniques described herein relate to a transportation AI convergence system of systems for vehicle simulation including: a machine learning model configured to: perform analytics related to vehicle data processing; create simulations of vehicle operations; analyze simulation results; and make predictions based on analyzed results.

In some aspects, the techniques described herein relate to a system, wherein the machine learning model processes sensor data.

In some aspects, the techniques described herein relate to a system, wherein the machine learning model processes event data.

In some aspects, the techniques described herein relate to a system, wherein the machine learning model processes state data.

In some aspects, the techniques described herein relate to a system, wherein the machine learning model implements neural networks.

In some aspects, the techniques described herein relate to a system, wherein the machine learning model implements decision trees.

In some aspects, the techniques described herein relate to a system, wherein the machine learning model implements support vector machines.

In some aspects, the techniques described herein relate to a system, wherein the machine learning model implements Bayesian networks.

In some aspects, the techniques described herein relate to a system, wherein the machine learning model implements genetic algorithms.

In some aspects, the techniques described herein relate to a system, wherein the machine learning model implements supervised learning.

In some aspects, the techniques described herein relate to a system, wherein the machine learning model implements reinforcement learning.

In some aspects, the techniques described herein relate to a transportation AI convergence system of systems for vehicle analysis including: an enterprise layer configured to: implement executive digital twins for vehicle fleet operations; create vehicle digital twins for design and simulation; predict fleet operational characteristics; and optimize fleet parameters based on predictions.

In some aspects, the techniques described herein relate to a system, wherein implementing includes processing sensor data.

In some aspects, the techniques described herein relate to a system, wherein creating includes component modeling.

In some aspects, the techniques described herein relate to a system, wherein predicting includes usage pattern analysis.

In some aspects, the techniques described herein relate to a system, wherein optimizing includes system coordination.

In some aspects, the techniques described herein relate to a system, wherein implementing includes environmental analysis.

In some aspects, the techniques described herein relate to a system, wherein creating includes preference processing.

In some aspects, the techniques described herein relate to a system, wherein predicting includes maintenance forecasting.

In some aspects, the techniques described herein relate to a system, wherein optimizing includes real-time adaptation.

In some aspects, the techniques described herein relate to a system, wherein implementing includes feedback analysis.

In some aspects, the techniques described herein relate to a system, wherein creating includes state simulation.

In some aspects, the techniques described herein relate to a transportation AI convergence system of systems for vehicle simulation including: a hybrid neural network configured to: process vehicle operational data; simulate vehicle performance patterns; predict future operational states; and optimize parameters based on predictions.

In some aspects, the techniques described herein relate to a system, wherein processing includes sensor analysis.

In some aspects, the techniques described herein relate to a system, wherein simulating includes usage pattern processing.

In some aspects, the techniques described herein relate to a system, wherein predicting includes maintenance forecasting.

In some aspects, the techniques described herein relate to a system, wherein optimizing includes system coordination.

In some aspects, the techniques described herein relate to a system, wherein processing includes environmental analysis.

In some aspects, the techniques described herein relate to a system, wherein simulating includes preference processing.

In some aspects, the techniques described herein relate to a system, wherein predicting includes time-series forecasting.

In some aspects, the techniques described herein relate to a system, wherein optimizing includes real-time adaptation.

In some aspects, the techniques described herein relate to a system, wherein processing includes feedback analysis.

In some aspects, the techniques described herein relate to a system, wherein simulating includes state simulation.

In some aspects, the techniques described herein relate to a method for vehicle simulation including: creating a digital replica of a vehicle; processing real-time sensor data for virtual representation; simulating future vehicle states; and optimizing vehicle parameters based on simulations.

In some aspects, the techniques described herein relate to a method, wherein creating includes component modeling.

In some aspects, the techniques described herein relate to a method, wherein processing includes environmental data analysis.

In some aspects, the techniques described herein relate to a method, wherein simulating includes stress testing.

In some aspects, the techniques described herein relate to a method, wherein optimizing includes system coordination.

In some aspects, the techniques described herein relate to a method, wherein creating includes physical property modeling.

In some aspects, the techniques described herein relate to a method, wherein processing includes operational data analysis.

In some aspects, the techniques described herein relate to a method, wherein simulating includes wear prediction.

In some aspects, the techniques described herein relate to a method, wherein optimizing includes real-time adaptation.

In some aspects, the techniques described herein relate to a method, wherein creating includes dynamic modeling.

In some aspects, the techniques described herein relate to a method, wherein processing includes feedback analysis.

In some aspects, the techniques described herein relate to a transportation AI convergence system of systems for vehicle prediction including: an artificial intelligence system configured to: analyze vehicle operational patterns; simulate vehicle performance scenarios; predict maintenance requirements; and optimize operational parameters based on predictions.

In some aspects, the techniques described herein relate to a system, wherein analyzing includes sensor processing.

In some aspects, the techniques described herein relate to a system, wherein simulating includes environmental modeling.

In some aspects, the techniques described herein relate to a system, wherein predicting includes component analysis.

In some aspects, the techniques described herein relate to a system, wherein optimizing includes system coordination.

In some aspects, the techniques described herein relate to a system, wherein analyzing includes usage pattern processing.

In some aspects, the techniques described herein relate to a system, wherein simulating includes stress testing.

In some aspects, the techniques described herein relate to a system, wherein predicting includes lifecycle analysis.

In some aspects, the techniques described herein relate to a system, wherein optimizing includes real-time adaptation.

In some aspects, the techniques described herein relate to a system, wherein analyzing includes feedback processing.

In some aspects, the techniques described herein relate to a system, wherein simulating includes state modeling.

In some aspects, the techniques described herein relate to a transportation AI convergence system of systems for vehicle analysis including: a data layer configured to: process sensor and operational data; simulate vehicle performance patterns; predict operational characteristics; and optimize parameters based on predictions.

In some aspects, the techniques described herein relate to a system, wherein processing includes environmental analysis.

In some aspects, the techniques described herein relate to a system, wherein simulating includes component modeling.

In some aspects, the techniques described herein relate to a system, wherein predicting includes maintenance forecasting.

In some aspects, the techniques described herein relate to a system, wherein optimizing includes system coordination.

In some aspects, the techniques described herein relate to a system, wherein processing includes usage pattern analysis.

In some aspects, the techniques described herein relate to a system, wherein simulating includes stress testing.

In some aspects, the techniques described herein relate to a system, wherein predicting includes lifecycle analysis.

In some aspects, the techniques described herein relate to a system, wherein optimizing includes real-time adaptation.

In some aspects, the techniques described herein relate to a system, wherein processing includes feedback analysis.

In some aspects, the techniques described herein relate to a system, wherein simulating includes state modeling.

In some aspects, the techniques described herein relate to a method for vehicle prediction including: processing vehicle operational data; creating simulation models of vehicle performance; predicting future operational states; and optimizing vehicle parameters based on predictions.

In some aspects, the techniques described herein relate to a method, wherein processing includes sensor analysis.

In some aspects, the techniques described herein relate to a method, wherein creating includes environmental modeling.

In some aspects, the techniques described herein relate to a method, wherein predicting includes maintenance forecasting.

In some aspects, the techniques described herein relate to a method, wherein optimizing includes system coordination.

In some aspects, the techniques described herein relate to a method, wherein processing includes usage pattern analysis.

In some aspects, the techniques described herein relate to a method, wherein creating includes stress testing.

In some aspects, the techniques described herein relate to a method, wherein predicting includes lifecycle analysis.

In some aspects, the techniques described herein relate to a method, wherein optimizing includes real-time adaptation.

In some aspects, the techniques described herein relate to a method, wherein processing includes feedback analysis.

In some aspects, the techniques described herein relate to a method, wherein creating includes state modeling.

In some aspects, the techniques described herein relate to a transportation AI convergence system of systems for vehicle simulation including: an operations layer configured to: process vehicle operational data; create performance simulations; predict future states; and optimize parameters based on predictions.

In some aspects, the techniques described herein relate to a system, wherein processing includes sensor analysis.

In some aspects, the techniques described herein relate to a system, wherein creating includes environmental modeling.

In some aspects, the techniques described herein relate to a system, wherein predicting includes maintenance forecasting.

In some aspects, the techniques described herein relate to a system, wherein optimizing includes system coordination.

In some aspects, the techniques described herein relate to a system, wherein processing includes usage pattern analysis.

In some aspects, the techniques described herein relate to a system, wherein creating includes stress testing.

In some aspects, the techniques described herein relate to a system, wherein predicting includes lifecycle analysis.

In some aspects, the techniques described herein relate to a system, wherein optimizing includes real-time adaptation.

In some aspects, the techniques described herein relate to a system, wherein processing includes feedback analysis.

In some aspects, the techniques described herein relate to a system, wherein creating includes state modeling. AI convergence system of systems ecosystem to alter user interface(s) characteristics for a driver of a software-defined vehicle.

In some aspects, the techniques described herein relate to a transportation AI convergence system of systems for optimizing vehicle user interfaces, including: a vehicle having a set of interfaces including steering systems, buttons, levers, touch screen interfaces, and audio interfaces; a sensor system configured to provide input to an expert system; an artificial intelligence system configured to: track vehicle operating states and user experience states; and modify interface characteristics based on current conditions and desired outcomes.

In some aspects, the techniques described herein relate to a system, wherein the set of interfaces includes a game interface.

In some aspects, the techniques described herein relate to a system, wherein the set of interfaces includes a navigation interface.

In some aspects, the techniques described herein relate to a system, wherein the set of interfaces includes an entertainment interface.

In some aspects, the techniques described herein relate to a system, wherein the set of interfaces includes a vehicle settings interface.

In some aspects, the techniques described herein relate to a system, wherein the set of interfaces includes a search interface.

In some aspects, the techniques described herein relate to a system, wherein the set of interfaces includes an ecommerce interface.

In some aspects, the techniques described herein relate to a system, wherein the artificial intelligence system processes voice patterns.

In some aspects, the techniques described herein relate to a system, wherein the artificial intelligence system processes facial expressions.

In some aspects, the techniques described herein relate to a system, wherein the artificial intelligence system processes physiological data.

In some aspects, the techniques described herein relate to a system, wherein the artificial intelligence system adapts interface characteristics based on emotional state.

In some aspects, the techniques described herein relate to a transportation AI convergence system of systems for transportation including: a vehicle having user interfaces; an offering layer implementing expert systems and generative AI configured to: provide location-based offering systems; integrate advertising and marketplace functions; and implement customer-facing vehicle digital twins.

In some aspects, the techniques described herein relate to a system, wherein the offering layer processes user profiles.

In some aspects, the techniques described herein relate to a system, wherein the offering layer analyzes user behavior.

In some aspects, the techniques described herein relate to a system, wherein the offering layer processes environmental data.

In some aspects, the techniques described herein relate to a system, wherein the offering layer adapts to user location.

In some aspects, the techniques described herein relate to a system, wherein the offering layer processes user requests.

In some aspects, the techniques described herein relate to a system, wherein the offering layer customizes content delivery.

In some aspects, the techniques described herein relate to a system, wherein the offering layer personalizes interfaces.

In some aspects, the techniques described herein relate to a system, wherein the offering layer adapts to user preferences.

In some aspects, the techniques described herein relate to a system, wherein the offering layer processes real-time data.

In some aspects, the techniques described herein relate to a system, wherein the offering layer implements feedback processing.

In some aspects, the techniques described herein relate to an AI convergence system of systems for vehicle interface optimization including: a cognitive system configured to: monitor driver interactions with vehicle controls; detect patterns indicating routine activities; generate cognitive challenges; and adapt interface characteristics based on detected patterns.

In some aspects, the techniques described herein relate to a system, wherein monitoring includes analyzing navigation system usage.

In some aspects, the techniques described herein relate to a system, wherein detecting includes analyzing spatial awareness.

In some aspects, the techniques described herein relate to a system, wherein generating includes memory recall challenges.

In some aspects, the techniques described herein relate to a system, wherein adapting includes modifying display characteristics.

In some aspects, the techniques described herein relate to a system, wherein monitoring includes analyzing voice patterns.

In some aspects, the techniques described herein relate to a system, wherein detecting includes analyzing facial expressions.

In some aspects, the techniques described herein relate to a system, wherein generating includes decision-making challenges.

In some aspects, the techniques described herein relate to a system, wherein adapting includes modifying audio feedback.

In some aspects, the techniques described herein relate to a system, wherein monitoring includes analyzing emotional states.

In some aspects, the techniques described herein relate to a system, wherein detecting includes analyzing user preferences.

In some aspects, the techniques described herein relate to an AI convergence system of systems for vehicle interface management including: an artificial intelligence system configured to: process feature vectors from facial images; determine driver emotional states; optimize interface parameters based on emotional states; and adapt information presentation to improve emotional states.

In some aspects, the techniques described herein relate to an AI convergence system of systems for vehicle interface adaptation including: a sensor system configured to detect driver state; an artificial intelligence system configured to: process voice patterns and physiological data; identify cognitive engagement levels; and modify interface characteristics to maintain optimal engagement.

In some aspects, the techniques described herein relate to a system, wherein processing includes analyzing speech patterns.

In some aspects, the techniques described herein relate to a system, wherein identifying includes analyzing facial expressions.

In some aspects, the techniques described herein relate to a system, wherein modifying includes adjusting display parameters.

In some aspects, the techniques described herein relate to a system, wherein processing includes analyzing emotional states.

In some aspects, the techniques described herein relate to a system, wherein identifying includes analyzing attention levels.

In some aspects, the techniques described herein relate to a system, wherein modifying includes adjusting audio feedback.

In some aspects, the techniques described herein relate to a system, wherein processing includes analyzing user preferences.

In some aspects, the techniques described herein relate to a system, wherein identifying includes analyzing stress levels.

In some aspects, the techniques described herein relate to a system, wherein modifying includes real-time adaptation.

In some aspects, the techniques described herein relate to a system, wherein processing includes feedback analysis.

In some aspects, the techniques described herein relate to an AI convergence system of systems for vehicle interface optimization including: a multiplatform attention management system configured to: monitor driver attention patterns; analyze cognitive load levels; adapt interface presentations; and optimize information delivery based on attention patterns.

In some aspects, the techniques described herein relate to a system, wherein monitoring includes analyzing eye movements.

In some aspects, the techniques described herein relate to a system, wherein analyzing includes processing voice patterns.

In some aspects, the techniques described herein relate to a system, wherein adapting includes modifying display characteristics.

In some aspects, the techniques described herein relate to a system, wherein optimizing includes adjusting content timing.

In some aspects, the techniques described herein relate to a system, wherein monitoring includes analyzing facial expressions.

In some aspects, the techniques described herein relate to a system, wherein analyzing includes processing emotional states.

In some aspects, the techniques described herein relate to a system, wherein adapting includes modifying audio feedback.

In some aspects, the techniques described herein relate to a system, wherein optimizing includes content prioritization.

In some aspects, the techniques described herein relate to a system, wherein monitoring includes stress level analysis.

In some aspects, the techniques described herein relate to a system, wherein analyzing includes preference processing.

In some aspects, the techniques described herein relate to a method for vehicle interface adaptation including: monitoring driver interactions with vehicle controls; analyzing cognitive engagement patterns; generating interface modifications; and implementing adaptive changes based on engagement patterns.

In some aspects, the techniques described herein relate to a method, wherein monitoring includes analyzing voice patterns.

In some aspects, the techniques described herein relate to a method, wherein analyzing includes processing facial expressions.

In some aspects, the techniques described herein relate to a method, wherein generating includes display modifications.

In some aspects, the techniques described herein relate to a method, wherein implementing includes audio adjustments.

In some aspects, the techniques described herein relate to a method, wherein monitoring includes emotional state analysis.

In some aspects, the techniques described herein relate to a method, wherein analyzing includes attention level processing.

In some aspects, the techniques described herein relate to a method, wherein generating includes content adaptation.

In some aspects, the techniques described herein relate to a method, wherein implementing includes real-time changes.

In some aspects, the techniques described herein relate to a method, wherein monitoring includes stress level analysis.

In some aspects, the techniques described herein relate to a method, wherein analyzing includes preference processing.

In some aspects, the techniques described herein relate to an AI convergence system of systems for vehicle interface management including: an artificial intelligence system configured to: process driver behavior patterns; analyze cognitive stimulation needs; generate interface modifications; and implement adaptive changes based on analyzed needs.

In some aspects, the techniques described herein relate to a system, wherein processing includes voice analysis.

In some aspects, the techniques described herein relate to a system, wherein analyzing includes facial expression processing.

In some aspects, the techniques described herein relate to a system, wherein generating includes display adaptations.

In some aspects, the techniques described herein relate to a system, wherein implementing includes audio modifications.

In some aspects, the techniques described herein relate to a system, wherein processing includes emotional state analysis.

In some aspects, the techniques described herein relate to a system, wherein analyzing includes attention level processing.

In some aspects, the techniques described herein relate to a system, wherein generating includes content optimization.

In some aspects, the techniques described herein relate to a system, wherein implementing includes real-time adaptation.

In some aspects, the techniques described herein relate to a system, wherein processing includes stress level analysis.

In some aspects, the techniques described herein relate to a system, wherein analyzing includes preference processing.

In some aspects, the techniques described herein relate to an AI convergence system of systems for vehicle interface optimization including: a transaction layer configured to: implement user profiling and targeting; configure smart contracts for in-vehicle offers; automate transaction orchestration; and adapt interfaces based on user profiles.

In some aspects, the techniques described herein relate to a system, wherein implementing includes behavior analysis.

In some aspects, the techniques described herein relate to a system, wherein configuring includes preference processing.

In some aspects, the techniques described herein relate to a system, wherein automating includes content adaptation.

In some aspects, the techniques described herein relate to a system, wherein adapting includes display modifications.

In some aspects, the techniques described herein relate to a system, wherein implementing includes emotional state analysis.

In some aspects, the techniques described herein relate to a system, wherein configuring includes attention level processing.

In some aspects, the techniques described herein relate to a system, wherein automating includes interface optimization.

In some aspects, the techniques described herein relate to a system, wherein adapting includes real-time changes.

In some aspects, the techniques described herein relate to a system, wherein implementing includes stress level analysis.

In some aspects, the techniques described herein relate to a system, wherein configuring includes feedback processing.

In some aspects, the techniques described herein relate to an AI convergence system of systems for vehicle interface adaptation including: an operations layer configured to: monitor rider satisfaction; analyze interface effectiveness; generate interface modifications; and implement adaptive changes based on satisfaction analysis.

In some aspects, the techniques described herein relate to a system, wherein monitoring includes voice analysis.

In some aspects, the techniques described herein relate to a system, wherein analyzing includes facial expression processing.

In some aspects, the techniques described herein relate to a system, wherein generating includes display adaptations.

In some aspects, the techniques described herein relate to a system, wherein implementing includes audio modifications.

In some aspects, the techniques described herein relate to a system, wherein monitoring includes emotional state analysis.

In some aspects, the techniques described herein relate to a system, wherein analyzing includes attention level processing.

In some aspects, the techniques described herein relate to a system, wherein generating includes content optimization.

In some aspects, the techniques described herein relate to a system, wherein implementing includes real-time adaptation.

In some aspects, the techniques described herein relate to a system, wherein monitoring includes stress level analysis.

In some aspects, the techniques described herein relate to a system, wherein analyzing includes preference processing. AI convergence system of systems ecosystem to alter a vehicle's interior or in-cabin characteristics.

In some aspects, the techniques described herein relate to an AI convergence system of systems for optimizing vehicle interior conditions, including: a vehicle having a set of interior systems including at least one of a seat, climate control system, or audio system; a sensor system configured to detect rider emotional states; an artificial intelligence system configured to: process physiological monitoring data from the rider; and optimize interior parameters based on the detected emotional states and physiological data.

In some aspects, the techniques described herein relate to a system, wherein the interior systems include seat positioning control.

In some aspects, the techniques described herein relate to a system, wherein the interior systems include lumbar support adjustment.

In some aspects, the techniques described herein relate to a system, wherein the interior systems include leg room adjustment.

In some aspects, the techniques described herein relate to a system, wherein the interior systems include seatback angle control.

In some aspects, the techniques described herein relate to a system, wherein the interior systems include ventilation control.

In some aspects, the techniques described herein relate to a system, wherein the interior systems include window control.

In some aspects, the techniques described herein relate to a system, wherein the interior systems include moonroof control.

In some aspects, the techniques described herein relate to a system, wherein the interior systems include temperature control.

In some aspects, the techniques described herein relate to a system, wherein the interior systems include humidity control.

In some aspects, the techniques described herein relate to a system, wherein the interior systems include fan speed control.

In some aspects, the techniques described herein relate to an AI convergence system of systems for transportation including: a vehicle having interior environment controls; a physiological sensing system configured to monitor rider state; an artificial intelligence system configured to: detect changes in rider emotional state; and adjust interior environmental parameters to improve rider emotional state.

In some aspects, the techniques described herein relate to a system, wherein detecting includes processing vision system data.

In some aspects, the techniques described herein relate to a system, wherein detecting includes processing seat sensor data.

In some aspects, the techniques described herein relate to a system, wherein detecting includes processing steering wheel sensor data.

In some aspects, the techniques described herein relate to a system, wherein adjusting includes modifying audio content.

In some aspects, the techniques described herein relate to a system, wherein adjusting includes modifying climate settings.

In some aspects, the techniques described herein relate to a system, wherein adjusting includes modifying seat position.

In some aspects, the techniques described herein relate to a system, wherein detecting includes processing voice data.

In some aspects, the techniques described herein relate to a system, wherein detecting includes processing facial expressions.

In some aspects, the techniques described herein relate to a system, wherein adjusting includes modifying lighting conditions.

In some aspects, the techniques described herein relate to a system, wherein adjusting includes modifying ventilation settings.

In some aspects, the techniques described herein relate to an AI convergence system of systems for vehicle interior optimization including: a sensor system configured to detect rider state; an artificial intelligence system configured to: process physiological parameters; identify stress indicators; and modify cabin environment to reduce detected stress.

In some aspects, the techniques described herein relate to a system, wherein processing includes analyzing galvanic skin response.

In some aspects, the techniques described herein relate to a system, wherein processing includes analyzing cortisol levels.

In some aspects, the techniques described herein relate to a system, wherein identifying includes analyzing voice patterns.

In some aspects, the techniques described herein relate to a system, wherein modifying includes adjusting audio content.

In some aspects, the techniques described herein relate to a system, wherein modifying includes adjusting climate settings.

In some aspects, the techniques described herein relate to a system, wherein modifying includes adjusting seat position.

In some aspects, the techniques described herein relate to a system, wherein processing includes analyzing facial expressions.

In some aspects, the techniques described herein relate to a system, wherein identifying includes analyzing emotional states.

In some aspects, the techniques described herein relate to a system, wherein modifying includes adjusting lighting.

In some aspects, the techniques described herein relate to a system, wherein modifying includes adjusting ventilation.

In some aspects, the techniques described herein relate to an AI convergence system of systems for vehicle interior management including: a hybrid neural network configured to: process rider physiological data; analyze cabin environmental conditions; predict optimal interior settings; and implement adaptive changes based on predictions.

In some aspects, the techniques described herein relate to a system, wherein processing includes voice analysis.

In some aspects, the techniques described herein relate to a system, wherein analyzing includes temperature monitoring.

In some aspects, the techniques described herein relate to a system, wherein predicting includes comfort optimization.

In some aspects, the techniques described herein relate to a system, wherein implementing includes seat adjustment.

In some aspects, the techniques described herein relate to a system, wherein processing includes stress level analysis.

In some aspects, the techniques described herein relate to a system, wherein analyzing includes humidity monitoring.

In some aspects, the techniques described herein relate to a system, wherein predicting includes ventilation optimization.

In some aspects, the techniques described herein relate to a system, wherein implementing includes audio adjustment.

In some aspects, the techniques described herein relate to a system, wherein processing includes emotional state analysis.

In some aspects, the techniques described herein relate to a system, wherein analyzing includes lighting conditions.

In some aspects, the techniques described herein relate to a method for vehicle interior optimization including: monitoring rider physiological state; analyzing cabin environmental conditions; predicting optimal comfort settings; and implementing adaptive changes based on predictions.

In some aspects, the techniques described herein relate to a method, wherein monitoring includes voice analysis.

In some aspects, the techniques described herein relate to a method, wherein analyzing includes temperature monitoring.

In some aspects, the techniques described herein relate to a method, wherein predicting includes comfort optimization.

In some aspects, the techniques described herein relate to a method, wherein implementing includes seat adjustment.

In some aspects, the techniques described herein relate to a method, wherein monitoring includes stress level analysis.

In some aspects, the techniques described herein relate to a method, wherein analyzing includes humidity monitoring.

In some aspects, the techniques described herein relate to a method, wherein predicting includes ventilation optimization.

In some aspects, the techniques described herein relate to a method, wherein implementing includes audio adjustment.

In some aspects, the techniques described herein relate to a method, wherein monitoring includes emotional state analysis.

In some aspects, the techniques described herein relate to a method, wherein analyzing includes lighting conditions.

In some aspects, the techniques described herein relate to an AI convergence system of systems for vehicle interior adaptation including: a sensor system configured to monitor cabin conditions; an artificial intelligence system configured to: analyze rider comfort indicators; predict optimal environmental settings; and implement adaptive changes based on predictions.

In some aspects, the techniques described herein relate to a system, wherein analyzing includes temperature monitoring.

In some aspects, the techniques described herein relate to a system, wherein analyzing includes humidity monitoring.

In some aspects, the techniques described herein relate to a system, wherein predicting includes ventilation optimization.

In some aspects, the techniques described herein relate to a system, wherein implementing includes seat adjustment.

In some aspects, the techniques described herein relate to a system, wherein analyzing includes stress level monitoring.

In some aspects, the techniques described herein relate to a system, wherein analyzing includes emotional state monitoring.

In some aspects, the techniques described herein relate to a system, wherein predicting includes lighting optimization.

In some aspects, the techniques described herein relate to a system, wherein implementing includes audio adjustment.

In some aspects, the techniques described herein relate to a system, wherein analyzing includes voice pattern monitoring.

In some aspects, the techniques described herein relate to a system, wherein implementing includes climate control.

In some aspects, the techniques described herein relate to an AI convergence system of systems for vehicle interior optimization including: a digital twin system configured to: create virtual representations of cabin conditions; simulate environmental modifications; predict rider responses to modifications; and implement optimal environmental changes.

In some aspects, the techniques described herein relate to a system, wherein creating includes temperature modeling.

In some aspects, the techniques described herein relate to a system, wherein simulating includes humidity variations.

In some aspects, the techniques described herein relate to a system, wherein predicting includes comfort analysis.

In some aspects, the techniques described herein relate to a system, wherein implementing includes seat adjustment.

In some aspects, the techniques described herein relate to a system, wherein creating includes lighting modeling.

In some aspects, the techniques described herein relate to a system, wherein simulating includes ventilation changes.

In some aspects, the techniques described herein relate to a system, wherein predicting includes stress response.

In some aspects, the techniques described herein relate to a system, wherein implementing includes audio modification.

In some aspects, the techniques described herein relate to a system, wherein creating includes acoustic modeling.

In some aspects, the techniques described herein relate to a system, wherein simulating includes climate variations.

In some aspects, the techniques described herein relate to an AI convergence system of systems for vehicle interior management including: an operations layer configured to: monitor cabin environmental conditions; analyze rider comfort indicators; predict optimal settings; and implement adaptive changes.

In some aspects, the techniques described herein relate to a system, wherein monitoring includes temperature analysis.

In some aspects, the techniques described herein relate to a system, wherein analyzing includes humidity monitoring.

In some aspects, the techniques described herein relate to a system, wherein predicting includes ventilation optimization.

In some aspects, the techniques described herein relate to a system, wherein implementing includes seat adjustment.

In some aspects, the techniques described herein relate to a system, wherein monitoring includes stress level analysis.

In some aspects, the techniques described herein relate to a system, wherein analyzing includes emotional state monitoring.

In some aspects, the techniques described herein relate to a system, wherein predicting includes lighting optimization.

In some aspects, the techniques described herein relate to a system, wherein implementing includes audio adjustment.

In some aspects, the techniques described herein relate to a system, wherein monitoring includes voice pattern analysis.

In some aspects, the techniques described herein relate to a system, wherein implementing includes climate control.

In some aspects, the techniques described herein relate to an AI convergence system of systems for vehicle interior optimization including: a hybrid neural network configured to: process cabin environmental data; analyze rider physiological responses; predict optimal comfort settings; and implement adaptive changes.

In some aspects, the techniques described herein relate to a system, wherein processing includes temperature analysis.

In some aspects, the techniques described herein relate to a system, wherein analyzing includes humidity monitoring.

In some aspects, the techniques described herein relate to a system, wherein predicting includes ventilation optimization.

In some aspects, the techniques described herein relate to a system, wherein implementing includes seat adjustment.

In some aspects, the techniques described herein relate to a system, wherein processing includes stress level analysis.

In some aspects, the techniques described herein relate to a system, wherein analyzing includes emotional state monitoring.

In some aspects, the techniques described herein relate to a system, wherein predicting includes lighting optimization.

In some aspects, the techniques described herein relate to a system, wherein implementing includes audio adjustment.

In some aspects, the techniques described herein relate to a system, wherein processing includes voice pattern analysis.

In some aspects, the techniques described herein relate to a system, wherein implementing includes climate control.

In some aspects, the techniques described herein relate to an AI convergence system of systems for vehicle interior adaptation including: an artificial intelligence system configured to: monitor cabin environmental conditions; analyze rider comfort indicators; generate environmental modifications; and implement adaptive changes based on analysis.

In some aspects, the techniques described herein relate to a system, wherein monitoring includes temperature analysis.

In some aspects, the techniques described herein relate to a system, wherein analyzing includes humidity monitoring.

In some aspects, the techniques described herein relate to a system, wherein generating includes ventilation optimization.

In some aspects, the techniques described herein relate to a system, wherein implementing includes seat adjustment.

In some aspects, the techniques described herein relate to a system, wherein monitoring includes stress level analysis.

In some aspects, the techniques described herein relate to a system, wherein analyzing includes emotional state monitoring.

In some aspects, the techniques described herein relate to a system, wherein generating includes lighting optimization.

In some aspects, the techniques described herein relate to a system, wherein implementing includes audio adjustment.

In some aspects, the techniques described herein relate to a system, wherein monitoring includes voice pattern analysis.

In some aspects, the techniques described herein relate to a system, wherein implementing includes climate control. AI convergence system of systems ecosystem to alter a vehicle's performance or operating characteristics.

In some aspects, the techniques described herein relate to an AI convergence system of systems for optimizing vehicle performance, including: a set of sensors configured to provide input to an expert system; an artificial intelligence system configured to: track vehicle operating states including energy utilization state, maintenance state, and component state; optimize powertrain parameters based on the tracked states; and adapt vehicle performance characteristics in real-time.

In some aspects, the techniques described herein relate to a system, wherein the artificial intelligence system implements hybrid neural networks.

In some aspects, the techniques described herein relate to a system, wherein the artificial intelligence system processes environmental data.

In some aspects, the techniques described herein relate to a system, wherein the artificial intelligence system optimizes fuel usage.

In some aspects, the techniques described herein relate to a system, wherein the artificial intelligence system optimizes electricity usage.

In some aspects, the techniques described herein relate to a system, wherein the artificial intelligence system optimizes refueling timing.

In some aspects, the techniques described herein relate to a system, wherein the artificial intelligence system optimizes recharging timing.

In some aspects, the techniques described herein relate to a system, wherein the artificial intelligence system processes traffic predictions.

In some aspects, the techniques described herein relate to a system, wherein the artificial intelligence system processes transportation predictions.

In some aspects, the techniques described herein relate to a system, wherein the artificial intelligence system optimizes suspension profiles.

In some aspects, the techniques described herein relate to a system, wherein the artificial intelligence system processes road profile data.

In some aspects, the techniques described herein relate to an AI convergence system of systems for transportation including: a hybrid neural network configured to: classify vehicle states including maintenance state, health state, and operating state; optimize powertrain operating parameters based on the classified states; and predict future vehicle states based on the optimization.

In some aspects, the techniques described herein relate to a system, wherein the hybrid neural network processes sensor data.

In some aspects, the techniques described herein relate to a system, wherein the hybrid neural network analyzes vehicle range.

In some aspects, the techniques described herein relate to a system, wherein the hybrid neural network analyzes powertrain parameters.

In some aspects, the techniques described herein relate to a system, wherein the hybrid neural network analyzes current gear state.

In some aspects, the techniques described herein relate to a system, wherein the hybrid neural network analyzes speed parameters.

In some aspects, the techniques described herein relate to a system, wherein the hybrid neural network analyzes acceleration parameters.

In some aspects, the techniques described herein relate to a system, wherein the hybrid neural network analyzes suspension profiles.

In some aspects, the techniques described herein relate to a system, wherein the hybrid neural network analyzes charge state.

In some aspects, the techniques described herein relate to a system, wherein the hybrid neural network analyzes fuel state.

In some aspects, the techniques described herein relate to a system, wherein the hybrid neural network implements feedback processing.

In some aspects, the techniques described herein relate to an AI convergence system of systems for vehicle performance optimization including: a data processing system configured to process data from vehicle sensors; an artificial intelligence system configured to: analyze vehicle operational states; optimize drivetrain parameters based on operational states; and implement adaptive changes based on real-time conditions.

In some aspects, the techniques described herein relate to a system, wherein analyzing includes processing transmission data.

In some aspects, the techniques described herein relate to a system, wherein analyzing includes processing gear system data.

In some aspects, the techniques described herein relate to a system, wherein analyzing includes processing clutch system data.

In some aspects, the techniques described herein relate to a system, wherein analyzing includes processing braking system data.

In some aspects, the techniques described herein relate to a system, wherein analyzing includes processing fuel system data.

In some aspects, the techniques described herein relate to a system, wherein analyzing includes processing lubrication system data.

In some aspects, the techniques described herein relate to a system, wherein analyzing includes processing steering system data.

In some aspects, the techniques described herein relate to a system, wherein analyzing includes processing suspension system data.

In some aspects, the techniques described herein relate to a system, wherein analyzing includes processing lighting system data.

In some aspects, the techniques described herein relate to a system, wherein analyzing includes processing electrical system data.

In some aspects, the techniques described herein relate to an AI convergence system of systems for vehicle performance management including: a hybrid neural network configured to: process vehicle telemetry data; analyze component performance patterns; predict maintenance requirements; and optimize operational parameters based on predictions.

In some aspects, the techniques described herein relate to a system, wherein processing includes analyzing sensor data.

In some aspects, the techniques described herein relate to a system, wherein analyzing includes powertrain monitoring.

In some aspects, the techniques described herein relate to a system, wherein predicting includes component wear analysis.

In some aspects, the techniques described herein relate to a system, wherein optimizing includes transmission adjustment.

In some aspects, the techniques described herein relate to a system, wherein processing includes suspension analysis.

In some aspects, the techniques described herein relate to a system, wherein analyzing includes brake system monitoring.

In some aspects, the techniques described herein relate to a system, wherein predicting includes fuel efficiency optimization.

In some aspects, the techniques described herein relate to a system, wherein optimizing includes real-time adaptation.

In some aspects, the techniques described herein relate to a system, wherein processing includes environmental analysis.

In some aspects, the techniques described herein relate to a system, wherein analyzing includes performance feedback.

In some aspects, the techniques described herein relate to a method for vehicle performance optimization including: monitoring vehicle operational states; analyzing component performance patterns; predicting maintenance requirements; and implementing adaptive changes based on predictions.

In some aspects, the techniques described herein relate to a method, wherein monitoring includes sensor data analysis.

In some aspects, the techniques described herein relate to a method, wherein analyzing includes powertrain monitoring.

In some aspects, the techniques described herein relate to a method, wherein predicting includes component wear analysis.

In some aspects, the techniques described herein relate to a method, wherein implementing includes transmission adjustment.

In some aspects, the techniques described herein relate to a method, wherein monitoring includes suspension analysis.

In some aspects, the techniques described herein relate to a method, wherein analyzing includes brake system monitoring.

In some aspects, the techniques described herein relate to a method, wherein predicting includes fuel efficiency optimization.

In some aspects, the techniques described herein relate to a method, wherein implementing includes real-time adaptation.

In some aspects, the techniques described herein relate to a method, wherein monitoring includes environmental analysis.

In some aspects, the techniques described herein relate to a method, wherein analyzing includes performance feedback.

In some aspects, the techniques described herein relate to an AI convergence system of systems for vehicle performance optimization including: an operations layer configured to: implement control and optimization capabilities; monitor performance patterns and resource utilization; optimize operations based on real-time conditions; and coordinate with vehicle subsystems for operational efficiency.

In some aspects, the techniques described herein relate to a system, wherein implementing includes powertrain control.

In some aspects, the techniques described herein relate to a system, wherein monitoring includes transmission analysis.

In some aspects, the techniques described herein relate to a system, wherein optimizing includes suspension adjustment.

In some aspects, the techniques described herein relate to a system, wherein coordinating includes brake system control.

In some aspects, the techniques described herein relate to a system, wherein implementing includes fuel system optimization.

In some aspects, the techniques described herein relate to a system, wherein monitoring includes component wear analysis.

In some aspects, the techniques described herein relate to a system, wherein optimizing includes efficiency improvement.

In some aspects, the techniques described herein relate to a system, wherein coordinating includes real-time adaptation.

In some aspects, the techniques described herein relate to a system, wherein implementing includes environmental analysis.

In some aspects, the techniques described herein relate to a system, wherein monitoring includes performance feedback.

In some aspects, the techniques described herein relate to an AI convergence system of systems for vehicle performance management including: a digital twin system configured to: create virtual representations of vehicle components; simulate component operations in real-time; predict maintenance requirements; and optimize performance based on simulations.

In some aspects, the techniques described herein relate to a system, wherein creating includes powertrain modeling.

In some aspects, the techniques described herein relate to a system, wherein simulating includes transmission analysis.

In some aspects, the techniques described herein relate to a system, wherein predicting includes component wear analysis.

In some aspects, the techniques described herein relate to a system, wherein optimizing includes performance adjustment.

In some aspects, the techniques described herein relate to a system, wherein creating includes suspension modeling.

In some aspects, the techniques described herein relate to a system, wherein simulating includes brake system analysis.

In some aspects, the techniques described herein relate to a system, wherein predicting includes efficiency optimization.

In some aspects, the techniques described herein relate to a system, wherein optimizing includes real-time adaptation.

In some aspects, the techniques described herein relate to a system, wherein creating includes environmental modeling.

In some aspects, the techniques described herein relate to a system, wherein simulating includes performance feedback.

In some aspects, the techniques described herein relate to an AI convergence system of systems for vehicle performance optimization including: an artificial intelligence system configured to: process vehicle operational data; analyze performance patterns; predict maintenance requirements; and implement adaptive changes based on predictions.

In some aspects, the techniques described herein relate to a system, wherein processing includes sensor analysis.

In some aspects, the techniques described herein relate to a system, wherein analyzing includes powertrain monitoring.

In some aspects, the techniques described herein relate to a system, wherein predicting includes component wear analysis.

In some aspects, the techniques described herein relate to a system, wherein implementing includes transmission adjustment.

In some aspects, the techniques described herein relate to a system, wherein processing includes suspension analysis.

In some aspects, the techniques described herein relate to a system, wherein analyzing includes brake system monitoring.

In some aspects, the techniques described herein relate to a system, wherein predicting includes efficiency optimization.

In some aspects, the techniques described herein relate to a system, wherein implementing includes real-time adaptation.

In some aspects, the techniques described herein relate to a system, wherein processing includes environmental analysis.

In some aspects, the techniques described herein relate to a system, wherein analyzing includes performance feedback.

In some aspects, the techniques described herein relate to an AI convergence system of systems for vehicle performance management including: a hybrid neural network configured to: analyze vehicle operational patterns; optimize component performance; predict maintenance requirements; and implement adaptive changes.

In some aspects, the techniques described herein relate to a system, wherein analyzing includes sensor processing.

In some aspects, the techniques described herein relate to a system, wherein optimizing includes powertrain control.

In some aspects, the techniques described herein relate to a system, wherein predicting includes component analysis.

In some aspects, the techniques described herein relate to a system, wherein implementing includes transmission adjustment.

In some aspects, the techniques described herein relate to a system, wherein analyzing includes suspension monitoring.

In some aspects, the techniques described herein relate to a system, wherein optimizing includes brake system control.

In some aspects, the techniques described herein relate to a system, wherein predicting includes efficiency analysis.

In some aspects, the techniques described herein relate to a system, wherein implementing includes real-time adaptation.

In some aspects, the techniques described herein relate to a system, wherein analyzing includes environmental processing.

In some aspects, the techniques described herein relate to a system, wherein optimizing includes performance feedback.

In some aspects, the techniques described herein relate to an AI convergence system of systems for vehicle performance optimization including: an artificial intelligence system configured to: monitor vehicle operational states; analyze component performance; predict maintenance needs; and implement adaptive changes.

In some aspects, the techniques described herein relate to a system, wherein monitoring includes sensor analysis.

In some aspects, the techniques described herein relate to a system, wherein analyzing includes powertrain monitoring.

In some aspects, the techniques described herein relate to a system, wherein predicting includes wear analysis.

In some aspects, the techniques described herein relate to a system, wherein implementing includes transmission control.

In some aspects, the techniques described herein relate to a system, wherein monitoring includes suspension analysis.

In some aspects, the techniques described herein relate to a system, wherein analyzing includes brake system monitoring.

In some aspects, the techniques described herein relate to a system, wherein predicting includes efficiency optimization.

In some aspects, the techniques described herein relate to a system, wherein implementing includes real-time adaptation.

In some aspects, the techniques described herein relate to a system, wherein monitoring includes environmental analysis.

In some aspects, the techniques described herein relate to a system, wherein analyzing includes performance feedback. Using digital twins in an AI convergence system of systems

In some aspects, the techniques described herein relate to an AI convergence system of systems for transportation analysis including: a digital twin system configured to: create digital replicas of transportation entities; process real-time sensor data to provide virtual representations; simulate possible future states of the transportation entities; predict behavior and performance under various conditions; and optimize operations based on the simulations and predictions.

In some aspects, the techniques described herein relate to a system, wherein the digital twin system simulates physical elements and properties.

In some aspects, the techniques described herein relate to a system, wherein the digital twin system simulates dynamics throughout lifecycles.

In some aspects, the techniques described herein relate to a system, wherein the digital twin system provides hypothetical simulations.

In some aspects, the techniques described herein relate to a system, wherein the digital twin system processes environmental data.

In some aspects, the techniques described herein relate to a system, wherein the digital twin system processes marketplace data.

In some aspects, the techniques described herein relate to a system, wherein the digital twin system adapts to real-time conditions.

In some aspects, the techniques described herein relate to a system, wherein the digital twin system processes feedback data.

In some aspects, the techniques described herein relate to a system, wherein the digital twin system simulates high stress conditions.

In some aspects, the techniques described herein relate to a system, wherein the digital twin system simulates component wear.

In some aspects, the techniques described herein relate to a system, wherein the digital twin system simulates planned improvements.

In some aspects, the techniques described herein relate to an AI convergence system of systems for transportation including: a digital twin management system configured to: interface with an environment; provide bi-directional transfer of data between coupled components; identify and store states related to transportation systems; and update properties based on client applications.

In some aspects, the techniques described herein relate to a system, wherein the states include vehicle operating states.

In some aspects, the techniques described herein relate to a system, wherein the states include user experience states.

In some aspects, the techniques described herein relate to a system, wherein the states include maintenance states.

In some aspects, the techniques described herein relate to a system, wherein the states include energy utilization states.

In some aspects, the techniques described herein relate to a system, wherein the states include component states.

In some aspects, the techniques described herein relate to a system, wherein the states include vehicle health states.

In some aspects, the techniques described herein relate to a system, wherein the states include charging states.

In some aspects, the techniques described herein relate to a system, wherein the states include satisfaction states.

In some aspects, the techniques described herein relate to a system, wherein the states include subsystem states.

In some aspects, the techniques described herein relate to a system, wherein the states include powertrain states.

In some aspects, the techniques described herein relate to an AI convergence system of systems for transportation analysis including: an enterprise digital twin system configured to: create digital representations at various levels of abstraction; simulate operations from different points of view; process real-time operational data; and optimize system parameters based on simulations.

In some aspects, the techniques described herein relate to a system, wherein creating includes fleet operations modeling.

In some aspects, the techniques described herein relate to a system, wherein simulating includes maintenance operations.

In some aspects, the techniques described herein relate to a system, wherein processing includes performance data.

In some aspects, the techniques described herein relate to a system, wherein optimizing includes resource allocation.

In some aspects, the techniques described herein relate to a system, wherein creating includes infrastructure modeling.

In some aspects, the techniques described herein relate to a system, wherein simulating includes component operations.

In some aspects, the techniques described herein relate to a system, wherein processing includes environmental data.

In some aspects, the techniques described herein relate to a system, wherein optimizing includes efficiency parameters.

In some aspects, the techniques described herein relate to a system, wherein creating includes system integration modeling.

In some aspects, the techniques described herein relate to a system, wherein simulating includes future states.

In some aspects, the techniques described herein relate to an AI convergence system of systems for transportation including: a digital twin creation module configured to: create digital twins using imported data; process image scans of transportation systems; analyze 3D data from sensing devices; and generate 3D representations of environments.

In some aspects, the techniques described herein relate to a system, wherein creating includes blueprint processing.

In some aspects, the techniques described herein relate to a system, wherein processing includes LIDAR data analysis.

In some aspects, the techniques described herein relate to a system, wherein analyzing includes SLAM sensor data.

In some aspects, the techniques described herein relate to a system, wherein generating includes object classification.

In some aspects, the techniques described herein relate to a system, wherein creating includes specification processing.

In some aspects, the techniques described herein relate to a system, wherein processing includes IR scanner data.

In some aspects, the techniques described herein relate to a system, wherein analyzing includes radar device data.

In some aspects, the techniques described herein relate to a system, wherein generating includes pathway mapping.

In some aspects, the techniques described herein relate to a system, wherein creating includes equipment modeling.

In some aspects, the techniques described herein relate to a system, wherein processing includes EMF scanner data.

In some aspects, the techniques described herein relate to an AI convergence system of systems for transportation optimization including: a digital twin system configured to: alter traffic patterns through navigational data updates; achieve predetermined optimization criteria; coordinate mobile element interactions; and optimize process efficiency.

In some aspects, the techniques described herein relate to a system, wherein altering includes route optimization.

In some aspects, the techniques described herein relate to a system, wherein achieving includes safety criteria.

In some aspects, the techniques described herein relate to a system, wherein coordinating includes path planning.

In some aspects, the techniques described herein relate to a system, wherein optimizing includes resource utilization.

In some aspects, the techniques described herein relate to a system, wherein altering includes real-time adaptation.

In some aspects, the techniques described herein relate to a system, wherein achieving includes efficiency targets.

In some aspects, the techniques described herein relate to a system, wherein coordinating includes collision avoidance.

In some aspects, the techniques described herein relate to a system, wherein optimizing includes energy efficiency.

In some aspects, the techniques described herein relate to a system, wherein altering includes congestion management.

In some aspects, the techniques described herein relate to a system, wherein achieving includes performance goals.

In some aspects, the techniques described herein relate to an AI convergence system of systems for transportation analysis including: a digital twin dynamic model system configured to: calculate device property values; update transportation worker digital twins; implement psychometric models; and predict reactions to stimuli.

In some aspects, the techniques described herein relate to a system, wherein calculating includes status monitoring.

In some aspects, the techniques described herein relate to a system, wherein updating includes location tracking.

In some aspects, the techniques described herein relate to a system, wherein implementing includes workflow models.

In some aspects, the techniques described herein relate to a system, wherein predicting includes behavioral responses.

In some aspects, the techniques described herein relate to a system, wherein calculating includes temperature analysis.

In some aspects, the techniques described herein relate to a system, wherein updating includes trajectory tracking.

In some aspects, the techniques described herein relate to a system, wherein implementing includes FMEA models.

In some aspects, the techniques described herein relate to a system, wherein predicting includes performance measures.

In some aspects, the techniques described herein relate to a system, wherein calculating includes stress measures.

In some aspects, the techniques described herein relate to a system, wherein updating includes task monitoring.

In some aspects, the techniques described herein relate to an AI convergence system of systems for transportation modeling including: a digital twin system configured to: adhere to physical laws and principles; implement dynamic models; conform to real-world conditions; and adapt based on behavioral differences.

In some aspects, the techniques described herein relate to a system, wherein adhering includes thermodynamic laws.

In some aspects, the techniques described herein relate to a system, wherein implementing includes motion laws.

In some aspects, the techniques described herein relate to a system, wherein conforming includes fluid dynamics.

In some aspects, the techniques described herein relate to a system, wherein adapting includes model correction.

In some aspects, the techniques described herein relate to a system, wherein adhering includes buoyancy laws.

In some aspects, the techniques described herein relate to a system, wherein implementing includes heat transfer laws.

In some aspects, the techniques described herein relate to a system, wherein conforming includes radiation laws.

In some aspects, the techniques described herein relate to a system, wherein adapting includes assumption validation.

In some aspects, the techniques described herein relate to a system, wherein adhering includes quantum dynamics.

In some aspects, the techniques described herein relate to a system, wherein implementing includes aging principles.

In some aspects, the techniques described herein relate to an AI convergence system of systems for transportation analysis including: a digital twin interface system configured to: enable user inspection of digital twins; facilitate interaction with transportation entities; monitor processes being performed; and control digital twin properties.

In some aspects, the techniques described herein relate to a system, wherein enabling includes measurement monitoring.

In some aspects, the techniques described herein relate to a system, wherein facilitating includes movement tracking.

In some aspects, the techniques described herein relate to a system, wherein monitoring includes interaction analysis.

In some aspects, the techniques described herein relate to a system, wherein controlling includes loading operations.

In some aspects, the techniques described herein relate to a system, wherein enabling includes maintenance tracking.

In some aspects, the techniques described herein relate to a system, wherein facilitating includes cleaning operations.

In some aspects, the techniques described herein relate to a system, wherein monitoring includes fueling processes.

In some aspects, the techniques described herein relate to a system, wherein controlling includes resupply operations.

In some aspects, the techniques described herein relate to a system, wherein enabling includes painting operations.

In some aspects, the techniques described herein relate to a system, wherein facilitating includes process control.

In some aspects, the techniques described herein relate to an AI convergence system of systems for transportation optimization including: a digital twin generation system configured to: receive digital twin requests; determine required data types; structure collected data; and generate requested digital twins.

In some aspects, the techniques described herein relate to a system, wherein receiving includes type specification.

In some aspects, the techniques described herein relate to a system, wherein determining includes data classification.

In some aspects, the techniques described herein relate to a system, wherein structuring includes historical data.

In some aspects, the techniques described herein relate to a system, wherein generating includes real-time data.

In some aspects, the techniques described herein relate to a system, wherein receiving includes role specification.

In some aspects, the techniques described herein relate to a system, wherein determining includes CRM data.

In some aspects, the techniques described herein relate to a system, wherein structuring includes market data.

In some aspects, the techniques described herein relate to a system, wherein generating includes configuration data.

In some aspects, the techniques described herein relate to a system, wherein receiving includes purpose specification.

In some aspects, the techniques described herein relate to a system, wherein determining includes operational data.

In some aspects, the techniques described herein relate to an AI convergence system of systems for transportation analysis including: an enterprise layer configured to: implement executive digital twins for vehicle fleet operations; create vehicle digital twins for design and simulation; provide enterprise access for fleet transactions; and manage software-defined vehicle fleets.

In some aspects, the techniques described herein relate to a system, wherein implementing includes contextual simulation.

In some aspects, the techniques described herein relate to a system, wherein creating includes performance forecasting.

In some aspects, the techniques described herein relate to a system, wherein providing includes transaction processing.

In some aspects, the techniques described herein relate to a system, wherein managing includes fleet optimization.

In some aspects, the techniques described herein relate to a system, wherein implementing includes operational modeling.

In some aspects, the techniques described herein relate to a system, wherein creating includes component simulation.

In some aspects, the techniques described herein relate to a system, wherein providing includes access control.

In some aspects, the techniques described herein relate to a system, wherein managing includes resource allocation.

In some aspects, the techniques described herein relate to a system, wherein implementing includes efficiency analysis.

In some aspects, the techniques described herein relate to a system, wherein creating includes maintenance planning.

In some aspects, the techniques described herein relate to a computer-implemented method substantially as hereinbefore described with reference to any of the examples and/or to the attached drawings.

In some aspects, the techniques described herein relate to a computing system including one or more processors and one or more memories configured to perform operations substantially as hereinbefore described with reference to any of the examples and/or to the attached drawings.

In some aspects, the techniques described herein relate to a computer program product residing on a computer readable storage medium having a plurality of instructions stored thereon which, when executed across one or more processors, causes at least a portion of the one or more processors to perform operations substantially as hereinbefore described with reference to any of the examples and/or to the attached drawings.

In some aspects, the techniques described herein relate to a device configured substantially as hereinbefore described with reference to any of the examples and/or to the attached drawings.

It is to be understood that any combination of features from the methods disclosed herein and/or from the systems disclosed herein may be used together, and/or that any features from any or all of these aspects may be combined with any of the features of the embodiments and/or examples disclosed herein to achieve the benefits as described in this disclosure.

### BRIEF DESCRIPTION OF THE FIGURES

In the accompanying figures, like reference numerals refer to identical or functionally similar elements throughout the separate views and together with the detailed description below are incorporated in and form part of the specification, serve to further illustrate various embodiments and to explain various principles and advantages all in accordance with the systems and methods disclosed herein.

FIG. 1 is a diagrammatic view that illustrates an architecture for a transportation system showing certain illustrative components and arrangements relating to various embodiments of the present disclosure.

FIG. 2 is a diagrammatic view that illustrates use of a hybrid neural network to optimize a powertrain component of a vehicle relating to various embodiments of the present disclosure.

FIG. 3 is a diagrammatic view that illustrates a set of states that may be provided as inputs to and/or be governed by an expert system/Artificial Intelligence (AI) system relating to various embodiments of the present disclosure.

FIG. 4 is a diagrammatic view that illustrates a range of parameters that may be taken as inputs by an expert system or AI system, or component thereof, as described throughout this disclosure, or that may be provided as outputs from such a system and/or one or more sensors, cameras, or external systems relating to various embodiments of the present disclosure.

FIG. 5 is a diagrammatic view that illustrates a set of vehicle user interfaces relating to various embodiments of the present disclosure.

FIG. 6 is a diagrammatic view that illustrates a set of interfaces among transportation system components relating to various embodiments of the present disclosure.

FIG. 7 is a diagrammatic view that illustrates a data processing system, which may process data from various sources relating to various embodiments of the present disclosure.

FIG. 8 is a diagrammatic view that illustrates a set of algorithms that may be executed in connection with one or more of the many embodiments of transportation systems described throughout this disclosure relating to various embodiments of the present disclosure.

FIG. 9 is a diagrammatic view that illustrates systems described throughout this disclosure relating to various embodiments of the present disclosure.

FIG. 10 is a diagrammatic view that illustrates systems described throughout this disclosure relating to various embodiments of the present disclosure.

FIG. 11 is a diagrammatic view that illustrates a method described throughout this disclosure relating to various embodiments of the present disclosure.

FIG. 12 is a diagrammatic view that illustrates systems described throughout this disclosure relating to various embodiments of the present disclosure.

FIG. 13 is a diagrammatic view that illustrates a method described throughout this disclosure relating to various embodiments of the present disclosure.

FIG. 14 is a diagrammatic view that illustrates systems described throughout this disclosure relating to various embodiments of the present disclosure.

FIG. 15 is a diagrammatic view that illustrates a method described throughout this disclosure relating to various embodiments of the present disclosure.

FIG. 16 is a diagrammatic view that illustrates systems described throughout this disclosure relating to various embodiments of the present disclosure.

FIG. 17 is a diagrammatic view that illustrates a method described throughout this disclosure relating to various embodiments of the present disclosure.

FIG. 18 is a diagrammatic view that illustrates systems described throughout this disclosure relating to various embodiments of the present disclosure.

FIG. 19 is a diagrammatic view that illustrates a method described throughout this disclosure relating to various embodiments of the present disclosure.

FIG. 20 is a diagrammatic view that illustrates a method described throughout this disclosure relating to various embodiments of the present disclosure.

FIG. 21 is a diagrammatic view that illustrates a method described throughout this disclosure relating to various embodiments of the present disclosure.

FIG. 22 is a diagrammatic view that illustrates systems described throughout this disclosure relating to various embodiments of the present disclosure.

FIG. 23 is a diagrammatic view that illustrates a method described throughout this disclosure relating to various embodiments of the present disclosure.

FIG. 24 is a diagrammatic view that illustrates a method described throughout this disclosure relating to various embodiments of the present disclosure.

FIG. 25 is a diagrammatic view that illustrates systems described throughout this disclosure relating to various embodiments of the present disclosure.

FIG. 26 is a diagrammatic view that illustrates a method described throughout this disclosure relating to various embodiments of the present disclosure.

FIG. 26A is a diagrammatic view that illustrates systems described throughout this disclosure relating to various embodiments of the present disclosure.

FIG. 27 is a diagrammatic view that illustrates systems described throughout this disclosure relating to various embodiments of the present disclosure.

FIG. 28 is a diagrammatic view that illustrates a method described throughout this disclosure relating to various embodiments of the present disclosure.

FIG. 29 is a diagrammatic view that illustrates systems described throughout this disclosure relating to various embodiments of the present disclosure.

FIG. 30 is a diagrammatic view that illustrates systems described throughout this disclosure relating to various embodiments of the present disclosure.

FIG. 31 is a diagrammatic view that illustrates systems described throughout this disclosure relating to various embodiments of the present disclosure.

FIG. 32 is a diagrammatic view that illustrates systems described throughout this disclosure relating to various embodiments of the present disclosure.

FIG. 33 is a diagrammatic view that illustrates a method described throughout this disclosure relating to various embodiments of the present disclosure.

FIG. 34 is a diagrammatic view that illustrates systems described throughout this disclosure relating to various embodiments of the present disclosure.

FIG. 35 is a diagrammatic view that illustrates a method described throughout this disclosure relating to various embodiments of the present disclosure.

FIG. 36 is a diagrammatic view that illustrates systems described throughout this disclosure relating to various embodiments of the present disclosure.

FIG. 37 is a diagrammatic view that illustrates systems described throughout this disclosure relating to various embodiments of the present disclosure.

FIG. 38 is a diagrammatic view that illustrates a method described throughout this disclosure relating to various embodiments of the present disclosure.

FIG. 39 is a diagrammatic view that illustrates a method described throughout this disclosure relating to various embodiments of the present disclosure.

FIG. 40 is a diagrammatic view that illustrates a method described throughout this disclosure relating to various embodiments of the present disclosure.

FIG. 41 is a diagrammatic view that illustrates systems described throughout this disclosure relating to various embodiments of the present disclosure.

FIG. 42 is a diagrammatic view that illustrates a method described throughout this disclosure relating to various embodiments of the present disclosure.

FIG. 43 is a diagrammatic view that illustrates a method described throughout this disclosure relating to various embodiments of the present disclosure.

FIG. 44 is a diagrammatic view that illustrates systems described throughout this disclosure relating to various embodiments of the present disclosure.

FIG. 45 is a diagrammatic view that illustrates systems and methods described throughout this disclosure relating to various embodiments of the present disclosure.

FIG. 46 is a diagrammatic view that illustrates systems and methods described throughout this disclosure relating to various embodiments of the present disclosure.

FIG. 47 is a diagrammatic view that illustrates systems and methods described throughout this disclosure relating to various embodiments of the present disclosure.

FIG. 48 is a diagrammatic view that illustrates systems described throughout this disclosure relating to various embodiments of the present disclosure.

FIG. 49 is a diagrammatic view that illustrates a method described throughout this disclosure relating to various embodiments of the present disclosure.

FIG. 50 is a diagrammatic view that illustrates a method described throughout this disclosure relating to various embodiments of the present disclosure.

FIG. 51 is a diagrammatic view that illustrates systems described throughout this disclosure relating to various embodiments of the present disclosure.

FIG. 52 is a diagrammatic view that illustrates systems described throughout this disclosure relating to various embodiments of the present disclosure.

FIG. 53 is a diagrammatic view that illustrates systems described throughout this disclosure relating to various embodiments of the present disclosure.

FIG. 54 is a diagrammatic view that illustrates a method described throughout this disclosure relating to various embodiments of the present disclosure.

FIG. 55 is a diagrammatic view that illustrates a method described throughout this disclosure relating to various embodiments of the present disclosure.

FIG. 56 is a diagrammatic view that illustrates systems described throughout this disclosure relating to various embodiments of the present disclosure.

FIG. 57 is a diagrammatic view that illustrates systems described throughout this disclosure relating to various embodiments of the present disclosure.

FIG. 58 is a diagrammatic view that illustrates systems described throughout this disclosure relating to various embodiments of the present disclosure.

FIG. 59 is a diagrammatic view that illustrates an architecture for a transportation system including a digital twin system of a vehicle showing certain illustrative components and arrangements relating to various embodiments of the present disclosure.

FIG. 60 shows a schematic illustration of the digital twin system integrated with an identity and access management system in accordance with certain embodiments of the present disclosure.

FIG. 61 illustrates a schematic view of an interface of the digital twin system presented on the user device of a driver of the vehicle relating to various embodiments of the present disclosure.

FIG. 62 is a schematic diagram showing the interaction between the driver and the digital twin using one or more views and modes of the interface in accordance with an example embodiment of the present disclosure.

FIG. 63 illustrates a schematic view of an interface of the digital twin system presented on the user device of a manufacturer of the vehicle in accordance with various embodiments of the present disclosure.

FIG. 64 depicts a scenario in which the manufacturer uses the quality view of a digital twin interface to run simulations and generate what-if scenarios for quality testing a vehicle in accordance with an example embodiment of the present disclosure.

FIG. 65 illustrates a schematic view of an interface of the digital twin system presented on the user device of a dealer of the vehicle.

FIG. 66 is a diagram illustrating the interaction between the dealer and the digital twin using one or more views with the goal of personalizing the experience of a customer purchasing a vehicle in accordance with an example embodiment.

FIG. 67 is a diagram illustrating the service & maintenance view presented to a user of a vehicle including a driver, a manufacturer and a dealer of the vehicle in accordance with various embodiments of the present disclosure.

FIG. 68 is a method used by the digital twin for detecting faults and predicting any future failures of the vehicle in accordance with an example embodiment.

FIG. 69 is a diagrammatic view that illustrates the architecture of a vehicle with a digital twin system for performing predictive maintenance on a vehicle in accordance with an example embodiment of the present disclosure.

FIG. 70 is a flow chart depicting a method for generating a digital twin of a vehicle in accordance with various embodiments of the disclosure.

FIG. 71 is a diagrammatic view that illustrates an alternate architecture for a transportation system comprising a vehicle and a digital twin system in accordance with various embodiments of the present disclosure.

FIG. 72 depicts a digital twin representing a combination of a set of states of both a vehicle and a driver of the vehicle in accordance with certain embodiments of the present disclosure.

FIG. 73 illustrates a schematic diagram depicting a scenario in which the integrated vehicle and driver digital twin may configure the vehicle experience in accordance with an example embodiment.

FIG. 74 is a schematic illustrating an example of a portion of an information technology system for transportation artificial intelligence leveraging digital twins according to some embodiments of the present disclosure.

FIG. 75 is a schematic illustrating examples of architecture of a digital twin system according to embodiments of the present disclosure.

FIG. 76 is a schematic illustrating exemplary components of a digital twin management system according to embodiments of the present disclosure.

FIG. 77 is a schematic illustrating examples of a digital twin I/O system that interfaces with an environment, the digital twin system, and/or components thereof to provide bi-directional transfer of data between coupled components according to embodiments of the present disclosure.

FIG. 78 is a schematic illustrating an example set of identified states related to transportation systems that the digital twin system may identify and/or store for access by intelligent systems (e.g., a cognitive intelligence system) or users of the digital twin system according to embodiments of the present disclosure.

FIG. 79 is a schematic illustrating example embodiments of methods for updating a set of properties of a digital twin of the present disclosure on behalf of a client application and/or one or more embedded digital twins.

FIG. 80 illustrates example embodiments of a display interface of the present disclosure that renders a digital twin of a dryer centrifuge with information relating to the dryer centrifuge.

FIG. 81 is a schematic illustrating an example embodiment of a method for updating a set of vibration fault level states of machine components such as bearings in the digital twin of a machine, on behalf of a client application.

FIG. 82 is a schematic illustrating an example embodiment of a method for updating a set of vibration severity unit values of machine components such as bearings in the digital twin of a machine on behalf of a client application.

FIG. 83 is a schematic illustrating an example embodiment of a method for updating a set of probability of failure values in the digital twins of machine components on behalf of a client application.

FIG. 84 is a schematic illustrating an example embodiment of a method for updating a set of probability of downtime values of machines in the digital twin of a transportation system on behalf of a client application.

FIG. 85 is a schematic illustrating an example embodiment of a method for updating one or more probability of shutdown values of transportation entities in one or more transportation system digital twins.

FIG. 86 is a schematic illustrating an example embodiment of a method for updating a set of cost of downtime values of machines in the digital twin of a transportation system.

FIG. 87 is a schematic illustrating an example embodiment of a method for updating one or more KPI values in a digital twin of a transportation system, on behalf of a client application.

FIG. 88 is a schematic illustrating an example embodiment of a method of the present disclosure.

FIG. 89 is a schematic illustrating examples of different types of enterprise digital twins, including executive digital twins, in relation to the data layer, processing layer, and application layer of an enterprise digital twin framework according to some embodiments of the present disclosure.

FIG. 90 is a schematic illustrating an example of a method for configuring role-based digital twins according to some embodiments of the present disclosure.

FIG. 91 is a schematic illustrating an example of a method for configuring a digital twin of a workforce according to some embodiments of the present disclosure.

FIG. 92 is a schematic view of an exemplary embodiment of the quantum computing service according to some embodiments of the present disclosure.

FIG. 93 illustrates quantum computing service request handling according to some embodiments of the present disclosure.

FIG. 94 is a diagrammatic view that illustrates embodiments of the biology-based system in accordance with the present disclosure.

FIG. 95 is a diagrammatic view of the thalamus service and how it coordinates within the modules in accordance with the present disclosure.

FIG. 96 is a diagrammatic view of the dual process artificial neural network system.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the many embodiments of the systems and methods disclosed herein.

FIG. 97 is a diagrammatic view of artificial intelligence capabilities, convergence technology stack capabilities and software-defined vehicle modules of a transportation system.

FIG. 98 is a diagrammatic view of software defined vehicle modules of a transportation system.

FIG. 99 depicts a block diagram of exemplary features, capabilities, and interfaces of a generative artificial intelligence platform of a transportation system.

FIG. 100 is a diagrammatic view of data and visualization methods and systems of a transportation system.

FIG. 101 is a diagrammatic view of data and visualization methods and systems of a transportation system.

FIG. 102 is a schematic view of an example AI convergence system of systems.

FIG. 103 is a schematic view of an example offering layer.

FIG. 104 is a schematic view of an example transactions layer.

FIG. 105 is a schematic view of an example operations layer.

FIG. 106 is a schematic view of an example network layer.

FIG. 107 is a schematic view of an example data layer.

FIG. 108 is a schematic view of an example data layer.

FIG. 109 is a schematic view of an example intelligent data layer architecture.

FIG. 110 is a schematic view of an example network layer.

FIG. 111 is a schematic view of an example AI subsystem integrator system.

FIG. 112 is a schematic view of an example multiplatform attention management system.

Like reference symbols in the various drawings indicate like elements.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art. The claims should be consulted to ascertain the true scope of the disclosure.

Before describing in detail embodiments that are in accordance with the systems and methods disclosed herein, it should be observed that the embodiments reside primarily in combinations of method and/or system components. Accordingly, the system components and methods have been represented where appropriate by conventional symbols in the drawings, showing only those specific details that are pertinent to understanding the embodiments of the systems and methods disclosed herein.

All documents mentioned herein are hereby incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth, except where the context clearly indicates otherwise.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one skilled in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “third,” “above,” “below,” and the like, are words of convenience and are not to be construed as implying a chronological order or otherwise limiting any corresponding element unless expressly stated otherwise. The term “set” should be understood to encompass a set with a single member or a plurality of members.

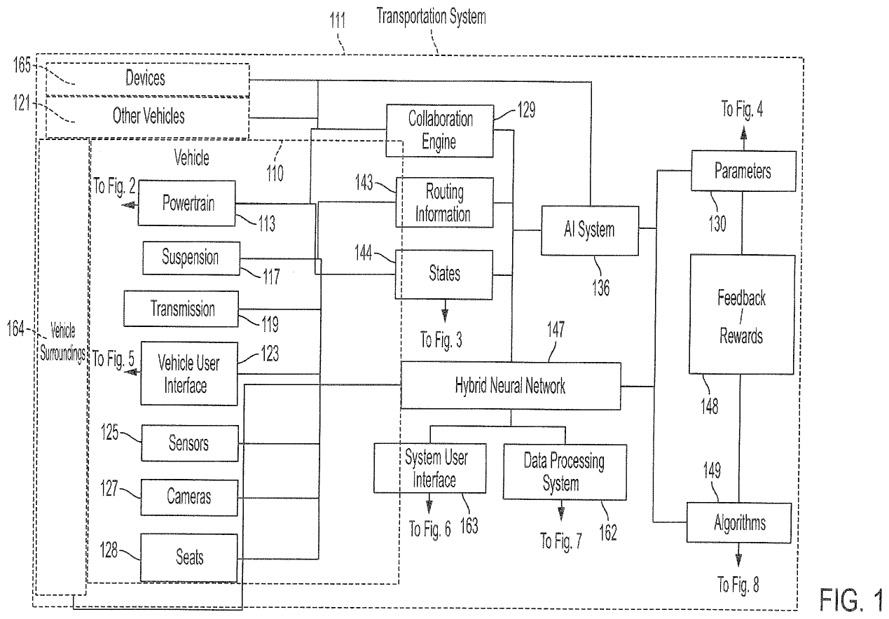

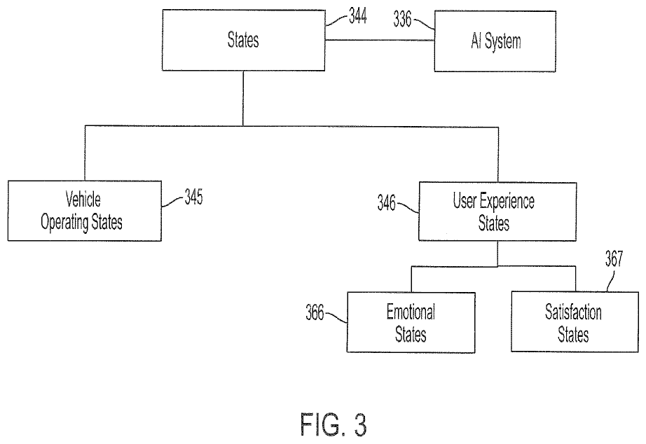

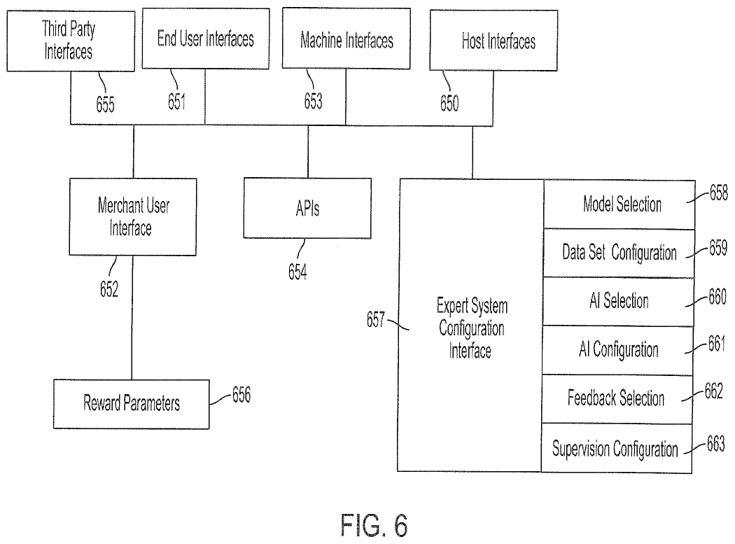

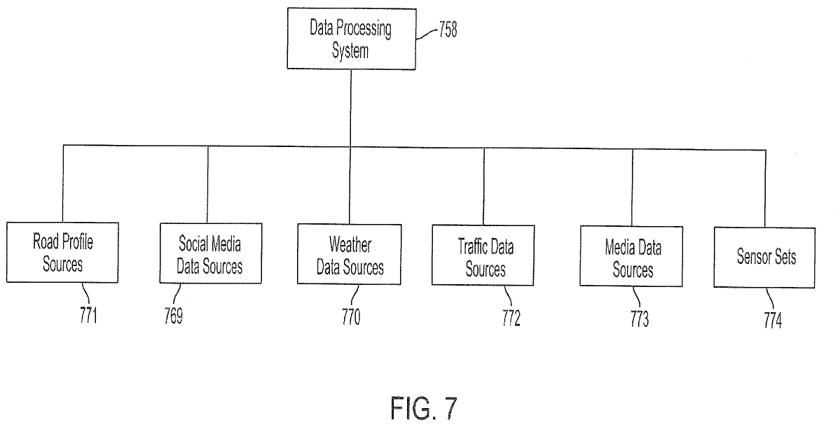

Referring to FIG. 1, an architecture for a transportation system 111 is depicted, showing certain illustrative components and arrangements relating to certain embodiments described herein. The transportation system 111 may include one or more vehicles 110, which may include various mechanical, electrical, and software components and systems, such as a powertrain 113, a suspension system 117, a steering system, a braking system, a fuel system, a charging system, seats 128, a combustion engine, an electric vehicle drive train, a transmission 119, a gear set, and the like. The vehicle may have a vehicle user interface 123, which may include a set of interfaces that include a steering system, buttons, levers, touch screen interfaces, audio interfaces, and the like as described throughout this disclosure. The vehicle may have a set of sensors 125 (including cameras 127), such as for providing input to expert system/artificial intelligence features described throughout this disclosure, such as one or more neural networks (which may include hybrid neural networks 147 as described herein). Sensors 125 and/or external information may be used to inform the expert system/Artificial Intelligence (AI) system 136 and to indicate or track one or more vehicle states 144, such as vehicle operating states 345 (FIG. 3), user experience states 346 (FIG. 3), and others described herein, which also may be as inputs to or taken as outputs from a set of expert system/AI components. Routing information 143 may inform and take input from the expert system/AI system 136, including using in-vehicle navigation capabilities and external navigation capabilities, such as Global Position System (GPS), routing by triangulation (such as cell towers), peer-to-peer routing with other vehicles 121, and the like. A collaboration engine 129 may facilitate collaboration among vehicles and/or among users of vehicles, such as for managing collective experiences, managing fleets and the like. Vehicles 110 may be networked among each other in a peer-to-peer manner, such as using cognitive radio, cellular, wireless or other networking features. An AI system 136 or other expert systems may take as input a wide range of vehicle parameters 130, such as from onboard diagnostic systems, telemetry systems, and other software systems, as well as from vehicle-located sensors 125 and from external systems. In embodiments, the system may manage a set of feedback/rewards 148, incentives, or the like, such as to induce certain user behavior and/or to provide feedback to the AI system 136, such as for learning on a set of outcomes to accomplish a given task or objective. The expert system or AI system 136 may inform, use, manage, or take output from a set of algorithms 149, including a wide variety as described herein. In the example of the present disclosure depicted in FIG. 1, a data processing system 162, is connected to the hybrid neural network 147. The data processing system 162 may process data from various sources (see FIG. 7). In the example of the present disclosure depicted in FIG. 1, a system user interface 163, is connected to the hybrid neural network 147. See the disclosure, below, relating to FIG. 6 for further disclosure relating to interfaces. FIG. 1 shows that vehicle surroundings 164 may be part of the transportation system 111. Vehicle surroundings may include roadways, weather conditions, lighting conditions, etc. FIG. 1 shows that devices 165, for example, mobile phones and computer systems, navigation systems, etc., may be connected to various elements of the transportation system 111, and therefore may be part of the transportation system 111 of the present disclosure.

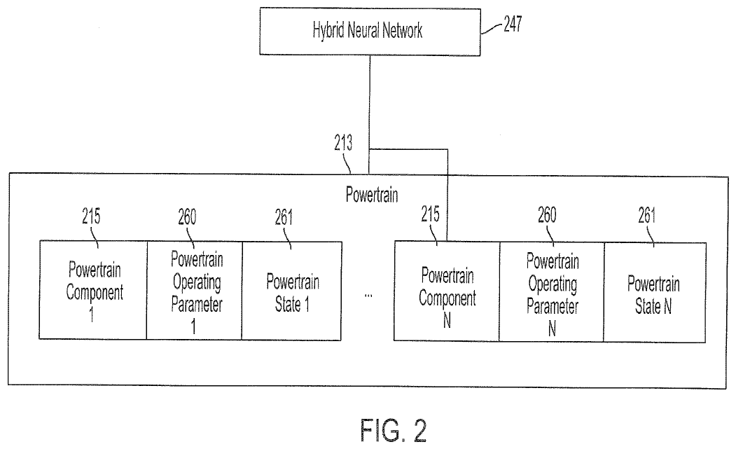

Referring to FIG. 2, provided herein are transportation systems having a hybrid neural network 247 for optimizing a powertrain 213 of a vehicle, wherein at least two parts of the hybrid neural network 247 optimize distinct parts of the powertrain 213. An artificial intelligence system may control a powertrain component 215 based on an operational model (such as a physics model, an electrodynamic model, a hydrodynamic model, a chemical model, or the like for energy conversion, as well as a mechanical model for operation of various dynamically interacting system components). For example, the AI system may control a powertrain component 215 by manipulating a powertrain operating parameter 260 to achieve a powertrain state 261. The AI system may be trained to operate a powertrain component 215, such as by training on a data set of outcomes (e.g., fuel efficiency, safety, rider satisfaction, or the like) and/or by training on a data set of operator actions (e.g., driver actions sensed by a sensor set, camera or the like or by a vehicle information system). In embodiments, a hybrid approach may be used, where one neural network optimizes one part of a powertrain (e.g., for gear shifting operations), while another neural network optimizes another part (e.g., braking, clutch engagement, or energy discharge and recharging, among others). Any of the powertrain components described throughout this disclosure may be controlled by a set of control instructions that consist of output from at least one component of a hybrid neural network 247.

FIG. 3 illustrates a set of states that may be provided as inputs to and/or be governed by an expert system/AI system 336, as well as used in connection with various systems and components in various embodiments described herein. States 344 may include vehicle operating states 345, including vehicle configuration states, component states, diagnostic states, performance states, location states, maintenance states, and many others, as well as user experience states 346, such as experience-specific states, emotional states 366 for users, satisfaction states 367, location states, content/entertainment states and many others.

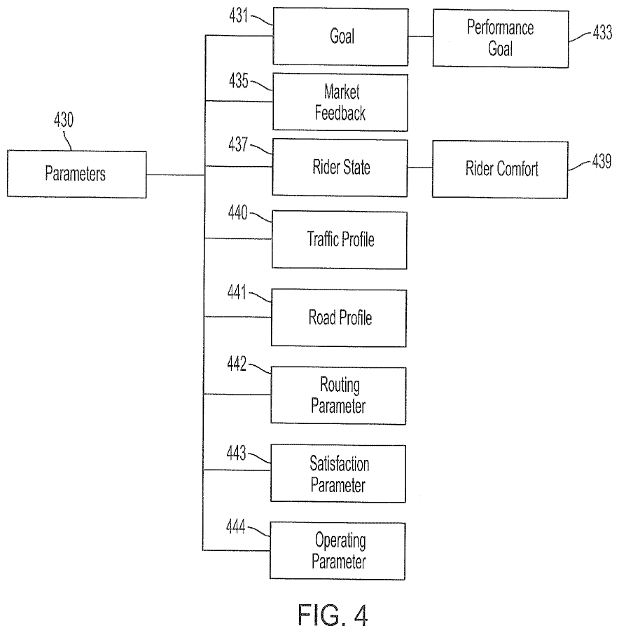

FIG. 4 illustrates a range of parameters 430 that may be taken as inputs by an expert system or AI system 136 (FIG. 1), or component thereof, as described throughout this disclosure, or that may be provided as outputs from such a system and/or one or more sensors 125 (FIG. 1), cameras 127 (FIG. 1), or external systems. Parameters 430 may include one or more goals 431 or objectives (such as ones that are to be optimized by an expert system/AI system, such as by iteration and/or machine learning), such as a performance goal 433, such as relating to fuel efficiency, trip time, satisfaction, financial efficiency, safety, or the like. Parameters 430 may include market feedback parameters 435, such as relating to pricing, availability, location, or the like of goods, services, fuel, electricity, advertising, content, or the like. Parameters 430 may include rider state parameters 437, such as parameters relating to comfort 439, emotional state, satisfaction, goals, type of trip, fatigue and the like. Parameters 430 may include parameters of various transportation-relevant profiles, such as traffic profiles 440 (location, direction, density and patterns in time, among many others), road profiles 441 (elevation, curvature, direction, road surface conditions and many others), user profiles, and many others. Parameters 430 may include routing parameters 442, such as current vehicle locations, destinations, waypoints, points of interest, type of trip, goal for trip, required arrival time, desired user experience, and many others. Parameters 430 may include satisfaction parameters 443, such as for riders (including drivers), fleet managers, advertisers, merchants, owners, operators, insurers, regulators and others. Parameters 430 may include operating parameters 444, including the wide variety described throughout this disclosure.

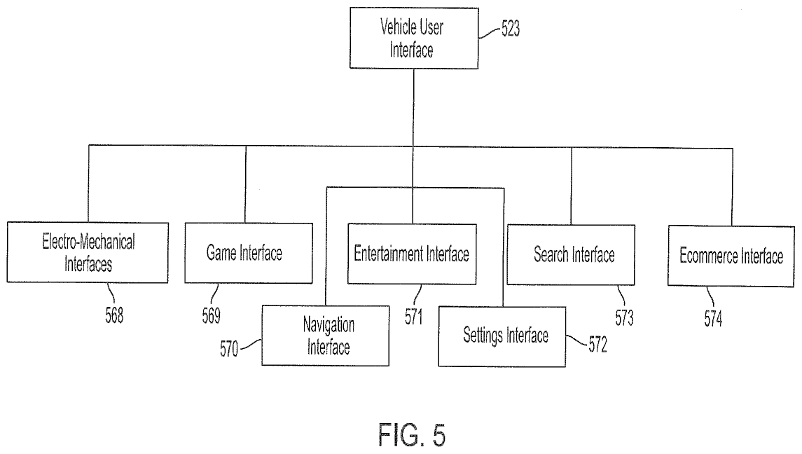

FIG. 5 illustrates a set of vehicle user interfaces 523. Vehicle user interfaces 523 may include electromechanical interfaces 568, such as steering interfaces, braking interfaces, interfaces for seats, windows, moonroof, glove box and the like. Interfaces 523 may include various software interfaces (which may have touch screen, dials, knobs, buttons, icons or other features), such as a game interface 569, a navigation interface 570, an entertainment interface 571, a vehicle settings interface 572, a search interface 573, an ecommerce interface 574, and many others. Vehicle interfaces may be used to provide inputs to, and may be governed by, one or more AI systems/expert systems such as described in embodiments throughout this disclosure.

FIG. 6 illustrates a set of interfaces among transportation system components, including interfaces within a host system (such as governing a vehicle or fleet of vehicles) and host interfaces 650 between a host system and one or more third parties and/or external systems. Interfaces include third party interfaces 655 and end user interfaces 651 for users of the host system, including the in-vehicle interfaces that may be used by riders as noted in connection with FIG. 5, as well as user interfaces for others, such as fleet managers, insurers, regulators, police, advertisers, merchants, content providers, and many others. Interfaces may include merchant interfaces 652, such as by which merchants may provide advertisements, content relating to offerings, and one or more rewards, such as to induce routing or other behavior on the part of users. Interfaces may include machine interfaces 653, such as application programming interfaces (API) 654, networking interfaces, peer-to-peer interfaces, connectors, brokers, extract-transform-load (ETL) system, bridges, gateways, ports and the like. Interfaces may include one or more host interfaces by which a host may manage and/or configure one or more of the many embodiments described herein, such as configuring neural network components, setting weight for models, setting one or more goals or objectives, setting reward parameters 656, and many others. Interfaces may include expert system/AI system configuration interfaces 657, such as for selecting one or more models 658, selecting and configuring data sets 659 (such as sensor data, external data and other inputs described herein), AI selection 660 and AI configuration 661 (such as selection of neural network category, parameter weighting and the like), feedback selection 662 for an expert system/AI system, such as for learning, and supervision configuration 663, among many others.

FIG. 7 illustrates a data processing system 758, which may process data from various sources, including social media data sources 769, weather data sources 770, road profile sources 771, traffic data sources 772, media data sources 773, sensors sets 774, and many others. The data processing system may be configured to extract data, transform data to a suitable format (such as for use by an interface system, an AI system/expert system, or other systems), load it to an appropriate location, normalize data, cleanse data, deduplicate data, store data (such as to enable queries) and perform a wide range of processing tasks as described throughout this disclosure.

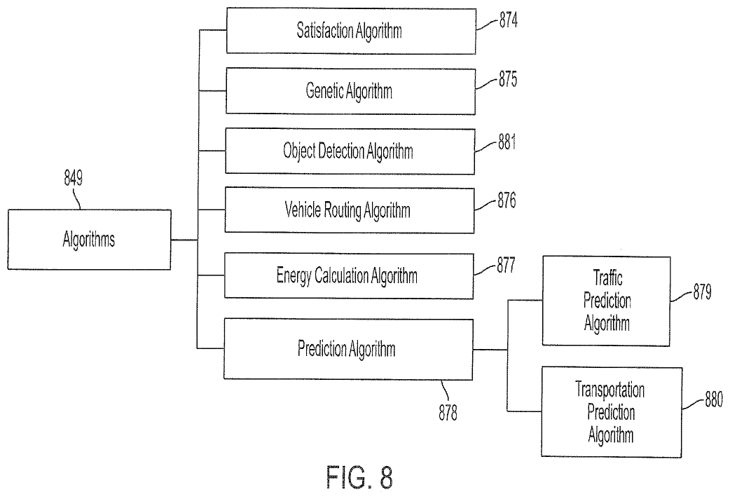

FIG. 8 illustrates a set of algorithms 849 that may be executed in connection with one or more of the many embodiments of transportation systems described throughout this disclosure. Algorithms 849 may take input from, provide output to, and be managed by a set of AI systems/expert systems, such as of the many types described herein. Algorithms 849 may include algorithms for providing or managing user satisfaction 874, one or more genetic algorithms 875, such as for seeking favorable states, parameters, or combinations of states/parameters in connection with optimization of one or more of the systems described herein. Algorithms 849 may include vehicle routing algorithms 876, including ones that are sensitive to various vehicle operating parameters, user experience parameters, or other states, parameters, profiles, or the like described herein, as well as to various goals or objectives. Algorithms 849 may include object detection algorithms 881. Algorithms 849 may include energy calculation algorithms 877, such as for calculating energy parameters, for optimizing fuel usage, electricity usage or the like, for optimizing refueling or recharging time, location, amount or the like. Algorithms may include prediction algorithms 878, such as for a traffic prediction algorithm 879, a transportation prediction algorithm 880, and algorithms for predicting other states or parameters of transportation systems as described throughout this disclosure.

In various embodiments, transportation systems 111 as described herein may include vehicles (including fleets and other sets of vehicles), as well as various infrastructure systems. Infrastructure systems may include Internet of Things systems (such as using cameras and other sensors, such as disposed on or in roadways, on or in traffic lights, utility poles, toll booths, signs and other roadside devices and systems, on or in buildings, and the like), refueling and recharging systems (such as at service stations, charging locations and the like, and including wireless recharging systems that use wireless power transfer), and many others.

Vehicle electrical, mechanical and/or powertrain components as described herein may include a wide range of systems, including transmission, gear system, clutch system, braking system, fuel system, lubrication system, steering system, suspension system, lighting system (including emergency lighting as well as interior and exterior lights), electrical system, and various subsystems and components thereof.

Vehicle operating states and parameters may include route, purpose of trip, geolocation, orientation, vehicle range, powertrain parameters, current gear, speed/acceleration, suspension profile (including various parameters, such as for each wheel), charge state for electric and hybrid vehicles, fuel state for fueled vehicles, and many others as described throughout this disclosure.

Rider and/or user experience states and parameters as described throughout this disclosure may include emotional states, comfort states, psychological states (e.g., anxiety, nervousness, relaxation or the like), awake/asleep states, and/or states related to satisfaction, alertness, health, wellness, one or more goals or objectives, and many others. User experience parameters as described herein may further include ones related to driving, braking, curve approach, seat positioning, window state, ventilation system, climate control, temperature, humidity, sound level, entertainment content type (e.g., news, music, sports, comedy, or the like), route selection (such as for POIs, scenic views, new sites and the like), and many others.

In embodiments, a route may be ascribed various parameters of value, such as parameters of value that may be optimized to improve user experience or other factors, such as under control of an AI system/expert system. Parameters of value of a route may include speed, duration, on time arrival, length (e.g., in miles), goals (e.g., to see a Point of Interest (POI), to complete a task (e.g., complete a shopping list, complete a delivery schedule, complete a meeting, or the like), refueling or recharging parameters, game-based goals, and others. As one of many examples, a route may be attributed value, such as in a model and/or as an input or feedback to an AI system or expert system that is configured to optimize a route, for task completion. A user may, for example, indicate a goal to meet up with at least one of a set of friends during a weekend, such as by interacting with a user interface or menu that allows setting of objectives. A route may be configured (including with inputs that provide awareness of friend locations, such as by interacting with systems that include location information for other vehicles and/or awareness of social relationships, such as through social data feeds) to increase the likelihood of meeting up, such as by intersecting with predicted locations of friends (which may be predicted by a neural network or other AI system/expert system as described throughout this disclosure) and by providing in-vehicle messages (or messages to a mobile device) that indicates possible opportunities for meeting up.

Market feedback factors may be used to optimize various elements of transportation systems as described throughout this disclosure, such as current and predicted pricing and/or cost (e.g., of fuel, electricity and the like, as well as of goods, services, content and the like that may be available along the route and/or in a vehicle), current and predicted capacity, supply and/or demand for one or more transportation related factors (such as fuel, electricity, charging capacity, maintenance, service, replacement parts, new or used vehicles, capacity to provide ride sharing, self-driving vehicle capacity or availability, and the like), and many others.

An interface in or on a vehicle may include a negotiation system, such as a bidding system, a price-negotiating system, a reward-negotiating system, or the like. For example, a user may negotiate for a higher reward in exchange for agreeing to re-route to a merchant location, a user may name a price the user is willing to pay for fuel (which may be provided to nearby refueling stations that may offer to meet the price), or the like. Outputs from negotiation (such as agreed prices, trips and the like) may automatically result in reconfiguration of a route, such as one governed by an AI system/expert system.

Rewards, such as provided by a merchant or a host, among others, as described herein may include one or more coupons, such as redeemable at a location, provision of higher priority (such as in collective routing of multiple vehicles), permission to use a “Fast Lane,” priority for charging or refueling capacity, among many others. Actions that can lead to rewards in a vehicle may include playing a game, downloading an app, driving to a location, taking a photograph of a location or object, visiting a website, viewing or listening to an advertisement, watching a video, and many others.

In embodiments, an AI system/expert system may use or optimize one or more parameters for a charging plan, such as for charging a battery of an electric or hybrid vehicle. Charging plan parameters may include routing (such as to charging locations), amount of charge or fuel provided, duration of time for charging, battery state, battery charging profile, time required to charge, value of charging, indicators of value, market price, bids for charging, available supply capacity (such as within a geofence or within a range of a set of vehicles), demand (such as based on detected charge/refueling state, based on requested demand, or the like), supply, and others. A neural network or other systems (optionally a hybrid system as described herein), using a model or algorithm (such as a genetic algorithm) may be used (such as by being trained over a set of trials on outcomes, and/or using a training set of human created or human supervised inputs, or the like) may provide a favorable and/or optimized charging plan for a vehicle or a set of vehicles based on the parameters. Other inputs may include priority for certain vehicles (e.g., for emergency responders or for those who have been rewarded priority in connection with various embodiments described herein).

In embodiments, a processor, as described herein, may comprise a neural processing chip, such as one employing a fabric, such as a LambdaFabric. Such a chip may have a plurality of cores, such as 256 cores, where each core is configured in a neuron-like arrangement with other cores on the same chip. Each core may comprise a micro-scale digital signal processor, and the fabric may enable the cores to readily connect to the other cores on the chip. In embodiments, the fabric may connect a large number of cores (e.g., more than 500,000 cores) and/or chips, thereby facilitating use in computational environments that require, for example, large scale neural networks, massively parallel computing, and large-scale, complex conditional logic. In embodiments, a low-latency fabric is used, such as one that has latency of 400 nanoseconds, 300 nanoseconds, 200 nanoseconds, 100 nanoseconds, or less from device-to-device, rack-to-rack, or the like. The chip may be a low power chip, such as one that can be powered by energy harvesting from the environment, from an inspection signal, from an onboard antenna, or the like. In embodiments, the cores may be configured to enable application of a set of sparse matrix heterogeneous machine learning algorithms. The chip may run an object-oriented programming language, such as C++, Java, or the like. In embodiments, a chip may be programmed to run each core with a different algorithm, thereby enabling heterogeneity in algorithms, such as to enable one or more of the hybrid neural network embodiments described throughout this disclosure. A chip can thereby take multiple inputs (e.g., one per core) from multiple data sources, undertake massively parallel processing using a large set of distinct algorithms, and provide a plurality of outputs (such as one per core or per set of cores).

In embodiments, a chip may contain or enable a security fabric, such as a fabric for performing content inspection, packet inspection (such as against a black list, white list, or the like), and the like, in addition to undertaking processing tasks, such as for a neural network, hybrid AI solution, or the like.

In embodiments, the platform described herein may include, integrate with, or connect with a system for robotic process automation (RPA), whereby an artificial intelligence/machine learning system may be trained on a training set of data that consists of tracking and recording sets of interactions of humans as the humans interact with a set of interfaces, such as graphical user interfaces (e.g., via interactions with mouse, trackpad, keyboard, touch screen, joystick, remote control devices); audio system interfaces (such as by microphones, smart speakers, voice response interfaces, intelligent agent interfaces (e.g., Siri and Alexa) and the like); human-machine interfaces (such as involving robotic systems, prosthetics, cybernetic systems, exoskeleton systems, wearables (including clothing, headgear, headphones, watches, wrist bands, glasses, arm bands, torso bands, belts, rings, necklaces and other accessories); physical or mechanical interfaces (e.g., buttons, dials, toggles, knobs, touch screens, levers, handles, steering systems, wheels, and many others); optical interfaces (including ones triggered by eye tracking, facial recognition, gesture recognition, emotion recognition, and the like); sensor-enabled interfaces (such as ones involving cameras, EEG or other electrical signal sensing (such as for brain-computer interfaces), magnetic sensing, accelerometers, galvanic skin response sensors, optical sensors, IR sensors, LIDAR and other sensor sets that are capable of recognizing thoughts, gestures (facial, hand, posture, or other), utterances, and the like, and others. In addition to tracking and recording human interactions, the RPA system may also track and record a set of states, actions, events and results that occur by, within, from or about the systems and processes with which the humans are engaging. For example, the RPA system may record mouse clicks on a frame of video that appears within a process by which a human review the video, such as where the human highlights points of interest within the video, tags objects in the video, captures parameters (such as sizes, dimensions, or the like), or otherwise operates on the video within a graphical user interface. The RPA system may also record system or process states and events, such as recording what elements were the subject of interaction, what the state of a system was before, during and after interaction, and what outputs were provided by the system or what results were achieved. Through a large training set of observation of human interactions and system states, events, and outcomes, the RPA system may learn to interact with the system in a fashion that mimics that of the human. Learning may be reinforced by training and supervision, such as by having a human correct the RPA system as it attempts in a set of trials to undertake the action that the human would have undertaken (e.g., tagging the right object, labeling an item correctly, selecting the correct button to trigger a next step in a process, or the like), such that over a set of trials the RPA system becomes increasingly effective at replicating the action the human would have taken. Learning may include deep learning, such as by reinforcing learning based on outcomes, such as successful outcomes (such as based on successful process completion, financial yield, and many other outcome measures described throughout this disclosure). In embodiments, an RPA system may be seeded during a learning phase with a set of expert human interactions, such that the RPA system begins to be able to replicate expert interaction with a system. For example, an expert driver's interactions with a robotic system, such as a remote-controlled vehicle or a UAV, may be recorded along with information about the vehicles state (e.g., the surrounding environment, navigation parameters, and purpose), such that the RPA system may learn to drive the vehicle in a way that reflects the same choices as an expert driver. After being taught to replicate the skills or expertise of an expert human, the RPA system may be transitioned to a deep learning mode, where the system further improves based on a set of outcomes, such as by being configured to attempt some level of variation in approach (e.g., trying different navigation paths to optimize time of arrival, or trying different approaches to deceleration and acceleration in curves) and tracking outcomes (with feedback), such that the RPA system can learn, by variation/experimentation (which may be randomized, rule-based, or the like, such as using genetic programming techniques, random-walk techniques, random forest techniques, and others) and selection, to exceed the expertise of the human expert. Thus, the RPA system learns from a human expert, acquires expertise in interacting with a system or process, facilitates automation of the process (such as by taking over some of the more repetitive tasks, including ones that require consistent execution of acquired skills), and provides a very effective seed for artificial intelligence, such as by providing a seed model or system that can be improved by machine learning with feedback on outcomes of a system or process.

RPA systems may have particular value in situations where human expertise or knowledge is acquired with training and experience, as well as in situations where the human brain and sensory systems are particularly adapted and evolved to solve problems that are computationally difficult or highly complex. Thus, in embodiments, RPA systems may be used to learn to undertake, among other things: visual pattern recognition tasks with respect to the various systems, processes, workflows and environments described herein (such as recognizing the meaning of dynamic interactions of objects or entities within a video stream (e.g., to understand what is taking place as humans and objects interact in a video); recognition of the significance of visual patterns (e.g., recognizing objects, structures, defects and conditions in a photograph or radiography image); tagging of relevant objects within a visual pattern (e.g., tagging or labeling objects by type, category, or specific identity (such as person recognition); indication of metrics in a visual pattern (such as dimensions of objects indicated by clicking on dimensions in an x-ray or the like); labeling activities in a visual pattern by category (e.g., what work process is being done); recognizing a pattern that is displayed as a signal (e.g., a wave or similar pattern in a frequency domain, time domain, or other signal processing representation); anticipate a n future state based on a current state (e.g., anticipating motion of a flying or rolling object, anticipating a next action by a human in a process, anticipating a next step by a machine, anticipating a reaction by a person to an event, and many others); recognize and predicting emotional states and reactions (such as based on facial expression, posture, body language or the like); apply a heuristic to achieve a favorable state without deterministic calculation (e.g., selecting a favorable strategy in sport or game, selecting a business strategy, selecting a negotiating strategy, setting a price for a product, developing a message to promote a product or idea, generating creative content, recognizing a favorable style or fashion, and many others); and many others. In embodiments, an RPA system may automate workflows that involve visual inspection of people, systems, and objects (including internal components), workflows that involve performing software tasks, such as involving sequential interactions with a series of screens in a software interface, workflows that involve remote control of robots and other systems and devices, workflows that involve content creation (such as selecting, editing and sequencing content), workflows that involve financial decision-making and negotiation (such as setting prices and other terms and conditions of financial and other transactions), workflows that involve decision-making (such as selecting an optimal configuration for a system or sub-system, selecting an optimal path or sequence of actions in a workflow, process or other activity that involves dynamic decision-making), and many others.

In embodiments, an RPA system may use a set of IoT devices and systems (such as cameras and sensors), to track and record human actions and interactions with respect to various interfaces and systems in an environment. The RPA system may also use data from onboard sensors, telemetry, and event recording systems, such as telemetry systems on vehicles and event logs on computers). The RPA system may thus generate and/or receive a large data set (optionally distributed) for an environment (such as any of the environments described throughout this disclosure) including data recording the various entities (human and non-human), systems, processes, applications (e.g., software applications used to enable workflows), states, events, and outcomes, which can be used to train the RPA system (or a set of RPA systems dedicated to automating various processes and workflows) to accomplish processes and workflows in a way that reflects and mimics accumulated human expertise, and that eventually improves on the results of that human expertise by further machine learning.

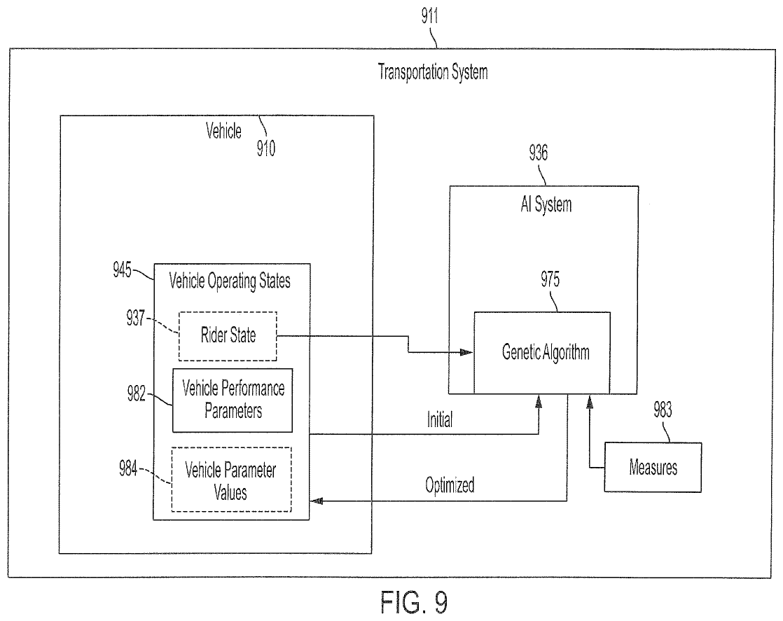

Referring to FIG. 9, in embodiments provided herein are systems for transportation 911 having an artificial intelligence system 936 that uses at least one genetic algorithm 975 to explore a set of possible vehicle operating states 945 to determine at least one optimized operating state. In embodiments, the genetic algorithm 975 takes inputs relating to at least one vehicle performance parameter 982 and at least one rider state 937.

An aspect provided herein includes a system for transportation 911, comprising: a vehicle 910 having a vehicle operating state 945; an artificial intelligence system 936 to execute a genetic algorithm 975 to generate mutations from an initial vehicle operating state to determine at least one optimized vehicle operating state. In embodiments, the vehicle operating state 945 includes a set of vehicle parameter values 984. In embodiments, the genetic algorithm 975 is to: vary the set of vehicle parameter values 984 for a set of corresponding time periods such that the vehicle 910 operates according to the set of vehicle parameter values 984 during the corresponding time periods; evaluate the vehicle operating state 945 for each of the corresponding time periods according to a set of measures 983 to generate evaluations; and select, for future operation of the vehicle 910, an optimized set of vehicle parameter values based on the evaluations.

In embodiments, the vehicle operating state 945 includes the rider state 937 of a rider of the vehicle. In embodiments, the at least one optimized vehicle operating state includes an optimized state of the rider. In embodiments, the genetic algorithm 975 is to optimize the state of the rider. In embodiments, the evaluating according to the set of measures 983 is to determine the state of the rider corresponding to the vehicle parameter values 984.

In embodiments, the vehicle operating state 945 includes a state of the rider of the vehicle. In embodiments, the set of vehicle parameter values 984 includes a set of vehicle performance control values. In embodiments, the at least one optimized vehicle operating state includes an optimized state of performance of the vehicle. In embodiments, the genetic algorithm 975 is to optimize the state of the rider and the state of performance of the vehicle. In embodiments, the evaluating according to the set of measures 983 is to determine the state of the rider and the state of performance of the vehicle corresponding to the vehicle performance control values.

In embodiments, the set of vehicle parameter values 984 includes a set of vehicle performance control values. In embodiments, the at least one optimized vehicle operating state includes an optimized state of performance of the vehicle. In embodiments, the genetic algorithm 975 is to optimize the state of performance of the vehicle. In embodiments, the evaluating according to the set of measures 983 is to determine the state of performance of the vehicle corresponding to the vehicle performance control values.

In embodiments, the set of vehicle parameter values 984 includes a rider-occupied parameter value. In embodiments, the rider-occupied parameter value affirms a presence of a rider in the vehicle 910. In embodiments, the vehicle operating state 945 includes the rider state 937 of a rider of the vehicle. In embodiments, the at least one optimized vehicle operating state includes an optimized state of the rider. In embodiments, the genetic algorithm 975 is to optimize the state of the rider. In embodiments, the evaluating according to the set of measures 983 is to determine the state of the rider corresponding to the vehicle parameter values 984. In embodiments, the state of the rider includes a rider satisfaction parameter. In embodiments, the state of the rider includes an input representative of the rider. In embodiments, the input representative of the rider is selected from the group consisting of: a rider state parameter, a rider comfort parameter, a rider emotional state parameter, a rider satisfaction parameter, a rider goals parameter, a classification of the trip, and combinations thereof.

In embodiments, the set of vehicle parameter values 984 includes a set of vehicle performance control values. In embodiments, the at least one optimized vehicle operating state includes an optimized state of performance of the vehicle. In embodiments, the genetic algorithm 975 is to optimize the state of the rider and the state of performance of the vehicle. In embodiments, the evaluating according to the set of measures 983 is to determine the state of the rider and the state of performance of the vehicle corresponding to the vehicle performance control values. In embodiments, the set of vehicle parameter values 984 includes a set of vehicle performance control values. In embodiments, the at least one optimized vehicle operating state includes an optimized state of performance of the vehicle. In embodiments, the genetic algorithm 975 is to optimize the state of performance of the vehicle. In embodiments, the evaluating according to the set of measures 983 is to determine the state of performance of the vehicle corresponding to the vehicle performance control values.

In embodiments, the set of vehicle performance control values are selected from the group consisting of: a fuel efficiency; a trip duration; a vehicle wear; a vehicle make; a vehicle model; a vehicle energy consumption profiles; a fuel capacity; a real-time fuel level; a charge capacity; a recharging capability; a regenerative braking state; and combinations thereof. In embodiments, at least a portion of the set of vehicle performance control values is sourced from at least one of an on-board diagnostic system, a telemetry system, a software system, a vehicle-located sensor, and a system external to the vehicle 910. In embodiments, the set of measures 983 relates to a set of vehicle operating criteria. In embodiments, the set of measures 983 relates to a set of rider satisfaction criteria. In embodiments, the set of measures 983 relates to a combination of vehicle operating criteria and rider satisfaction criteria. In embodiments, each evaluation uses feedback indicative of an effect on at least one of a state of performance of the vehicle and a state of the rider.

An aspect provided herein includes a system for transportation 911, comprising: an artificial intelligence system 936 to process inputs representative of a state of a vehicle and inputs representative of a rider state 937 of a rider occupying the vehicle during the state of the vehicle with the genetic algorithm 975 to optimize a set of vehicle parameters that affects the state of the vehicle or the rider state 937. In embodiments, the genetic algorithm 975 is to perform a series of evaluations using variations of the inputs. In embodiments, each evaluation in the series of evaluations uses feedback indicative of an effect on at least one of a vehicle operating state 945 and the rider state 937. In embodiments, the inputs representative of the rider state 937 indicate that the rider is absent from the vehicle 910. In embodiments, the state of the vehicle includes the vehicle operating state 945. In embodiments, a vehicle parameter in the set of vehicle parameters includes a vehicle performance parameter 982. In embodiments, the genetic algorithm 975 is to optimize the set of vehicle parameters for the state of the rider.

In embodiments, optimizing the set of vehicle parameters is responsive to an identifying, by the genetic algorithm 975, of at least one vehicle parameter that produces a favorable rider state. In embodiments, the genetic algorithm 975 is to optimize the set of vehicle parameters for vehicle performance. In embodiments, the genetic algorithm 975 can optimize the set of vehicle parameters for the state of the rider and can optimize the set of vehicle parameters for vehicle performance. In embodiments, optimizing the set of vehicle parameters is responsive to the genetic algorithm 975 identifying at least one of a favorable vehicle operating state, and favorable vehicle performance that maintains the rider state 937. In embodiments, the artificial intelligence system 936 further includes a neural network selected from a plurality of different neural networks. In embodiments, the selection of the neural network involves the genetic algorithm 975. In embodiments, the selection of the neural network is based on a structured competition among the plurality of different neural networks. In embodiments, the genetic algorithm 975 facilitates training a neural network to process interactions among a plurality of vehicle operating systems and riders to produce the optimized set of vehicle parameters.

In embodiments, a set of inputs relating to at least one vehicle parameter are provided by at least one of an on-board diagnostic system, a telemetry system, a vehicle-located sensor, and a system external to the vehicle. In embodiments, the inputs representative of the rider state 937 comprise at least one of comfort, emotional state, satisfaction, goals, classification of trip, or fatigue. In embodiments, the inputs representative of the rider state 937 reflect a satisfaction parameter of at least one of a driver, a fleet manager, an advertiser, a merchant, an owner, an operator, an insurer, and a regulator. In embodiments, the inputs representative of the rider state 937 comprise inputs relating to a user that, when processed with a cognitive system yield the rider state 937.

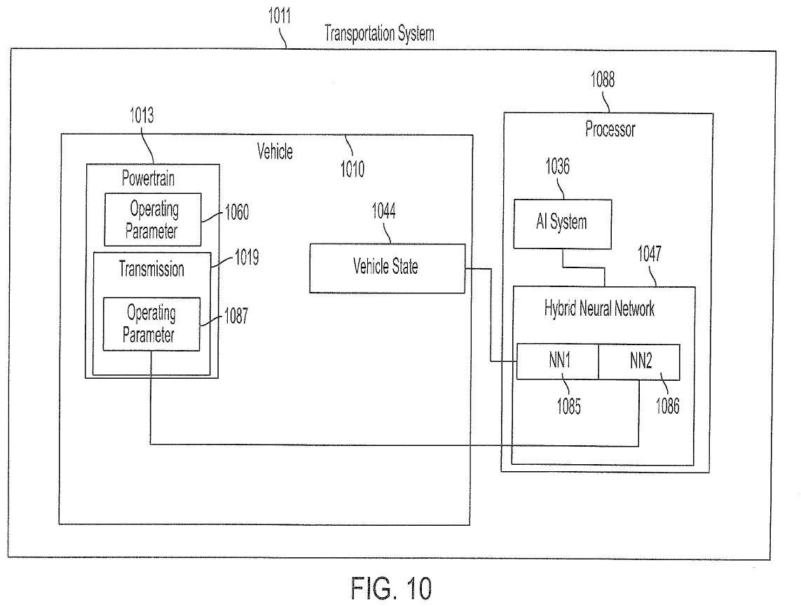

Referring to FIG. 10, in embodiments provided herein are systems for transportation 1011 having a hybrid neural network 1047 for optimizing the operating state of a continuously variable powertrain 1013 of a vehicle 1010. In embodiments, at least one part of the hybrid neural network 1047 operates to classify a state of the vehicle 1010 and another part of the hybrid neural network 1047 operates to optimize at least one operating parameter 1087 of the transmission 1019. In embodiments, the vehicle 1010 may be a self-driving vehicle. In an example, the first portion 1085 of the hybrid neural network may classify the vehicle 1010 as operating in a high-traffic state (such as by use of LIDAR, RADAR, or the like that indicates the presence of other vehicles, or by taking input from a traffic monitoring system, or by detecting the presence of a high density of mobile devices, or the like) and a bad weather state (such as by taking inputs indicating wet roads (such as using vision-based systems), precipitation (such as determined by radar), presence of ice (such as by temperature sensing, vision-based sensing, or the like), hail (such as by impact detection, sound-sensing, or the like), lightning (such as by vision-based systems, sound-based systems, or the like), or the like. Once classified, another neural network 1086 (optionally of another type) may optimize the vehicle operating parameter based on the classified state, such as by putting the vehicle 1010 into a safe-driving mode (e.g., by providing forward-sensing alerts at greater distances and/lower speeds than in good weather, by providing automated braking earlier and more aggressively than in good weather, and the like).

An aspect provided herein includes a system for transportation 1011, comprising: a hybrid neural network 1047 for optimizing an operating state of a continuously variable powertrain 1013 of a vehicle 1010. In embodiments, a portion 1085 of the hybrid neural network 1047 is to operate to classify a state 1044 of the vehicle 1010 thereby generating a classified state of the vehicle, and another neural network 1086 portion of the hybrid neural network 1047 is to operate to optimize at least one operating parameter 1060 of a transmission 1019 portion of the continuously variable powertrain 1013.

In embodiments, the system for transportation 1011 further comprises: an artificial intelligence system 1036 operative on at least one processor 1088, the artificial intelligence system 1036 to operate the portion 1085 of the hybrid neural network 1047 to operate to classify the state of the vehicle and the artificial intelligence system 1036 to operate the other neural network 1086 portion of the hybrid neural network 1047 to optimize the at least one operating parameter 1087 of the transmission 1019 portion of the continuously variable powertrain 1013 based on the classified state of the vehicle. In embodiments, the vehicle 1010 comprises a system for automating at least one control parameter of the vehicle. In embodiments, the vehicle 1010 is at least a semi-autonomous vehicle. In embodiments, the vehicle 1010 is to be automatically routed. In embodiments, the vehicle 1010 is a self-driving vehicle. In embodiments, the classified state of the vehicle is: a vehicle maintenance state; a vehicle health state; a vehicle operating state; a vehicle energy utilization state; a vehicle charging state; a vehicle satisfaction state; a vehicle component state; a vehicle sub-system state; a vehicle powertrain system state; a vehicle braking system state; a vehicle clutch system state; a vehicle lubrication system state; a vehicle transportation infrastructure system state; or a vehicle rider state. In embodiments, at least a portion of the hybrid neural network 1047 is a convolutional neural network.

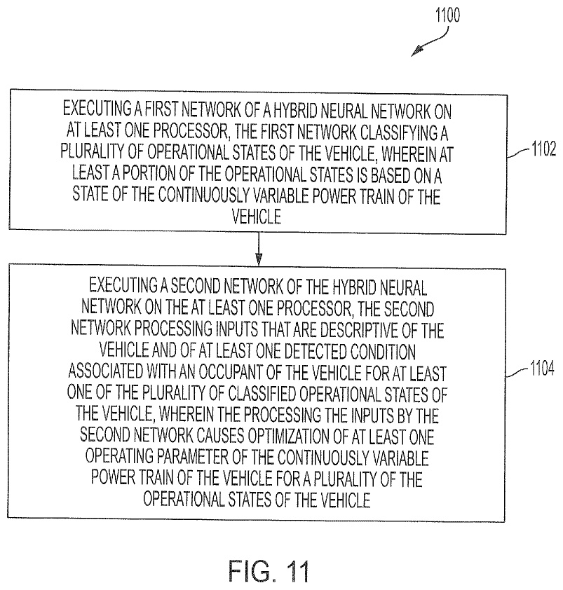

FIG. 11 illustrates a method 1100 for optimizing operation of a continuously variable vehicle powertrain of a vehicle in accordance with embodiments of the systems and methods disclosed herein. At 1102, the method includes executing a first network of a hybrid neural network on at least one processor, the first network classifying a plurality of operational states of the vehicle. In embodiments, at least a portion of the operational states is based on a state of the continuously variable powertrain of the vehicle. At 1104, the method includes executing a second network of the hybrid neural network on the at least one processor, the second network processing inputs that are descriptive of the vehicle and of at least one detected condition associated with an occupant of the vehicle for at least one of the plurality of classified operational states of the vehicle. In embodiments, the processing of the inputs by the second network can cause optimization of at least one operating parameter of the continuously variable powertrain of the vehicle for a plurality of the operational states of the vehicle.

Referring to FIG. 10 and FIG. 11 together, in embodiments, the vehicle comprises an artificial intelligence system 1036, the method further comprising automating at least one control parameter of the vehicle by the artificial intelligence system 1036. In embodiments, the vehicle 1010 is at least a semi-autonomous vehicle. In embodiments, the vehicle 1010 is to be automatically routed. In embodiments, the vehicle 1010 is a self-driving vehicle. In embodiments, the method further comprises optimizing, by the artificial intelligence system 1036, an operating state of the continuously variable powertrain 1013 of the vehicle based on the optimized at least one operating parameter 1060 of the continuously variable powertrain 1013 by adjusting at least one other operating parameter 1087 of a transmission 1019 portion of the continuously variable powertrain 1013.

In embodiments, the method further comprises optimizing, by the artificial intelligence system 1036, the operating state of the continuously variable powertrain 1013 by processing social data from a plurality of social data sources. In embodiments, the method further comprises optimizing, by the artificial intelligence system 1036, the operating state of the continuously variable powertrain 1013 by processing data sourced from a stream of data from unstructured data sources. In embodiments, the method further comprises optimizing, by the artificial intelligence system 1036, the operating state of the continuously variable powertrain 1013 by processing data sourced from wearable devices. In embodiments, the method further comprises optimizing, by the artificial intelligence system 1036, the operating state of the continuously variable powertrain 1013 by processing data sourced from in-vehicle sensors. In embodiments, the method further comprises optimizing, by the artificial intelligence system 1036, the operating state of the continuously variable powertrain 1013 by processing data sourced from a rider helmet.

In embodiments, the method further comprises optimizing, by the artificial intelligence system 1036, the operating state of the continuously variable powertrain 1013 by processing data sourced from rider headgear. In embodiments, the method further comprises optimizing, by the artificial intelligence system 1036, the operating state of the continuously variable powertrain 1013 by processing data sourced from a rider voice system. In embodiments, the method further comprises operating, by the artificial intelligence system 1036, a third network of the hybrid neural network 1047 to predict a state of the vehicle based at least in part on at least one of the classified plurality of operational states of the vehicle and at least one operating parameter of the transmission 1019. In embodiments, the first network of the hybrid neural network 1047 comprises a structure-adaptive network to adapt a structure of the first network responsive to a result of operating the first network of the hybrid neural network 1047. In embodiments, the first network of the hybrid neural network 1047 is to process a plurality of social data from social data sources to classify the plurality of operational states of the vehicle.

In embodiments, at least a portion of the hybrid neural network 1047 is a convolutional neural network. In embodiments, at least one of the classified plurality of operational states of the vehicle is: a vehicle maintenance state; or a vehicle health state. In embodiments, at least one of the classified states of the vehicle is: a vehicle operating state; a vehicle energy utilization state; a vehicle charging state; a vehicle satisfaction state; a vehicle component state; a vehicle sub-system state; a vehicle powertrain system state; a vehicle braking system state; a vehicle clutch system state; a vehicle lubrication system state; or a vehicle transportation infrastructure system state. In embodiments, the at least one of classified states of the vehicle is a vehicle driver state. In embodiments, the at least one of classified states of the vehicle is a vehicle rider state.

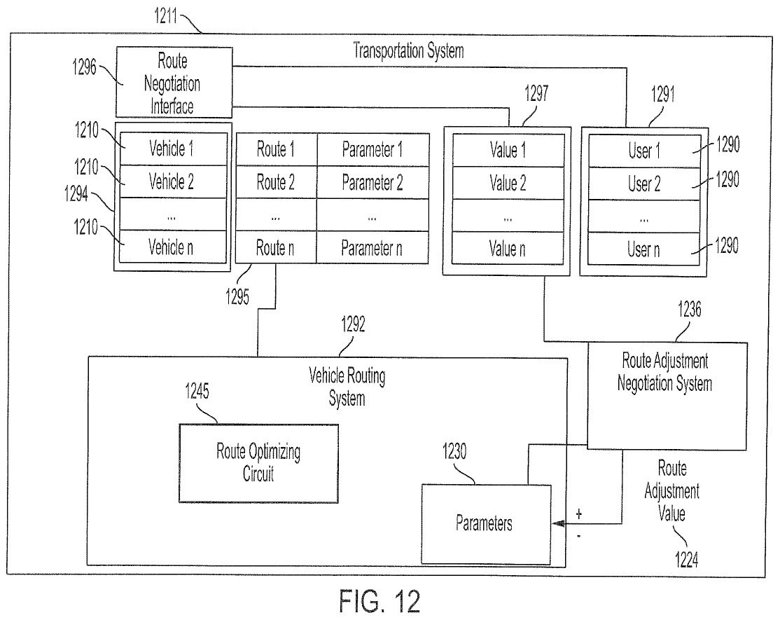

Referring to FIG. 12, in embodiments, provided herein are transportation systems 1211 having a cognitive system for routing at least one vehicle 1210 within a set of vehicles 1294 based on a routing parameter determined by facilitating negotiation among a designated set of vehicles. In embodiments, negotiation accepts inputs relating to the value attributed by at least one rider to at least one parameter 1230 of a route 1295. A user 1290 may express value by a user interface that rates one or more parameters (e.g., any of the parameters noted throughout), by behavior (e.g., undertaking behavior that reflects or indicates value ascribed to arriving on time, following a given route 1295, or the like), or by providing or offering value (e.g., offering currency, tokens, points, cryptocurrency, rewards, or the like). For example, a user 1290 may negotiate for a preferred route by offering tokens to the system that are awarded if the user 1290 arrives at a designated time, while others may offer to accept tokens in exchange for taking alternative routes (and thereby reducing congestion). Thus, an artificial intelligence system may optimize a combination of offers to provide rewards or to undertake behavior in response to rewards, such that the reward system optimizes a set of outcomes. Negotiation may include explicit negotiation, such as where a driver offers to reward drivers ahead of the driver on the road in exchange for their leaving the route temporarily as the driver passes.

An aspect provided herein includes a transportation system 1211, comprising: a cognitive system for routing at least one vehicle 1210 within a set of vehicles 1294 based on a routing parameter determined by facilitating a negotiation among a designated set of vehicles, wherein the negotiation accepts inputs relating to a value attributed by at least one user 1290 to at least one parameter of a route 1295.

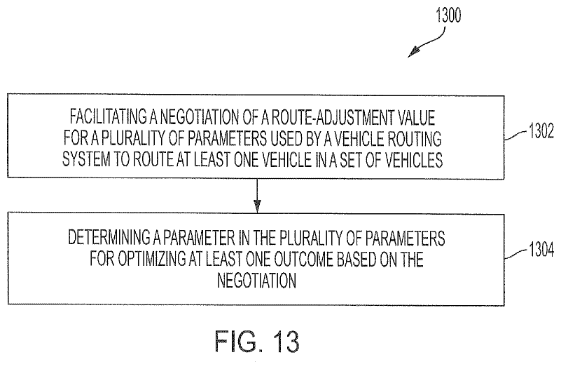

FIG. 13 illustrates a method 1300 of negotiation-based vehicle routing in accordance with embodiments of the systems and methods disclosed herein. At 1302, the method includes facilitating a negotiation of a route-adjustment value for a plurality of parameters used by a vehicle routing system to route at least one vehicle in a set of vehicles. At 1304, the method includes determining a parameter in the plurality of parameters for optimizing at least one outcome based on the negotiation.

Referring to FIG. 12 and FIG. 13, in embodiments, a user 1290 is an administrator for a set of roadways to be used by the at least one vehicle 1210 in the set of vehicles 1294. In embodiments, a user 1290 is an administrator for a fleet of vehicles including the set of vehicles 1294. In embodiments, the method further comprises offering a set of offered user-indicated values for the plurality of parameters 1230 to users 1290 with respect to the set of vehicles 1294. In embodiments, the route-adjustment value 1224 is based at least in part on the set of offered user-indicated values 1297. In embodiments, the route-adjustment value 1224 is further based on at least one user response to the offering. In embodiments, the route-adjustment value 1224 is based at least in part on the set of offered user-indicated values 1297 and at least one response thereto by at least one user of the set of vehicles 1294. In embodiments, the determined parameter facilitates adjusting a route 1295 of at least one of the vehicles 1210 in the set of vehicles 1294. In embodiments, adjusting the route includes prioritizing the determined parameter for use by the vehicle routing system.

In embodiments, the facilitating negotiation includes facilitating negotiation of a price of a service. In embodiments, the facilitating negotiation includes facilitating negotiation of a price of fuel. In embodiments, the facilitating negotiation includes facilitating negotiation of a price of recharging. In embodiments, the facilitating negotiation includes facilitating negotiation of a reward for taking a routing action.

An aspect provided herein includes a transportation system 1211 for negotiation-based vehicle routing comprising: a route adjustment negotiation system 1236 through which users 1290 in a set of users 1291 negotiate a route-adjustment value 1224 for at least one of a plurality of parameters 1230 used by a vehicle routing system 1292 to route at least one vehicle 1210 in a set of vehicles 1294; and a user route optimizing circuit 1245 to optimize a portion of a route 1295 of at least one user 1290 of the set of vehicles 1294 based on the route-adjustment value 1224 for the at least one of the plurality of parameters 1230. In embodiments, the route-adjustment value 1224 is based at least in part on user-indicated values 1297 and at least one negotiation response thereto by at least one user of the set of vehicles 1294. In embodiments, the transportation system 1211 further comprises a vehicle-based route negotiation interface 1296 through which user-indicated values 1297 for the plurality of parameters 1230 used by the vehicle routing system are captured. In embodiments, a user 1290 is a rider of the at least one vehicle 1210. In embodiments, a user 1290 is an administrator for a set of roadways to be used by the at least one vehicle 1210 in the set of vehicles 1294.

In embodiments, a user 1290 is an administrator for a fleet of vehicles including the set of vehicles 1294. In embodiments, the at least one of the plurality of parameters 1230 facilitates adjusting a route 1295 of the at least one vehicle 1210. In embodiments, adjusting the route 1295 includes prioritizing a determined parameter for use by the vehicle routing system. In embodiments, at least one of the user-indicated values 1297 is attributed to at least one of the plurality of parameters 1230 through an interface to facilitate expression of rating one or more route parameters. In embodiments, the vehicle-based route negotiation interface facilitates expression of rating one or more route parameters. In embodiments, the user-indicated values 1297 are derived from a behavior of the user 1290. In embodiments, the vehicle-based route negotiation interface facilitates converting user behavior to the user-indicated values 1297. In embodiments, the user behavior reflects value ascribed to the at least one parameter used by the vehicle routing system to influence a route 1295 of at least one vehicle 1210 in the set of vehicles 1294. In embodiments, the user-indicated value indicated by at least one user 1290 correlates to an item of value provided by the user 1290. In embodiments, the item of value is provided by the user 1290 through an offering of the item of value in exchange for a result of routing based on the at least one parameter. In embodiments, the negotiating of the route-adjustment value 1224 includes offering an item of value to the users of the set of vehicles 1294.

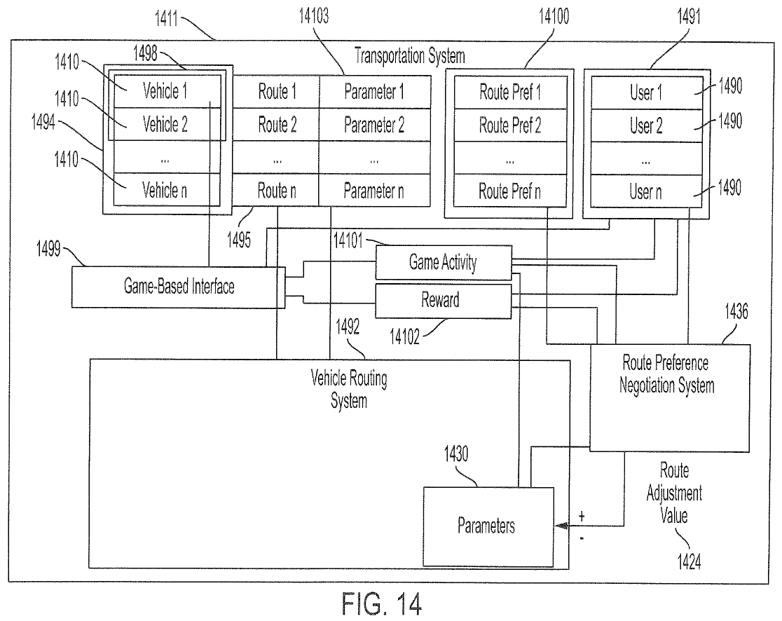

Referring to FIG. 14, in embodiments provided herein are transportation systems 1411 having a cognitive system for routing at least one vehicle 1410 within a set of vehicles 1494 based on a routing parameter determined by facilitating coordination among a designated set of vehicles 1498. In embodiments, the coordination is accomplished by taking at least one input from at least one game-based interface 1499 for riders of the vehicles. A game-based interface 1499 may include rewards for undertaking game-like actions (i.e., game activities 14101) that provide an ancillary benefit. For example, a rider in a vehicle 1410 may be rewarded for routing the vehicle 1410 to a point of interest off a highway (such as to collect a coin, to capture an item, or the like), while the rider's departure clears space for other vehicles that are seeking to achieve other objectives, such as on-time arrival. For example, a game like Pokemon Go™ may be configured to indicate the presence of rare Pokemon™ creatures in locations that attract traffic away from congested locations. Others may provide rewards (e.g., currency, cryptocurrency or the like) that may be pooled to attract users 1490 away from congested roads.

An aspect provided herein includes a transportation system 1411, comprising: a cognitive system for routing at least one vehicle 1410 within a set of vehicles 1494 based on a set of routing parameters 1430 determined by facilitating coordination among a designated set of vehicles 1498, wherein the coordination is accomplished by taking at least one input from at least one game-based interface 1499 for a user 1490 of users 1491 of a vehicle 1410 in the designated set of vehicles 1498.

In embodiments, the system for transportation further comprises: a vehicle routing system 1492 to route the at least one vehicle 1410 based on the set of routing parameters 1430; and the game-based interface 1499 through which the user 1490 indicates a routing preference 14100 for at least one vehicle 1410 within the set of vehicles 1494 to undertake a game activity 14101 offered in the game-based interface 1499; wherein the game-based interface 1499 is to induce the user 1490 to undertake a set of favorable routing choices based on the set of routing parameters 1430. As used herein, “to route” means to select a route 1495.

In embodiments, the vehicle routing system 1492 accounts for the routing preference 14100 of the user 1490 when routing the at least one vehicle 1410 within the set of vehicles 1494. In embodiments, the game-based interface 1499 is disposed for in-vehicle use as indicated in FIG. 14 by the line extending from the Game-Based Interface into the box for Vehicle 1. In embodiments, the user 1490 is a rider of the at least one vehicle 1410. In embodiments, the user 1490 is an administrator for a set of roadways to be used by the at least one vehicle 1410 in the set of vehicles 1494. In embodiments, the user 1490 is an administrator for a fleet of vehicles including the set of vehicles 1494. In embodiments, the set of routing parameters 1430 includes at least one of traffic congestion, desired arrival times, preferred routes, fuel efficiency, pollution reduction, accident avoidance, avoiding bad weather, avoiding bad road conditions, reduced fuel consumption, reduced carbon footprint, reduced noise in a region, avoiding high-crime regions, collective satisfaction, maximum speed limit, avoidance of toll roads, avoidance of city roads, avoidance of undivided highways, avoidance of left turns, avoidance of driver-operated vehicles. In embodiments, the game activity 14101 offered in the game-based interface 1499 includes contests. In embodiments, the game activity 14101 offered in the game-based interface 1499 includes entertainment games.

In embodiments, the game activity 14101 offered in the game-based interface 1499 includes competitive games. In embodiments, the game activity 14101 offered in the game-based interface 1499 includes strategy games. In embodiments, the game activity 14101 offered in the game-based interface 1499 includes scavenger hunts. In embodiments, the set of favorable routing choices is configured so that the vehicle routing system 1492 achieves a fuel efficiency objective. In embodiments, the set of favorable routing choices is configured so that the vehicle routing system 1492 achieves a reduced traffic objective. In embodiments, the set of favorable routing choices is configured so that the vehicle routing system 1492 achieves a reduced pollution objective. In embodiments, the set of favorable routing choices is configured so that the vehicle routing system 1492 achieves a reduced carbon footprint objective.

In embodiments, the set of favorable routing choices is configured so that the vehicle routing system 1492 achieves a reduced noise in neighborhoods objective. In embodiments, the set of favorable routing choices is configured so that the vehicle routing system 1492 achieves a collective satisfaction objective. In embodiments, the set of favorable routing choices is configured so that the vehicle routing system 1492 achieves an avoiding accident scenes objective. In embodiments, the set of favorable routing choices is configured so that the vehicle routing system 1492 achieves an avoiding high-crime areas objective. In embodiments, the set of favorable routing choices is configured so that the vehicle routing system 1492 achieves a reduced traffic congestion objective. In embodiments, the set of favorable routing choices is configured so that the vehicle routing system 1492 achieves a bad weather avoidance objective.

In embodiments, the set of favorable routing choices is configured so that the vehicle routing system 1492 achieves a maximum travel time objective. In embodiments, the set of favorable routing choices is configured so that the vehicle routing system 1492 achieves a maximum speed limit objective. In embodiments, the set of favorable routing choices is configured so that the vehicle routing system 1492 achieves an avoidance of toll road's objective. In embodiments, the set of favorable routing choices is configured so that the vehicle routing system 1492 achieves an avoidance of city road's objective. In embodiments, the set of favorable routing choices is configured so that the vehicle routing system 1492 achieves an avoidance of undivided highway's objective. In embodiments, the set of favorable routing choices is configured so that the vehicle routing system 1492 achieves an avoidance of left turns objective. In embodiments, the set of favorable routing choices is configured so that the vehicle routing system 1492 achieves an avoidance of driver-operated vehicles objective.

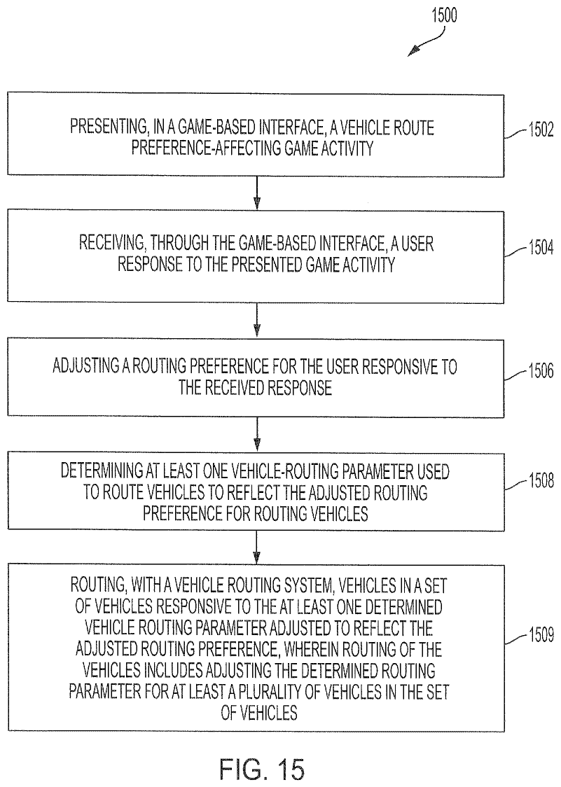

FIG. 15 illustrates a method 1500 of game-based coordinated vehicle routing in accordance with embodiments of the systems and methods disclosed herein. At 1502, the method includes presenting, in a game-based interface, a vehicle route preference-affecting game activity. At 1504, the method includes receiving, through the game-based interface, a user response to the presented game activity. At 1506, the method includes adjusting a routing preference for the user responsive to the received response. At 1508, the method includes determining at least one vehicle-routing parameter used to route vehicles to reflect the adjusted routing preference for routing vehicles. At 1509, the method includes routing, with a vehicle routing system, vehicles in a set of vehicles responsive to the at least one determined vehicle routing parameter adjusted to reflect the adjusted routing preference, wherein routing of the vehicles includes adjusting the determined routing parameter for at least a plurality of vehicles in the set of vehicles.

Referring to FIG. 14 and FIG. 15, in embodiments, the method further comprises indicating, by the game-based interface 1499, a reward value 14102 for accepting the game activity 14101. In embodiments, the game-based interface 1499 further comprises a routing preference negotiation system 1436 for a rider to negotiate the reward value 14102 for accepting the game activity 14101. In embodiments, the reward value 14102 is a result of pooling contributions of value from riders in the set of vehicles. In embodiments, at least one routing parameter 1430 used by the vehicle routing system 1492 to route the vehicles 1410 in the set of vehicles 1494 is associated with the game activity 14101 and a user acceptance of the game activity 14101 adjusts (e.g., by the routing adjustment value 1424) the at least one routing parameter 1430 to reflect the routing preference. In embodiments, the user response to the presented game activity 14101 is derived from a user interaction with the game-based interface 1499. In embodiments, the at least one routing parameter used by the vehicle routing system 1492 to route the vehicles 1410 in the set of vehicles 1494 includes at least one of: traffic congestion, desired arrival times, preferred routes, fuel efficiency, pollution reduction, accident avoidance, avoiding bad weather, avoiding bad road conditions, reduced fuel consumption, reduced carbon footprint, reduced noise in a region, avoiding high-crime regions, collective satisfaction, maximum speed limit, avoidance of toll roads, avoidance of city roads, avoidance of undivided highways, avoidance of left turns, and avoidance of driver-operated vehicles.

In embodiments, the game activity 14101 presented in the game-based interface 1499 includes contests. In embodiments, the game activity 14101 presented in the game-based interface 1499 includes entertainment games. In embodiments, the game activity 14101 presented in the game-based interface 1499 includes competitive games. In embodiments, the game activity 14101 presented in the game-based interface 1499 includes strategy games. In embodiments, the game activity 14101 presented in the game-based interface 1499 includes scavenger hunts. In embodiments, the routing responsive to the at least one determined vehicle routing parameter 14103 achieves a fuel efficiency objective. In embodiments, the routing responsive to the at least one determined vehicle routing parameter 14103 achieves a reduced traffic objective.

In embodiments, the routing responsive to the at least one determined vehicle routing parameter 14103 achieves a reduced pollution objective. In embodiments, the routing responsive to the at least one determined vehicle routing parameter 14103 achieves a reduced carbon footprint objective. In embodiments, the routing responsive to the at least one determined vehicle routing parameter 14103 achieves a reduced noise in neighborhoods objective. In embodiments, the routing responsive to the at least one determined vehicle routing parameter 14103 achieves a collective satisfaction objective. In embodiments, the routing responsive to the at least one determined vehicle routing parameter 14103 achieves an avoiding accident scene's objective. In embodiments, the routing responsive to the at least one determined vehicle routing parameter 14103 achieves an avoiding high-crime areas objective. In embodiments, the routing responsive to the at least one determined vehicle routing parameter 14103 achieves a reduced traffic congestion objective.

In embodiments, the routing responsive to the at least one determined vehicle routing parameter 14103 achieves a bad weather avoidance objective. In embodiments, the routing responsive to the at least one determined vehicle routing parameter 14103 achieves a maximum travel time objective. In embodiments, the routing responsive to the at least one determined vehicle routing parameter 14103 achieves a maximum speed limit objective. In embodiments, the routing responsive to the at least one determined vehicle routing parameter 14103 achieves an avoidance of toll road's objective. In embodiments, the routing responsive to the at least one determined vehicle routing parameter 14103 achieves an avoidance of city road's objective. In embodiments, the routing responsive to the at least one determined vehicle routing parameter 14103 achieves an avoidance of undivided highway's objective. In embodiments, the routing responsive to the at least one determined vehicle routing parameter 14103 achieves an avoidance of left turns objective. In embodiments, the routing responsive to the at least one determined vehicle routing parameter 14103 achieves an avoidance of driver-operated vehicles objective.

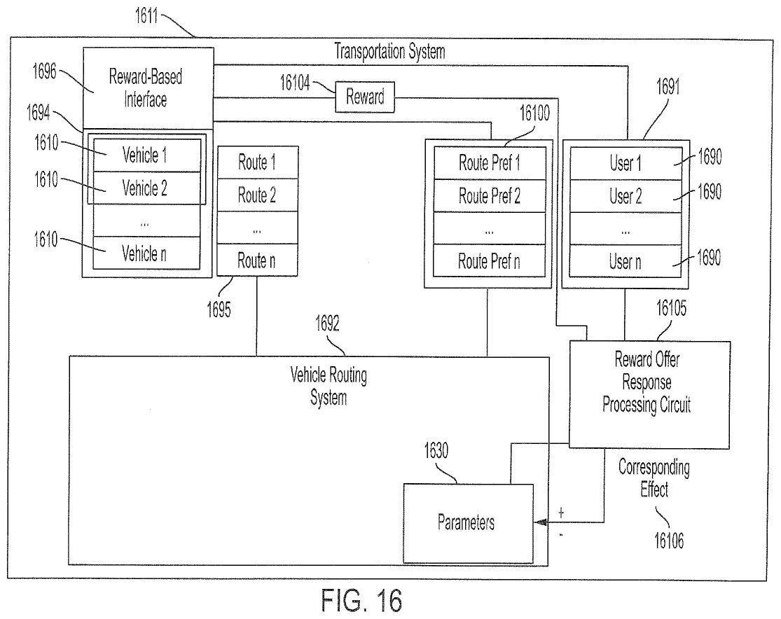

Referring to FIG. 16, in embodiments, provided herein are transportation systems 1611 having a cognitive system for routing at least one vehicle, wherein the routing is determined at least in part by processing at least one input from a rider interface wherein a rider can obtain a reward 16102 by undertaking an action while in the vehicle. In embodiments, the rider interface may display a set of available rewards for undertaking various actions, such that the rider may select (such as by interacting with a touch screen or audio interface), a set of rewards to pursue, such as by allowing a navigation system of the vehicle (or of a ride-share system of which the user 1690 has at least partial control) or a routing system 1692 of a self-driving vehicle to use the actions that result in rewards to govern routing. For example, selection of a reward for attending a site may result in sending a signal to a navigation or routing system 1692 to set an intermediate destination at the site. As another example, indicating a willingness to watch a piece of content may cause a routing system 1692 to select a route that permits adequate time to view or hear the content.

An aspect provided herein includes a transportation system 1611, comprising: a cognitive system for routing at least one vehicle 1610, wherein the routing is based, at least in part, by processing at least one input from a rider interface, wherein a reward 16102 is made available to a rider in response to the rider undertaking a predetermined action while in the at least one vehicle 1610.

An aspect provided herein includes a transportation system 1611 for reward-based coordinated vehicle routing comprising: a reward-based interface 1696 to offer a reward 16102 and through which a user 1690 of users 1691 related to a set of vehicles 1694 indicates a routing preference of the user 1690 related to the reward 16102 by responding to the reward 16102 offered in the reward-based interface 1696; a reward offer response processing circuit 16105 to determine at least one user action resulting from the user response to the reward 16102 and to determine a corresponding effect 16106 on at least one routing parameter 1630; and a vehicle routing system 1692 to use the routing preference 16100 of the user 1690 and the corresponding effect on the at least one routing parameter to govern routing of the set of vehicles 1694.

In embodiments, the user 1690 is a rider of at least one vehicle 1610 in the set of vehicles 1694. In embodiments, the user 1690 is an administrator for a set of roadways to be used by at least one vehicle 1610 in the set of vehicles 1694. In embodiments, the user 1690 is an administrator for a fleet of vehicles including the set of vehicles 1694. In embodiments, the reward-based interface 1696 is disposed for in-vehicle use. In embodiments, the at least one routing parameter 1630 includes at least one of: traffic congestion, desired arrival times, preferred routes, fuel efficiency, pollution reduction, accident avoidance, avoiding bad weather, avoiding bad road conditions, reduced fuel consumption, reduced carbon footprint, reduced noise in a region, avoiding high-crime regions, collective satisfaction, maximum speed limit, avoidance of toll roads, avoidance of city roads, avoidance of undivided highways, avoidance of left turns, and avoidance of driver-operated vehicles. In embodiments, the vehicle routing system 1692 is to use the routing preference of the user 1690 and the corresponding effect on the at least one routing parameter to govern routing of the set of vehicles to achieve a fuel efficiency objective. In embodiments, the vehicle routing system 1692 is to use the routing preference of the user 1690 and the corresponding effect on the at least one routing parameter to govern routing of the set of vehicles to achieve a reduced traffic objective. In embodiments, the vehicle routing system 1692 is to use the routing preference of the user 1690 and the corresponding effect on the at least one routing parameter to govern routing of the set of vehicles to achieve' a reduced pollution objective. In embodiments, the vehicle routing system 1692 is to use the routing preference of the user 1690 and the corresponding effect on the at least one routing parameter to govern routing of the set of vehicles to achieve a reduced carbon footprint objective.

In embodiments, the vehicle routing system 1692 is to use the routing preference of the user 1690 and the corresponding effect on the at least one routing parameter to govern routing of the set of vehicles to achieve a reduced noise in neighborhoods objective. In embodiments, the vehicle routing system 1692 is to use the routing preference of the user 1690 and the corresponding effect on the at least one routing parameter to govern routing of the set of vehicles to achieve a collective satisfaction objective. In embodiments, the vehicle routing system 1692 is to use the routing preference of the user 1690 and the corresponding effect on the at least one routing parameter to govern routing of the set of vehicles to achieve' an avoiding accident scenes objective. In embodiments, the vehicle routing system 1692 is to use the routing preference of the user 1690 and the corresponding effect on the at least one routing parameter to govern routing of the set of vehicles to achieve an avoiding high-crime areas objective. In embodiments, the vehicle routing system 1692 is to use the routing preference of the user 1690 and the corresponding effect on the at least one routing parameter to govern routing of the set of vehicles to achieve a reduced traffic congestion objective.

In embodiments, the vehicle routing system 1692 is to use the routing preference of the user 1690 and the corresponding effect on the at least one routing parameter to govern routing of the set of vehicles to achieve a bad weather avoidance objective. In embodiments, the vehicle routing system 1692 is to use the routing preference of the user 1690 and the corresponding effect on the at least one routing parameter to govern routing of the set of vehicles to achieve a maximum travel time objective. In embodiments, the vehicle routing system 1692 is to use the routing preference of the user 1690 and the corresponding effect on the at least one routing parameter to govern routing of the set of vehicles to achieve a maximum speed limit objective. In embodiments, the vehicle routing system 1692 is to use the routing preference of the user 1690 and the corresponding effect on the at least one routing parameter to govern routing of the set of vehicles to achieve an avoidance of toll road's objective. In embodiments, the vehicle routing system 1692 is to use the routing preference of the user 1690 and the corresponding effect on the at least one routing parameter to govern routing of the set of vehicles to achieve an avoidance of city road's objective.

In embodiments, the vehicle routing system 1692 is to use the routing preference of the user 1690 and the corresponding effect on the at least one routing parameter to govern routing of the set of vehicles to achieve an avoidance of undivided highway's objective. In embodiments, the vehicle routing system 1692 is to use the routing preference of the user 1690 and the corresponding effect on the at least one routing parameter to govern routing of the set of vehicles to achieve an avoidance of left turns objective. In embodiments, the vehicle routing system 1692 is to use the routing preference of the user 1690 and the corresponding effect on the at least one routing parameter to govern routing of the set of vehicles to achieve an avoidance of driver-operated vehicles objective.

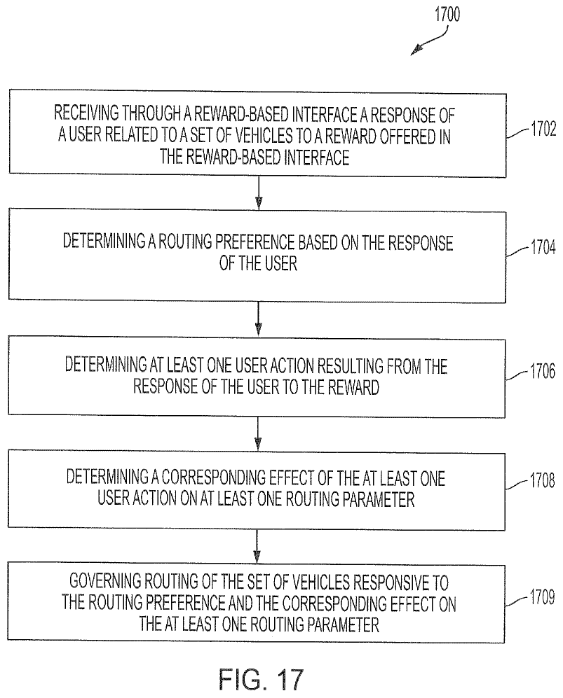

FIG. 17 illustrates a method 1700 of reward-based coordinated vehicle routing in accordance with embodiments of the systems and methods disclosed herein. At 1702, the method includes receiving through a reward-based interface a response of a user related to a set of vehicles to a reward offered in the reward-based interface. At 1704, the method includes determining a routing preference based on the response of the user. At 1706, the method includes determining at least one user action resulting from the response of the user to the reward. At 1708, the method includes determining a corresponding effect of the at least one user action on at least one routing parameter. At 1709, the method includes governing routing of the set of vehicles responsive to the routing preference and the corresponding effect on the at least one routing parameter.

In embodiments, the user 1690 is a rider of at least one vehicle 1610 in the set of vehicles 1694. In embodiments, the user 1690 is an administrator for a set of roadways to be used by at least one vehicle 1610 in the set of vehicles 1694. In embodiments, the user 1690 is an administrator for a fleet of vehicles including the set of vehicles 1694.

In embodiments, the reward-based interface 1696 is disposed for in-vehicle use. In embodiments, the at least one routing parameter 1630 includes at least one of: traffic congestion, desired arrival times, preferred routes, fuel efficiency, pollution reduction, accident avoidance, avoiding bad weather, avoiding bad road conditions, reduced fuel consumption, reduced carbon footprint, reduced noise in a region, avoiding high-crime regions, collective satisfaction, maximum speed limit, avoidance of toll roads, avoidance of city roads, avoidance of undivided highways, avoidance of left turns, and avoidance of driver-operated vehicles. In embodiments, the user 1690 responds to the reward 16102 offered in the reward-based interface 1696 by accepting the reward 16102 offered in the interface, rejecting the reward 16102 offered in the reward-based interface 1696, or ignoring the reward 16102 offered in the reward-based interface 1696. In embodiments, the user 1690 indicates the routing preference by either accepting or rejecting the reward 16102 offered in the reward-based interface 1696. In embodiments, the user 1690 indicates the routing preference by undertaking an action in at least one vehicle 1610 in the set of vehicles 1694 that facilitates transferring the reward 16102 to the user 1690.

In embodiments, the method further comprises sending, via a reward offer response processing circuit 16105, a signal to the vehicle routing system 1692 to select a vehicle route that permits adequate time for the user 1690 to perform the at least one user action. In embodiments, the method further comprises: sending, via a reward offer response processing circuit 16105, a signal to a vehicle routing system 1692, the signal indicating a destination of a vehicle associated with the at least one user action; and adjusting, by the vehicle routing system 1692, a route of the vehicle 1695 associated with the at least one user action to include the destination. In embodiments, the reward 16102 is associated with achieving a vehicle routing fuel efficiency objective.

In embodiments, the reward 16102 is associated with achieving a vehicle routing reduced traffic objective. In embodiments, the reward 16102 is associated with achieving a vehicle routing reduced pollution objective. In embodiments, the reward 16102 is associated with achieving a vehicle routing reduced carbon footprint objective. In embodiments, the reward 16102 is associated with achieving a vehicle routing reduced noise in neighborhoods objective. In embodiments, reward 16102 is associated with achieving a vehicle routing collective satisfaction objective. In embodiments, the reward 16102 is associated with achieving a vehicle routing avoiding accident scene's objective.

In embodiments, the reward 16102 is associated with achieving a vehicle routing avoiding high-crime areas objective. In embodiments, the reward 16102 is associated with achieving a vehicle routing reduced traffic congestion objective. In embodiments, the reward 16102 is associated with achieving a vehicle routing bad weather avoidance objective. In embodiments, the reward 16102 is associated with achieving a vehicle routing maximum travel time objective. In embodiments, the reward 16102 is associated with achieving a vehicle routing maximum speed limit objective. In embodiments, the reward 16102 is associated with achieving a vehicle routing avoidance of toll road's objective. In embodiments, the reward 16102 is associated with achieving a vehicle routing avoidance of city road's objective. In embodiments, the reward 16102 is associated with achieving a vehicle routing avoidance of undivided highway's objective. In embodiments, the reward 16102 is associated with achieving a vehicle routing avoidance of left turns objective. In embodiments, the reward 16102 is associated with achieving a vehicle routing avoidance of driver-operated vehicles objective.

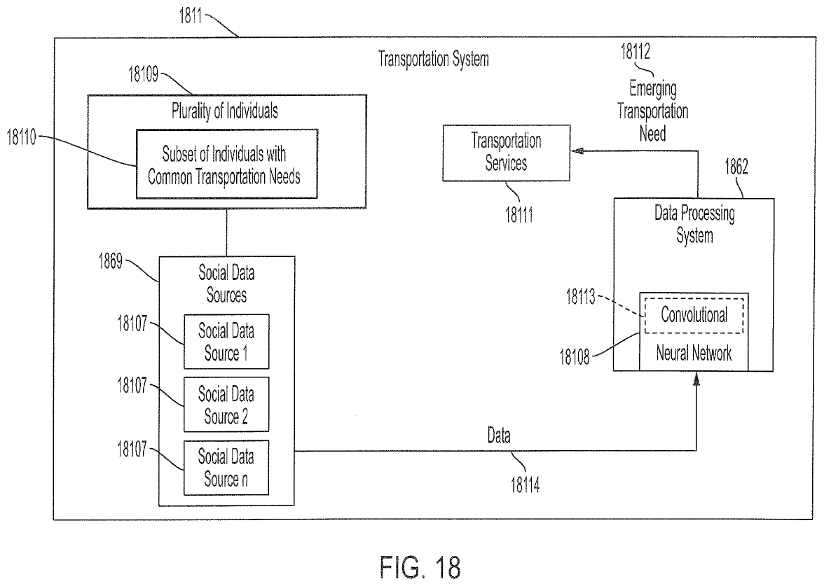

Referring to FIG. 18, in embodiments provided herein are transportation systems 1811 having a data processing system 1862 for taking data 18114 from a plurality 1869 of social data sources 18107 and using a neural network 18108 to predict an emerging transportation need 18112 for a group of individuals. Among the various social data sources 18107, such as those described above, a large amount of data is available relating to social groups, such as friend groups, families, workplace colleagues, club members, people having shared interests or affiliations, political groups, and others. The expert system described above can be trained, as described throughout, such as using a training data set of human predictions and/or a model, with feedback of outcomes, to predict the transportation needs of a group. For example, based on a discussion thread of a social group as indicated at least in part on a social network feed, it may become evident that a group meeting or trip will take place, and the system may (such as using location information for respective members, as well as indicators of a set of destinations of the trip), predict where and when each member would need to travel in order to participate. Based on such a prediction, the system could automatically identify and show options for travel, such as available public transportation options, flight options, ride share options, and the like. Such options may include ones by which the group may share transportation, such as indicating a route that results in picking up a set of members of the group for travel together. Social media information may include posts, tweets, comments, chats, photographs, and the like and may be processed as noted above.

An aspect provided herein includes a system 1811 for transportation, comprising: a data processing system 1862 for taking data 18114 from a plurality 1869 of social data sources 18107 and using a neural network 18108 to predict an emerging transportation need 18112 for a group of individuals 18110.

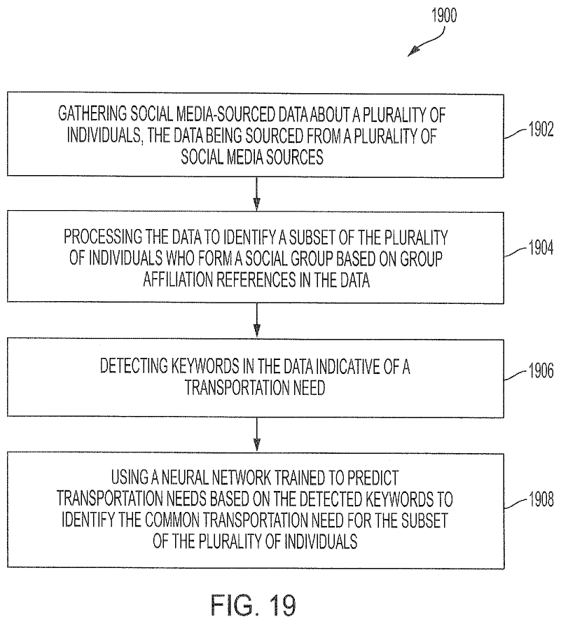

FIG. 19 illustrates a method 1900 of predicting a common transportation need for a group in accordance with embodiments of the systems and methods disclosed herein. At 1902, the method includes gathering social media-sourced data about a plurality of individuals, the data being sourced from a plurality of social media sources. At 1904, the method includes processing the data to identify a subset of the plurality of individuals who form a social group based on group affiliation references in the data. At 1906, the method includes detecting keywords in the data indicative of a transportation need. At 1908, the method includes using a neural network trained to predict transportation needs based on the detected keywords to identify the common transportation need for the subset of the plurality of individuals.

Referring to FIG. 18 and FIG. 19, in embodiments, the neural network 18108 is a convolutional neural network 18113. In embodiments, the neural network 18108 is trained based on a model that facilitates matching phrases in social media with transportation activity. In embodiments, the neural network 18108 predicts at least one of a destination and an arrival time for the subset 18110 of the plurality of individuals sharing the common transportation need. In embodiments, the neural network 18108 predicts the common transportation need based on analysis of transportation need-indicative keywords detected in a discussion thread among a portion of individuals in the social group. In embodiments, the method further comprises identifying at least one shared transportation service 18111 that facilitates a portion of the social group meeting the predicted common transportation need 18112. In embodiments, the at least one shared transportation service comprises generating a vehicle route that facilitates picking up the portion of the social group.

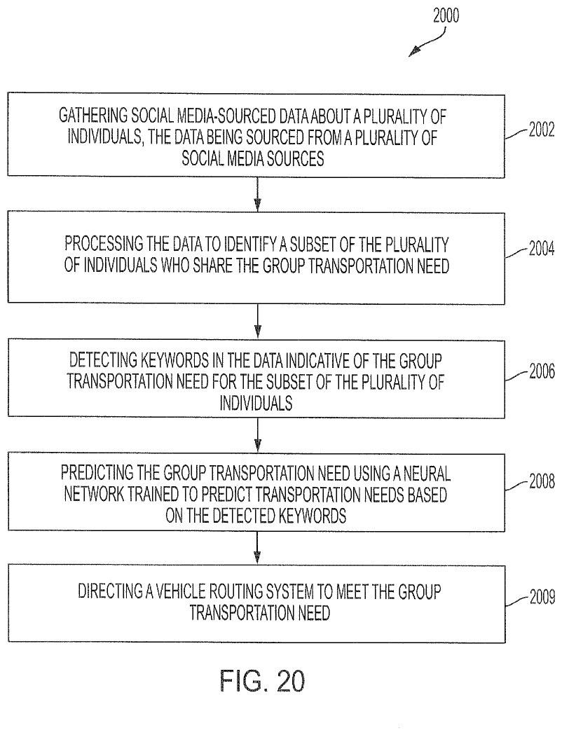

FIG. 20 illustrates a method 2000 of predicting a group transportation need for a group in accordance with embodiments of the systems and methods disclosed herein. At 2002, the method includes gathering social media-sourced data about a plurality of individuals, the data being sourced from a plurality of social media sources. At 2004, the method includes processing the data to identify a subset of the plurality of individuals who share the group transportation need. At 2006, the method includes detecting keywords in the data indicative of the group transportation need for the subset of the plurality of individuals. At 2008, the method includes predicting the group transportation need using a neural network trained to predict transportation needs based on the detected keywords. At 2009, the method includes directing a vehicle routing system to meet the group transportation need.

Referring to FIG. 18 and FIG. 20, in embodiments, the neural network 18108 is a convolutional neural network 18113. In embodiments, directing the vehicle routing system to meet the group transportation need involves routing a plurality of vehicles to a destination derived from the social media-sourced data 18114. In embodiments, the neural network 18108 is trained based on a model that facilitates matching phrases in the social media-sourced data 18114 with transportation activities. In embodiments, the method further comprises predicting, by the neural network 18108, at least one of a destination and an arrival time for the subset 18110 of the plurality 18109 of individuals sharing the group transportation need. In embodiments, the method further comprises predicting, by the neural network 18108, the group transportation need based on an analysis of transportation need-indicative keywords detected in a discussion thread in the social media-sourced data 18114. In embodiments, the method further comprises identifying at least one shared transportation service 18111 that facilitates meeting the predicted group transportation need for at least a portion of the subset 18110 of the plurality of individuals. In embodiments, the at least one shared transportation service 18111 comprises generating a vehicle route that facilitates picking up the at least the portion of the subset 18110 of the plurality of individuals.

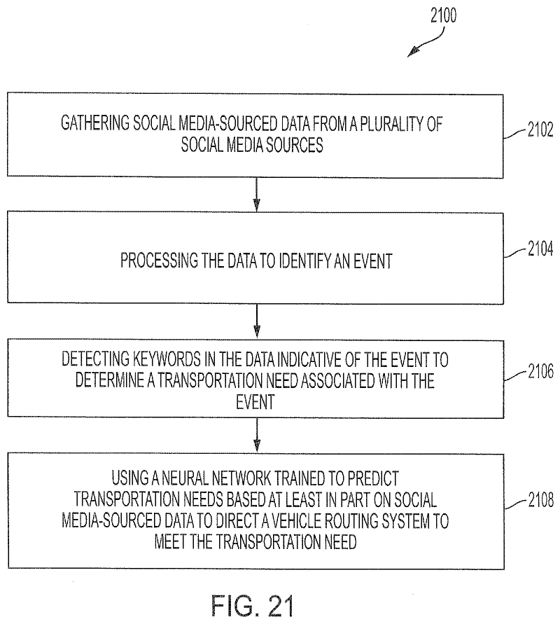

FIG. 21 illustrates a method 2100 of predicting a group transportation need in accordance with embodiments of the systems and methods disclosed herein. At 2102, the method includes gathering social media-sourced data from a plurality of social media sources. At 2104, the method includes processing the data to identify an event. At 2106, the method includes detecting keywords in the data indicative of the event to determine a transportation need associated with the event. At 2108, the method includes using a neural network trained to predict transportation needs based at least in part on social media-sourced data to direct a vehicle routing system to meet the transportation need.

Referring to FIG. 18 and FIG. 21, in embodiments, the neural network 18108 is a convolutional neural network 18113. In embodiments, the vehicle routing system is directed to meet the transportation need by routing a plurality of vehicles to a location associated with the event. In embodiments, the vehicle routing system is directed to meet the transportation need by routing a plurality of vehicles to avoid a region proximal to a location associated with the event. In embodiments, the vehicle routing system is directed to meet the transportation need by routing vehicles associated with users whose social media-sourced data 18114 do not indicate the transportation need to avoid a region proximal to a location associated with the event. In embodiments, the method further comprises presenting at least one transportation service for satisfying the transportation need. In embodiments, the neural network 18108 is trained based on a model that facilitates matching phrases in social media-sourced data 18114 with transportation activity.

In embodiments, the neural network 18108 predicts at least one of a destination and an arrival time for individuals attending the event. In embodiments, the neural network 18108 predicts the transportation need based on analysis of transportation need-indicative keywords detected in a discussion thread in the social media-sourced data 18114. In embodiments, the method further comprises identifying at least one shared transportation service that facilitates meeting the predicted transportation need for at least a subset of individuals identified in the social media-sourced data 18114. In embodiments, the at least one shared transportation service comprises generating a vehicle route that facilitates picking up the portion of the subset of individuals identified in the social media-sourced data 18114.

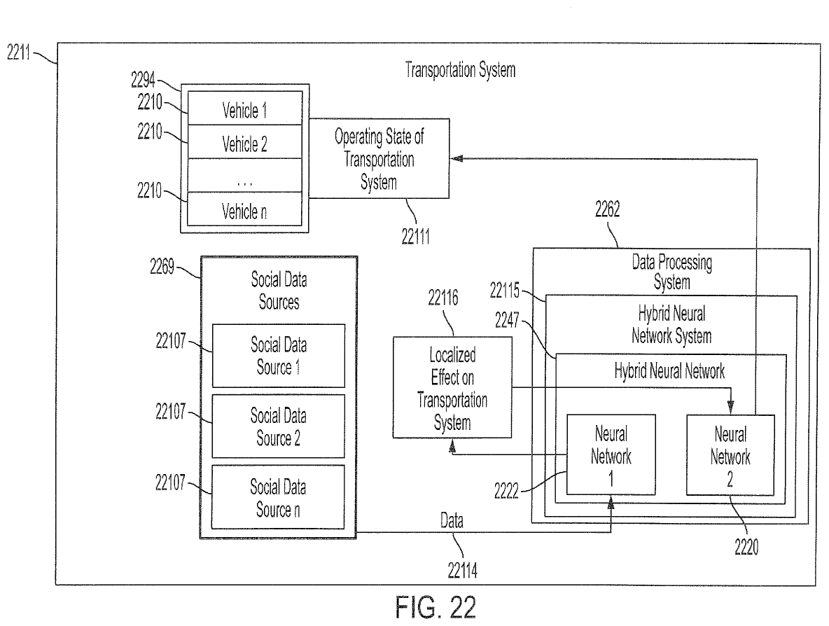

Referring to FIG. 22, in embodiments provided herein are transportation systems 2211 having a data processing system 2262 for taking social media data 22114 from a plurality 2269 of social data sources 22107 and using a hybrid neural network 2247 to optimize an operating state of a transportation system 22111 based on processing the social data sources 22107 with the hybrid neural network 2247. A hybrid neural network 2247 may have, for example, a neural network component that makes a classification or prediction based on processing social media data 22114 (such as predicting a high level of attendance of an event by processing images on many social media feeds that indicate interest in the event by many people, prediction of traffic, classification of interest by an individual in a topic, and many others) and another component that optimizes an operating state of a transportation system, such as an in-vehicle state, a routing state (for an individual vehicle 2210 or a set of vehicles 2294), a user-experience state, or other state described throughout this disclosure (e.g., routing an individual early to a venue like a music festival where there is likely to be very high attendance, playing music content in a vehicle 2210 for bands who will be at the music festival, or the like).

An aspect provided herein includes a system for transportation, comprising: a data processing system 2262 for taking social media data 22114 from a plurality 2269 of social data sources 22107 and using a hybrid neural network 2247 to optimize an operating state of a transportation system based on processing the data 22114 from the plurality 2269 of social data sources 22107 with the hybrid neural network 2247.

An aspect provided herein includes a hybrid neural network system 22115 for transportation system optimization, the hybrid neural network system 22115 comprising a hybrid neural network 2247, including: a first neural network 2222 that predicts a localized effect 22116 on a transportation system through analysis of social medial data 22114 sourced from a plurality 2269 of social media data sources 22107; and a second neural network 2220 that optimizes an operating state of the transportation system based on the predicted localized effect 22116.

In embodiments, at least one of the first neural network 2222 and the second neural network 2220 is a convolutional neural network. In embodiments, the second neural network 2220 is to optimize an in-vehicle rider experience state. In embodiments, the first neural network 2222 identifies a set of vehicles 2294 contributing to the localized effect 22116 based on correlation of vehicle location and an area of the localized effect 22116. In embodiments, the second neural network 2220 is to optimize a routing state of the transportation system for vehicles proximal to a location of the localized effect 22116. In embodiments, the hybrid neural network 2247 is trained for at least one of the predicting and optimizing based on keywords in the social media data indicative of an outcome of a transportation system optimization action. In embodiments, the hybrid neural network 2247 is trained for at least one of predicting and optimizing based on social media posts.

In embodiments, the hybrid neural network 2247 is trained for at least one of predicting and optimizing based on social media feeds. In embodiments, the hybrid neural network 2247 is trained for at least one of predicting and optimizing based on ratings derived from the social media data 22114. In embodiments, the hybrid neural network 2247 is trained for at least one of predicting and optimizing based on like or dislike activity detected in the social media data 22114. In embodiments, the hybrid neural network 2247 is trained for at least one of predicting and optimizing based on indications of relationships in the social media data 22114. In embodiments, the hybrid neural network 2247 is trained for at least one of predicting and optimizing based on user behavior detected in the social media data 22114. In embodiments, the hybrid neural network 2247 is trained for at least one of predicting and optimizing based on discussion threads in the social media data 22114.

In embodiments, the hybrid neural network 2247 is trained for at least one of predicting and optimizing based on chats in the social media data 22114. In embodiments, the hybrid neural network 2247 is trained for at least one of predicting and optimizing based on photographs in the social media data 22114. In embodiments, the hybrid neural network 2247 is trained for at least one of predicting and optimizing based on traffic-affecting information in the social media data 22114. In embodiments, the hybrid neural network 2247 is trained for at least one of predicting and optimizing based on an indication of a specific individual at a location in the social media data 22114. In embodiments, the specific individual is a celebrity. In embodiments, the hybrid neural network 2247 is trained for at least one of predicting and optimizing based a presence of a rare or transient phenomena at a location in the social media data 22114.

In embodiments, the hybrid neural network 2247 is trained for at least one of predicting and optimizing based a commerce-related event at a location in the social media data 22114. In embodiments, the hybrid neural network 2247 is trained for at least one of predicting and optimizing based an entertainment event at a location in the social media data 22114. In embodiments, the social media data analyzed to predict a localized effect on a transportation system includes traffic conditions. In embodiments, the social media data analyzed to predict a localized effect on a transportation system includes weather conditions. In embodiments, the social media data analyzed to predict a localized effect on a transportation system includes entertainment options.

In embodiments, the social media data analyzed to predict a localized effect on a transportation system includes risk-related conditions. In embodiments, the risk-related conditions include crowds gathering for potentially dangerous reasons. In embodiments, the social media data analyzed to predict a localized effect on a transportation system includes commerce-related conditions. In embodiments, the social media data analyzed to predict a localized effect on a transportation system includes goal-related conditions.

In embodiments, the social media data analyzed to predict a localized effect on a transportation system includes estimates of attendance at an event. In embodiments, the social media data analyzed to predict a localized effect on a transportation system includes predictions of attendance at an event. In embodiments, the social media data analyzed to predict a localized effect on a transportation system includes modes of transportation. In embodiments, the modes of transportation include car traffic. In embodiments, the modes of transportation include public transportation options.

In embodiments, the social media data analyzed to predict a localized effect on a transportation system includes hash tags. In embodiments, the social media data analyzed to predict a localized effect on a transportation system includes trending of topics. In embodiments, an outcome of a transportation system optimization action is reducing fuel consumption. In embodiments, an outcome of a transportation system optimization action is reducing traffic congestion. In embodiments, an outcome of a transportation system optimization action is reduced pollution. In embodiments, an outcome of a transportation system optimization action is bad weather avoidance. In embodiments, an operating state of the transportation system being optimized includes an in-vehicle state. In embodiments, an operating state of the transportation system being optimized includes a routing state.

In embodiments, the routing state is for an individual vehicle 2210. In embodiments, the routing state is for a set of vehicles 2294. In embodiments, an operating state of the transportation system being optimized includes a user-experience state.

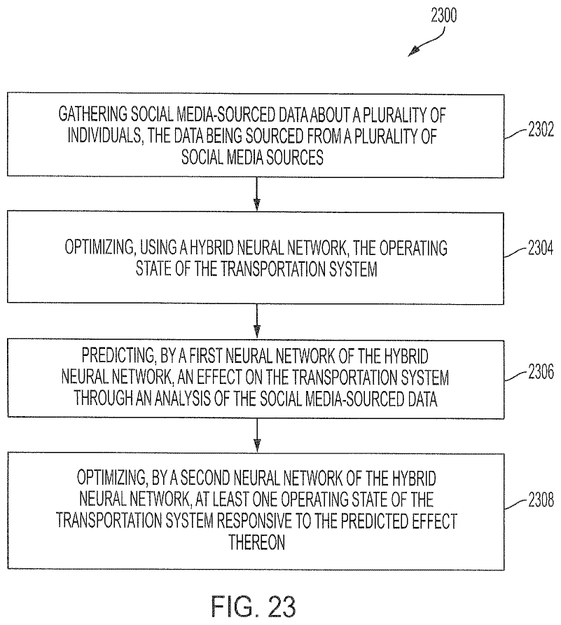

FIG. 23 illustrates a method 2300 of optimizing an operating state of a transportation system in accordance with embodiments of the systems and methods disclosed herein. At 2302 the method includes gathering social media-sourced data about a plurality of individuals, the data being sourced from a plurality of social media sources. At 2304 the method includes optimizing, using a hybrid neural network, the operating state of the transportation system. At 2306 the method includes predicting, by a first neural network of the hybrid neural network, an effect on the transportation system through an analysis of the social media-sourced data. At 2308 the method includes optimizing, by a second neural network of the hybrid neural network, at least one operating state of the transportation system responsive to the predicted effect thereon.

Referring to FIG. 22 and FIG. 23, in embodiments, at least one of the first neural network 2222 and the second neural network 2220 is a convolutional neural network. In embodiments, the second neural network 2220 optimizes an in-vehicle rider experience state. In embodiments, the first neural network 2222 identifies a set of vehicles contributing to the effect based on correlation of vehicle location and an effect area. In embodiments, the second neural network 2220 optimizes a routing state of the transportation system for vehicles proximal to a location of the effect.

In embodiments, the hybrid neural network 2247 is trained for at least one of the predicting and optimizing based on keywords in the social media data indicative of an outcome of a transportation system optimization action. In embodiments, the hybrid neural network 2247 is trained for at least one of predicting and optimizing based on social media posts. In embodiments, the hybrid neural network 2247 is trained for at least one of predicting and optimizing based on social media feeds. In embodiments, the hybrid neural network 2247 is trained for at least one of predicting and optimizing based on ratings derived from the social media data 22114. In embodiments, the hybrid neural network 2247 is trained for at least one of predicting and optimizing based on like or dislike activity detected in the social media data 22114. In embodiments, the hybrid neural network 2247 is trained for at least one of predicting and optimizing based on indications of relationships in the social media data 22114.

In embodiments, the hybrid neural network 2247 is trained for at least one of predicting and optimizing based on user behavior detected in the social media data 22114. In embodiments, the hybrid neural network 2247 is trained for at least one of predicting and optimizing based on discussion threads in the social media data 22114. In embodiments, the hybrid neural network 2247 is trained for at least one of predicting and optimizing based on chats in the social media data 22114. In embodiments, the hybrid neural network 2247 is trained for at least one of predicting and optimizing based on photographs in the social media data 22114. In embodiments, the hybrid neural network 2247 is trained for at least one of predicting and optimizing based on traffic-affecting information in the social media data 22114.

In embodiments, the hybrid neural network 2247 is trained for at least one of predicting and optimizing based on an indication of a specific individual at a location in the social media data. In embodiments, the specific individual is a celebrity. In embodiments, the hybrid neural network 2247 is trained for at least one of predicting and optimizing based a presence of a rare or transient phenomena at a location in the social media data. In embodiments, the hybrid neural network 2247 is trained for at least one of predicting and optimizing based a commerce-related event at a location in the social media data. In embodiments, the hybrid neural network 2247 is trained for at least one of predicting and optimizing based an entertainment event at a location in the social media data. In embodiments, the social media data analyzed to predict an effect on a transportation system includes traffic conditions.

In embodiments, the social media data analyzed to predict an effect on a transportation system includes weather conditions. In embodiments, the social media data analyzed to predict an effect on a transportation system includes entertainment options. In embodiments, the social media data analyzed to predict an effect on a transportation system includes risk-related conditions. In embodiments, the risk-related conditions include crowds gathering for potentially dangerous reasons. In embodiments, the social media data analyzed to predict an effect on a transportation system includes commerce-related conditions. In embodiments, the social media data analyzed to predict an effect on a transportation system includes goal-related conditions.

In embodiments, the social media data analyzed to predict an effect on a transportation system includes estimates of attendance at an event. In embodiments, the social media data analyzed to predict an effect on a transportation system includes predictions of attendance at an event. In embodiments, the social media data analyzed to predict an effect on a transportation system includes modes of transportation. In embodiments, the modes of transportation include car traffic. In embodiments, the modes of transportation include public transportation options. In embodiments, the social media data analyzed to predict an effect on a transportation system includes hash tags. In embodiments, the social media data analyzed to predict an effect on a transportation system includes trending of topics.

In embodiments, an outcome of a transportation system optimization action is reducing fuel consumption. In embodiments, an outcome of a transportation system optimization action is reducing traffic congestion. In embodiments, an outcome of a transportation system optimization action is reduced pollution. In embodiments, an outcome of a transportation system optimization action is bad weather avoidance. In embodiments, the operating state of the transportation system being optimized includes an in-vehicle state. In embodiments, the operating state of the transportation system being optimized includes a routing state. In embodiments, the routing state is for an individual vehicle. In embodiments, the routing state is for a set of vehicles. In embodiments, the operating state of the transportation system being optimized includes a user-experience state.

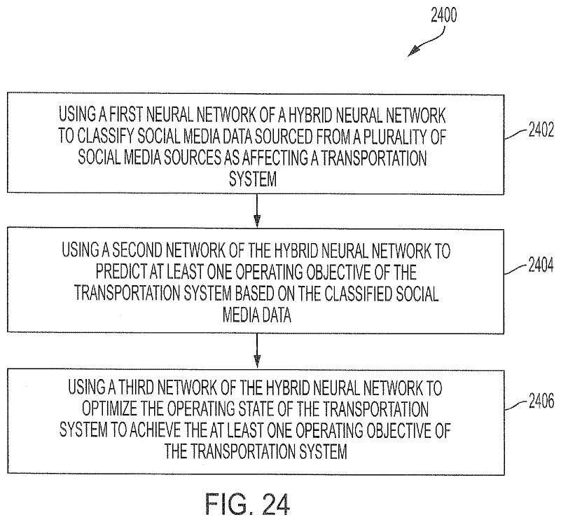

FIG. 24 illustrates a method 2400 of optimizing an operating state of a transportation system in accordance with embodiments of the systems and methods disclosed herein. At 2402 the method includes using a first neural network of a hybrid neural network to classify social media data sourced from a plurality of social media sources as affecting a transportation system. At 2404 the method includes using a second network of the hybrid neural network to predict at least one operating objective of the transportation system based on the classified social media data. At 2406 the method includes using a third network of the hybrid neural network to optimize the operating state of the transportation system to achieve the at least one operating objective of the transportation system.

Referring to FIG. 22 and FIG. 24, in embodiments, at least one of the neural networks in the hybrid neural network 2247 is a convolutional neural network.

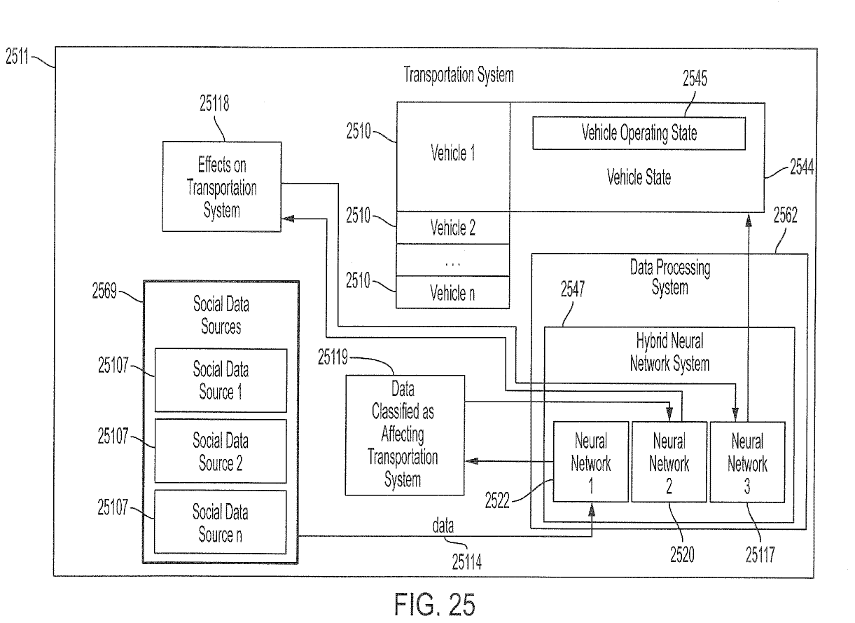

Referring to FIG. 25, in embodiments provided herein are transportation systems 2511 having a data processing system 2562 for taking social media data 25114 from a plurality of social data sources 25107 and using a hybrid neural network 2547 to optimize an operating state 2545 of a vehicle 2510 based on processing the social data sources with the hybrid neural network 2547. In embodiments, the hybrid neural network 2547 can include one neural network category for prediction, another for classification, and another for optimization of one or more operating states, such as based on optimizing one or more desired outcomes (such a providing efficient travel, highly satisfying rider experiences, comfortable rides, on-time arrival, or the like). Social data sources 2569 may be used by distinct neural network categories (such as any of the types described herein) to predict travel times, to classify content such as for profiling interests of a user, to predict objectives for a transportation plan (such as what will provide overall satisfaction for an individual or a group) and the like. Social data sources 2569 may also inform optimization, such as by providing indications of successful outcomes (e.g., a social data source 25107 like a Facebook feed might indicate that a trip was “amazing” or “horrible,” a Yelp review might indicate a restaurant was terrible, or the like). Thus, social data sources 2569, by contributing to outcome tracking, can be used to train a system to optimize transportation plans, such as relating to timing, destinations, trip purposes, what individuals should be invited, what entertainment options should be selected, and many others.

An aspect provided herein includes a transportation system 2511, comprising: a data processing system 2562 for taking social media data 25114 from a plurality of social data sources 25107 and using a hybrid neural network 2547 to optimize an operating state 2545 of a vehicle 2510 based on processing the data 25114 from the plurality of social data sources 25107 with the hybrid neural network 2547.

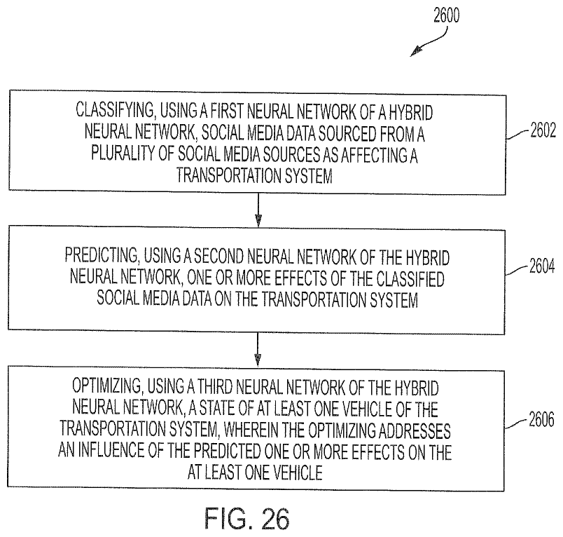

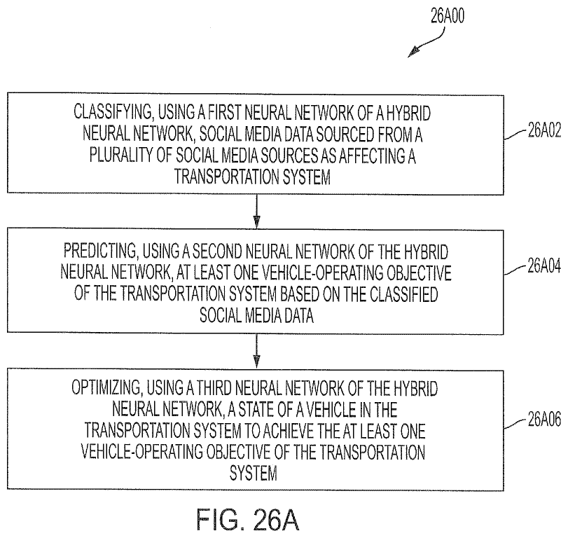

FIG. 26 illustrates a method 2600 of optimizing an operating state of a vehicle in accordance with embodiments of the systems and methods disclosed herein. At 2602 the method includes classifying, using a first neural network 2522 (FIG. 25) of a hybrid neural network, social media data 25119 (FIG. 25) sourced from a plurality of social media sources as affecting a transportation system. At 2604 the method includes predicting, using a second neural network 2520 (FIG. 25) of the hybrid neural network, one or more effects 25118 (FIG. 25) of the classified social media data on the transportation system. At 2606 the method includes optimizing, using a third neural network 25117 (FIG. 25) of the hybrid neural network, a state of at least one vehicle of the transportation system, wherein the optimizing addresses an influence of the predicted one or more effects on the at least one vehicle.

Referring to FIG. 25 and FIG. 26, in embodiments, at least one of the neural networks in the hybrid neural network 2547 is a convolutional neural network. In embodiments, the social media data 25114 includes social media posts. In embodiments, the social media data 25114 includes social media feeds. In embodiments, the social media data 25114 includes like or dislike activity detected in the social media. In embodiments, the social media data 25114 includes indications of relationships. In embodiments, the social media data 25114 includes user behavior. In embodiments, the social media data 25114 includes discussion threads. In embodiments, the social media data 25114 includes chats. In embodiments, the social media data 25114 includes photographs.

In embodiments, the social media data 25114 includes traffic-affecting information. In embodiments, the social media data 25114 includes an indication of a specific individual at a location. In embodiments, the social media data 25114 includes an indication of a celebrity at a location. In embodiments, the social media data 25114 includes presence of a rare or transient phenomena at a location. In embodiments, the social media data 25114 includes a commerce-related event. In embodiments, the social media data 25114 includes an entertainment event at a location. In embodiments, the social media data 25114 includes traffic conditions. In embodiments, the social media data 25114 includes weather conditions. In embodiments, the social media data 25114 includes entertainment options.

In embodiments, the social media data 25114 includes risk-related conditions. In embodiments, the social media data 25114 includes predictions of attendance at an event. In embodiments, the social media data 25114 includes estimates of attendance at an event. In embodiments, the social media data 25114 includes modes of transportation used with an event. In embodiments, the effect 25118 on the transportation system includes reducing fuel consumption. In embodiments, the effect 25118 on the transportation system includes reducing traffic congestion. In embodiments, the effect 25118 on the transportation system includes reduced carbon footprint. In embodiments, the effect 25118 on the transportation system includes reduced pollution.

In embodiments, the optimized state 2544 of the at least one vehicle 2510 is an operating state 2545 of the vehicle. In embodiments, the optimized state of the at least one vehicle includes an in-vehicle state. In embodiments, the optimized state of the at least one vehicle includes a rider state. In embodiments, the optimized state of the at least one vehicle includes a routing state. In embodiments, the optimized state of the at least one vehicle includes user experience state. In embodiments, a characterization of an outcome of the optimizing in the social media data 25114 is used as feedback to improve the optimizing. In embodiments, the feedback includes likes and dislikes of the outcome. In embodiments, the feedback includes social medial activity referencing the outcome.

In embodiments, the feedback includes trending of social media activity referencing the outcome. In embodiments, the feedback includes hash tags associated with the outcome. In embodiments, the feedback includes ratings of the outcome. In embodiments, the feedback includes requests for the outcome.

FIG. 26A illustrates a method 26A00 of optimizing an operating state of a vehicle in accordance with embodiments of the systems and methods disclosed herein. At 26A02 the method includes classifying, using a first neural network of a hybrid neural network, social media data sourced from a plurality of social media sources as affecting a transportation system. At 26A04 the method includes predicting, using a second neural network of the hybrid neural network, at least one vehicle-operating objective of the transportation system based on the classified social media data. At 26A06 the method includes optimizing, using a third neural network of the hybrid neural network, a state of a vehicle in the transportation system to achieve the at least one vehicle-operating objective of the transportation system.

Referring to FIG. 25 and FIG. 26A, in embodiments, at least one of the neural networks in the hybrid neural network 2547 is a convolutional neural network. In embodiments, the vehicle-operating objective comprises achieving a rider state of at least one rider in the vehicle. In embodiments, the social media data 25114 includes social media posts.

In embodiments, the social media data 25114 includes social media feeds. In embodiments, the social media data 25114 includes like and dislike activity detected in the social media. In embodiments, the social media data 25114 includes indications of relationships. In embodiments, the social media data 25114 includes user behavior. In embodiments, the social media data 25114 includes discussion threads. In embodiments, the social media data 25114 includes chats. In embodiments, the social media data 25114 includes photographs. In embodiments, the social media data 25114 includes traffic-affecting information.

In embodiments, the social media data 25114 includes an indication of a specific individual at a location. In embodiments, the social media data 25114 includes an indication of a celebrity at a location. In embodiments, the social media data 25114 includes presence of a rare or transient phenomena at a location. In embodiments, the social media data 25114 includes a commerce-related event. In embodiments, the social media data 25114 includes an entertainment event at a location. In embodiments, the social media data 25114 includes traffic conditions. In embodiments, the social media data 25114 includes weather conditions. In embodiments, the social media data 25114 includes entertainment options.

In embodiments, the social media data 25114 includes risk-related conditions. In embodiments, the social media data 25114 includes predictions of attendance at an event. In embodiments, the social media data 25114 includes estimates of attendance at an event. In embodiments, the social media data 25114 includes modes of transportation used with an event. In embodiments, the effect on the transportation system includes reducing fuel consumption. In embodiments, the effect on the transportation system includes reducing traffic congestion. In embodiments, the effect on the transportation system includes reduced carbon footprint. In embodiments, the effect on the transportation system includes reduced pollution. In embodiments, the optimized state of the vehicle is an operating state of the vehicle.

In embodiments, the optimized state of the vehicle includes an in-vehicle state. In embodiments, the optimized state of the vehicle includes a rider state. In embodiments, the optimized state of the vehicle includes a routing state. In embodiments, the optimized state of the vehicle includes user experience state. In embodiments, a characterization of an outcome of the optimizing in the social media data is used as feedback to improve the optimizing. In embodiments, the feedback includes likes or dislikes of the outcome. In embodiments, the feedback includes social medial activity referencing the outcome. In embodiments, the feedback includes trending of social media activity referencing the outcome.

In embodiments, the feedback includes hash tags associated with the outcome. In embodiments, the feedback includes ratings of the outcome. In embodiments, the feedback includes requests for the outcome.

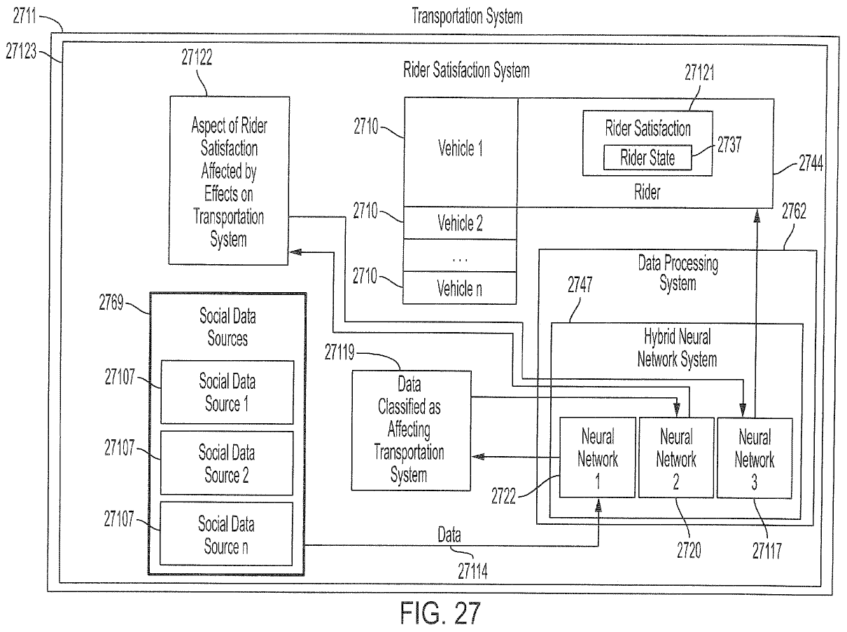

Referring to FIG. 27, in embodiments provided herein are transportation systems 2711 having a data processing system 2762 for taking social data 27114 from a plurality 2769 of social data sources 27107 and using a hybrid neural network 2747 to optimize satisfaction 27121 of at least one rider 27120 in a vehicle 2710 based on processing the social data sources with the hybrid neural network 2747. Plurality 2769 of social data sources may be used, for example, to predict what entertainment options are most likely to be effective for a rider 27120 by one neural network category, while another neural network category may be used to optimize a routing plan (such as based on social data that indicates likely traffic, points of interest, or the like). Social data 27114 may also be used for outcome tracking and feedback to optimize the system, both as to entertainment options and as to transportation planning, routing, or the like.

An aspect provided herein includes a transportation system 2711, comprising: a data processing system 2762 for taking social data 27114 from a plurality 2769 of social data sources 27107 and using a hybrid neural network 2747 to optimize satisfaction 27121 of at least one rider 27120 in a vehicle 2710 based on processing the social data 27114 from the plurality 2769 of social data sources 27107 with the hybrid neural network 2747.

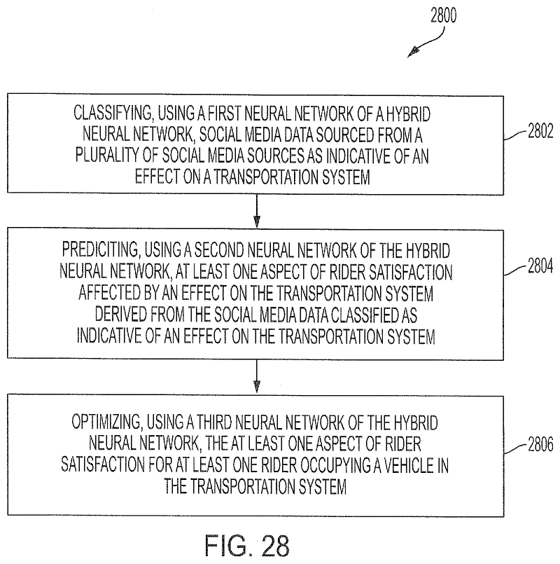

FIG. 28 illustrates a method 2800 of optimizing rider satisfaction in accordance with embodiments of the systems and methods disclosed herein. At 2802 the method includes classifying, using a first neural network 2722 (FIG. 27) of a hybrid neural network, social media data 27119 (FIG. 27) sourced from a plurality of social media sources as indicative of an effect on a transportation system. At 2804 the method includes predicting, using a second neural network 2720 (FIG. 27) of the hybrid neural network, at least one aspect 27122 (FIG. 27) of rider satisfaction affected by an effect on the transportation system derived from the social media data classified as indicative of an effect on the transportation system. At 2806 the method includes optimizing, using a third neural network 27117 (FIG. 27) of the hybrid neural network, the at least one aspect of rider satisfaction for at least one rider occupying a vehicle in the transportation system.

Referring to FIG. 27 and FIG. 28, in embodiments, at least one of the neural networks in the hybrid neural network 2547 is a convolutional neural network. In embodiments, the at least one aspect of rider satisfaction 27121 is optimized by predicting an entertainment option for presenting to the rider. In embodiments, the at least one aspect of rider satisfaction 27121 is optimized by optimizing route planning for a vehicle occupied by the rider. In embodiments, the at least one aspect of rider satisfaction 27121 is a rider state and optimizing the aspects of rider satisfaction comprising optimizing the rider state. In embodiments, social media data specific to the rider is analyzed to determine at least one optimizing action likely to optimize the at least one aspect of rider satisfaction 27121. In embodiments, the optimizing action is selected from the group of actions consisting of adjusting a routing plan to include passing points of interest to the user, avoiding traffic congestion predicted from the social media data, and presenting entertainment options.

In embodiments, the social media data includes social media posts. In embodiments, the social media data includes social media feeds. In embodiments, the social media data includes like or dislike activity detected in the social media. In embodiments, the social media data includes indications of relationships. In embodiments, the social media data includes user behavior. In embodiments, the social media data includes discussion threads. In embodiments, the social media data includes chats. In embodiments, the social media data includes photographs.

In embodiments, the social media data includes traffic-affecting information. In embodiments, the social media data includes an indication of a specific individual at a location. In embodiments, the social media data includes an indication of a celebrity at a location. In embodiments, the social media data includes presence of a rare or transient phenomena at a location. In embodiments, the social media data includes a commerce-related event. In embodiments, the social media data includes an entertainment event at a location. In embodiments, the social media data includes traffic conditions. In embodiments, the social media data includes weather conditions. In embodiments, the social media data includes entertainment options. In embodiments, the social media data includes risk-related conditions. In embodiments, the social media data includes predictions of attendance at an event. In embodiments, the social media data includes estimates of attendance at an event. In embodiments, the social media data includes modes of transportation used with an event. In embodiments, the effect on the transportation system includes reducing fuel consumption. In embodiments, the effect on the transportation system includes reducing traffic congestion. In embodiments, the effect on the transportation system includes reduced carbon footprint. In embodiments, the effect on the transportation system includes reduced pollution. In embodiments, the optimized at least one aspect of rider satisfaction is an operating state of the vehicle. In embodiments, the optimized at least one aspect of rider satisfaction includes an in-vehicle state. In embodiments, the optimized at least one aspect of rider satisfaction includes a rider state. In embodiments, the optimized at least one aspect of rider satisfaction includes a routing state. In embodiments, the optimized at least one aspect of rider satisfaction includes user experience state.

In embodiments, a characterization of an outcome of the optimizing in the social media data is used as feedback to improve the optimizing. In embodiments, the feedback includes likes or dislikes of the outcome. In embodiments, the feedback includes social medial activity referencing the outcome. In embodiments, the feedback includes trending of social media activity referencing the outcome. In embodiments, the feedback includes hash tags associated with the outcome. In embodiments, the feedback includes ratings of the outcome. In embodiments, the feedback includes requests for the outcome.

An aspect provided herein includes a rider satisfaction system 27123 for optimizing rider satisfaction 27121, the system comprising: a first neural network 2722 of a hybrid neural network 2747 to classify social media data 27114 sourced from a plurality 2769 of social media sources 27107 as indicative of an effect on a transportation system 2711; a second neural network 2720 of the hybrid neural network 2747 to predict at least one aspect 27122 of rider satisfaction 27121 affected by an effect on the transportation system derived from the social media data classified as indicative of the effect on the transportation system; and a third neural network 27117 of the hybrid neural network 2747 to optimize the at least one aspect of rider satisfaction 27121 for at least one rider 2744 occupying a vehicle 2710 in the transportation system 2711. In embodiments, at least one of the neural networks in the hybrid neural network 2747 is a convolutional neural network.

In embodiments, the at least one aspect of rider satisfaction 27121 is optimized by predicting an entertainment option for presenting to the rider 2744. In embodiments, the at least one aspect of rider satisfaction 27121 is optimized by optimizing route planning for a vehicle 2710 occupied by the rider 2744. In embodiments, the at least one aspect of rider satisfaction 27121 is a rider state 2737 and optimizing the at least one aspect of rider satisfaction 27121 comprises optimizing the rider state 2737. In embodiments, social media data specific to the rider 2744 is analyzed to determine at least one optimizing action likely to optimize the at least one aspect of rider satisfaction 27121. In embodiments, the at least one optimizing action is selected from the group consisting of: adjusting a routing plan to include passing points of interest to the user, avoiding traffic congestion predicted from the social media data, deriving an economic benefit, deriving an altruistic benefit, and presenting entertainment options.

In embodiments, the economic benefit is saved fuel. In embodiments, the altruistic benefit is reduction of environmental impact. In embodiments, the social media data includes social media posts. In embodiments, the social media data includes social media feeds. In embodiments, the social media data includes like or dislike activity detected in the social media. In embodiments, the social media data includes indications of relationships. In embodiments, the social media data includes user behavior. In embodiments, the social media data includes discussion threads. In embodiments, the social media data includes chats. In embodiments, the social media data includes photographs. In embodiments, the social media data includes traffic-affecting information. In embodiments, the social media data includes an indication of a specific individual at a location.

In embodiments, the social media data includes an indication of a celebrity at a location. In embodiments, the social media data includes presence of a rare or transient phenomena at a location. In embodiments, the social media data includes a commerce-related event. In embodiments, the social media data includes an entertainment event at a location. In embodiments, the social media data includes traffic conditions. In embodiments, the social media data includes weather conditions. In embodiments, the social media data includes entertainment options. In embodiments, the social media data includes risk-related conditions. In embodiments, the social media data includes predictions of attendance at an event. In embodiments, the social media data includes estimates of attendance at an event. In embodiments, the social media data includes modes of transportation used with an event.

In embodiments, the effect on the transportation system includes reducing fuel consumption. In embodiments, the effect on the transportation system includes reducing traffic congestion. In embodiments, the effect on the transportation system includes reduced carbon footprint. In embodiments, the effect on the transportation system includes reduced pollution. In embodiments, the optimized at least one aspect of rider satisfaction is an operating state of the vehicle. In embodiments, the optimized at least one aspect of rider satisfaction includes an in-vehicle state. In embodiments, the optimized at least one aspect of rider satisfaction includes a rider state. In embodiments, the optimized at least one aspect of rider satisfaction includes a routing state. In embodiments, the optimized at least one aspect of rider satisfaction includes user experience state. In embodiments, a characterization of an outcome of the optimizing in the social media data is used as feedback to improve the optimizing. In embodiments, the feedback includes likes or dislikes of the outcome. In embodiments, the feedback includes social medial activity referencing the outcome. In embodiments, the feedback includes trending of social media activity referencing the outcome. In embodiments, the feedback includes hash tags associated with the outcome. In embodiments, the feedback includes ratings of the outcome. In embodiments, the feedback includes requests for the outcome.

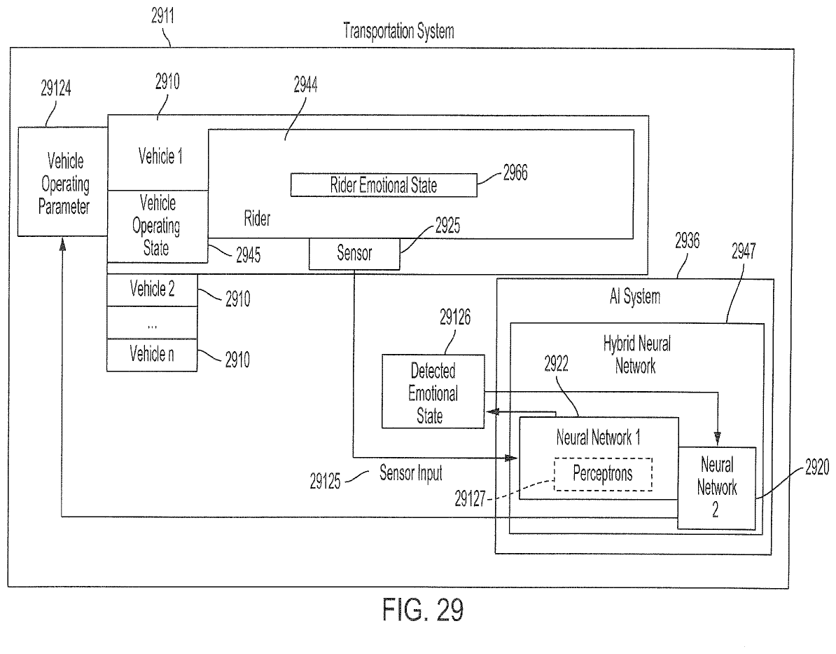

Referring to FIG. 29, in embodiments provided herein are transportation systems 2911 having a hybrid neural network 2947 wherein one neural network 2922 processes a sensor input 29125 about a rider 2944 of a vehicle 2910 to determine an emotional state 29126 and another neural network optimizes at least one operating parameter 29124 of the vehicle to improve the rider's emotional state 2966. For example, a neural net 2922 that includes one or more perceptrons 29127 that mimic human senses may be used to mimic or assist with determining the likely emotional state of a rider 29126 based on the extent to which various senses have been stimulated, while another neural network 2920 is used in an expert system that performs random and/or systematized variations of various combinations of operating parameters (such as entertainment settings, seat settings, suspension settings, route types and the like) with genetic programming that promotes favorable combinations and eliminates unfavorable ones, optionally based on input from the output of the perceptron-containing neural network 2922 that predict emotional state. These and many other such combinations are encompassed by the present disclosure. In FIG. 29, perceptrons 29127 are depicted as optional.

An aspect provided herein includes a transportation system 2911, comprising: a hybrid neural network 2947 wherein one neural network 2922 processes a sensor input 29125 corresponding to a rider 2944 of a vehicle 2910 to determine an emotional state 2966 of the rider 2944 and another neural network 2920 optimizes at least one operating parameter 29124 of the vehicle to improve the emotional state 2966 of the rider 2944.

An aspect provided herein includes a hybrid neural network 2947 for rider satisfaction, comprising: a first neural network 2922 to detect a detected emotional state 29126 of a rider 2944 occupying a vehicle 2910 through analysis of the sensor input 29125 gathered from sensors 2925 deployed in a vehicle 2910 for gathering physiological conditions of the rider; and a second neural network 2920 to optimize, for achieving a favorable emotional state of the rider, an operational parameter 29124 of the vehicle in response to the detected emotional state 29126 of the rider.

In embodiments, the first neural network 2922 is a recurrent neural network and the second neural network 2920 is a radial basis function neural network. In embodiments, at least one of the neural networks in the hybrid neural network 2947 is a convolutional neural network. In embodiments, the second neural network 2920 is to optimize the operational parameter 29124 based on a correlation between a vehicle operating state 2945 and a rider emotional state 2966 of the rider. In embodiments, the second neural network 2920 optimizes the operational parameter 29124 in real time responsive to the detecting of the detected emotional state 29126 of the rider 2944 by the first neural network 2922. In embodiments, the first neural network 2922 comprises a plurality of connected nodes that form a directed cycle, the first neural network 2922 further facilitating bi-directional flow of data among the connected nodes. In embodiments, the operational parameter 29124 that is optimized affects at least one of: a route of the vehicle, in-vehicle audio contents, a speed of the vehicle, an acceleration of the vehicle, a deceleration of the vehicle, a proximity to objects along the route, and a proximity to other vehicles along the route.

An aspect provided herein includes an artificial intelligence system 2936 for optimizing rider satisfaction, comprising: a hybrid neural network 2947, including: a recurrent neural network (e.g., in FIG. 29, neural network 2922 may be a recurrent neural network) to indicate a change in an emotional state of a rider 2944 in a vehicle 2910 through recognition of patterns of physiological data of the rider captured by at least one sensor 2925 deployed for capturing rider emotional state-indicative data while occupying the vehicle 2910; and a radial basis function neural network (e.g., in FIG. 29, the second neural network 2920 may be a radial basis function neural network) to optimize, for achieving a favorable emotional state of the rider, an operational parameter 29124 of the vehicle in response to the indication of change in the emotional state of the rider. In embodiments, the operational parameter 29124 of the vehicle that is to be optimized is to be determined and adjusted to induce the favorable emotional state of the rider.

An aspect provided herein includes an artificial intelligence system 2936 for optimizing rider satisfaction, comprising: a hybrid neural network 2947, including: a convolutional neural network (in FIG. 29, neural network 1, depicted at reference numeral 2922, may optionally be a convolutional neural network) to indicate a change in an emotional state of a rider in a vehicle through recognitions of patterns of visual data of the rider captured by at least one image sensor (in FIG. 29, the sensor 2925 may optionally be an image sensor) deployed for capturing images of the rider while occupying the vehicle; and a second neural network 2920 to optimize, for achieving a favorable emotional state of the rider, an operational parameter 29124 of the vehicle in response to the indication of change in the emotional state of the rider.

In embodiments, the operational parameter 19124 of the vehicle that is to be optimized is to be determined and adjusted to induce the favorable emotional state of the rider.

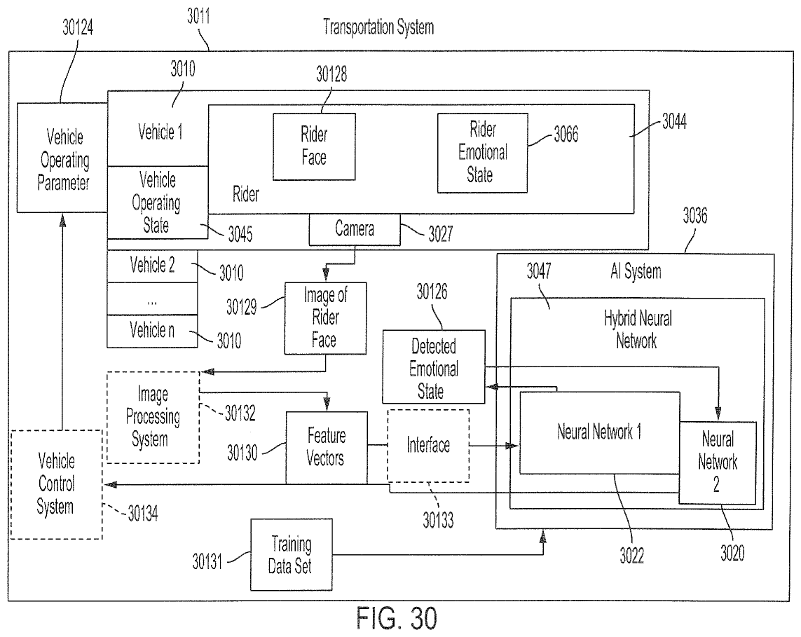

Referring to FIG. 30, in embodiments provided herein are transportation systems 3011 having an artificial intelligence system 3036 for processing feature vectors of an image of a face of a rider in a vehicle to determine an emotional state and optimizing at least one operating parameter of the vehicle to improve the rider's emotional state. A face may be classified based on images from in-vehicle cameras, available cellphone or other mobile device cameras, or other sources. An expert system, optionally trained based on a training set of data provided by humans or trained by deep learning, may learn to adjust vehicle parameters (such as any described herein) to provide improved emotional states. For example, if a rider's face indicates stress, the vehicle may select a less stressful route, play relaxing music, play humorous content, or the like.

An aspect provided herein includes a transportation system 3011, comprising: an artificial intelligence system 3036 (with a hybrid neural network 3047) for processing feature vectors 30130 of an image 30129 of a face 30128 of a rider 3044 in a vehicle 3010 to determine an emotional state 3066 of the rider and optimizing an operational parameter 30124 of the vehicle to improve the emotional state 3066 of the rider 3044.

In embodiments, the artificial intelligence system 3036 includes: a first neural network 3022 to detect the emotional state 30126 of the rider through recognition of patterns of the feature vectors 30130 of the image 30129 of the face 30128 of the rider 3044 in the vehicle 3010, the feature vectors 30130 indicating at least one of a favorable emotional state of the rider and an unfavorable emotional state of the rider; and a second neural network 3020 to optimize, for achieving the favorable emotional state of the rider, the operational parameter 30124 of the vehicle in response to the detected emotional state 30126 of the rider.

In embodiments, the first neural network 3022 is a recurrent neural network and the second neural network 3020 is a radial basis function neural network. In embodiments, the second neural network 3020 optimizes the operational parameter 30124 based on a correlation between the vehicle operating state 3045 and the emotional state 3066 of the rider. In embodiments, the second neural network 3020 is to determine an optimum value for the operational parameter of the vehicle, and the transportation system 3011 is to adjust the operational parameter 30124 of the vehicle to the optimum value to induce the favorable emotional state of the rider. In embodiments, the first neural network 3022 further learns to classify the patterns in the feature vectors and associate the patterns with a set of emotional states and changes thereto by processing a training data set 30131. In embodiments, the training data set 30131 is sourced from at least one of a stream of data from an unstructured data source, a social media source, a wearable device, an in-vehicle sensor, a rider helmet, a rider headgear, and a rider voice recognition system.

In embodiments, the second neural network 3020 optimizes the operational parameter 30124 in real time responsive to the detecting of the emotional state of the rider by the first neural network 3022. In embodiments, the first neural network 3022 is to detect a pattern of the feature vectors. In embodiments, the pattern is associated with a change in the emotional state of the rider from a first emotional state to a second emotional state. In embodiments, the second neural network 3020 optimizes the operational parameter of the vehicle in response to the detection of the pattern associated with the change in the emotional state. In embodiments, the first neural network 3022 comprises a plurality of interconnected nodes that form a directed cycle, the first neural network 3022 further facilitating bi-directional flow of data among the interconnected nodes. In embodiments, the transportation system 3011 further comprises: a feature vector generation system to process a set of images of the face of the rider, the set of images captured over an interval of time from by a plurality of image capture devices 3027 while the rider 3044 is in the vehicle 3010, wherein the processing of the set of images is to produce the feature vectors 30130 of the image of the face of the rider. In embodiments, the transportation system further comprises: image capture devices 3027 disposed to capture a set of images of the face of the rider in the vehicle from a plurality of perspectives; and an image processing system to produce the feature vectors from the set of images captured from at least one of the plurality of perspectives.

In embodiments, the transportation system 3011 further comprises an interface 30133 between the first neural network and the image processing system 30132 to communicate a time sequence of the feature vectors, wherein the feature vectors are indicative of the emotional state of the rider. In embodiments, the feature vectors indicate at least one of a changing emotional state of the rider, a stable emotional state of the rider, a rate of change of the emotional state of the rider, a direction of change of the emotional state of the rider, a polarity of a change of the emotional state of the rider; the emotional state of the rider is changing to the unfavorable emotional state; and the emotional state of the rider is changing to the favorable emotional state.

In embodiments, the operational parameter that is optimized affects at least one of a route of the vehicle, in-vehicle audio content, speed of the vehicle, acceleration of the vehicle, deceleration of the vehicle, proximity to objects along the route, and proximity to other vehicles along the route. In embodiments, the second neural network is to interact with a vehicle control system to adjust the operational parameter. In embodiments, the artificial intelligence system further comprises a neural network that includes one or more perceptrons that mimic human senses that facilitates determining the emotional state of the rider based on an extent to which at least one of the senses of the rider is stimulated. In embodiments, the artificial intelligence system includes: a recurrent neural network to indicate a change in the emotional state of the rider through recognition of patterns of the feature vectors of the image of the face of the rider in the vehicle; and a radial basis function neural network to optimize, for achieving the favorable emotional state of the rider, the operational parameter of the vehicle in response to the indication of the change in the emotional state of the rider.

In embodiments, the radial basis function neural network is to optimize the operational parameter based on a correlation between a vehicle operating state and a rider emotional state. In embodiments, the operational parameter of the vehicle that is optimized is determined and adjusted to induce a favorable rider emotional state. In embodiments, the recurrent neural network further learns to classify the patterns of the feature vectors and associate the patterns of the feature vectors to emotional states and changes thereto from a training data set sourced from at least one of a stream of data from unstructured data sources, social media sources, wearable devices, in-vehicle sensors, a rider helmet, a rider headgear, and a rider voice system. In embodiments, the radial basis function neural network is to optimize the operational parameter in real time responsive to the detecting of the change in the emotional state of the rider by the recurrent neural network. In embodiments, the recurrent neural network detects a pattern of the feature vectors that indicates the emotional state of the rider is changing from a first emotional state to a second emotional state. In embodiments, the radial basis function neural network is to optimize the operational parameter of the vehicle in response to the indicated change in emotional state.

In embodiments, the recurrent neural network comprises a plurality of connected nodes that form a directed cycle, the recurrent neural network further facilitating bi-directional flow of data among the connected nodes. In embodiments, the feature vectors indicate at least one of the emotional state of the rider is changing, the emotional state of the rider is stable, a rate of change of the emotional state of the rider, a direction of change of the emotional state of the rider, and a polarity of a change of the emotional state of the rider; the emotional state of a rider is changing to an unfavorable emotional state; and an emotional state of a rider is changing to a favorable emotional state. In embodiments, the operational parameter that is optimized affects at least one of a route of the vehicle, in-vehicle audio content, speed of the vehicle, acceleration of the vehicle, deceleration of the vehicle, proximity to objects along the route, and proximity to other vehicles along the route.

In embodiments, the radial basis function neural network is to interact with a vehicle control system 30134 to adjust the operational parameter 30124. In embodiments, the artificial intelligence system 3036 further comprises a neural network that includes one or more perceptrons that mimic human senses that facilitates determining the emotional state of a rider based on an extent to which at least one of the senses of the rider is stimulated. In embodiments, the artificial intelligence system 3036 is to maintain the favorable emotional state of the rider via a modular neural network, the modular neural network comprising: a rider emotional state determining neural network to process the feature vectors of the image of the face of the rider in the vehicle to detect patterns. In embodiments, the patterns in the feature vectors indicate at least one of the favorable emotional state and the unfavorable emotional state; an intermediary circuit to convert data from the rider emotional state determining neural network into vehicle operational state data; and a vehicle operational state optimizing neural network to adjust an operational parameter of the vehicle in response to the vehicle operational state data.

In embodiments, the vehicle operational state optimizing neural network is to adjust the operational parameter 30124 of the vehicle for achieving a favorable emotional state of the rider. In embodiments, the vehicle operational state optimizing neural network is to optimize the operational parameter based on a correlation between a vehicle operating state 3045 and a rider emotional state 3066. In embodiments, the operational parameter of the vehicle that is optimized is determined and adjusted to induce a favorable rider emotional state. In embodiments, the rider emotional state determining neural network further learns to classify the patterns of the feature vectors and associate the pattern of the feature vectors to emotional states and changes thereto from a training data set sourced from at least one of a stream of data from unstructured data sources, social media sources, wearable devices, in-vehicle sensors, a rider helmet, a rider headgear, and a rider voice 3228 system.

In embodiments, the vehicle operational state optimizing neural network is to optimize the operational parameter 30124 in real time responsive to the detecting of a change in an emotional state 30126 of the rider by the rider emotional state determining neural network. In embodiments, the rider emotional state determining neural network is to detect a pattern of the feature vectors 30130 that indicates the emotional state of the rider is changing from a first emotional state to a second emotional state. In embodiments, the vehicle operational state optimizing neural network is to optimize the operational parameter of the vehicle in response to the indicated change in emotional state. In embodiments, the artificial intelligence system 3036 comprises a plurality of connected nodes that form a directed cycle, the artificial intelligence system further facilitating bi-directional flow of data among the connected nodes.

In embodiments, the feature vectors 30130 indicate at least one of the emotional state of the rider is changing, the emotional state of the rider is stable, a rate of change of the emotional state of the rider, a direction of change of the emotional state of the rider, and a polarity of a change of the emotional state of the rider; the emotional state of a rider is changing to an unfavorable emotional state; and the emotional state of the rider is changing to a favorable emotional state. In embodiments, the operational parameter that is optimized affects at least one of a route of the vehicle, in-vehicle audio content, speed of the vehicle, acceleration of the vehicle, deceleration of the vehicle, proximity to objects along the route, and proximity to other vehicles along the route. In embodiments, the vehicle operational state optimizing neural network interacts with a vehicle control system to adjust the operational parameter.

In embodiments, the artificial intelligence system 3036 further comprises a neural net that includes one or more perceptrons that mimic human senses that facilitates determining an emotional state of a rider based on an extent to which at least one of the senses of the rider is stimulated. It is to be understood that the terms “neural net” and “neural network” are used interchangeably in the present disclosure. In embodiments, the rider emotional state determining neural network comprises one or more perceptrons that mimic human senses that facilitates determining an emotional state of a rider based on an extent to which at least one of the senses of the rider is stimulated. In embodiments, the artificial intelligence system 3036 includes a recurrent neural network to indicate a change in the emotional state of the rider in the vehicle through recognition of patterns of the feature vectors of the image of the face of the rider in the vehicle; the transportation system further comprising: a vehicle control system 30134 to control operation of the vehicle by adjusting a plurality of vehicle operational parameters 30124; and a feedback loop to communicate the indicated change in the emotional state of the rider between the vehicle control system 30134 and the artificial intelligence system 3036. In embodiments, the vehicle control system is to adjust at least one of the plurality of vehicle operational parameters 30124 in response to the indicated change in the emotional state of the rider. In embodiments, the vehicle controls system adjusts the at least one of the plurality of vehicle operational parameters based on a correlation between vehicle operational state and rider emotional state.

In embodiments, the vehicle control system adjusts the at least one of the plurality of vehicle operational parameters 30124 that are indicative of a favorable rider emotional state. In embodiments, the vehicle control system 30134 selects an adjustment of the at least one of the plurality of vehicle operational parameters 30124 that is indicative of producing a favorable rider emotional state. In embodiments, the recurrent neural network further learns to classify the patterns of feature vectors and associate them to emotional states and changes thereto from a training data set 30131 sourced from at least one of a stream of data from unstructured data sources, social media sources, wearable devices, in-vehicle sensors, a rider helmet, a rider headgear, and a rider voice system. In embodiments, the vehicle control system 30134 adjusts the at least one of the plurality of vehicle operation parameters 30124 in real time. In embodiments, the recurrent neural network detects a pattern of the feature vectors that indicates the emotional state of the rider is changing from a first emotional state to a second emotional state. In embodiments, the vehicle operation control system adjusts an operational parameter of the vehicle in response to the indicated change in emotional state. In embodiments, the recurrent neural network comprises a plurality of connected nodes that form a directed cycle, the recurrent neural network further facilitating bi-directional flow of data among the connected nodes.

In embodiments, the feature vectors indicating at least one of an emotional state of the rider is changing, an emotional state of the rider is stable, a rate of change of an emotional state of the rider, a direction of change of an emotional state of the rider, and a polarity of a change of an emotional state of the rider; an emotional state of a rider is changing to an unfavorable state; an emotional state of a rider is changing to a favorable state. In embodiments, the at least one of the plurality of vehicle operational parameters responsively adjusted affects a route of the vehicle, in-vehicle audio content, speed of the vehicle, acceleration of the vehicle, deceleration of the vehicle, proximity to objects along the route, proximity to other vehicles along the route. In embodiments, the at least one of the plurality of vehicle operation parameters that is responsively adjusted affects operation of a powertrain of the vehicle and a suspension system of the vehicle. In embodiments, the radial basis function neural network interacts with the recurrent neural network via an intermediary component of the artificial intelligence system 3036 that produces vehicle control data indicative of an emotional state response of the rider to a current operational state of the vehicle. In embodiments, the recognition of patterns of feature vectors comprises processing the feature vectors of the image of the face of the rider captured during at least two of before the adjusting at least one of the plurality of vehicle operational parameters, during the adjusting at least one of the plurality of vehicle operational parameters, and after adjusting at least one of the plurality of vehicle operational parameters.

In embodiments, the adjusting at least one of the plurality of vehicle operational parameters 30124 improves an emotional state of a rider in a vehicle. In embodiments, the adjusting at least one of the plurality of vehicle operational parameters causes an emotional state of the rider to change from an unfavorable emotional state to a favorable emotional state. In embodiments, the change is indicated by the recurrent neural network. In embodiments, the recurrent neural network indicates a change in the emotional state of the rider responsive to a change in an operating parameter of the vehicle by determining a difference between a first set of feature vectors of an image of the face of a rider captured prior to the adjusting at least one of the plurality of operating parameters and a second set of feature vectors of an image of the face of the rider captured during or after the adjusting at least one of the plurality of operating parameters.

In embodiments, the recurrent neural network detects a pattern of the feature vectors that indicates an emotional state of the rider is changing from a first emotional state to a second emotional state. In embodiments, the vehicle operation control system adjusts an operational parameter of the vehicle in response to the indicated change in emotional state.

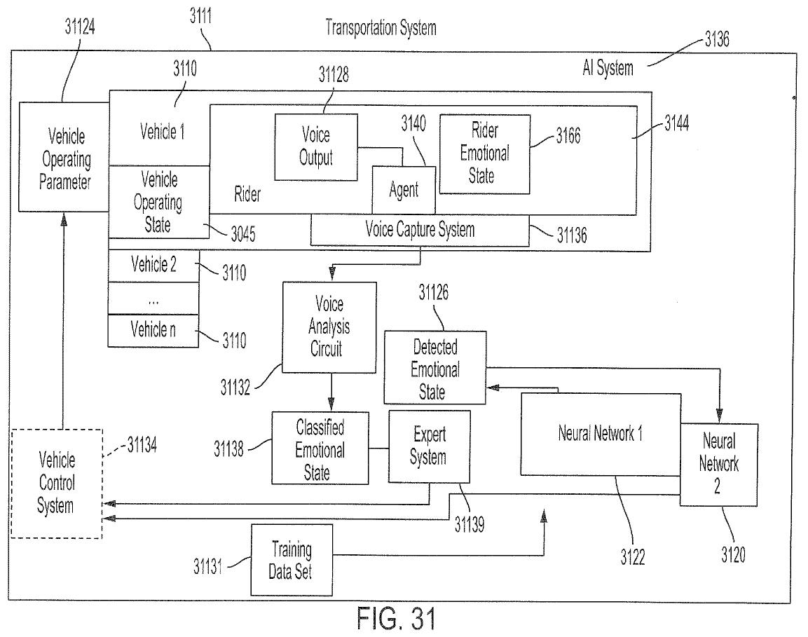

Referring to FIG. 31, in embodiments, provided herein are transportation systems having an artificial intelligence system for processing a voice of a rider in a vehicle to determine an emotional state and optimizing at least one operating parameter of the vehicle to improve the rider's emotional state. A voice-analysis module may take voice input and, using a training set of labeled data where individuals indicate emotional states while speaking and/or whether others tag the data to indicate perceived emotional states while individuals are talking, a machine learning system (such as any of the types described herein) may be trained (such as using supervised learning, deep learning, or the like) to classify the emotional state of the individual based on the voice. Machine learning may improve classification by using feedback from a large set of trials, where feedback in each instance indicates whether the system has correctly assessed the emotional state of the individual in the case of an instance of speaking. Once trained to classify the emotional state, an expert system (optionally using a different machine learning system or other artificial intelligence system) may, based on feedback of outcomes of the emotional states of a set of individuals, be trained to optimize various vehicle parameters noted throughout this disclosure to maintain or induce more favorable states. For example, among many other indicators, where a voice of an individual indicates happiness, the expert system may select or recommend upbeat music to maintain that state. Where a voice indicates stress, the system may recommend or provide a control signal to change a planned route to one that is less stressful (e.g., has less stop-and-go traffic, or that has a higher probability of an on-time arrival). In embodiments, the system may be configured to engage in a dialog (such as on on-screen dialog or an audio dialog), such as using an intelligent agent module of the system, that is configured to use a series of questions to help obtain feedback from a user about the user's emotional state, such as asking the rider about whether the rider is experiencing stress, what the source of the stress may be (e.g., traffic conditions, potential for late arrival, behavior of other drivers, or other sources unrelated to the nature of the ride), what might mitigate the stress (route options, communication options (such as offering to send a note that arrival may be delayed), entertainment options, ride configuration options, and the like), and the like. Driver responses may be fed as inputs to the expert system as indicators of emotional state, as well as to constrain efforts to optimize one or more vehicle parameters, such as by eliminating options for configuration that are not related to a driver's source of stress from a set of available configurations.

An aspect provided herein includes a transportation system 3111, comprising: an artificial intelligence system 3136 for processing a voice 31135 of a rider 3144 in a vehicle 3110 to determine an emotional state 3166 of the rider 3144 and optimizing at least one operating parameter 31124 of the vehicle 3110 to improve the emotional state 3166 of the rider 3144.

An aspect provided herein includes an artificial intelligence system 3136 for voice processing to improve rider satisfaction in a transportation system 3111, comprising: a rider voice capture system 30136 deployed to capture voice output 31128 of a rider 3144 occupying a vehicle 3110; a voice-analysis circuit 31132 trained using machine learning that classifies an emotional state 31138 of the rider for the captured voice output of the rider; and an expert system 31139 trained using machine learning that optimizes at least one operating parameter 31124 of the vehicle to change the rider emotional state to an emotional state classified as an improved emotional state.

In embodiments, the rider voice capture system 31136 comprises an intelligent agent 3140 that engages in a dialog with the rider to obtain rider feedback for use by the voice-analysis circuit 31132 for rider emotional state classification. In embodiments, the voice-analysis circuit 31132 uses a first machine learning system and the expert system 31139 uses a second machine learning system. In embodiments, the expert system 31139 is trained to optimize the at least one operating parameter 31124 based on feedback of outcomes of the emotional states when adjusting the at least one operating parameter 31124 for a set of individuals. In embodiments, the emotional state 3166 of the rider is determined by a combination of the captured voice output 31128 of the rider and at least one other parameter. In embodiments, the at least one other parameter is a camera-based emotional state determination of the rider. In embodiments, the at least one other parameter is traffic information. In embodiments, the at least one other parameter is weather information. In embodiments, the at least one other parameter is a vehicle state. In embodiments, the at least one other parameter is at least one pattern of physiological data of the rider. In embodiments, the at least one other parameter is a route of the vehicle. In embodiments, the at least one other parameter is in-vehicle audio content. In embodiments, the at least one other parameter is a speed of the vehicle. In embodiments, the at least one other parameter is acceleration of the vehicle. In embodiments, the at least one other parameter is deceleration of the vehicle. In embodiments, the at least one other parameter is proximity to objects along the route. In embodiments, the at least one other parameter is proximity to other vehicles along the route.

An aspect provided herein includes an artificial intelligence system 3136 for voice processing to improve rider satisfaction, comprising: a first neural network 3122 trained to classify emotional states based on analysis of human voices detects an emotional state of a rider through recognition of aspects of the voice output 31128 of the rider captured while the rider is occupying the vehicle 3110 that correlate to at least one emotional state 3166 of the rider; and a second neural network 3120 that optimizes, for achieving a favorable emotional state of the rider, an operational parameter 31124 of the vehicle in response to the detected emotional state 31126 of the rider 3144. In embodiments, at least one of the neural networks is a convolutional neural network. In embodiments, the first neural network 3122 is trained through use of a training data set that associates emotional state classes with human voice patterns. In embodiments, the first neural network 3122 is trained through the use of a training data set of voice recordings that are tagged with emotional state identifying data. In embodiments, the emotional state of the rider is determined by a combination of the captured voice output of the rider and at least one other parameter. In embodiments, the at least one other parameter is a camera-based emotional state determination of the rider. In embodiments, the at least one other parameter is traffic information. In embodiments, the at least one other parameter is weather information. In embodiments, the at least one other parameter is a vehicle state.

In embodiments, the at least one other parameter is at least one pattern of physiological data of the rider. In embodiments, the at least one other parameter is a route of the vehicle. In embodiments, the at least one other parameter is in-vehicle audio content. In embodiments, the at least one other parameter is a speed of the vehicle. In embodiments, the at least one other parameter is acceleration of the vehicle. In embodiments, the at least one other parameter is deceleration of the vehicle. In embodiments, the at least one other parameter is proximity to objects along the route. In embodiments, the at least one other parameter is proximity to other vehicles along the route.

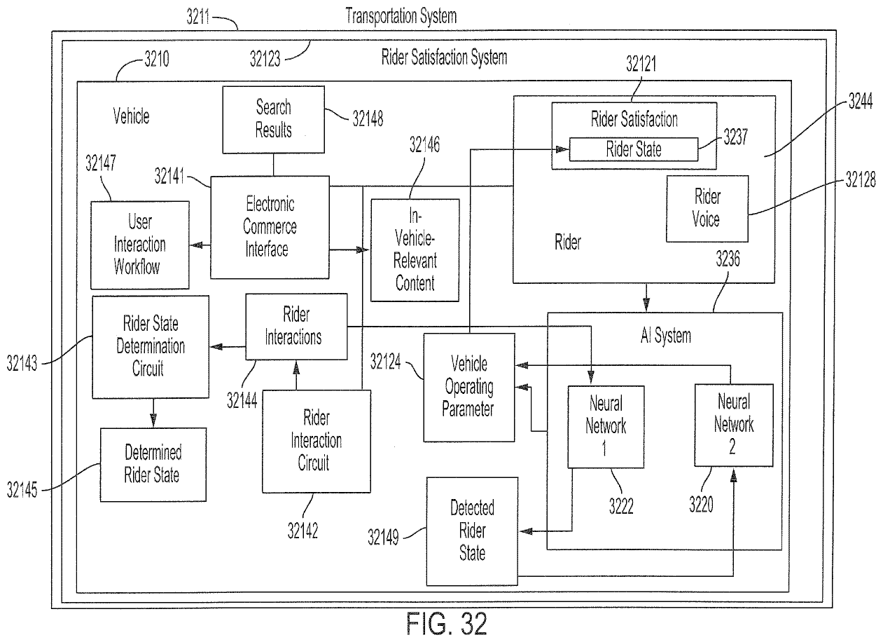

Referring now to FIG. 32, in embodiments provided herein are transportation systems 3211 having an artificial intelligence system 3236 for processing data from an interaction of a rider with an electronic commerce system of a vehicle to determine a rider state and optimizing at least one operating parameter of the vehicle to improve the rider's state. Another common activity for users of device interfaces is e-commerce, such as shopping, bidding in auctions, selling items and the like. E-commerce systems use search functions, undertake advertising and engage users with various workflows that may eventually result in an order, a purchase, a bid, or the like. As described herein with search, a set of in-vehicle-relevant search results may be provided for e-commerce, as well as in-vehicle relevant advertising. In addition, in-vehicle-relevant interfaces and workflows may be configured based on detection of an in-vehicle rider, which may be quite different than workflows that are provided for e-commerce interfaces that are configured for smart phones or for desktop systems. Among other factors, an in-vehicle system may have access to information that is unavailable to conventional e-commerce systems, including route information (including direction, planned stops, planned duration and the like), rider mood and behavior information (such as from past routes, as well as detected from in-vehicle sensor sets), vehicle configuration and state information (such as make and model), and any of the other vehicle-related parameters described throughout this disclosure. As one example, a rider who is bored (as detected by an in-vehicle sensor set, such as using an expert system that is trained to detect boredom) and is on a long trip (as indicated by a route that is being undertaken by a car) may be far more patient, and likely to engage in deeper, richer content, and longer workflows, than a typical mobile user. As another example, an in-vehicle rider may be far more likely to engage in free trials, surveys, or other behaviors that promote brand engagement. Also, an in-vehicle user may be motivated to use otherwise down time to accomplish specific goals, such as shopping for needed items. Presenting the same interfaces, content, and workflows to in-vehicle users may miss excellent opportunities for deeper engagement that would be highly unlikely in other settings where many more things may compete for a user's attention. In embodiments, an e-commerce system interface may be provided for in-vehicle users, where at least one of interface displays, content, search results, advertising, and one or more associated workflows (such as for shopping, bidding, searching, purchasing, providing feedback, viewing products, entering ratings or reviews, or the like) is configured based on the detection of the use of an in-vehicle interface. Displays and interactions may be further configured (optionally based on a set of rules or based on machine learning), such as based on detection of display types (e.g., allowing richer or larger images for large, HD displays), network capabilities (e.g., enabling faster loading and lower latency by caching low-resolution images that initially render), audio system capabilities (such as using audio for dialog management and intelligence assistant interactions) and the like for the vehicle. Display elements, content, and workflows may be configured by machine learning, such as by A/B testing and/or using genetic programming techniques, such as configuring alternative interaction types and tracking outcomes. Outcomes used to train automatic configuration of workflows for in-vehicle e-commerce interfaces may include extent of engagement, yield, purchases, rider satisfaction, ratings, and others. In-vehicle users may be profiled and clustered, such as by behavioral profiling, demographic profiling, psychographic profiling, location-based profiling, collaborative filtering, similarity-based clustering, or the like, as with conventional e-commerce, but profiles may be enhanced with route information, vehicle information, vehicle configuration information, vehicle state information, rider information and the like. A set of in-vehicle user profiles, groups and clusters may be maintained separately from conventional user profiles, such that learning on what content to present, and how to present it, is accomplished with increased likelihood that the differences in in-vehicle shopping area accounted for when targeting search results, advertisements, product offers, discounts, and the like.

An aspect provided herein includes a transportation system 3211, comprising: an artificial intelligence system 3236 for processing data from an interaction of a rider 3244 with an electronic commerce system of a vehicle to determine a rider state 3249 and optimizing at least one operating parameter of the vehicle to improve the rider state.

An aspect provided herein includes a rider satisfaction system 3223 for optimizing rider satisfaction 3221, the rider satisfaction system comprising: an electronic commerce interface 3241 deployed for access by a rider in a vehicle 3210; a rider interaction circuit that captures rider interactions with the deployed interface 3241; a rider state determination circuit 3243 that processes the captured rider interactions 3244 to determine a rider state 3237; and an artificial intelligence system 3236 trained to optimize, responsive to a rider state 3237, at least one parameter 3224 affecting operation of the vehicle to improve the rider state 3237. In embodiments, the vehicle 3210 comprises a system for automating at least one control parameter of the vehicle. In embodiments, the vehicle is at least a semi-autonomous vehicle. In embodiments, the vehicle is automatically routed. In embodiments, the vehicle is a self-driving vehicle. In embodiments, the electronic commerce interface is self-adaptive and responsive to at least one of an identity of the rider, a route of the vehicle, a rider mood, rider behavior, vehicle configuration, and vehicle state.

In embodiments, the electronic commerce interface 3241 provides in-vehicle-relevant content 3246 that is based on at least one of an identity of the rider, a route of the vehicle, a rider mood, rider behavior, vehicle configuration, and vehicle state. In embodiments, the electronic commerce interface executes a user interaction workflow 3247 adapted for use by a rider 3244 in a vehicle 3210. In embodiments, the electronic commerce interface provides one or more results of a search query 3248 that are adapted for presentation in a vehicle. In embodiments, the search query results adapted for presentation in a vehicle are presented in the electronic commerce interface along with advertising adapted for presentation in a vehicle. In embodiments, the rider interaction circuit 3242 captures rider interactions 3244 with the interface responsive to content 3246 presented in the interface.

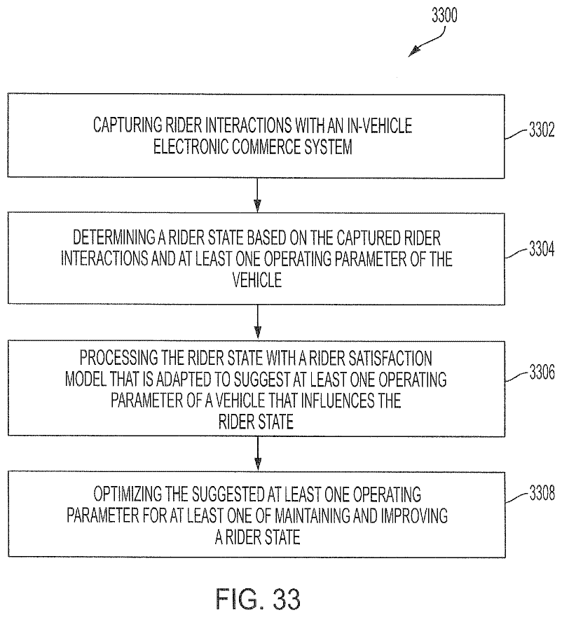

FIG. 33 illustrates a method 3300 for optimizing a parameter of a vehicle in accordance with embodiments of the systems and methods disclosed herein. At 3302 the method includes capturing rider interactions with an in-vehicle electronic commerce system. At 3304 the method includes determining a rider state based on the captured rider interactions and a least one operating parameter of the vehicle. At 3306 the method includes processing the rider state with a rider satisfaction model that is adapted to suggest at least one operating parameter of a vehicle the influences the rider state. At 3308 the method includes optimizing the suggested at least one operating parameter for at least one of maintaining and improving a rider state.

Referring to FIG. 32 and FIG. 33, an aspect provided herein includes an artificial intelligence system 3236 for improving rider satisfaction, comprising: a first neural network 3222 trained to classify rider states based on analysis of rider interactions 32144 with an in-vehicle electronic commerce system to detect a rider state 32149 through recognition of aspects of the rider interactions 32144 captured while the rider is occupying the vehicle that correlate to at least one state 3237 of the rider; and a second neural network 3220 that optimizes, for achieving a favorable state of the rider, an operational parameter of the vehicle in response to the detected state of the rider.

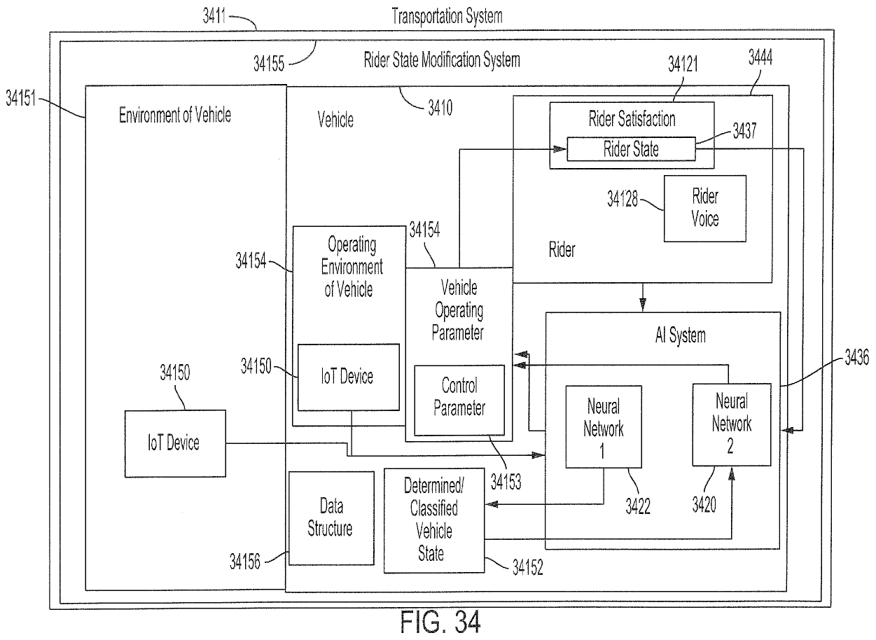

Referring to FIG. 34, in embodiments provided herein are transportation systems 3411 having an artificial intelligence system 3436 for processing data from at least one Internet of Things (IOT) device 3450 in the environment 3451 of a vehicle 3410 to determine a state 3452 of the vehicle and optimizing at least one operating parameter 3424 of the vehicle to improve a rider's state 3437 based on the determined state 34152 of the vehicle.

An aspect provided herein includes a system for transportation 3411, comprising: an artificial intelligence system 3436 for processing data from at least one Internet of Things device 34150 in an environment 34151 of a vehicle 3410 to determine a determined state 3452 of the vehicle and optimizing at least one operating parameter 3424 of the vehicle to improve a state 3437 of the rider based on the determined state 3452 of the vehicle 3410.

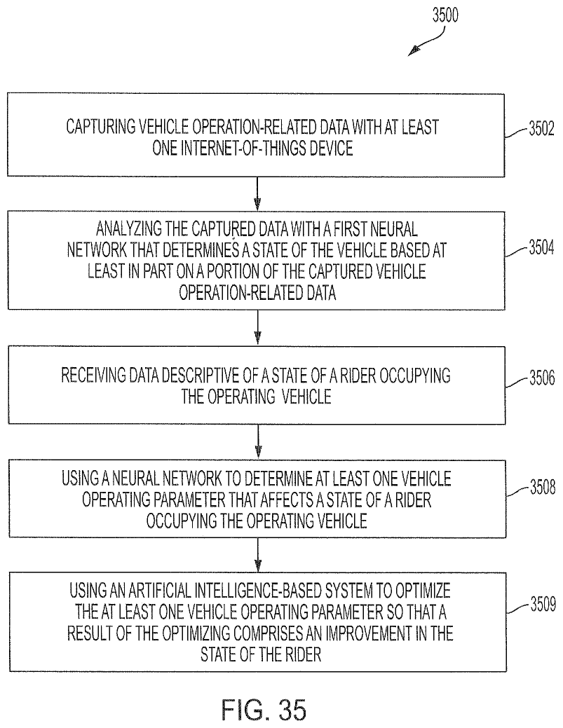

FIG. 35 illustrates a method 3500 for improving a state of a rider through optimization of operation of a vehicle in accordance with embodiments of the systems and methods disclosed herein. At 3502 the method includes capturing vehicle operation-related data with at least one Internet-of-things device. At 3504 the method includes analyzing the captured data with a first neural network that determines a state of the vehicle based at least in part on a portion of the captured vehicle operation-related data. At 3506 the method includes receiving data descriptive of a state of a rider occupying the operating vehicle. At 3508 the method includes using a neural network to determine at least one vehicle operating parameter that affects a state of a rider occupying the operating vehicle. At 3509 the method includes using an artificial intelligence-based system to optimize the at least one vehicle operating parameter so that a result of the optimizing comprises an improvement in the state of the rider.

Referring to FIG. 34 and FIG. 35, in embodiments, the vehicle 3410 comprises a system for automating at least one control parameter 3453 of the vehicle 3410. In embodiments, the vehicle 3410 is at least a semi-autonomous vehicle. In embodiments, the vehicle 3410 is automatically routed. In embodiments, the vehicle 3410 is a self-driving vehicle. In embodiments, the at least one Internet-of-things device 3450 is disposed in an operating environment 3454 of the vehicle. In embodiments, the at least one Internet-of-things device 3450 that captures the data about the vehicle 3410 is disposed external to the vehicle 3410. In embodiments, the at least one Internet-of-things device is a dashboard camera. In embodiments, the at least one Internet-of-things device is a mirror camera. In embodiments, the at least one Internet-of-things device is a motion sensor. In embodiments, the at least one Internet-of-things device is a seat-based sensor system. In embodiments, the at least one Internet-of-things device is an IoT enabled lighting system. In embodiments, the lighting system is a vehicle interior lighting system. In embodiments, the lighting system is a headlight lighting system. In embodiments, the at least one Internet-of-things device is a traffic light camera or sensor. In embodiments, the at least one Internet-of-things device is a roadway camera. In embodiments, the roadway camera is disposed on at least one of a telephone phone and a light pole. In embodiments, the at least one Internet-of-things device is an in-road sensor. In embodiments, the at least one Internet-of-things device is an in-vehicle thermostat. In embodiments, the at least one Internet-of-things device is a toll booth. In embodiments, the at least one Internet-of-things device is a street sign. In embodiments, the at least one Internet-of-things device is a traffic control light. In embodiments, the at least one Internet-of-things device is a vehicle mounted sensor. In embodiments, the at least one Internet-of-things device is a refueling system. In embodiments, the at least one Internet-of-things device is a recharging system. In embodiments, the at least one Internet-of-things device is a wireless charging station.

An aspect provided herein includes a rider state modification system 34155 for improving a state 3437 of a rider 3444 in a vehicle 3410, the system comprising: a first neural network 3422 that operates to classify a state of the vehicle through analysis of information about the vehicle captured by an Internet-of-things device 3450 during operation of the vehicle 3410; and a second neural network 3420 that operates to optimize at least one operating parameter 3424 of the vehicle based on the classified state 3452 of the vehicle, information about a state of a rider occupying the vehicle, and information that correlates vehicle operation with an effect on rider state.

In embodiments, the vehicle comprises a system for automating at least one control parameter 3453 of the vehicle 3410. In embodiments, the vehicle 3410 is at least a semi-autonomous vehicle. In embodiments, the vehicle 3410 is automatically routed. In embodiments, the vehicle 3410 is a self-driving vehicle. In embodiments, the at least one Internet-of-things device 34150 is disposed in an operating environment of the vehicle 3410. In embodiments, the at least one Internet-of-things device 3450 that captures the data about the vehicle 3410 is disposed external to the vehicle 3410. In embodiments, the at least one Internet-of-things device is a dashboard camera. In embodiments, the at least one Internet-of-things device is a mirror camera. In embodiments, the at least one Internet-of-things device is a motion sensor. In embodiments, the at least one Internet-of-things device is a seat-based sensor system. In embodiments, the at least one Internet-of-things device is an IoT enabled lighting system.

In embodiments, the lighting system is a vehicle interior lighting system. In embodiments, the lighting system is a headlight lighting system. In embodiments, the at least one Internet-of-things device is a traffic light camera or sensor. In embodiments, the at least one Internet-of-things device is a roadway camera. In embodiments, the roadway camera is disposed on at least one of a telephone phone and a light pole. In embodiments, the at least one Internet-of-things device is an in-road sensor. In embodiments, the at least one Internet-of-things device is an in-vehicle thermostat. In embodiments, the at least one Internet-of-things device is a toll booth. In embodiments, the at least one Internet-of-things device is a street sign. In embodiments, the at least one Internet-of-things device is a traffic control light. In embodiments, the at least one Internet-of-things device is a vehicle mounted sensor. In embodiments, the at least one Internet-of-things device is a refueling system. In embodiments, the at least one Internet-of-things device is a recharging system. In embodiments, the at least one Internet-of-things device is a wireless charging station.

An aspect provided herein includes an artificial intelligence system 3436 comprising: a first neural network 3422 trained to determine an operating state 3452 of a vehicle 3410 from data about the vehicle captured in an operating environment 3454 of the vehicle, wherein the first neural network 3422 operates to identify an operating state 3452 of the vehicle by processing information about the vehicle 3410 that is captured by at least one Internet-of things device 3450 while the vehicle is operating; a data structure 3456 that facilitates determining operating parameters that influence an operating state of a vehicle; a second neural network 3420 that operates to optimize at least one of the determined operating parameters 3424 of the vehicle based on the identified operating state 3452 by processing information about a state of a rider 3444 occupying the vehicle 3410, and information that correlates vehicle operation with an effect on rider state.

In embodiments, the improvement in the state of the rider is reflected in updated data that is descriptive of a state of the rider captured responsive to the vehicle operation based on the optimized at least one vehicle operating parameter. In embodiments, the improvement in the state of the rider is reflected in data captured by at least one Internet-of-things device 3450 disposed to capture information about the rider 3444 while occupying the vehicle 3410 responsive to the optimizing. In embodiments, the vehicle 3410 comprises a system for automating at least one control parameter 3453 of the vehicle. In embodiments, the vehicle 3410 is at least a semi-autonomous vehicle. In embodiments, the vehicle 3410 is automatically routed. In embodiments, the vehicle 3410 is a self-driving vehicle. In embodiments, the at least one Internet-of-things device 3450 is disposed in an operating environment 3454 of the vehicle. In embodiments, the at least one Internet-of-things device 3450 that captures the data about the vehicle is disposed external to the vehicle. In embodiments, the at least one Internet-of-things device 3450 is a dashboard camera. In embodiments, the at least one Internet-of-things device 3450 is a mirror camera. In embodiments, the at least one Internet-of-things device 3450 is a motion sensor. In embodiments, the at least one Internet-of-things device 3450 is a seat-based sensor system. In embodiments, the at least one Internet-of-things device 3450 is an IoT enabled lighting system.

In embodiments, the lighting system is a vehicle interior lighting system. In embodiments, the lighting system is a headlight lighting system. In embodiments, the at least one Internet-of-things device 3450 is a traffic light camera or sensor. In embodiments, the at least one Internet-of-things device 3450 is a roadway camera. In embodiments, the roadway camera is disposed on at least one of a telephone phone and a light pole. In embodiments, the at least one Internet-of-things device 3450 is an in-road sensor. In embodiments, the at least one Internet-of-things device 3450 is an in-vehicle thermostat. In embodiments, the at least one Internet-of-things device 34150 is a toll booth. In embodiments, the at least one Internet-of-things device 3450 is a street sign. In embodiments, the at least one Internet-of-things device 3450 is a traffic control light. In embodiments, the at least one Internet-of-things device 3450 is a vehicle mounted sensor. In embodiments, the at least one Internet-of-things device 3450 is a refueling system. In embodiments, the at least one Internet-of-things device 3450 is a recharging system. In embodiments, the at least one Internet-of-things device 3450 is a wireless charging station.

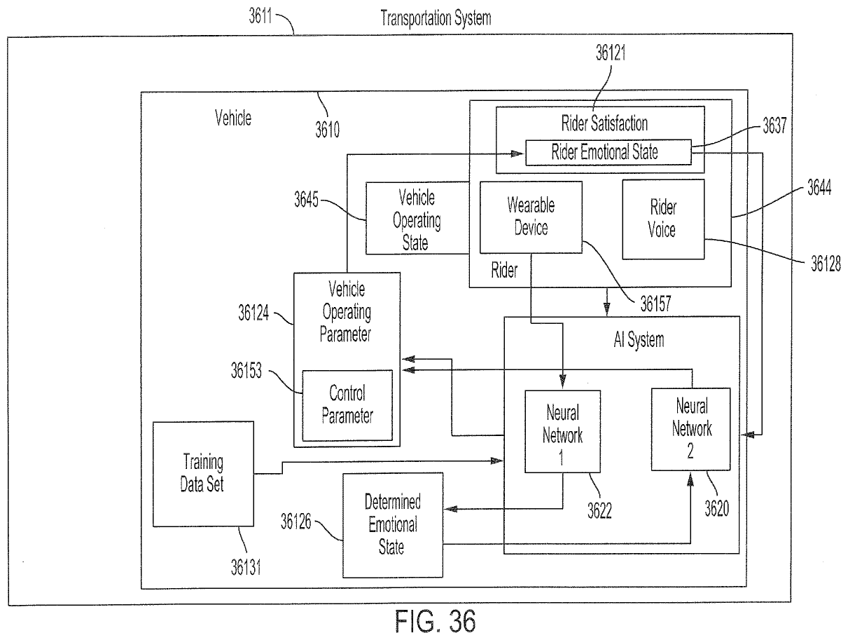

Referring to FIG. 36, in embodiments provided herein are transportation systems 3611 having an artificial intelligence system 3636 for processing a sensory input from a wearable device 3657 in a vehicle 3610 to determine an emotional state 3626 and optimizing at least one operating parameter 3624 of the vehicle 3610 to improve the rider's emotional state 3637. A wearable device 3657, such as any described throughout this disclosure, may be used to detect any of the emotional states described herein (favorable or unfavorable) and used both as an input to a real-time control system (such as a model-based, rule-based, or artificial intelligence system of any of the types described herein), such as to indicate an objective to improve an unfavorable state or maintain a favorable state, as well as a feedback mechanism to train an artificial intelligence system 3636 to configure sets of operating parameters 3624 to promote or maintain favorable states.

An aspect provided herein includes a system for transportation 3611, comprising: an artificial intelligence system 3636 for processing a sensory input from a wearable device 36157 in a vehicle 3610 to determine an emotional state 3626 of a rider 3644 in the vehicle 3610 and optimizing an operating parameter 36124 of the vehicle to improve the emotional state 3637 of the rider 3644. In embodiments, the vehicle is a self-driving vehicle. In embodiments, the artificial intelligence system 3636 is to detect the emotional state 36126 of the rider riding in the self-driving vehicle by recognition of patterns of emotional state indicative data from a set of wearable sensors 36157 worn by the rider 3644. In embodiments, the patterns are indicative of at least one of a favorable emotional state of the rider and an unfavorable emotional state of the rider. In embodiments, the artificial intelligence system 3636 is to optimize, for achieving at least one of maintaining a detected favorable emotional state of the rider and achieving a favorable emotional state of a rider subsequent to a detection of an unfavorable emotional state, the operating parameter 36124 of the vehicle in response to the detected emotional state of the rider. In embodiments, the artificial intelligence system 3636 comprises an expert system that detects an emotional state of the rider by processing rider emotional state indicative data received from the set of wearable sensors 36157 worn by the rider. In embodiments, the expert system processes the rider emotional state indicative data using at least one of a training set of emotional state indicators of a set of riders and trainer-generated rider emotional state indicators. In embodiments, the artificial intelligence system comprises a recurrent neural network 3622 that detects the emotional state of the rider.

In embodiments, the recurrent neural network comprises a plurality of connected nodes that form a directed cycle, the recurrent neural network further facilitating bi-directional flow of data among the connected nodes. In embodiments, the artificial intelligence system 3636 comprises a radial basis function neural network that optimizes the operational parameter 36124. In embodiments, the optimizing an operational parameter 36124 is based on a correlation between a vehicle operating state 3645 and a rider emotional state 3637. In embodiments, the correlation is determined using at least one of a training set of emotional state indicators of a set of riders and human trainer-generated rider emotional state indicators. In embodiments, the operational parameter of the vehicle that is optimized is determined and adjusted to induce a favorable rider emotional state.

In embodiments, the artificial intelligence system 3636 further learns to classify the patterns of the emotional state indicative data and associate the patterns to emotional states and changes thereto from a training data set 36131 sourced from at least one of a stream of data from unstructured data sources, social media sources, wearable devices, in-vehicle sensors, a rider helmet, a rider headgear, and a rider voice system. In embodiments, the artificial intelligence system 3636 detects a pattern of the rider emotional state indicative data that indicates the emotional state of the rider is changing from a first emotional state to a second emotional state, the optimizing of the operational parameter of the vehicle being response to the indicated change in emotional state. In embodiments, the patterns of rider emotional state indicative data indicates at least one of an emotional state of the rider is changing, an emotional state of the rider is stable, a rate of change of an emotional state of the rider, a direction of change of an emotional state of the rider, and a polarity of a change of an emotional state of the rider; an emotional state of a rider is changing to an unfavorable state; and an emotional state of a rider is changing to a favorable state.

In embodiments, the operational parameter 36124 that is optimized affects at least one of a route of the vehicle, in-vehicle audio content, speed of the vehicle, acceleration of the vehicle, deceleration of the vehicle, proximity to objects along the route, and proximity to other vehicles along the route. In embodiments, the artificial intelligence system 3636 interacts with a vehicle control system to optimize the operational parameter. In embodiments, the artificial intelligence system 3636 further comprises a neural net 3622 that includes one or more perceptrons that mimic human senses that facilitates determining an emotional state of a rider based on an extent to which at least one of the senses of the rider is stimulated. In embodiments, the set of wearable sensors 36157 comprises at least two of a watch, a ring, a wrist band, an arm band, an ankle band, a torso band, a skin patch, a head-worn device, eye glasses, foot wear, a glove, an in-ear device, clothing, headphones, a belt, a finger ring, a thumb ring, a toe ring, and a necklace. In embodiments, the artificial intelligence system 3636 uses deep learning for determining patterns of wearable sensor-generated emotional state indicative data that indicate an emotional state of the rider as at least one of a favorable emotional state and an unfavorable emotional state. In embodiments, the artificial intelligence system 3636 is responsive to a rider indicated emotional state by at least optimizing the operation parameter to at least one of achieve and maintain the rider indicated emotional state.

In embodiments, the artificial intelligence system 3636 adapts a characterization of a favorable emotional state of the rider based on context gathered from a plurality of sources including data indicating a purpose of the rider riding in the self-driving vehicle, a time of day, traffic conditions, weather conditions and optimizes the operating parameter 36124 to at least one of achieve and maintain the adapted favorable emotional state. In embodiments, the artificial intelligence system 3636 optimizes the operational parameter in real time responsive to the detecting of an emotional state of the rider. In embodiments, the vehicle is a self-driving vehicle. In embodiments, the artificial intelligence system comprises: a first neural network 3622 to detect the emotional state of the rider through expert system-based processing of rider emotional state indicative wearable sensor data of a plurality of wearable physiological condition sensors worn by the rider in the vehicle, the emotional state indicative wearable sensor data indicative of at least one of a favorable emotional state of the rider and an unfavorable emotional state of the rider; and a second neural network 3620 to optimize, for at least one of achieving and maintaining a favorable emotional state of the rider, the operating parameter 36124 of the vehicle in response to the detected emotional state of the rider. In embodiments, the first neural network 3622 is a recurrent neural network and the second neural network 3620 is a radial basis function neural network.

In embodiments, the second neural network 3620 optimizes the operational parameter 36124 based on a correlation between a vehicle operating state 3645 and a rider emotional state 3637. In embodiments, the operational parameter of the vehicle that is optimized is determined and adjusted to induce a favorable rider emotional state. In embodiments, the first neural network 3622 further learns to classify patterns of the rider emotional state indicative wearable sensor data and associate the patterns to emotional states and changes thereto from a training data set sourced from at least one of a stream of data from unstructured data sources, social media sources, wearable devices, in-vehicle sensors, a rider helmet, a rider headgear, and a rider voice system. In embodiments, the second neural network 3620 optimizes the operational parameter in real time responsive to the detecting of an emotional state of the rider by the first neural network 3622. In embodiments, the first neural network 3622 detects a pattern of the rider emotional state indicative wearable sensor data that indicates the emotional state of the rider is changing from a first emotional state to a second emotional state. In embodiments, the second neural network 3620 optimizes the operational parameter of the vehicle in response to the indicated change in emotional state.

In embodiments, the first neural network 3622 comprises a plurality of connected nodes that form a directed cycle, the first neural network 3622 further facilitating bi-directional flow of data among the connected nodes. In embodiments, the first neural network 3622 includes one or more perceptrons that mimic human senses that facilitates determining an emotional state of a rider based on an extent to which at least one of the senses of the rider is stimulated. In embodiments, the rider emotional state indicative wearable sensor data indicates at least one of an emotional state of the rider is changing, an emotional state of the rider is stable, a rate of change of an emotional state of the rider, a direction of change of an emotional state of the rider, and a polarity of a change of an emotional state of the rider; an emotional state of a rider is changing to an unfavorable state; and an emotional state of a rider is changing to a favorable state. In embodiments, the operational parameter that is optimized affects at least one of a route of the vehicle, in-vehicle audio content, speed of the vehicle, acceleration of the vehicle, deceleration of the vehicle, proximity to objects along the route, and proximity to other vehicles along the route. In embodiments, the second neural network 3620 interacts with a vehicle control system to adjust the operational parameter. In embodiments, the first neural network 3622 includes one or more perceptrons that mimic human senses that facilitates determining an emotional state of a rider based on an extent to which at least one of the senses of the rider is stimulated.

In embodiments, the vehicle is a self-driving vehicle. In embodiments, the artificial intelligence system 3636 is to detect a change in the emotional state of the rider riding in the self-driving vehicle at least in part by recognition of patterns of emotional state indicative data from a set of wearable sensors worn by the rider. In embodiments, the patterns are indicative of at least one of a diminishing of a favorable emotional state of the rider and an onset of an unfavorable emotional state of the rider. In embodiments, the artificial intelligence system 3636 is to determine at least one operating parameter 36124 of the self-driving vehicle that is indicative of the change in emotional state based on a correlation of the patterns of emotional state indicative data with a set of operating parameters of the vehicle. In embodiments, the artificial intelligence system 3636 is to determine an adjustment of the at least one operating parameter 36124 for achieving at least one of restoring the favorable emotional state of the rider and achieving a reduction in the onset of the unfavorable emotional state of a rider.

In embodiments, the correlation of patterns of rider emotional indicative state wearable sensor data is determined using at least one of a training set of emotional state wearable sensor indicators of a set of riders and human trainer-generated rider emotional state wearable sensor indicators. In embodiments, the artificial intelligence system 3636 further learns to classify the patterns of the emotional state indicative wearable sensor data and associate the patterns to changes in rider emotional states from a training data set sourced from at least one of a stream of data from unstructured data sources, social media sources, wearable devices, in-vehicle sensors, a rider helmet, a rider headgear, and a rider voice system. In embodiments, the patterns of rider emotional state indicative wearable sensor data indicates at least one of an emotional state of the rider is changing, an emotional state of the rider is stable, a rate of change of an emotional state of the rider, a direction of change of an emotional state of the rider, and a polarity of a change of an emotional state of the rider; an emotional state of a rider is changing to an unfavorable state; and an emotional state of a rider is changing to a favorable state.

In embodiments, the operational parameter determined from a result of processing the rider emotional state indicative wearable sensor data affects at least one of a route of the vehicle, in-vehicle audio content, speed of the vehicle, acceleration of the vehicle, deceleration of the vehicle, proximity to objects along the route, and proximity to other vehicles along the route. In embodiments, the artificial intelligence system 3636 further interacts with a vehicle control system for adjusting the operational parameter. In embodiments, the artificial intelligence system 3636 further comprises a neural net that includes one or more perceptrons that mimic human senses that facilitate determining an emotional state of a rider based on an extent to which at least one of the senses of the rider is stimulated.

In embodiments, the set of wearable sensors comprises at least two of a watch, a ring, a wrist band, an arm band, an ankle band, a torso band, a skin patch, a head-worn device, eye glasses, foot wear, a glove, an in-ear device, clothing, headphones, a belt, a finger ring, a thumb ring, a toe ring, and a necklace. In embodiments, the artificial intelligence system 3636 uses deep learning for determining patterns of wearable sensor-generated emotional state indicative data that indicate the change in the emotional state of the rider. In embodiments, the artificial intelligence system 3636 further determines the change in emotional state of the rider based on context gathered from a plurality of sources including data indicating a purpose of the rider riding in the self-driving vehicle, a time of day, traffic conditions, weather conditions and optimizes the operating parameter 36124 to at least one of achieve and maintain the adapted favorable emotional state. In embodiments, the artificial intelligence system 3636 adjusts the operational parameter in real time responsive to the detecting of a change in rider emotional state.

In embodiments, the vehicle is a self-driving vehicle. In embodiments, the artificial intelligence system 3636 includes: a recurrent neural network to indicate a change in the emotional state of a rider in the self-driving vehicle by a recognition of patterns of emotional state indicative wearable sensor data from a set of wearable sensors worn by the rider. In embodiments, the patterns are indicative of at least one of a first degree of an favorable emotional state of the rider and a second degree of an unfavorable emotional state of the rider; and a radial basis function neural network to optimize, for achieving a target emotional state of the rider, the operating parameter 36124 of the vehicle in response to the indication of the change in the emotional state of the rider.

In embodiments, the radial basis function neural network optimizes the operational parameter based on a correlation between a vehicle operating state and a rider emotional state. In embodiments, the target emotional state is a favorable rider emotional state and the operational parameter of the vehicle that is optimized is determined and adjusted to induce the favorable rider emotional state. In embodiments, the recurrent neural network further learns to classify the patterns of emotional state indicative wearable sensor data and associate them to emotional states and changes thereto from a training data set sourced from at least one of a stream of data from unstructured data sources, social media sources, wearable devices, in-vehicle sensors, a rider helmet, a rider headgear, and a rider voice system. In embodiments, the radial basis function neural network optimizes the operational parameter in real time responsive to the detecting of a change in an emotional state of the rider by the recurrent neural network. In embodiments, the recurrent neural network detects a pattern of the emotional state indicative wearable sensor data that indicates the emotional state of the rider is changing from a first emotional state to a second emotional state. In embodiments, the radial basis function neural network optimizes the operational parameter of the vehicle in response to the indicated change in emotional state. In embodiments, the recurrent neural network comprises a plurality of connected nodes that form a directed cycle, the recurrent neural network further facilitating bi-directional flow of data among the connected nodes.

In embodiments, the patterns of emotional state indicative wearable sensor data indicate at least one of an emotional state of the rider is changing, an emotional state of the rider is stable, a rate of change of an emotional state of the rider, a direction of change of an emotional state of the rider, and a polarity of a change of an emotional state of the rider; an emotional state of a rider is changing to an unfavorable state; and an emotional state of a rider is changing to a favorable state. In embodiments, the operational parameter that is optimized affects at least one of a route of the vehicle, in-vehicle audio content, speed of the vehicle, acceleration of the vehicle, deceleration of the vehicle, proximity to objects along the route, and proximity to other vehicles along the route. In embodiments, the radial basis function neural network interacts with a vehicle control system to adjust the operational parameter. In embodiments, the recurrent neural net includes one or more perceptrons that mimic human senses that facilitates determining an emotional state of a rider based on an extent to which at least one of the senses of the rider is stimulated.

In embodiments, the artificial intelligence system 3636 is to maintain a favorable emotional state of the rider through use of a modular neural network, the modular neural network comprising: a rider emotional state determining neural network to process emotional state indicative wearable sensor data of a rider in the vehicle to detect patterns. In embodiments, the patterns found in the emotional state indicative wearable sensor data are indicative of at least one of a favorable emotional state of the rider and an unfavorable emotional state of the rider; an intermediary circuit to convert output data from the rider emotional state determining neural network into vehicle operational state data; and a vehicle operational state optimizing neural network to adjust the operating parameter 36124 of the vehicle in response to the vehicle operational state data.

In embodiments, the vehicle operational state optimizing neural network adjusts an operational parameter of the vehicle for achieving a favorable emotional state of the rider. In embodiments, the vehicle operational state optimizing neural network optimizes the operational parameter based on a correlation between a vehicle operating state and a rider emotional state. In embodiments, the operational parameter of the vehicle that is optimized is determined and adjusted to induce a favorable rider emotional state. In embodiments, the rider emotional state determining neural network further learns to classify the patterns of emotional state indicative wearable sensor data and associate them to emotional states and changes thereto from a training data set sourced from at least one of a stream of data from unstructured data sources, social media sources, wearable devices, in-vehicle sensors, a rider helmet, a rider headgear, and a rider voice system.

In embodiments, the vehicle operational state optimizing neural network optimizes the operational parameter in real time responsive to the detecting of a change in an emotional state of the rider by the rider emotional state determining neural network. In embodiments, the rider emotional state determining neural network detects a pattern of emotional state indicative wearable sensor data that indicates the emotional state of the rider is changing from a first emotional state to a second emotional state. In embodiments, the vehicle operational state optimizing neural network optimizes the operational parameter of the vehicle in response to the indicated change in emotional state. In embodiments, the artificial intelligence system 3636 comprises a plurality of connected nodes that forms a directed cycle, the artificial intelligence system 3636 further facilitating bi-directional flow of data among the connected nodes. In embodiments, the pattern of emotional state indicative wearable sensor data indicate at least one of an emotional state of the rider is changing, an emotional state of the rider is stable, a rate of change of an emotional state of the rider, a direction of change of an emotional state of the rider, and a polarity of a change of an emotional state of the rider; an emotional state of a rider is changing to an unfavorable state; and an emotional state of a rider is changing to a favorable state.

In embodiments, the operational parameter that is optimized affects at least one of a route of the vehicle, in-vehicle audio content, speed of the vehicle, acceleration of the vehicle, deceleration of the vehicle, proximity to objects along the route, and proximity to other vehicles along the route. In embodiments, the vehicle operational state optimizing neural network interacts with a vehicle control system to adjust the operational parameter. In embodiments, the artificial intelligence system 3636 further comprises a neural net that includes one or more perceptrons that mimic human senses that facilitates determining an emotional state of a rider based on an extent to which at least one of the senses of the rider is stimulated. In embodiments, the rider emotional state determining neural network comprises one or more perceptrons that mimic human senses that facilitates determining an emotional state of a rider based on an extent to which at least one of the senses of the rider is stimulated.

In embodiments, the artificial intelligence system 3636 is to indicate a change in the emotional state of a rider in the vehicle through recognition of patterns of emotional state indicative wearable sensor data of the rider in the vehicle; the transportation system further comprising: a vehicle control system to control an operation of the vehicle by adjusting a plurality of vehicle operating parameters; and a feedback loop through which the indication of the change in the emotional state of the rider is communicated between the vehicle control system and the artificial intelligence system 3636. In embodiments, the vehicle control system adjusts at least one of the plurality of vehicle operating parameters responsive to the indication of the change. In embodiments, the vehicle controls system adjusts the at least one of the plurality of vehicle operational parameters based on a correlation between vehicle operational state and rider emotional state.

In embodiments, the vehicle control system adjusts the at least one of the plurality of vehicle operational parameters that are indicative of a favorable rider emotional state. In embodiments, the vehicle control system selects an adjustment of the at least one of the plurality of vehicle operational parameters that is indicative of producing a favorable rider emotional state. In embodiments, the artificial intelligence system 3636 further learns to classify the patterns of emotional state indicative wearable sensor data and associate them to emotional states and changes thereto from a training data set sourced from at least one of a stream of data from unstructured data sources, social media sources, wearable devices, in-vehicle sensors, a rider helmet, a rider headgear, and a rider voice system. In embodiments, the vehicle control system adjusts the at least one of the plurality of vehicle operation parameters in real time.

In embodiments, the artificial intelligence system 3636 further detects a pattern of the emotional state indicative wearable sensor data that indicates the emotional state of the rider is changing from a first emotional state to a second emotional state. In embodiments, the vehicle operation control system adjusts an operational parameter of the vehicle in response to the indicated change in emotional state. In embodiments, the artificial intelligence system 3636 comprises a plurality of connected nodes that form a directed cycle, the artificial intelligence system 3636 further facilitating bi-directional flow of data among the connected nodes. In embodiments, the at least one of the plurality of vehicle operation parameters that is responsively adjusted affects operation of a powertrain of the vehicle and a suspension system of the vehicle.

In embodiments, the radial basis function neural network interacts with the recurrent neural network via an intermediary component of the artificial intelligence system 3636 that produces vehicle control data indicative of an emotional state response of the rider to a current operational state of the vehicle. In embodiments, the artificial intelligence system 3636 further comprises a modular neural network comprising a rider emotional state recurrent neural network for indicating the change in the emotional state of a rider, a vehicle operational state radial based function neural network, and an intermediary system. In embodiments, the intermediary system processes rider emotional state characterization data from the recurrent neural network into vehicle control data that the radial based function neural network uses to interact with the vehicle control system for adjusting the at least one operational parameter.

In embodiments, the artificial intelligence system 3636 comprises a neural net that includes one or more perceptrons that mimic human senses that facilitate determining an emotional state of a rider based on an extent to which at least one of the senses of the rider is stimulated. In embodiments, the recognition of patterns of emotional state indicative wearable sensor data comprises processing the emotional state indicative wearable sensor data captured during at least two of before the adjusting at least one of the plurality of vehicle operational parameters, during the adjusting at least one of the plurality of vehicle operational parameters, and after adjusting at least one of the plurality of vehicle operational parameters.

In embodiments, the artificial intelligence system 3636 indicates a change in the emotional state of the rider responsive to a change in an operating parameter 36124 of the vehicle by determining a difference between a first set of emotional state indicative wearable sensor data of a rider captured prior to the adjusting at least one of the plurality of operating parameters and a second set of emotional state indicative wearable sensor data of the rider captured during or after the adjusting at least one of the plurality of operating parameters.

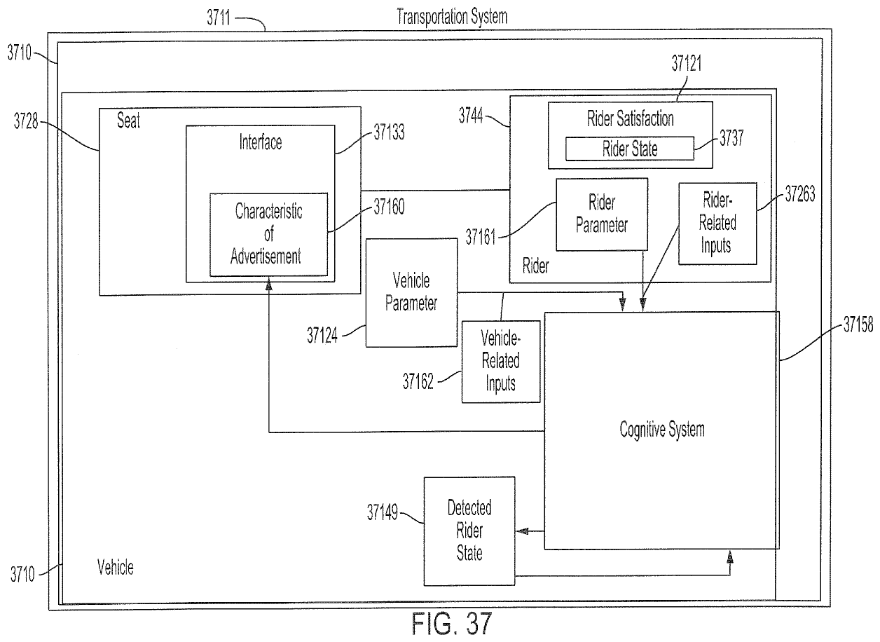

Referring to FIG. 37, in embodiments provided herein are transportation systems 3711 having a cognitive system 37158 for managing an advertising market for in-seat advertising for riders 3744 of self-driving vehicles. In embodiments, the cognitive system 37158 takes inputs relating to at least one parameter 37124 of the vehicle and/or the rider 3744 to determine at least one of a price, a type and a location of an advertisement to be delivered within an interface 37133 to a rider 3744 in a seat 3728 of the vehicle. As described above in connection with search, in-vehicle riders, particularly in self-driving vehicles, may be situationally disposed quite differently toward advertising when riding in a vehicle than at other times. Bored riders may be more willing to watch advertising content, click on offers or promotions, engage in surveys, or the like. In embodiments, an advertising marketplace platform may segment and separately handle advertising placements (including handling bids and asks for advertising placement and the like) for in-vehicle ads. Such an advertising marketplace platform may use information that is unique to a vehicle, such as vehicle type, display type, audio system capabilities, screen size, rider demographic information, route information, location information, and the like when characterizing advertising placement opportunities, such that bids for in-vehicle advertising placement reflect such vehicle, rider and other transportation-related parameters. For example, an advertiser may bid for placement of advertising on in-vehicle display systems of self-driving vehicles that are worth more than $50,000 and that are routed north on highway 101 during the morning commute. The advertising marketplace platform may be used to configure many such vehicle-related placement opportunities, to handle bidding for such opportunities, to place advertisements (such as by load-balanced servers that cache the ads) and to resolve outcomes. Yield metrics may be tracked and used to optimize configuration of the marketplace.

An aspect provided herein includes a system for transportation, comprising: a cognitive system 37158 for managing an advertising market for in-seat advertising for riders of self-driving vehicles, wherein the cognitive system 37158 takes inputs corresponding to at least one parameter 37159 of the vehicle or the rider 3744 to determine a characteristic 37160 of an advertisement to be delivered within an interface 37133 to a rider 3744 in a seat 3728 of the vehicle, wherein the characteristic 37160 of the advertisement is selected from the group consisting of a price, a category, a location and combinations thereof.

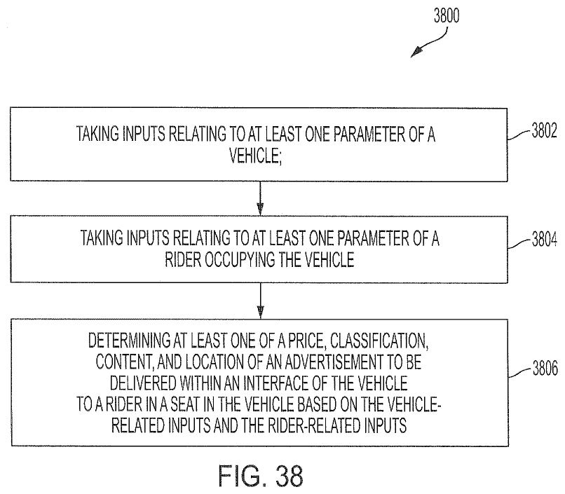

FIG. 38 illustrates a method 3800 of vehicle in-seat advertising in accordance with embodiments of the systems and methods disclosed herein. At 3802 the method includes taking inputs relating to at least one parameter of a vehicle. At 3804 the method includes taking inputs relating to at least one parameter of a rider occupying the vehicle. At 3806 the method includes determining at least one of a price, classification, content, and location of an advertisement to be delivered within an interface of the vehicle to a rider in a seat in the vehicle based on the vehicle-related inputs and the rider-related inputs.

Referring to FIG. 37 and FIG. 38, in embodiments, the vehicle 3710 is automatically routed. In embodiments, the vehicle 3710 is a self-driving vehicle. In embodiments, the cognitive system 37158 further determines at least one of a price, classification, content and location of an advertisement placement. In embodiments, an advertisement is delivered from an advertiser who places a winning bid. In embodiments, delivering an advertisement is based on a winning bid. In embodiments, the inputs 37162 relating to the at least one parameter of a vehicle include vehicle classification. In embodiments, the inputs 37162 relating to the at least one parameter of a vehicle include display classification. In embodiments, the inputs 37162 relating to the at least one parameter of a vehicle include audio system capability. In embodiments, the inputs 37162 relating to the at least one parameter of a vehicle include screen size.

In embodiments, the inputs 37162 relating to the at least one parameter of a vehicle include route information. In embodiments, the inputs 37162 relating to the at least one parameter of a vehicle include location information. In embodiments, the inputs 37163 relating to the at least one parameter of a rider include rider demographic information. In embodiments, the inputs 37163 relating to the at least one parameter of a rider include rider emotional state. In embodiments, the inputs 37163 relating to the at least one parameter of a rider include rider response to prior in-seat advertising. In embodiments, the inputs 37163 relating to the at least one parameter of a rider include rider social media activity.

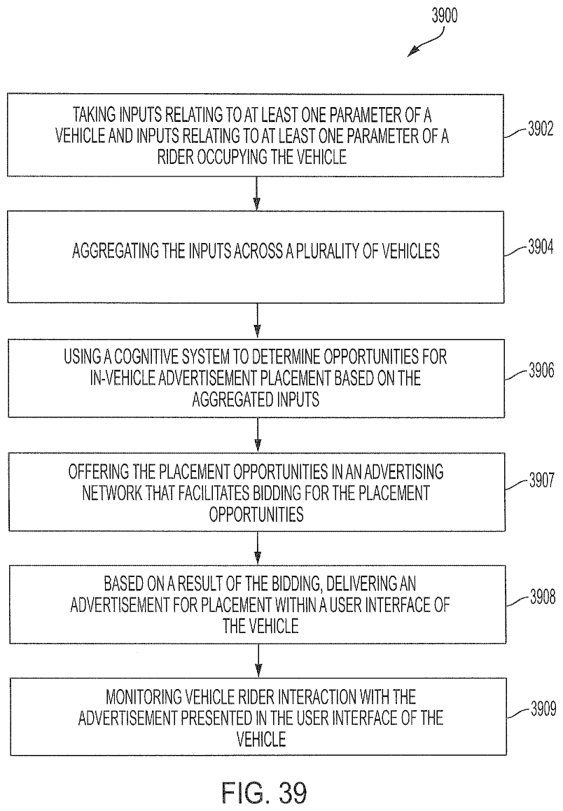

FIG. 39 illustrates a method 3900 of in-vehicle advertising interaction tracking in accordance with embodiments of the systems and methods disclosed herein. At 3902 the method includes taking inputs relating to at least one parameter of a vehicle and inputs relating to at least one parameter of a rider occupying the vehicle. At 3904 the method includes aggregating the inputs across a plurality of vehicles. At 3906 the method includes using a cognitive system to determine opportunities for in-vehicle advertisement placement based on the aggregated inputs. At 3907 the method includes offering the placement opportunities in an advertising network that facilitates bidding for the placement opportunities. At 3908 the method includes based on a result of the bidding, delivering an advertisement for placement within a user interface of the vehicle. At 3909 the method includes monitoring vehicle rider interaction with the advertisement presented in the user interface of the vehicle.

Referring to FIGS. 37 and 39, in embodiments, the vehicle 3710 comprises a system for automating at least one control parameter of the vehicle. In embodiments, the vehicle 3710 is at least a semi-autonomous vehicle. In embodiments, the vehicle 3710 is automatically routed. In embodiments, the vehicle 3710 is a self-driving vehicle. In embodiments, an advertisement is delivered from an advertiser who places a winning bid. In embodiments, delivering an advertisement is based on a winning bid. In embodiments, the monitored vehicle rider interaction information includes information for resolving click-based payments. In embodiments, the monitored vehicle rider interaction information includes an analytic result of the monitoring. In embodiments, the analytic result is a measure of interest in the advertisement. In embodiments, the inputs 37162 relating to the at least one parameter of a vehicle include vehicle classification.

In embodiments, the inputs 37162 relating to the at least one parameter of a vehicle include display classification. In embodiments, the inputs 37162 relating to the at least one parameter of a vehicle include audio system capability. In embodiments, the inputs 37162 relating to the at least one parameter of a vehicle include screen size. In embodiments, the inputs 37162 relating to the at least one parameter of a vehicle include route information. In embodiments, the inputs 37162 relating to the at least one parameter of a vehicle include location information. In embodiments, the inputs 37163 relating to the at least one parameter of a rider include rider demographic information. In embodiments, the inputs 37163 relating to the at least one parameter of a rider include rider emotional state. In embodiments, the inputs 37163 relating to the at least one parameter of a rider include rider response to prior in-seat advertising. In embodiments, the inputs 37163 relating to the at least one parameter of a rider include rider social media activity.

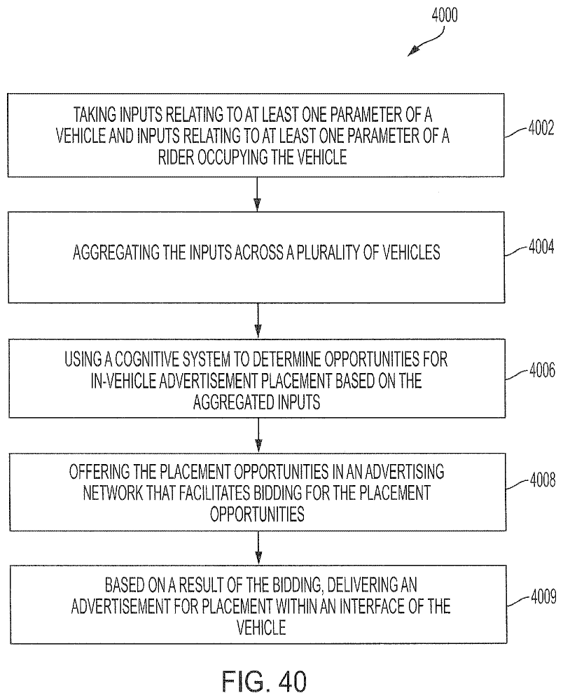

FIG. 40 illustrates a method 4000 of in-vehicle advertising in accordance with embodiments of the systems and methods disclosed herein. At 4002 the method includes taking inputs relating to at least one parameter of a vehicle and inputs relating to at least one parameter of a rider occupying the vehicle. At 4004 the method includes aggregating the inputs across a plurality of vehicles. At 4006 the method includes using a cognitive system to determine opportunities for in-vehicle advertisement placement based on the aggregated inputs. At 4008 the method includes offering the placement opportunities in an advertising network that facilitates bidding for the placement opportunities. At 4009, the method includes, based on a result of the bidding, delivering an advertisement for placement within an interface of the vehicle.

Referring to FIG. 37 and FIG. 40, in embodiments, the vehicle 3710 comprises a system for automating at least one control parameter of the vehicle. In embodiments, the vehicle 3710 is at least a semi-autonomous vehicle. In embodiments, the vehicle 3710 is automatically routed. In embodiments, the vehicle 3710 is a self-driving vehicle. In embodiments, the cognitive system 37158 further determines at least one of a price, classification, content and location of an advertisement placement. In embodiments, an advertisement is delivered from an advertiser who places a winning bid. In embodiments, delivering an advertisement is based on a winning bid. In embodiments, the inputs 37162 relating to the at least one parameter of a vehicle include vehicle classification.

In embodiments, the inputs 37162 relating to the at least one parameter of a vehicle include display classification. In embodiments, the inputs 37162 relating to the at least one parameter of a vehicle include audio system capability. In embodiments, the inputs 37162 relating to the at least one parameter of a vehicle include screen size. In embodiments, the inputs 37162 relating to the at least one parameter of a vehicle include route information. In embodiments, the inputs 37162 relating to the at least one parameter of a vehicle include location information. In embodiments, the inputs 37163 relating to the at least one parameter of a rider include rider demographic information. In embodiments, the inputs 37163 relating to the at least one parameter of a rider include rider emotional state. In embodiments, the inputs 37163 relating to the at least one parameter of a rider include rider response to prior in-seat advertising. In embodiments, the inputs 37163 relating to the at least one parameter of a rider include rider social media activity.

An aspect provided herein includes an advertising system of vehicle in-seat advertising, the advertising system comprising: a cognitive system 37158 that takes inputs 37162 relating to at least one parameter 37124 of a vehicle 3710 and takes inputs relating to at least one parameter 37161 of a rider occupying the vehicle, and determines at least one of a price, classification, content and location of an advertisement to be delivered within an interface 37133 of the vehicle 3710 to a rider 3744 in a seat 3728 in the vehicle 3710 based on the vehicle-related inputs 37162 and the rider-related inputs 37163.

In embodiments, the vehicle 4110 comprises a system for automating at least one control parameter of the vehicle. In embodiments, the vehicle 4110 is at least a semi-autonomous vehicle. In embodiments, the vehicle 4110 is automatically routed. In embodiments, the vehicle 4110 is a self-driving vehicle. In embodiments, the inputs 37162 relating to the at least one parameter of a vehicle include vehicle classification. In embodiments, the inputs 37162 relating to the at least one parameter of a vehicle include display classification. In embodiments, the inputs 37162 relating to the at least one parameter of a vehicle include audio system capability. In embodiments, the inputs 37162 relating to the at least one parameter of a vehicle include screen size. In embodiments, the inputs 37162 relating to the at least one parameter of a vehicle include route information. In embodiments, the inputs 37162 relating to the at least one parameter of a vehicle include location information. In embodiments, the inputs 37163 relating to the at least one parameter of a rider include rider demographic information. In embodiments, the inputs 37163 relating to the at least one parameter of a rider include rider emotional state. In embodiments, the inputs 37163 relating to the at least one parameter of a rider include rider response to prior in-seat advertising. In embodiments, the inputs 37163 relating to the at least one parameter of a rider include rider social media activity.

In embodiments, the advertising system is further to determine a vehicle operating state from the inputs 37162 related to at least one parameter of the vehicle. In embodiments, the advertisement to be delivered is determined based at least in part on the determined vehicle operating state. In embodiments, the advertising system is further to determine a rider state 37149 from the inputs 37163 related to at least one parameter of the rider. In embodiments, the advertisement to be delivered is determined based at least in part on the determined rider state 37149.

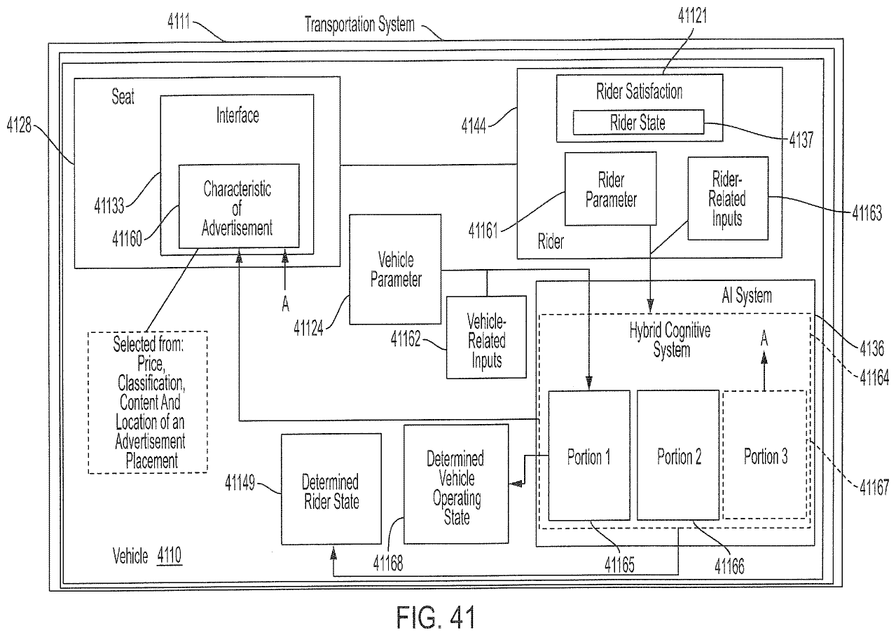

Referring to FIG. 41, in embodiments provided herein are transportation systems 4111 having a hybrid cognitive system 41164 for managing an advertising market for in-seat advertising to riders of vehicles 4110. In embodiments, at least one part of the hybrid cognitive system 41164 processes inputs 41162 relating to at least one parameter 41124 of the vehicle to determine a vehicle operating state and at least one other part of the cognitive system processes inputs relating to a rider to determine a rider state. In embodiments, the cognitive system determines at least one of a price, a type and a location of an advertisement to be delivered within an interface to a rider in a seat of the vehicle.

An aspect provided herein includes a system for transportation 4111, comprising: a hybrid cognitive system 41164 for managing an advertising market for in-seat advertising to riders 4144 of vehicles 4110. In embodiments, at least one part 41165 of the hybrid cognitive system processes inputs 41162 corresponding to at least one parameter of the vehicle to determine a vehicle operating state 41168 and at least one other part 41166 of the cognitive system 41164 processes inputs 41163 relating to a rider to determine a rider state 41149. In embodiments, the cognitive system 41164 determines a characteristic 41160 of an advertisement to be delivered within an interface 41133 to the rider 4144 in a seat 4128 of the vehicle 4110. In embodiments, the characteristic 41160 of the advertisement is selected from the group consisting of a price, a category, a location and combinations thereof.

An aspect provided herein includes an artificial intelligence system 4136 for vehicle in-seat advertising, comprising: a first portion 41165 of the artificial intelligence system 4136 that determines a vehicle operating state 41168 of the vehicle by processing inputs 41162 relating to at least one parameter of the vehicle; a second portion 41166 of the artificial intelligence system 4136 that determines a state 41149 of the rider of the vehicle by processing inputs 41163 relating to at least one parameter of the rider; and a third portion 41167 of the artificial intelligence system 4136 that determines at least one of a price, classification, content and location of an advertisement to be delivered within an interface 41133 of the vehicle to a rider 4144 in a seat in the vehicle 4110 based on the vehicle (operating) state 41168 and the rider state 41149.

In embodiments, the vehicle 4110 comprises a system for automating at least one control parameter of the vehicle. In embodiments, the vehicle is at least a semi-autonomous vehicle. In embodiments, the vehicle is automatically routed. In embodiments, the vehicle is a self-driving vehicle. In embodiments, the cognitive system 41164 further determines at least one of a price, classification, content and location of an advertisement placement. In embodiments, an advertisement is delivered from an advertiser who places a winning bid. In embodiments, delivering an advertisement is based on a winning bid. In embodiments, the inputs relating to the at least one parameter of a vehicle include vehicle classification.

In embodiments, the inputs relating to the at least one parameter of a vehicle include display classification. In embodiments, the inputs relating to the at least one parameter of a vehicle include audio system capability. In embodiments, the inputs relating to the at least one parameter of a vehicle include screen size. In embodiments, the inputs relating to the at least one parameter of a vehicle include route information. In embodiments, the inputs relating to the at least one parameter of a vehicle include location information. In embodiments, the inputs relating to the at least one parameter of a rider include rider demographic information. In embodiments, the inputs relating to the at least one parameter of a rider include rider emotional state. In embodiments, the inputs relating to the at least one parameter of a rider include rider response to prior in-seat advertising. In embodiments, the inputs relating to the at least one parameter of a rider include rider social media activity.

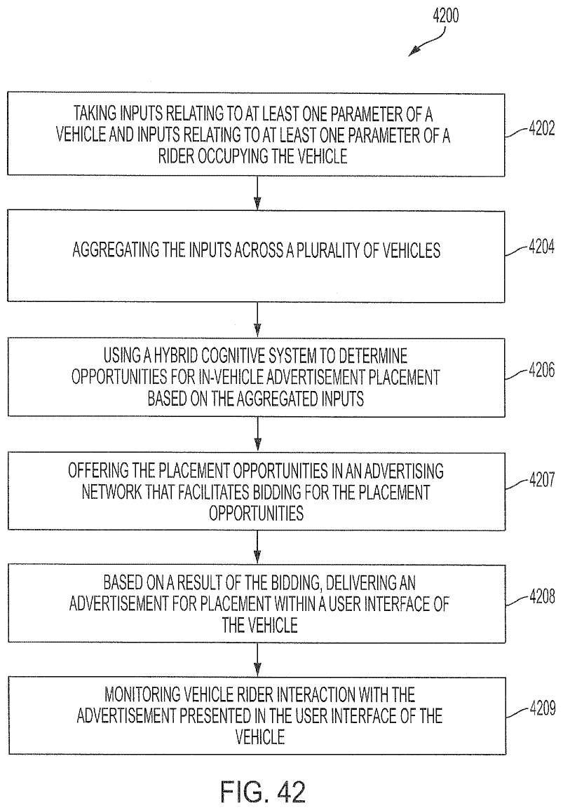

FIG. 42 illustrates a method 4200 of in-vehicle advertising interaction tracking in accordance with embodiments of the systems and methods disclosed herein. At 4202 the method includes taking inputs relating to at least one parameter of a vehicle and inputs relating to at least one parameter of a rider occupying the vehicle. At 4204 the method includes aggregating the inputs across a plurality of vehicles. At 4206 the method includes using a hybrid cognitive system to determine opportunities for in-vehicle advertisement placement based on the aggregated inputs. At 4207 the method includes offering the placement opportunities in an advertising network that facilitates bidding for the placement opportunities. At 4208, the method includes, based on a result of the bidding, delivering an advertisement for placement within a user interface of the vehicle. At 4209 the method includes monitoring vehicle rider interaction with the advertisement presented in the user interface of the vehicle.

Referring to FIG. 41 and FIG. 42, in embodiments, the vehicle 4110 comprises a system for automating at least one control parameter of the vehicle. In embodiments, the vehicle 4110 is at least a semi-autonomous vehicle. In embodiments, the vehicle 4110 is automatically routed. In embodiments, the vehicle 4110 is a self-driving vehicle. In embodiments, a first portion 41165 of the hybrid cognitive system 41164 determines an operating state of the vehicle by processing inputs relating to at least one parameter of the vehicle. In embodiments, a second portion 41166 of the hybrid cognitive system 41164 determines a state 41149 of the rider of the vehicle by processing inputs relating to at least one parameter of the rider. In embodiments, a third portion 41167 of the hybrid cognitive system 41164 determines at least one of a price, classification, content and location of an advertisement to be delivered within an interface of the vehicle to a rider in a seat in the vehicle based on the vehicle state and the rider state. In embodiments, an advertisement is delivered from an advertiser who places a winning bid. In embodiments, delivering an advertisement is based on a winning bid. In embodiments, the monitored vehicle rider interaction information includes information for resolving click-based payments. In embodiments, the monitored vehicle rider interaction information includes an analytic result of the monitoring. In embodiments, the analytic result is a measure of interest in the advertisement. In embodiments, the inputs 41162 relating to the at least one parameter of a vehicle include vehicle classification. In embodiments, the inputs 41162 relating to the at least one parameter of a vehicle include display classification. In embodiments, the inputs 41162 relating to the at least one parameter of a vehicle include audio system capability. In embodiments, the inputs 41162 relating to the at least one parameter of a vehicle include screen size. In embodiments, the inputs 41162 relating to the at least one parameter of a vehicle include route information. In embodiments, the inputs 41162 relating to the at least one parameter of a vehicle include location information. In embodiments, the inputs 41163 relating to the at least one parameter of a rider include rider demographic information. In embodiments, the inputs 41163 relating to the at least one parameter of a rider include rider emotional state. In embodiments, the inputs 41163 relating to the at least one parameter of a rider include rider response to prior in-seat advertising. In embodiments, the inputs 41163 relating to the at least one parameter of a rider include rider social media activity.

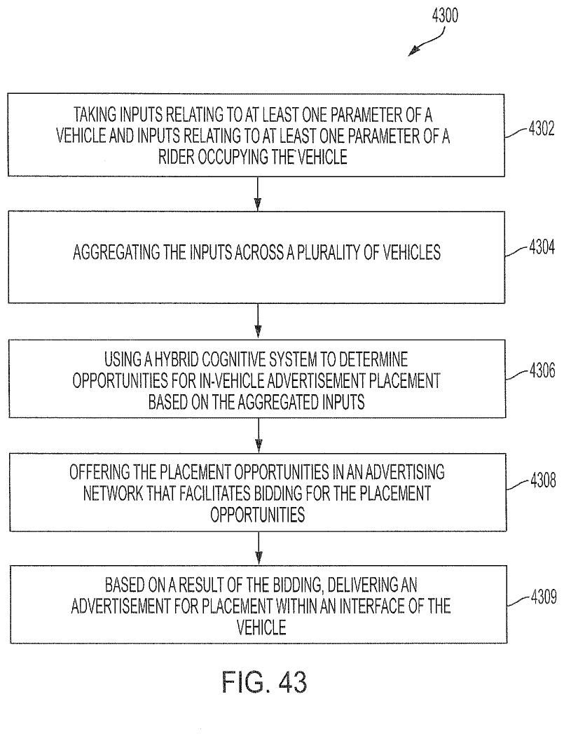

FIG. 43 illustrates a method 4300 of in-vehicle advertising in accordance with embodiments of the systems and methods disclosed herein. At 4302 the method includes taking inputs relating to at least one parameter of a vehicle and inputs relating to at least one parameter of a rider occupying the vehicle. At 4304 the method includes aggregating the inputs across a plurality of vehicles. At 4306 the method includes using a hybrid cognitive system to determine opportunities for in-vehicle advertisement placement based on the aggregated inputs. At 4308 the method includes offering the placement opportunities in an advertising network that facilitates bidding for the placement opportunities. At 4309 the method includes based on a result of the bidding, delivering an advertisement for placement within an interface of the vehicle.

Referring to FIG. 41 and FIG. 43, in embodiments, the vehicle 4110 comprises a system for automating at least one control parameter of the vehicle. In embodiments, the vehicle 4110 is at least a semi-autonomous vehicle. In embodiments, the vehicle 4110 is automatically routed. In embodiments, the vehicle 4110 is a self-driving vehicle. In embodiments, a first portion 41165 of the hybrid cognitive system 41164 determines an operating state 41168 of the vehicle by processing inputs 41162 relating to at least one parameter of the vehicle. In embodiments, a second portion 41166 of the hybrid cognitive system 41164 determines a state 41149 of the rider of the vehicle by processing inputs 41163 relating to at least one parameter of the rider. In embodiments, a third portion 41167 of the hybrid cognitive system 41164 determines at least one of a price, classification, content and location of an advertisement to be delivered within an interface 41133 of the vehicle 4110 to a rider 4144 in a seat 4128 in the vehicle 4110 based on the vehicle (operating) state 41168 and the rider state 41149. In embodiments, an advertisement is delivered from an advertiser who places a winning bid. In embodiments, delivering an advertisement is based on a winning bid. In embodiments, the inputs 41162 relating to the at least one parameter of a vehicle include vehicle classification. In embodiments, the inputs 41162 relating to the at least one parameter of a vehicle include display classification. In embodiments, the inputs 41162 relating to the at least one parameter of a vehicle include audio system capability. In embodiments, the inputs 41162 relating to the at least one parameter of a vehicle include screen size. In embodiments, the inputs 41162 relating to the at least one parameter of a vehicle include route information. In embodiments, the inputs 41162 relating to the at least one parameter of a vehicle include location information. In embodiments, the inputs 41163 relating to the at least one parameter of a rider include rider demographic information. In embodiments, the inputs 41163 relating to the at least one parameter of a rider include rider emotional state. In embodiments, the inputs 41163 relating to the at least one parameter of a rider include rider response to prior in-seat advertising. In embodiments, the inputs 41163 relating to the at least one parameter of a rider include rider social media activity.

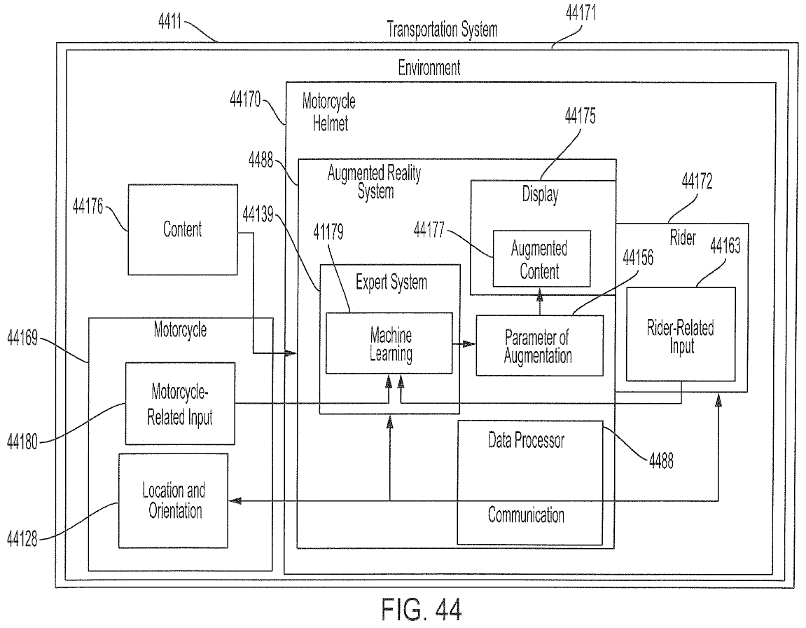

Referring to FIG. 44, in embodiments provided herein are transportation systems 4411 having a motorcycle helmet 44170 that is configured to provide an augmented reality experience based on registration of the location and orientation of the wearer 44172 in an environment 44171.

An aspect provided herein includes a system for transportation 4411, comprising: a motorcycle helmet 44170 to provide an augmented reality experience based on registration of a location and orientation of a wearer 44172 of the helmet 44170 in an environment 44171.

An aspect provided herein includes a motorcycle helmet 44170 comprising: a data processor 4488 configured to facilitate communication between a rider 44172 wearing the helmet 44170 and a motorcycle 44169, the motorcycle 44169 and the helmet 44170 communicating location and orientation 44173 of the motorcycle 44169; and an augmented reality system 44174 with a display 44175 disposed to facilitate presenting an augmentation of content in an environment 44171 of a rider wearing the helmet, the augmentation responsive to a registration of the communicated location and orientation 44128 of the motorcycle 44169. In embodiments, at least one parameter of the augmentation is determined by machine learning on at least one input relating to at least one of the rider 44172 and the motorcycle 44180.

In embodiments, the motorcycle 44169 comprises a system for automating at least one control parameter of the motorcycle. In embodiments, the motorcycle 44169 is at least a semi-autonomous motorcycle. In embodiments, the motorcycle 44169 is automatically routed. In embodiments, the motorcycle 44169 is a self-driving motorcycle. In embodiments, the content in the environment is content that is visible in a portion of a field of view of the rider wearing the helmet. In embodiments, the machine learning on the input of the rider determines an emotional state of the rider and a value for the at least one parameter is adapted responsive to the rider emotional state. In embodiments, the machine learning on the input of the motorcycle determines an operational state of the motorcycle and a value for the at least one parameter is adapted responsive to the motorcycle operational state. In embodiments, the helmet 44170 further comprises a motorcycle configuration expert system 44139 for recommending an adjustment of a value of the at least one parameter 44156 to the augmented reality system responsive to the at least one input.

An aspect provided herein includes a motorcycle helmet augmented reality system comprising: a display 44175 disposed to facilitate presenting an augmentation of content in an environment of a rider wearing the helmet; a circuit 4488 for registering at least one of location and orientation of a motorcycle that the rider is riding; a machine learning circuit 44179 that determines at least one augmentation parameter 44156 by processing at least one input relating to at least one of the rider 44163 and the motorcycle 44180; and a reality augmentation circuit 4488 that, responsive to the registered at least one of a location and orientation of the motorcycle generates an augmentation element 44177 for presenting in the display 44175, the generating based at least in part on the determined at least one augmentation parameter 44156.

In embodiments, the motorcycle 44169 comprises a system for automating at least one control parameter of the motorcycle. In embodiments, the motorcycle 44169 is at least a semi-autonomous motorcycle. In embodiments, the motorcycle 44169 is automatically routed. In embodiments, the motorcycle 44169 is a self-driving motorcycle. In embodiments, the content 44176 in the environment is content that is visible in a portion of a field of view of the rider 44172 wearing the helmet. In embodiments, the machine learning on the input of the rider determines an emotional state of the rider and a value for the at least one parameter is adapted responsive to the rider emotional state. In embodiments, the machine learning on the input of the motorcycle determines an operational state of the motorcycle and a value for the at least one parameter is adapted responsive to the motorcycle operational state.

In embodiments, the helmet further comprises a motorcycle configuration expert system 44139 for recommending an adjustment of a value of the at least one parameter 44156 to the augmented reality system 4488 responsive to the at least one input.

In embodiments, leveraging network technologies for a transportation system may support a cognitive collective charging or refueling plan for vehicles in the transportation system. Such a transportation system may include an artificial intelligence system for taking inputs relating to a plurality of vehicles, such as self-driving vehicles, and determining at least one parameter of a re-charging or refueling plan for at least one of the plurality of vehicles based on the inputs.

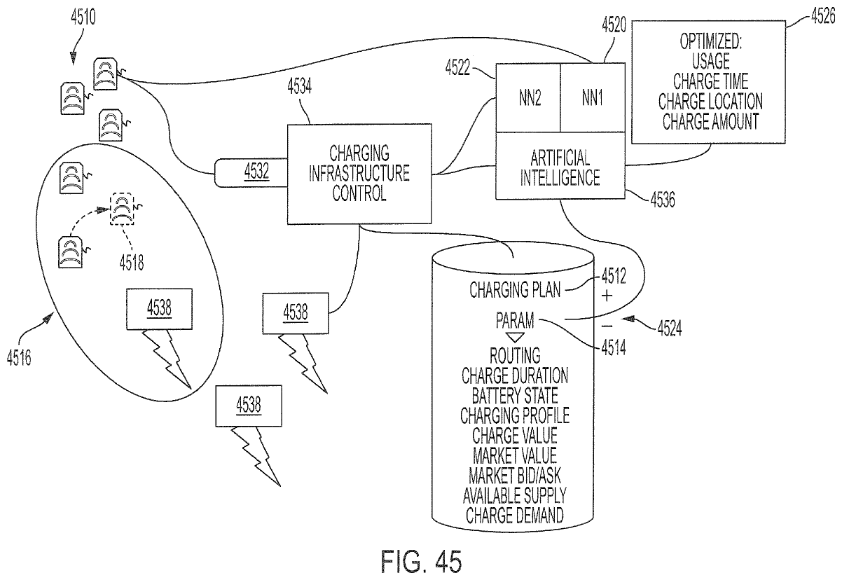

Referring to FIG. 45, in embodiments, the transportation system may be a vehicle transportation system. Such a vehicle transportation system may include a network-enabled vehicle information ingestion port 4532 that may provide a network (e.g., Internet and the like) interface through which inputs, such as inputs comprising operational state and energy consumption information from at least one of a plurality of network-enabled vehicles 4510 may be gathered. In embodiments, such inputs may be gathered in real time as the plurality of network-enabled vehicles 4510 connect to and deliver vehicle operational state, energy consumption and other related information. In embodiments, the inputs may relate to vehicle energy consumption and may be determined from a battery charge state of a portion of the plurality of vehicles. The inputs may include a route plan for the vehicle, an indicator of the value of charging of the vehicle, and the like. The inputs may include predicted traffic conditions for the plurality of vehicles. The transportation system may also include vehicle charging or refueling infrastructure that may include one or more vehicle charging infrastructure control system(s) 4534. These control system(s) 4534 may receive the operational state and energy consumption information for the plurality of network-enabled vehicles 4510 via the ingestion port 4532 or directly through a common or set of connected networks, such as the Internet and the like. Such a transportation system may further include an artificial intelligence system 4536 that may be functionally connected with the vehicle charging infrastructure control system(s) 4534 that, for example, responsive to the receiving of the operational state and energy consumption information, may determine, provide, adjust or create at least one charging plan parameter 4514 upon which a charging plan 4512 for at least a portion of the plurality of network-enabled vehicles 4510 is dependent. This dependency may yield changes in the application of the charging plan 4512 by the control system(s) 4534, such as when a processor of the control system(s) 4534 executes a program derived from or based on the charging plan 4512. The charging infrastructure control system(s) 4534 may include a cloud-based computing system remote from charging infrastructure systems (e.g., remote from an electric vehicle charging kiosk and the like); it may also include a local charging infrastructure system 4538 that may be disposed with and/or integrated with an infrastructure element, such as a fuel station, a charging kiosk and the like. In embodiments, the artificial intelligence system 4536 may interface and coordinate with the cloud-based system 4534, the local charging infrastructure system 4538 or both. In embodiments, coordination of the cloud-based system may take on a different form of interfacing, such as providing parameters that affect more than one charging kiosk and the like than may coordination with the local charging infrastructure system 4538, which may provide information that the local system could use to adapt charging system control commands and the like that may be provided from, for example, a cloud-based control system 4534. In an example, a cloud-based control system (that may control only a portion, such as a localized set, of available charging/refueling infrastructure devices) may respond to the charging plan parameter 4514 of the artificial intelligence system 4536 by setting a charging rate that facilitates highly parallel vehicle charging. However, the local charging infrastructure system 4538 may adapt this control plan, such as based on a control plan parameter provided to it by the artificial intelligence system 4536, to permit a different charging rate (e.g., a faster charging rate), such as for a brief period to accommodate an accumulation of vehicles queued up or estimated to use a local charging kiosk in the period. In this way, an adjustment to the at least one parameter 4514 that when made to the charge infrastructure operation plan 4512 ensures that the at least one of the plurality of vehicles 4510 has access to energy renewal in a target energy renewal geographic region 4516.

In embodiments, a charging or refueling plan may have a plurality of parameters that may impact a wide range of transportation aspects ranging from vehicle-specific to vehicle group-specific to vehicle location-specific and infrastructure impacting aspects. Therefore, a parameter of the plan may impact or relate to any of vehicle routing to charging infrastructure, amount of charge permitted to be provided, duration of time or rate for charging, battery conditions or state, battery charging profile, time required to charge to a minimum value that may be based on consumption needs of the vehicle(s), market value of charging, indicators of market value, market price, infrastructure provider profit, bids or offers for providing fuel or electricity to one or more charging or refueling infrastructure kiosks, available supply capacity, recharge demand (local, regional, system wide), and the like.

In embodiments, to facilitate a cognitive charging or refueling plan, the transportation system may include a recharging plan update facility that interacts with the artificial intelligence system 4536 to apply an adjustment value 4524 to the at least one of the plurality of recharging plan parameters 4514. An adjustment value 4524 may be further adjusted based on feedback of applying the adjustment value. In embodiments, the feedback may be used by the artificial intelligence system 4534 to further adjust the adjustment value. In an example, feedback may impact the adjustment value applied to charging or refueling infrastructure facilities in a localized way, such as for a target recharging geographic region 4516 or geographic range relative to one or more vehicles. In embodiments, providing a parameter adjustment value may facilitate optimizing consumption of a remaining battery charge state of at least one of the plurality of vehicles.

By processing energy-related consumption, demand, availability, and access information and the like, the artificial intelligence system 4536 may optimize aspects of the transportation system, such as vehicle electricity usage as shown in the box at 4526. The artificial intelligence system 4536 may further optimize at least one of recharging time, location, and amount. In an example, a recharging plan parameter that may be configured and updated based on feedback may be a routing parameter for the at least one of the plurality of vehicles as shown in the box at 4526.

The artificial intelligence system 4536 may further optimize a transportation system charging or refueling control plan parameter 4514 to, for example, accommodate near-term charging needs for the plurality of rechargeable vehicles 4510 based on the optimized at least one parameter. The artificial intelligence system 4536 may execute an optimizing algorithm that may calculate energy parameters (including vehicle and non-vehicle energy), optimizes electricity usage for at least vehicles and/or charging or refueling infrastructure, and optimizes at least one charging or refueling infrastructure-specific recharging time, location, and amount.

In embodiments, the artificial intelligence system 4534 may predict a geolocation 4518 of one or more vehicles within a geographic region 4516. The geographic region 4516 may include vehicles that are currently located in or predicted to be in the region and optionally may require or prefer recharging or refueling. As an example of predicting geolocation and its impact on a charging plan, a charging plan parameter may include allocation of vehicles currently in or predicted to be in the region to charging or refueling infrastructure in the geographic region 4516. In embodiments, geolocation prediction may include receiving inputs relating to charging states of a plurality of vehicles within or predicted to be within a geolocation range so that the artificial intelligence system can optimize at least one charging plan parameter 4514 based on a prediction of geolocations of the plurality of vehicles.

There are many aspects of a charging plan that may be impacted. Some aspects may be financial related, such as automated negotiation of at least one of a duration, a quantity and a price for charging or refueling a vehicle.

The transportation system cognitive charging plan system may include the artificial intelligence system being configured with a hybrid neural network. A first neural network 4522 of the hybrid neural network may be used to process inputs relating to charge or fuel states of the plurality of vehicles (directly received from the vehicles or through the vehicle information port 4532) and a second neural network 4520 of the hybrid neural network is used to process inputs relating to charging or refueling infrastructure and the like. In embodiments, the first neural network 4522 may process inputs comprising vehicle route and stored energy state information for a plurality of vehicles to predict for at least one of the plurality of vehicles a target energy renewal region. The second neural network 4520 may process vehicle energy renewal infrastructure usage and demand information for vehicle energy renewal infrastructure facilities within the target energy renewal region to determine at least one parameter 4514 of a charge infrastructure operational plan 4512 that facilitates access by the at least one of the plurality vehicles to renewal energy in the target energy renewal region 4516. In embodiments, the first and/or second neural networks may be configured as any of the neural networks described herein including without limitation convolutional type networks.

In embodiments, a transportation system may be distributed and may include an artificial intelligence system 4536 for taking inputs relating to a plurality of vehicles 4510 and determining at least one parameter 4514 of a re-charging and refueling plan 4512 for at least one of the plurality of vehicles based on the inputs. In embodiments, such inputs may be gathered in real time as plurality of vehicles 4510 connect to and deliver vehicle operational state, energy consumption and other related information. In embodiments, the inputs may relate to vehicle energy consumption and may be determined from a battery charge state of a portion of the plurality of vehicles. The inputs may include a route plan for the vehicle, an indicator of the value of charging of the vehicle, and the like. The inputs may include predicted traffic conditions for the plurality of vehicles. The distributed transportation system may also include cloud-based and vehicle-based systems that exchange information about the vehicle, such as energy consumption and operational information and information about the transportation system, such as recharging or refueling infrastructure. The artificial intelligence system may respond to transportation system and vehicle information shared by the cloud and vehicle-based system with control parameters that facilitate executing a cognitive charging plan for at least a portion of charging or refueling infrastructure of the transportation system. The artificial intelligence system 4536 may determine, provide, adjust or create at least one charging plan parameter 4514 upon which a charging plan 4512 for at least a portion of the plurality of vehicles 4510 is dependent. This dependency may yield changes in the execution of the charging plan 4512 by at least one the cloud-based and vehicle-based systems, such as when a processor executes a program derived from or based on the charging plan 4512.

In embodiments, an artificial intelligence system of a transportation system may facilitate execution of a cognitive charging plan by applying a vehicle recharging facility utilization optimization algorithm to a plurality of rechargeable vehicle-specific inputs, e.g., current operating state data for rechargeable vehicles present in a target recharging range of one of the plurality of rechargeable vehicles. The artificial intelligence system may also evaluate an impact of a plurality of recharging plan parameters on recharging infrastructure of the transportation system in the target recharging range. The artificial intelligence system may select at least one of the plurality of recharging plan parameters that facilitates, for example optimizing energy usage by the plurality of rechargeable vehicles and generate an adjustment value for the at least one of the plurality of recharging plan parameters. The artificial intelligence system may further predict a near-term need for recharging for a portion of the plurality of rechargeable vehicles within the target region based on, for example, operational status of the plurality of rechargeable vehicles that may be determined from the rechargeable vehicle-specific inputs. Based on this prediction and near-term recharging infrastructure availability and capacity information, the artificial intelligence system may optimize at least one parameter of the recharging plan. In embodiments, the artificial intelligence system may operate a hybrid neural network for the predicting and parameter selection or adjustment. In an example, a first portion of the hybrid neural network may process inputs that relate to route plans for one more rechargeable vehicles. In the example, a second portion of the hybrid neural network that is distinct from the first portion may process inputs relating to recharging infrastructure within a recharging range of at least one of the rechargeable vehicles. In this example, the second distinct portion of the hybrid neural net predicts the geolocation of a plurality of vehicles within the target region. To facilitate execution of the recharging plan, the parameter may impact an allocation of vehicles to at least a portion of recharging infrastructure within the predicted geographic region.

In embodiments, vehicles described herein may comprise a system for automating at least one control parameter of the vehicle. The vehicles may further at least operate as a semi-autonomous vehicle. The vehicles may be automatically routed. Also, the vehicles, recharging and otherwise may be self-driving vehicles.

In embodiments, leveraging network technologies for a transportation system may support a cognitive collective charging or refueling plan for vehicles in the transportation system. Such a transportation system may include an artificial intelligence system for taking inputs relating to battery status of a plurality of vehicles, such as self-driving vehicles and determining at least one parameter of a re-charging and/or refueling plan for optimizing battery operation of at least one of the plurality of vehicles based on the inputs.

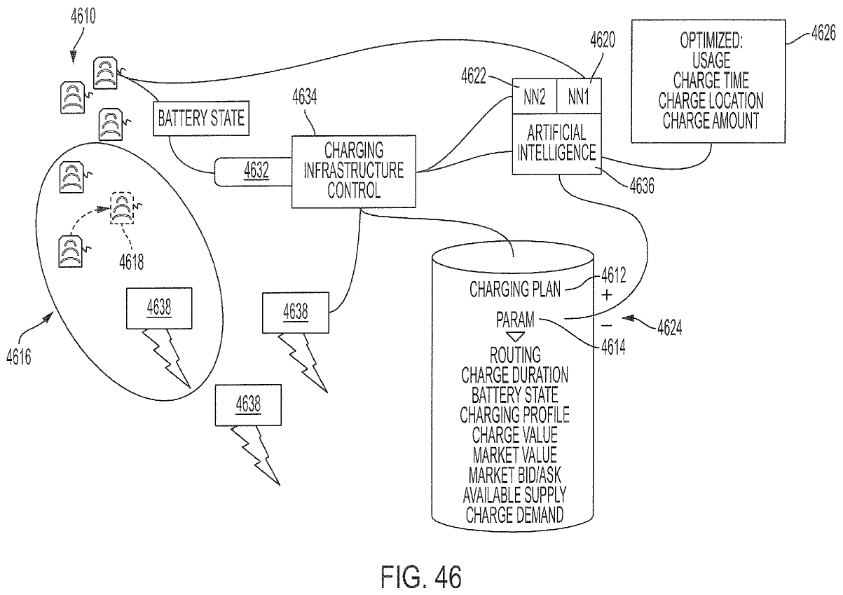

Referring to FIG. 46, in embodiments, such a vehicle transportation system may include a network-enabled vehicle information ingestion port 4632 that may provide a network (e.g., Internet and the like) interface through which inputs, such as inputs comprising operational state and energy consumption information and battery state from at least one of a plurality of network-enabled vehicles 4610 may be gathered. In embodiments, such inputs may be gathered in real time as a plurality of vehicles 4610 connect to a network and deliver vehicle operational state, energy consumption, battery state and other related information. In embodiments, the inputs may relate to vehicle energy consumption and may include a battery charge state of a portion of the plurality of vehicles. The inputs may include a route plan for the vehicle, an indicator of the value of charging of the vehicle, and the like. The inputs may include predicted traffic conditions for the plurality of vehicles. The transportation system may also include vehicle charging or refueling infrastructure that may include one or more vehicle charging infrastructure control systems 4634. These control systems may receive the battery status information and the like for the plurality of network-enabled vehicles 4610 via the ingestion port 4632 and/or directly through a common or set of connected networks, such as an Internet infrastructure including wireless networks and the like. Such a transportation system may further include an artificial intelligence system 4636 that may be functionally connected with the vehicle charging infrastructure control systems that may, based on at least the battery status information from the portion of the plurality of vehicles determine, provide, adjust or create at least one charging plan parameter 4614 upon which a charging plan 4612 for at least a portion of the plurality of network-enabled vehicles 4610 is dependent. This parameter dependency may yield changes in the application of the charging plan 4612 by the control system(s) 4634, such as when a processor of the control system(s) 4634 executes a program derived from or based on the charging plan 4612. These changes may be applied to optimize anticipated battery usage of one or more of the vehicles. The optimizing may be vehicle-specific, aggregated across a set of vehicles, and the like. The charging infrastructure control system(s) 4634 may include a cloud-based computing system remote from charging infrastructure systems (e.g., remote from an electric vehicle charging kiosk and the like); it may also include a local charging infrastructure system 4638 that may be disposed with and/or integrated into an infrastructure element, such as a fuel station, a charging kiosk and the like. In embodiments, the artificial intelligence system 4636 may interface with the cloud-based system 4634, the local charging infrastructure system 4638 or both. In embodiments, the artificial intelligence system may interface with individual vehicles to facilitate optimizing anticipated battery usage. In embodiments, interfacing with the cloud-based system may affect infrastructure-wide impact of a charging plan, such as providing parameters that affect more than one charging kiosk. Interfacing with the local charging infrastructure system 4638 may include providing information that the local system could use to adapt charging system control commands and the like that may be provided from, for example, a regional or broader control system, such as a cloud-based control system 4634. In an example, a cloud-based control system (that may control only a target or geographic region, such as a localized set, a town, a county, a city, a ward, county and the like of available charging or refueling infrastructure devices) may respond to the charging plan parameter 4614 of the artificial intelligence system 4636 by setting a charging rate that facilitates highly parallel vehicle charging so that vehicle battery usage can be optimized. However, the local charging infrastructure system 4638 may adapt this control plan, such as based on a control plan parameter provided to it by the artificial intelligence system 4636, to permit a different charging rate (e.g., a faster charging rate), such as for a brief period to accommodate an accumulation of vehicles for which anticipated battery usage is not yet optimized. In this way, an adjustment to the at least one parameter 4614 that when made to the charge infrastructure operation plan 4612 ensures that the at least one of the plurality of vehicles 4610 has access to energy renewal in a target energy renewal region 4616. In embodiments, a target energy renewal region may be defined by a geofence that may be configured by an administrator of the region. In an example an administrator may have control or responsibility for a jurisdiction (e.g., a township, and the like). In the example, the administrator may configure a geofence for a region that is substantially congruent with the jurisdiction.

In embodiments, a charging or refueling plan may have a plurality of parameters that may impact a wide range of transportation aspects ranging from vehicle-specific to vehicle group-specific to vehicle location-specific and infrastructure impacting aspects. Therefore, a parameter of the plan may impact or relate to any of vehicle routing to charging infrastructure, amount of charge permitted to be provided, duration of time or rate for charging, battery conditions or state, battery charging profile, time required to charge to a minimum value that may be based on consumption needs of the vehicle(s), market value of charging, indicators of market value, market price, infrastructure provider profit, bids or offers for providing fuel or electricity to one or more charging or refueling infrastructure kiosks, available supply capacity, recharge demand (local, regional, system wide), maximum energy usage rate, time between battery charging, and the like.

In embodiments, to facilitate a cognitive charging or refueling plan, the transportation system may include a recharging plan update facility that interacts with the artificial intelligence system 4636 to apply an adjustment value 4624 to the at least one of the plurality of recharging plan parameters 4614. An adjustment value 4624 may be further adjusted based on feedback of applying the adjustment value. In embodiments, the feedback may be used by the artificial intelligence system 4634 to further adjust the adjustment value. In an example, feedback may impact the adjustment value applied to charging or refueling infrastructure facilities in a localized way, such as impacting only a set of vehicles that are impacted by or projected to be impacted by a traffic jam so that their battery operation is optimized, so as to, for example, ensure that they have sufficient battery power throughout the duration of the traffic jam. In embodiments, providing a parameter adjustment value may facilitate optimizing consumption of a remaining battery charge state of at least one of the plurality of vehicles.

By processing energy-related consumption, demand, availability, and access information and the like, the artificial intelligence system 4636 may optimize aspects of the transportation system, such as vehicle electricity usage as shown in the box at 4626. The artificial intelligence system 4636 may further optimize at least one of recharging time, location, and amount as shown in the box at 4626. In an example, a recharging plan parameter that may be configured and updated based on feedback may be a routing parameter for the at least one of the plurality of vehicles.

The artificial intelligence system 4636 may further optimize a transportation system charging or refueling control plan parameter 4614 to, for example accommodate near-term charging needs for the plurality of rechargeable vehicles 4610 based on the optimized at least one parameter. The artificial intelligence system 4636 may execute a vehicle recharging optimizing algorithm that may calculate energy parameters (including vehicle and non-vehicle energy) that may impact an anticipated battery usage, optimizes electricity usage for at least vehicles and/or charging or refueling infrastructure, and optimizes at least one charging or refueling infrastructure-specific recharging time, location, and amount.

In embodiments, the artificial intelligence system 4634 may predict a geolocation 4618 of one or more vehicles within a geographic region 4616. The geographic region 4616 may include vehicles that are currently located in or predicted to be in the region and optionally may require or prefer recharging or refueling. As an example of predicting geolocation and its impact on a charging plan, a charging plan parameter may include allocation of vehicles currently in or predicted to be in the region to charging or refueling infrastructure in the geographic region 4616. In embodiments, geolocation prediction may include receiving inputs relating to battery and battery charging states and recharging needs of a plurality of vehicles within or predicted to be within a geolocation range so that the artificial intelligence system can optimize at least one charging plan parameter 4614 based on a prediction of geolocations of the plurality of vehicles.

There are many aspects of a charging plan that may be impacted. Some aspects may be financial related, such as automated negotiation of at least one of a duration, a quantity and a price for charging or refueling a vehicle.

The transportation system cognitive charging plan system may include the artificial intelligence system being configured with a hybrid neural network. A first neural network 4622 of the hybrid neural network may be used to process inputs relating to battery charge or fuel states of the plurality of vehicles (directly received from the vehicles or through the vehicle information port 4632) and a second neural network 4620 of the hybrid neural network is used to process inputs relating to charging or refueling infrastructure and the like. In embodiments, the first neural network 4622 may process inputs comprising information about a charging system of the vehicle and vehicle route and stored energy state information for a plurality of vehicles to predict for at least one of the plurality of vehicles a target energy renewal region. The second neural network 4620 may further predict a geolocation of a portion of the plurality of vehicles relative to another vehicle or set of vehicles. The second neural network 4620 may process vehicle energy renewal infrastructure usage and demand information for vehicle energy renewal infrastructure facilities within the target energy renewal region to determine at least one parameter 4614 of a charge infrastructure operational plan 4612 that facilitates access by the at least one of the plurality vehicles to renewal energy in the target energy renewal region 4616. In embodiments, the first and/or second neural networks may be configured as any of the neural networks described herein including without limitation convolutional type networks.

In embodiments, a transportation system may be distributed and may include an artificial intelligence system 4636 for taking inputs relating to a plurality of vehicles 4610 and determining at least one parameter 4614 of a re-charging and refueling plan 4612 for at least one of the plurality of vehicles based on the inputs. In embodiments, such inputs may be gathered in real time as plurality of vehicles 4610 connect to a network and deliver vehicle operational state, energy consumption and other related information. In embodiments, the inputs may relate to vehicle energy consumption and may be determined from a battery charge state of a portion of the plurality of vehicles. The inputs may include a route plan for the vehicle, an indicator of the value of charging of the vehicle, and the like. The inputs may include predicted traffic conditions for the plurality of vehicles. The distributed transportation system may also include cloud-based and vehicle-based systems that exchange information about the vehicle, such as energy consumption and operational information and information about the transportation system, such as recharging or refueling infrastructure. The artificial intelligence system may respond to transportation system and vehicle information shared by the cloud and vehicle-based system with control parameters that facilitate executing a cognitive charging plan for at least a portion of charging or refueling infrastructure of the transportation system. The artificial intelligence system 4636 may determine, provide, adjust or create at least one charging plan parameter 4614 upon which a charging plan 4612 for at least a portion of the plurality of vehicles 4610 is dependent. This dependency may yield changes in the execution of the charging plan 4612 by at least one of the cloud-based and vehicle-based systems, such as when a processor executes a program derived from or based on the charging plan 4612.

In embodiments, an artificial intelligence system of a transportation system may facilitate execution of a cognitive charging plan by applying a vehicle recharging facility utilization of a vehicle battery operation optimization algorithm to a plurality of rechargeable vehicle-specific inputs, e.g., current operating state data for rechargeable vehicles present in a target recharging range of one of the plurality of rechargeable vehicles. The artificial intelligence system may also evaluate an impact of a plurality of recharging plan parameters on recharging infrastructure of the transportation system in the target recharging range. The artificial intelligence system may select at least one of the plurality of recharging plan parameters that facilitates, for example optimizing energy usage by the plurality of rechargeable vehicles and generate an adjustment value for the at least one of the plurality of recharging plan parameters. The artificial intelligence system may further predict a near-term need for recharging for a portion of the plurality of rechargeable vehicles within the target region based on, for example, operational status of the plurality of rechargeable vehicles that may be determined from the rechargeable vehicle-specific inputs. Based on this prediction and near-term recharging infrastructure availability and capacity information, the artificial intelligence system may optimize at least one parameter of the recharging plan. In embodiments, the artificial intelligence system may operate a hybrid neural network for the predicting and parameter selection or adjustment. In an example, a first portion of the hybrid neural network may process inputs that relate to route plans for one more rechargeable vehicles. In the example, a second portion of the hybrid neural network that is distinct from the first portion may process inputs relating to recharging infrastructure within a recharging range of at least one of the rechargeable vehicles. In this example, the second distinct portion of the hybrid neural net predicts the geolocation of a plurality of vehicles within the target region. To facilitate execution of the recharging plan, the parameter may impact an allocation of vehicles to at least a portion of recharging infrastructure within the predicted geographic region.

In embodiments, vehicles described herein may comprise a system for automating at least one control parameter of the vehicle. The vehicles may further at least operate as a semi-autonomous vehicle. The vehicles may be automatically routed. Also, the vehicles, recharging and otherwise may be self-driving vehicles.

In embodiments, leveraging network technologies for a transportation system may support a cognitive collective charging or refueling plan for vehicles in the transportation system. Such a transportation system may include a cloud-based artificial intelligence system for taking inputs relating to a plurality of vehicles, such as self-driving vehicles and determining at least one parameter of a re-charging and/or refueling plan for at least one of the plurality of vehicles based on the inputs.

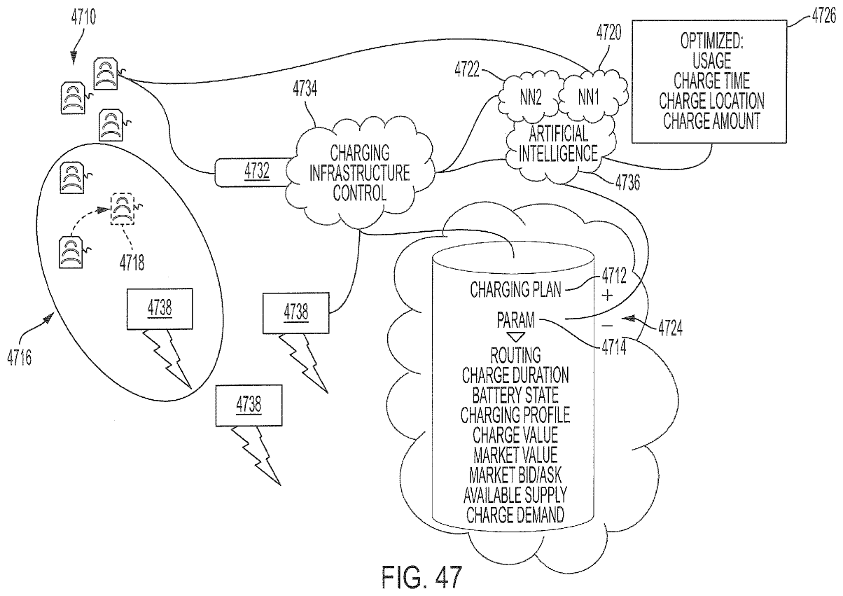

Referring to FIG. 47, in embodiments, such a vehicle transportation system may include a cloud-enabled vehicle information ingestion port 4732 that may provide a network (e.g., Internet and the like) interface through which inputs, such as inputs comprising operational state and energy consumption information from at least one of a plurality of network-enabled vehicles 4710 may be gathered and provided into cloud resources, such as the cloud-based control and artificial intelligence systems described herein. In embodiments, such inputs may be gathered in real time as a plurality of vehicles 4710 connect to the cloud and deliver vehicle operational state, energy consumption and other related information through at least the port 4732. In embodiments, the inputs may relate to vehicle energy consumption and may be determined from a battery charge state of a portion of the plurality of vehicles. The inputs may include a route plan for the vehicle, an indicator of the value of charging of the vehicle, and the like. The inputs may include predicted traffic conditions for the plurality of vehicles. The transportation system may also include vehicle charging or refueling infrastructure that may include one or more vehicle charging infrastructure cloud-based control system(s) 4734. These cloud-based control system(s) 4734 may receive the operational state and energy consumption information for the plurality of network-enabled vehicles 4710 via the cloud-enabled ingestion port 4732 and/or directly through a common or set of connected networks, such as the Internet and the like. Such a transportation system may further include a cloud-based artificial intelligence system 4736 that may be functionally connected with the vehicle charging infrastructure cloud-based control system(s) 4734 that, for example, may determine, provide, adjust or create at least one charging plan parameter 4714 upon which a charging plan 4712 for at least a portion of the plurality of network-enabled vehicles 4710 is dependent. This dependency may yield changes in the application of the charging plan 4712 by the cloud-based control system(s) 4734, such as when a processor of the cloud-based control system(s) 4734 executes a program derived from or based on the charging plan 4712. The charging infrastructure cloud-based control system(s) 4734 may include a cloud-based computing system remote from charging infrastructure systems (e.g., remote from an electric vehicle charging kiosk and the like); it may also include a local charging infrastructure system 4738 that may be disposed with and/or integrated into an infrastructure element, such as a fuel station, a charging kiosk and the like. In embodiments, the cloud-based artificial intelligence system 4736 may interface and coordinate with the cloud-based charging infrastructure control system 4734, the local charging infrastructure system 4738 or both. In embodiments, coordination of the cloud-based system may take on a form of interfacing, such as providing parameters that affect more than one charging kiosk and the like than may be different from coordination with the local charging infrastructure system 4738, which may provide information that the local system could use to adapt cloud-based charging system control commands and the like that may be provided from, for example, a cloud-based control system 4734. In an example, a cloud-based control system (that may control only a portion, such as a localized set, of available charging or refueling infrastructure devices) may respond to the charging plan parameter 4714 of the cloud-based artificial intelligence system 4736 by setting a charging rate that facilitates highly parallel vehicle charging. However, the local charging infrastructure system 4738 may adapt this control plan, such as based on a control plan parameter provided to it by the cloud-based artificial intelligence system 4736, to permit a different charging rate (e.g., a faster charging rate), such as for a brief period to accommodate an accumulation of vehicles queued up or estimated to use a local charging kiosk in the period. In this way, an adjustment to the at least one parameter 4714 that when made to the charge infrastructure operation plan 4712 ensures that the at least one of the plurality of vehicles 4710 has access to energy renewal in a target energy renewal region 4716.

In embodiments, a charging or refueling plan may have a plurality of parameters that may impact a wide range of transportation aspects ranging from vehicle-specific to vehicle group-specific to vehicle location-specific and infrastructure impacting aspects. Therefore, a parameter of the plan may impact or relate to any of vehicle routing to charging infrastructure, amount of charge permitted to be provided, duration of time or rate for charging, battery conditions or state, battery charging profile, time required to charge to a minimum value that may be based on consumption needs of the vehicle(s), market value of charging, indicators of market value, market price, infrastructure provider profit, bids or offers for providing fuel or electricity to one or more charging or refueling infrastructure kiosks, available supply capacity, recharge demand (local, regional, system wide), and the like.

In embodiments, to facilitate a cognitive charging or refueling plan, the transportation system may include a recharging plan update facility that interacts with the cloud-based artificial intelligence system 4736 to apply an adjustment value 4724 to the at least one of the plurality of recharging plan parameters 4714. An adjustment value 4724 may be further adjusted based on feedback of applying the adjustment value. In embodiments, the feedback may be used by the cloud-based artificial intelligence system 4734 to further adjust the adjustment value. In an example, feedback may impact the adjustment value applied to charging or refueling infrastructure facilities in a localized way, such as for a target recharging area 4716 or geographic range relative to one or more vehicles. In embodiments, providing a parameter adjustment value may facilitate optimizing consumption of a remaining battery charge state of at least one of the plurality of vehicles.

By processing energy-related consumption, demand, availability, and access information and the like, the cloud-based artificial intelligence system 4736 may optimize aspects of the transportation system, such as vehicle electricity usage. The cloud-based artificial intelligence system 4736 may further optimize at least one of recharging time, location, and amount. In an example, a recharging plan parameter that may be configured and updated based on feedback may be a routing parameter for the at least one of the plurality of vehicles.

The cloud-based artificial intelligence system 4736 may further optimize a transportation system charging or refueling control plan parameter 4714 to, for example, accommodate near-term charging needs for the plurality of rechargeable vehicles 4710 based on the optimized at least one parameter. The cloud-based artificial intelligence system 4736 may execute an optimizing algorithm that may calculate energy parameters (including vehicle and non-vehicle energy), optimizes electricity usage for at least vehicles and/or charging or refueling infrastructure, and optimizes at least one charging or refueling infrastructure-specific recharging time, location, and amount.

In embodiments, the cloud-based artificial intelligence system 4734 may predict a geolocation 4718 of one or more vehicles within a geographic region 4716. The geographic region 4716 may include vehicles that are currently located in or predicted to be in the region and optionally may require or prefer recharging or refueling. As an example of predicting geolocation and its impact on a charging plan, a charging plan parameter may include allocation of vehicles currently in or predicted to be in the region to charging or refueling infrastructure in the geographic region 4716. In embodiments, geolocation prediction may include receiving inputs relating to charging states of a plurality of vehicles within or predicted to be within a geolocation range so that the cloud-based artificial intelligence system can optimize at least one charging plan parameter 4714 based on a prediction of geolocations of the plurality of vehicles.

There are many aspects of a charging plan that may be impacted. Some aspects may be financially related, such as automated negotiation of at least one of a duration, a quantity and a price for charging or refueling a vehicle.

The transportation system cognitive charging plan system may include the cloud-based artificial intelligence system being configured with a hybrid neural network. A first neural network 4722 of the hybrid neural network may be used to process inputs relating to charge or fuel states of the plurality of vehicles (directly received from the vehicles or through the vehicle information port 4732) and a second neural network 4720 of the hybrid neural network is used to process inputs relating to charging or refueling infrastructure and the like. In embodiments, the first neural network 4722 may process inputs comprising vehicle route and stored energy state information for a plurality of vehicles to predict for at least one of the plurality of vehicles a target energy renewal region. The second neural network 4720 may process vehicle energy renewal infrastructure usage and demand information for vehicle energy renewal infrastructure facilities within the target energy renewal region to determine at least one parameter 4714 of a charge infrastructure operational plan 4712 that facilitates access by the at least one of the plurality vehicles to renewal energy in the target energy renewal region 4716. In embodiments, the first and/or second neural networks may be configured as any of the neural networks described herein including without limitation convolutional type networks.

In embodiments, a transportation system may be distributed and may include a cloud-based artificial intelligence system 4736 for taking inputs relating to a plurality of vehicles 4710 and determining at least one parameter 4714 of a re-charging and refueling plan 4712 for at least one of the plurality of vehicles based on the inputs. In embodiments, such inputs may be gathered in real time as plurality of vehicles 4710 connect to and deliver vehicle operational state, energy consumption and other related information. In embodiments, the inputs may relate to vehicle energy consumption and may be determined from a battery charge state of a portion of the plurality of vehicles. The inputs may include a route plan for the vehicle, an indicator of the value of charging of the vehicle, and the like. The inputs may include predicted traffic conditions for the plurality of vehicles. The distributed transportation system may also include cloud-based and vehicle-based systems that exchange information about the vehicle, such as energy consumption and operational information and information about the transportation system, such as recharging or refueling infrastructure. The cloud-based artificial intelligence system may respond to transportation system and vehicle information shared by the cloud and vehicle-based system with control parameters that facilitate executing a cognitive charging plan for at least a portion of charging or refueling infrastructure of the transportation system. The cloud-based artificial intelligence system 4736 may determine, provide, adjust or create at least one charging plan parameter 4714 upon which a charging plan 4712 for at least a portion of the plurality of vehicles 4710 is dependent. This dependency may yield changes in the execution of the charging plan 4712 by at least one the cloud-based and vehicle-based systems, such as when a processor executes a program derived from or based on the charging plan 4712.

In embodiments, a cloud-based artificial intelligence system of a transportation system may facilitate execution of a cognitive charging plan by applying a vehicle recharging facility utilization optimization algorithm to a plurality of rechargeable vehicle-specific inputs, e.g., current operating state data for rechargeable vehicles present in a target recharging range of one of the plurality of rechargeable vehicles. The cloud-based artificial intelligence system may also evaluate an impact of a plurality of recharging plan parameters on recharging infrastructure of the transportation system in the target recharging range. The cloud-based artificial intelligence system may select at least one of the plurality of recharging plan parameters that facilitates, for example optimizing energy usage by the plurality of rechargeable vehicles and generate an adjustment value for the at least one of the plurality of recharging plan parameters. The cloud-based artificial intelligence system may further predict a near-term need for recharging for a portion of the plurality of rechargeable vehicles within the target region based on, for example, operational status of the plurality of rechargeable vehicles that may be determined from the rechargeable vehicle-specific inputs. Based on this prediction and near-term recharging infrastructure availability and capacity information, the cloud-based artificial intelligence system may optimize at least one parameter of the recharging plan. In embodiments, the cloud-based artificial intelligence system may operate a hybrid neural network for the predicting and parameter selection or adjustment. In an example, a first portion of the hybrid neural network may process inputs that relates to route plans for one more rechargeable vehicles. In the example, a second portion of the hybrid neural network that is distinct from the first portion may process inputs relating to recharging infrastructure within a recharging range of at least one of the rechargeable vehicles. In this example, the second distinct portion of the hybrid neural net predicts the geolocation of a plurality of vehicles within the target region. To facilitate execution of the recharging plan, the parameter may impact an allocation of vehicles to at least a portion of recharging infrastructure within the predicted geographic region.

In embodiments, vehicles described herein may comprise a system for automating at least one control parameter of the vehicle. The vehicles may further at least operate as a semi-autonomous vehicle. The vehicles may be automatically routed. Also, the vehicles, recharging and otherwise may be self-driving vehicles.

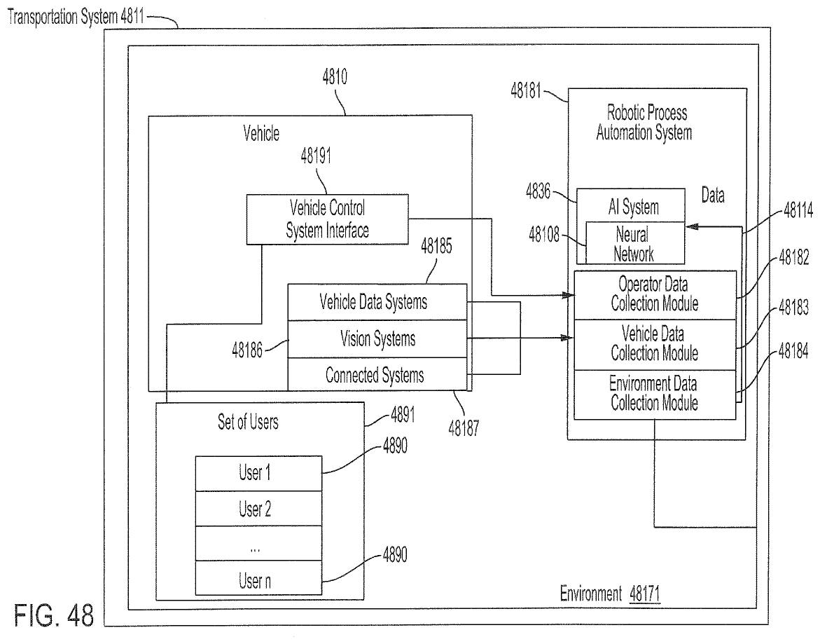

Referring to FIG. 48, provided herein are transportation systems 4811 having a robotic process automation system 48181 (RPA system). In embodiments, data is captured for each of a set of individuals/users 4891 as the individuals/users 4890 interact with a user interface 4823 of a vehicle 4811, and an artificial intelligence system 4836 is trained using the data and interacts with the vehicle 4810 to automatically undertake actions with the vehicle 4810 on behalf of the user 4890. Data 48114 collected for the RPA system 48181 may include a sequence of images, sensor data, telemetry data, or the like, among many other types of data described throughout this disclosure. Interactions of an individual/user 4890 with a vehicle 4810 may include interactions with various vehicle interfaces as described throughout this disclosure. For example, a robotic process automation (RPA) system 4810 may observe patterns of a driver, such as braking patterns, typical following distance behind other vehicles, approach to curves (e.g., entry angle, entry speed, exit angle, exit speed and the like), acceleration patterns, lane preferences, passing preferences, and the like. Such patterns may be obtained through vision systems 48186 (e.g., ones observing the driver, the steering wheel, the brake, the surrounding environment 48171, and the like), through vehicle data systems 48185 (e.g., data streams indicating states and changes in state in steering, braking and the like, as well as forward and rear-facing cameras and sensors), through connected systems 48187 (e.g., GPS, cellular systems, and other network systems, as well as peer-to-peer, vehicle-to-vehicle, mesh and cognitive networks, among others), and other sources. Using a training data set, the RPA system 48181, such as via a neural network 48108 of any of the types described herein, may learn to drive in the same style as a driver. In embodiments, the RPA system 48181 may learn changes in style, such as varying levels of aggressiveness in different situations, such as based on time of day, length of trip, type of trip, or the like. Thus, a self-driving car may learn to drive like its typical driver. Similarly, an RPA system 48181 may be used to observe driver, passenger, or other individual interactions with a navigation system, an audio entertainment system, a video entertainment system, a climate control system, a seat warming and/or cooling system, a steering system, a braking system, a mirror system, a window system, a door system, a trunk system, a fueling system, a moonroof system, a ventilation system, a lumbar support system, a seat positioning system, a GPS system, a WIFI system, a glovebox system, or other systems.

An aspect provided herein includes a system 4811 for transportation, comprising: a robotic process automation system 48181. In embodiments, a set of data is captured for each user 4890 in a set of users 4891 as each user 4890 interacts with a user interface 4823 of a vehicle 4810. In embodiments, an artificial intelligence system 4836 is trained using the set of data 48114 to interact with the vehicle 4810 to automatically undertake actions with the vehicle 4810 on behalf of the user 4890.

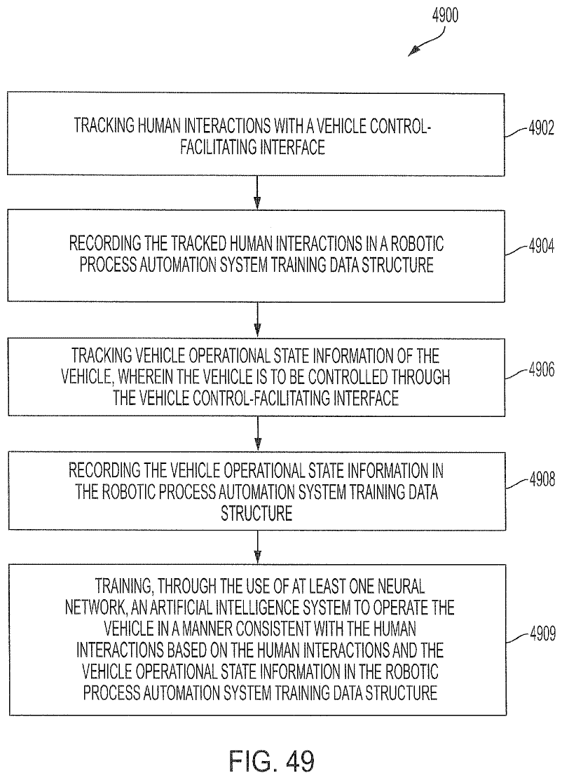

FIG. 49 illustrates a method 4900 of robotic process automation to facilitate mimicking human operator operation of a vehicle in accordance with embodiments of the systems and methods disclosed herein. At 4902 the method includes tracking human interactions with a vehicle control-facilitating interface. At 4904 the method includes recording the tracked human interactions in a robotic process automation system training data structure. At 4906 the method includes tracking vehicle operational state information of the vehicle. In embodiments, the vehicle is to be controlled through the vehicle control-facilitating interface. At 4908 the method includes recording the vehicle operational state information in the robotic process automation system training data structure. At 4909 the method includes training, through the use of at least one neural network, an artificial intelligence system to operate the vehicle in a manner consistent with the human interactions based on the human interactions and the vehicle operational state information in the robotic process automation system training data structure.

In embodiments, the method further comprises controlling at least one aspect of the vehicle with the trained artificial intelligence system. In embodiments, the method further comprises applying deep learning to the controlling the at least one aspect of the vehicle by structured variation in the controlling the at least one aspect of the vehicle to mimic the human interactions and processing feedback from the controlling the at least one aspect of the vehicle with machine learning. In embodiments, the controlling at least one aspect of the vehicle is performed via the vehicle control-facilitating interface.

In embodiments, the controlling at least one aspect of the vehicle is performed by the artificial intelligence system emulating the control-facilitating interface being operated by the human. In embodiments, the vehicle control-facilitating interface comprises at least one of an audio capture system to capture audible expressions of the human, a human-machine interface, a mechanical interface, an optical interface and a sensor-based interface. In embodiments, the tracking vehicle operational state information comprises tracking at least one of a set of vehicle systems and a set of vehicle operational processes affected by the human interactions. In embodiments, the tracking vehicle operational state information comprises tracking at least one vehicle system element. In embodiments, the at least one vehicle system element is controlled via the vehicle control-facilitating interface. In embodiments, the at least one vehicle system element is affected by the human interactions. In embodiments, the tracking vehicle operational state information comprises tracking the vehicle operational state information before, during, and after the human interaction.

In embodiments, the tracking vehicle operational state information comprises tracking at least one of a plurality of vehicle control system outputs that result from the human interactions and vehicle operational results achieved in response to the human interactions. In embodiments, the vehicle is to be controlled to achieve results that are consistent with results achieved via the human interactions. In embodiments, the method further comprises tracking and recording conditions proximal to the vehicle with a plurality of vehicle mounted sensors. In embodiments, the training of the artificial intelligence system is further responsive to the conditions proximal to the vehicle tracked contemporaneously to the human interactions. In embodiments, the training is further responsive to a plurality of data feeds from remote sensors, the plurality of data feeds comprising data collected by the remote sensors contemporaneous to the human interactions. In embodiments, the artificial intelligence system employs a workflow that involves decision-making and the robotic process automation system facilitates automation of the decision-making. In embodiments, the artificial intelligence system employs a workflow that involves remote control of the vehicle and the robotic process automation system facilitates automation of remotely controlling the vehicle.

An aspect provided herein includes a transportation system 4811 for mimicking human operation of a vehicle 4810, comprising: a robotic process automation system 48181 comprising: an operator data collection module 48182 to capture human operator interaction with a vehicle control system interface 48191; a vehicle data collection module 48183 to capture vehicle response and operating conditions associated at least contemporaneously with the human operator interaction; and an environment data collection module 48184 to capture instances of environmental information associated at least contemporaneously with the human operator interaction; and an artificial intelligence system 4836 to learn to mimic the human operator (e.g., user 4890) to control the vehicle 4810 responsive to the robotic process automation system 48181 detecting data 48114 indicative of at least one of a plurality of the instances of environmental information associated with the contemporaneously captured vehicle response and operating conditions.

In embodiments, the operator data collection module 48182 is to capture patterns of data including braking patterns, follow-behind distance, approach to curve acceleration patterns, lane preferences, and passing preferences. In embodiments, vehicle data collection module 48183 captures data from a plurality of vehicle data systems 48185 that provide data streams indicating states and changes in state in steering, braking, acceleration, forward looking images, and rear-looking images. In embodiments, the artificial intelligence system 4836 includes a neural network 48108 for training the artificial intelligence system 4836.

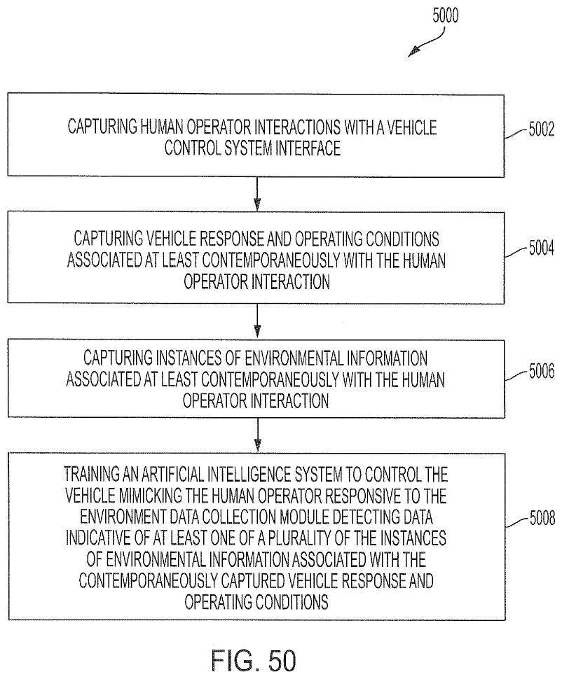

FIG. 50 illustrates a robotic process automation method 5000 of mimicking human operation of a vehicle in accordance with embodiments of the systems and methods disclosed herein. At 5002 the method includes capturing human operator interactions with a vehicle control system interface. At 5004 the method includes capturing vehicle response and operating conditions associated at least contemporaneously with the human operator interaction. At 5006 the method includes capturing instances of environmental information associated at least contemporaneously with the human operator interaction. At 5008 the method includes training an artificial intelligence system to control the vehicle mimicking the human operator responsive to the environment data collection module detecting data indicative of at least one of a plurality of the instances of environmental information associated with the contemporaneously captured vehicle response and operating conditions.

In embodiments, the method further comprises applying deep learning in the artificial intelligence system to optimize a margin of vehicle operating safety by affecting the controlling of the at least one aspect of the vehicle by structured variation in the controlling of the at least one aspect of the vehicle to mimic the human interactions and processing feedback from the controlling the at least one aspect of the vehicle with machine learning. In embodiments, the robotic process automation system facilitates automation of a decision-making workflow employed by the artificial intelligence system. In embodiments, the robotic process automation system facilitates automation of a remote control workflow that the artificial intelligence system employs to remotely control the vehicle.

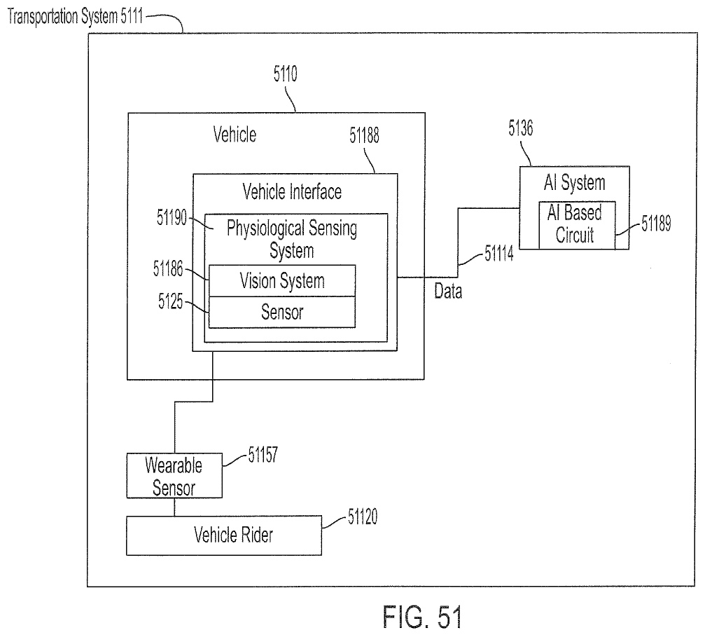

Referring to FIG. 51, a transportation system 5111 is provided having an artificial intelligence system 5136 that automatically randomizes a parameter of an in-vehicle experience in order to improve a user state that benefits from variation. In embodiments, a system used to control a driver or passenger experience (such as in a self-driving car, assisted car, or conventional vehicle) may be configured to automatically undertake actions based on an objective or feedback function, such as where an artificial intelligence system 5136 is trained on outcomes from a training data set to provide outputs to one or more vehicle systems to improve health, satisfaction, mood, safety, one or more financial metrics, efficiency, or the like.

Such systems may involve a wide range of in-vehicle experience parameters (including any of the experience parameters described herein, such as driving experience (including assisted and self-driving, as well as vehicle responsiveness to inputs, such as in controlled suspension performance, approaches to curves, braking and the like), seat positioning (including lumbar support, leg room, seatback angle, seat height and angle, etc.), climate control (including ventilation, window or moonroof state (e.g., open or closed), temperature, humidity, fan speed, air motion and the like), sound (e.g., volume, bass, treble, individual speaker control, focus area of sound, etc.), content (audio, video and other types, including music, news, advertising and the like), route selection (e.g., for speed, for road experience (e.g., smooth or rough, flat or hilly, straight or curving), for points of interest (POIs), for view (e.g., scenic routes), for novelty (e.g., to see different locations), and/or for defined purposes (e.g., shopping opportunities, saving fuel, refueling opportunities, recharging opportunities, or the like).

In many situations, variation of one or more vehicle experience parameters may provide or result in a preferred state for a vehicle 5110 (or set of vehicles), a user (such as vehicle rider 51120), or both, as compared to seeking to find a single optimized state of such a parameter. For example, while a user may have a preferred seat position, sitting in the same position every day, or during an extended period on the same day, may have adverse effects, such as placing undue pressure on certain joints, promoting atrophy of certain muscles, diminishing flexibility of soft tissue, or the like. In such a situation, an automated control system (including one that is configured to use artificial intelligence of any of the types described herein) may be configured to induce variation in one or more of the user experience parameters described herein, optionally with random variation or with variation that is according to a prescribed pattern, such as one that may be prescribed according to a regimen, such as one developed to provide physical therapy, chiropractic, or other medical or health benefits. As one example, seat positioning may be varied over time to promote health of joints, muscles, ligaments, cartilage or the like. As another example, consistent with evidence that human health is improved when an individual experiences significant variations in temperature, humidity, and other climate factors, a climate control system may be varied (randomly or according to a defined regimen) to provide varying temperature, humidity, fresh air (including by opening windows or ventilation) or the like in order to improve the health, mood, or alertness of a user.

An artificial intelligence-based control system 5136 may be trained on a set of outcomes (of various types described herein) to provide a level of variation of a user experience that achieves desired outcomes, including selection of the timing and extent of such variations. As another example, an audio system may be varied to preserve hearing (such as based on tracking accumulated sound pressure levels, accumulated dosage, or the like), to promote alertness (such as by varying the type of content), and/or to improve health (such as by providing a mix of stimulating and relaxing content). In embodiments, such an artificial intelligence system 5136 may be fed sensor data 51444, such as from a wearable device 51157 (including a sensor set) or a physiological sensing system 51190, which includes a set of systems and/or sensors capable of providing physiological monitoring within a vehicle 5110 (e.g., a vison-based system 51186 that observes a user, a sensor 5125 embedded in a seat, a steering wheel, or the like that can measure a physiological parameter, or the like). For example, a vehicle interface 51188 (such as a steering wheel or any other interface described herein) can measure a physiological parameter (e.g., galvanic skin response, such as to indicate a stress level, cortisol level, or the like of a driver or other user), which can be used to indicate a current state for purposes of control or can be used as part of a training data set to optimize one or more parameters that may benefit from control, including control of variation of user experience to achieve desired outcomes. In one such example, an artificial intelligence system 5136 may vary parameters, such as driving experience, music and the like, to account for changes in hormonal systems of the user (such as cortisol and other adrenal system hormones), such as to induce healthy changes in state (consistent with evidence that varying cortisol levels over the course of a day are typical in healthy individuals, but excessively high or low levels at certain times of day may be unhealthy or unsafe). Such a system may, for example, “amp up” the experience with more aggressive settings (e.g., more acceleration into curves, tighter suspension, and/or louder music) in the morning when rising cortisol levels are healthy and “mellow out” the experience (such as by softer suspension, relaxing music and/or gentle driving motion) in the afternoon when cortisol levels should be dropping to lower levels to promote health. Experiences may consider both health of the user and safety, such as by ensuring that levels vary over time, but are sufficiently high to assure alertness (and hence safety) in situations where high alertness is required. While cortisol (an important hormone) is provided as an example, user experience parameters may be controlled (optionally with random or configured variation) with respect to other hormonal or biological systems, including insulin-related systems, cardiovascular systems (e.g., relating to pulse and blood pressure), gastrointestinal systems, and many others.

An aspect provided herein includes a system for transportation 5111, comprising: an artificial intelligence system 5136 to automatically randomize a parameter of an in-vehicle experience to improve a user state. In embodiments, the user state benefits from variation of the parameter.

An aspect provided herein includes a system for transportation 5111, comprising: a vehicle interface 51188 for gathering physiological sensed data of a rider 51120 in the vehicle 5110; and an artificial intelligence-based circuit 51189 that is trained on a set of outcomes related to rider in-vehicle experience and that induces, responsive to the sensed rider physiological data, variation in one or more of the user experience parameters to achieve at least one desired outcome in the set of outcomes, the inducing variation including control of timing and extent of the variation.

In embodiments, the induced variation includes random variation. In embodiments, the induced variation includes variation that is according to a prescribed pattern. In embodiments, the prescribed pattern is prescribed according to a regimen. In embodiments, the regimen is developed to provide at least one of physical therapy, chiropractic, and other medical health benefits. In embodiments, the one or more user experience parameters affect at least one of seat position, temperature, humidity, cabin air source, or audio output. In embodiments, the vehicle interface 51188 comprises at least one wearable sensor 51157 disposed to be worn by the rider 51120. In embodiments, the vehicle interface 51188 comprises a vision system 51186 disposed to capture and analyze images from a plurality of perspectives of the rider 51120. In embodiments, the variation in one or more of the user experience parameters comprises variation in control of the vehicle 5110.

In embodiments, variation in control of the vehicle 5110 includes configuring the vehicle 5110 for aggressive driving performance. In embodiments, variation in control of the vehicle 5110 includes configuring the vehicle 5110 for non-aggressive driving performance. In embodiments, the variation is responsive to the physiological sensed data that includes an indication of a hormonal level of the rider 51120, and the artificial intelligence-based circuit 51189 varies the one or more user experience parameters to promote a hormonal state that promotes rider safety.

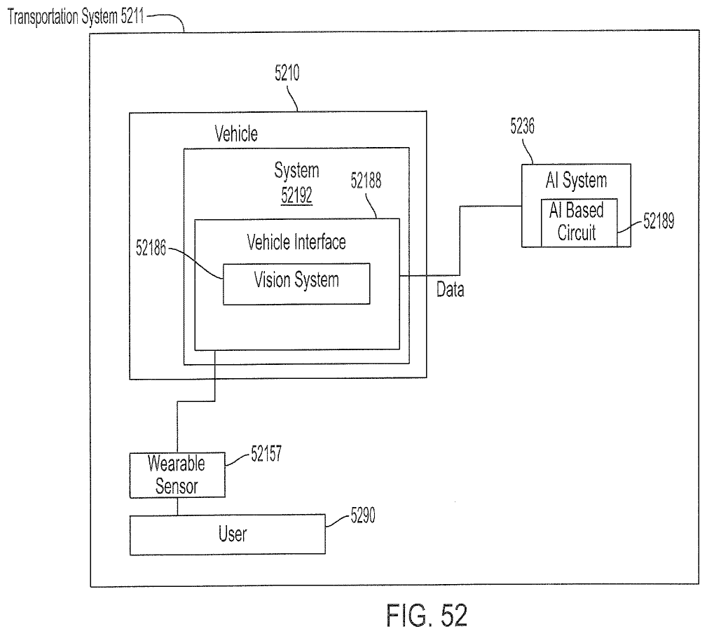

Referring now to FIG. 52, also provided herein are transportation systems 5211 having a system 52192 for taking an indicator of a hormonal system level of a user 5290 and automatically varying a user experience in the vehicle 5210 to promote a hormonal state that promotes safety.

An aspect provided herein includes a system for transportation 5211, comprising: a system 52192 for detecting an indicator of a hormonal system level of a user 5290 and automatically varying a user experience in a vehicle 5210 to promote a hormonal state that promotes safety.

An aspect provided herein includes a system for transportation 5211 comprising: a vehicle interface 52188 for gathering hormonal state data of a rider (e.g., user 5290) in the vehicle 5210; and an artificial intelligence-based circuit 52189 that is trained on a set of outcomes related to rider in-vehicle experience and that induces, responsive to the sensed rider hormonal state data, variation in one or more of the user experience parameters to achieve at least one desired outcome in the set of outcomes, the set of outcomes including a least one outcome that promotes rider safety, the inducing variation including control of timing and extent of the variation.

In embodiments, the variation in the one or more user experience parameters is controlled by the artificial intelligence system 5236 to promote a desired hormonal state of the rider (e.g., user 5290). In embodiments, the desired hormonal state of the rider promotes safety. In embodiments, the at least one desired outcome in the set of outcomes is the at least one outcome that promotes rider safety. In embodiments, the variation in the one or more user experience parameters includes varying at least one of a food and a beverage offered to the rider (e.g., user 5290). In embodiments, the one or more user experience parameters affect at least one of seat position, temperature, humidity, cabin air source, or audio output. In embodiments, the vehicle interface 52188 comprises at least one wearable sensor 52157 disposed to be worn by the rider (e.g., user 5290).

In embodiments, the vehicle interface 52188 comprises a vision system 52186 disposed to capture and analyze images from a plurality of perspectives of the rider (e.g., user 5290). In embodiments, the variation in one or more of the user experience parameters comprises variation in control of the vehicle 5210. In embodiments, variation in control of the vehicle 5210 includes configuring the vehicle 5210 for aggressive driving performance. In embodiments, variation in control of the vehicle 5210 includes configuring the vehicle 5210 for non-aggressive driving performance.

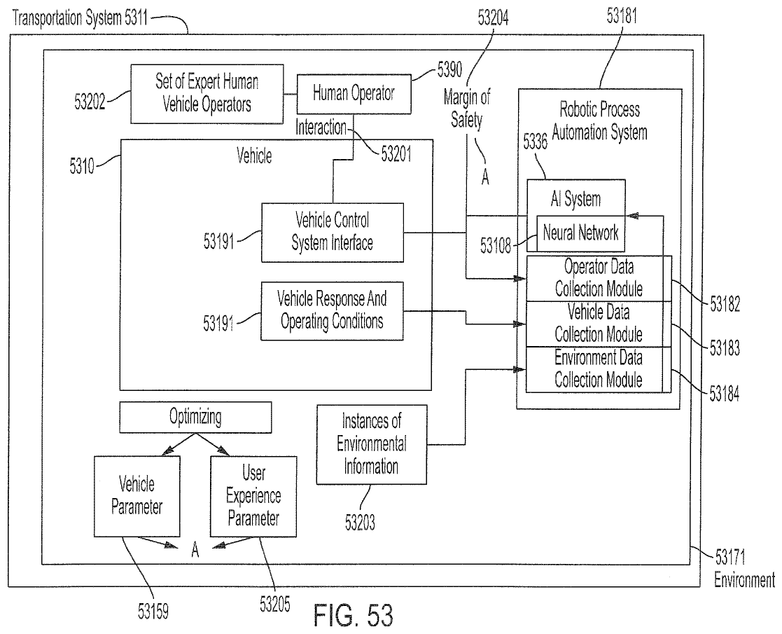

Referring to FIG. 53, provided herein are transportation systems 5311 having a system for optimizing at least one of a vehicle parameter 53159 and a user experience parameter 53205 to provide a margin of safety 53204. In embodiments, the margin of safety 53204 may be a user-selected margin of safety or user-based margin of safety, such as selected based on a profile of a user or actively selected by a user, such as by interaction with a user interface, or selected based on a profile developed by tracking user behavior, including behavior in a vehicle 5310 and in other contexts, such as on social media, in e-commerce, in consuming content, in moving from place-to-place, or the like. In many situations, there is a tradeoff between optimizing the performance of a dynamic system (such as to achieve some objective function, like fuel efficiency) and one or more risks that are present in the system. This is particularly true in situations where there is some asymmetry between the benefits of optimizing one or more parameters and the risks that are present in the dynamic systems in which the parameter plays a role. As an example, seeking to minimize travel time (such as for a daily commute), leads to an increased likelihood of arriving late, because a wide range of effects in dynamic systems, such as ones involving vehicle traffic, tend to cascade and periodically produce travel times that vary widely (and quite often adversely). Variances in many systems are not symmetrical; for example, unusually uncrowded roads may improve a 30-mile commute time by a few minutes, but an accident, or high congestion, can increase the same commute by an hour or more. Thus, to avoid risks that have high adverse consequences, a wide margin of safety may be required. In embodiments, systems are provided herein for using an expert system (which may be model-based, rule-based, deep learning, a hybrid, or other intelligent systems as described herein) to provide a desired margin of safety with respect to adverse events that are present in transportation-related dynamic systems. The margin of safety 53204 may be provided via an output of the expert system 5336, such as an instruction, a control parameter for a vehicle 5310 or an in-vehicle user experience, or the like. An artificial intelligence system 5336 may be trained to provide the margin of safety 53204 based on a training set of data based on outcomes of transportation systems, such as traffic data, weather data, accident data, vehicle maintenance data, fueling and charging system data (including in-vehicle data and data from infrastructure systems, such as charging stations, fueling stations, and energy production, transportation, and storage systems), user behavior data, user health data, user satisfaction data, financial information (e.g., user financial information, pricing information (e.g., for fuel, for food, for accommodations along a route, and the like), vehicle safety data, failure mode data, vehicle information system data, and the like), and many other types of data as described herein and in the documents incorporated by reference herein.

An aspect provided herein includes a system for transportation 5311, comprising: a system for optimizing at least one of a vehicle parameter 53159 and a user experience parameter 53205 to provide a margin of safety 53204.

An aspect provided herein includes a transportation system 5311 for optimizing a margin of safety when mimicking human operation of a vehicle 5310, the transportation system 5311 comprising: a set of robotic process automation systems 53181 comprising: an operator data collection module 53182 to capture human operator 5390 interactions 53201 with a vehicle control system interface 53191; a vehicle data collection module 53183 to capture vehicle response and operating conditions associated at least contemporaneously with the human operator interaction 53201; an environment data collection module 53184 to capture instances of environmental information 53203 associated at least contemporaneously with the human operator interactions 53201; and an artificial intelligence system 5336 to learn to control the vehicle 5310 with an optimized margin of safety while mimicking the human operator. In embodiments, the artificial intelligence system 5336 is responsive to the robotic process automation system 53181. In embodiments, the artificial intelligence system 5336 is to detect data indicative of at least one of a plurality of the instances of environmental information associated with the contemporaneously captured vehicle response and operating conditions. In embodiments, the optimized margin of safety is to be achieved by training the artificial intelligence system 5336 to control the vehicle 5310 based on a set of human operator interaction data collected from interactions of a set of expert human vehicle operators with the vehicle control system interface 53191.

In embodiments, the operator data collection module 53182 captures patterns of data including braking patterns, follow-behind distance, approach to curve acceleration patterns, lane preferences, or passing preferences. In embodiments, the vehicle data collection module 53183 captures data from a plurality of vehicle data systems that provide data streams indicating states and changes in state in steering, braking, acceleration, forward looking images, or rear-looking images. In embodiments, the artificial intelligence system includes a neural network 53108 for training the artificial intelligence system 53114.

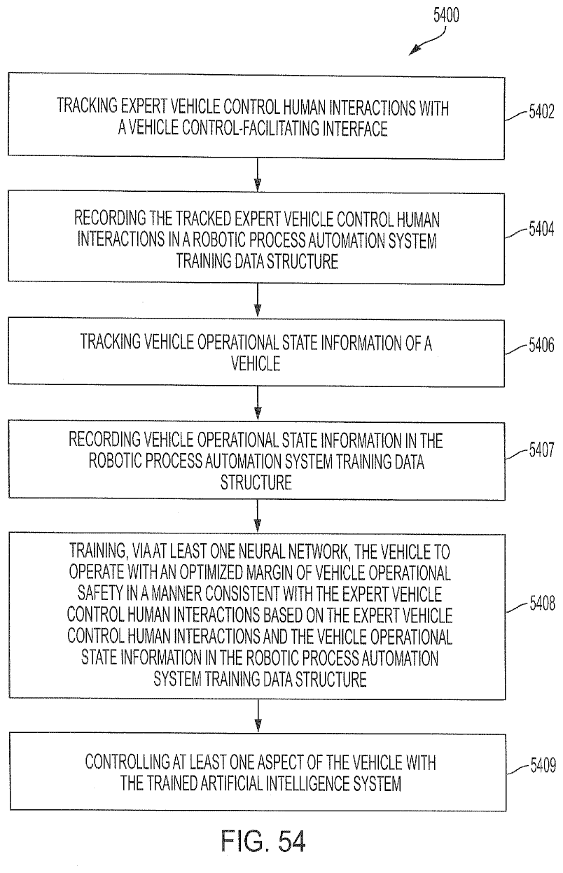

FIG. 54 illustrates a method 5400 of robotic process automation for achieving an optimized margin of vehicle operational safety in accordance with embodiments of the systems and methods disclosed herein. At 5402 the method includes tracking expert vehicle control human interactions with a vehicle control-facilitating interface. At 5404 the method includes recording the tracked expert vehicle control human interactions in a robotic process automation system training data structure. At 5406 the method includes tracking vehicle operational state information of a vehicle. At 5407 the method includes recording vehicle operational state information in the robotic process automation system training data structure. At 5408 the method includes training, via at least one neural network, the vehicle to operate with an optimized margin of vehicle operational safety in a manner consistent with the expert vehicle control human interactions based on the expert vehicle control human interactions and the vehicle operational state information in the robotic process automation system training data structure. At 5409 the method includes controlling at least one aspect of the vehicle with the trained artificial intelligence system.

Referring to FIG. 53 and FIG. 54, in embodiments, the method further comprises applying deep learning to optimize the margin of vehicle operational safety by controlling the at least one aspect of the vehicle through structured variation in the controlling the at least one aspect of the vehicle to mimic the expert vehicle control human interactions 53201 and processing feedback from the controlling the at least one aspect of the vehicle with machine learning. In embodiments, the controlling at least one aspect of the vehicle is performed via the vehicle control-facilitating interface 53191. In embodiments, the controlling at least one aspect of the vehicle is performed by the artificial intelligence system emulating the control-facilitating interface being operated by the expert vehicle control human 53202. In embodiments, the vehicle control-facilitating interface 53191 comprises at least one of an audio capture system to capture audible expressions of the expert vehicle control human, a human-machine interface, mechanical interface, an optical interface and a sensor-based interface. In embodiments, the tracking vehicle operational state information comprises tracking at least one of vehicle systems and vehicle operational processes affected by the expert vehicle control human interactions. In embodiments, the tracking vehicle operational state information comprises tracking at least one vehicle system element. In embodiments, the at least one vehicle system element is controlled via the vehicle control-facilitating interface. In embodiments, the at least one vehicle system element is affected by the expert vehicle control human interactions.

In embodiments, the tracking vehicle operational state information comprises tracking the vehicle operational state information before, during, and after the expert vehicle control human interaction. In embodiments, the tracking vehicle operational state information comprises tracking at least one of a plurality of vehicle control system outputs that result from the expert vehicle control human interactions and vehicle operational results achieved responsive to the expert vehicle control human interactions. In embodiments, the vehicle is to be controlled to achieve results that are consistent with results achieved via the expert vehicle control human interactions.

In embodiments, the method further comprises tracking and recording conditions proximal to the vehicle with a plurality of vehicle mounted sensors. In embodiments, the training of the artificial intelligence system is further responsive to the conditions proximal to the vehicle tracked contemporaneously to the expert vehicle control human interactions. In embodiments, the training is further responsive to a plurality of data feeds from remote sensors, the plurality of data feeds comprising data collected by the remote sensors contemporaneous to the expert vehicle control human interactions.

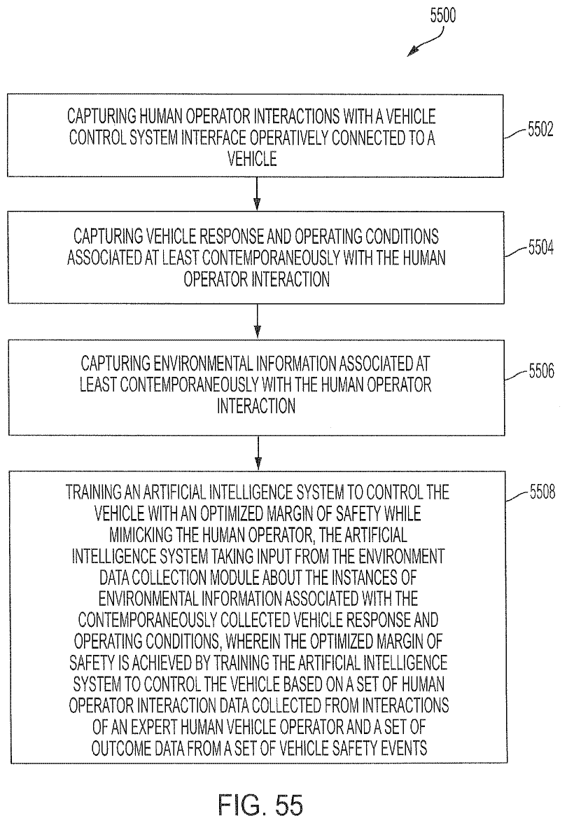

FIG. 55 illustrates a method 5500 for mimicking human operation of a vehicle by robotic process automation in accordance with embodiments of the systems and methods disclosed herein. At 5502 the method includes capturing human operator interactions with a vehicle control system interface operatively connected to a vehicle. At 5504 the method includes capturing vehicle response and operating conditions associated at least contemporaneously with the human operator interaction. At 5506 the method includes capturing environmental information associated at least contemporaneously with the human operator interaction. At 5508 the method includes training an artificial intelligence system to control the vehicle with an optimized margin of safety while mimicking the human operator, the artificial intelligence system taking input from the environment data collection module about the instances of environmental information associated with the contemporaneously collected vehicle response and operating conditions. In embodiments, the optimized margin of safety is achieved by training the artificial intelligence system to control the vehicle based on a set of human operator interaction data collected from interactions of an expert human vehicle operator and a set of outcome data from a set of vehicle safety events.

Referring to FIGS. 53 and 55 in embodiments, the method further comprises: applying deep learning of the artificial intelligence system 53114 to optimize a margin of vehicle operating safety 53204 by affecting a controlling of at least one aspect of the vehicle through structured variation in control of the at least one aspect of the vehicle to mimic the expert vehicle control human interactions 53201 and processing feedback from the controlling of the at least one aspect of the vehicle with machine learning. In embodiments, the artificial intelligence system employs a workflow that involves decision-making and the robotic process automation system 53181 facilitates automation of the decision-making. In embodiments, the artificial intelligence system employs a workflow that involves remote control of the vehicle and the robotic process automation system facilitates automation of remotely controlling the vehicle 5310.

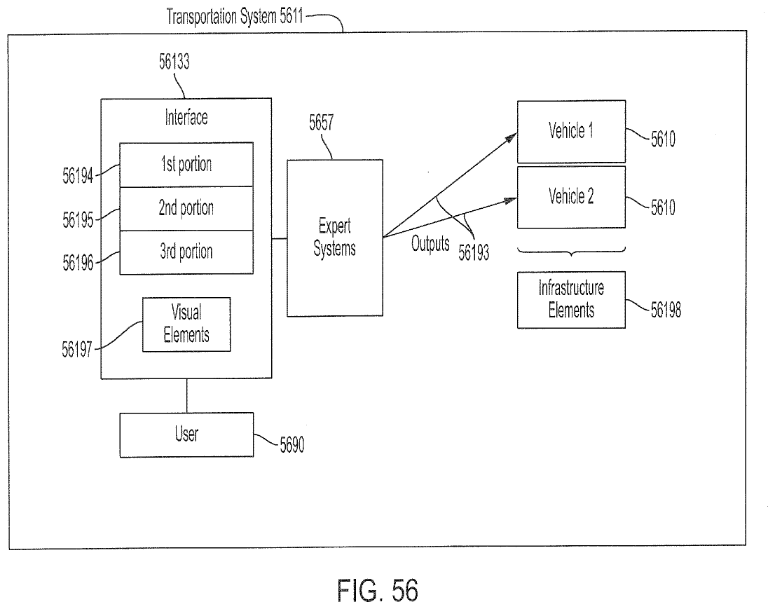

Referring now to FIG. 56, a transportation system 5611 is depicted which includes an interface 56133 by which a set of expert systems 5657 may be configured to provide respective outputs 56193 for managing at least one of a set of vehicle parameters, a set of fleet parameters and a set of user experience parameters.

Such an interface 56133 may include a graphical user interface (such as having a set of visual elements, menu items, forms, and the like that can be manipulated to enable selection and/or configuration of an expert system 5657), an application programming interface, an interface to a computing platform (e.g., a cloud-computing platform, such as to configure parameters of one or more services, programs, modules, or the like), and others. For example, an interface 56133 may be used to select a type of expert system 5657, such as a model (e.g., a selected model for representing behavior of a vehicle, a fleet or a user, or a model representing an aspect of an environment relevant to transportation, such as a weather model, a traffic model, a fuel consumption model, an energy distribution model, a pricing model or the like), an artificial intelligence system (such as selecting a type of neural network, deep learning system, or the like, of any type described herein), or a combination or hybrid thereof. For example, a user may, in an interface 56133, elect to use the European Center for Medium-Range Weather Forecast (ECMWF) to forecast weather events that may impact a transportation environment, along with a recurrent neural network for forecasting user shopping behavior (such as to indicate likely preferences of a user along a traffic route).

Thus, an interface 56133 may be configured to provide a host, manager, operator, service provider, vendor, or other entity interacting within or with a transportation system 5611 with the ability to review a range of models, expert systems 5657, neural network categories, and the like. The interface 56133 may optionally be provided with one or more indicators of suitability for a given purpose, such as one or more ratings, statistical measures of validity, or the like. The interface 56133 may also be configured to select a set (e.g., a model, expert system, neural network, etc.) that is well adapted for purposes of a given transportation system, environment, and purpose. In embodiments, such an interface 56133 may allow a user 5690 to configure one or more parameters of an expert system 5657, such as one or more input data sources to which a model is to be applied and/or one or more inputs to a neural network, one or more output types, targets, durations, or purposes, one or more weights within a model or an artificial intelligence system, one or more sets of nodes and/or interconnections within a model, graph structure, neural network, or the like, one or more time periods of input, output, or operation, one or more frequencies of operation, calculation, or the like, one or more rules (such as rules applying to any of the parameters configured as described herein or operating upon any of the inputs or outputs noted herein), one or more infrastructure parameters (such as storage parameters, network utilization parameters, processing parameters, processing platform parameters, or the like). As one example among many other possible examples, a user 5690 may configure a selected neural network to take inputs from a weather model, a traffic model, and a real-time traffic reporting system in order to provide a real-time output 56193 to a routing system for a vehicle 5610, where the neural network is configured to have ten million nodes and to undertake processing on a selected cloud platform.

In embodiments, the interface 56133 may include elements for selection and/or configuration of a purpose, an objective or a desired outcome of a system and/or sub-system, such as one that provides input, feedback, or supervision to a model, to a machine learning system, or the like. For example, a user 5690 may be allowed, in an interface 56133, to select among modes (e.g., comfort mode, sports mode, high-efficiency mode, work mode, entertainment mode, sleep mode, relaxation mode, long-distance trip mode, or the like) that correspond to desired outcomes, which may include emotional outcomes, financial outcomes, performance outcomes, trip duration outcomes, energy utilization outcomes, environmental impact outcomes, traffic avoidance outcomes, or the like. Outcomes may be declared with varying levels of specificity. Outcomes may be defined by or for a given user 5690 (such as based on a user profile or behavior) or for a group of users (such as by one or more functions that harmonizes outcomes according to multiple user profiles, such as by selecting a desired configuration that is consistent with an acceptable state for each of a set of riders). As an example, a rider may indicate a preferred outcome of active entertainment, while another rider may indicate a preferred outcome of maximum safety. In such a case, the interface 56133 may provide a reward parameter to a model or expert system 5657 for actions that reduce risk and for actions that increase entertainment, resulting in outcomes that are consistent with objectives of both riders. Rewards may be weighted, such as to optimize a set of outcomes. Competition among potentially conflicting outcomes may be resolved by a model, by rule (e.g., a vehicle owner's objectives may be weighted higher than other riders, a parent's over a child, or the like), or by machine learning, such as by using genetic programming techniques (such as by varying combinations of weights and/or outcomes randomly or systematically and determining overall satisfaction of a rider or set of riders).

An aspect provided herein includes a system for transportation 5611, comprising: an interface 56133 to configure a set of expert systems 5657 to provide respective outputs 56193 for managing a set of parameters selected from the group consisting of a set of vehicle parameters, a set of fleet parameters, a set of user experience parameters, and combinations thereof.

An aspect provided herein includes a system for configuration management of components of a transportation system 5611 comprising: an interface 56133 comprising: a first portion 56194 of the interface 56133 for configuring a first expert computing system of the expert computing systems 5657 for managing a set of vehicle parameters; a second portion 56195 of the interface 56133 for configuring a second expert computing system of the expert computing systems 5657 for managing a set of vehicle fleet parameters; and a third portion 56196 of the interface 56133 for configuring a third expert computing system for managing a set of user experience parameters. In embodiments, the interface 56133 is a graphical user interface through which a set of visual elements 56197 presented in the graphical user interface, when manipulated in the interface 56133 causes at least one of selection and configuration of one or more of the first, second, and third expert systems 5657. In embodiments, the interface 56133 is an application programming interface. In embodiments, the interface 56133 is an interface to a cloud-based computing platform through which one or more transportation-centric services, programs and modules are configured.

An aspect provided herein includes a transportation system 5611 comprising: an interface 56133 for configuring a set of expert systems 5657 to provide outputs 56193 based on which the transportation system 5611 manages transportation-related parameters. In embodiments, the parameters facilitate operation of at least one of a set of vehicles, a fleet of vehicles, and a transportation system user experience; and a plurality of visual elements 56197 representing a set of attributes and parameters of the set of expert systems 5657 that are configurable by the interface 56133 and a plurality of the transportation systems 5611. In embodiments, the interface 56133 is configured to facilitate manipulating the visual elements 56197 thereby causing configuration of the set of expert systems 5657. In embodiments, the plurality of the transportation systems comprises a set of vehicles 5610.

In embodiments, the plurality of the transportation systems comprises a set of infrastructure elements 56198 supporting a set of vehicles 5610. In embodiments, the set of infrastructure elements 56198 comprises vehicle fueling elements. In embodiments, the set of infrastructure elements 56198 comprises vehicle charging elements. In embodiments, the set of infrastructure elements 56198 comprises traffic control lights. In embodiments, the set of infrastructure elements 56198 comprises a toll booth. In embodiments, the set of infrastructure elements 56198 comprises a rail system. In embodiments, the set of infrastructure elements 56198 comprises automated parking facilities. In embodiments, the set of infrastructure elements 56198 comprises vehicle monitoring sensors.

In embodiments, the visual elements 56197 display a plurality of models that can be selected for use in the set of expert systems 5657. In embodiments, the visual elements 56197 display a plurality of neural network categories that can be selected for use in the set of expert systems 5657. In embodiments, at least one of the plurality of neural network categories includes a convolutional neural network. In embodiments, the visual elements 56197 include one or more indicators of suitability of items represented by the plurality of visual elements 56197 for a given purpose. In embodiments, configuring a plurality of expert systems 5657 comprises facilitating selection sources of inputs for use by at least a portion of the plurality of expert systems 5657. In embodiments, the interface 56133 facilitates selection, for at least a portion of the plurality of expert systems 5657, one or more output types, targets, durations, and purposes.

In embodiments, the interface 56133 facilitates selection, for at least a portion of the plurality of expert systems 5657, of one or more weights within a model or an artificial intelligence system. In embodiments, the interface 56133 facilitates selection, for at least a portion of the plurality of expert systems 5657, of one or more sets of nodes or interconnections within a model. In embodiments, the interface 56133 facilitates selection, for at least a portion of the plurality of expert systems 5657, of a graph structure. In embodiments, the interface 56133 facilitates selection, for at least a portion of the plurality of expert systems 5657, of a neural network. In embodiments, the interface facilitates selection, for at least a portion of the plurality of expert systems, of one or more time periods of input, output, or operation.

In embodiments, the interface 56133 facilitates selection, for at least a portion of the plurality of expert systems 5657, of one or more frequencies of operation. In embodiments, the interface 56133 facilitates selection, for at least a portion of the plurality of expert systems 5657, of frequencies of calculation. In embodiments, the interface 56133 facilitates selection, for at least a portion of the plurality of expert systems 5657, of one or more rules for applying to the plurality of parameters. In embodiments, the interface 56133 facilitates selection, for at least a portion of the plurality of expert systems 5657, of one or more rules for operating upon any of the inputs or upon the provided outputs. In embodiments, the plurality of parameters comprise one or more infrastructure parameters selected from the group consisting of storage parameters, network utilization parameters, processing parameters, and processing platform parameters.

In embodiments, the interface 56133 facilitates selecting a class of an artificial intelligence computing system, a source of inputs to the selected artificial intelligence computing system, a computing capacity of the selected artificial intelligence computing system, a processor for executing the artificial intelligence computing system, and an outcome objective of executing the artificial intelligence computing system. In embodiments, the interface 56133 facilitates selecting one or more operational modes of at least one of the vehicles 5610 in the transportation system 5611. In embodiments, the interface 56133 facilitates selecting a degree of specificity for outputs 56193 produced by at least one of the plurality of expert systems 5657.

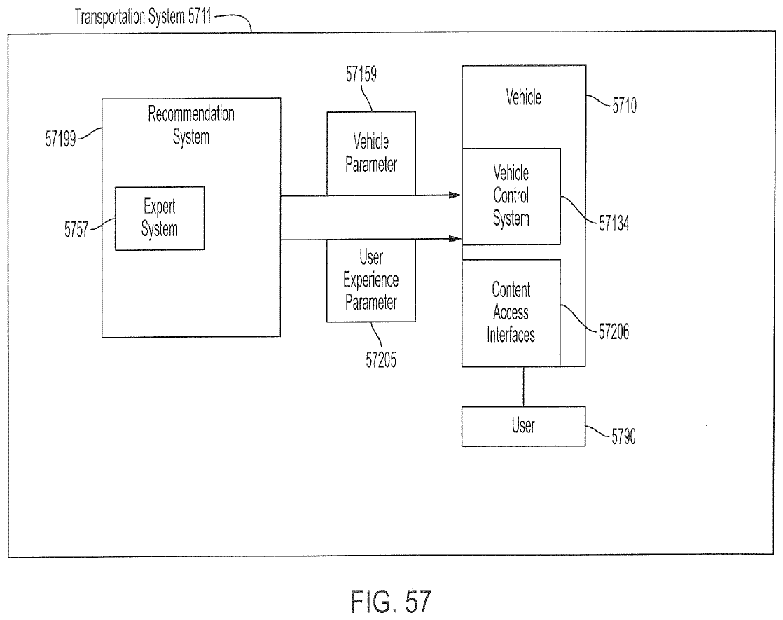

Referring now to FIG. 57, an example of a transportation system 5711 is depicted having an expert system 5757 for configuring a recommendation for a configuration of a vehicle 5710. In embodiments, the recommendation includes at least one parameter of configuration for the expert system 5757 that controls a parameter of at least one of a vehicle parameter 57159 and a user experience parameter 57205. Such a recommendation system may recommend a configuration for a user based on a wide range of information, including data sets indicating degrees of satisfaction of other users, such as user profiles, user behavior tracking (within a vehicle and outside), content recommendation systems (such as collaborative filtering systems used to recommend music, movies, video and other content), content search systems (e.g., such as used to provide relevant search results to queries), e-commerce tracking systems (such as to indicate user preferences, interests, and intents), and many others. The recommendation system 57199 may use the foregoing to profile a rider and, based on indicators of satisfaction by other riders, determine a configuration of a vehicle 5710, or an experience within the vehicle 5710, for the rider.

The configuration may use similarity (such as by similarity matrix approaches, attribute-based clustering approaches (e.g., k-means clustering) or other techniques to group a rider with other similar riders. Configuration may use collaborative filtering, such as by querying a rider about particular content, experiences, and the like and taking input as to whether they are favorable or unfavorable (optionally with a degree of favorability, such as a rating system (e.g., 5 stars for a great item of content). The recommendation system 57199 may use genetic programming, such as by configuring (with random and/or systematic variation) combinations of vehicle parameters and/or user experience parameters and taking inputs from a rider or a set of riders (e.g., a large survey group) to determine a set of favorable configurations. This may occur with machine learning over a large set of outcomes, where outcomes may include various reward functions of the type described herein, including indicators of overall satisfaction and/or indicators of specific objectives. Thus, a machine learning system or other expert systems 5757 may learn to configure the overall ride for a rider or set of riders and to recommend such a configuration for a rider. Recommendations may be based on context, such as whether a rider is alone or in a group, the time of day (or week, month or year), the type of trip, the objective of the trip, the type or road, the duration of a trip, the route, and the like.

An aspect provided herein includes a system for transportation 5711, comprising: an expert system 5757 to configure a recommendation for a vehicle configuration. In embodiments, the recommendation includes at least one parameter of configuration for the expert system 5757 that controls a parameter selected from the group consisting of a vehicle parameter 57159, a user experience parameter 57205, and combinations thereof.

An aspect provided herein includes a recommendation system 57199 for recommending a configuration of a vehicle 5710, the recommendation system 57199 comprising an expert system 5757 that produces a recommendation of a parameter for configuring a vehicle control system 57134 that controls at least one of a vehicle parameter 57159 and a vehicle rider experience parameter 57205.

In embodiments, the vehicle 5710 comprises a system for automating at least one control parameter of the vehicle 5710. In embodiments, the vehicle is at least a semi-autonomous vehicle. In embodiments, the vehicle is automatically routed. In embodiments, the vehicle is a self-driving vehicle.

In embodiments, the expert system 5757 is a neural network system. In embodiments, the expert system 5757 is a deep learning system. In embodiments, the expert system 5757 is a machine learning system. In embodiments, the expert system 5757 is a model-based system. In embodiments, the expert system 5757 is a rule-based system. In embodiments, the expert system 5757 is a random walk-based system. In embodiments, the expert system 5757 is a genetic algorithm system. In embodiments, the expert system 5757 is a convolutional neural network system. In embodiments, the expert system 5757 is a self-organizing system. In embodiments, the expert system 5757 is a pattern recognition system. In embodiments, the expert system 5757 is a hybrid artificial intelligence-based system. In embodiments, the expert system 5757 is an acrylic graph-based system.

In embodiments, the expert system 5757 produces a recommendation based on degrees of satisfaction of a plurality of riders of vehicles 5710 in the transportation system 5711. In embodiments, the expert system 5757 produces a recommendation based on a rider entertainment degree of satisfaction. In embodiments, the expert system 5757 produces a recommendation based on a rider safety degree of satisfaction. In embodiments, the expert system 5757 produces a recommendation based on a rider comfort degree of satisfaction. In embodiments, the expert system 5757 produces a recommendation based on a rider in-vehicle search degree of satisfaction.

In embodiments, the at least one rider (or user) experience parameter 57205 is a parameter of traffic congestion. In embodiments, the at least one rider experience parameter 57205 is a parameter of desired arrival times. In embodiments, the at least one rider experience parameter 57205 is a parameter of preferred routes. In embodiments, the at least one rider experience parameter 57205 is a parameter of fuel efficiency. In embodiments, the at least one rider experience parameter 57205 is a parameter of pollution reduction. In embodiments, the at least one rider experience parameter 57205 is a parameter of accident avoidance. In embodiments, the at least one rider experience parameter 57205 is a parameter of avoiding bad weather. In embodiments, the at least one rider experience parameter 57205 is a parameter of avoiding bad road conditions. In embodiments, the at least one rider experience parameter 57205 is a parameter of reduced fuel consumption. In embodiments, the at least one rider experience parameter 57205 is a parameter of reduced carbon footprint. In embodiments, the at least one rider experience parameter 57205 is a parameter of reduced noise in a region. In embodiments, the at least one rider experience parameter 57205 is a parameter of avoiding high-crime regions.

In embodiments, the at least one rider experience parameter 57205 is a parameter of collective satisfaction. In embodiments, the at least one rider experience parameter 57205 is a parameter of maximum speed limit. In embodiments, the at least one rider experience parameter 57205 is a parameter of avoidance of toll roads. In embodiments, the at least one rider experience parameter 57205 is a parameter of avoidance of city roads. In embodiments, the at least one rider experience parameter 57205 is a parameter of avoidance of undivided highways. In embodiments, the at least one rider experience parameter 57205 is a parameter of avoidance of left turns. In embodiments, the at least one rider experience parameter 57205 is a parameter of avoidance of driver-operated vehicles.

In embodiments, the at least one vehicle parameter 57159 is a parameter of fuel consumption. In embodiments, the at least one vehicle parameter 57159 is a parameter of carbon footprint. In embodiments, the at least one vehicle parameter 57159 is a parameter of vehicle speed. In embodiments, the at least one vehicle parameter 57159 is a parameter of vehicle acceleration. In embodiments, the at least one vehicle parameter 57159 is a parameter of travel time.

In embodiments, the expert system 5757 produces a recommendation based on at least one of user behavior of the rider (e.g., user 5790) and rider interactions with content access interfaces 57206 of the vehicle 5710. In embodiments, the expert system 5757 produces a recommendation based on similarity of a profile of the rider (e.g., user 5790) to profiles of other riders. In embodiments, the expert system 5757 produces a recommendation based on a result of collaborative filtering determined through querying the rider (e.g., user 5790) and taking input that facilitates classifying rider responses thereto on a scale of response classes ranging from favorable to unfavorable. In embodiments, the expert system 5757 produces a recommendation based on content relevant to the rider (e.g., user 5790) including at least one selected from the group consisting of classification of trip, time of day, classification of road, trip duration, configured route, and number of riders.

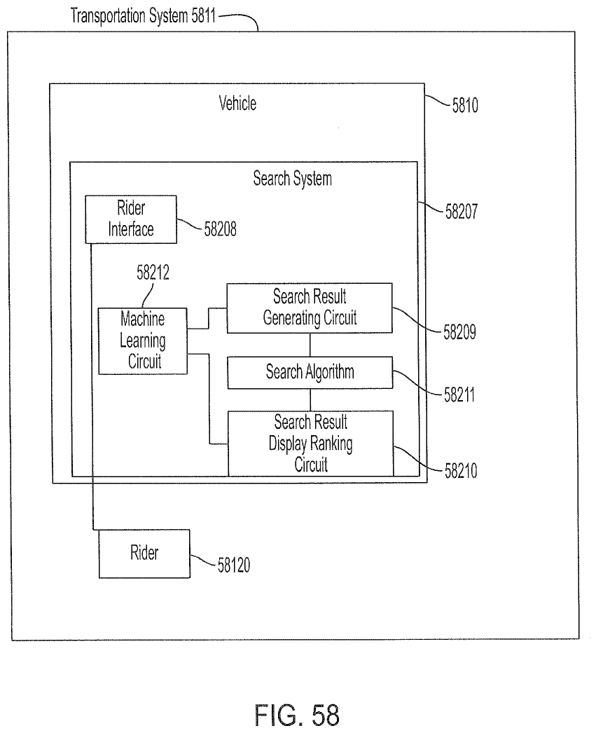

Referring now to FIG. 58, an example transportation system 5811 is depicted having a search system 58207 that is configured to provide network search results for in-vehicle searchers.

Self-driving vehicles offer their riders greatly increased opportunity to engage with in-vehicle interfaces, such as touch screens, virtual assistants, entertainment system interfaces, communication interfaces, navigation interfaces, and the like. While systems exist to display the interface of a rider's mobile device on an in-vehicle interface, the content displayed on a mobile device screen is not necessarily tuned to the unique situation of a rider in a vehicle. In fact, riders in vehicles may be collectively quite different in their immediate needs from other individuals who engage with the interfaces, as the presence in the vehicle itself tends to indicate a number of things that are different from a user sitting at home, sitting at a desk, or walking around. One activity that engages almost all device users is searching, which is undertaken on many types of devices (desktops, mobile devices, wearable devices, and others). Searches typically include keyword entry, which may include natural language text entry or spoken queries. Queries are processed to provide search results, in one or more lists or menu elements, often involving delineation between sponsored results and non-sponsored results. Ranking algorithms typically factor in a wide range of inputs, in particular the extent of utility (such as indicated by engagement, clicking, attention, navigation, purchasing, viewing, listening, or the like) of a given search result to other users, such that more useful items are promoted higher in lists.

However, the usefulness of a search result may be very different for a rider in a self-driving vehicle than for more general searchers. For example, a rider who is being driven on a defined route (as the route is a necessary input to the self-driving vehicle) may be far more likely to value search results that are relevant to locations that are ahead of the rider on the route than the same individual would be sitting at the individual's desk at work or on a computer at home. Accordingly, conventional search engines may fail to deliver the most relevant results, deliver results that crowd out more relevant results, and the like, when considering the situation of a rider in a self-driving vehicle.

In embodiments, of the system 5811 of FIG. 58, a search result ranking system (search system 58207) may be configured to provide in-vehicle-relevant search results. In embodiments, such a configuration may be accomplished by segmenting a search result ranking algorithm to include ranking parameters that are observed in connection only with a set of in-vehicle searches, so that in-vehicle results are ranked based on outcomes with respect to in-vehicle searches by other users. In embodiments, such a configuration may be accomplished by adjusting the weighting parameters applied to one or more weights in a conventional search algorithm when an in-vehicle search is detected (such as by detecting an indicator of an in-vehicle system, such as by communication protocol type, IP address, presence of cookies stored on a vehicle, detection of mobility, or the like). For example, local search results may be weighted more heavily in a ranking algorithm.

In embodiments, routing information from a vehicle 5810 may be used as an input to a ranking algorithm, such as allowing favorable weighting of results that are relevant to local points of interest ahead on a route.

In embodiments, content types may be weighted more heavily in search results based on detection of an in-vehicle query, such as weather information, traffic information, event information and the like. In embodiments, outcomes tracked may be adjusted for in-vehicle search rankings, such as by including route changes as a factor in rankings (e.g., where a search result appears to be associated in time with a route change to a location that was the subject of a search result), by including rider feedback on search results (such as satisfaction indicators for a ride), by detecting in-vehicle behaviors that appear to derive from search results (such as playing music that appeared in a search result), and the like.

In embodiments, a set of in-vehicle-relevant search results may be provided in a separate portion of a search result interface (e.g., a rider interface 58208), such as in a portion of a window that allows a rider 57120 to see conventional search engine results, sponsored search results and in-vehicle relevant search results. In embodiments, both general search results and sponsored search results may be configured using any of the techniques described herein or other techniques that would be understood by skilled in the art to provide in-vehicle-relevant search results.

In embodiments where in-vehicle-relevant search results and conventional search results are presented in the same interface (e.g., the rider interface 58208), selection and engagement with in-vehicle-relevant search results can be used as a success metric to train or reinforce one or more search algorithms 58211. In embodiments, in-vehicle search algorithms 58211 may be trained using machine learning, optionally seeded by one or more conventional search models, which may optionally be provided with adjusted initial parameters based on one or more models of user behavior that may contemplate differences between in-vehicle behavior and other behavior. Machine learning may include use of neural networks, deep learning systems, model-based systems, and others. Feedback to machine learning may include conventional engagement metrics used for search, as well as metrics of rider satisfaction, emotional state, yield metrics (e.g., for sponsored search results, banner ads, and the like), and the like.

An aspect provided herein includes a system for transportation 5811, comprising: a search system 58207 to provide network search results for in-vehicle searchers.

An aspect provided herein includes an in-vehicle network search system 58207 of a vehicle 5810, the search system comprising: a rider interface 58208 through which the rider 58120 of the vehicle 5810 is enabled to engage with the search system 58207; a search result generating circuit 58209 that favors search results based on a set of in-vehicle search criteria that are derived from a plurality of in-vehicle searches previously conducted; and a search result display ranking circuit 58210 that orders the favored search results based on a relevance of a location component of the search results with a configured route of the vehicle 5810.

In embodiments, the vehicle 5810 comprises a system for automating at least one control parameter of the vehicle 5810. In embodiments, the vehicle 5810 is at least a semi-autonomous vehicle. In embodiments, the vehicle 5810 is automatically routed. In embodiments, the vehicle 5810 is a self-driving vehicle.

In embodiments, the rider interface 58208 comprises at least one of a touch screen, a virtual assistant, an entertainment system interface, a communication interface and a navigation interface.

In embodiments, the favored search results are ordered by the search result display ranking circuit 58210 so that results that are proximal to the configured route appear before other results. In embodiments, the in-vehicle search criteria are based on ranking parameters of a set of in-vehicle searches. In embodiments, the ranking parameters are observed in connection only with the set of in-vehicle searches. In embodiments, the search system 58207 adapts the search result generating circuit 58209 to favor search results that correlate to in-vehicle behaviors. In embodiments, the search results that correlate to in-vehicle behaviors are determined through comparison of rider behavior before and after conducting a search. In embodiments, the search system further comprises a machine learning circuit 58212 that facilitates training the search result generating circuit 58209 from a set of search results for a plurality of searchers and a set of search result generating parameters based on an in-vehicle rider behavior model.

An aspect provided herein includes an in-vehicle network search system 58207 of a vehicle 5810, the search system 58207 comprising: a rider interface 58208 through which the rider 58120 of the vehicle 5810 is enabled to engage with the search system 5810; a search result generating circuit 58209 that varies search results based on detection of whether the vehicle 5810 is in self-driving or autonomous mode or being driven by an active driver; and a search result display ranking circuit 58210 that orders the search results based on a relevance of a location component of the search results with a configured route of the vehicle 5810. In embodiments, the search results vary based on whether the user (e.g., the rider 58120) is a driver of the vehicle 5810 or a passenger in the vehicle 5810.

In embodiments, the vehicle 5810 comprises a system for automating at least one control parameter of the vehicle 5810. In embodiments, the vehicle 5810 is at least a semi-autonomous vehicle. In embodiments, the vehicle 5810 is automatically routed. In embodiments, the vehicle 5810 is a self-driving vehicle.

In embodiments, the rider interface 58208 comprises at least one of a touch screen, a virtual assistant, an entertainment system interface, a communication interface and a navigation interface.

In embodiments, the search results are ordered by the search result display ranking circuit 58210 so that results that are proximal to the configured route appear before other results.

In embodiments, search criteria used by the search result generating circuit 58209 are based on ranking parameters of a set of in-vehicle searches. In embodiments, the ranking parameters are observed in connection only with the set of in-vehicle searches. In embodiments, the search system 58207 adapts the search result generating circuit 58209 to favor search results that correlate to in-vehicle behaviors. In embodiments, the search results that correlate to in-vehicle behaviors are determined through comparison of rider behavior before and after conducting a search. In embodiments, the search system 58207 further comprises a machine learning circuit 58212 that facilitates training the search result generating circuit 58209 from a set of search results for a plurality of searchers and a set of search result generating parameters based on an in-vehicle rider behavior model.

An aspect provided herein includes an in-vehicle network search system 58207 of a vehicle 5810, the search system 58207 comprising: a rider interface 58208 through which the rider 58120 of the vehicle 5810 is enabled to engage with the search system 58207; a search result generating circuit 58209 that varies search results based on whether the user (e.g., the rider 58120) is a driver of the vehicle or a passenger in the vehicle; and a search result display ranking circuit 58210 that orders the search results based on a relevance of a location component of the search results with a configured route of the vehicle 5810.

In embodiments, the vehicle 5810 comprises a system for automating at least one control parameter of the vehicle 5810. In embodiments, the vehicle 5810 is at least a semi-autonomous vehicle. In embodiments, the vehicle 5810 is automatically routed. In embodiments, the vehicle 5810 is a self-driving vehicle.

In embodiments, the rider interface 58208 comprises at least one of a touch screen, a virtual assistant, an entertainment system interface, a communication interface and a navigation interface.

In embodiments, the search results are ordered by the search result display ranking circuit 58210 so that results that are proximal to the configured route appear before other results. In embodiments, search criteria used by the search result generating circuit 58209 are based on ranking parameters of a set of in-vehicle searches. In embodiments, the ranking parameters are observed in connection only with the set of in-vehicle searches.

In embodiments, the search system 58207 adapts the search result generating circuit 58209 to favor search results that correlate to in-vehicle behaviors. In embodiments, the search results that correlate to in-vehicle behaviors are determined through comparison of rider behavior before and after conducting a search. In embodiments, the search system 58207, further comprises a machine learning circuit 58212 that facilitates training the search result generating circuit 58209 from a set of search results for a plurality of searchers and a set of search results generating parameters based on an in-vehicle rider behavior model.

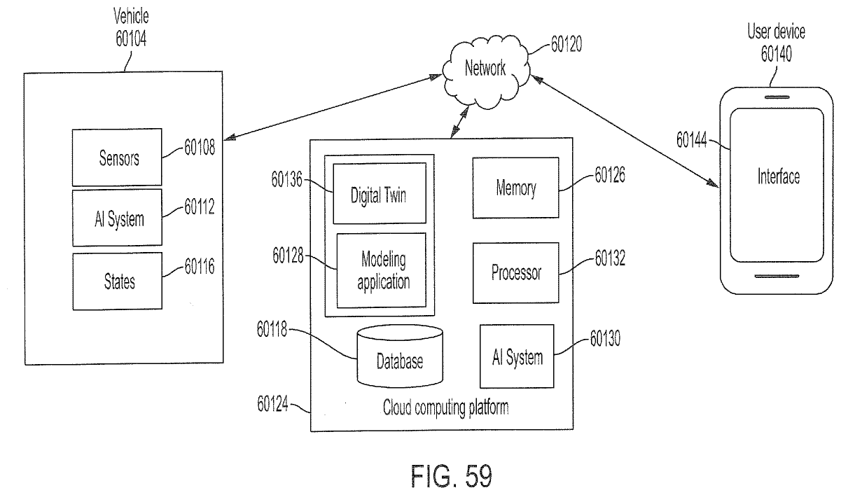

Referring to FIG. 59, an architecture for transportation system 60100 is depicted, showing certain illustrative components and arrangements relating to certain embodiments described herein. The system 60100 includes a vehicle 60104, which may include various mechanical, electrical, and software components and systems, such as a powertrain, a suspension system, a steering system, a braking system, a fuel system, a charging system, seats, a combustion engine, an electric vehicle drive train, a transmission, a gear set, and the like. The vehicle may have a vehicle user interface, which may include a set of interfaces that include a steering system, buttons, levers, touch screen interfaces, audio interfaces, and the like. The vehicle may have a set of sensors 60108 (including cameras), such as for providing input to an expert system/artificial intelligence system described throughout this disclosure. The sensors 60108 and/or external information may be used to inform the expert system/Artificial Intelligence (AI) system 60112 and to indicate or track one or more vehicle states 60116, such as vehicle operating states including energy utilization state, maintenance state, component state, user experience states, and others described herein. The AI system 60112 may take as input a wide range of vehicle parameters, such as from onboard diagnostic systems, telemetry systems, and other software systems, as well as from the sensors 60108 and from external systems and may control one or more components of the vehicle 60104. The data from the sensors 60108 including data about vehicle states 60116 may be transmitted via a network 60120 to a cloud computing platform 60124 for storage in a memory 60126 and for processing. In embodiments, the cloud computing platform 60124 and all the elements disposed with or operating therein may be separately embodied from the remainder of the elements in the system 60100. A modeling application 60128 on the cloud computing platform 60124 includes code and functions that are operable, when executed by a processor 60132 on the cloud computing platform 60124, to generate and operate a digital twin 60136 of the vehicle 60104. The digital twin 60136 represents, among other things regarding the vehicle and its environment, the operating state of the vehicle 60104 through a virtual model. A user device 60140 connected to the cloud computing platform 60124 and the vehicle 60104 via the network 60120 may interact with the modeling application 60128 and other software on the cloud computing platform 60124 to receive data from and control operation of the vehicle 60104, such as through the digital twin 60136. An interface 60144 on the user device 60140 may display the one or more vehicle states 60116 using the digital twin 60136 to a user associated with the vehicle 60104, such as a driver, a rider, a third party observer, an owner of the vehicle, an operator/owner of a fleet of vehicles, a traffic safety representative, a vehicle designer, a digital twin development engineer, and others. In embodiments, the user device 60140 may receive specific views of data about the vehicle 60104 as the data is processed by one or more applications on the cloud computing platform 60124. For example, the user device 60140 may receive specific views of data including a graphic view of the vehicle, its interior, subsystems and components, an environment proximal to the vehicle, a navigation view, a maintenance timeline, a safety testing view and the like about the vehicle 60104 as the data is processed by one or more applications, such as the digital twin 60136. As another example, the user device 60140 may display a graphical user interface that allows a user to input commands to the digital twin 60136, the vehicle 60104, modeling application 60128, and the like using one or more applications hosted by the cloud computing platform 60124.

In embodiments, cloud computing platform 60124 may comprise a plurality of servers or processors, that are geographically distributed and connected with each other via a network. In embodiments, cloud computing platform 60124 may comprise an AI system 60130 coupled to or included within the cloud computing platform 60124.

In embodiments, cloud computing platform 60124 may include a database management system for creating, monitoring, and controlling access to data in the database 60118 coupled to or included within the cloud computing platform 60124. The cloud computing platform 60124 may also include services that developers can use to build or test applications. The cloud computing platform 60124 may enable remote configuring, and/or controlling user devices 60140 via interface 60144. Also, the cloud computing platform 60124 may facilitate storing and analyzing of data periodically gathered from user devices 60140, and providing analytics, insights and alerts to users including manufacturers, drivers or owners of the user devices 60140 via the interface 60144.

In embodiments, an on-premises server may be used to host the digital twin 60136 instead of the cloud computing platform 60124.

In embodiments, the network 60120 may be a conventional type, wired or wireless, and may have numerous different configurations including a star configuration, token ring configuration, or other configurations. Furthermore, the network 60120 may include a local area network (LAN), a wide area network (WAN) (e.g., the Internet), or other interconnected data paths across which multiple devices and/or entities may communicate. In some embodiments, the network 60120 may include a peer-to-peer network. The network 60120 may also be coupled to or may include portions of a telecommunications network for sending data in a variety of different communication protocols. In some embodiments, the network 60120 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, etc. The network 60120 may also include a mobile data network that may include 3G, 4G, 5G, LTE, LTE-V2X, VoLTE or any other mobile data network or combination of mobile data networks. Further, the network 60120 may include one or more IEEE 802.11 wireless networks.

In embodiments, digital twin 60136 of the vehicle 60104 is a virtual replication of hardware, software, and processes in the vehicle 60104 that combines real-time and historical operational data and includes structural models, mathematical models, physical process models, software process models, etc. In embodiments, digital twin 60136 encompasses hierarchies and functional relationships between the vehicle and various components and subsystems and may be represented as a system of systems. Thus, the digital twin 60136 of the vehicle 60104 may be seen to encompass the digital twins of the vehicle subsystems like vehicle interior layout, electrical and fuel subsystems as well as digital twins of components like engine, brake, fuel pump, alternator, etc.

The digital twin 60136 may encompass methods and systems to represent other aspects of the vehicle environment including, without limitation a passenger environment, driver and passengers in the vehicle, environment proximal to the vehicle including nearby vehicles, infrastructure, and other objects detectable through, for example, sensors of the vehicle and sensors disposed proximal to the vehicle, such as other vehicles, traffic control infrastructure, pedestrian safety infrastructure, and the like.

In embodiments, the digital twin 60136 of the vehicle 60104 is configured to simulate the operation of the vehicle 60104 or any portion or environment thereof. In embodiments, the digital twin 60136 may be configured to communicate with a user of the vehicle 60104 via a set of communication channels, such as speech, text, gestures, and the like. In embodiments, the digital twin 60136 may be configured to communicate with digital twins of other entities including digital twins of users, nearby vehicles, traffic lights, pedestrians and so on.

In embodiments, the digital twin is linked to an identity of a user, such that the digital twin is automatically provisioned for display and configuration via a mobile device of an identified user. For example, when a user purchases a vehicle and installs the mobile application provided by the manufacturer, the digital twin is pre-configured to be displayed and controlled by the user.

In embodiments, the digital twin is integrated with an identity management system, such that capabilities to view, modify, and configure the digital twin are managed by an authentication and authorization system that parses a set of identities and roles managed by the identity management system.

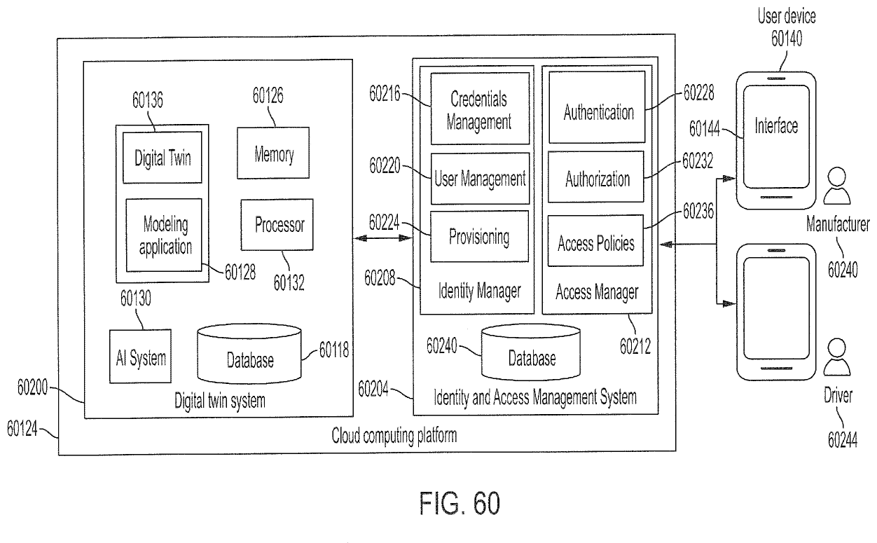

FIG. 60 shows a schematic illustration of a digital twin system 60200 integrated with an identity and access management system 60204 in accordance with certain embodiments described herein. The Identity Manager 60208 in the identity and access management system 60204 manages the various identities, attributes and roles of users of the digital twin system 200. The Access Manager 60212 in the identity and access management system 60204 evaluates the user attributes based on access policies to provide access to authenticated users and regulates the levels of access for the users. The Identity Manager 60208 includes the credentials management 60216, user management 60220 and provisioning 60224. The credentials management 60216 manages a set of user credentials like usernames, passwords, biometrics, cryptographic keys etc. The user management 60220 manages user identities and profile information including various attributes, role definitions and preferences etc. for each user. The provisioning 60224 creates, manages and maintains the rights and privileges of the users including those related to accessing resources of the digital twin system. The Access Manager 60212 includes authentication 60228, authorization 60232 and access policies 60236. Authentication 60228 verifies the identity of a user by checking the credentials provided by the user against those stored in the credentials management 60216 and provides access to the digital twin system to verified users. The authorization 60232 parses a set of identities and roles to determine the entitlements for each user including the capabilities to view, modify, and configure the digital twin. The authorization 60232 may be performed by checking the resource access request from a user against access policies 60236. The database 60118 may store all the user directories, identity, roles, attributes, and authorization, etc. related data of the identity and access management system 60204. Roles may include driver, manufacturer, dealer, rider, owner, service department, etc. In an example of role-based digital twin authenticated access, the manufacturer role might be authorized to access content and views that are relevant to vehicle wear and tear, maintenance conditions, needs for service, quality testing etc. (e.g., to recommend replacing worn tires, adjust a vehicle operating parameter limit, such as maximum speed for badly worn tires), but not be authorized to access other content, such as content potentially considered sensitive by the vehicle owner. In embodiments, access to content by particular roles may be configured by a set of rules, by the manufacturer, by the owner of the vehicle, or the like.

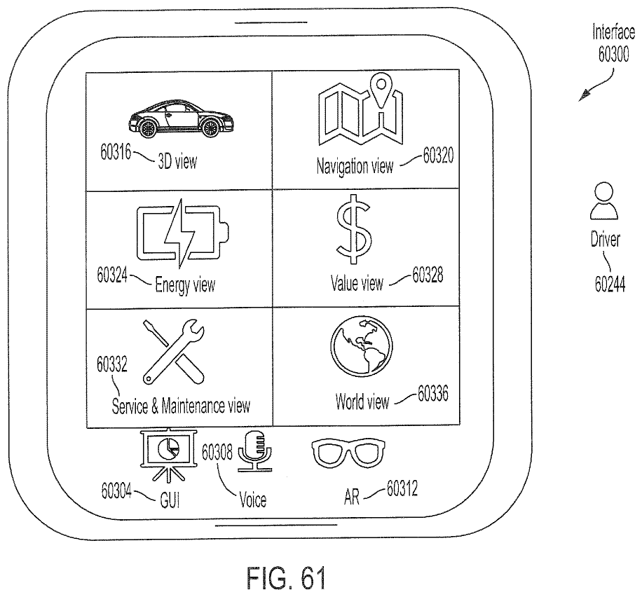

FIG. 61 illustrates a schematic view of an interface 60300 of the digital twin system presented on the user device of a driver of the vehicle 60104. The interface 60300 includes multiple modes like a graphical user interface (GUI) mode 60304, a voice mode 60308 and an augmented reality (AR) mode 60312. Further, the digital twin 60136 may be configured to communicate with the user via multiple communication channels such as speech, text, gestures, and the like. The GUI mode 60304 may provide the driver with various graphs and charts, diagrams and tables representing the operating state of the vehicle 60104 or one or more of its components. The voice mode 60308 may provide the driver with a speech interface to communicate with the digital twin 60136 whereby the digital twin may receive queries from a driver about the vehicle 60104, generate responses for the queries and communicate such responses to the driver. The augmented reality (AR) mode 60312 may present the user with an augmented reality (AR) view that uses the forward-facing camera of the user device 60140 and enhances the screen with one or more elements from the digital twin 60136 of the vehicle 60104. The digital twin 60136 may display to the user a converged view of the world where a physical view is augmented with computer graphics, including imagery, animation, video, text related to directions, road signs or the like.

The interface 60300 presents the driver with a set of views, with each view showing an operating state, aspect, parameter etc. of the vehicle 60104, or one or more of its components, sub-systems or environment. The 3D view 60316 presents the driver with a three-dimensional rendering of the model of the vehicle 60104. The driver may select one or more components in the 3D view to see a 3D model of the components including relevant data about the components. The navigation view 60320 may show the digital twin inside a navigation screen allowing the driver to view real-time navigation parameters. The navigation view may provide to the driver information about traffic conditions, time to destination, routes to destination and preferred routes, road conditions, weather conditions, parking lots, landmarks, traffic lights and so on. Additionally, the navigation view 60320 may provide increased situational awareness to the driver by establishing communication with nearby vehicles (V2V), pedestrians (V2P) and infrastructure (V2I) and exchanging real-time information. The energy view 60324 shows the state of fuel or battery in the vehicle 60104 including utilization and battery health. The value view 60328 shows the condition and blue book value of the vehicle 60104 based on the condition. Such information may for example, be useful when selling the vehicle 60104 in a used car market. The service view 60332 may present information and view related to wear and failure of components of the vehicle 60104 and predicts the need for service, repairs or replacement based on the current and historic operational state data. The world view 60336 may show the vehicle 60104 immersed in a virtual reality (VR) environment.

The digital twin 60136 may make use of the artificial intelligence system 60112 (including any of the various expert systems, neural networks, supervised learning systems, machine learning systems, deep learning systems, and other systems described throughout this disclosure and in the documents incorporated by reference) for analyzing relevant data and presenting the various views to the driver.

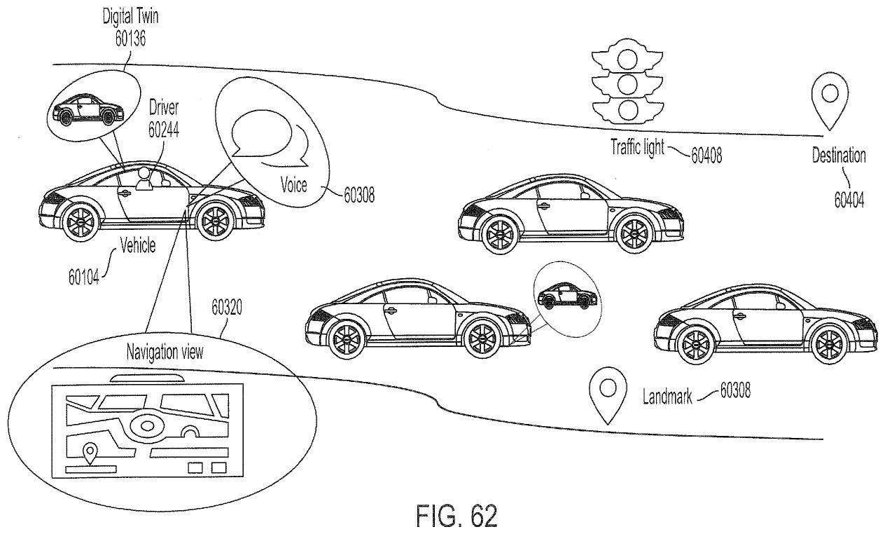

FIG. 62 is a schematic diagram showing the interaction between the driver and the digital twin using one or more views and modes of the interface in accordance with an example embodiment of the present disclosure. The driver 60244 of the vehicle 60104 interacts with the digital twin 60136 using the interface 60300 and requests assistance in navigation, at least because the digital twin 60136 may be deployed in a virtual vehicle operating environment in which it interacts with other digital twins that may have knowledge of the environment that is not readily available to an in-vehicle navigation system, such as real-time or near real-time traffic activity, road conditions and the like that may be communicated from real-world vehicles to their respective digital twins in the virtual operating environment. Digital twin 60136 may display a navigation view 60320 to the driver 60244 that may show the position of the vehicle 60104 on a map as well as the position of nearby vehicles anticipated route of nearby vehicles (e.g., a nearby vehicle that is routed to take the next exit, yet the nearby vehicle is not yet in the exit lane), tendencies of drivers in such nearby vehicles (such as if the driver tends to change lanes without using a directional signal, and the like) and one or more candidate routes that the vehicle 60104 can take to a destination. The digital twin 60136 may also use the voice mode 60308, such as to interact with the driver 60244 and provide assistance with navigation and the like. In embodiments, the digital twin may use a combination of the GUI mode 60304 and the voice mode to respond to the driver's queries. In embodiments, the digital twin 60136 may interact with the digital twins of infrastructure elements including nearby vehicles, pedestrians, traffic lights, toll-booths, street signs, refueling systems, charging systems, etc. for determining their behavior, coordinating traffic and obtaining a 3600 non-line of sight awareness of the environment. In embodiments, the digital twin 60136 may use a combination of the 802.11p/Dedicated short-range communication (DSRC) and the cellular V2X for interaction with infrastructure elements. In embodiments, the digital twin 60136 may inform the driver 60244 about upcoming abrupt sharp left or right turns that the digital twin 60136 may recognize based on behaviors of other digital twins in a multiple digital twin virtual operating environment, such as to help prevent accidents. In embodiments, the digital twin 60136 may interact with digital twins of nearby vehicles to identify any instances of rapid deceleration or lane changes and provide a warning to the driver 60244 about the same. In embodiments, the digital twin 60136 may interact with the digital twins of nearby vehicles to identify any potential driving hazards and inform the driver 60244 about the same. In embodiments, the digital twin 60136 may utilize external sensor data and traffic information to model the driving environment and optimize driving routes for the driver 60244. As an example of optimizing driving routes, the digital twin 60136 may determine that moving into an exit lane behind a nearby vehicle has a higher probability of avoiding unsafe driving conditions than the driver of the vehicle waiting to move into an exit lane further up the road. In embodiments, the digital twin 60136 may interact with digital twins of traffic lights to pick the route with minimal stops, or to suggest, among other things, when to take a bio-break, such as ahead of a long duration of traffic congestion along a route without exits. In embodiments, the digital twin 60136 may assist the driver in finding empty spaces in nearby parking lots and/or alert the driver to spaces which may soon be opening up by interacting with other twins to get the information. In embodiments, the digital twin 60136 may reach out to law enforcement authorities or police, etc. in case of any emergency or distress situation, like an accident or a crime that may be detected through interactions of the digital twin with the vehicle 60104 and the like. In embodiments, the digital twin 60136 may advise the driver with respect to driving speeds or behavior based on an anticipated change in driving conditions either occurring or likely to occur ahead, such as an unexpected slowdown in traffic around a blind curve. For example, the digital twin 60136 may advise the driver to reduce the driving speed to a safe range of 20-40 kmph as the weather changes from “foggy” to “rainy”. In embodiments, the digital twin 60136 assists the driver 60244 in resolving any issues related to the vehicle 60104 by diagnosing such issues and then indicating options for fixing them and/or adjusting an operating parameter or mode of the vehicle 60104 to mitigate a potential for such issues to continue or worsen. For example, the driver 60244 may ask the digital twin 60136 about potential reasons for a rattling noise emerging from the vehicle 60104. In embodiments, the digital twin 60136 may receive an indication of the rattling noise from audio sensors deployed in/with the vehicle (e.g., in a passenger compartment, in an engine compartment, and the like) and may proactively suggest an action that the driver and/or any passenger may take to mitigate the rattling noise (e.g., securing a metal object that is vibrating against a window of the vehicle 60104 and the like). The twin may dissect the data, search for correlations, formulate diagnosis and interact with the driver 60244 to resolve the potential issues. In embodiments, the digital twin 60136 may communicate with other algorithms accessible by and/or through the platform 60124 that may perform, in such an instance, noise analysis and the like. For example, the digital twin 60136 may determine, through any of the means described herein, that the noise is caused by faulty hydraulics of a vehicle door, it may download and install a software update that can tweak the hydraulics of the particular door to fix the problem. Alternatively, the twin may determine that the noise is caused by a faulty exhaust system that can be fixed by replacing the catalytic converter. The twin may then proceed to resolve the issue by ordering a new catalytic converter using an e-commerce website and/or reaching out to a mechanic shop in the vicinity of the vehicle 60104.

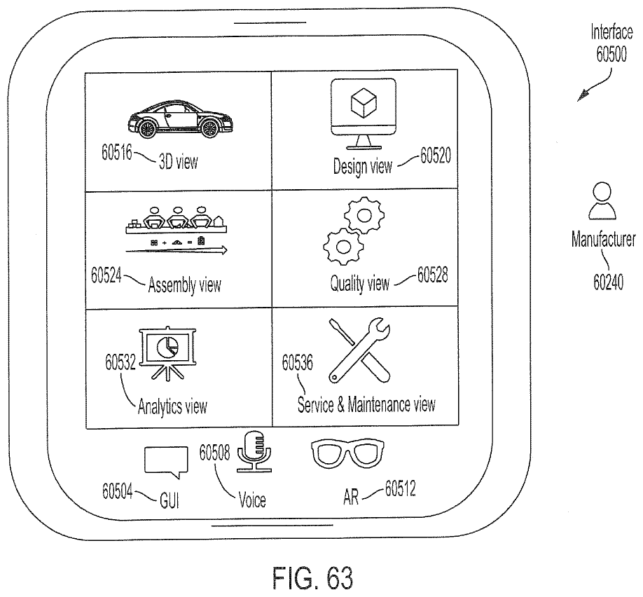

FIG. 63 illustrates a schematic view of an interface of the digital twin system presented on the user device of a manufacturer 60240 of the vehicle 60104 in accordance with various embodiments of the present disclosure. As shown, the interface provided to the manufacturer 60240 is different from the one displayed to the driver 60244 of the vehicle 60104. The manufacturer 60240 is shown views of the digital twin 60136 that are in line with the manufacturer's role and needs and which may, for example, provide information useful to make modifications to a vehicle assembly line or an operating vehicle. Yet, some parts of the manufacturer's interface might be similar to those of the driver's interface. For example, the 3D view 60516 presents the manufacturer 60240 with a three-dimensional rendering of the model of the vehicle 60104 as well as various components and related data. The design view 60520 includes digital data describing design information for the vehicle 60104 and its individual vehicle components. For example, the design information includes Computer-Aided Design (CAD) data of the vehicle 60104 or its individual vehicle components. The design view enables the manufacturer 60240 to view the vehicle 60104 under a wide variety of representations, rotate in three dimensions allowing viewing from any desired angle, provide accurate dimensions and shapes of vehicle parts. In embodiments, the design view enables the manufacturer 60240 to use simulation methods for optimizing and driving the design of the vehicle and its components and sub-systems. In embodiments, the design view 60520 enables the manufacturer 60240 in determining the optimal system architecture of a new vehicle model through generative design techniques. The assembly view 60524 allows the manufacturer 60240 to run prescriptive models showing how the vehicle would work and to optimize the performance of the vehicle 60104 and its components and subsystems. The manufacturer 60240 may create an integrated workflow by combining design, modeling, engineering and simulation using the view. This may allow the manufacturer 60240 to predict how a vehicle would perform before committing to expensive changes in the manufacturing process. As an example, when the manufacturer 60240 is building a new model of a hybrid vehicle, it may evaluate the effect of different options for transmission, fuel type and engine displacement over metrics such as fuel economy and retail price. The simulations in the assembly view 60524 may then provide the manufacturer 60240 with different fuel economies and retail prices based on the combination of transmission, fuel type and engine displacement used in the simulation. The manufacturer 60240 may use such simulations for making business decisions for example, to determine the combinations of transmission, fuel type and engine displacement to be used in a given model for a given segment of customers. The quality view 60528 allows the manufacturer 60240 to run millions of simulations to test the components in real-world situations and generate “what-if” scenarios that can help the manufacturer 60240 avoid costly quality and recall related issues. For instance, the manufacturer 60240 may run quality scenarios to determine the effect of different hydraulic fluid options on the effectiveness of braking in a sudden-brake situation and select the option with best effectiveness. The Real-time Analytics view 60532 may allow the manufacturer 60240 to run data analytics to build a wide range of charts, graphs and models to help the manufacturer 60240 calculate a wide range of metrics and visualize the effect of change of vehicle and component parameters on the operational performance. The Service & Maintenance view 60536 may present information related to wear and failure of components of the vehicle 60104 and predicts the need for service, repairs or replacement based on the current and historic operational state data. The view may also help the manufacturer 60240 run data analytics and formulate predictions on the remaining useful life of one or more components of the vehicle 60104.

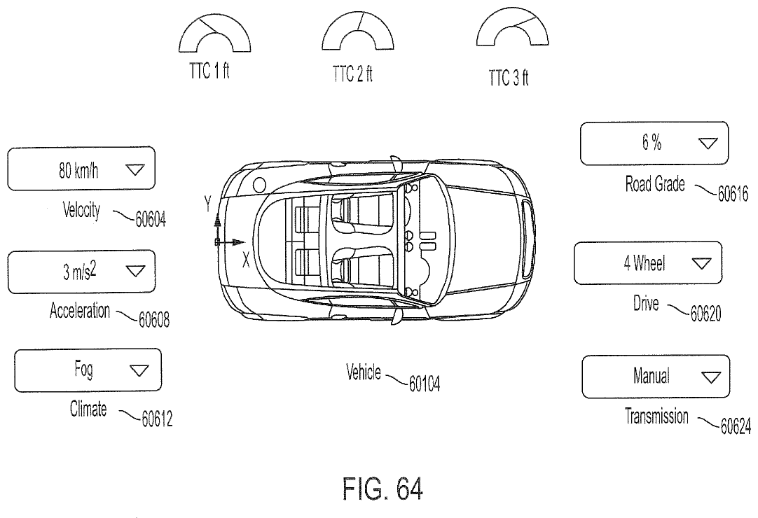

FIG. 64 depicts a scenario in which the manufacturer 60240 uses the quality view of digital twin interface to run simulations and generate what-if scenarios for quality testing a vehicle in accordance with an example embodiment. The digital twin interface may provide the manufacturer 60240 with a list of options related to various vehicle states to choose from. For example, the states may include velocity 60604, acceleration 60608, climate 60612, road grade 60616, drive 60620 and transmission 60624. The manufacturer 60240 may be provided with graphical menus to select different values for a given state. The digital twin 60136 may then use this combination of vehicle states to run a simulation to predict the behavior of the vehicle 60104 in a given scenario. In embodiments, the digital twin 60136 may display the trajectory taken by the vehicle 60104 in case of sudden braking and also provide a minimum safe distance from another vehicle driving in front of the vehicle 60104. In embodiments, the digital twin 60136 may display the behavior of the vehicle 60104 in case of a sudden tire blowout as well as the impact on occupants or other vehicles. In embodiments, the digital twin 60136 may generate a large set of realistic accident scenarios and then reliably simulate the response of the vehicle 60104 in such scenarios. In embodiments, the digital twin 60136 may display the trajectory taken by the vehicle 60104 in case of brake failure and the impact on occupants or other vehicles. In embodiments, the digital twin 60136 may communicate with the digital twins of other vehicles in proximity to help prevent the collision. In embodiments, the digital twin 60136 may predict a time to collision (TTC) from another vehicle at a given distance from the vehicle 60104. In embodiments, the digital twin 60136 may determine the crashworthiness and rollover characteristics of the vehicle 60104 in case of a collision. In embodiments, the digital twin 60136 may analyze the structural impact of a head-on collision on the vehicle 60104 to determine the safety of the occupant. In embodiments, the digital twin 60136 may analyze the structural impact of a sideways collision on the vehicle 60104 to determine the safety of the occupant.

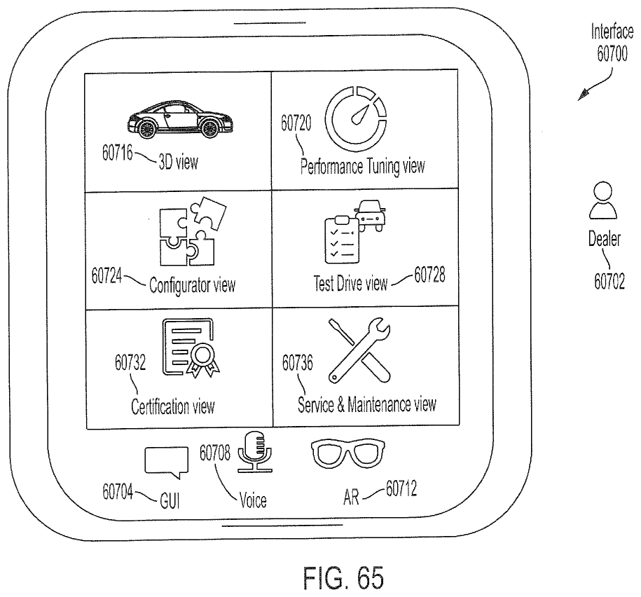

FIG. 65 illustrates a schematic view of an interface 700 of the digital twin system presented on the user device of a dealer 60702 of the vehicle 60104. As shown, the interface provided to the dealer 60702 is different from the one provided to the driver 60244 and the manufacturer 60240 of the vehicle 60104. The dealer 60702 is shown views of the digital twin 60136 that are in line with the dealer's role and needs and which may for example, provide information useful to provide superior selling and customer experience. Yet, some parts of the dealer's interface might be similar to those of the manufacturer's or driver's interface. For example, the 3D view 60716 presents the dealer 60702 with a three-dimensional rendering of the model of the vehicle 60104 as well as various components and related data. The performance tuning view 60720 allows the dealer 60702 to alter the vehicle 60104 so as to personalize the characteristics of the vehicle according to the preference of a driver or a rider. For example, vehicles may be tuned to provide better fuel economy, produce more power, or provide better handling and driving. The performance tuning view 60720 may allow the dealer 60702 in modifying or tuning the performance of one or more components like engine, body, suspension etc. The configurator view 60724 enables the dealer 60702 in helping a potential customer with configuring the various components and materials of the vehicle including engine, wheels, interiors, exterior, color, accessories, etc. based on the preference of the potential customer. The configurator view 60724 helps the dealer 60702 in determining the different possible configurations of a vehicle, selecting a configuration based on potential customer preference and then calculating the price of the selected configuration. The test drive view 60728 may allow the dealer 60702 in allowing the potential customer to virtually test drive a new or used vehicle using the digital twin 60136. The certification view 60732 allows a used car dealer to provide certification about the condition of a used vehicle to a potential customer using the digital twin. The Service & Maintenance view 60736 may present information related to wear and failure of components of the vehicle 60104 and predicts the need for service, repairs or replacement based on the current and historic operational state data. The view may also help the dealer 60702 run data analytics and formulate predictions on remaining useful life of one or more components of the vehicle 60104.

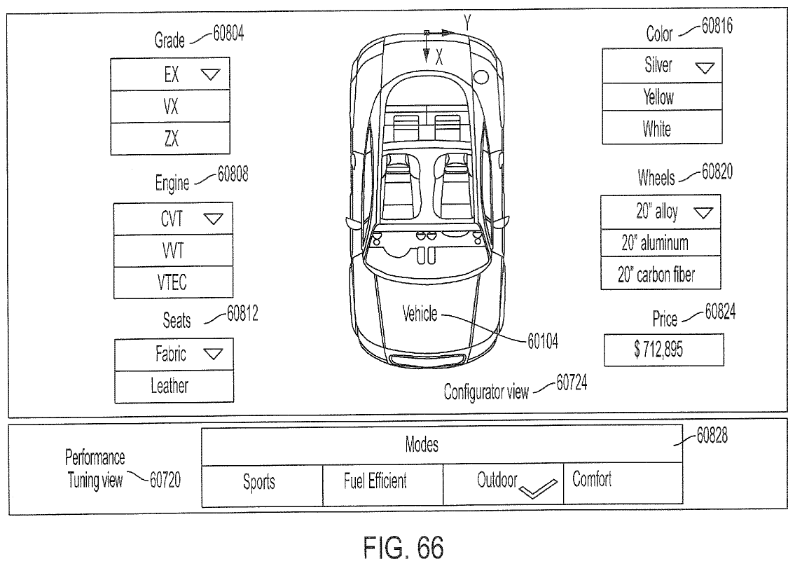

FIG. 66 is a diagram illustrating the interaction between the dealer 60702 and the digital twin 60136 using one or more views with the goal of personalizing the experience of a potential customer purchasing the vehicle 60104 in accordance with an example embodiment. The digital twin 60136 enables the dealer 60702 to interactively select one or more components or options to configure a vehicle based on customer preferences as well as the availability and compatibility of the components. Further, the digital twin 60136 enables the dealer 60702 to alter the performance of the vehicle 60104 in line with customer preferences as well as allow the customer to test drive the customized vehicle before finally purchasing the same.

The dealer 60702 of the vehicle 60104 interacts with the digital twin 60136 using a configurator view 60724 of the interface 60700 and requests for assistance in configuring a vehicle for a customer. The digital twin 60136 may display the GUI 60704 of the configurator view 60724 to the dealer 60702 showing all the different options available for one or more components. The dealer 60702 may then select one or more components using a drop-down menu or use drag and drop operations to add one or more components to configure the vehicle as per the preference of the customer. In the example embodiment, the GUI view 60704 of the digital twin displays options for vehicle grade 60804, engine 60808, seats 60812, color 60816 and wheels 60820.

The digital twin 60136 may check for compatibility between one or more components selected by the dealer 60702 with the model of the vehicle 60104 using a set of predefined database of valid relationships. In embodiments, certain combinations of components may not be compatible with a given grade of a vehicle and the dealer 60702 may be advised about the same. For example, grade EX may stand for the based model of the vehicle and may not offer the option of leather seats. Similarly, grade ZX may stand for the premium model of the vehicle and may not offer CVT engine, fabric seats and 20″ aluminum wheels. In embodiments, the dealer 60702 is only displayed compatible combinations by the configurator view. The configurator view of digital twin then allows the dealer 60702 to configure the complete vehicle by adding a set of compatible components and subsystems. Upon completing the configuration, the digital twin 60136 calculates the price 60824 of the assembled vehicle based on the price of individual components and presents the same to the dealer 60702.

In embodiments, the digital twin 60136 may also use voice mode 60708 to interact with the dealer 60702 and provide assistance with configuration. In embodiments, the digital twin 60136 may use a combination of the GUI mode 60704 and the voice mode 60708 to respond to the dealer's queries.

In embodiments, the digital twin 60136 may further allow the dealer 60702 to assist the customer in tuning the performance of the vehicle using the performance tuning view 60720. The dealer 60702 may be presented with different modes 60828 including sports, fuel-efficient, outdoor and comfort and may pick one of them to tune the performance of the vehicle 60104 accordingly.

Similarly, the digital twin 60136 may present to an owner of the vehicle 60136 with views showing an operating state, aspect, parameter, etc. of the vehicle 60104, or one or more of its components, subsystems or environment based on the owner's requirements. Fleet monitoring view may allow an owner to track and monitor the movement/route/condition of one or more vehicles. The driver behavior monitoring view may allow the owner to monitor instances of unsafe or dangerous driving by a driver. The insurance view may assist the owner in determining the insurance policy quote of a vehicle based on the vehicle condition. The compliance view may show a compliance status of the vehicle with respect to emission/pollution and other regulatory norms based on the condition of the vehicle.

Similarly, the digital twin 60136 may present to a rider of the vehicle 60136 with views showing aspects relevant for the rider. For example, the rider may be provided an experience optimization view allowing the rider to select an experience mode to personalize the riding experience based on rider preferences/ride objectives. The rider may select from one or more experience modes including comfort mode, sports mode, high-efficiency mode, work mode, entertainment mode, sleep mode, relaxation mode, and long-distance trip mode.

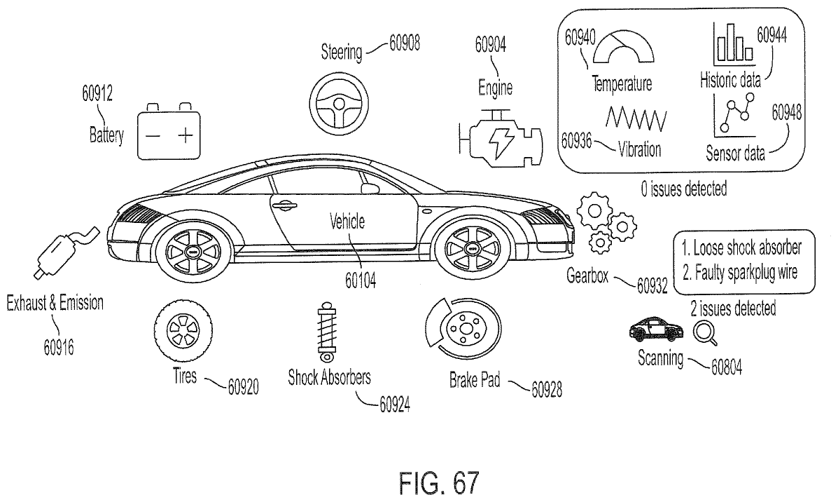

FIG. 67 is a diagram illustrating the service & maintenance view presented to a user of a vehicle including a driver 60244, a manufacturer 60240 and a dealer 60702 of the vehicle 60104 in accordance with an example embodiment. The service & maintenance view provided by the digital twin allows a user, like the dealer 60702, to monitor the health of one or more components or subsystems of the vehicle 60104. The view shows some key components including an engine 60904, a steering 60908, a battery 60912, an exhaust & emission 60916, tires 60920, shock absorbers 60924, brake pads 60928 and a gearbox 60932. The dealer 60702 may click an icon of the component to view detailed data and diagnostics associated with that component. For example, the digital twin 60136 may present the dealer 60702 with analytics related to parameters like vibration 60936 and temperature 60940 as well as historical vehicle data 60944 and real-time series sensor data 948. The digital twin 60136 may also conduct a health scan to discover no issues with engine health and present a “0 issues detected” message to the dealer 60702. The digital twin 60136 may also allow the dealer 60702 to conduct a full health scan on the complete vehicle (instead of component-wise scanning). The digital twin may diagnose the issues and assist the dealer 60702 in resolving the issues. In the example, the digital twin detects two issues upon full health scan as “loose shock absorber” and “faulty sparkplug wire.”

In embodiments, the digital twin 60136 may also help predict when one or more components of the vehicle should receive maintenance. The digital twin 60136 may predict the anticipated wear and failure of components of the vehicle 60104 by reviewing historical and current operational data thereby reducing the risk of unplanned downtime and the need for scheduled maintenance. Instead of over-servicing or over-maintaining the vehicle 60104, any issues predicted by the digital twin 60136 may be addressed in a proactive or just-in-time manner to avoid costly downtime, repairs or replacement.

The digital twin 60136 may collect on-board data including real-time sensor data about components that may be communicated through CAN network of the vehicle 60104. The digital twin 60136 may also collect historical or other data around vehicle statistics and maintenance including data on repairs and repair diagnostics from the database 60118.

Predictive analytics powered by the artificial intelligence system 60112 dissect the data, search for correlations, and employ prediction modeling to determine the condition of the vehicle 60104 and predict maintenance needs and remaining useful life for one or more components.

The cloud computing platform 60124 may include a system for learning on a training set of outcomes, parameters, and data collected from data sources relating to a set of vehicle activities to train artificial intelligence (including any of the various expert systems, artificial intelligence systems, neural networks, supervised learning systems, machine learning systems, deep learning systems, and other systems described throughout this disclosure) for performing condition monitoring, anomaly detection, failure forecasting and predictive maintenance of one or more components of the vehicle 60104 using the digital twin 60136.

In embodiments, the cloud computing platform 60124 may include a system for learning on a training set of vehicle maintenance outcomes, parameters, and data collected from data sources relating to a set of vehicle activities to train the artificial intelligence system 60112 to perform predictive maintenance on the vehicle 60104 using the digital twin 60136.

In embodiments, the artificial intelligence system 60112 may train models, such as predictive models (e.g., various types of neural networks, classification based models, regression-based models, and other machine-learned models). In embodiments, training can be supervised, semi-supervised, or unsupervised. In embodiments, training can be done using training data, which may be collected or generated for training purposes.

An example artificial intelligence system trains a vehicle predictive maintenance model. A predictive maintenance model may be a model that receives vehicle-related data and outputs one or more predictions or answers regarding the remaining life of the vehicle 60104. The training data can be gathered from multiple sources including vehicle or component specifications, environmental data, sensor data, operational information, and outcome data. The artificial intelligence system 60112 takes in the raw data, pre-processes it and applies machine learning algorithms to generate the predictive maintenance model. In embodiments, the artificial intelligence system 60112 may store the predictive model in a model datastore within the database 60118.

The artificial intelligence system 60112 may train multiple predictive models to answer different questions on predictive maintenance. For example, a classification model may be trained to predict failure within a given time window, while a regression model may be trained to predict the remaining useful life of the vehicle 60104 or one or more components.

In embodiments, training may be done based on feedback received by the system, which is also referred to as “reinforcement learning.” In embodiments, the artificial intelligence system 60112 may receive a set of circumstances that led to a prediction (e.g., attributes of vehicle, attributes of a model, and the like) and an outcome related to the vehicle and may update the model according to the feedback.

In embodiments, the artificial intelligence system 60112 may use a clustering algorithm to identify the failure pattern hidden in the failure data to train a model for detecting uncharacteristic or anomalous behavior for one or more components. The failure data across multiple vehicles and their historical records may be clustered to understand how different patterns correlate to certain wear-down behavior and develop a maintenance plan to resonant with the failure.

In embodiments, the artificial intelligence system 60112 may output scores for each possible prediction, where each prediction corresponds to a possible outcome. For example, in using a predictive model used to determine a likelihood that the vehicle 60104 or one or more components will fail in the next one week, the predictive model may output a score for a “will fail” outcome and a score for a “will not fail” outcome. The artificial intelligence system 60112 may then select the outcome with the greater score as the prediction. Alternatively, the system 60112 may output the respective scores to a requesting system. In embodiments, the output from system 60112 includes a probability of the prediction's accuracy.

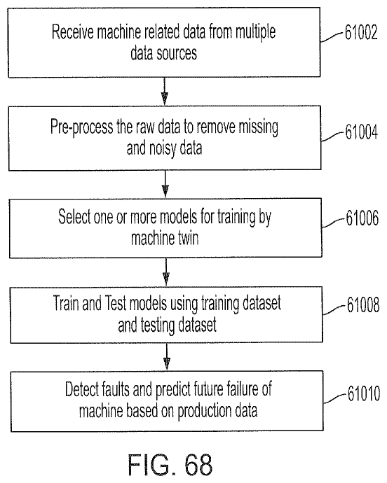

FIG. 68 is an example method used by digital twin 60136 for detecting faults and predicting any future failures of the vehicle 60104 in accordance with an example embodiment.

At 61002, a plurality of streams of vehicle-related data from multiple data sources is received by the digital twin 60136. This includes vehicle specifications like mechanical properties, data from maintenance records, operating data collected from the sensors 60112, historical data including failure data from multiple vehicles running at different times and under different operating conditions and so on. At 61004, the raw data is cleaned by removing any missing or noisy data, which may occur due to any technical problems in the vehicle 60104 at the time of collection of data. At 61006, one or more models are selected for training by the digital twin 60136. The selection of the model is based on the kind of data available at the digital twin 60136 and the desired outcome of the model. For example, there may be cases where failure data from vehicles is not available, or only a limited number of failure datasets exist because of regular maintenance being performed. Classification or regression models may not work well for such cases and clustering models may be the most suitable. As another example, if the desired outcome of the model is determining the current condition of the vehicle and detecting any faults, then fault detection models may be selected, whereas if the desired outcome is predicting future failures then remaining useful life prediction model may be selected. At 61008, the one or more models are trained using training dataset and tested for performance using testing dataset. At 61010, the trained model is used for detecting faults and predicting future failure of the vehicle 60104 on production data.

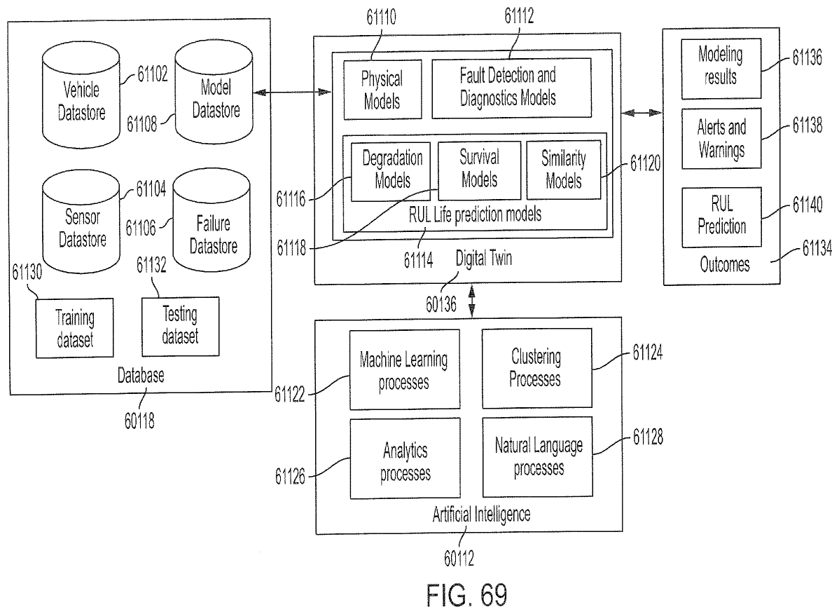

FIG. 69 is an example embodiment depicting the deployment of the digital twin 60136 to perform predictive maintenance on the vehicle 60104. Digital twin 60136 receives data from the database 60118 on a real-time or near real-time basis. The database 60118 may store different types of data in different datastores. For example, the vehicle datastore 61102 may store data related to vehicle identification and attributes, vehicle state and event data, data from maintenance records, historical operating data, notes from vehicle service engineer, etc. The sensor datastore 61104 may store sensor data from operations including data from temperature, pressure, and vibration sensors that may be stored as signal or time-series data. The failure datastore 61106 may store failure data from the vehicle 60104 including failure data of components or similar vehicles at different times and under different operating conditions. The model datastore 61108 may store data related to different predictive models including fault detection and remaining life prediction models.

The digital twin 60136 coordinates with an artificial intelligence system to select one or more models based on the kind and quality of available data and the desired answers or outcomes. For example, the physical models 61110 may be selected if the intended use of the digital twin 60136 is to simulate what-if scenarios and predict how the vehicle will behave under such scenarios. The Fault Detection and Diagnostics Models 61112 may be selected to determine the current health of the vehicle 60104 and any faulty conditions. A simple fault detection model may use or more condition indicators to distinguish between regular and faulty behaviors and may have a threshold value for the condition indicator that is indicative of a fault condition when exceeded. A more complex model may train a classifier to compare the value of one or more condition indicators to values associated with fault states, and returns the probability of the presence of one or more fault states.

The Remaining Useful Life (RUL) Prediction models 61114 are used for predicting future failures and may include degradation models 61116, survival models 61118 and similarity models 61120. An example RUL prediction model may fit the time evolution of a condition indicator and predicts how long it will be before the condition indicator crosses some threshold value indicative of a failure. Another model may compare the time evolution of the condition indicator to measured or simulated time series from similar systems that ran to failure.

In embodiments, a combination of one or more of these models may be selected by the digital twin 60136.

The Artificial Intelligence system 60112 may include machine learning processes 61122, clustering processes 61124, analytics processes 61126 and natural language processes 61128. The machine learning processes 61122 work with the digital twin 60136 to train one or more models as identified above. An example of such machine-learned model is the RUL prediction model 61114. The model 61114 may be trained using training dataset 61130 from the database 60118. The performance of the model 61114 and classifier may then be tested using testing dataset 61132.

The clustering processes 61124 may be implemented to identify the failure pattern hidden in the failure data to train a model for detecting uncharacteristic or anomalous behavior. The failure data across multiple vehicles and their historical records may be clustered to understand how different patterns correlate to certain wear-down behavior. The analytics processes 61126 perform data analytics on various data to identify insights and predict outcomes. The natural language processes 61128 coordinate with the digital twin 60136 to communicate the outcomes and results to the user of the vehicle 60104.

The outcomes 60234 may be in the form of modeling results 61136, alerts and warnings 61138 or remaining useful life (RUL) predictions 61140. The digital twin 60136 may communicate with a user via multiple communication channels such as speech, text, gestures to convey outcomes 61134.

In embodiments, models may then be updated or reinforced based on the model outcomes 61134. For example, the artificial intelligence system 60112 may receive a set of circumstances that led to a prediction of failure and the outcome and may update the model based on the feedback.

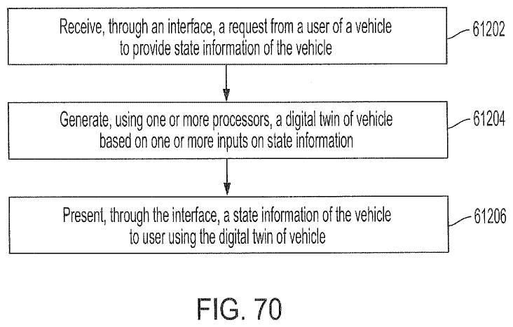

FIG. 70 is a flow chart depicting a method for generating a digital twin of a vehicle in accordance with certain embodiments of the disclosure. At 61202, a request from a user, such as an owner, a lessee, a driver, a fleet operator/owner, a mechanic, and the like associated with the vehicle 60104 is received by the vehicle 60104, such as through an interface provided in the vehicle or a user device 60140 carried by the user to provide state information of the vehicle 60104. At 61204, a digital twin 60136 of the vehicle 60104 is generated using one or more processors, based on one or more inputs regarding vehicle state from an on-board diagnostic system, a telemetry system, a vehicle-located sensor, and a system external to the vehicle. At 61206, the user is presented through the interface, a version of state information of the vehicle 60104 as determined by using the digital twin 60136 of the vehicle 60104 as noted above.

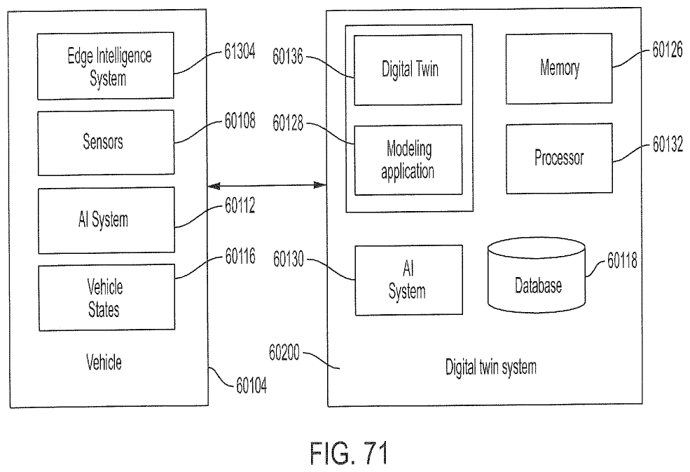

FIG. 71 is a diagrammatic view that illustrates an alternate architecture for a transportation system comprising a vehicle and a digital twin system in accordance with various embodiments of the present disclosure. The vehicle 60104 includes an edge intelligence system 61304 that provides 5G connectivity to a system external to the vehicle 60104, internal connectivity to a set of sensors 60108 and data sources of the vehicle 60104, and onboard artificial intelligence system 60112. The edge intelligence system 61304 may also communicate with artificial intelligence system 60130 of the digital twin system 60200 hosted on the cloud computing platform 60124. The digital twin system 60200 may be populated via an application programming interface (API) from the edge intelligence system 61304.

The edge intelligence system 61304 helps provide certain intelligence locally in the vehicle 60104 instead of relying on cloud-based intelligence. This may, for example, include tasks requiring low-overhead computations and/or those performed in low latency conditions. This helps the system perform reliably in even a limited network bandwidth situations and avoid dropouts.

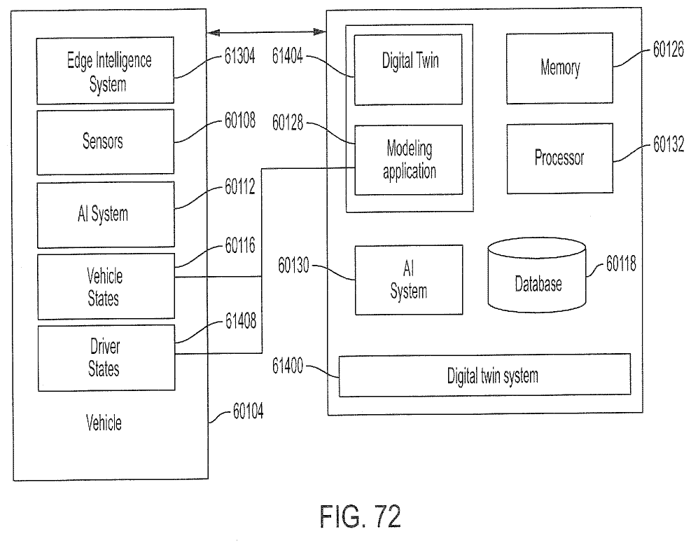

FIG. 72 depicts a digital twin representing a combination of set of states of both a vehicle and a driver of the vehicle in accordance with certain embodiments of the present disclosure.

The integrated vehicle and driver twin 61404 may be created, such as by integrating a digital twin of the vehicle 60104 with the digital twin of the driver. In embodiments, such an integration may be achieved by normalizing the 3D models used by each of the twins to represent a consistent scale, and linking via APIs to obtain regular updates of each twin (such as current operating states of the vehicle and current physiological state, posture, or the like of the driver).

The integrated vehicle and driver twin may then work with the edge intelligence system 1304 to configure a vehicle experience based on the combined vehicle state 60116 and the driver state 61408.

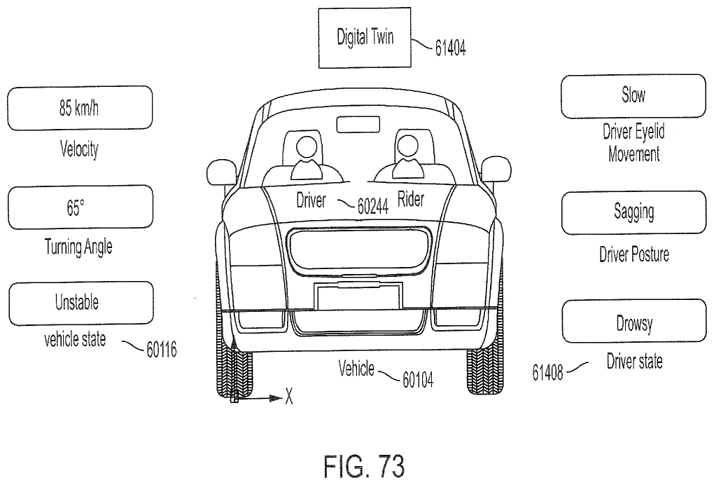

FIG. 73 illustrates a schematic diagram depicting a scenario in which the integrated vehicle and the driver digital twin may configure the vehicle experience in accordance with an example embodiment.

In the example scenario, the integrated vehicle and the driver twin 61404 may determine that the driver's state is “drowsy” based on an input from a set of IR cameras tracking the pupil size and eyelid movement and a set of sensors 60108 tracking the (sagging) posture and (slower) reaction time of the driver 60244. The twin may also determine that the vehicle is “unstable” based on the tracking of speed, lateral position, turning angles and moving course. The integrated vehicle and driver twin 61404 may communicate with the driver 60244 alerting the driver 60244 about the potential safety hazards driving in such a state. Alternatively, the integrated vehicle and the driver twin 61404 may take one or more steps to wake the driver like switching on music or turning up the volume and/or ensure driver and vehicle safety by switching the vehicle into an autopilot or autosteer mode.

As another example, the integrated vehicle and the driver twin may use information about the vehicle state (e.g., amount of fuel remaining) and the driver state (e.g., time since the driver last ate), to activate a point of interest suggestion function to suggest a detour along a planned route to a good place to eat that passes by a preferred fuel provider.

In embodiments, an integrated vehicle and the rider twin may be created, such as by integrating a digital twin of the vehicle 60104 with the digital twin of the rider. In embodiments, such an integration may be achieved by normalizing the 3D models used by each of the twins to represent a consistent scale and linking via APIs to obtain regular updates of each twin (such as current operating states of the vehicle and current physiological state, posture, or the like of the rider).

In embodiments, the integrated vehicle and the rider twin are updated when a second rider enters the vehicle.

In embodiments, the integrated vehicle and the rider twin may work with the edge intelligence system 61304 to configure a vehicle experience based on the combined vehicle state and the rider state.

For example, the integrated vehicle and rider twin may determine that the rider state is “fatigued” based on an input from one or more sensors 60108, etc. In embodiments, a seat-integrated and sensor-enabled fabric wrapped around the parts of the body of the rider may assist the twin in determining the rider state. The twin may also determine that the vehicle state includes high traffic congestion and damaged road conditions. The integrated vehicle and the rider twin may then take one or more actions to provide comfort to the rider: the twin may activate a seat-integrated robotic exoskeleton element for providing functional support to the rider including support for arms, legs, back and neck/head. Alternatively, the twin may activate an electrostimulation element on the seat-integrated and sensor-enabled fabric wrapped around the parts of the body of the rider including torso, legs, etc. for providing relaxation and comfort to the rider.

As another example, the integrated vehicle and the rider twin may determine that the rider state is “shivery” based on an input from one or more sensors 60108, etc. In embodiments, a seat-integrated and sensor-enabled fabric wrapped around the parts of the body of the rider may assist the twin in determining the rider state. The twin may also determine that the vehicle state includes rainy weather conditions. The integrated vehicle and rider twin may then take one or more actions to provide warmth to the rider: the twin may activate a warming element or an element for mid-infrared (penetrating heat) on the seat-integrated and sensor-enabled fabric wrapped around the parts of the body of the rider including torso, legs, etc. for providing warmth and comfort to the rider.

In embodiments, a digital twin may represent a set of items contained in a vehicle, such as ones recognized by a network (e.g., by having device identifiers recognized by the network, such as device identifiers of cellular phones, laptops, tablets, or other computing devices) and/or ones identified by in-vehicle sensors, such as cameras, including ones using computer vision for object recognition. Thus, a digital twin may provide a view of a user of the interior contents of the vehicle that depicts to presence or absence of the items, such that the user can confirm the same. This may assist with finding lost items, with confirming the presence of items required for a trip (such as coordinated with a packing list, including a digital packing list), with confirming the presence of sports equipment, provisions, portable seats, umbrellas, or other accessories or personal property items of the user. In embodiments, the digital twin of the vehicle may integrate with, or integrate information from, a set of digital twins that represent other items, including items of personal property of the user of the digital twin. In embodiments, an application, such as a mobile application, may be provided, such as by or linked to a vehicle manufacturer or dealer, or the like, for tracking the personal items of a user, including a typical set of vehicle accessories and items typically transported or stored in a vehicle, via a set of digital twins that each represent some or all of the items. A user may be prompted to enter the items, such as by identifying the items by name or description, by linking to the items (such as by linking to or from identifiers in e-commerce sites (or to communications from such sites, such as confirmation emails indicating purchases), by capturing photographs of the items, by capturing QR codes, bar codes, or the like of the items, or other techniques. Identified items may be represented in a set of digital twins based on type (such as by retrieving dimensions, images, and other attributes from relevant data sources, such as e-commerce sites or providers), or based on actual images (which may be sized based on dimensional information captured during image capture, such as using structured light, LIDAR or other dimension estimating techniques). In the mobile application, the user may indicate a wish to track the personal property, in which case location tracking systems, including tag-based systems (such as RFID systems), label-based systems (such as QR systems), sensor-based systems (such as using cameras and other sensors), network-based systems (such as Internet of Things systems) and others may track the locations of the personal property. In embodiments, the location information from a location tracking system may represent the items in a set of digital twins, such as ones representing a user's vehicle, locations within a user's vehicle (in a vehicle digital twin), locations within a user's home (such as in a home digital twin), locations within a user's workplace (such as in a workplace digital twin), or the like. In embodiments, a user may select an item in the mobile application, such as from a list or menu, or via a search function, and the mobile application will retrieve the appropriate digital twin and display the item within the digital twin based on the current location of the item.

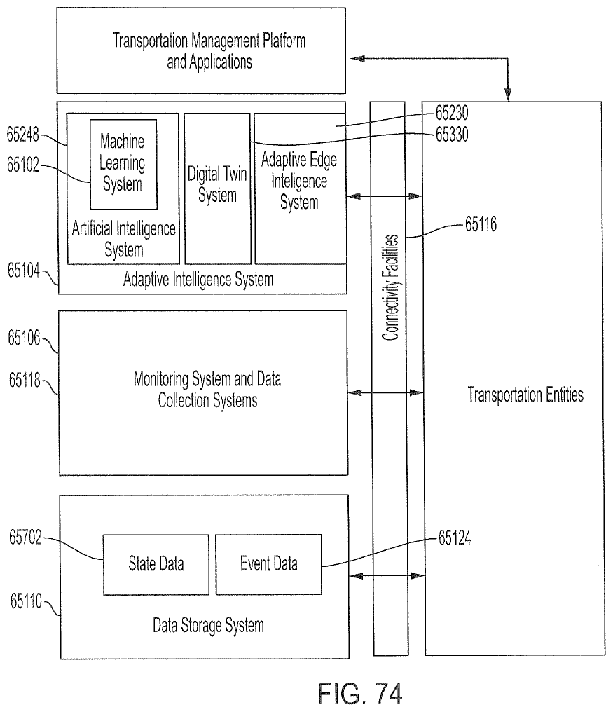

Referring to FIG. 74, the artificial intelligence system 65248 may define a machine learning model 65102 for performing analytics, simulation, decision making, and prediction making related to data processing, data analysis, simulation creation, and simulation analysis of one or more of the transportation entities. The machine learning model 65102 is an algorithm and/or statistical model that performs specific tasks without using explicit instructions, relying instead on patterns and inference. The machine learning model 65102 builds one or more mathematical models based on training data to make predictions and/or decisions without being explicitly programmed to perform the specific tasks. The machine learning model 65102 may receive inputs of sensor data as training data, including event data 65124 and state data 65702 related to one or more of the transportation entities. The sensor data input to the machine learning model 65102 may be used to train the machine learning model 65102 to perform the analytics, simulation, decision making, and prediction making relating to the data processing, data analysis, simulation creation, and simulation analysis of the one or more of the transportation entities. The machine learning model 65102 may also use input data from a user or users of the information technology system. The machine learning model 65102 may include an artificial neural network, a decision tree, a support vector machine, a Bayesian network, a genetic algorithm, any other suitable form of machine learning model, or a combination thereof. The machine learning model 65102 may be configured to learn through supervised learning, unsupervised learning, reinforcement learning, self-learning, feature learning, sparse dictionary learning, anomaly detection, association rules, a combination thereof, or any other suitable algorithm for learning.

The artificial intelligence system 65248 may also define the digital twin system 65330 to create a digital replica of one or more of the transportation entities. The digital replica of the one or more of the transportation entities may use substantially real-time sensor data to provide for substantially real-time virtual representation of the transportation entity and provides for simulation of one or more possible future states of the one or more transportation entities. The digital replica exists simultaneously with the one or more transportation entities being replicated. The digital replica provides one or more simulations of both physical elements and properties of the one or more transportation entities being replicated and the dynamics thereof, in embodiments, throughout the lifestyle of the one or more transportation entities being replicated. The digital replica may provide a hypothetical simulation of the one or more transportation entities, for example during a design phase before the one or more transportation entities are constructed or fabricated, or during or after construction or fabrication of the one or more transportation entities by allowing for hypothetical extrapolation of sensor data to simulate a state of the one or more transportation entities, such as during high stress, after a period of time has passed during which component wear may be an issue, during maximum throughput operation, after one or more hypothetical or planned improvements have been made to the one or more transportation entities, or any other suitable hypothetical situation. In some embodiments, the machine learning model 65102 may automatically predict hypothetical situations for simulation with the digital replica, such as by predicting possible improvements to the one or more transportation entities, predicting when one or more components of the one or more transportation entities may fail, and/or suggesting possible improvements to the one or more transportation entities, such as changes to timing settings, arrangement, components, or any other suitable change to the transportation entities. The digital replica allows for simulation of the one or more transportation entities during both design and operation phases of the one or more transportation entities, as well as simulation of hypothetical operation conditions and configurations of the one or more transportation entities. The digital replica allows for invaluable analysis and simulation of the one or more transportation entities, by facilitating observation and measurement of nearly any type of metric, including temperature, wear, light, vibration, etc. not only in, on, and around each component of the one or more transportation entities, but in some embodiments within the one or more transportation entities. In some embodiments, the machine learning model 65102 may process the sensor data including the event data 65124 and the state data 65702 to define simulation data for use by the digital twin system 65330. The machine learning model 65102 may, for example, receive state data 65702 and event data 65124 related to a particular transportation entity of the plurality of transportation entities and perform a series of operations on the state data 65702 and the event data 65124 to format the state data 65702 and the event data 65124 into a format suitable for use by the digital twin system 65330 in creation of a digital replica of the transportation entity. For example, one or more transportation entities may include a robot configured to augment products on an adjacent assembly line. The machine learning model 65102 may collect data from one or more sensors positioned on, near, in, and/or around the robot. The machine learning model 65102 may perform operations on the sensor data to process the sensor data into simulation data and output the simulation data to the digital twin system 65330. The digital twin simulation 65330 may use the simulation data to create one or more digital replicas of the robot, the simulation including for example metrics including temperature, wear, speed, rotation, and vibration of the robot and components thereof. The simulation may be a substantially real-time simulation, allowing for a human user of the information technology to view the simulation of the robot, metrics related thereto, and metrics related to components thereof, in substantially real time. The simulation may be a predictive or hypothetical situation, allowing for a human user of the information technology to view a predictive or hypothetical simulation of the robot, metrics related thereto, and metrics related to components thereof.

In some embodiments, the machine learning model 65102 and the digital twin system 65330 may process sensor data and create a digital replica of a set of transportation entities of the plurality of transportation entities to facilitate design, real-time simulation, predictive simulation, and/or hypothetical simulation of a related group of transportation entities. The digital replica of the set of transportation entities may use substantially real-time sensor data to provide for substantially real-time virtual representation of the set of transportation entities and provide for simulation of one or more possible future states of the set of transportation entities. The digital replica exists simultaneously with the set of transportation entities being replicated. The digital replica provides one or more simulations of both physical elements and properties of the set of transportation entities being replicated and the dynamics thereof, in embodiments throughout the lifestyle of the set of transportation entities being replicated. The one or more simulations may include a visual simulation, such as a wire-frame virtual representation of the one or more transportation entities that may be viewable on a monitor, using an augmented reality (AR) apparatus, or using a virtual reality (VR) apparatus. The visual simulation may be able to be manipulated by a human user of the information technology system, such as zooming or highlighting components of the simulation and/or providing an exploded view of the one or more transportation entities. The digital replica may provide a hypothetical simulation of the set of transportation entities, for example during a design phase before the one or more transportation entities are constructed or fabricated, or during or after construction or fabrication of the one or more transportation entities by allowing for hypothetical extrapolation of sensor data to simulate a state of the set of transportation entities, such as during high stress, after a period of time has passed during which component wear may be an issue, during maximum throughput operation, after one or more hypothetical or planned improvements have been made to the set of transportation entities, or any other suitable hypothetical situation. In some embodiments, the machine learning model 65102 may automatically predict hypothetical situations for simulation with the digital replica, such as by predicting possible improvements to the set of transportation entities, predicting when one or more components of the set of transportation entities may fail, and/or suggesting possible improvements to the set of transportation entities, such as changes to timing settings, arrangement, components, or any other suitable change to the transportation entities. The digital replica allows for simulation of the set of transportation entities during both design and operation phases of the set of transportation entities, as well as simulation of hypothetical operation conditions and configurations of the set of transportation entities. The digital replica allows for invaluable analysis and simulation of the one or more transportation entities, by facilitating observation and measurement of nearly any type of metric, including temperature, wear, light, vibration, etc. not only in, on, and around each component of the set of transportation entities, but in some embodiments within the set of transportation entities. In some embodiments, the machine learning model 65102 may process the sensor data including the event data 65124 and the state data 65702 to define simulation data for use by the digital twin system 65330. The machine learning model 65102 may, for example, receive state data 65702 and event data 65124 related to a particular transportation entity of the plurality of transportation entities and perform a series of operations on the state data 65702 and the event data 65124 to format the state data 65702 and the event data 65124 into a format suitable for use by the digital twin system 65330 in the creation of a digital replica of the set of transportation entities. For example, a set of transportation entities may include a die machine configured to place products on a conveyor belt, the conveyor belt on which the die machine is configured to place the products, and a plurality of robots configured to add parts to the products as they move along the assembly line. The machine learning model 65102 may collect data from one or more sensors positioned on, near, in, and/or around each of the die machines, the conveyor belt, and the plurality of robots. The machine learning model 65102 may perform operations on the sensor data to process the sensor data into simulation data and output the simulation data to the digital twin system 65330. The digital twin simulation 65330 may use the simulation data to create one or more digital replicas of the die machine, the conveyor belt, and the plurality of robots, the simulation including for example metrics including temperature, wear, speed, rotation, and vibration of the die machine, the conveyor belt, and the plurality of robots and components thereof. The simulation may be a substantially real-time simulation, allowing for a human user of the information technology to view the simulation of the die machine, the conveyor belt, and the plurality of robots, metrics related thereto, and metrics related to components thereof, in substantially real time. The simulation may be a predictive or hypothetical situation, allowing for a human user of the information technology to view a predictive or hypothetical simulation of the die machine, the conveyor belt, and the plurality of robots, metrics related thereto, and metrics related to components thereof.

In some embodiments, the machine learning model 65102 may prioritize collection of sensor data for use in digital replica simulations of one or more of the transportation entities. The machine learning model 65102 may use sensor data and user inputs to train, thereby learning which types of sensor data are most effective for creation of digital replicate simulations of one or more of the transportation entities. For example, the machine learning model 65102 may find that a particular transportation entity has dynamic properties such as component wear and throughput affected by temperature, humidity, and load. The machine learning model 65102 may, through machine learning, prioritize collection of sensor data related to temperature, humidity, and load, and may prioritize processing sensor data of the prioritized type into simulation data for output to the digital twin system 65330. In some embodiments, the machine learning model 65102 may suggest to a user of the information technology system that more and/or different sensors of the prioritized type be implemented in the information technology near and around the transportation entity being simulation such that more and/or better data of the prioritized type may be used in simulation of the transportation entity via the digital replica thereof.

In some embodiments, the machine learning model 65102 may be configured to learn to determine which types of sensor data are to be processed into simulation data for transmission to the digital twin system 65330 based on one or both of a modeling goal and a quality or type of sensor data. A modeling goal may be an objective set by a user of the information technology system or may be predicted or learned by the machine learning model 65102. Examples of modeling goals include creating a digital replica capable of showing dynamics of throughput on an assembly line, which may include collection, simulation, and modeling of, e.g., thermal, electrical power, component wear, and other metrics of a conveyor belt, an assembly machine, one or more products, and other components of the transportation ecosystem. The machine learning model 65102 may be configured to learn to determine which types of sensor data are necessary to be processed into simulation data for transmission to the digital twin system 65330 to achieve such a model. In some embodiments, the machine learning model 65102 may analyze which types of sensor data are being collected, the quality and quantity of the sensor data being collected, and what the sensor data being collected represents, and may make decisions, predictions, analyses, and/or determinations related to which types of sensor data are and/or are not relevant to achieving the modeling goal and may make decisions, predictions, analyses, and/or determinations to prioritize, improve, and/or achieve the quality and quantity of sensor data being processed into simulation data for use by the digital twin system 65330 in achieving the modeling goal.

In some embodiments, a user of the information technology system may input a modeling goal into the machine learning model 65102. The machine learning model 65102 may learn to analyze training data to output suggestions to the user of the information technology system regarding which types of sensor data are most relevant to achieving the modeling goal, such as one or more types of sensors positioned in, on, or near a transportation entity or a plurality of transportation entities that is relevant to the achievement of the modeling goal is and/or are not sufficient for achieving the modeling goal, and how a different configuration of the types of sensors, such as by adding, removing, or repositioning sensors, may better facilitate achievement of the modeling goal by the machine learning model 65102 and the digital twin system 65330. In some embodiments, the machine learning model 65102 may automatically increase or decrease collection rates, processing, storage, sampling rates, bandwidth allocation, bitrates, and other attributes of sensor data collection to achieve or better achieve the modeling goal. In some embodiments, the machine learning model 65102 may make suggestions or predictions to a user of the information technology system related to increasing or decreasing collection rates, processing, storage, sampling rates, bandwidth allocation, bitrates, and other attributes of sensor data collection to achieve or better achieve the modeling goal. In some embodiments, the machine learning model 65102 may use sensor data, simulation data, previous, current, and/or future digital replica simulations of one or more transportation entities of the plurality of transportation entities to automatically create and/or propose modeling goals. In some embodiments, modeling goals automatically created by the machine learning model 65102 may be automatically implemented by the machine learning model 65102. In some embodiments, modeling goals automatically created by the machine learning model 65102 may be proposed to a user of the information technology system, and implemented only after acceptance and/or partial acceptance by the user, such as after modifications are made to the proposed modeling goal by the user.

In some embodiments, the user may input the one or more modeling goals, for example, by inputting one or more modeling commands to the information technology system. The one or more modeling commands may include, for example, a command for the machine learning model 65102 and the digital twin system 65330 to create a digital replica simulation of one transportation entity or a set of transportation entities, may include a command for the digital replica simulation to be one or more of a real-time simulation, and a hypothetical simulation. The modeling command may also include, for example, parameters for what types of sensor data should be used, sampling rates for the sensor data, and other parameters for the sensor data used in the one or more digital replica simulations. In some embodiments, the machine learning model 65102 may be configured to predict modeling commands, such as by using previous modeling commands as training data. The machine learning model 65102 may propose predicted modeling commands to a user of the information technology system, for example, to facilitate simulation of one or more of the transportation entities that may be useful for the management of the transportation entities and/or to allow the user to easily identify potential issues with or possible improvements to the transportation entities.

In some embodiments, the machine learning model 65102 may be configured to evaluate a set of hypothetical simulations of one or more of the transportation entities. The set of hypothetical simulations may be created by the machine learning model 65102 and the digital twin system 65330 as a result of one or more modeling commands, as a result of one or more modeling goals, one or more modeling commands, by prediction by the machine learning model 65102, or a combination thereof. The machine learning model 65102 may evaluate the set of hypothetical simulations based on one or more metrics defined by the user, one or more metrics defined by the machine learning model 65102, or a combination thereof. In some embodiments, the machine learning model 65102 may evaluate each of the hypothetical simulations of the set of hypothetical simulations independently of one another. In some embodiments, the machine learning model 65102 may evaluate one or more of the hypothetical simulations of the set of hypothetical simulations in relation to one another, for example by ranking the hypothetical simulations or creating tiers of the hypothetical simulations based on one or more metrics.

In some embodiments, the machine learning model 65102 may include one or more model interpretability systems to facilitate human understanding of outputs of the machine learning model 65102, as well as information and insight related to cognition and processes of the machine learning model 65102, i.e., the one or more model interpretability systems allow for human understanding of not only “what” the machine learning model 65102 is outputting, but also “why” the machine learning model 65102 is outputting the outputs thereof, and what process led to the 65102 formulating the outputs. The one or more model interpretability systems may also be used by a human user to improve and guide training of the machine learning model 65102, to help debug the machine learning model 65102, to help recognize bias in the machine learning model 65102. The one or more model interpretability systems may include one or more of linear regression, logistic regression, a generalized linear model (GLM), a generalized additive model (GAM), a decision tree, a decision rule, RuleFit, Naive Bayes Classifier, a K-nearest neighbors algorithm, a partial dependence plot, individual conditional expectation (ICE), an accumulated local effects (ALE) plot, feature interaction, permutation feature importance, a global surrogate model, a local surrogate (LIME) model, scoped rules, i.e. anchors, Shapley values, Shapley additive explanations (SHAP), feature visualization, network dissection, or any other suitable machine learning interpretability implementation. In some embodiments, the one or more model interpretability systems may include a model dataset visualization system. The model dataset visualization system is configured to automatically provide to a human user of the information technology system visual analysis related to distribution of values of the sensor data, the simulation data, and data nodes of the machine learning model 65102.

In some embodiments, the machine learning model 65102 may include and/or implement an embedded model interpretability system, such as a Bayesian case model (BCM) or glass box. The Bayesian case model uses Bayesian case-based reasoning, prototype classification, and clustering to facilitate human understanding of data such as the sensor data, the simulation data, and data nodes of the machine learning model 65102. In some embodiments, the model interpretability system may include and/or implement a glass box interpretability method, such as a Gaussian process, to facilitate human understanding of data such as the sensor data, the simulation data, and data nodes of the machine learning model 65102.

In some embodiments, the machine learning model 65102 may include and/or implement testing with concept activation vectors (TCAV). The TCAV allows the machine learning model 65102 to learn human-interpretable concepts, such as “running,” “not running,” “powered,” “not powered,” “robot,” “human,” “truck,” or “ship” from examples by a process including defining the concept, determining concept activation vectors, and calculating directional derivatives. By learning human-interpretable concepts, objects, states, etc., TCAV may allow the machine learning model 65102 to output useful information related to the transportation entities and data collected therefrom in a format that is readily understood by a human user of the information technology system.

In some embodiments, the machine learning model 65102 may be and/or include an artificial neural network, e.g., a connectionist system configured to “learn” to perform tasks by considering examples and without being explicitly programmed with task-specific rules. The machine learning model 65102 may be based on a collection of connected units and/or nodes that may act like artificial neurons that may in some ways emulate neurons in a biological brain. The units and/or nodes may each have one or more connections to other units and/or nodes. The units and/or nodes may be configured to transmit information, e.g., one or more signals, to other units and/or nodes, process signals received from other units and/or nodes, and forward processed signals to other units and/or nodes. One or more of the units and/or nodes and connections therebetween may have one or more numerical “weights” assigned. The assigned weights may be configured to facilitate learning, i.e., training, of the machine learning model 65102. The weights assigned weights may increase and/or decrease one or more signals between one or more units and/or nodes, and in some embodiments may have one or more thresholds associated with one or more of the weights. The one or more thresholds may be configured such that a signal is only sent between one or more units and/or nodes if a signal and/or aggregate signal crosses the threshold. In some embodiments, the units and/or nodes may be assigned to a plurality of layers, each of the layers having one or both of inputs and outputs. A first layer may be configured to receive training data, transform at least a portion of the training data, and transmit signals related to the training data and transformation thereof to a second layer. A final layer may be configured to output an estimate, conclusion, product, or other consequence of processing of one or more inputs by the machine learning model 65102. Each of the layers may perform one or more types of transformations, and one or more signals may pass through one or more of the layers one or more times. In some embodiments, the machine learning model 65102 may employ deep learning and being at least partially modeled and/or configured as a deep neural network, a deep belief network, a recurrent neural network, and/or a convolutional neural network, such as by being configured to include one or more hidden layers.

In some embodiments, the machine learning model 65102 may be and/or include a decision tree, e.g., a tree-based predictive model configured to identify one or more observations and determine one or more conclusions based on an input. The observations may be modeled as one or more “branches” of the decision tree, and the conclusions may be modeled as one or more “leaves” of the decision tree. In some embodiments, the decision tree may be a classification tree, the classification tree may include one or more leaves representing one or more class labels, and one or more branches representing one or more conjunctions of features configured to lead to the class labels. In some embodiments, the decision tree may be a regression tree. The regression tree may be configured such that one or more target variables may take continuous values.

In some embodiments, the machine learning model 65102 may be and/or include a support vector machine, e.g., a set of related supervised learning methods configured for use in one or both of classification and regression-based modeling of data. The support vector machine may be configured to predict whether a new example falls into one or more categories, the one or more categories being configured during training of the support vector machine.

In some embodiments, the machine learning model 65102 may be configured to perform regression analysis to determine and/or estimate a relationship between one or more inputs and one or more features of the one or more inputs. Regression analysis may include linear regression, wherein the machine learning model 65102 may calculate a single line to best fit input data according to one or more mathematical criteria.

In embodiments, inputs to the machine learning model 65102 (such as a regression model, Bayesian network, supervised model, or other types of model) may be tested, such as by using a set of testing data that is independent from the data set used for the creation and/or training of the machine learning model, such as to test the impact of various inputs to the accuracy of the model 65102. For example, inputs to the regression model may be removed, including single inputs, pairs of inputs, triplets, and the like, to determine whether the absence of inputs creates a material degradation of the success of the model 65102. This may assist with recognition of inputs that are in fact correlated (e.g., are linear combinations of the same underlying data), that are overlapping, or the like. Comparison of model success may help select among alternative input data sets that provide similar information, such as to identify the inputs (among several similar ones) that generate the least “noise” in the model, that provide the most impact on model effectiveness for the lowest cost, or the like. Thus, input variation and testing of the impact of input variation on model effectiveness may be used to prune or enhance model performance for any of the machine learning systems described throughout this disclosure.

In some embodiments, the machine learning model 65102 may be and/or include a Bayesian network. The Bayesian network may be a probabilistic graphical model configured to represent a set of random variables and conditional independence of the set of random variables. The Bayesian network may be configured to represent the random variables and conditional independence via a directed acyclic graph. The Bayesian network may include one or both of a dynamic Bayesian network and an influence diagram.

In some embodiments, the machine learning model 65102 may be defined via supervised learning, i.e., one or more algorithms configured to build a mathematical model of a set of training data containing one or more inputs and desired outputs. The training data may consist of a set of training examples, each of the training examples having one or more inputs and desired outputs, i.e., a supervisory signal. Each of the training examples may be represented in the machine learning model 65102 by an array and/or a vector, i.e., a feature vector. The training data may be represented in the machine learning model 65102 by a matrix. The machine learning model 65102 may learn one or more functions via iterative optimization of an objective function, thereby learning to predict an output associated with new inputs. Once optimized, the objective function may provide the machine learning model 65102 with the ability to accurately determine an output for inputs other than inputs included in the training data. In some embodiments, the machine learning model 65102 may be defined via one or more supervised learning algorithms such as active learning, statistical classification, regression analysis, and similarity learning. Active learning may include interactively querying, by the machine learning model 65102, a user and/or an information source to label new data points with desired outputs. Statistical classification may include identifying, by the machine learning model 65102, to which a set of subcategories, i.e., subpopulations, a new observation belongs based on a training set of data containing observations having known categories. Regression analysis may include estimating, by the machine learning model 65102 relationships between a dependent variable, i.e., an outcome variable, and one or more independent variables, i.e., predictors, covariates, and/or features. Similarity learning may include learning, by the machine learning model 65102, from examples using a similarity function, the similarity function being designed to measure how similar or related two objects are.

In some embodiments, the machine learning model 65102 may be defined via unsupervised learning, i.e., one or more algorithms configured to build a mathematical model of a set of data containing only inputs by finding structure in the data such as grouping or clustering of data points. In some embodiments, the machine learning model 65102 may learn from test data, i.e. training data, that has not been labeled, classified, or categorized. The unsupervised learning algorithm may include identifying, by the machine learning model 65102, commonalities in the training data and learning by reacting based on the presence or absence of the identified commonalities in new pieces of data. In some embodiments, the machine learning model 65102 may generate one or more probability density functions. In some embodiments, the machine learning model 65102 may learn by performing cluster analysis, such as by assigning a set of observations into subsets, i.e., clusters, according to one or more predesignated criteria, such as according to a similarity metric of which internal compactness, separation, estimated density, and/or graph connectivity are factors.

In some embodiments, the machine learning model 65102 may be defined via semi-supervised learning, i.e., one or more algorithms using training data wherein some training examples may be missing training labels. The semi-supervised learning may be weakly supervised learning, wherein the training labels may be noisy, limited, and/or imprecise. The noisy, limited, and/or imprecise training labels may be cheaper and/or less labor intensive to produce, thus allowing the machine learning model 65102 to train on a larger set of training data for less cost and/or labor.

In some embodiments, the machine learning model 65102 may be defined via reinforcement learning, such as one or more algorithms using dynamic programming techniques such that the machine learning model 65102 may train by taking actions in an environment in order to maximize a cumulative reward. In some embodiments, the training data is represented as a Markov Decision Process.

In some embodiments, the machine learning model 65102 may be defined via self-learning, wherein the machine learning model 65102 is configured to train using training data with no external rewards and no external teaching, such as by employing a Crossbar Adaptive Array (CAA). The CAA may compute decisions about actions and/or emotions about consequence situations in a crossbar fashion, thereby driving teaching of the machine learning model 65102 by interactions between cognition and emotion.

In some embodiments, the machine learning model 65102 may be defined via feature learning, i.e., one or more algorithms designed to discover increasingly accurate and/or apt representations of one or more inputs provided during training, e.g., training data. Feature learning may include training via principal component analysis and/or cluster analysis. Feature learning algorithms may include attempting, by the machine learning model 65102, to preserve input training data while also transforming the input training data such that the transformed input training data is useful. In some embodiments, the machine learning model 65102 may be configured to transform the input training data prior to performing one or more classifications and/or predictions of the input training data. Thus, the machine learning model 65102 may be configured to reconstruct input training data from one or more unknown data-generating distributions without necessarily conforming to implausible configurations of the input training data according to the distributions. In some embodiments, the feature learning algorithm may be performed by the machine learning model 65102 in a supervised, unsupervised, or semi-supervised manner.

In some embodiments, the machine learning model 65102 may be defined via anomaly detection, i.e., by identifying rare and/or outlier instances of one or more items, events and/or observations. The rare and/or outlier instances may be identified by the instances differing significantly from patterns and/or properties of a majority of the training data. Unsupervised anomaly detection may include detecting of anomalies, by the machine learning model 65102, in an unlabeled training data set under an assumption that a majority of the training data is “normal.” Supervised anomaly detection may include training on a data set wherein at least a portion of the training data has been labeled as “normal” and/or “abnormal.”

In some embodiments, the machine learning model 65102 may be defined via robot learning. Robot learning may include generation, by the machine learning model 65102, of one or more curricula, the curricula being sequences of learning experiences, and cumulatively acquiring new skills via exploration guided by the machine learning model 65102 and social interaction with humans by the machine learning model 65102. Acquisition of new skills may be facilitated by one or more guidance mechanisms such as active learning, maturation, motor synergies, and/or imitation.

In some embodiments, the machine learning model 65102 can be defined via association rule learning. Association rule learning may include discovering relationships, by the machine learning model 65102, between variables in databases, in order to identify strong rules using some measure of “interestingness.” Association rule learning may include identifying, learning, and/or evolving rules to store, manipulate and/or apply knowledge. The machine learning model 65102 may be configured to learn by identifying and/or utilizing a set of relational rules, the relational rules collectively representing knowledge captured by the machine learning model 65102. Association rule learning may include one or more of learning classifier systems, inductive logic programming, and artificial immune systems. Learning classifier systems are algorithms that may combine a discovery component, such as one or more genetic algorithms, with a learning component, such as one or more algorithms for supervised learning, reinforcement learning, or unsupervised learning. Inductive logic programming may include rule-learning, by the machine learning model 65102, using logic programming to represent one or more of input examples, background knowledge, and hypothesis determined by the machine learning model 65102 during training. The machine learning model 65102 may be configured to derive a hypothesized logic program entailing all positive examples given an encoding of known background knowledge and a set of examples represented as a logical database of facts.

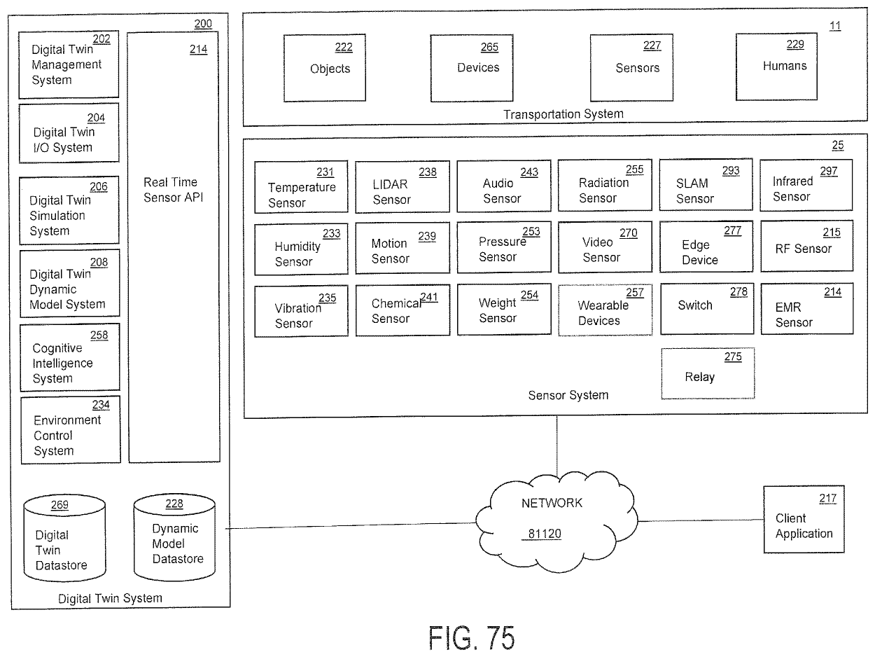

FIG. 75 illustrates an example environment of a digital twin system 200. In embodiments, the digital twin system 200 generates a set of digital twins of a set of transportation systems 11 and/or transportation entities within the set of transportation systems. In embodiments, the digital twin system 200 maintains a set of states of the respective transportation systems 11, such as using sensor data obtained from respective sensor systems 25 that monitor the transportation systems 11. In embodiments, the digital twin system 200 may include a digital twin management system 202, a digital twin I/O system 204, a digital twin simulation system 206, a digital twin dynamic model system 208, a cognitive intelligence system 258, (also disclosed herein as a cognitive processes system 258) and/or an environment control system 234. In embodiments, the digital twin system 200 may provide a real time sensor API 214 that provides a set of capabilities for enabling a set of interfaces for the sensors of the respective sensor systems 25. In embodiments, the digital twin system 200 may include and/or employ other suitable APIs, brokers, connectors, bridges, gateways, hubs, ports, routers, switches, data integration systems, peer-to-peer systems, and the like to facilitate the transferring of data to and from the digital twin system 200. In embodiments, the digital twin system 200, the sensor system 25, and a client application 217 may be connected to a network 81120. In these embodiments, these connective components may allow a network connected sensor or an intermediary device (e.g., a relay, an edge device, a switch, or the like) within a sensor system 25 to communicate data to the digital twin system 25 and/or to receive data (e.g., configuration data, control data, or the like) from the digital twin system 25 or another external system. In embodiments, the digital twin system 200 may further include a digital twin datastore 269 that stores digital twins 236 of various transportation systems 11 and the objects 222, devices 265, sensors 227, and/or humans 229 in the transportation system 11.

A digital twin may refer to a digital representation of one or more transportation entities, such as a transportation system 11, a physical object 222, a device 265, a sensor 227, a human 229, or any combination thereof. Examples of transportation systems 11 include, but are not limited to, a land, sea, or air vehicle, a group of vehicles, a fleet, a squadron, an armada, a port, a rail yard, a loading dock, a ferry, a train, a drone, a submarine, a street sweeper, a snow plow, a recycling truck, a tanker truck, a mobile generator, a tunneling machine, a natural resources excavation machine (e.g., a mining vehicle, a mobile oil rig, etc.), a barge, an offshore oil platform, a rail car, a trailer, a dirigible, an aircraft carrier, a fishing vessel, a cargo ship, a cruise ship, a hospital ship and the like. Depending on the type of transportation system, the types of objects, devices, and sensors that are found in the environments will differ. Non-limiting examples of physical objects 222 include raw materials, manufactured products, excavated materials, containers (e.g., boxes, dumpsters, cooling towers, ship funnels, vats, pallets, barrels, palates, bins, and the like), furniture (e.g., tables, counters, workstations, shelving, etc.), and the like. Non-limiting examples of devices 265 include robots, computers, vehicles (e.g., cars, trucks, tankers, trains, forklifts, cranes, etc.), machinery/equipment (e.g., tractors, tillers, drills, presses, assembly lines, conveyor belts, etc.), and the like. The sensors 227 may be any sensor devices and/or sensor aggregation devices that are found in a sensor system 25 within a transportation system. Non-limiting examples of sensors 227 that may be implemented in a sensor system 25 may include temperature sensors 231, humidity sensors 233, vibration sensors 235, LIDAR devices 238, motion sensors 239, chemical sensors 241, audio sensors 243, pressure sensors 253, weight sensors 254, radiation sensors 255, video sensors 270, wearable devices 257, relays 275, edge devices 277, switches 278, infrared sensors 297, radio frequency (RF) Sensors 215, Extraordinary Magnetoresistive (EMR) sensors 280, and/or any other suitable sensors. Examples of different types of physical objects 222, devices 265, sensors 227, and transportation systems 11 are referenced throughout the disclosure.

In embodiments, a switch 278 is implemented in the sensor system 25 having multiple inputs and multiple outputs including a first input connected to the first sensor and a second input connected to the second sensor. The multiple outputs include a first output and second output configured to be switchable between a condition in which the first output is configured to switch between delivery of the first sensor signal and the second sensor signal and a condition in which there is simultaneous delivery of the first sensor signal from the first output and the second sensor signal from the second output. Each of multiple inputs is configured to be individually assigned to any of the multiple outputs. Unassigned outputs are configured to be switched off producing a high-impedance state. In some examples, the switch 278 can be a crosspoint switch.

In embodiments, the first sensor signal and the second sensor signal are continuous vibration data about the transportation system. In embodiments, the second sensor in the sensor system 25 is configured to be connected to the first machine. In embodiments, the second sensor in the sensor system 25 is configured to be connected to a second machine in the transportation system. In embodiments, the computing environment of the platform is configured to compare relative phases of the first and second sensor signals. In embodiments, the first sensor is a single-axis sensor and the second sensor is a three-axis sensor. In embodiments, at least one of the multiple inputs of the switch 278 includes internet protocol, front-end signal conditioning, for improved signal-to-noise ratio. In embodiments, the switch 278 includes a third input that is configured with a continuously monitored alarm having a pre-determined trigger condition when the third input is unassigned to any of the multiple outputs.

In embodiments, multiple inputs of the switch 278 include a third input connected to the second sensor and a fourth input connected to the second sensor. The first sensor signal is from a single-axis sensor at an unchanging location associated with the first machine. In embodiments, the second sensor is a three-axis sensor. In embodiments, the sensor system 25 is configured to record gap-free digital waveform data simultaneously from at least the first input, the second input, the third input, and the fourth input. In embodiments, the platform is configured to determine a change in relative phase based on the simultaneously recorded gap-free digital waveform data. In embodiments, the second sensor is configured to be movable to a plurality of positions associated with the first machine while obtaining the simultaneously recorded gap-free digital waveform data. In embodiments, multiple outputs of the switch include a third output and fourth output. The second, third, and fourth outputs are assigned together to a sequence of tri-axial sensors each located at different positions associated with the machine. In embodiments, the platform is configured to determine an operating deflection shape based on the change in relative phase and the simultaneously recorded gap-free digital waveform data.

In embodiments, the unchanging location is a position associated with the rotating shaft of the first machine. In embodiments, tri-axial sensors in the sequence of the tri-axial sensors are each located at different positions on the first machine but are each associated with different bearings in the machine. In embodiments, tri-axial sensors in the sequence of the tri-axial sensors are each located at similar positions associated with similar bearings but are each associated with different machines. In embodiments, the sensor system 25 is configured to obtain the simultaneously recorded gap-free digital waveform data from the first machine while the first machine and a second machine are both in operation. In embodiments, the sensor system 25 is configured to characterize a contribution from the first machine and the second machine in the simultaneously recorded gap-free digital waveform data from the first machine. In embodiments, the simultaneously recorded gap-free digital waveform data has a duration that is in excess of one minute.

In embodiments, a method of monitoring a machine having at least one shaft supported by a set of bearings includes monitoring a first data channel assigned to a single-axis sensor at an unchanging location associated with the machine. The method includes monitoring second, third, and fourth data channels each assigned to an axis of a three-axis sensor. The method includes recording gap-free digital waveform data simultaneously from all of the data channels while the machine is in operation and determining a change in relative phase based on the digital waveform data.

In embodiments, the tri-axial sensor is located at a plurality of positions associated with the machine while obtaining the digital waveform. In embodiments, the second, third, and fourth channels are assigned together to a sequence of tri-axial sensors each located at different positions associated with the machine. In embodiments, the data is received from all of the sensors simultaneously. In embodiments, the method includes determining an operating deflection shape based on the change in relative phase information and the waveform data. In embodiments, the unchanging location is a position associated with the shaft of the machine. In embodiments, the tri-axial sensors in the sequence of the tri-axial sensors are each located at different positions and are each associated with different bearings in the machine. In embodiments, the unchanging location is a position associated with the shaft of the machine. The tri-axial sensors in the sequence of the tri-axial sensors are each located at different positions and are each associated with different bearings that support the shaft in the machine.

In embodiments, the method includes monitoring the first data channel assigned to the single-axis sensor at an unchanging location located on a second machine. The method includes monitoring the second, the third, and the fourth data channels, each assigned to the axis of a three-axis sensor that is located at the position associated with the second machine. The method also includes recording gap-free digital waveform data simultaneously from all of the data channels from the second machine while both of the machines are in operation. In embodiments, the method includes characterizing the contribution from each of the machines in the gap-free digital waveform data simultaneously from the second machine.

In some embodiments, on-device sensor fusion and data storage for network connected devices is supported, including on-device sensor fusion and data storage for a network connected device, where data from multiple sensors is multiplexed at the device for storage of a fused data stream. For example, pressure and temperature data may be multiplexed into a data stream that combines pressure and temperature in a time series, such as in a byte-like structure (where time, pressure, and temperature are bytes in a data structure, so that pressure and temperature remain linked in time, without requiring separate processing of the streams by outside systems), or by adding, dividing, multiplying, subtracting, or the like, such that the fused data can be stored on the device. Any of the sensor data types described throughout this disclosure, including vibration data, can be fused in this manner and stored in a local data pool, in storage, or on an IoT device, such as a data collector, a component of a machine, or the like.

In some embodiments, a set of digital twins may represent an organization, such as an energy transport organization, an oil and gas transport organization, aerospace manufacturers, vehicle manufacturers, heavy equipment manufacturers, a mining organization, a drilling organization, an offshore platform organization, and the like. In these examples, the digital twins may include digital twins of one or more transportation systems of the organization.

In embodiments, the digital twin management system 202 generates digital twins. A digital twin may be comprised of (e.g., via reference) other digital twins. In this way, a discrete digital twin may be comprised of a set of other discrete digital twins. For example, a digital twin of a machine may include digital twins of sensors on the machine, digital twins of components that make up the machine, digital twins of other devices that are incorporated in or integrated with the machine (such as systems that provide inputs to the machine or take outputs from it), and/or digital twins of products or other items that are made by the machine. Taking this example one step further, a digital twin of a transportation system may include a digital twin representing the layout of the transportation system, including the arrangement of physical assets and systems in or around the transportation system, as well as digital assets of the assets within the transportation system (e.g., the digital twin of the machine), as well as digital twins of storage areas in the transportation system, digital twins of humans collecting vibration measurements from machines throughout the transportation system, and the like. In this second example, the digital twin of the transportation system may reference the embedded digital twins, which may then reference other digital twins embedded within those digital twins.

In some embodiments, a digital twin may represent abstract entities, such as workflows and/or processes, including inputs, outputs, sequences of steps, decision points, processing loops, and the like that make up such workflows and processes. For example, a digital twin may be a digital representation of a manufacturing process, a logistics workflow, an agricultural process, a mineral extraction process, or the like. In these embodiments, the digital twin may include references to the transportation entities that are included in the workflow or process. The digital twin of the manufacturing process may reflect the various stages of the process. In some of these embodiments, the digital twin system 200 receives real-time data from the transportation system (e.g., from a sensor system 25 of the transportation system 11) in which the manufacturing process takes place and reflects a current (or substantially current) state of the process in real-time.

In embodiments, the digital representation may include a set of data structures (e.g., classes) that collectively define a set of properties of a represented physical object 222, device 265, sensor 227, or transportation system 11 and/or possible behaviors thereof. For example, the set of properties of a physical object 222 may include a type of the physical object, the dimensions of the object, the mass of the object, the density of the object, the material(s) of the object, the physical properties of the material(s), the surface of the physical object, the status of the physical object, a location of the physical object, identifiers of other digital twins contained within the object, and/or other suitable properties. Examples of behavior of a physical object may include a state of the physical object (e.g., a solid, liquid, or gas), a melting point of the physical object, a density of the physical object when in a liquid state, a viscosity of the physical object when in a liquid state, a freezing point of the physical object, a density of the physical object when in a solid state, a hardness of the physical object when in a solid state, the malleability of the physical object, the buoyancy of the physical object, the conductivity of the physical object, a burning point of the physical object, the manner by which humidity affects the physical object, the manner by which water or other liquids affect the physical object, a terminal velocity of the physical object, and the like. In another example, the set of properties of a device may include a type of the device, the dimensions of the device, the mass of the device, the density of the density of the device, the material(s) of the device, the physical properties of the material(s), the surface of the device, the output of the device, the status of the device, a location of the device, a trajectory of the device, vibration characteristics of the device, identifiers of other digital twins that the device is connected to and/or contains, and the like. Examples of the behaviors of a device may include a maximum acceleration of a device, a maximum speed of a device, ranges of motion of a device, a heating profile of a device, a cooling profile of a device, processes that are performed by the device, operations that are performed by the device, and the like. Example properties of an environment may include the dimensions of the environment, the boundaries of the environment, the temperature of the environment, the humidity of the environment, the airflow of the environment, the physical objects in the environment, currents of the environment (if a body of water), and the like. Examples of behaviors of an environment may include scientific laws that govern the environment, processes that are performed in the environment, rules or regulations that must be adhered to in the environment, and the like.

In embodiments, the properties of a digital twin may be adjusted. For example, the temperature of a digital twin, a humidity of a digital twin, the shape of a digital twin, the material of a digital twin, the dimensions of a digital twin, or any other suitable parameters may be adjusted. As the properties of the digital twin are adjusted, other properties may be affected as well. For example, if the temperature of a volume associated with a transportation system 11 is increased, the pressure within the volume may increase as well, such as a pressure of a gas in accordance with the ideal gas law. In another example, if a digital twin of a subzero volume is increased to above freezing temperatures, the properties of an embedded twin of water in a solid state (i.e., ice) may change into a liquid state over time.

Digital twins may be represented in a number of different forms. In embodiments, a digital twin may be a visual digital twin that is rendered by a computing device, such that a human user can view digital representations of a transportation system 11 and/or the physical objects 222, devices 265, and/or the sensors 227 within an environment. In embodiments, the digital twin may be rendered and output to a display device. In some of these embodiments, the digital twin may be rendered in a graphical user interface, such that a user may interact with the digital twin. For example, a user may “drill down” on a particular element (e.g., a physical object or device) to view additional information regarding the element (e.g., a state of a physical object or device, properties of the physical object or device, or the like). In some embodiments, the digital twin may be rendered and output in a virtual reality display. For example, a user may view a 3D rendering of a transportation system (e.g., using monitor or a virtual reality headset). While doing so, the user may view/inspect digital twins of physical assets or devices in the environment.

In some embodiments, a data structure of the visual digital twins (i.e., digital twins that are configured to be displayed in a 2D or 3D manner) may include surfaces (e.g., splines, meshes, polygons meshes, or the like). In some embodiments, the surfaces may include texture data, shading information, and/or reflection data. In this way, a surface may be displayed in a more realistic manner. In some embodiments, such surfaces may be rendered by a visualization engine (not shown) when the digital twin is within a field of view and/or when existing in a larger digital twin (e.g., a digital twin of a transportation system). In these embodiments, the digital twin system 200 may render the surfaces of digital objects, whereby a rendered digital twin may be depicted as a set of adjoined surfaces.

In embodiments, a user may provide input that controls one or more properties of a digital twin via a graphical user interface. For example, a user may provide input that changes a property of a digital twin. In response, the digital twin system 200 can calculate the effects of the changed property and may update the digital twin and any other digital twins affected by the change of the property.

In embodiments, a user may view processes being performed with respect to one or more digital twins (e.g., manufacturing of a product, extracting minerals from a mine or well, a livestock inspection line, and the like). In these embodiments, a user may view the entire process or specific steps within a process.

In some embodiments, a digital twin (and any digital twins embedded therein) may be represented in a non-visual representation (or “data representation”). In these embodiments, a digital twin and any embedded digital twins exist in a binary representation but the relationships between the digital twins are maintained. For example, in embodiments, each digital twin and/or the components thereof may be represented by a set of physical dimensions that define a shape of the digital twin (or component thereof). Furthermore, the data structure embodying the digital twin may include a location of the digital twin. In some embodiments, the location of the digital twin may be provided in a set of coordinates. For example, a digital twin of a transportation system may be defined with respect to a coordinate space (e.g., a Cartesian coordinate space, a polar coordinate space, or the like). In embodiments, embedded digital twins may be represented as a set of one or more ordered triples (e.g., [x coordinate, y coordinate, z coordinates] or other vector-based representations). In some of these embodiments, each ordered triple may represent a location of a specific point (e.g., center point, top point, bottom point, or the like) on the transportation entity (e.g., object, device, or sensor) in relation to the environment in which the transportation entity resides. In some embodiments, a data structure of a digital twin may include a vector that indicates a motion of the digital twin with respect to the environment. For example, fluids (e.g., liquids or gasses) or solids may be represented by a vector that indicates a velocity (e.g., direction and magnitude of speed) of the entity represented by the digital twin. In embodiments, a vector within a twin may represent a microscopic subcomponent, such as a particle within a fluid, and a digital twin may represent physical properties, such as displacement, velocity, acceleration, momentum, kinetic energy, vibrational characteristics, thermal properties, electromagnetic properties, and the like.

In some embodiments, a set of two or more digital twins may be represented by a graph database that includes nodes and edges that connect the nodes. In some implementations, an edge may represent a spatial relationship (e.g., “abuts,” “rests upon,” “contains,” and the like). In these embodiments, each node in the graph database represents a digital twin of an entity (e.g., a transportation entity) and may include the data structure defining the digital twin. In these embodiments, each edge in the graph database may represent a relationship between two entities represented by connected nodes. In some implementations, an edge may represent a spatial relationship (e.g., “abuts,” “rests upon,” “interlocks with,” “bears,” “contains,” and the like). In embodiments, various types of data may be stored in a node or an edge. In embodiments, a node may store property data, state data, and/or metadata relating to a facility, system, subsystem, and/or component. Types of property data and state data will differ based on the entity represented by a node. For example, a node representing a robot may include property data that indicates a material of the robot, the dimensions of the robot (or components thereof), a mass of the robot, and the like. In this example, the state data of the robot may include a current pose of the robot, a location of the robot, and the like. In embodiments, an edge may store relationship data and metadata data relating to a relationship between two nodes. Examples of relationship data may include the nature of the relationship, whether the relationship is permanent (e.g., a fixed component would have a permanent relationship with the structure to which it is attached or resting on), and the like. In embodiments, an edge may include metadata concerning the relationship between two entities. For example, if a product was produced on an assembly line, one relationship that may be documented between a digital twin of the product and the assembly line may be “created by.” In these embodiments, an example edge representing the “created by” relationship may include a timestamp indicating a date and time that the product was created. In another example, a sensor may take measurements relating to a state of a device, whereby one relationship between the sensor and the device may include “measured” and may define a measurement type that is measured by the sensor. In this example, the metadata stored in an edge may include a list of N measurements taken and a timestamp of each respective measurement. In this way, temporal data relating to the nature of the relationship between two entities may be maintained, thereby allowing for an analytics engine, machine-learning engine, and/or visualization engine to leverage such temporal relationship data, such as by aligning disparate data sets with a series of points in time, such as to facilitate cause-and-effect analysis used for prediction systems.

In some embodiments, a graph database may be implemented in a hierarchical manner, such that the graph database relates a set of facilities, systems, and components. For example, a digital twin of a manufacturing environment may include a node representing the manufacturing environment. The graph database may further include nodes representing various systems within the manufacturing environment, such as nodes representing an HVAC system, a lighting system, a manufacturing system, and the like, all of which may connect to the node representing the manufacturing system. In this example, each of the systems may further connect to various subsystems and/or components of the system. For example, within the HVAC system, the HVAC system may connect to a subsystem node representing a cooling system of the facility, a second subsystem node representing a heating system of the facility, a third subsystem node representing the fan system of the facility, and one or more nodes representing a thermostat of the facility (or multiple thermostats). Carrying this example further, the subsystem nodes and/or component nodes may connect to lower level nodes, which may include subsystem nodes and/or component nodes. For example, the subsystem node representing the cooling subsystem may be connected to a component node representing an air conditioner unit. Similarly, a component node representing a thermostat device may connect to one or more component nodes representing various sensors (e.g., temperature sensors, humidity sensors, and the like).

In embodiments where a graph database is implemented, a graph database may relate to a single environment, transportation entity or transportation system or may represent a larger enterprise. In the latter scenario, a company may have various manufacturing and distribution facilities, as well as transportation entities and systems. In these embodiments, an enterprise node representing the enterprise may connect to transportation system nodes of each respective facility. In this way, the digital twin system 200 may maintain digital twins for multiple facilities, and transportation systems of an enterprise.

In embodiments, such an enterprise may involve any sort of business or organization. In some embodiments, a transportation system may be the enterprise, for example, an airport. In other examples, an enterprise may include or be linked to a transportation system, for example a moving and storage company.

In embodiments, an example of an enterprise could be a cruise line. The cruise line enterprise may be a business that owns and operates a fleet of cruise ships. The cruise line enterprise may also own or operate real estate and buildings, for example cruise terminals and resorts. Digital twins may be useful for representing the cruise line enterprise at various levels of abstraction and from various points of view. It may be advantageous for digital twins to have different characteristics appropriate to the various roles/responsibilities of the enterprise. The Chief Engineer of a ship may be interested in the ship's ability to provide electrical power to the electric motors that drive the propellers. The Hotel Director of a ship may be the head of a department that is responsible for all guest services, entertainment, and revenue of the ship. While the Hotel Director may have an interest in the power generating capability of the ship, the appropriate level of detail regarding power generation would be different for a Hotel Director compared to the Chief Engineer. Similarly, the Captain of the ship and the Chief Executive Officer (CEO) of the cruise line would have different points of view, and the appropriate level of abstraction could be different for each.

Another example of an enterprise could be a delivery service. The delivery service may be a business that operates transportation systems that include a fleet of aircraft, a fleet of trucks, and a fleet of smaller vehicles including automobiles. The delivery service may also operate real estate and buildings, for example, airport terminals, truck depots and sorting facilities. The delivery service may be organized to have individuals in charge of various functions of the enterprise; for example, aircraft operations and ground operations. Digital twins may be useful for representing the delivery service enterprise at various levels of abstraction and from various points of view. The various roles of the enterprise, having different responsibilities, may find utility in digital twins having different characteristics. A Chief Engineer of aircraft operations may be interested in the potential for a particular jet engine type to cause unexpected aircraft downtime. The Chief Engineer of ground operations may have an interest in the aircraft downtime, but the appropriate level of detail regarding jet engines would be different for Chief Engineer of ground operations compared to the Chief Engineer of aircraft operations. Similarly, the president of aircraft operations, and the CEO of the delivery service enterprise would have different points of view, and the appropriate level of abstraction could be different for each.

Digital twins can be helpful for visualizing the current state of a system, running simulations on the system, and modeling behaviors, amongst many other uses. Depending on the configuration of the digital twin, however, a particular view or feature may not be useful for some members of an organization, as the configuration of the digital twin dictates the data that is depicted/visualized by the digital twin. Thus, in some embodiments, role-based digital twins are generated. Role-based digital twins may refer to digital twins of one or more segments/aspects of an enterprise, where the one or more segments/aspects and/or the granularity of the data represented by the role-based digital twin are tailored to a particular role within the entity and/or to the identity of a user that is associated with the role (optionally accounting for the competencies, training, education, experience, authority and/or permissions of the user, or other characteristics).

In embodiments, the role-based digital twins include executive digital twins. Executive digital twins may refer to digital twins that are configured for a respective executive within an enterprise. Examples of executive digital twins may include CEO digital twins, (Chief Financial Officer (CFO) digital twins, Chief Operations Officer (COO) digital twins, Human Resources (HR) digital twins, Chief Technology Officer (CTO) digital twins, Chief Marketing Officer (CMO) digital twins, General Counsel (GC) digital twins, Chief Information Officer (CIO) digital twins, and the like. In some of these embodiments, the digital twin generation system 8928, also called the digital twin management system 202 (FIG. 75) herein, generates different types of executive digital twins for users having different roles within the organization. In some of these embodiments, the respective configuration of each type of executive digital twin may be predefined with default digital twin data types, default relationships among entities, default features, and default granularities, among other elements. The default data types, entities, features and granularities may be determined based on a model of an organization, which may, in turn, be based on an industry-specific or domain-specific model or template, such as one that is based on a typical organizational structure for an industry (e.g., an automotive manufacturer, a consumer packaged goods manufacturer, a nationwide retailer, a regional grocery chain, or many others). In embodiments, an artificial intelligence system may be trained, such as on a labeled industry specific or domain-specific data set, to automatically generate an industry-specific or domain-specific digital twin for an organization, with default configuration of data types, entities, features and granularities for various roles within an organization of that industry or domain. The defaults can then be reconfigured in a user interface of an authorized user to reflect company-specific variations from the industry-specific or domain-specific defaults. In some embodiments, a user (e.g., during an on-boarding process) may define the types of data depicted in the different types of executive digital twins, the entities to be represented, the features to be provided and/or the granularities of the different types of executive digital twins. Features may include what data is permitted to be accessed, what views are represented, levels of granularity of views, what analytic models and results can be accessed, what simulations can be undertaken, what changes can be made (including changes relevant to permissions of other users), communication and collaboration features (including receipt of alerts and the capacity to communicate directly to digital twins of other roles and users), control features, and many others. For convenience of reference, references to views, data, features, control or granularity throughout this disclosure should be understood to encompass any and all of the above, except where context specifically indicates otherwise. Granularity may refer to the level of detail at which a particular type of data or types of data is/are represented in a digital twin. For example, a CEO digital twin may include P&L data for a particular time period but may not depict the various revenue streams and costs that contribute to the P&L data during the time period. Continuing this example, the CFO digital twin may depict the various revenue streams and costs during the time period in addition to the high-level P&L data. The foregoing examples are not intended to limit the scope of the disclosure. Additional examples and configurations of different executive digital twins are described throughout the disclosure.

In some embodiments, executive digital twins may allow a user (e.g., a CEO, CFO, COO, VP, Board member, GC, or the like) to increase the granularity of a particular state depicted in the digital twin (also referred to “drilling down into” a state of the digital twin) For example, a CEO digital twin may depict low granularity snapshots or summaries of P&L data, sales figures, customer satisfaction, employee satisfaction, and the like. A user (e.g., the CEO of an enterprise) may opt to drill down into the P&L data via a client application depicting the CEO digital twin. In response, the digital twin system may provide higher resolution P&L data, such as real-time revenue streams, real-time cost streams, and the like. In another example, the CEO digital twin may include visual indicators of different states of the enterprise. For example, the CEO digital twin may depict different colored icons to differentiate a condition (e.g., current and/or forecasted condition) of a respective data item. For example, a red icon may indicate a warning state, a yellow icon may indicate a neutral state, and a green icon may indicate a satisfactory state. In this example, the user (e.g., a CEO) may drill down into a particular data item (e.g., may select a red sales icon to drill down into the sales data, to see more specific and/or additional data, in order to determine why there is the warning state). In response, the CEO digital twin may depict one or more different data streams relating to the selected data item.

In embodiments, the digital twin system 200 may use a graph database to generate a digital twin that may be rendered and displayed and/or may be represented in a data representation. In the former scenario, the digital twin system 200 may receive a request to render a digital twin, whereby the request includes one or more parameters that are indicative of a view that will be depicted. For example, the one or more parameters may indicate a transportation system to be depicted and the type of rendering (e.g., “real-world view” that depicts the environment as a human would see it, an “infrared view” that depicts objects as a function of their respective temperature, an “airflow view” that depicts the airflow in a digital twin, or the like). In response, the digital twin system 200 may traverse a graph database and may determine a configuration of the transportation system to be depicted based on the nodes in the graph database that are related (either directly or through a lower level node) to the transportation system node of the transportation system and the edges that define the relationships between the related nodes. Upon determining a configuration, the digital twin system 200 may identify the surfaces that are to be depicted and may render those surfaces. The digital twin system 200 may then render the requested digital twin by connecting the surfaces in accordance with the configuration. The rendered digital twin may then be output to a viewing device (e.g., VR headset, monitor, or the like). In some scenarios, the digital twin system 200 may receive real-time sensor data from a sensor system 25 of a transportation system 11 and may update the visual digital twin based on the sensor data. For example, the digital twin system 200 may receive sensor data (e.g., vibration data from a vibration sensor 235) relating to a motor and its set of bearings. Based on the sensor data, the digital twin system 200 may update the visual digital twin to indicate the approximate vibrational characteristics of the set of bearings within a digital twin of the motor.

In scenarios where the digital twin system 200 is providing data representations of digital twins (e.g., for dynamic modeling, simulations, machine learning), the digital twin system 200 may traverse a graph database and may determine a configuration of the transportation system to be depicted based on the nodes in the graph database that are related (either directly or through a lower level node) to the transportation system node of the transportation system and the edges that define the relationships between the related nodes. In some scenarios, the digital twin system 200 may receive real-time sensor data from a sensor system 25 of a transportation system 11 and may apply one or more dynamic models to the digital twin based on the sensor data. In other scenarios, a data representation of a digital twin may be used to perform simulations, as is discussed in greater detail throughout the specification.

In some embodiments, the digital twin system 200 may execute a digital ghost that is executed with respect to a digital twin of a transportation system. In these embodiments, the digital ghost may monitor one or more sensors of a sensor system 25 of a transportation system to detect anomalies that may indicate a malicious virus or other security issues.

As discussed, the digital twin system 200 may include a digital twin management system 202, a digital twin I/O system 204, a digital twin simulation system 206, a digital twin dynamic model system 208, a cognitive intelligence system 258, and/or an environment control system 234.

In embodiments, the digital twin management system 202 creates new digital twins, maintains/updates existing digital twins, and/or renders digital twins. The digital twin management system 202 may receive user input, uploaded data, and/or sensor data to create and maintain existing digital twins. Upon creating a new digital twin, the digital twin management system 202 may store the digital twin in the digital twin datastore 269. Creating, updating, and rendering digital twins are discussed in greater detail throughout the disclosure.

In embodiments, the digital twin I/O system 204 receives input from various sources and outputs data to various recipients. In embodiments, the digital twin I/O system receives sensor data from one or more sensor systems 25. In these embodiments, each sensor system 25 may include one or more IoT sensors that output respective sensor data. Each sensor may be assigned an IP address or may have another suitable identifier. Each sensor may output sensor packets that include an identifier of the sensor and the sensor data. In some embodiments, the sensor packets may further include a timestamp indicating a time at which the sensor data was collected. In some embodiments, the digital twin I/O system 204 may interface with a sensor system 25 via the real-time sensor API 214. In these embodiments, one or more devices (e.g., sensors, aggregators, edge devices) in the sensor system 25 may transmit the sensor packets containing sensor data to the digital twin I/O system 204 via the API. The digital twin I/O system may determine the sensor system 25 that transmitted the sensor packets and the contents thereof, and may provide the sensor data and any other relevant data (e.g., time stamp, environment identifier/sensor system identifier, and the like) to the digital twin management system 202.

In embodiments, the digital twin I/O system 204 may receive imported data from one or more sources. For example, the digital twin system 200 may provide a portal for users to create and manage their digital twins. In these embodiments, a user may upload one or more files (e.g., image files, LIDAR scans, blueprints, and the like) in connection with a new digital twin that is being created. In response, the digital twin I/O system 204 may provide the imported data to the digital twin management system 202. The digital twin I/O system 204 may receive other suitable types of data without departing from the scope of the disclosure.

In some embodiments, the digital twin simulation system 206 is configured to execute simulations using the digital twin. For example, the digital twin simulation system 206 may iteratively adjust one or more parameters of a digital twin and/or one or more embedded digital twins. In embodiments, the digital twin simulation system 206, for each set of parameters, executes a simulation based on the set of parameters and may collect the simulation outcome data resulting from the simulation. Put another way, the digital twin simulation system 206 may collect the properties of the digital twin and the digital twins within or containing the digital twin used during the simulation as well as any outcomes stemming from the simulation. For example, in running a simulation on a digital twin of an indoor agricultural facility, the digital twin simulation system 206 can vary the temperature, humidity, airflow, carbon dioxide and/or other relevant parameters and can execute simulations that output outcomes resulting from different combinations of the parameters. In another example, the digital twin simulation system 206 may simulate the operation of a specific machine within a transportation system that produces an output given a set of inputs. In some embodiments, the inputs may be varied to determine an effect of the inputs on the machine and the output thereof. In another example, the digital twin simulation system 206 may simulate the vibration of a machine and/or machine components. In this example, the digital twin of the machine may include a set of operating parameters, interfaces, and capabilities of the machine. In some embodiments, the operating parameters may be varied to evaluate the effectiveness of the machine. The digital twin simulation system 206 is discussed in further detail throughout the disclosure.

In embodiments, the digital twin dynamic model system 208 is configured to model one or more behaviors with respect to a digital twin of a transportation system. In embodiments, the digital twin dynamic model system 208 may receive a request to model a certain type of behavior regarding an environment or a process and may model that behavior using a dynamic model, the digital twin of the transportation system or process, and sensor data collected from one or more sensors that are monitoring the environment or process. For example, an operator of a machine having bearings may wish to model the vibration of the machine and bearings to determine whether the machine and/or bearings can withstand an increase in output. In this example, the digital twin dynamic model system 208 may execute a dynamic model that is configured to determine whether an increase in output would result in adverse consequences (e.g., failures, downtime, or the like). The digital twin dynamic model system 208 is discussed in further detail throughout the disclosure.

In embodiments, the cognitive processes system 258 performs machine learning and artificial intelligence related tasks on behalf of the digital twin system. In embodiments, the cognitive processes system 258 may train any suitable type of model, including but not limited to various types of neural networks, regression models, random forests, decision trees, Hidden Markov models, Bayesian models, and the like. In embodiments, the cognitive processes system 258 trains machine learned models using the output of simulations executed by the digital twin simulation system 206. In some of these embodiments, the outcomes of the simulations may be used to supplement training data collected from real-world environments and/or processes. In embodiments, the cognitive processes system 258 leverages machine learned models to make predictions, identifications, classifications and provide decision support relating to the real-world environments and/or processes represented by respective digital twins.

For example, a machine-learned prediction model may be used to predict the cause of irregular vibrational patterns (e.g., a suboptimal, critical, or alarm vibration fault state) for a bearing of an engine in a transportation system. In this example, the cognitive processes system 258 may receive vibration sensor data from one or more vibration sensors disposed on or near the engine and may receive maintenance data from the transportation system and may generate a feature vector based on the vibration sensor data and the maintenance data. The cognitive processes system 258 may input the feature vector into a machine-learned model trained specifically for the engine (e.g., using a combination of simulation data and real-world data of causes of irregular vibration patterns) to predict the cause of the irregular vibration patterns. In this example, the causes of the irregular vibrational patterns could be a loose bearing, a lack of bearing lubrication, a bearing that is out of alignment, a worn bearing, the phase of the bearing may be aligned with the phase of the engine, loose housing, loose bolt, and the like.

In another example, a machine-learned model may be used to provide decision support to bring a bearing of an engine in a transportation system operating at a suboptimal vibration fault level state to a normal operation vibration fault level state. In this example, the cognitive processes system 258 may receive vibration sensor data from one or more vibration sensors disposed on or near the engine and may receive maintenance data from the transportation system and may generate a feature vector based on the vibration sensor data and the maintenance data. The cognitive processes system 258 may input the feature vector into a machine-learned model trained specifically for the engine (e.g., using a combination of simulation data and real-world data of solutions to irregular vibration patterns) to provide decision support in achieving a normal operation fault level state of the bearing. In this example, the decision support could be a recommendation to tighten the bearing, lubricate the bearing, re-align the bearing, order a new bearing, order a new part, collect additional vibration measurements, change operating speed of the engine, tighten housings, tighten bolts, and the like.

In another example, a machine-learned model may be used to provide decision support relating to vibration measurement collection by a worker. In this example, the cognitive processes system 258 may receive vibration measurement history data from the transportation system and may generate a feature vector based on the vibration measurement history data. The cognitive processes system 258 may input the feature vector into a machine-learned model trained specifically for the engine (e.g., using a combination simulation data and real-world vibration measurement history data) to provide decision support in selecting vibration measurement locations.

In yet another example, a machine-learned model may be used to identify vibration signatures associated with machine and/or machine component problems. In this example, the cognitive processes system 258 may receive vibration measurement history data from the transportation system and may generate a feature vector based on the vibration measurement history data. The cognitive processes system 258 may input the feature vector into a machine-learned model trained specifically for the engine (e.g., using a combination simulation data and real-world vibration measurement history data) to identify vibration signatures associated with a machine and/or machine component. The foregoing examples are non-limiting examples and the cognitive processes system 258 may be used for any other suitable AI/machine-learning related tasks that are performed with respect to industrial facilities.

In examples, vibration data can be diagnostic of fault level states of many bearing applications in transportation entities and systems. For example, bearing vibrations can be used to detect nascent faults in axles and transmissions used in automobiles, trucks and trains. In examples, vibration data can be used to detect fault level states of bearings that support propeller shafts, water pumps, and crankshafts of various transportation entities and systems including automobiles, aircraft, ships, and submarines. Vibration data can also be used to detect fault level states of other components of transportation entities or systems including, e.g., jet engine compressor blades, aircraft propellers, ship propellers, and ship propeller shafts. It is to be understood that by analyzing vibration data, it can be possible to identify or classify transportation entities by their vibration signatures. Some tools for analysis include Fast Fourier Transforms (FFT) and filters. As such, some transportation entities may be identified or classified by the vibrations, including sounds, that they produce, without the vibration sensor, including microphones, being in direct contact with the transportation entity. In a similar way that certain brands of motorcycles and automobiles may be identified by their exhaust notes, vibration sensors may be used to identify or classify a particular machine. Having selected an appropriate digital twin based on the identity or classification of a particular machine, a better diagnosis can be done on fault level states. Thus, as disclosed herein, sensors may rove in a large transportation system, like a ship, and audit various machines in the transportation system. In some examples, location-based identification of the various machines may be used. In other examples, the methods and systems of the present disclosure can be used to identify or classify the various machines based on their vibration signatures. Further, the methods of the present disclosure can use a stationary set of vibration sensors, for example, to monitor a fleet of vehicles as the vehicles pass by the sensors. The digital twins of the various vehicles may be maintained so that changes in the vibration signatures, detected by sensors mounted to or near the roadbed, can be tracked. Thus, using the methods of the present disclosure, it may be possible to determine by a drive-by test that a particular vehicle in a fleet has, for example, wrist-pin damage that is getting worse without taking the vehicle out of service, and to report that information in a convenient system that uses digital twins.

In embodiments, the environment control system 234 controls one or more aspects of transportation systems 11. In some of these embodiments, the environment control system 234 may control one or more devices within a transportation system. For example, the environment control system 234 may control one or more machines within a transportation system 11, robots within a transportation system 11, an HVAC system of the transportation system 11, an alarm system of the transportation system 11, an assembly line in the transportation system 11, or the like. In embodiments, the environment control system 234 may leverage the digital twin simulation system 206, the digital twin dynamic model system 208, and/or the cognitive processes system 258 to determine one or more control instructions. In embodiments, the environment control system 234 may implement a rules-based and/or a machine-learning approach to determine the control instructions. In response to determining a control instruction, the environment control system 234 may output the control instruction to the intended device within a specific transportation system 11 via the digital twin I/O system 204.

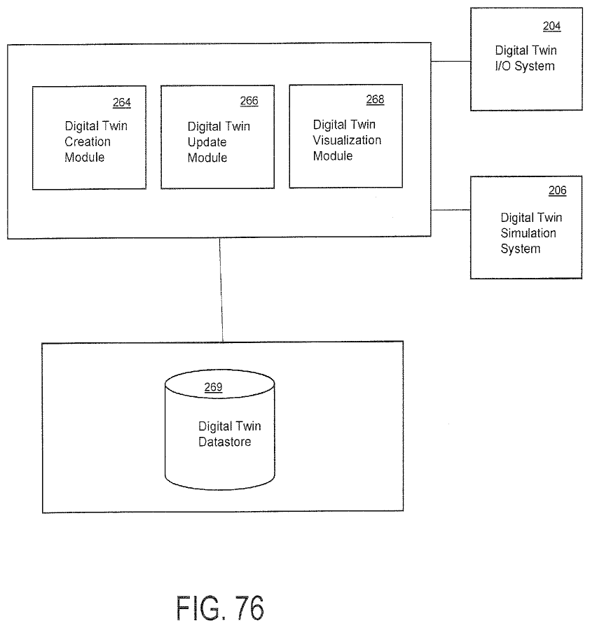

FIG. 76 illustrates an example digital twin management system 202 according to some embodiments of the present disclosure. In embodiments, the digital twin management system 202 may include, but is not limited to, a digital twin creation module 264, a digital twin update module 266, and a digital twin visualization module 268.

In embodiments, the digital twin creation module 264 may create a set of new digital twins of a set of transportation systems using input from users, imported data (e.g., blueprints, specifications, and the like), image scans of the transportation system, 3D data from a LIDAR device and/or SLAM sensor, and other suitable data sources. For example, a user (e.g., a user affiliated with an organization/customer account) may, via a client application 217, provide input to create a new digital twin of a transportation system. In doing so, the user may upload 2D or 3D image scans of the transportation system and/or a blueprint of the transportation system. The user may also upload 3D data, such as taken by a camera, a LIDAR device, an IR scanner, a set of SLAM sensors, a radar device, an EMF scanner, or the like. In response to the provided data, the digital twin creation module 264 may create a 3D representation of the environment, which may include any objects that were captured in the image data/detected in the 3D data. In embodiments, the cognitive processes system 258 may analyze input data (e.g., blueprints, image scans, 3D data) to classify rooms, pathways, equipment, and the like to assist in the generation of the 3D representation. In some embodiments, the digital twin creation module 264 may map the digital twin to a 3D coordinate space (e.g., a Cartesian space having x, y, and z axes).

In some embodiments, the digital twin creation module 264 may output the 3D representation of the transportation system to a graphical user interface (GUI). In some of these embodiments, a user may identify certain areas and/or objects and may provide input relating to the identified areas and/or objects. For example, a user may label specific rooms, equipment, machines, and the like. Additionally or alternatively, the user may provide data relating to the identified objects and/or areas. For example, in identifying a piece of equipment, the user may provide a make/model number of the equipment. In some embodiments, the digital twin creation module 264 may obtain information from a manufacturer of a device, a piece of equipment, or machinery. This information may include one or more properties and/or behaviors of the device, equipment, or machinery. In some embodiments, the user may, via the GUI, identify locations of sensors throughout the environment. For each sensor, the user may provide a type of sensor and related data (e.g., make, model, IP address, and the like). The digital twin creation module 264 may record the locations (e.g., the x, y, z coordinates of the sensors) in the digital twin of the transportation system. In embodiments, the digital twin system 200 may employ one or more systems that automate the population of digital twins. For example, the digital twin system 200 may employ a machine vision-based classifier that classifies makes and models of devices, equipment, or sensors. Additionally or alternatively, the digital twin system 200 may iteratively ping different types of known sensors to identify the presence of specific types of sensors that are in an environment. Each time a sensor responds to a ping, the digital twin system 200 may extrapolate the make and model of the sensor.

In some embodiments, the manufacturer may provide or make available digital twins of their products (e.g., sensors, devices, machinery, equipment, raw materials, and the like). In these embodiments, the digital twin creation module 264 may import the digital twins of one or more products that are identified in the transportation system and may embed those digital twins in the digital twin of the transportation system. In embodiments, embedding a digital twin within another digital twin may include creating a relationship between the embedded digital twin with the other digital twin. In these embodiments, the manufacturer of the digital twin may define the behaviors and/or properties of the respective products. For example, a digital twin of a machine may define the manner by which the machine operates, the inputs/outputs of the machine, and the like. In this way, the digital twin of the machine may reflect the operation of the machine given a set of inputs.

In embodiments, a user may define one or more processes that occur in an environment. In these embodiments, the user may define the steps in the process, the machines/devices that perform each step in the process, the inputs to the process, and the outputs of the process.

In embodiments, the digital twin creation module 264 may create a graph database that defines the relationships between a set of digital twins. In these embodiments, the digital twin creation module 264 may create nodes for the environment, systems and subsystems of the transportation system, devices in the environment, sensors in the environment, workers that work in the environment, processes that are performed in the environment, and the like. In embodiments, the digital twin creation module 264 may write the graph database representing a set of digital twins to the digital twin datastore 269.

In embodiments, the digital twin creation module 264 may, for each node, include any data relating to the entity in the node representing the entity. For example, in defining a node representing an environment, the digital twin creation module 264 may include the dimensions, boundaries, layout, pathways, and other relevant spatial data in the node. Furthermore, the digital twin creation module 264 may define a coordinate space with respect to the environment. In the case that the digital twin may be rendered, the digital twin creation module 264 may include a reference in the node to any shapes, meshes, splines, surfaces, and the like that may be used to render the environment. In representing a system, subsystem, device, or sensor, the digital twin creation module 264 may create a node for the respective entity and may include any relevant data. For example, the digital twin creation module 264 may create a node representing a machine in the environment. In this example, the digital twin creation module 264 may include the dimensions, behaviors, properties, location, and/or any other suitable data relating to the machine in the node representing the machine. The digital twin creation module 264 may connect nodes of related entities with an edge, thereby creating a relationship between the entities. In doing so, the created relationship between the entities may define the type of relationship characterized by the edge. In representing a process, the digital twin creation module 264 may create a node for the entire process or may create a node for each step in the process. In some of these embodiments, the digital twin creation module 264 may relate the process nodes to the nodes that represent the machinery/devices that perform the steps in the process. In embodiments where an edge connects the process step nodes to the machinery/device that performs the process step, the edge or one of the nodes may contain information that indicates the input to the step, the output of the step, the amount of time the step takes, the nature of processing of inputs to produce outputs, a set of states or modes the process can undergo, and the like.

In embodiments, the digital twin update module 266 updates sets of digital twins based on a current status of one or more transportation entities. In some embodiments, the digital twin update module 266 receives sensor data from a sensor system 25 of a transportation system and updates the status of the digital twin of the transportation system and/or digital twins of any affected systems, subsystems, devices, workers, processes, or the like. As discussed, the digital twin I/O system 204 may receive the sensor data in one or more sensor packets. The digital twin I/O system 204 may provide the sensor data to the digital twin update module 266 and may identify the environment from which the sensor packets were received and the sensor that provided the sensor packet. In response to the sensor data, the digital twin update module 266 may update a state of one or more digital twins based on the sensor data. In some of these embodiments, the digital twin update module 266 may update a record (e.g., a node in a graph database) corresponding to the sensor that provided the sensor data to reflect the current sensor data. In some scenarios, the digital twin update module 266 may identify certain areas within the environment that are monitored by the sensor and may update a record (e.g., a node in a graph database) to reflect the current sensor data. For example, the digital twin update module 266 may receive sensor data reflecting different vibrational characteristics of a machine and/or machine components. In this example, the digital twin update module 266 may update the records representing the vibration sensors that provided the vibration sensor data and/or the records representing the machine and/or the machine components to reflect the vibration sensor data. In another example, in some scenarios, workers (e.g., drivers, pilots, ship's crew, aircraft crew, maintenance workers), in a transportation system (e.g., air-traffic control facility, airport, railyard, truck depot, bridge, road, railroad, tunnel, or the like) may be required to wear wearable devices (e.g., smart watches, smart helmets, smart shoes, or the like). In these embodiments, the wearable devices may collect sensor data relating to the worker (e.g., location, movement, heartrate, respiration rate, body temperature, or the like) and/or the ambient environment surrounding the worker and may communicate the collected sensor data to the digital twin system 200 (e.g., via the real-time sensor API 214) either directly or via an aggregation device of the sensor system. In response to receiving the sensor data from the wearable device of a worker, the digital twin update module 266 may update a digital twin of a worker to reflect, for example, a location of the worker, a trajectory of the worker, a health status of the worker, or the like. In some of these embodiments, the digital twin update module 266 may update a node representing a worker and/or an edge that connects the node representing the transportation system with the collected sensor data to reflect the current status of the worker.

In some embodiments, the digital twin update module 266 may provide the sensor data from one or more sensors to the digital twin dynamic model system 208, which may model a behavior of the transportation system and/or one or more transportation entities to extrapolate additional state data.

In embodiments, the digital twin visualization module 268 receives requests to view a visual digital twin or a portion thereof. In embodiments, the request may indicate the digital twin to be viewed (e.g., a transportation system identifier). In response, the digital twin visualization module 268 may determine the requested digital twin and any other digital twins implicated by the request. For example, in requesting to view a digital twin of a transportation system, the digital twin visualization module 268 may further identify the digital twins of any transportation entities within the transportation system. In embodiments, the digital twin visualization module 268 may identify the spatial relationships between the transportation entities and the environment based on, for example, the relationships defined in a graph database. In these embodiments, the digital twin visualization module 268 can determine the relative location of embedded digital twins within the containing digital twin, relative locations of adjoining digital twins, and/or the transience of the relationship (e.g., is an object fixed to a point or does the object move). The digital twin visualization module 268 may render the requested digital twins and any other implicated digital twin based on the identified relationships. In some embodiments, the digital twin visualization module 268 may, for each digital twin, determine the surfaces of the digital twin. In some embodiments, the surfaces of a digital may be defined or referenced in a record corresponding to the digital twin, which may be provided by a user, determined from imported images, or defined by a manufacturer of a transportation entity. In the scenario that an object can take different poses or shapes (e.g., a robot), the digital twin visualization module 268 may determine a pose or shape of the object for the digital twin. The digital twin visualization module 268 may embed the digital twins into the requested digital twin and may output the requested digital twin to a client application.

In some of these embodiments, the request to view a digital twin may further indicate the type of view. As discussed, in some embodiments, digital twins may be depicted in a number of different view types. For example, a transportation system or device may be viewed in a “real-world” view that depicts the transportation system or device as they typically appear, in a “heat” view that depicts the transportation system or device in a manner that is indicative of a temperature of the transportation system or device, in a “vibration” view that depicts the machines and/or machine components in a transportation system in a manner that is indicative of vibrational characteristics of the machines and/or machine components, in a “filtered” view that only displays certain types of objects within a transportation system or components of a device (such as objects that require attention resulting from, for example, recognition of a fault condition, an alert, an updated report, or other factors), an augmented view that overlays data on the digital twin, and/or any other suitable view types. In embodiments, digital twins may be depicted in a number of different role-based view types. For example, a manufacturing facility device may be viewed in an “operator” view that depicts the facility in a manner that is suitable for a facility operator, a “C-Suite” view that depicts the facility in a manner that is suitable for executive-level managers, a “marketing” view that depicts the facility in a manner that is suitable for workers in sales and/or marketing roles, a “board” view that depicts the facility in a manner that is suitable for members of a corporate board, a “regulatory” view that depicts the facility in a manner that is suitable for regulatory managers, and a “human resources” view that depicts the facility in a manner that is suitable for human resources personnel. In response to a request that indicates a view type, the digital twin visualization module 268 may retrieve the data for each digital twin that corresponds to the view type. For example, if a user has requested a vibration view of a transportation system, the digital twin visualization module 268 may retrieve vibration data for the transportation system (which may include vibration measurements taken from different machines and/or machine components and/or vibration measurements that were extrapolated by the digital twin dynamic model system 208 and/or simulated vibration data from digital twin simulation system 206) as well as available vibration data for any transportation entities appearing in the transportation system. In this example, the digital twin visualization module 268 may determine colors corresponding to each machine component in a transportation system that represent a vibration fault level state (e.g., red for alarm, orange for critical, yellow for suboptimal, and green for normal operation). The digital twin visualization module 268 may then render the digital twins of the machine components within the transportation system based on the determined colors. Additionally or alternatively, the digital twin visualization module 268 may render the digital twins of the machine components within the transportation system with indicators having the determined colors. For instance, if the vibration fault level state of an inbound bearing of a motor is suboptimal and the outbound bearing of the motor is critical, the digital twin visualization module 268 may render the digital twin of the inbound bearing having an indicator in a shade of yellow (e.g., suboptimal) and the outbound bearing having an indicator in a shade of orange (e.g., critical). It is noted that in some embodiments, the digital twin simulation system 200 may include an analytics system (not shown) that determines the manner by which the digital twin visualization module 268 presents information to a human user. For example, the analytics system may track outcomes relating to human interactions with real-world transportation systems or objects in response to information presented in a visual digital twin. In some embodiments, the analytics system may apply cognitive models to determine the most effective manner to display visualized information (e.g., what colors to use to denote an alarm condition, what kind of movements or animations bring attention to an alarm condition, or the like) or audio information (what sounds to use to denote an alarm condition) based on the outcome data. In some embodiments, the analytics system may apply cognitive models to determine the most suitable manner to display visualized information based on the role of the user. In embodiments, the visualization may include display of information related to the visualized digital twins, including graphical information, graphical information depicting vibration characteristics, graphical information depicting harmonic peaks, graphical information depicting peaks, vibration severity units data, vibration fault level state data, recommendations from cognitive intelligence system 258, predictions from cognitive intelligence system 258, probability of failure data, maintenance history data, time to failure data, cost of downtime data, probability of downtime data, cost of repair data, cost of machine replace data, probability of shutdown data, KPIs, and the like.

In another example, a user may request a filtered view of a digital twin of a process, whereby the digital twin of the process only shows components (e.g., machine or equipment) that are involved in the process. In this example, the digital twin visualization module 268 may retrieve a digital twin of the process, as well as any related digital twins (e.g., a digital twin of the transportation system and digital twins of any machinery or devices that affect the process). The digital twin visualization module 268 may then render each of the digital twins (e.g., the transportation system and the relevant transportation entities) and then may perform the process on the rendered digital twins. It is noted that as a process may be performed over a period of time and may include moving items and/or parts, the digital twin visualization module 268 may generate a series of sequential frames that demonstrate the process. In this scenario, the movements of the machines and/or devices implicated by the process may be determined according to the behaviors defined in the respective digital twins of the machines and/or devices.

As discussed, the digital twin visualization module 268 may output the requested digital twin to a client application 217. In some embodiments, the client application 217 is a virtual reality application, whereby the requested digital twin is displayed on a virtual reality headset. In some embodiments, the client application 217 is an augmented reality application, whereby the requested digital twin is depicted in an AR-enabled device. In these embodiments, the requested digital twin may be filtered such that visual elements and/or text are overlaid on the display of the AR-enabled device.

It is noted that while a graph database is discussed, the digital twin system 200 may employ other suitable data structures to store information relating to a set of digital twins. In these embodiments, the data structures, and any related storage system, may be implemented such that the data structures provide for some degree of feedback loops and/or recursion when representing iteration of flows.

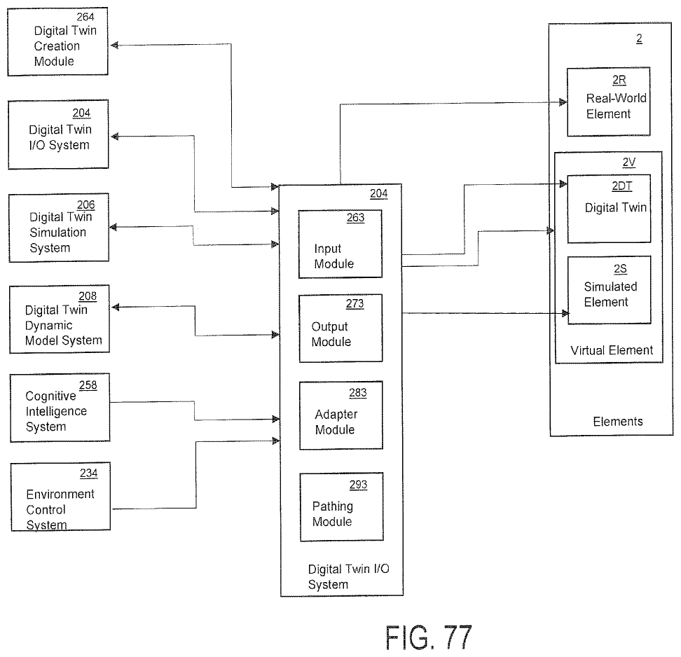

FIG. 77 illustrates an example of a digital twin I/O system 204 that interfaces with the transportation system 11, the digital twin system 200, and/or components thereof to provide bi-directional transfer of data between coupled components according to some embodiments of the present disclosure.

In embodiments, the transferred data includes signals (e.g., request signals, command signals, response signals, etc.) between connected components, which may include software components, hardware components, physical devices, virtualized devices, simulated devices, combinations thereof, and the like. The signals may define material properties (e.g., physical quantities of temperature, pressure, humidity, density, viscosity, etc.), measured values (e.g., contemporaneous or stored values acquired by the device or system), device properties (e.g., device ID or properties of the device's design specifications, materials, measurement capabilities, dimensions, absolute position, relative position, combinations thereof, and the like), set points (e.g., targets for material properties, device properties, system properties, combinations thereof, and the like), and/or critical points (e.g., threshold values such as minimum or maximum values for material properties, device properties, system properties, etc.). The signals may be received from systems or devices that acquire (e.g., directly measure or generate) or otherwise obtain (e.g., receive, calculate, lookup, filter, etc.) the data, and may be communicated to or from the digital twin I/O system 204 at predetermined times or in response to a request (e.g., polling) from the digital twin I/O system 204. The communications may occur through direct or indirect connections (e.g., via intermediate modules within a circuit and/or intermediate devices between the connected components). The values may correspond to real-world elements 2R (e.g., an input or output for a tangible vibration sensor) or virtual elements 2V (e.g., an input or output for a digital twin 2DT and/or a simulated element 2S that provide vibration data).

In embodiments, the real-world elements 2R may be elements within the transportation system 11. The real-world elements 2R may include, for example, non-networked physical objects 222, the devices 265 (smart or non-smart), sensors 227, and humans 229. The real-world elements 2R may be process or non-process equipment within the transportation systems 11. For example, process equipment may include motors, pumps, mills, fans, painters, welders, smelters, etc., and non-process equipment may include personal protective equipment, safety equipment, emergency stations or devices (e.g., safety showers, eyewash stations, fire extinguishers, sprinkler systems, etc.), warehouse features (e.g., walls, floor layout, etc.), obstacles (e.g., persons or other items within the transportation system 11, etc.), etc.

In embodiments, the virtual elements 2V may be digital representations of or that correspond to contemporaneously existing real-world elements 2R. Additionally or alternatively, the virtual elements 2V may be digital representations of or that correspond to real-world elements 2R that may be available for later addition and implementation into the transportation system 11. The virtual elements may include, for example, simulated elements 2S and/or digital twins 2DT. In embodiments, the simulated elements 2S may be digital representations of real-world elements 2S that are not present within the transportation system 11. The simulated elements 2S may mimic desired physical properties which may be later integrated within the transportation system 11 as real-world elements 2R (e.g., a “black box” that mimics the dimensions of real-world elements 2R). The simulated elements 2S may include digital twins of existing objects (e.g., a single simulated element 2S may include one or more digital twins 2DT for existing sensors). Information related to the simulated elements 2S may be obtained, for example, by evaluating behavior of corresponding real-world elements 2R using mathematical models or algorithms, from libraries that define information and behavior of the simulated elements 2S (e.g., physics libraries, chemistry libraries, or the like).

In embodiments, the digital twin 2DT may be a digital representation of one or more real-world elements 2R. The digital twins 2DT are configured to mimic, copy, and/or model behaviors and responses of the real-world elements 2R in response to inputs, outputs, and/or conditions of the surrounding or ambient environment. Data related to physical properties and responses of the real-world elements 2R may be obtained, for example, via user input, sensor input, and/or physical modeling (e.g., thermodynamic models, electrodynamic models, mechanodynamic models, etc.). Information for the digital twin 2DT may correspond to and be obtained from the one or more real-world elements 2R corresponding to the digital twin 2DT. For example, in some embodiments, the digital twin 2DT may correspond to one real-world element 2R that is a fixed digital vibration sensor 235 on a machine component, and vibration data for the digital twin 2DT may be obtained by polling or fetching vibration data measured by the fixed digital vibration sensor on the machine component. In a further example, the digital twin 2DT may correspond to a plurality of real-world elements 2R such that each of the elements can be a fixed digital vibration sensor on a machine component, and vibration data for the digital twin 2DT may be obtained by polling or fetching vibration data measured by each of the fixed digital vibration sensors on the plurality of real-world elements 2R. Additionally or alternatively, vibration data of a first digital twin 2DT may be obtained by fetching vibration data of a second digital twin 2DT that is embedded within the first digital twin 2DT, and vibration data for the first digital twin 2DT may include or be derived from vibration data for the second digital twin 2DT. For example, the first digital twin may be a digital twin 2DT of a transportation system 11 (alternatively referred to as a “transportation system digital twin”) and the second digital twin 2DT may be a digital twin 2DT corresponding to a vibration sensor disposed within the transportation system 11 such that the vibration data for the first digital twin 2DT is obtained from or calculated based on data including the vibration data for the second digital twin 2DT.

In embodiments, the digital twin system 200 monitors properties of the real-world elements 2R using the sensors 227 within a respective transportation system 11 that is or may be represented by a digital twin 2DT and/or outputs of models for one or more simulated elements 2S. In embodiments, the digital twin system 200 may minimize network congestion while maintaining effective monitoring of processes by extending polling intervals and/or minimizing data transfer for sensors corresponding that correspond to affected real-world elements 2R and performing simulations (e.g., via the digital-twin simulation system 106) during the extended interval using data that was obtained from other sources (e.g., sensors that are physically proximate to or have an effect on the affected real-world elements 2R). Additionally or alternatively, error checking may be performed by comparing the collected sensor data with data obtained from the digital-twin simulation system 106. For example, consistent deviations or fluctuations between sensor data obtained from the real-world element 2R and the simulated element 2S may indicate malfunction of the respective sensor or another fault condition.

In embodiments, the digital twin system 200 may optimize features of the transportation system through use of one or more simulated elements 2S. For example, the digital twin system 200 may evaluate effects of the simulated elements 2S within a digital twin of a transportation system to quickly and efficiently determine costs and/or benefits flowing from inclusion, exclusion, or substitution of real-world elements 2R within the transportation system 11. The costs and benefits may include, for example, increased machinery costs (e.g., capital investment and maintenance), increased efficiency (e.g., process optimization to reduce waste or increase throughput), decreased or altered footprint within the transportation system 11, extension or optimization of useful lifespans, minimization of component faults, minimization of component downtime, etc.

In embodiments, the digital twin I/O system 204 may include one or more software modules that are executed by one or more controllers of one or more devices (e.g., server devices, user devices, and/or distributed devices) to affect the described functions. The digital twin I/O system 204 may include, for example, an input module 263, an output module 273, and an adapter module 283.

In embodiments, the input module 263 may obtain or import data from data sources in communication with the digital twin I/O system 204, such as the sensor system 25 and the digital twin simulation system 206. The data may be immediately used by or stored within the digital twin system 200. The imported data may be ingested from data streams, data batches, in response to a triggering event, combinations thereof, and the like. The input module 263 may receive data in a format that is suitable to transfer, read, and/or write information within the digital twin system 200.

In embodiments, the output module 273 may output or export data to other system components (e.g., the digital twin datastore 269, the digital twin simulation system 206, the cognitive intelligence system 258, etc.), devices 265, and/or the client application 217. The data may be output in data streams, data batches, in response to a triggering event (e.g., a request), combinations thereof, and the like. The output module 273 may output data in a format that is suitable to be used or stored by the target element (e.g., one protocol for output to the client application and another protocol for the digital twin datastore 269).

In embodiments, the adapter module 283 may process and/or convert data between the input module 263 and the output module 273. In embodiments, the adapter module 283 may convert and/or route data automatically (e.g., based on data type) or in response to a received request (e.g., in response to information within the data).

In embodiments, the digital twin system 200 may represent a set of workpiece elements in a digital twin, and the digital twin simulation system 206 simulates a set of physical interactions of a worker with the workpiece elements. For example, the worker may be a crewmember of a transportation system that is a cruise ship, and the workpiece may be a dinner plate that needs to be cleaned and stowed.

In embodiments, the digital twin simulation system 206 may determine process outcomes for the simulated physical interactions accounting for simulated human factors. For example, variations in workpiece throughput may be modeled by the digital twin system 200 including, for example, worker response times to events, worker fatigue, discontinuity within worker actions (e.g., natural variations in human-movement speed, differing positioning times, etc.), effects of discontinuities on downstream processes, and the like. In embodiments, individualized worker interactions may be modeled using historical data that is collected, acquired, and/or stored by the digital twin system 200. The simulation may begin based on estimated amounts (e.g., worker age, industry averages, workplace expectations, etc.). The simulation may also individualize data for each worker (e.g., comparing estimated amounts to collected worker-specific outcomes).

In embodiments, information relating to workers (e.g., fatigue rates, efficiency rates, and the like) may be determined by analyzing performance of specific workers over time and modeling said performance.

In embodiments, the digital twin system 200 includes a plurality of proximity sensors within the sensor array 25. The proximity sensors are or may be configured to detect elements of the transportation system 11 that are within a predetermined area. For example, proximity sensors may include electromagnetic sensors, light sensors, and/or acoustic sensors.

The electromagnetic sensors are or may be configured to sense objects or interactions via one or more electromagnetic fields (e.g., emitted electromagnetic radiation or received electromagnetic radiation). In embodiments, the electromagnetic sensors include inductive sensors (e.g., radio-frequency identification sensors), capacitive sensors (e.g., contact and contactless capacitive sensors), combinations thereof, and the like.

The light sensors are or may be configured to sense objects or interactions via electromagnetic radiation in, for example, the far-infrared, near-infrared, optical, and/or ultraviolet spectra. In embodiments, the light sensors may include image sensors (e.g., charge-coupled devices and CMOS active-pixel sensors), photoelectric sensors (e.g., through-beam sensors, retroreflective sensors, and diffuse sensors), combinations thereof, and the like. Further, the light sensors may be implemented as part of a system or subsystem, such as a light detection and ranging (“LIDAR”) sensor.

The acoustic sensors are or may be configured to sense objects or interactions via sound waves that are emitted and/or received by the acoustic sensors. In embodiments, the acoustic sensors may include infrasonic, sonic, and/or ultrasonic sensors. Further, the acoustic sensors may be grouped as part of a system or subsystem, such as a sound navigation and ranging (“SONAR”) sensor.

In embodiments, the digital twin system 200 stores and collects data from a set of proximity sensors within the transportation system 11 or portions thereof. The collected data may be stored, for example, in the digital twin datastore 269 for use by components the digital twin system 200 and/or visualization by a user. Such use and/or visualization may occur contemporaneously with or after collection of the data (e.g., during later analysis and/or optimization of processes).

In embodiments, data collection may occur in response to a triggering condition. These triggering conditions may include, for example, expiration of a static or a dynamic predetermined interval, obtaining a value short of or in excess of a static or dynamic value, receiving an automatically generated request or instruction from the digital twin system 200 or components thereof, interaction of an element with the respective sensor or sensors (e.g., in response to a worker or machine breaking a beam or coming within a predetermined distance from the proximity sensor), interaction of a user with a digital twin (e.g., selection of a transportation system digital twin, a sensor array digital twin, or a sensor digital twin), combinations thereof, and the like.

In some embodiments, the digital twin system 200 collects and/or stores RFID data in response to interaction of a worker with a real-world element 2R. For example, in response to a worker interaction with a real-world environment, the digital twin will collect and/or store RFID data from RFID sensors within or associated with the corresponding transportation system 11. Additionally or alternatively, worker interaction with a sensor-array digital twin will collect and/or store RFID data from RFID sensors within or associated with the corresponding sensor array. Similarly, worker interaction with a sensor digital twin will collect and/or store RFID data from the corresponding sensor. The RFID data may include suitable data attainable by RFID sensors such as proximate RFID tags, RFID tag position, authorized RFID tags, unauthorized RFID tags, unrecognized RFID tags, RFID type (e.g., active or passive), error codes, combinations thereof, and the like.

In embodiments, the digital twin system 200 may further embed outputs from one or more devices within a corresponding digital twin. In embodiments, the digital twin system 200 embeds output from a set of individual-associated devices into a transportation system digital twin. For example, the digital twin I/O system 204 may receive information output from one or more wearable devices 257 or mobile devices (not shown) associated with an individual within a transportation system. The wearable devices may include image capture devices (e.g., body cameras or augmented-reality headwear), navigation devices (e.g., GPS devices, inertial guidance systems), motion trackers, acoustic capture devices (e.g., microphones), radiation detectors, combinations thereof, and the like.

In embodiments, upon receiving the output information, the digital twin I/O system 204 routes the information to the digital twin creation module 264 to check and/or update the transportation system digital twin and/or associated digital twins within the environment (e.g., a digital twin of a worker, machine, or robot position at a given time). Further, the digital twin system 200 may use the embedded output to determine characteristics of the transportation system 11.

In embodiments, the digital twin system 200 embeds output from a LIDAR point cloud system into a transportation system digital twin. For example, the digital twin I/O system 204 may receive information output from one or more Lidar devices 238 within a transportation system. The Lidar devices 238 is configured to provide a plurality of points having associated position data (e.g., coordinates in absolute or relative x, y, and z values). Each of the plurality of points may include further LIDAR attributes, such as intensity, return number, total returns, laser color data, return color data, scan angle, scan direction, etc. The Lidar devices 238 may provide a point cloud that includes the plurality of points to the digital twin system 200 via, for example, the digital twin I/O system 204. Additionally or alternatively, the digital twin system 200 may receive a stream of points and assemble the stream into a point cloud, or may receive a point cloud and assemble the received point cloud with existing point cloud data, map data, or three dimensional (3D)-model data.

In embodiments, upon receiving the output information, the digital twin I/O system 204 routes the point cloud information to the digital twin creation module 264 to check and/or update the environment digital twin and/or associated digital twins within the environment (e.g., a digital twin of a worker, machine, or robot position at a given time). In some embodiments, the digital twin system 200 is further configured to determine closed-shape objects within the received LIDAR data. For example, the digital twin system 200 may group a plurality of points within the point cloud as an object and, if necessary, estimate obstructed faces of objects (e.g., a face of the object contacting or adjacent a floor or a face of the object contacting or adjacent another object such as another piece of equipment). The system may use such closed-shape objects to narrow search space for digital twins and thereby increase efficiency of matching algorithms (e.g., a shape-matching algorithm).

In embodiments, the digital twin system 200 embeds output from a simultaneous location and mapping (“SLAM”) system in an environmental digital twin. For example, the digital twin I/O system 204 may receive information output from the SLAM system, such as Slam sensor 293, and embed the received information within an environment digital twin corresponding to the location determined by the SLAM system. In embodiments, upon receiving the output information from the SLAM system, the digital twin I/O system 204 routes the information to the digital twin creation module 264 to check and/or update the environment digital twin and/or associated digital twins within the environment (e.g., a digital twin of a workpiece, furniture, movable object, or autonomous object). Such updating provides digital twins of non-connected elements (e.g., furnishings or persons) automatically and without need of user interaction with the digital twin system 200.

In embodiments, the digital twin system 200 can leverage known digital twins to reduce computational requirements for the SLAM sensor 293 by using suboptimal map-building algorithms. For example, the suboptimal map-building algorithms may allow for a higher uncertainty tolerance using simple bounded-region representations and identifying possible digital twins. Additionally or alternatively, the digital twin system 200 may use a bounded-region representation to limit the number of digital twins, analyze the group of potential twins for distinguishing features, then perform higher precision analysis for the distinguishing features to identify and/or eliminate categories of, groups of, or individual digital twins and, in the event that no matching digital twin is found, perform a precision scan of only the remaining areas to be scanned.

In embodiments, the digital twin system 200 may further reduce compute required to build a location map by leveraging data captured from other sensors within the environment (e.g., captured images or video, radio images, etc.) to perform an initial map-building process (e.g., a simple bounded-region map or other suitable photogrammetry methods), associate digital twins of known environmental objects with features of the simple bounded-region map to refine the simple bounded-region map, and perform more precise scans of the remaining simple bounded regions to further refine the map. In some embodiments, the digital twin system 200 may detect objects within received mapping information and, for each detected object, determine whether the detected object corresponds to an existing digital twin of a real-world-element. In response to determining that the detected object does not correspond to an existing real-world-element digital twin, the digital twin system 200 may use, for example, the digital twin creation module 264 to generate a new digital twin corresponding to the detected object (e.g., a detected-object digital twin) and add the detected-object digital twin to the real-world-element digital twins within the digital twin datastore. Additionally or alternatively, in response to determining that the detected object corresponds to an existing real-world-element digital twin, the digital twin system 200 may update the real-world-element digital twin to include new information detected by the simultaneous location and mapping sensor, if any.

In embodiments, the digital twin system 200 represents locations of autonomously or remotely moveable elements and attributes thereof within a transportation system digital twin. Such movable elements may include, for example, workers, persons, vehicles, autonomous vehicles, robots, etc. The locations of the moveable elements may be updated in response to a triggering condition. Such triggering conditions may include, for example, expiration of a static or a dynamic predetermined interval, receiving an automatically generated request or instruction from the digital twin system 200 or components thereof, interaction of an element with a respective sensor or sensors (e.g., in response to a worker or machine breaking a beam or coming within a predetermined distance from a proximity sensor), interaction of a user with a digital twin (e.g., selection of an environmental digital twin, a sensor array digital twin, or a sensor digital twin), combinations thereof, and the like.

In embodiments, the time intervals may be based on probability of the respective movable element having moved within a time period. For example, the time interval for updating a worker location may be relatively shorter for workers expected to move frequently (e.g., a worker tasked with lifting and carrying objects within and through the transportation system 11) and relatively longer for workers expected to move infrequently (e.g., a worker tasked with monitoring a process stream). Additionally or alternatively, the time interval may be dynamically adjusted based on applicable conditions, such as increasing the time interval when no movable elements are detected, decreasing the time interval as or when the number of moveable elements within an environment increases (e.g., increasing number of workers and worker interactions), increasing the time interval during periods of reduced environmental activity (e.g., breaks such as lunch), decreasing the time interval during periods of abnormal environmental activity (e.g., tours, inspections, or maintenance), decreasing the time interval when unexpected or uncharacteristic movement is detected (e.g., frequent movement by a typically sedentary element or coordinated movement, for example, of workers approaching an exit or moving cooperatively to carry a large object), combinations thereof, and the like. Further, the time interval may also include additional, semi-random acquisitions. For example, occasional mid-interval locations may be acquired by the digital twin system 200 to reinforce or evaluate the efficacy of the particular time interval.

In embodiments, the digital twin system 200 may analyze data received from the digital twin I/O system 204 to refine, remove, or add conditions. For example, the digital twin system 200 may optimize data collection times for movable elements that are updated more frequently than needed (e.g., multiple consecutive received positions being identical or within a predetermined margin of error).

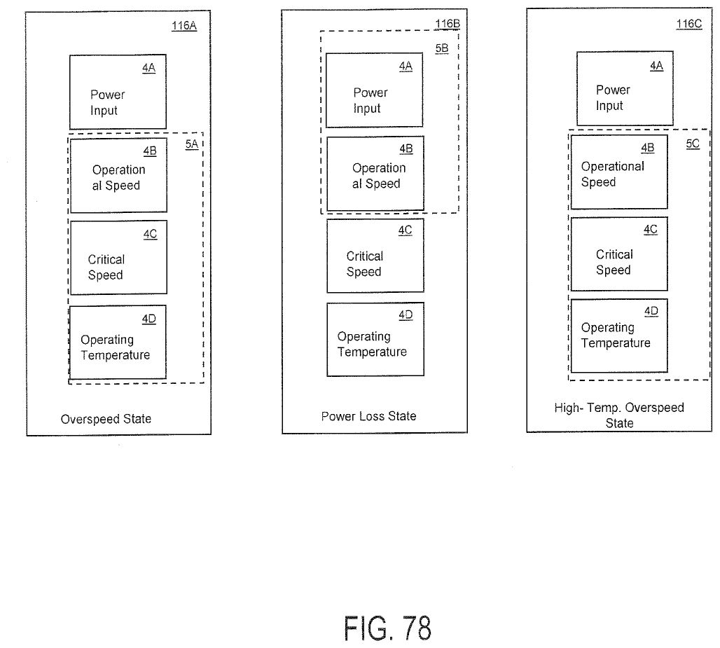

In embodiments, the digital twin system 200 may receive, identify, and/or store a set of states 116A-116N (i.e., 116A, 116B, 116C . . . 116N) where A, B, C . . . N indicates a set of indexes that is unique to the identified state. For example, the set of indexes may be the positive integers. Thus, the quantity of indexes in the set of indexes is not necessarily limited to the quantity of letters in an alphabet. Each index in the set of indexes may be used, for example, to indicate an association between a state 116N and a set of identifying criteria 5N having the same index (N in the example of this sentence). In the example depicted in FIG. 78, the set of identified states 116A-116N is related to the transportation system 11. The states 116A-116N may be, for example, data structures that include a plurality of attributes 4A-4N. In this case, the index A-N associated with the attribute may not necessarily be associated with a particular state 116A-116N. When written herein with reference numeral 4, e.g., 4A, the indexes A-N indicate a unique attribute. For example, 4A may be a reference sign for “power input,” 4B may be a reference sign for “operational speed,” 4C may be a reference sign for “critical speed,” and 4D may be a reference sign for “operating temperature.”

Further, the states 116A-116N may be, for example, data structures that include a set of identifying criteria 5A-5N to uniquely identify each respective state 116A-116N. In embodiments, the states 116A-116N may correspond to states where it is desirable for the digital twin system 200 to set or alter conditions of real-world elements 2R and/or the transportation system 11 (e.g., increase/decrease monitoring intervals, alter operating conditions, etc.).

In embodiments, the set of states 116A-116N may further include, for example, minimum monitored attributes for each state 116A-116N, the set of identifying criteria 5A-5N for each state 116A-116N, and/or actions available to be taken or recommended to be taken in response to each state 116A-116N. Such information may be stored by, for example, the digital twin datastore 269 or another datastore. The states 116A-116N or portions thereof may be provided to, determined by, or altered by the digital twin system 200. Further, the set of states 116A-116N may include data from disparate sources. For example, details to identify and/or respond to occurrence of a first state may be provided to the digital twin system 200 via user input, details to identify and/or respond to occurrence of a second state may be provided to the digital twin system 200 via an external system, details to identify and/or respond to occurrence of a third state may be determined by the digital twin system 200 (e.g., via simulations or analysis of process data), and details to identify and/or respond to occurrence of a fourth state may be stored by the digital twin system 200 and altered as desired (e.g., in response to simulated occurrence of the state or analysis of data collected during an occurrence of and response to the state).

In embodiments, the plurality of attributes 4A-4N includes at least the attributes 4A-4N needed to identify the respective state 116A-116N. The plurality of attributes 4A-4N may further include additional attributes that are or may be monitored in determining the respective state 116A-116N, but are not needed to identify the respective state 116A-116N. For example, the plurality of attributes 4A-4N for a first state may include relevant information such as rotational speed, fuel level, energy input, linear speed, acceleration, temperature, strain, torque, volume, weight, etc.

The set of identifying criteria 5A-5N may include information for each of the set of attributes 4A-4N to uniquely identify the respective state. The identifying criteria 5A-5N may include, for example, rules, thresholds, limits, ranges, logical values, conditions, comparisons, combinations thereof, and the like.

The change in operating conditions or monitoring may be any suitable change. For example, after identifying occurrence of a respective state 116A-116N, the digital twin system 200 may increase or decrease monitoring intervals for a device (e.g., decreasing monitoring intervals in response to a measured parameter differing from nominal operation) without altering operation of the device. Additionally or alternatively, the digital twin system 200 may alter operation of the device (e.g., reduce speed or power input) without altering monitoring of the device. In further embodiments, the digital twin system 200 may alter operation of the device (e.g., reduce speed or power input) and alter monitoring intervals for the device (e.g., decreasing monitoring intervals).

FIG. 78 illustrates an example set of identified states 116A-116N related to transportation systems that the digital twin system 200 may identify and/or store for access by intelligent systems (e.g., the cognitive intelligence system 258) or users of the digital twin system 200, according to some embodiments of the present disclosure. The states 116A-116N may include operational states (e.g., suboptimal, normal, optimal, critical, or alarm operation of one or more components), excess or shortage states (e.g., supply-side or output-side quantities), combinations thereof, and the like.

In embodiments, the digital twin system 200 may monitor attributes 4A-4N of real-world elements 2R and/or digital twins 2DT to determine the respective state 116A-116N. The attributes 4A-4N may be, for example, operating conditions, set points, critical points, status indicators, other sensed information, combinations thereof, and the like. For example, the attributes 4A-4N may include power input 4A, operational speed 4B, critical speed 4C, and operational temperature 4D of the monitored elements. While the illustrated example illustrates uniform monitored attributes, the monitored attributes may differ by target device (e.g., the digital twin system 200 would not monitor rotational speed for an object with no rotatable components).

Each of the states 116A-116N includes a set of identifying criteria 5A-5N meeting particular criteria that are unique among the group of monitored states 116A-116N. Referring to FIG. 78, the digital twin system 200 may identify the overspeed state 116A, for example, in response to the monitored attributes 4A-4N meeting a first set of identifying criteria 5A (e.g., operational speed 4B being higher than the critical speed 4C, while the operational temperature 4D is nominal).

The digital twin system 200 may identify the power loss state 116B, for example, in response to the monitored attributes 4A-4N meeting a second set of identifying criteria 5B (e.g., operational speed 4B requiring more than expected power input 4C).

The digital twin system 200 may identify the high-temperature overspeed state 116C, for example, in response to the monitored attributes 4A-4N meeting a third set of identifying criteria 5C (e.g., operational speed 4B being higher than the critical speed 4C, while the operational temperature 4D is above a predetermined limit).

In response to determining that one or more states 116A-116N exists or has occurred, the digital twin system 200 may update triggering conditions for one or more monitoring protocols, issue an alert or notification, or trigger actions of subcomponents of the digital twin system 200. For example, subcomponents of the digital twin system 200 may take actions to mitigate and/or evaluate impacts of the detected states 116A-116N. When attempting to take actions to mitigate impacts of the detected states 116A-116N on real-world elements 2R, the digital twin system 200 may determine whether instructions exist (e.g., are stored in the digital twin datastore 269) or should be developed (e.g., developed via simulation and cognitive intelligence or via user or worker input). Further, the digital twin system 200 may evaluate impacts of the detected states 116A-116N, for example, concurrently with the mitigation actions or in response to determining that the digital twin system 200 has no stored mitigation instructions for the detected states 116A-116N.

In embodiments, the digital twin system 200 employs the digital twin simulation system 206 to simulate one or more impacts, such as immediate, upstream, downstream, and/or continuing effects, of recognized states. The digital twin simulation system 206 may collect and/or be provided with values relevant to the evaluated states 116A-116N. In simulating the effect of the one or more states 116A-116N, the digital twin simulation system 206 may recursively evaluate performance characteristics of affected digital twins 2DT until convergence is achieved. The digital twin simulation system 206 may work, for example, in tandem with the cognitive intelligence system 258 to determine response actions to alleviate, mitigate, inhibit, and/or prevent occurrence of the one or more states 116A-116N. For example, the digital twin simulation system 206 may recursively simulate impacts of the one or more states 116A-116N until achieving a desired fit (e.g., convergence is achieved), provide the simulated values to the cognitive intelligence system 258 for evaluation and determination of potential actions, receive the potential actions, evaluate impacts of each of the potential actions for a respective desired fit (e.g., cost functions for minimizing production disturbance, preserving critical components, minimizing maintenance and/or downtime, optimizing system, worker, user, or personal safety, etc.).

In embodiments, the digital twin simulation system 206 and the cognitive intelligence system 258 may repeatedly share and update the simulated values and response actions for each desired outcome until desired conditions are met (e.g., convergence for each evaluated cost function for each evaluated action). The digital twin system 200 may store the results in the digital twin datastore 269 for use in response to determining that one or more states 116A-116N has occurred. Additionally, simulations and evaluations by the digital twin simulation system 206 and/or the cognitive intelligence system 258 may occur in response to occurrence or detection of the event.

In embodiments, simulations and evaluations are triggered only when associated actions are not present within the digital twin system 200. In further embodiments, simulations and evaluations are performed concurrently with use of stored actions to evaluate the efficacy or effectiveness of the actions in real time and/or evaluate whether further actions should be employed or whether unrecognized states may have occurred. In embodiments, the cognitive intelligence system 258 may also be provided with notifications of instances of undesired actions with or without data on the undesired aspects or results of such actions to optimize later evaluations.

In embodiments, the digital twin system 200 evaluates and/or represents the effect of machine downtime within a digital twin of a manufacturing facility. For example, the digital twin system 200 may employ the digital twin simulation system 206 to simulate the immediate, upstream, downstream, and/or continuing effects of a machine downtime state 116D. The digital twin simulation system 206 may collect or be provided with performance-related values such as optimal, suboptimal, and minimum performance requirements for elements (e.g., real-world elements 2R and/or nested digital twins 2DT) within the affected digital twins 2DT, and/or characteristics thereof that are available to the affected digital twins 2DT, nested digital twins 2DT, redundant systems within the affected digital twins 2DT, combinations thereof, and the like.

In embodiments, the digital twin system 200 is configured to: simulate one or more operating parameters for the real-world elements in response to the transportation system being supplied with given characteristics using the real-world-element digital twins; calculate a mitigating action to be taken by one or more of the real-world elements in response to being supplied with the contemporaneous characteristics; and actuate, in response to detecting the contemporaneous characteristics, the mitigating action. The calculation may be performed in response to detecting contemporaneous characteristics or operating parameters falling outside of respective design parameters or may be determined via a simulation prior to detection of such characteristics.

Additionally or alternatively, the digital twin system 200 may provide alerts to one or more users or system elements in response to detecting states.

In embodiments, the digital twin I/O system 204 includes a pathing module 293. The pathing module 293 may ingest navigational data from the elements 2, provide and/or request navigational data to components of the digital twin system 200 (e.g., the digital twin simulation system 206, the digital twin dynamic model system 208, and/or the cognitive intelligence system 258), and/or output navigational data to elements 2 (e.g., to the wearable devices 257). The navigational data may be collected or estimated using, for example, historical data, guidance data provided to the elements 2, combinations thereof, and the like.

For example, the navigational data may be collected or estimated using historical data stored by the digital twin system 200. The historical data may include or be processed to provide information such as acquisition time, associated elements 2, polling intervals, task performed, laden or unladen conditions, whether prior guidance data was provided and/or followed, conditions of the transportation system 11, other elements 2 within the transportation system 11, combinations thereof, and the like. The estimated data may be determined using one or more suitable pathing algorithms. For example, the estimated data may be calculated using suitable order-picking algorithms, suitable path-search algorithms, combinations thereof, and the like. The order-picking algorithm may be, for example, a largest gap algorithm, an s-shape algorithm, an aisle-by-aisle algorithm, a combined algorithm, combinations thereof, and the like. The path-search algorithms may be, for example, Dijkstra's algorithm, the A* algorithm, hierarchical path-finding algorithms, incremental path-finding algorithms, any angle path-finding algorithms, flow field algorithms, combinations thereof, and the like.

Additionally or alternatively, the navigational data may be collected or estimated using guidance data of the worker. The guidance data may include, for example, a calculated route provided to a device of the worker (e.g., a mobile device or the wearable device 257). In another example, the guidance data may include a calculated route provided to a device of the worker that instructs the worker to collect vibration measurements from one or more locations on one or more machines along the route. The collected and/or estimated navigational data may be provided to a user of the digital twin system 200 for visualization, used by other components of the digital twin system 200 for analysis, optimization, and/or alteration, provided to one or more elements 2, combinations thereof, and the like.

In embodiments, the digital twin system 200 ingests navigational data for a set of workers for representation in a digital twin. Additionally or alternatively, the digital twin system 200 ingests navigational data for a set of mobile equipment assets of a transportation system into a digital twin.

In embodiments, the digital twin system 200 ingests a system for modeling traffic of mobile elements in a transportation system digital twin. For example, the digital twin system 200 may model traffic patterns for workers or persons within the transportation system 11, mobile equipment assets, combinations thereof, and the like. The traffic patterns may be estimated based on modeling traffic patterns from and historical data and contemporaneous ingested data. Further, the traffic patterns may be continuously or intermittently updated depending on conditions within the transportation system 11 (e.g., a plurality of autonomous mobile equipment assets may provide information to the digital twin system 200 at a slower update interval than the transportation system 11 including both workers and mobile equipment assets).

The digital twin system 200 may alter traffic patterns (e.g., by providing updated navigational data to one or more of the mobile elements) to achieve one or more predetermined criteria. The predetermined criteria may include, for example, increasing process efficiency, decreasing interactions between laden workers and mobile equipment assets, minimizing worker path length, routing mobile equipment around paths or potential paths of persons, combinations thereof, and the like.

In embodiments, the digital twin system 200 may provide traffic data and/or navigational information to mobile elements in a transportation system digital twin. The navigational information may be provided as instructions or rule sets, displayed path data, or selective actuation of devices. For example, the digital twin system 200 may provide a set of instructions to a robot to direct the robot to and/or along a desired route for collecting vibration data from one or more specified locations on one or more specified machines along the route using a vibration sensor. The robot may communicate updates to the system including obstructions, reroutes, unexpected interactions with other assets within the transportation system 11, etc.

In embodiments, the digital twin system 200 includes design specification information for representing a real-world element 2R using a digital twin 2DT. The digital may correspond to an existing real-world element 2R or a potential real-world element 2R. The design specification information may be received from one or more sources. For example, the design specification information may include design parameters set by user input, determined by the digital twin system 200 (e.g., the via digital twin simulation system 206), optimized by users or the digital twin simulation system 206, combinations thereof, and the like. The digital twin simulation system 206 may represent the design specification information for the component to users, for example, via a display device or a wearable device. The design specification information may be displayed schematically (e.g., as part of a process diagram or table of information) or as part of an augmented reality or virtual reality display. The design specification information may be displayed, for example, in response to a user interaction with the digital twin system 200 (e.g., via user selection of the element or user selection to generally include design specification information within displays). Additionally or alternatively, the design specification information may be displayed automatically, for example, upon the element coming within view of an augmented reality or virtual reality device. In embodiments, the displayed design specification information may further include indicia of information source (e.g., different displayed colors indicate user input versus digital twin system 200 determination), indicia of mismatches (e.g., between design specification information and operational information), combinations thereof, and the like.

In embodiments, the digital twin system 200 embeds a set of control instructions for a wearable device within a transportation system digital twin, such that the control instructions are provided to the wearable device to induce an experience for a wearer of the wearable device upon interaction with an element of the transportation system digital twin. The induced experience may be, for example, an augmented reality experience or a virtual reality experience. The wearable device, such as a headset, may be configured to output video, audio, and/or haptic feedback to the wearer to induce the experience. For example, the wearable device may include a display device and the experience may include display of information related to the respective digital twin. The information displayed may include maintenance data associated with the digital twin, vibration data associated with the digital twin, vibration measurement location data associated with the digital twin, financial data associated with the digital twin, such as a profit or loss associated with operation of the digital twin, manufacturing KPIs associated with the digital twin, information related to an occluded element (e.g., a sub-assembly) that is at least partially occluded by a foreground element (e.g., a housing), a virtual model of the occluded element overlaid on the occluded element and visible with the foreground element, operating parameters for the occluded element, a comparison to a design parameter corresponding to the operating parameter displayed, combinations thereof, and the like. Comparisons may include, for example, altering display of the operating parameter to change a color, size, and/or display period for the operating parameter.

In some embodiments, the displayed information may include indicia for removable elements that are or may be configured to provide access to the occluded element with each indicium being displayed proximate to or overlying the respective removable element. Further, the indicia may be sequentially displayed such that a first indicium corresponding to a first removable element (e.g., a housing) is displayed, and a second indicium corresponding to a second removable element (e.g., an access panel within the housing) is displayed in response to the worker removing the first removable element. In some embodiments, the induced experience allows the wearer to see one or more locations on a machine for optimal vibration measurement collection. In an example, the digital twin system 200 may provide an augmented reality view that includes highlighted vibration measurement collection locations on a machine and/or instructions related to collecting vibration measurements. Furthering the example, the digital twin system 200 may provide an augmented reality view that includes instructions related to timing of vibration measurement collection. Information utilized in displaying the highlighted placement locations may be obtained using information stored by the digital twin system 200. In some embodiments, mobile elements may be tracked by the digital twin system 200 (e.g., via observational elements within the transportation system 11 and/or via pathing information communicated to the digital twin system 200) and continually displayed by the wearable device within the occluded view of the worker. This optimizes movement of elements within the transportation system 11, increases worker safety, and minimizes down time of elements resulting from damage.

In some embodiments, the digital twin system 200 may provide an augmented reality view that displays mismatches between design parameters or expected parameters of real-world elements 2R to the wearer. The displayed information may correspond to real-world elements 2R that are not within the view of the wearer (e.g., elements within another room or obscured by machinery). This allows the worker to quickly and accurately troubleshoot mismatches to determine one or more sources for the mismatch. The cause of the mismatch may then be determined, for example, by the digital twin system 200 and corrective actions ordered. In example embodiments, a wearer may be able to view malfunctioning subcomponents of machines without removing occluding elements (e.g., housings or shields). Additionally or alternatively, the wearer may be provided with instructions to repair the device, for example, including display of the removal process (e.g., location of fasteners to be removed), assemblies or subassemblies that should be transported to other areas for repair (e.g., dust-sensitive components), assemblies or subassemblies that need lubrication, and locations of objects for reassembly (e.g., storing location that the wearer has placed removed objects and directing the wearer or another wearer to the stored locations to expedite reassembly and minimize further disassembly or missing parts in the reassembled element). This can expedite repair work, minimize process impact, allow workers to disassemble and reassemble equipment (e.g., by coordinating disassembly without direct communication between the workers), increase equipment longevity and reliability (e.g., by assuring that all components are properly replaced prior to placing back in service), combinations thereof, and the like.

In some embodiments, the induced experience includes a virtual reality view or an augmented reality view that allows the wearer to see information related to existing or planned elements. The information may be unrelated to physical performance of the element (e.g., financial performance such as asset value, energy cost, input material cost, output material value, legal compliance, and corporate operations). One or more wearers may perform a virtual walkthrough or an augmented walkthrough of the transportation system 11.

In examples, the wearable device displays compliance information that expedites inspections or performance of work.

In further examples, the wearable device displays financial information that is used to identify targets for alteration or optimization. For example, a manager or officer may inspect the transportation system 11 for compliance with updated regulations, including information regarding compliance with former regulations, “grandfathered,” and/or excepted elements. This can be used to reduce unnecessary downtime (e.g., scheduling upgrades for the least impactful times, such as during planned maintenance cycles), prevent unnecessary upgrades (e.g., replacing grandfathered or excepted equipment), and reduce capital investment.

Referring back to FIG. 75, in embodiments, the digital twin system 200 may include, integrate, integrate with, manage, handle, link to, take input from, provide output to, control, coordinate with, or otherwise interact with a digital twin dynamic model system 208. The digital twin dynamic model system 208 can update the properties of a set of digital twins of a set of transportation entities and/or systems, including properties of physical industrial assets, workers, processes, manufacturing facilities, warehouses, and the like (or any of the other types of entities or systems described in this disclosure or in the documents incorporated by reference herein) in such a manner that the digital twins may represent those transportation entities and environments, and properties or attributes thereof, in real-time or very near real-time. In some embodiments, the digital twin dynamic model system 208 may obtain sensor data received from a sensor system 25 and may determine one or more properties of a transportation system or a transportation entity within an environment based on the sensor data and based on one or more dynamic models.

In embodiments, the digital twin dynamic model system 208 may update/assign values of various properties in a digital twin and/or one or more embedded digital twins, including, but not limited to, vibration values, vibration fault level states, probability of failure values, probability of downtime values, cost of downtime values, probability of shutdown values, financial values, KPI values, temperature values, humidity values, heat flow values, fluid flow values, radiation values, substance concentration values, velocity values, acceleration values, location values, pressure values, stress values, strain values, light intensity values, sound level values, volume values, shape characteristics, material characteristics, and dimensions.

In embodiments, a digital twin may be comprised of (e.g., via reference) of other embedded digital twins. For example, a digital twin of a manufacturing facility may include an embedded digital twin of a machine and one or more embedded digital twins of one or more respective motors enclosed within the machine. A digital twin may be embedded, for example, in the memory of a machine that has an onboard IT system (e.g., the memory of an Onboard Diagnostic System, control system (e.g., SCADA system) or the like). Other non-limiting examples of where a digital twin may be embedded include the following: on a wearable device of a worker; in memory on a local network asset, such as a switch, router, access point, or the like; in a cloud computing resource that is provisioned for an environment or entity; and on an asset tag or other memory structure that is dedicated to an entity.

In one example, the digital twin dynamic model system 208 can update vibration characteristics throughout a transportation system digital twin based on captured vibration sensor data measured at one or more locations in the transportation system and one or more dynamic models that model vibration within the transportation system digital twin. The transportation system digital twin may, before updating, already contain information about properties of the transportation entities and/or system that can be used to feed a dynamic model, such as information about materials, shapes/volumes (e.g., of conduits), positions, connections/interfaces, and the like, such that vibration characteristics can be represented for the entities and/or system in the digital twin. Alternatively, the dynamic models may be configured using such information.

In embodiments, the digital twin dynamic model system 208 can update the properties of a digital twin and/or one or more embedded digital twins on behalf of a client application 217. In embodiments, a client application 217 may be an application relating to a component or system (e.g., monitoring a transportation system or a component within, simulating a transportation system, or the like). In embodiments, the client application 217 may be used in connection with both fixed and mobile data collection systems. In embodiments, the client application 217 may be used in connection with network connected sensor system 25.

In embodiments, the digital twin dynamic model system 208 leverages digital twin dynamic models to model the behavior of a transportation entity and/or system. Dynamic models may enable digital twins to represent physical reality, including the interactions of transportation entities, by using a limited number of measurements to enrich the digital representation of a transportation entity and/or system, such as based on scientific principles. In embodiments, the dynamic models are formulaic or mathematical models. In embodiments, the dynamic models adhere to scientific laws, laws of nature, and formulas (e.g., Newton's laws of motion, second law of thermodynamics, Bernoulli's principle, ideal gas law, Dalton's law of partial pressures, Hooke's law of elasticity, Fourier's law of heat conduction, Archimedes' principle of buoyancy, and the like). In embodiments, the dynamic models are machine-learned models.

In embodiments, the digital twin system 200 may have a digital twin dynamic model datastore 208 for storing dynamic models that may be represented in digital twins. In embodiments, digital twin dynamic model datastore can be searchable and/or discoverable. In embodiments, digital twin dynamic model datastore can contain metadata that allows a user to understand what characteristics a given dynamic model can handle, what inputs are required, what outputs are provided, and the like. In some embodiments, digital twin dynamic model datastore 228 can be hierarchical (such as where a model can be deepened or made simpler based on the extent of available data and/or inputs, the granularity of the inputs, and/or situational factors (such as where something becomes of high interest and a higher fidelity model is accessed for a period of time).

In embodiments, a digital twin or digital representation of a transportation entity or system may include a set of data structures that collectively define a set of properties of a represented physical asset, device, worker, process, facility, and/or system, and/or possible behaviors thereof. In embodiments, the digital twin dynamic model system 208 may leverage the dynamic models to inform the set of data structures that collectively define a digital twin with real-time data values. The digital twin dynamic models may receive one or more sensor measurements, network connected device data, and/or other suitable data as inputs and calculate one or more outputs based on the received data and one or more dynamic models. The digital twin dynamic model system 208 then uses the one or more outputs to update the digital twin data structures.

In one example, the set of properties of a digital twin of an asset that may be updated by the digital twin dynamic model system 208 using dynamic models may include the vibration characteristics of the asset, temperature(s) of the asset, the state of the asset (e.g., a solid, liquid, or gas), the location of the asset, the displacement of the asset, the velocity of the asset, the acceleration of the asset, probability of downtime values associated with the asset, cost of downtime values associated with the asset, probability of shutdown values associated with the asset, KPIs associated with the asset, financial information associated with the asset, heat flow characteristics associated with the asset, fluid flow rates associated with the asset (e.g., fluid flow rates of a fluid flowing through a pipe), identifiers of other digital twins embedded within the digital twin of the asset and/or identifiers of digital twins embedding the digital twin of the asset, and/or other suitable properties. Dynamic models associated with a digital twin of an asset can be configured to calculate, interpolate, extrapolate, and/or output values for such asset digital twin properties based on input data collected from sensors and/or devices disposed in the transportation system setting and/or other suitable data and subsequently populate the asset digital twin with the calculated values.

In some embodiments, the set of properties of a digital twin of a transportation system device that may be updated by the digital twin dynamic model system 208 using dynamic models may include the status of the device, a location of the device, the temperature(s) of a device, a trajectory of the device, identifiers of other digital twins that the digital twin of the device is embedded within, embeds, is linked to, includes, integrates with, takes input from, provides output to, and/or interacts with and the like. Dynamic models associated with a digital twin of a device can be configured to calculate or output values for these device digital twin properties based on input data and subsequently update the device digital twin with the calculated values.

In some embodiments, the set of properties of a digital twin of a transportation system worker that may be updated by the digital twin dynamic model system 208 using dynamic models may include the status of the worker, the location of the worker, a stress measure for the worker, a task being performed by the worker, a performance measure for the worker, and the like. Dynamic models associated with a digital twin of a transportation system worker can be configured to calculate or output values for such properties based on input data, which then may be used to populate the transportation system worker digital twin. In embodiments, transportation system worker dynamic models (e.g., psychometric models) can be configured to predict reactions to stimuli, such as cues that are given to workers to direct them to undertake tasks and/or alerts or warnings that are intended to induce safe behavior. In embodiments, transportation system worker dynamic models may be workflow models (Gantt charts and the like), failure mode effects analysis models (FMEA), biophysical models (such as to model worker fatigue, energy utilization, hunger), and the like.

Example properties of a digital twin of a transportation system that may be updated by the digital twin dynamic model system 208 using dynamic models may include the dimensions of the transportation system environment, the temperature(s) of the transportation system environment, the humidity value(s) of the transportation system environment, the fluid flow characteristics in the transportation system environment, the heat flow characteristics of the transportation system environment, the lighting characteristics of the transportation system environment, the acoustic characteristics of the transportation system environment the physical objects in the transportation system environment, processes occurring in the transportation system environment, currents of the transportation system environment (if a body of water), and the like. Dynamic models associated with a digital twin of a transportation system can be configured to calculate or output these properties based on input data collected from sensors and/or devices disposed in the transportation system environment and/or other suitable data and subsequently populate the transportation system digital twin with the calculated values.

In embodiments, dynamic models may adhere to physical limitations that define boundary conditions, constants or variables for digital twin modeling. For example, the physical characterization of a digital twin of a transportation entity or transportation system may include a gravity constant (e.g., 9.8 m/s²), friction coefficients of surfaces, thermal coefficients of materials, maximum temperatures of assets, maximum flow capacities, and the like. Additionally or alternatively, the dynamic models may adhere to the laws of nature. For example, dynamic models may adhere to the laws of thermodynamics, laws of motion, laws of fluid dynamics, laws of buoyancy, laws of heat transfer, laws or radiation, laws of quantum dynamics, and the like. In some embodiments, dynamic models may adhere to biological aging theories or mechanical aging principles. Thus, when the digital twin dynamic model system 208 facilitates a real-time digital representation, the digital representation may conform to dynamic models, such that the digital representations mimic real world conditions. In some embodiments, the output(s) from a dynamic model can be presented to a human user and/or compared against real-world data to ensure convergence of the dynamic models with the real world. Furthermore, as dynamic models are based partly on assumptions, the properties of a digital twin may be improved and/or corrected when a real-world behavior differs from that of the digital twin. In embodiments, additional data collection and/or instrumentation can be recommended based on the recognition that an input is missing from a desired dynamic model, that a model in operation isn't working as expected (perhaps due to missing and/or faulty sensor information), that a different result is needed (such as due to situational factors that make something of high interest), and the like.

Dynamic models may be obtained from a number of different sources. In some embodiments, a user can upload a model created by the user or a third party. Additionally or alternatively, the models may be created on the digital twin system using a graphical user interface. The dynamic models may include bespoke models that are configured for a particular transportation system and/or set of transportation entities and/or agnostic models that are applicable to similar types of digital twins. The dynamic models may be machine-learned models.

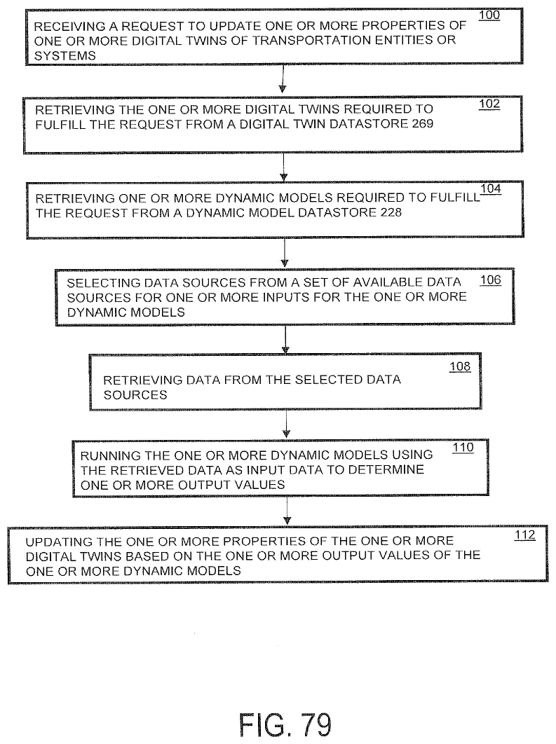

FIG. 79 illustrates example embodiments of a method for updating a set of properties of a digital twin and/or one or more embedded digital twins on behalf of client applications 217. In embodiments, a digital twin dynamic model system 208 leverages one or more dynamic models to update a set of properties of a digital twin and/or one or more embedded digital twins on behalf of client application 217 based on the effect of collected sensor data from sensor system 25, data collected from network connected devices 265, and/or other suitable data in the set of dynamic models that are used to enable the transportation system digital twins. In embodiments, the digital twin dynamic model system 208 may be instructed to run specific dynamic models using one or more digital twins that represent physical transportation system assets, devices, workers, processes, and/or transportation systems that are managed, maintained, and/or monitored by the client applications 217.

In embodiments, the digital twin dynamic model system 208 may obtain data from other types of external data sources that are not necessarily transportation-related data sources, but may provide data that can be used as input data for the dynamic models. For example, weather data, news events, social media data, and the like may be collected, crawled, subscribed to, and the like to supplement sensor data, network connected device data, and/or other data that is used by the dynamic models. In embodiments, the digital twin dynamic model system 208 may obtain data from a machine vision system. The machine vision system may use video and/or still images to provide measurements (e.g., locations, statuses, and the like) that may be used as inputs by the dynamic models.

In embodiments, the digital twin dynamic model system 208 may feed this data into one or more of the dynamic models discussed above to obtain one or more outputs. These outputs may include calculated vibration fault level states, vibration severity unit values, vibration characteristics, probability of failure values, probability of downtime values, probability of shutdown values, cost of downtime values, cost of shutdown values, time to failure values, temperature values, pressure values, humidity values, precipitation values, visibility values, air quality values, strain values, stress values, displacement values, velocity values, acceleration values, location values, performance values, financial values, KPI values, electrodynamic values, thermodynamic values, fluid flow rate values, and the like. The client application 217 may then initiate a digital twin visualization event using the results obtained by the digital twin dynamic model system 208. In embodiments, the visualization may be a heat map visualization.

In embodiments, the digital twin dynamic model system 208 may receive requests to update one or more properties of digital twins of transportation entities and/or systems such that the digital twins represent the transportation entities and/or systems in real-time. As shown in FIG. 79, at box 100, the digital twin dynamic model system 208 receives a request to update one or more properties of one or more of the digital twins of transportation entities and/or systems. For example, the digital twin dynamic model system 208 may receive the request from a client application 217 or from another process executed by the digital twin system 200 (e.g., a predictive maintenance process). The request may indicate the one or more properties and the digital twin or digital twins implicated by the request. In FIG. 79 step 102, the digital twin dynamic model system 208 determines the one or more digital twins required to fulfill the request and retrieves the one or more required digital twins, including any embedded digital twins, from the digital twin datastore 269. At FIG. 79, box 104, the digital twin dynamic model system 208 determines one or more dynamic models required to fulfill the request and retrieves the one or more required dynamic models from digital twin dynamic model datastore 208. At FIG. 79, system 106, the digital twin dynamic model system 208 selects one or more sensors from sensor system 25, data collected from network connected devices 265, and/or other data sources from digital twin I/O system 204 based on available data sources for one or more inputs for the one or more dynamic models. In embodiments, the data sources may be defined in the inputs required by the one or more dynamic models or may be selected using a lookup table. At FIG. 79, box 108, the digital twin dynamic model system 208 retrieves the selected data from digital twin I/O system 204, which receives sensor data and other data via real-time sensor API 214. At FIG. 79, vehicle 110, digital twin dynamic model system 208 runs the one or more dynamic models using the retrieved data (e.g., vibration sensor data, network connected device data, and the like) as input data and determines one or more output values based on the one or more dynamic models and the input data. At FIG. 79, engine 112, the digital twin dynamic model system 208 updates the values of one or more properties of the one or more digital twins based on the one or more outputs of the dynamic model(s).

In example embodiments, client application 217 may be configured to provide a digital representation and/or visualization of the digital twin of a transportation entity. In embodiments, the client application 217 may include one or more software modules that are executed by one or more server devices. These software modules may be configured to quantify properties of the digital twin, model properties of a digital twin, and/or to visualize digital twin behaviors. In embodiments, these software modules may enable a user to select a particular digital twin behavior visualization for viewing. In embodiments, these software modules may enable a user to select to view a digital twin behavior visualization playback. In some embodiments, the client application 217 may provide a selected behavior visualization to digital twin dynamic model system 208.

In embodiments, the digital twin dynamic model system 208 may receive requests from the client application 217 to update properties of a digital twin in order to enable a digital representation of a transportation entity and/or system wherein the real-time digital representation is a visualization of the digital twin. In embodiments, a digital twin may be rendered by a computing device, such that a human user can view the digital representations of real-world assets, devices, workers, processes and/or systems. For example, the digital twin may be rendered and outcome to a display device. In embodiments, dynamic model outputs and/or related data may be overlaid on the rendering of the digital twin. In embodiments, dynamic model outputs and/or related information may appear with the rendering of the digital twin in a display interface. In embodiments, the related information may include real-time video footage associated with the real-world entity represented by the digital twin. In embodiments, the related information may include a sum of each of the vibration fault level states in the machine. In embodiments, the related information may be graphical information. In embodiments, the graphical information may depict motion and/or motion as a function of frequency for individual machine components. In embodiments, graphical information may depict motion and/or motion as a function of frequency for individual machine components, wherein a user is enabled to select a view of the graphical information in the x, y, and z dimensions. In embodiments, graphical information may depict motion and/or motion as a function of frequency for individual machine components, wherein the graphical information includes harmonic peaks and peaks. In embodiments, the related information may be cost data, including the cost of downtime per day data, cost of repair data, cost of new part data, cost of new machine data, and the like. In embodiments, related information may be a probability of downtime data, probability of failure data, and the like. In embodiments, related information may be time to failure data.

In embodiments, the related information may be recommendations and/or insights. For example, recommendations or insights received from the cognitive intelligence system related to a machine may appear with the rendering of the digital twin of a machine in a display interface.

In embodiments, clicking, touching, or otherwise interacting with the digital twin rendered in the display interface can allow a user to “drill down” and see underlying subsystems or processes and/or embedded digital twins. For example, in response to a user clicking on a machine bearing rendered in the digital twin of a machine, the display interface can allow a user to drill down and see information related to the bearing, view a 3D visualization of the bearing's vibration, and/or view a digital twin of the bearing.

In embodiments, clicking, touching, or otherwise interacting with information related to the digital twin rendered in the display interface can allow a user to “drill down” and see underlying information.

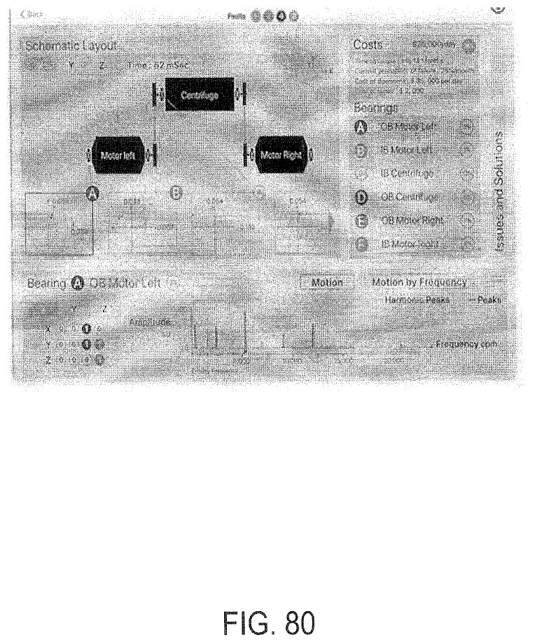

FIG. 80 illustrates example embodiments of a display interface that renders the digital twin of a dryer centrifuge and other information related to the dryer centrifuge. Dryer centrifuges may be included in many transportation systems. For example, some ships use a dryer centrifuge to separate water from fuel and lubricating oil. Transportation systems and transportation entities such as, for example, shipping ports, fuel infrastructure systems at airports, and oil platforms, may include a dryer centrifuge.

In some embodiments, the digital twin may be rendered and output in a virtual reality display. For example, a user may view a 3D rendering of a transportation system (e.g., using a monitor or a virtual reality headset). The user may also inspect and/or interact with digital twins of transportation entities. In embodiments, a user may view processes being performed with respect to one or more digital twins (e.g., collecting measurements, movements, interactions, loading, packing, fueling, resupplying, maintaining, cleaning, painting and the like). In embodiments, a user may provide input that controls one or more properties of a digital twin via a graphical user interface.

In some embodiments, the digital twin dynamic model system 208 may receive requests from client application 217 to update properties of a digital twin in order to enable a digital representation of transportation entities and/or systems wherein the digital representation is a heat map visualization of the digital twin. In embodiments, a platform is provided having heat maps displaying collected data from the sensor system 25, network connected devices 265, and data outputs from dynamic models for providing input to a display interface. In embodiments, the heat map interface is provided as an output for digital twin data, such as for handling and providing information for visualization of various sensor data, dynamic model output data, and other data (such as map data, analog sensor data, and other data), such as to another system, such as a mobile device, tablet, dashboard, computer, AR/VR device, or the like. A digital twin representation may be provided in a form factor (e.g., user device, VR-enabled device, AR-enabled device, or the like) suitable for delivering visual input to a user, such as the presentation of a map that includes indicators of levels of analog sensor data, digital sensor data, and output values from the dynamic models (such as data indicating vibration fault level states, vibration severity unit values, probability of downtime values, cost of downtime values, probability of shutdown values, time to failure values, probability of failure values, KPIs, temperatures, levels of rotation, vibration characteristics, fluid flow, heating or cooling, pressure, substance concentrations, and many other output values). In embodiments, signals from various sensors or input sources (or selective combinations, permutations, mixes, and the like) as well as data determined by the digital twin dynamic model system 208 may provide input data to a heat map. Coordinates may include real world location coordinates (such as geo-location or location on a map of a transportation system), as well as other coordinates, such as time-based coordinates, frequency-based coordinates, or other coordinates that allow for representation of analog sensor signals, digital signals, dynamic model outputs, input source information, and various combinations, in a map-based visualization, such that colors may represent varying levels of input along the relevant dimensions. For example, among many other possibilities, if transportation system machine component is at a critical vibration fault level state, the heat map interface may alert a user by showing the machine component in orange. In the example of a heat map, clicking, touching, or otherwise interacting with the heat map can allow a user to drill down and see underlying sensor, dynamic model outputs, or other input data that is used as an input to the heat map display. In other examples, such as ones where a digital twin is displayed in a VR or AR environment, if a transportation system machine component is vibrating outside of normal operation (e.g., at a suboptimal, critical, or alarm vibration fault level), a haptic interface may induce vibration when a user touches a representation of the machine component, or if a machine component is operating in an unsafe manner, a directional sound signal may direct a user's attention toward the machine in digital twin, such as by playing in a particular speaker of a headset or other sound system.

In embodiments, the digital twin dynamic model system 208 may take a set of ambient environmental data and/or other data and automatically update a set of properties of a digital twin of a transportation entity or system based on the effect of the ambient environmental data and/or other data in the set of dynamic models that are used to enable the digital twin. Ambient environmental data may include temperature data, pressure data, humidity data, wind data, rainfall data, tide data, storm surge data, cloud cover data, snowfall data, visibility data, water level data, and the like. Additionally or alternatively, the digital twin dynamic model system 208 may use a set of ambient environmental data measurements collected by a set of network connected devices 265 disposed in a transportation system setting as inputs for the set of dynamic models that are used to enable the digital twin. For example, digital twin dynamic model system 208 may feed the dynamic models data collected, handled or exchanged by network connected devices 265, such as cameras, monitors, embedded sensors, mobile devices, diagnostic devices and systems, instrumentation systems, telematics systems, and the like, such as for monitoring various parameters and features of machines, devices, components, parts, operations, functions, conditions, states, events, workflows and other elements (collectively encompassed by the term “states”) of transportation systems. Other examples of network connected devices include smart fire alarms, smart security systems, smart air quality monitors, smart/learning thermostats, and smart lighting systems.

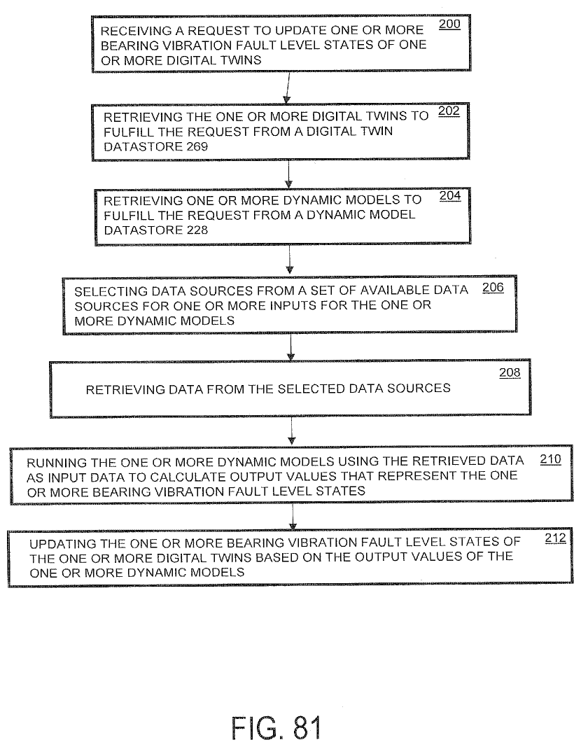

FIG. 81 illustrates example embodiments of a method for updating a set of vibration fault level states for a set of bearings in a digital twin of a machine. In examples, the machine may be a transportation entity or system. In this example, a client application 217, which interfaces with digital twin dynamic model system 208, may be configured to provide a visualization of the fault level states of the bearings in the digital twin of the machine.

In the example depicted in FIG. 81, the digital twin dynamic model system 208 may receive requests from the client application 217 to update one or more vibration fault level states of a digital twin of a machine. At FIG. 81, system 200, digital twin dynamic model system 208 receives a request from client application 217 to update one or more bearing vibration fault level states of one or more digital twins. Next, in FIG. 81, step 202, digital twin dynamic model system 208 determines the one or more digital twins to fulfill the request and retrieves the one or more digital twins from the digital twin datastore 269. In this example, the digital twin dynamic model system 208 may retrieve the digital twin of the machine and any embedded digital twins, such as any embedded motor digital twins and bearing digital twins, and any digital twins that embed the machine digital twin, such as the transportation system digital twin. At FIG. 81, box 204, digital twin dynamic model system 208 determines one or more dynamic models to fulfill the request and retrieves the one or more dynamic models from the digital twin dynamic model datastore 228. At FIG. 81, box 206, the digital twin dynamic model system 208 selects data sources (e.g., one or more sensors from sensor system 25, data from network connected devices 265, and any other suitable data via digital twin I/O system 204) from a set of available data sources (e.g., available sensors from a set of sensors in sensor system 25) for the one or more inputs of the one or more dynamic models. In the present example, the retrieved one or more dynamic models may take one or more vibration sensor measurements from vibration sensors 235 for input to the one or more dynamic models. In embodiments, vibration sensors 235 may be optical vibration sensors, single axis vibration sensors, tri-axial vibration sensors, and the like. At FIG. 81, box 208, digital twin dynamic model system 208 retrieves data from the selected data sources via the digital twin I/O system 204. Next, at FIG. 81, box 210, the digital twin dynamic model system 208 runs the one or more dynamic models, using the retrieved data as inputs, and calculates one or more output values that represent the one or more bearing vibration fault level state. Next, at FIG. 81, box 212, the digital twin dynamic model system 208 updates one or more bearing vibration fault level states of the one or more digital twins, based on the one or more output values of the one or more dynamic models. The client application 217 may obtain vibration fault level states of the bearings and may display the obtained vibration fault level state associated with each bearing and/or display colors associated with fault level severity (e.g., red for alarm, orange for critical, yellow for suboptimal, green for normal operation) in the rendering of one or more of the digital twins on a display interface.

In another example, a client application 217 may be an augmented reality application. In some embodiments of this example, the client application 217 may obtain vibration fault level states of bearings in a field of view of an AR-enabled device (e.g., smart glasses) hosting the client application from the digital twin of the transportation system (e.g., via an API of the digital twin system 200) and may display the obtained vibration fault level states on the display of the AR-enabled device, such that the vibration fault level state displayed corresponds to the location in the field of view of the AR-enabled device. In this way, a vibration fault level state may be displayed even if there are no vibration sensors located within the field of view of the AR-enabled device.

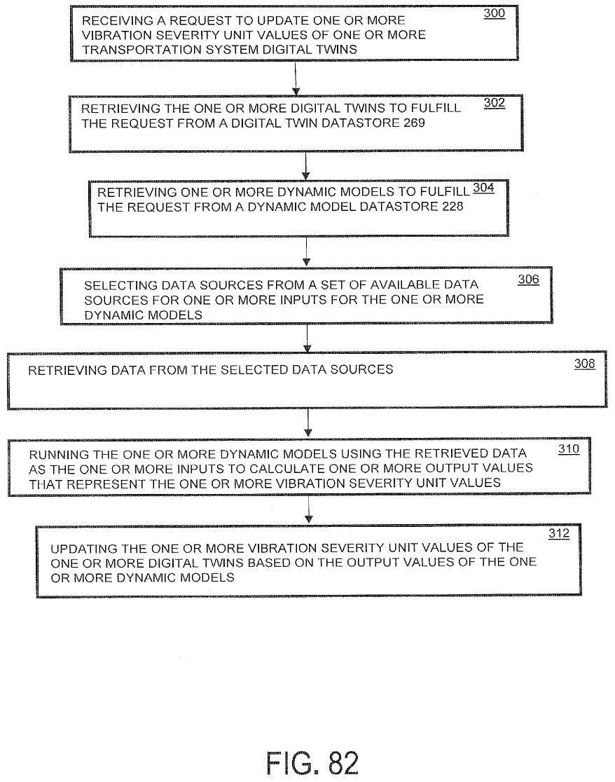

FIG. 82 illustrates example embodiments of a method for updating a set of vibration severity unit values of bearings in a digital twin of a machine. Vibration severity units may be measured as displacement, velocity, and acceleration.

In this example, client application 217 that interfaces with the digital twin dynamic model system 208 may be configured to provide a visualization of the three-dimensional vibration characteristics of bearings in a digital twin of a machine.

In this example, the digital twin dynamic model system 208 may receive requests from client application 217 to update the vibration severity unit values in the digital twin of a transportation system. At FIG. 82, box 300, digital twin dynamic model system 208 receives a request from client application 217 to update one or more vibration severity unit values in one or more digital twins of a transportation system. Next, in FIG. 82, at step 302, a digital twin dynamic model system 208 determines the one or more digital twins required to fulfill the request and retrieves the one or more required digital twins from digital twin datastore 269. In this example, the digital twin dynamic model system 208 may retrieve the one or more digital twins of the transportation system and any embedded digital twins (e.g., digital twins of bearings and other components). At FIG. 82, box 304, digital twin dynamic model system 208 determines one or more dynamic models required to fulfill the request and retrieves the one or more required dynamic models from dynamic model datastore 228. At FIG. 82, box 306, the digital twin dynamic model system 208 selects dynamic model input data sources (e.g., one or more sensors from sensor system 25, data from network connected devices 265, and any other suitable data) via digital twin I/O system 204 based on available data sources (e.g., available sensors from a set of sensors in sensor system 25) and the one or more required inputs of the one or more dynamic models. In the present example, the retrieved dynamic models may be configured to take one or more vibration sensor measurements as inputs and provide severity unit values for bearings in the transportation system. At FIG. 82, box 308, digital twin dynamic model system 208 retrieves data from the selected data sources. For example, the data may be one or more measurements from each of the selected one or more vibration sensors. In the present example, the digital twin dynamic model system 208 retrieves measurements from vibration sensors 235 via digital twin I/O system 204. At FIG. 82, box 310, digital twin dynamic model system 208 runs the one or more dynamic models using the retrieved data as the one or more inputs to calculate one or more output values that represent vibration severity unit values for the one or more digital twins. Next, at FIG. 82, box 312, the digital twin dynamic model system 208 updates the one or more vibration severity unit values in the one or more digital twins and all other embedded digital twins or digital twins that embed the one or more digital twins based on the one or more output values of the one or more dynamic models.

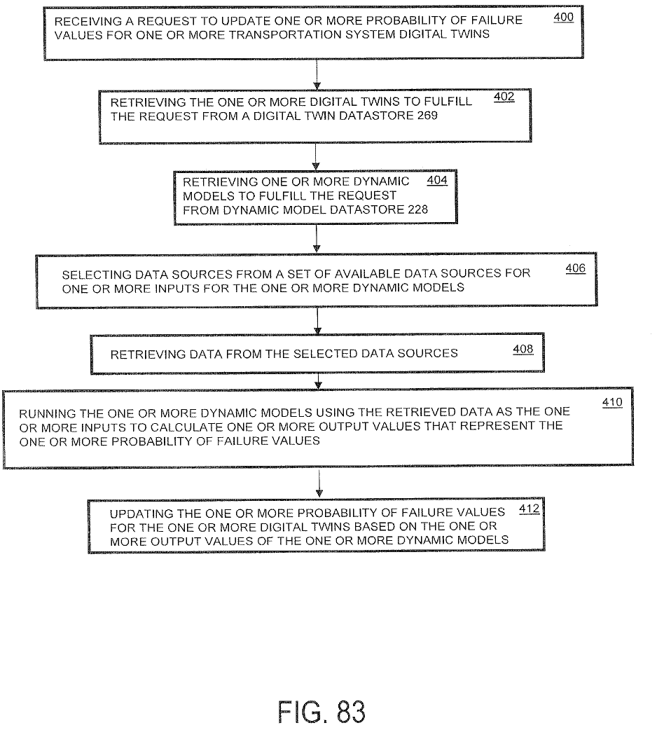

FIG. 83 illustrates example embodiments of a method for updating a set of probability of failure values for machine components in the digital twin of a machine.

In this example, the digital twin dynamic model system 208 may receive requests from client application 217 to update the probability of failure values for one or more digital twins of a transportation system. At FIG. 83, box 400, digital twin dynamic model system 208 receives a request from client application 217 to update one or more probability of failure values for one or more digital twins of a transportation system, any embedded component digital twins, and any digital twins that embed the machine digital twin such as a transportation system digital twin. Next, in FIG. 83, at step 402, digital twin dynamic model system 208 determines the one or more digital twins required to fulfill the request and retrieves the one or more required digital twins. In this example, the digital twin dynamic model system 208 may retrieve the digital twin of the transportation system, the digital twin of the machine, and the digital twins of machine components from digital twin datastore 269. At FIG. 83, box 404, digital twin dynamic model system 208 determines one or more dynamic models required to fulfill the request and retrieves the one or more required dynamic models from dynamic model datastore 228. At FIG. 83, box 406, the digital twin dynamic model system 208 selects, via digital twin I/O system 204, dynamic model input data sources (e.g., one or more sensors from sensor system 25, data from network connected devices 265, historical failure records, and any other suitable data) based on available data sources (e.g., available sensors from a set of sensors in sensor system 25) and the and the one or more required inputs of the dynamic model(s). In the present example, the retrieved dynamic models may take one or more vibration measurements from vibration sensors 235 and historical failure data as dynamic model inputs and output probability of failure values for the machine components in the digital twin of the machine. At FIG. 83, box 408, digital twin dynamic model system 208 retrieves data from each of the selected sensors and/or network connected devices via digital twin I/O system 204. At FIG. 83, box 410, digital twin dynamic model system 208 runs the one or more dynamic models using the retrieved one or more vibration measurements and historical failure data as inputs and calculates one or more output values that represent the probability of failure values for the one or more digital twins. Next, at FIG. 83, box 412, the digital twin dynamic model system 208 updates the one or more probability of failure values of one or more digital twins, all embedded digital twins, and all digital twins that embed the digital twin based on the output values of the one or more dynamic models.

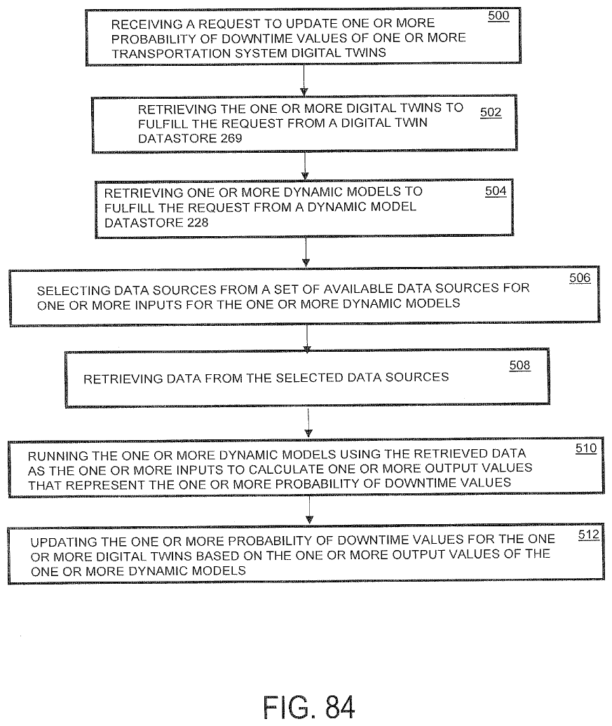

FIG. 84 illustrates example embodiments of a method for updating a set of probability of downtime for machines in one or more digital twins of a transportation system.

In this example, client application 217, which interfaces with the digital twin dynamic model system 208, may be configured to provide a visualization of the probability of downtime values of a transportation system in the one or more digital twins of the transportation system.

In this example, the digital twin dynamic model system 208 may receive requests from a client application 217 to update probability of downtime values of one or more digital twins of a transportation system. At FIG. 84, box 500, the digital twin dynamic model system 208 receives a request from client application 217 to update one or more probability of downtime values of one or more digital twins of a transportation system and any embedded digital twins such as the individual machine digital twins. Next, in FIG. 84, at step 502, digital twin dynamic model system 208 determines the one or more digital twins required to fulfill the request and retrieves the one or more required digital twins from digital twin datastore 269. In this example, the digital twin dynamic model system 208 may retrieve the one or more digital twins of the transportation system and any embedded digital twins from digital twin datastore 269. At FIG. 84, box 504, digital twin dynamic model system 208 determines one or more dynamic models required to fulfill the request and retrieves the one or more required dynamic models from dynamic model datastore 228. At FIG. 84, box 506, the digital twin dynamic model system 208 selects dynamic model input data sources (e.g., one or more sensors from sensor system 25, data from network connected devices 265, and any other suitable data) based on available data sources (e.g., available sensors from a set of sensors in sensor system 25) and the and the one or more required inputs of the one or more dynamic models via digital twin I/O system 204. In the present example, the retrieved one or more dynamic models may be configured to take vibration measurements from vibration sensors and historical downtime data as inputs and output probability of downtime values for different machines throughout the transportation system. At FIG. 84, box 508, digital twin dynamic model system 208 retrieves data from the selected data sources. For example, the retrieved data may be one or more measurements from each of the selected one or more vibration sensors retrieved via digital twin I/O system 204. At FIG. 84, box 510, digital twin dynamic model system 208 runs the one or more dynamic models using the retrieved data as the one or more inputs to calculate one or more output values that represent the one or more probability of downtime values. In examples, the retrieved data may include vibration measurements and historical downtime data. Next, at FIG. 84, box 512, the digital twin dynamic model system 208 updates one or more probability of downtime values for the machines in the one or more digital twins and all embedded digital twins based on the one or more output values of the dynamic models.

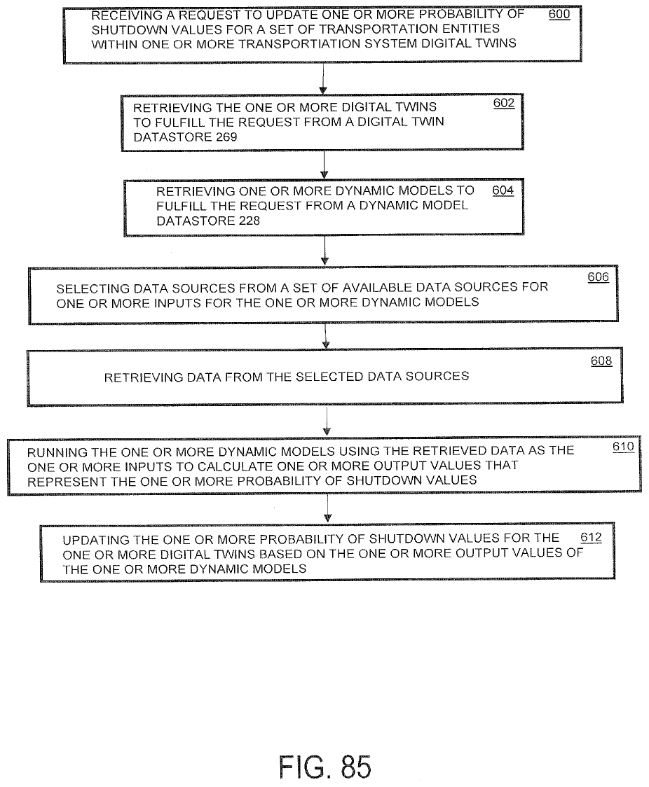

FIG. 85 illustrates example embodiments of a method for updating one or more probability of shutdown values in the one or more digital twins of a transportation system having a set of transportation entities.

In the present example, the digital twin dynamic model system 208 may receive requests from client application 217 to update the probability of shutdown values for the set of transportation entities within one or more digital twins of a transportation system. For example, the transportation entities may be relatively large entities like refueling centers that could lead to a shutdown of large portions of the transportation system. At FIG. 85, box 600, digital twin dynamic model system 208 receives a request from client application 217 to update one or more probability of shutdown values of the one or more digital twins and any embedded digital twins. Next, in FIG. 85, at step 602, digital twin dynamic model system 208 determines the one or more digital twins required to fulfill the request and retrieves the one or more required digital twins from digital twin datastore 269. In this example, the digital twin dynamic model system 208 may retrieve the one or more digital twins of the transportation system and any embedded digital twins. At FIG. 85, box 604, digital twin dynamic model system 208 determines one or more dynamic models required to fulfill the request and retrieves the one or more required dynamic models from dynamic model datastore 228. At FIG. 85, box 606, the digital twin dynamic model system 208 selects dynamic model input data sources (e.g., one or more sensors from sensor system 25, data from network connected devices 265, and any other suitable data) based on available data sources (e.g., available sensors from a set of sensors in sensor system 25) and the and the one or more required inputs of the one or more dynamic models via digital twin I/O system 204. In the present example, the retrieved one or more dynamic models may be configured to take one or more vibration measurements from one or more vibration sensors 235 and/or other suitable data as inputs and output probability of shutdown values for each transportation entity in the one or more digital twins of the transportation system. At FIG. 85, box 608, digital twin dynamic model system 208 retrieves data from the selected data sources. For example, the retrieved data may be one or more vibration measurements from each of the selected vibration sensors 235 retrieved via digital twin I/O system 204. At FIG. 85, box 610, digital twin dynamic model system 208 runs the one or more dynamic models using the retrieved data as the one or more inputs to calculate one or more output values that represent the one or more probability of shutdown values. In examples, the retrieved data may include vibration measurements and historical shutdown data. Next, at FIG. 85, box 612, the digital twin dynamic model system 208 updates one or more probability of shutdown values of the one or more digital twins and all embedded digital twins based on the one or more output values of the one or more dynamic models.

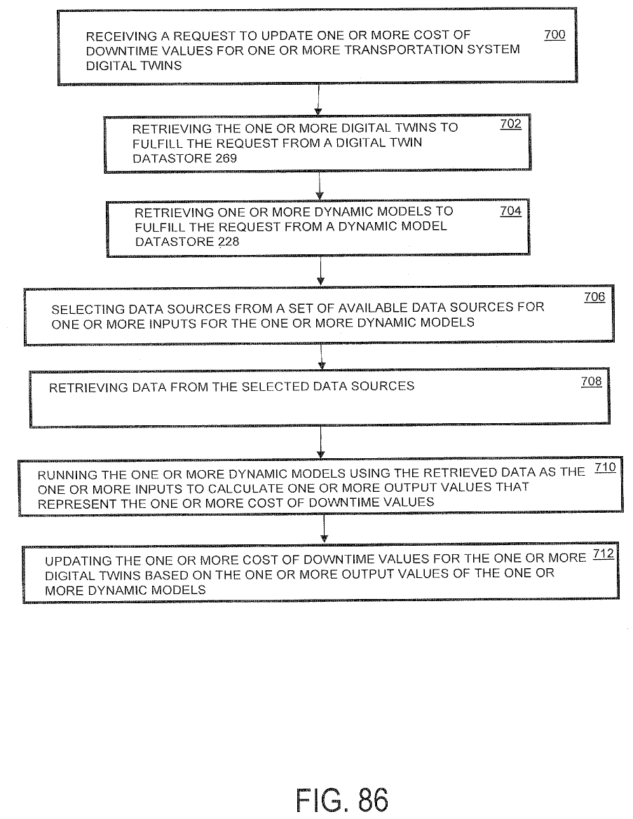

FIG. 86 illustrates example embodiments of a method for updating a set of cost of downtime values in machines in one or more digital twins of a transportation system.

In the present example, the digital twin dynamic model system 208 may receive requests from a client application 217 to populate real-time cost of downtime values associated with machines in one or more digital twins of a transportation system. At FIG. 86, interface 700, digital twin dynamic model system 208 receives a request from the client application 217 to update one or more cost of downtime values of one or more digital twins and any embedded digital twins (e.g., machines, machine parts, and the like) from the client application 217. Next, in FIG. 86, at step 702, the digital twin dynamic model system 208 determines the one or more digital twins required to fulfill the request and retrieves the one or more required digital twins. In this example, the digital twin dynamic model system 208 may retrieve the digital twins of the transportation system, the machines, the machine parts, and any other embedded digital twins from digital twin datastore 269. At FIG. 86, box 704, digital twin dynamic model system 208 determines one or more dynamic models required to fulfill the request and retrieves the one or more required dynamic models from dynamic model datastore 228. At FIG. 86, box 706, the digital twin dynamic model system 208 selects dynamic model input data sources (e.g., one or more sensors from sensor system 25, data from network connected devices 265, and any other suitable data) based on available data sources (e.g., available sensors from a set of sensors in sensor system 25) and the and the one or more required inputs of the one or more dynamic models via digital twin I/O system 204. In the present example, the retrieved one or more dynamic models may be configured to take historical downtime data and operational data as inputs and output data representing cost of downtime per day for machines in the transportation system. At FIG. 86, box 708, digital twin dynamic model system 208 retrieves data from the selected data sources. For example, the retrieved data may be historical downtime data and operational data retrieved via digital twin I/O system 204. At FIG. 86, box 710, digital twin dynamic model system 208 runs the at least one dynamic models using the retrieved data as the one or more inputs to calculate one or more output values that represent a cost of downtime. In examples, the retrieved data may include historical downtime data and operational data. In examples, the cost of downtime may be a cost of downtime per day for machines in the transportation system. Next, at FIG. 86, box 712, the digital twin dynamic model system 208 updates the one or more cost of downtime values of the one or more digital twins and the digital twins of all embedded digital twins based on the one or more output values of the one or more dynamic models.

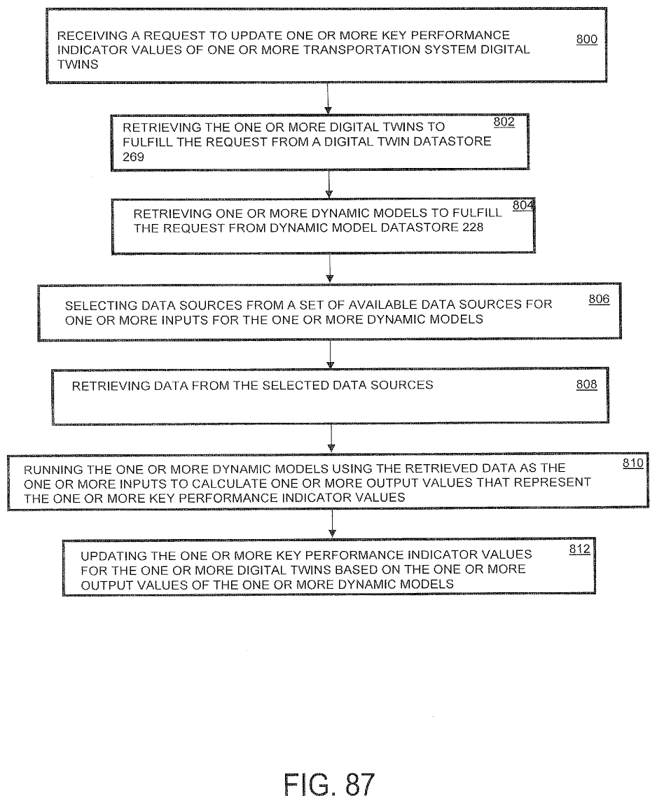

FIG. 87 illustrates example embodiments of a method for updating a set of KPI values in the digital twin of a transportation system. In embodiments, the KPI is selected from the group consisting of uptime, capacity utilization, on standard operating efficiency, overall operating efficiency, overall equipment effectiveness, machine downtime, unscheduled downtime, machine set up time, inventory turns, inventory accuracy, quality (e.g., percent defective), first pass yield, rework, scrap, failed audits, on-time delivery, customer returns, training hours, employee turnover, reportable health & safety incidents, revenue per employee, profit per employee, schedule attainment, total cycle time, throughput, changeover time, yield, planned maintenance percentage, availability, and customer return rate.

In the present example, the digital twin dynamic model system 208 may receive requests from a client application 217 to update real-time KPI values in one or more digital twins of a transportation system. At FIG. 87, box 800, digital twin dynamic model system 208 receives a request from the client application 217 to update one or more KPI values of the one or more digital twins and any embedded digital twins (e.g., machines, machine parts, and the like) from the client application 217. Next, in FIG. 87, at step 802, the digital twin dynamic model system 208 determines the one or more digital twins required to fulfill the request and retrieves the one or more required digital twins. In this example, the digital twin dynamic model system 208 may retrieve the one or more digital twins of the transportation system, the machines, the machine parts, and any other embedded digital twins from digital twin datastore 269. At FIG. 87, box 804, digital twin dynamic model system 208 determines one or more dynamic models required to fulfill the request and retrieves the one or more required dynamic models from the dynamic model datastore 228. At FIG. 87, box 806, the digital twin dynamic model system 208 selects dynamic model input data sources (e.g., one or more sensors from sensor system 25, data from network connected devices 265, and any other suitable data) based on available data sources (e.g., available sensors from a set of sensors in sensor system 25) and the and the one or more required inputs of the one or more dynamic models via a digital twin I/O system 204. In the present example, the retrieved one or more dynamic models may be configured to take one or more vibration measurements obtained from one or more vibration sensors 235 and operational data as inputs and output one or more KPI values for the transportation system. At FIG. 87, box 808, digital twin dynamic model system 208 retrieves data from the selected data sources. For example, the retrieved data may be one or more vibration measurements from each of the selected one or more vibration sensors 235 and operational data retrieved via digital twin I/O system 204. At FIG. 87, box 810, digital twin dynamic model system 208 runs the one or more dynamic models using the retrieved data as the one or more inputs to calculate one or more output values that represent KPI values. In examples, the retrieved data may include vibration measurements and operational data. Next, at FIG. 87, box 812, the digital twin dynamic model system 208 updates one or more KPI values of the one or more digital twins, machine digital twins, machine part digital twins, and all other embedded digital twins based on the one or more output values of the one or more dynamic models.

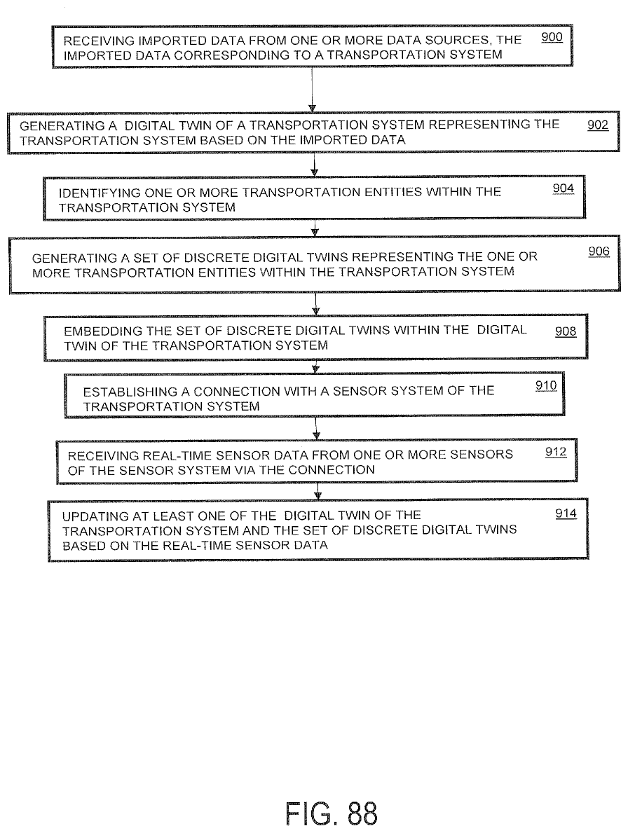

FIG. 88 illustrates examples of a method of the present disclosure. At FIG. 88, box 900, the method includes: receiving imported data from one or more data sources, the imported data corresponding to a transportation system. At FIG. 88, box 902 is: generating a digital twin of a transportation system representing the transportation system based on the imported data. At FIG. 88, box 904 is: identifying one or more transportation entities within the transportation system. At FIG. 88, box 906 is: generating a set of discrete digital twins representing the one or more transportation entities within the transportation system. At FIG. 88, box 908 is: embedding the set of discrete digital twins within the digital twin of the transportation system. At FIG. 88, vehicle 910 is: establishing a connection with a sensor system of the transportation system. At FIG. 88, box 912 is: receiving real-time sensor data from one or more sensors of the sensor system via the connection. At FIG. 88, box 914 is: updating at least one of the digital twin of the transportation system and the set of discrete digital twins based on the real-time sensor data.

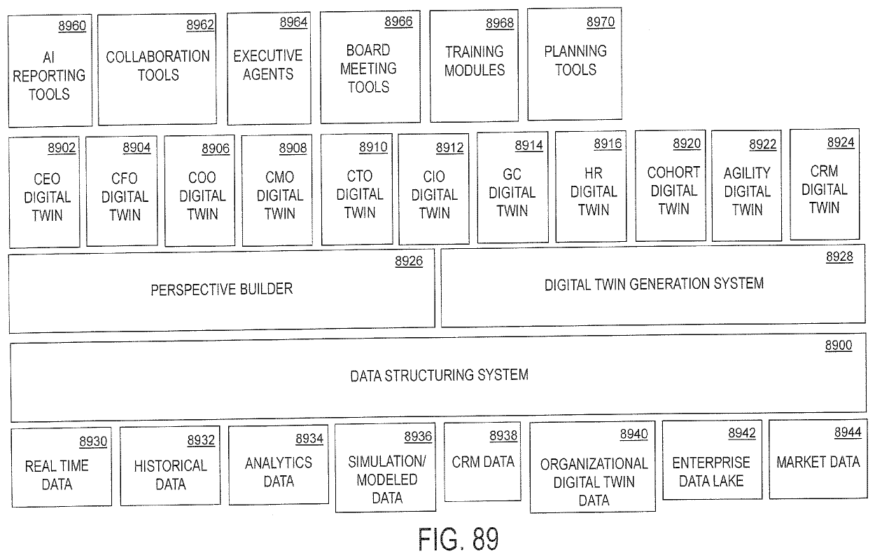

FIG. 89 illustrates examples of different types of enterprise digital twins, including executive digital twins, in relation to the data layer, processing layer, and application layer of an enterprise digital twin framework. In embodiments, executive digital twins may include, but are not limited to, CEO digital twins 8902, CFO digital twins 8904, COO digital twins 8906, CMO digital twins 8908, CTO digital twins 8910, CIO digital twins 8912, GC digital twins 8914, HR digital twins 8916, and the like. Additionally, the enterprise digital twins that may be relevant to the executive suite may include cohort digital twins 8920, agility digital twins 8922, Customer Relationship Management (CRM) digital twins 8924, and the like. The discussion of the different types of digital twins is provided for example and not intended to limit the scope of the disclosure. It is understood that in some embodiments, users may alter the configuration of the various executive digital twins based on the business needs of the enterprise, the reporting structure of the enterprise, and the roles and responsibilities of the various executives within the enterprise.

In embodiments, executive digital twins and the additional enterprise digital twins are generated using various types of data collected from different data sources. As discussed, the data may include real-time data 8930, historical data 8932, analytics data 8934, simulation/modeled data 8936, CRM data 8938, organizational data, such as org charts and/or an organizational digital twin 8940, an enterprise data lake 8942, and market data 8944. In embodiments, the real-time data 8930 may include sensor data collected from, for example, sensor systems 25 as depicted in FIG. 75. In embodiments, the real-time data 8930 may include sensor data collected from one or more IoT sensor systems, which may be collected directly from each sensor and/or by various data collection devices associated with the enterprise, including readers (e.g., RFID, NFC, and Bluetooth readers), beacons, gateways, repeaters, mesh network nodes, WIFI systems, access points, routers, switches, gateways, local area network nodes, edge devices, and the like. Real-time data 8930 may include additional or alternative types of data that are collected in real-time, such as real-time sales data, real-time cost data, project management data that indicates the status of current projects, and the like. Historical data 8932 may be any data collected by the enterprise and/or on behalf of the enterprise in the past. This may include sensor data collected from the sensor systems of the enterprise, sales data, cost data, maintenance data, purchase data, employee hiring data, employee on-boarding data, employee retention data, legal-related data indicating legal proceedings, patent filing data indicating patent filings and issued patents, project management data indicating historical progress of past and current projects, product data indicating products that are on the market, and the like. Analytics data 8934 may be data derived by performing one or more analytics processes on data collected by and/or on behalf of the enterprise. Simulation/modeled data 8936 may be any data derived from simulation and/or behavior modeling processes that are performed with respect to one or more digital twins. CRM data 8936 may include data obtained from a CRM of the enterprise. An organizational digital twin 8940 may be a digital twin of the enterprise. The enterprise data lake 8942 may be a data lake that includes data collected from any number of sources. In embodiments, the market data 8942 may include data that is collected from disparate data sources concerning or related to competitors and other cohorts in the marketplace and supply chain. Market data 8942 may be collected from many different sources and may be structured or unstructured. In embodiments, market data 8942 may contain an element of uncertainty that may be depicted in a digital twin that relies on such market data 8942, such as by showing error bars, probability cones, random walk paths, or the like. It is appreciated that the different types of data highlighted above may overlap. For example, historical data 8932 may be obtained from the CRM data 8938; the enterprise data lake 8942 may include real-time data 8930, historical data 8932, analytics data 8932, simulated/modeled data 8936, and/or CRM data 8938; and analytics data 8934 may be based on historical data 8932, real-time data 8932, CRM data 8938, and/or market data 8942. Additional or alternative types of data may be used to populate an enterprise digital twin.

In embodiments, the data structuring system 8900 may structure the various data collected by and/or on behalf of the enterprise. In embodiments, the digital twin generation system 8928 generates the enterprise digital twins. As discussed, the digital twin generation system 8928 may receive a request for a particular type of digital twin (e.g., a CEO digital twin 8902 or a CTO digital twin 8910) and may determine the types of data needed to populate the digital twin based on the configuration of the requested type of digital twin. In embodiments, the digital twin generation system 8928 may then generate the requested digital twin based on the various types of data (which may include structured data structured by the data structuring system 8900). In some embodiments, the digital twin generation system 8928 may output the generated digital twin to a client application 217, which may then display the requested digital twins.

In embodiments, a CEO digital twin 8902 is a digital twin configured for the CEO or analogous top-level decision maker of an enterprise. The CEO digital twin 8902 may include high-level views of different states and/or operations data of the enterprise, including real-time and historical representations of major assets, processes, divisions, performance metrics, the condition of different business units of the enterprise, and any other mission-critical information type. In embodiments, the CEO digital twin 8902 may provide simulations, predictions, statistical summaries, decision-support based on analytics, machine learning, and/or other AI and learning-type processing of inputs (e.g., fiscal data, competitor data, product data, and the like). In embodiments, a CEO digital twin 8902 may provide functionality including, but not limited to, management of personnel, delegation of tasks, decisions, or tasks, coordination with the Board of Directors and/or strategic partners, risk management, policy management, oversight of budgets, resource allocation, investments, and other executive-related resources.

In embodiments, the types of data that may populate a CEO digital twin 8902 may include, but are not limited to: macroeconomic data, microeconomic analytic data, forecast data, demand planning data, employment and salary data, analytic results of AI and/or machine learning modeling.

In embodiments, the digital twin perspective builder 8926 leverages metadata, artificial intelligence, and/or other data processing techniques to produce a definition of information required for generation of the digital twin in the digital twin generation system 8928. In some embodiments, different relevant datasets are hooked to a digital twin (e.g., an executive digital twin, an environment digital twin, or the like) at the appropriate level of granularity, thereby allowing for the structural aspects of the data (e.g., system of accounts, sensor readings, sales data, or the like) to be a part of the data analytics process. One aspect of making a perspective function is that the user can change the structural view or the granularity of data while potentially forecasting future events or changes to the structure to guide control of the area of the business at question. In embodiments, the term “granularity” or “grain of data” may refer to a single line of data, a single byte of data, a single file, a single instance, or the like. Examples of “grains of data” or highly granular data may include a detail record on a sale, a single block in a blockchain in a distributed ledger, a single event in an event log, a single vibration reading from a vibration sensor, or similar singular or atomic data units, and the like. Grain or atomicity may impose a constraint in how the data can be combined or processed to form different outputs. For example, if some element of data is captured only at the level of once-per-day, then it can only be broken down to single days (or aggregation of days) and cannot be broken down to hours or minutes, unless derived from the day representation (e.g., using inference techniques and/or models). Similarly, if data is provided only at the aggregate business unit level, it can be broken down to the level of an individual employee only by, for example, averaging, modeling, or inductive functions. Role-based and other enterprise digital twins may benefit from finer levels of data, as aggregations and other processing steps may produce outputs that are dynamic in nature and/or that relate to dynamic processes and/or real-time decision-making. It is noted that different types of digital twins may have different “sized” grains of data. For example, the grains of data that feed a CEO digital twin may be at a different granularity level than the grains of data that feed a COO digital twin. In some embodiments, however, a CEO may drill down into a state of the CEO digital twin and the granularity for the selected state may be increased.

In embodiments, the executive digital twins may link to, interact with, integrate with and/or be used by a number of different applications. For example, the executive digital twins may be used in automated A1-reporting tools 8960, collaboration tools 8962, in connection with executive agents 8964, in board meeting tools 8966, for training modules 8968, and for planning tools 8970.

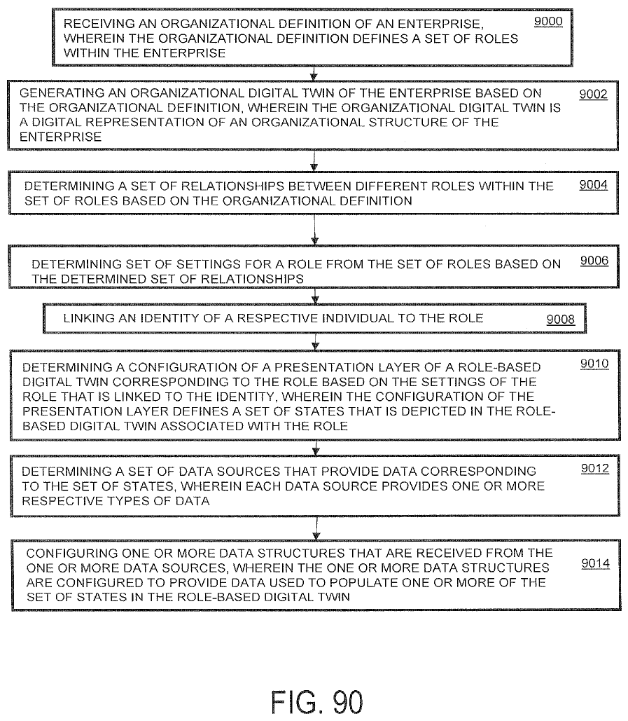

FIG. 90 illustrates example embodiments of a method for configuring role-based digital twins. At FIG. 90, box 9000, a processing system having one or more processors receives an organizational definition of an enterprise, wherein the organizational definition defines a set of roles within the enterprise. In this example, the organizational definition may further identify a set of physical assets of the enterprise. Next, in FIG. 90, at step 9102, the processing system generates an organizational digital twin of the enterprise based on the organizational definition, wherein the organizational digital twin is a digital representation of an organizational structure of the enterprise. In some examples, the organizational structure includes hierarchical components. In some examples, the hierarchical components are embodied in a graph data structure. At FIG. 90, box 9004, the processing system determines a set of relationships between different roles within the set of roles based on the organizational definition. In this example, determining the set of relationships may include parsing the organizational definition to identify a reporting structure and one or more business units of the enterprise. The set of relationships may be inferred from the reporting structure and the business units. At FIG. 90, box 9006, the processing system determines a set of settings for a role from the set of roles based on the determined set of relationships. At FIG. 90, box 9008, is linking an identity of a respective individual to the role. Some examples further include linking a set of identities to the set of roles, wherein each identity corresponds to a respective role from the set of roles. At FIG. 90, box 9010, the processing system determines a configuration of a presentation layer of a role-based digital twin corresponding to the role based on the settings of the role that is linked to the identity, wherein the configuration of the presentation layer defines a set of states that is depicted in the role-based digital twin associated with the role. Next, at FIG. 90, box 9012, the processing system determines a set of data sources that provide data corresponding to the set of states, wherein each data source provides one or more respective types of data. At FIG. 90, box 9014 is configuring one or more data structures that are received from the one or more data sources, wherein the one or more data structures are configured to provide data used to populate one or more of the set of states in the role-based digital twin.

In examples, the set of settings for the set of roles may include role-based preference settings. In some examples, the role-based preference settings may be configured based on a set of role-specific templates. In some examples, the set of templates may include at least one of a CEO template, a COO template, a CFO template, a counsel template, a board member template, a CTO template, a chief marketing officer template, an information technology manager template, a chief information officer template, a chief data officer template, an investor template, a customer template, a vendor template, a supplier template, an engineering manager template, a project manager template, an operations manager template, a sales manager template, a salesperson template, a service manager template, a maintenance operator template, and a business development template.

In some examples, the set of settings for the set of roles may include role-based taxonomy settings. In some examples, the taxonomy settings may identify a taxonomy that is used to characterize data that is presented in the role-based digital twin, such that the data is presented in a taxonomy that is linked to the role corresponding to the role-based digital twin. In some examples, the taxonomy may include at least one of a CEO taxonomy, a COO taxonomy, a CFO taxonomy, a counsel taxonomy, a board member taxonomy, a CTO taxonomy, a chief marketing officer taxonomy, an information technology manager taxonomy, a chief information officer taxonomy, a chief data officer taxonomy, an investor taxonomy, a customer taxonomy, a vendor taxonomy, a supplier taxonomy, an engineering manager taxonomy, a project manager taxonomy, an operations manager taxonomy, a sales manager taxonomy, a salesperson taxonomy, a service manager taxonomy, a maintenance operator taxonomy, and a business development taxonomy.

In examples, at least one role of the set of roles may be selected from among a CEO role, a COO role, a CFO role, a counsel role, a board member role, a CTO role, an information technology manager role, a chief information officer role, a chief data officer role, a human resources manager role, an investor role, an engineering manager role, an accountant role, an auditor role, a resource planning role, a public relations manager role, a project manager role, an operations manager role, a research and development role, an engineer role, including but not limited to mechanical engineer, electrical engineer, semiconductor engineer, chemical engineer, computer science engineer, data science engineer, network engineer, or some other type of engineer, and a business development role. In examples, the at least one role may be selected from among a factory manager role, a factory operations role, a factory worker role, a power plant manager role, a power plant operations role, a power plant worker role, an equipment service role, and an equipment maintenance operator role. In examples, the at least one role may be selected from among a chief marketing officer role, a product development role, a supply chain manager role, a product design role, a marketing analyst role, a product manager role, a competitive analyst role, a customer service representative role, a procurement operator, an inbound logistics operator, an outbound logistics operator, a customer role, a supplier role, a vendor role, a demand management role, a marketing manager role, a sales manager role, a service manager role, a demand forecasting role, a retail manager role, a warehouse manager role, a salesperson role, and a distribution center manager role.

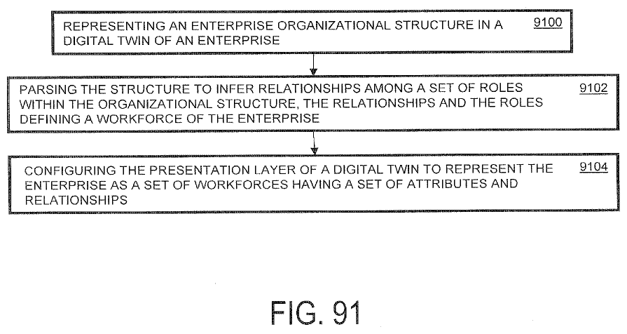

FIG. 91 illustrates example embodiments of a method for configuring a digital twin of a workforce. At FIG. 91, box 9100, the method includes representing an enterprise organizational structure in a digital twin of an enterprise. Next, in FIG. 91, at step 9102, the method includes parsing the structure to infer relationships among a set of roles within the organizational structure, the relationships and the roles defining a workforce of the enterprise. At FIG. 91, box 9104, the method includes configuring the presentation layer of a digital twin to represent the enterprise as a set of workforces having a set of attributes and relationships. In examples, the digital twin integrates with an enterprise resource planning system that operates on a data structure representing a set of roles in the enterprise, such that changes in the enterprise resource planning system are automatically reflected in the digital twin, wherein the organizational structure includes hierarchical components. In examples, the hierarchical components may be embodied in a graph data structure. In examples, the workforce may be a factory operations workforce. In examples, the workforce may be a plant operations workforce. In examples, the workforce may be a resource extraction operations workforce. In examples, at least one workforce role may be selected from among a CEO role, a COO role, a CFO role, a counsel role, a board member role, a CTO role, an information technology manager role, a Chief information officer role, a chief data officer role, an investor role, an engineering manager role, a project manager role, an operations manager role, and a business development role. In examples, the digital twin provides a recommendation for configuration of the workforce.

### Quantum Computing

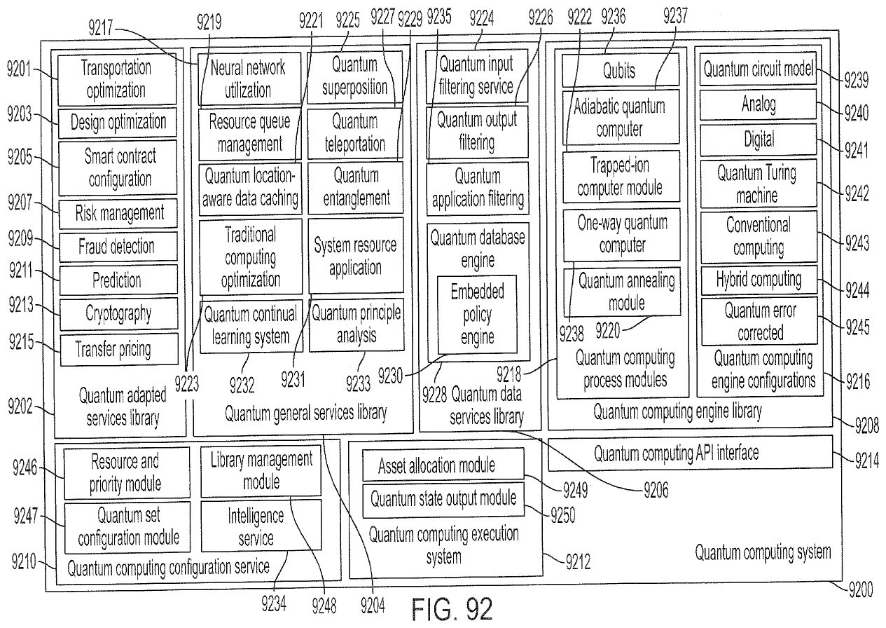

FIG. 92 illustrates an example quantum computing system 9200 according to some embodiments of the present disclosure that may be used in conjunction with the transportation system, as described herein. In embodiments, the quantum computing system 9200 provides a framework for providing a set of quantum computing services to one or more quantum computing clients, including clients within the transportation system, including clients associated with one or more vehicles 110, which may include various mechanical, electrical, and software components and systems, such as a powertrain 113, a suspension system 117, a steering system, a braking system, a fuel system, a charging system, seats 128, a combustion engine, an electric vehicle drive train, a transmission 119, a gear set, and the like. The vehicle may have a vehicle user interface 123, which may include a set of interfaces that include a steering system, buttons, levers, touch screen interfaces, audio interfaces, and the like as described throughout this disclosure. In some embodiments, the quantum computing system 9200 framework may be at least partially replicated in respective quantum computing clients. In these embodiments, an individual client may include some or all of the capabilities of the quantum computing system 9200, whereby the quantum computing system 9200 is adapted for the specific functions performed by the subsystems of the quantum computing client. Additionally, or alternatively, in some embodiments, the quantum computing system 9200 may be implemented as a set of microservices, such that different quantum computing clients may leverage the quantum computing system 9200 via one or more APIs exposed to the quantum computing clients. In these embodiments, the quantum computing system 9200 may be configured to perform various types of quantum computing services that may be adapted for different quantum computing clients. In either of these configurations, a quantum computing client may provide a request to the quantum computing system 9200, whereby the request is to perform a specific task (e.g., an optimization). In response, the quantum computing system 9200 executes the requested task and returns a response to the quantum computing client.

Referring to FIG. 92, in some embodiments, the quantum computing system 9200 may include a quantum adapted services library 9202, a quantum general services library 9204, a quantum data services library 9206, a quantum computing engine library 9208, a quantum computing configuration service 9210, a quantum computing execution system 9212, and quantum computing API interface 9214.

In embodiments, the quantum adapted services library 9202 includes transportation optimization 9201, design optimization 9203, smart contract configuration 9205, risk management 9207, fraud detection 9209, prediction 9211, cryptography 9213, and transfer pricing 9215.

In embodiments, the quantum general services library 9204 includes quantum continual learning system 9232, neural network utilization 9217, resource queue management 9219, quantum location-aware data caching 9221, traditional computing optimization 9223, quantum superposition 9225, quantum teleportation 9227, quantum entanglement 9229, system resource application 9231, and quantum principle analysis 9233. In embodiments, the quantum computing execution system 9212 includes asset allocation module 9249 and quantum state output module 9250.

In embodiments, the quantum data services library 9206 includes quantum input filtering service 9224, quantum output filtering 9226, quantum application filtering 9235, and quantum database engine 9228. In embodiments, the quantum computing process modules 9218 include qubits 9236, adiabatic quantum computer 9237, trapped-ion computer module 9222, on-way quantum computer 9238, and quantum annealing module 9220. In embodiments, the quantum computing engine configurations 9216 include quantum circuit modeling 9239, analog configurations 9240, digital configurations 9241, quantum Turing machine 9242, conventional computing 9243, hybrid computing 9244, and quantum error corrected 9245.

In embodiments, the quantum computing engine library 9208 includes quantum computing engine configurations 9216 and quantum computing process modules 9218 based on various supported quantum models. In embodiments, the quantum computing system 9200 may support many different quantum models, including, but not limited to, the quantum circuit model, quantum Turing machine, adiabatic quantum computer, spintronic computing system (such as using spin-orbit coupling to generate spin-polarized electronic states in non-magnetic solids, such as ones using diamond materials), one-way quantum computer, quantum annealing, and various quantum cellular automata. Under the quantum circuit model, quantum circuits may be based on the quantum bit, or “qubit”, which is somewhat analogous to the bit in classical computation. Qubits may be in a 1 or 0 quantum state or they may be in a superposition of the 1 and 0 states. However, when qubits have measured the result of a measurement, qubits will always be in is always either a 1 or 0 quantum state. The probabilities related to these two outcomes depend on the quantum state that the qubits were in immediately before the measurement. Computation is performed by manipulating qubits with quantum logic gates, which are somewhat analogous to classical logic gates.

In embodiments, the quantum computing system 9200 may be physically implemented using an analog approach or a digital approach. Analog approaches may include, but are not limited to, quantum simulation, quantum annealing, and adiabatic quantum computation. In embodiments, digital quantum computers use quantum logic gates for computation. Both analog and digital approaches may use quantum bits, or qubits.

In embodiments, the quantum computing system 9200 includes a quantum annealing module 9220 wherein the quantum annealing module may be configured to find the global minimum or maximum of a given objective function over a given set of candidate solutions (e.g., candidate states) using quantum fluctuations. As used herein, quantum annealing may refer to a meta-procedure for finding a procedure that identifies an absolute minimum or maximum, such as a size, length, cost, time, distance or other measure, from within a possibly very large, but finite, set of possible solutions using quantum fluctuation-based computation instead of classical computation. The quantum annealing module 9220 may be leveraged for problems where the search space is discrete (e.g., combinatorial optimization problems) with many local minima, such as finding the ground state of a spin glass or the traveling salesman problem.

In embodiments, the quantum annealing module 9220 starts from a quantum-mechanical superposition of all possible states (candidate states) with equal weights. The quantum annealing module 9220 may then evolve, such as following the time-dependent Schrödinger equation, a natural quantum-mechanical evolution of systems (e.g., physical systems, logical systems, or the like). In embodiments, the amplitudes of all candidate states change, realizing quantum parallelism according to the time-dependent strength of the transverse field, which causes quantum tunneling between states. If the rate of change of the transverse field is slow enough, the quantum annealing module 9220 may stay close to the ground state of the instantaneous Hamiltonian. If the rate of change of the transverse field is accelerated, the quantum annealing module 9220 may leave the ground state temporarily but produce a higher likelihood of concluding in the ground state of the final problem energy state or Hamiltonian.

In embodiments, the quantum computing system 9200 may include arbitrarily large numbers of qubits and may transport ions to spatially distinct locations in an array of ion traps, building large, entangled states via photonically connected networks of remotely entangled ion chains.

In some implementations, the quantum computing system 9200 includes a trapped ion computer module 9222, which may be a quantum computer that applies trapped ions to solve complex problems. Trapped ion computer module 9222 may have low quantum decoherence and may be able to construct large solution states. Ions, or charged atomic particles, may be confined and suspended in free space using electromagnetic fields. Qubits are stored in stable electronic states of each ion, and quantum information may be transferred through the collective quantized motion of the ions in a shared trap (interacting through the Coulomb force). Lasers may be applied to induce coupling between the qubit states (for single-qubit operations) or coupling between the internal qubit states and the external motional states (for entanglement between qubits).

In embodiments, a traditional computer, including a processor, memory, and a graphical user interface (GUI), may be used for designing, compiling, and providing output from the execution and the quantum computing system 9200 may be used for executing the machine language instructions. In embodiments, the quantum computing system 9200 may be simulated by a computer program executed by the traditional computer. In such embodiments, a superposition of states of the quantum computing system 9200 can be prepared based on input from the initial conditions. Since the initialization operation available in a quantum computer can only initialize a qubit to either the |0> or |1> state, initialization to a superposition of states is physically unrealistic. For simulation purposes, however, it may be useful to bypass the initialization process and initialize the quantum computing service directly.

In some embodiments, the quantum computing system 9200 provides various quantum data services, including quantum input filtering, quantum output filtering, quantum application filtering, and a quantum database engine.

In embodiments, the quantum computing system 9200 may include a quantum input filtering service 9224. In embodiments, quantum input filtering service 9224 may be configured to select whether to run a model on the quantum computing system 9200 or to run the model on a classic computing system. In some embodiments, quantum input filtering service 9224 may filter data for later modeling on a classic computer. In embodiments, the quantum computing system 9200 may provide input to traditional compute platforms while filtering out unnecessary information from flowing into distributed systems. In some embodiments, the platform 9200 may trust through filtered specified experiences for intelligent agents.

In embodiments, a system in the system of systems may include a model or system for automatically determining, based on a set of inputs, whether to deploy quantum computational or quantum algorithmic resources to an activity, whether to deploy traditional computational resources and algorithms, or whether to apply a hybrid or combination of them. In embodiments, inputs to a model or automation system may include demand information, supply information, financial data, energy cost information, capital costs for computational resources, development costs (such as for algorithms), energy costs, operational costs (including labor and other costs), performance information on available resources (quantum and traditional), and any of the many other data sets that may be used to simulate (such as using any of a wide variety of simulation techniques described herein and/or in the documents incorporated herein by refence) and/or predict the difference in outcome between a quantum-optimized result and a non-quantum-optimized result. A machine learned model (including in a DPANN system) may be trained, such as by deep learning on outcomes or by a data set from human expert decisions, to determine what set of resources to deploy given the input data for a given request. The model may itself be deployed on quantum computational resources and/or may use quantum algorithms, such as quantum annealing, to determine whether, where and when to use quantum systems, conventional systems, and/or hybrids or combinations.

In embodiments, the quantum computing system 9200 may include a quantum output filtering service 9226. In embodiments, the quantum output filtering service 9226 may be configured to select a solution from solutions of multiple neural networks. For example, multiple neural networks may be configured to generate solutions to a specific problem and the quantum output filtering service 9226 may select the best solution from the set of solutions.

In some embodiments, the quantum computing system 9200 connects and directs a neural network development or selection process. In this embodiment, the quantum computing system 9200 may directly program the weights of a neural network such that the neural network gives the desired outputs. This quantum-programmed neural network may then operate without the oversight of the quantum computing system 9200 but will still be operating within the expected parameters of the desired computational engine.

In embodiments, the quantum computing system 9200 includes a quantum database engine 9228. In embodiments, the quantum database engine 9228 is configured with in-database quantum algorithm execution. In embodiments, a quantum query language may be employed to query the quantum database engine 9228. In some embodiments, the quantum database engine may have an embedded policy engine 9230 for prioritization and/or allocation of quantum workflows, including prioritization of query workloads, such as based on overall priority as well as the comparative advantage of using quantum computing resources versus others. In embodiments, quantum database engine 9228 may assist with the recognition of entities by establishing a single identity for that is valid across interactions and touchpoints. The quantum database engine 9228 may be configured to perform optimization of data matching and intelligent traditional compute optimization to match individual data elements. The quantum computing system 9200 may include a quantum data obfuscation system for obfuscating data.

The quantum computing system 9200 may include, but is not limited to, analog quantum computers, digital computers, and/or error-corrected quantum computers. Analog quantum computers may directly manipulate the interactions between qubits without breaking these actions into primitive gate operations. In embodiments, quantum computers that may run analog machines include, but are not limited to, quantum annealers, adiabatic quantum computers, and direct quantum simulators. The digital computers may operate by carrying out an algorithm of interest using primitive gate operations on physical qubits. Error-corrected quantum computers may refer to a version of gate-based quantum computers made more robust through the deployment of quantum error correction (QEC), which enables noisy physical qubits to emulate stable logical qubits so that the computer behaves reliably for any computation. Further, quantum information products may include, but are not limited to, computing power, quantum predictions, and quantum inventions.

In some embodiments, the quantum computing system 9200 is configured as an engine that may be used to optimize traditional computers, integrate data from multiple sources into a decision-making process, and the like. The data integration process may involve real-time capture and management of interaction data by a wide range of tracking capabilities, both directly and indirectly related to value chain network activities. In embodiments, the quantum computing system 9200 may be configured to accept cookies, email addresses and other contact data, social media feeds, news feeds, event and transaction log data (including transaction events, network events, computational events, and many others), event streams, results of web crawling, distributed ledger information (including blockchain updates and state information), results from distributed or federated queries of data sources, streams of data from chat rooms and discussion forums, and many others.

In embodiments, the quantum computing system 9200 includes a quantum register having a plurality of qubits. Further, the quantum computing system 9200 may include a quantum control system for implementing the fundamental operations on each of the qubits in the quantum register and a control processor for coordinating the operations required.

In embodiments, the quantum computing system 9200 is configured to optimize the pricing of a set of goods or services. In embodiments, the quantum computing system 9200 may utilize quantum annealing to provide optimized pricing. In embodiments, the quantum computing system 9200 may use q-bit based computational methods to optimize pricing.

In embodiments, the quantum computing system 9200 is configured to automatically discover smart contract configuration opportunities. Automated discovery of smart contract configuration opportunities may be based on published APIs to marketplaces and machine learning (e.g., by robotic process automation (RPA) of stakeholder, asset, and transaction types.

In embodiments, quantum-established or other blockchain-enabled smart contracts enable frequent transactions occurring among a network of parties, and manual or duplicative tasks are performed by counterparties for each transaction. The quantum-established or other blockchain acts as a shared database to provide a secure, single source of truth, and smart contracts automate approvals, calculations, and other transacting activities that are prone to lag and error. Smart contracts may use software code to automate tasks, and in some embodiments, this software code may include quantum code that enables extremely sophisticated optimized results.

In embodiments, the quantum computing system 9200 or other system in the system of systems may include a quantum-enabled or other risk identification module that is configured to perform risk identification and/or mitigation. The steps that may be taken by the risk identification module may include, but are not limited to, risk identification, impact assessment, and the like. In some embodiments, the risk identification module determines a risk type from a set of risk types. In embodiments, risks may include, but are not limited to, preventable, strategic, and external risks. Preventable risks may refer to risks that come from within and that can usually be managed on a rule-based level, such as employing operational procedures monitoring and employee and manager guidance and instruction. Strategy risks may refer to those risks that are taken on voluntarily to achieve greater rewards. External risks may refer to those risks that originate outside and are not in the businesses' control (such as natural disasters). External risks are not preventable or desirable. In embodiments, the risk identification module can determine a predicted cost for many categories of risk. The risk identification module may perform a calculation of current and potential impact on an overall risk profile. In embodiments, the risk identification module may determine the probability and significance of certain events. Additionally, or alternatively, the risk identification module may be configured to anticipate events.

In embodiments, the quantum computing system 9200 or other system of the platform 9200 is configured for graph clustering analysis for anomaly and fraud detection.

In some embodiments, the quantum computing system 9200 includes a quantum prediction module, which is configured to generate predictions. Furthermore, the quantum prediction module may construct classical prediction engines to further generate predictions, reducing the need for ongoing quantum calculation costs, which, can be substantial compared to traditional computers.

In embodiments, the quantum computing system 9200 may include a quantum principal component analysis (QPCA) algorithm that may process input vector data if the covariance matrix of the data is efficiently obtainable as a density matrix, under specific assumptions about the vectors given in the quantum mechanical form. It may be assumed that the user has quantum access to the training vector data in a quantum memory. Further, it may be assumed that each training vector is stored in the quantum memory in terms of its difference from the class means. These QPCA algorithms can then be applied to provide for dimension reduction using the calculational benefits of a quantum method.

In embodiments, the quantum computing system 9200 is configured for graph clustering analysis for certified randomness for proof-of-stake blockchains. Quantum cryptographic schemes may make use of quantum mechanics in their designs, which enables such schemes to rely on presumably unbreakable laws of physics for their security. The quantum cryptography schemes may be information-theoretically secure such that their security is not based on any non-fundamental assumptions. In the design of blockchain systems, information-theoretic security is not proven. Rather, classical blockchain technology typically relies on security arguments that make assumptions about the limitations of attackers' resources.

In embodiments, the quantum computing system 9200 is configured for detecting adversarial systems, such as adversarial neural networks, including adversarial convolutional neural networks. For example, the quantum computing system 9200 or other system of the platform 9200 may be configured to detect fake trading patterns.

In embodiments, the quantum computing system 9200 includes a quantum continual learning (QCL) system 9232, wherein the QCL system 9232 learns continuously and adaptively about the external world, enabling the autonomous incremental development of complex skills and knowledge by updating a quantum model to account for different tasks and data distributions. The QCL system 9232 operates on a realistic time scale where data and/or tasks become available only during operation. Previous quantum states can be superimposed into the quantum engine to provide the capacity for QCL. Because the QCL system 9232 is not constrained to a finite number of variables that can be processed deterministically, it can continuously adapt to future states, producing a dynamic continual learning capability. The QCL system 9232 may have applications where data distributions stay relatively static, but where data is continuously being received. For example, the QCL system 9232 may be used in quantum recommendation applications or quantum anomaly detection systems where data is continuously being received and where the quantum model is continuously refined to provide for various outcomes, predictions, and the like. QCL enables asynchronous alternate training of tasks and only updates the quantum model on the real-time data available from one or more streaming sources at a particular moment.

In embodiments, the QCL system 9232 operates in a complex environment in which the target data keeps changing based on a hidden variable that is not controlled. In embodiments, the QCL system 9232 can scale in terms of intelligence while processing increasing amounts of data and while maintaining a realistic number of quantum states. The QCL system 9232 applies quantum methods to drastically reduce the requirement for storage of historic data while allowing the execution of continuous computations to provide for detail-driven optimal results. In embodiments, a QCL system 9232 is configured for unsupervised streaming perception data since it continually updates the quantum model with new available data.

In embodiments, QCL system 9232 enables multi-modal-multi-task quantum learning. The QCL system 9232 is not constrained to a single stream of perception data but allows for many streams of perception data from different sensors and input modalities. In embodiments, the QCL system 9232 can solve multiple tasks by duplicating the quantum state and executing computations on the duplicate quantum environment. A key advantage to QCL is that the quantum model does not need to be retrained on historic data, as the superposition state holds information relating to all prior inputs. Multi-modal and multi-task quantum learning enhance quantum optimization since it endows quantum machines with reasoning skills through the application of vast amounts of state information.

In embodiments, the quantum computing system 9200 supports quantum superposition, or the ability of a set of states to be overlaid into a single quantum environment.

In embodiments, the quantum computing system 9200 supports quantum teleportation. For example, information may be passed between photons on chipsets even if the photons are not physically linked.

In embodiments, the quantum computing system 9200 may include a quantum transfer pricing system.

Quantum transfer pricing allows for the establishment of prices for the goods and/or services exchanged between subsidiaries, affiliates, or commonly controlled companies that are part of a larger enterprise and may be used to provide tax savings for corporations. In embodiments, solving a transfer pricing problem involves testing the elasticities of each system in the system of systems with a set of tests. In these embodiments, the testing may be done in periodic batches and then may be iterated. As described herein, transfer pricing may refer to the price that one division in a company charges another division in that company for goods and services.

In embodiments, the quantum transfer pricing system consolidates all financial data related to transfer pricing on an ongoing basis throughout the year for all entities of an organization wherein the consolidation involves applying quantum entanglement to overlay data into a single quantum state. In embodiments, the financial data may include profit data, loss data, data from intercompany invoices (potentially including quantities and prices), and the like.

In embodiments, the quantum transfer pricing system may interface with a reporting system that reports segmented profit and loss, transaction matrices, tax optimization results, and the like based on superposition data. In embodiments, the quantum transfer pricing system automatically generates forecast calculations and assesses the expected local profits for any set of quantum states.

In embodiments, the quantum transfer pricing system may integrate with a simulation system for performing simulations. Suggested optimal values for new product prices can be discussed cross-border via integrated quantum workflows and quantum teleportation communicated states.

In embodiments, quantum transfer pricing may be used to proactively control the distribution of profits within a multi-national enterprise (MNE), for example, during the course of a calendar year, enabling the entities to achieve arms-length profit ranges for each type of transaction.

In embodiments, the QCL system 9232 may use a number of methods to calculate quantum transfer pricing, including the quantum comparable uncontrolled price (QCUP) method, the quantum cost plus percent method (QCPM), the quantum resale price method (QRPM), the quantum transaction net margin method (QTNM), and the quantum profit-split method.

The QCUP method may apply quantum calculations to find comparable transactions made between related and unrelated organizations, potentially through the sharing of quantum superposition data. By comparing the price of goods and/or services in an intercompany transaction with the price used by independent parties through the application of a quantum comparison engine, a benchmark price may be determined.

The QCPM method may compare the gross profit to the cost of sales, thus measuring the cost-plus mark-up (the actual profit earned from the products). Once this mark-up is determined, it should be equal to what a third party would make for a comparable transaction in a comparable context with similar external market conditions. In embodiments, the quantum engine may simulate the external market conditions.

The QRPM method looks at groups of transactions rather than individual transactions and is based on the gross margin or difference between the price at which a product is purchased and the price at which it is sold to a third party. In embodiments, the quantum engine may be applied to calculate the price differences and to record the transactions in the superposition system.

The QTNM method is based on the net profit of a controlled transaction rather than comparable external market pricing. The calculation of the net profit is accomplished through a quantum engine that can consider a wide variety of factors and solve optimally for the product price. The net profit may then be compared with the net profit of independent enterprises, potentially using quantum teleportation.

The quantum profit-split method may be used when two related companies work on the same business venture, but separately. In these applications, the quantum transfer pricing is based on profit. The quantum profit-split method applies quantum calculations to determine how the profit associated with a particular transaction would have been divided between the independent parties involved.

In embodiments, the quantum computing system 9200 may leverage one or artificial networks to fulfill the request of a quantum computing client. For example, the quantum computing system 9200 may leverage a set of artificial neural networks to identify patterns in images (e.g., using image data from a liquid lens system), perform binary matrix factorization, perform topical content targeting, perform similarity-based clustering, perform collaborative filtering, perform opportunity mining, or the like.

In embodiments, the system of systems may include a hybrid computing allocation system for prioritization and allocation of quantum computing resources and traditional computing resources. In embodiments, the prioritization and allocation of quantum computing resources and traditional computing resources may be measure-based (e.g., measuring the extent of the advantage of the quantum resource relative to other available resources), cost-based, optimality-based, speed-based, impact-based, or the like. In some embodiments the hybrid computing allocation system is configured to perform time-division multiplexing between the quantum computing system 9200 and a traditional computing system. In embodiments, the hybrid computing allocation system may automatically track and report on the allocation of computational resources, the availability of computational resources, the cost of computational resources, and the like.

In embodiments, the quantum computing system 9200 may be leveraged for queue optimization for utilization of quantum computing resources, including context-based queue optimizations.

In embodiments, the quantum computing system 9200 may support quantum-computation-aware location-based data caching.

In embodiments, the quantum computing system 9200 may be leveraged for optimization of various system resources in the system of systems, including the optimization of quantum computing resources, traditional computing resources, energy resources, human resources, robotic fleet resources, smart container fleet resources, I/O bandwidth, storage resources, network bandwidth, attention resources, or the like.

The quantum computing system 9200 may be implemented where a complete range of capabilities are available to or as part of any configured service. Configured quantum computing services may be configured with subsets of these capabilities to perform specific predefined function, produce newly defined functions, or various combinations of both.

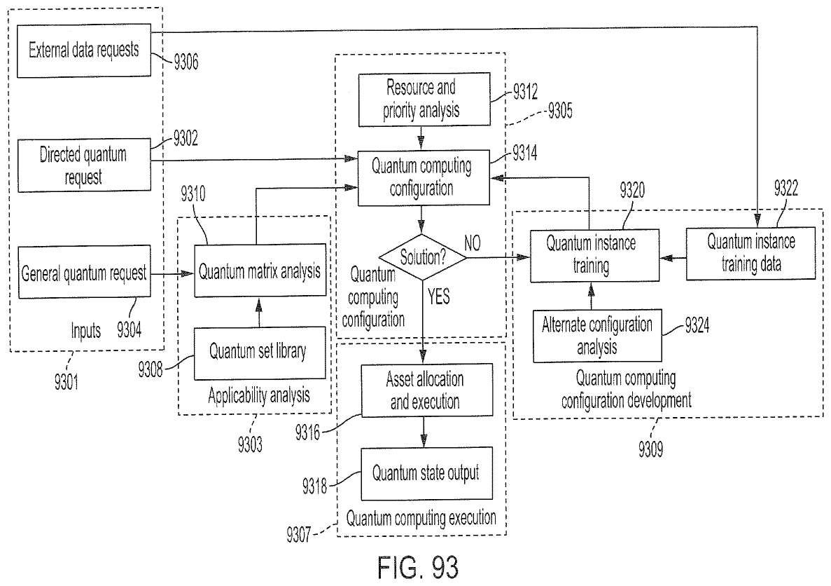

FIG. 93 illustrates quantum computing service request handling 9300 according to some embodiments of the present disclosure. In embodiments, the request handling 9300 includes inputs 9301, applicability analysis 9303, quantum computing configuration 9305, quantum computing execution 9307, and quantum computing configuration development 9309. In embodiments, inputs 9301 include external data requests 9306, directed quantum request 9302, and general quantum request 9304. In embodiments, applicability analysis 9303 includes quantum set library 9308 and quantum matrix analysis 9310. In embodiments, quantum computing configuration 9305 includes resource and priority analysis 9312 and quantum computing configuration 9314. In embodiments, quantum computing execution 9307 includes asset allocation and execution 9316 and quantum state output 9318. In embodiments, quantum computing configuration development 9309 includes quantum instance training 9320, quantum instance training data 9322, and alternate configuration analysis 9324.

A directed quantum computing request 9302 may come from one or more quantum-aware devices or stack of devices, where the request is for known application configured with specific quantum instance(s), quantum computing engine(s), or other quantum computing resources, and where data associated with the request may be preprocessed or otherwise optimized for use with quantum computing.

A general quantum computing request 9304 may come from any system in the system of systems or configured service, where the requestor has determined that quantum computing resources may provide additional value or other improved outcomes. Improved outcomes may also be suggested by the quantum computing service in association with some form of monitoring and analysis. For a general quantum computing request 9304, input data may not be structured or formatted as necessary for quantum computing.

In embodiments, external data requests 9306 may include any available data that may be necessary for training new quantum instances. The sources of such requests could be public data, sensors, ERP systems, and many others.

Incoming operating requests and associated data may be analyzed using a standardized approach that identifies one or more possible sets of known quantum instances, quantum computing engines, or other quantum computing resources that may be applied to perform the requested operation(s). Potential existing sets may be identified in the quantum set library 9308.

In embodiments, the quantum computing system 9200 includes a quantum computing configuration service 9210. The quantum computing configuration service may work alone or with the intelligence service 9234 to select a best available configuration using a resource and priority analysis that also includes the priority of the requestor. The quantum computing configuration service may provide a solution (YES) or determine that a new configuration is required (NO).

In embodiments, the quantum computing configuration service 9210 includes intelligence service 9234, resource and priority module 9246, quantum set configuration module 9247, and library management module 9248.

In one example, the requested set of quantum computing services may not exist in the quantum set library 9308. In this example, one or more new quantum instances must be developed (trained) with the intelligence service 9234 using available data. In embodiments, alternate configurations may be developed with assistance from the intelligence service 9234 to identify alternate ways to provide all or some of the requested quantum computing services until appropriate resources become available. For example, a quantum/traditional hybrid model may be possible that provides the requested service, but at a slower rate.

In embodiments, alternate configurations may be developed with assistance from the intelligence service 9234 to identify alternate and possibly temporary ways to provide all or some of the requested quantum computing services. For example, a hybrid quantum/traditional model may be possible that provides the requested service, but at a slower rate. This may also include a feedback learning loop to adjust services in real time or to improved stored library elements.

When a quantum computing configuration has been identified and available, it is allocated and programmed for execution and delivery of one or more quantum states (solutions).

### Biology Based Systems.

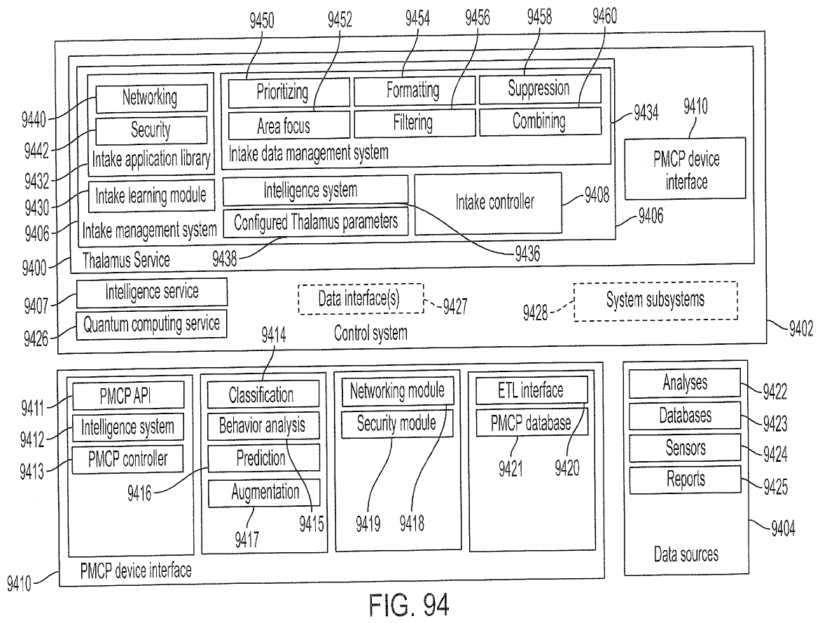

FIG. 94 shows a thalamus service 9400 and a set of input sensors streaming data from various sources across a system 9402, including a transportation system, as described herein, with its centrally managed data sources 9404. In embodiments, the thalamus service 9400 filters the into the control system 9402 such that the control system is never overwhelmed by the total volume of information. In embodiments, the thalamus service 9400 provides an information suppression mechanism for information flows within the system. This mechanism monitors all data streams and strips away irrelevant data streams by ensuring that the maximum data flows from all input sensors are always constrained. Input sensors may include but are not limited to sensors associated with one or more vehicles 110, which may include various mechanical, electrical, and software components and systems, such as a powertrain 113, a suspension system 117, a steering system, a braking system, a fuel system, a charging system, seats 128, a combustion engine, an electric vehicle drive train, a transmission 119, a gear set, and the like. The vehicle may have a vehicle user interface 123, which may include a set of interfaces that include a steering system, buttons, levers, touch screen interfaces, audio interfaces, and the like as described throughout this disclosure.

The thalamus service 9400 may be a gateway for all communication that responds to the prioritization of the control system 9402. The control system 9402 may decide to change the prioritization of the data streamed from the thalamus service 9400, for example, during a known fire in an isolated area, and the event may direct the thalamus service 9400 to continue to provide flame sensor information despite the fact that majority of this data is not unusual. The thalamus service 9400 may be an integral part of the overall system communication framework.

In embodiments, the control system 9402 includes the thalamus service 9400, intelligence service 9407, quantum computing service 9426, data interface(s) 9427, and system subsystems 9428. In embodiments, the data sources 9404 include analyses 9422, databases 9423, sensors 9424, and reports 9425.

In embodiments, the thalamus service 9400 includes an intake management system 9406. The intake management system 9406 may be configured to receive and process multiple large datasets by converting them into data streams that are sized and organized for subsequent use by a central control system 9402 operating within one or more systems. For example, a robot may include vision and sensing systems that are used by its central control system 9402 to identify and move through an environment in real time. The intake management system 9406 can facilitate robot decision-making by parsing, filtering, classifying, or otherwise reducing the size and increasing the utility of multiple large datasets that would otherwise overwhelm the central control system 9402. In embodiments, the intake management system 9406 may include an intake controller 9408 that works with an intelligence system 9436 to evaluate incoming data and take actions-based evaluation results. Evaluations and actions may include specific instruction sets received by the thalamus service 9400, for example the use of a set of specific compression and prioritization tools stipulated within a “Networking” library module. In another example, thalamus service inputs may direct the use of specific filtering and suppression techniques. In a third example, thalamus service inputs may stipulate data filtering associated with an area of interest such as a certain type of financial transaction. The intake management system is also configured to recognize and manage datasets that are in a vectorized format such as PCMP, where they may be passed directly to central control, or alternatively deconstructed and processed separately. The intake management system 9406 may include a learning module 9430 that receives data from external sources that enables improvement and creation of application and data management library modules. In some cases, the intake management system may request external data to augment existing datasets.

In embodiments, the intake management system 9406 includes intake learning module 9430, intake controller 9408, intake application library 9432, intake data management system 9434, intelligence system 9436, and configured thalamus parameters 9438. In embodiments, the intake application library 9432 includes networking 9440 and security 9442. In embodiments, the intake data management system 9434 includes prioritizing 9450, area focus 9452, formatting 9454, filtering 9456, suppression 9458, and combining 9460.

In embodiments, the control system 9402 may direct the thalamus service 9400 to alter its filtering to provide more input from a set of specific sources. This indication more input is handled by the thalamus service 9400 by suppressing other information flows based to constrain the total data flows to within a volume the central control system can handle.

The thalamus service 9400 can operate by suppressing data based on several different factors, and in embodiments, the default factor maybe unusualness of the data. This unusualness is a constant monitoring of all input sensors and determining the unusualness of the data.

In some embodiments, the thalamus service 9400 may suppress data based on geospatial factors. The thalamus service 9400 may be aware of the geospatial location of all sensors and is able to look for unusual patterns in data based on geospatial context and suppress data accordingly.

In some embodiments, the thalamus service 9400 may suppress data based on temporal factors. Data can be suppressed temporally, for example, if the cadence of the data can be reduced such that the overall data stream is filtered to level that can be handled by the central processing unit.

In some embodiments, the thalamus service 9400 may suppress data based on contextual factors. In embodiments, context-based filtering is a filtering event in which the thalamus service 9400 is aware of some context-based event. In this context the filtering is made to suppress information flows not relating to the data from the event.

In embodiments, the control system 9402 can override the thalamus filtering and decide to focus on a completely different area for any specific reason.

In embodiments, the system may include a vector module. In embodiments, the vector module may be used to convert data to a vectorized format. In many examples, the conversion of a long sequence of oftentimes similar numbers into a vector, which may include short term future predictions, makes the communication both smaller in size and forward looking in nature. In embodiments, forecast methods may include: moving average; weighted moving average; Kalman filtering; exponential smoothing; autoregressive moving average (ARMA) (forecasts depend on past values of the variable being forecast, and on past prediction errors); autoregressive integrated moving average (ARIMA) (ARMA on the period-to-period change in the forecasted variable); extrapolation; linear prediction; trend estimation (predicting the variable as a linear or polynomial function of time); growth curve (e.g., statistics); and recurrent neural network.

In embodiments, the system may include a predictive model communication protocol (PMCP) system to support vector-based predictive models and a predictive model communication protocol (PMCP). Under the PMCP protocol, instead of traditional streams where individual data items are transmitted, vectors representing how the data is changing or what is the forecast trend in the data is communicated. The PMCP system may transmit actual model parameters and receiving units such that edge devices can apply the vector-based predictive models to determine future states. For example, each automated device in a network could train a regression model or a neural network, constantly fitting the data streams to current input data. All automated devices leveraging the PMCP system would be able to react in advance of events actually happening, rather than waiting for depletion of inventory for an item, for example, to occur. Continuing the example, the stateless automated device can react to the forecast future state and make the necessary adjustments, such as ordering more of the item.

In embodiments, the PMCP system includes a PMCP device interface 9410. In embodiments, the PMCP device interface 9410 relates to PMCP API 9411, intelligence system 9412, PMCP controller 9413, classification 9414, behavior analysis 9415, prediction 9416, augmentation 9417, networking module 9418, security module 9419, ETL interface 9420, and PMCP database 9421.

In embodiments, the PMCP system enables communicating vectorized information and algorithms that allow vectorized information to be processed to refine the known information regarding a set of probability-based states. For example, the PMCP system may support communicating the vectorized information gathered at each point of a sensor reading but also adding algorithms that allow the information to be processed. Applied in an environment with large numbers of sensors with different accuracies and reliabilities, the probabilistic vector-based mechanism of the PMCP system allows large numbers, if not all, data streams to combine to produce refined models representing the current state, past states and likely future states of goods. Approximation methods may include importance sampling, and the resulting algorithm is known as a particle filter, condensation algorithm, or Monte Carlo localization.

In embodiments, the vector-based communication of the PMCP system allows future security events to be anticipated, for example, by simple edge node devices that are running in a semi-autonomous way. The edge devices may be responsible for building a set of forecast models showing trends in the data. The parameters of this set of forecast models may be transmitted using the PMCP system.

Security systems are constantly looking for vectors showing change in state, as unusual events tend to trigger multiple vectors to show unusual patterns. In a security setting, seeing multiple simultaneous unusual vectors may trigger escalation and a response by, for example, the control system. In addition, one of the major areas of communication security concern is around the protection of stored data, and in a vector-based system data does not need to be stored, and so the risk of data loss is simply removed.

In embodiments, PMCP data can be directly stored in a queryable database where the actual data is reconstructed dynamically in response to a query. In some embodiments, the PMCP data streams can be used to recreate the fine-grained data so they become part of an Extract Transform and Load (ETL) process.

In embodiments where there are edge devices with very limited capacities, additional edge communication devices can be added to convert the data into PMCP format. For example, to protect distributed medical equipment from hacking attempts many manufacturers will choose to not connect the device to any kind of network. To overcome this limitation, the medical equipment may be monitored using sensors, such as cameras, sound monitors, voltage detectors for power usage, chemical sniffers, and the like. Functional unit learning and other data techniques may be used to determine the actual usage of the medical equipment detached from the network functional unit.

Communication using vectorized data allows for a constant view of likely future states. This allows the future state to be communicated, allowing various entities to respond ahead of future state requirements without needing access to the fine-grained data.

In embodiments, the PMCP protocol can be used to communicate relevant information about production levels and future trends in production. This PMCP data feed, with its built-in data obfuscation allows real contextual information about production levels to be shared with consumers, regulators, and other entities without requiring sensitive data to be shared. For example, when choosing to purchase a new car, if there is an upcoming shortage of red paint then the consumer could be encouraged to choose a different color in order to maintain a desired delivery time. PMCP and vector data enables simple data informed interactive systems that user can apply without having to build enormously complex big data engines. As an example, an upstream manufacturer has an enormously complex task of coordinating many downstream consumption points. Through the use of PMCP, the manufacturer is able to provide real information to consumers without the need to store detailed data and build complex models.

In embodiments, edge device units may communicate via the PMCP system to show direction of movement and likely future positions. For example, a moving robot can communicate its likely track of future movement.

In embodiments, the PMCP system enables visual representations of vector-based data (e.g., via a user interface), highlighting of areas of concern without the need to process enormous volumes of data. The representation allows for the display of many monitored vector inputs. The user interface can then display information relating to the key items of interest, specifically vectors showing areas of unusual or troublesome movement. This mechanism allows sophisticated models that are built at the edge device edge nodes to feed into end user communications in a visually informative way.

Functional units produce a constant stream of “boring” data. By changing from producing data, to being monitored for problems, issues with the logistical modules are highlighted without the need for scrutiny of fine-grained data. In embodiments, the vectorizing process could constantly manage a predictive model showing future state. In the context of maintenance, these changes to the parameters in the predictive model are in and of themselves predictors of change in operational parameters, potentially indicating the need for maintenance. In embodiments, functional areas are not always designed to be connected, but by allowing for an external device to virtually monitor devices, functional areas that do not allow for connectivity can become part of the information flow in the goods. This concept extends to allow functional areas that have limited connectivity to be monitored effectively by embellishing their data streams with vectorized monitored information. Placing an automated device in the proximity of the functional unit that has limited or no connectivity allows capture of information from the devices without the requirement of connectivity. There is also potential to add training data capture functional units for these unconnected or limitedly connected functional areas. These training data capture functional units are typically quite expensive and can provide high quality monitoring data, which is used as an input into the proximity edge device monitoring device to provide data for supervised learning algorithms.

Oftentimes, locations are laden with electrical interference, causing fundamental challenges with communications. The traditional approach of streaming all the fine-grained data is dependent on the completeness of the data stream. For example, if an edge device was to go offline for 10 minutes, the streaming data and its information would be lost. With vectorized communication, the offline unit continues to refine the predictive model until the moment when it reconnects, which allows the updated model to be transmitted via the PMCP system.

In embodiments, systems and devices may be based on the PMCP protocol. For example, cameras and vision systems (e.g., liquid lens systems), user devices, sensors, robots, smart containers, and the like may use PMCP and/or vector-based communication. By using vector-based cameras, for example, only information relating to the movement of items is transmitted. This reduces the data volume and by its nature filters information about static items, showing only the changes in the images and focusing the data communication on elements of change. The overall shift in communication to communication of change is similar to how the human process of sight functions, where stationary items are not even communicated to the higher levels of the brain.

Radio Frequency Identification allows for massive volumes of mobile tags to be tracked in real-time. In embodiments, the movement of the tags may be communicated as vector information via the PMCP protocol, as this form of communication is naturally suited to handing information regarding the location of tag within the goods. Adding the ability to show future state of the location using predictive models that can use paths of prior movement allows the goods to change the fundamental communication mechanism to one where units consuming data streams are consuming information about the likely future state of the goods. In embodiments, each tagged item may be represented as a probability-based location matrix showing the likely probability of the tagged item being at a position in space. The communication of movement shows the transformation of the location probability matrix to a new set of probabilities. This probabilistic locational overview provides for constant modeling of areas of likely intersection of moving units and allows for refinement of the probabilistic view of the location of items. Moving to a vector-based probability matrix allows units to constantly handle the inherent uncertainty in the measurement of status of various items, entities, and the like. In embodiments, status includes, but is not limited to, location, temperature, movement and power consumption.

In embodiments, continuous connectivity is not required for continuous monitoring of sensor inputs in a PMCP-based communication system. For example, a mobile robotic device with a plurality of sensors will continue to build models and predictions of data streams while disconnected from the network, and upon reconnection, the updated models are communicated. Furthermore, other systems or devices that use input from the monitored system or device can apply the best known, typically last communicated, vector predictions to continue to maintain a probabilistic understanding of the states of the goods.

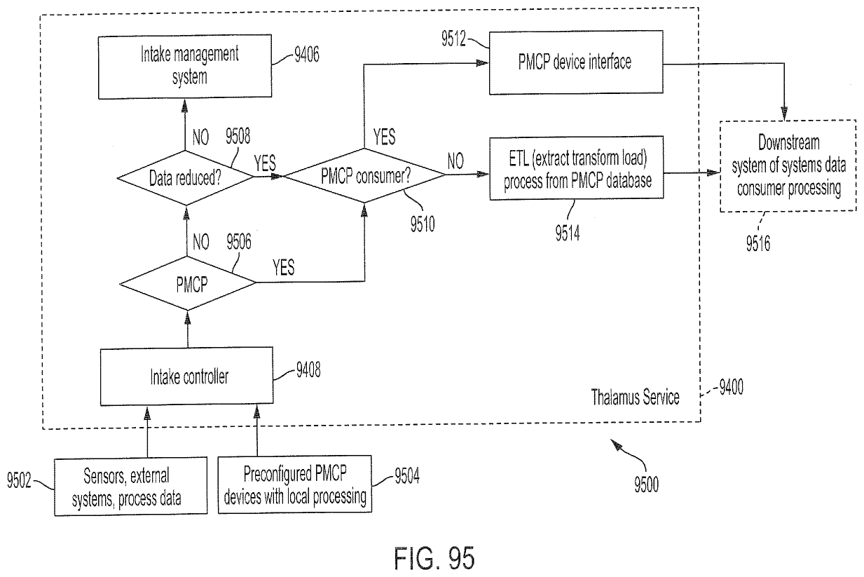

FIG. 95 is a simplified thalamus service workflow 9500 according to some embodiments. In the example provided, the intake controller 9408 receives sensors, external systems, and process data 9502 and input from preconfigured PMCP devices with local processing 9504. The decision 9506 related to PMCP proceeds to decision 9508 when the decision is “no” and proceeds to decision 9510 when the decision is “yes.” If the data is not reduced as decided in decision 9508, the workflow proceeds to intake management system 9406. If the data is reduced according to decision 9508, the workflow 9500 proceeds to decision 9510. When the decision 9510 is yes regarding a PMCP consumer, the workflow 9500 proceeds to PMCP device interface 9512. When the decision 9510 is no regarding a PMCP consumer, the workflow 9500 proceeds to ETL (extract transform load) process from PMCP data base 9514. The output relates to downstream system of systems data consumer processing 9516.

### Dual Process Artificial Neural Network

In embodiments, the transportation system includes a dual process artificial neural network (DPANN) system 9500. The DPANN system 9500 includes an artificial neural network (ANN) having behaviors and operational processes (such as decision-making) that are products of a training system and a retraining system. The training system is configured to perform automatic, trained execution of ANN operations. The retraining system performs effortful, analytical, intentional retraining of the ANN, such as based on one or more relevant aspects of the ANN, such as memory, one or more input data sets (including time information with respect to elements in such data sets), one or more goals or objectives (including ones that may vary dynamically, such as periodically and/or based on contextual changes, such as ones relating to the usage context of the ANN), and/or others. In cases involving memory-based retraining, the memory may include original/historical training data and refined training data. The DPANN system 9500 includes a dual process learning function (DPLF) configured to manage and perform an ongoing data retention process. The DPLF (including, where applicable, memory management process) facilitate retraining and refining of behavior of the ANN. The DPLF provides a framework by which the ANN creates outputs such as predictions, classifications, recommendations, conclusions and/or other outputs based on a historic inputs, new inputs, and new outputs (including outputs configured for specific use cases, including ones determined by parameters of the context of utilization (which may include performance parameters such as latency parameters, accuracy parameters, consistency parameters, bandwidth utilization parameters, processing capacity utilization parameters, prioritization parameters, energy utilization parameters, and many others).

In embodiments, the DPANN system 9500 associated with the transportation system may store training data, thereby allowing for constant retraining based on results of decisions, predictions, and/or other operations of the ANN, as well as allowing for analysis of training data upon the outputs of the ANN. The management of entities stored in the memory allows the construction and execution of new models, such as ones that may be processed, executed or otherwise performed by or under management of the training system. The DPANN system 9500 uses instances of the memory to validate actions (e.g., in a manner similar to the thinking of a biological neural network (including retrospective or self-reflective thinking about whether actions that were undertaken under a given situation where optimal) and perform training of the ANN, including training that intentionally feeds the ANN with appropriate sets of memories (i.e., ones that produce favorable outcomes given the performance requirements for the ANN).

In embodiments, the DPLF may be or include the continued process retention of one or more training datasets and/or memories stored in the memory over time. The DPLF thereby allows the ANN to apply existing neural functions and draw upon sets of past events (including ones that are intentionally varied and/or curated for distinct purposes), such as to frame understanding of and behavior within present, recent, and/or new scenarios, including in simulations, during training processes, and in fully operational deployments of the ANN. The DPLF may provide the ANN with a framework by which the ANN may analyze, evaluate, and/or manage data, such as data related to the past, present and future. As such, the DPLF plays a crucial role in training and retraining the ANN via the training system and the retraining system.

In embodiments, the DPLF is configured to perform a dual-process operation to manage existing training processes and is also configured to manage and/or perform new training processes, i.e., retraining processes. In embodiments, each instance of the ANN is trained via the training system and configured to be retrained via the retraining system. The ANN encodes training and/or retraining datasets, stores the datasets, and retrieves the datasets during both training via the training system and retraining via the retraining system. The DPANN system 9500 may recognize whether a dataset (the term dataset in this context optionally including various subsets, supersets, combinations, permutations, elements, metadata, augmentations, or the like, relative to a base dataset used for training or retraining), storage activity, processing operation and/or output, has characteristics that natively favor the training system versus the retraining system based on its respective inputs, processing (e.g., based on its structure, type, models, operations, execution environment, resource utilization, or the like) and/or outcomes (including outcome types, performance requirements (including contextual or dynamic requirements), and the like. For example, the DPANN system 9500 may determine that poor performance of the training system on a classification task may indicate a novel problem for which the training of the ANN was not adequate (e.g., in type of data set, nature of input models and/or feedback, quantity of training data, quality of tagging or labeling, quality of supervision, or the like), for which the processing operations of the ANN are not well-suited (e.g., where they are prone to known vulnerabilities due to the type of neural network used, the type of models used, etc.), and that may be solved by engaging the retraining system to retrain the model to teach the model to learn to solve the new classification problem (e.g., by feeding it many more labeled instances of correctly classified items). With periodic or continuous evaluation of the performance of the ANN, the DPANN system may subsequently determine that highly stable performance of the ANN (such as where only small improvements of the ANN occur over many iterations of retraining by the retraining system) indicates readiness for the training system to replace the retraining system (or be weighted more favorably where both are involved). Over longer periods of time, cycles of varying performance may emerge, such as where a series of novel problems emerge, such that the retraining system of the DPANN is serially engaged, as needed, to retrain the ANN and/or to augment the ANN by providing a second source of outputs (which may be fused or combined with ANN outputs to provide a single result (with various weightings across them), or may be provided in parallel, such as enabling comparison, selection, averaging, or context- or situation-specific application of the respective outputs).

In embodiments, the ANN is configured to learn new functions in conjunction with the collection of data according to the dual-process training of the ANN via the training system and the retraining system. The DPANN system 9500 performs analysis of the ANN via the training system and performs initial training of the ANN such that the ANN gains new internal functions (or internal functions are subtracted or modified, such as where existing functions are not contributing to favorable outcomes). After the initial training, the DPANN system 9500 performs retraining of the ANN via the retraining system. To perform the retraining, the retraining system evaluates the memory and historic processing of the ANN to construct targeted DPLF processes for retraining. The DPLF processes may be specific to identified scenarios. The ANN processes can run in parallel with the DPLF processes. By way of example, the ANN may function to operate a particular make and model of a self-driving car after the initial training by the training system. The DPANN system 9500 may perform retraining of the functions of the ANN via the retraining system, such as to allow the ANN to operate a different make and model of car (such as one with different cameras, accelerometers and other sensors, different physical characteristics, different performance requirements, and the like), or even a different kind of vehicle, such as a bicycle or a spaceship.

In embodiments, as quality of outputs and/or operations of the ANN improves, and as long as the performance requirements and the context of utilization for the ANN remain fairly stable, performing the dual-process training process can become a decreasingly demanding process. As such, the DPANN system 9500 may determine that fewer neurons of the ANN are required to perform operations and/or processes of the ANN, that performance monitoring can be less intensive (such as with longer intervals between performance checks), and/or that the retraining is no longer necessary (at least for a period of time, such as until a long-term maintenance period arrives and/or until there are significant shifts in context of utilization). As the ANN continues to improve upon existing functions and/or add new functions via the dual-process training process, the ANN may perform other, at times more “intellectually-demanding” (e.g., retraining intensive) tasks simultaneously. For example, utilizing dual process-learned knowledge of a function or process being trained, the ANN can solve an unrelated complex problem or make a retraining decision simultaneously. The retraining may include supervision, such as where an agent (e.g., human supervisor or intelligent agent) directs the ANN to a retraining objective (e.g., “master this new function”) and provides a set of training tasks and feedback functions (such as supervisory grading) for the retraining. In-embodiments, the ANN can be used to organize the supervision, training and retraining of other dual process-trained ANNs, to seed such training or retraining, or the like.

In embodiments, one or more behaviors and operational processes (such as decision-making) of the ANN may be products of training and retraining processes facilitated by the training system and the retraining system, respectively. The training system may be configured to perform automatic training of ANN, such as by continuously adding additional instances of training data as it is collected by or from various data sources. The retraining system may be configured to perform effortful, analytical, intentional retraining of the ANN, such as based on memory (e.g., stored training data or refined training data) and/or optionally based on reasoning or other factors. For example, in a deployment management context, the training system may be associated with a standard response by the ANN, while the retraining system may implement DPLF retraining and/or network adaptation of the ANN. In some cases, retraining of the ANN beyond the factory, or “out-of-the-box,” training level may involve more than retraining by the retraining system. Successful adjustment of the ANN by one or more network adaptations may be dependent on the operation of one or more network adjustments of the training system.

In embodiments, the training system may facilitate fast operating by and training of the ANN by applying existing neural functions of the ANN based on training of the ANN with previous datasets. Standard operational activities of the ANN that may draw heavily on the training system may include one or more of the methods, processes, workflows, systems, or the like described throughout this disclosure and the documents incorporated herein, such as, without limitation: defined functions within networking (such as discovering available networks and connections, establishing connections in networks, provisioning network bandwidth among devices and systems, routing data within networks, steering traffic to available network paths, load balancing across networking resources, and many others); recognition and classification (such as of images, text, symbols, objects, video content, music and other audio content, speech content, and many others); spoken words; prediction of states and events (such as prediction of failure modes of machines or systems, prediction of events within workflows, predictions of behavior in shopping and other activities, and many others); control (such as controlling autonomous or semi-autonomous systems, automated agents (such as automated call-center operations, chat bots, and the like) and others); and/or optimization and recommendation (such as for products, content, decisions, and many others). ANNs may also be suitable for training datasets for scenarios that only require output. The standard operational activities may not require the ANN to actively analyze what is being asked of the ANN beyond operating on well-defined data inputs, to calculate well-defined outputs for well-defined use cases. The operations of the training system and/or the retraining system may be based on one or more historic data training datasets and may use the parameters of the historic data training datasets to calculate results based on new input values and may be performed with small or no alterations to the ANN or its input types. In embodiments, an instance of the training system can be trained to classify whether the ANN is capable of performing well in a given situation, such as by recognizing whether an image or sound being classified by the ANN is of a type that has historically been classified with a high accuracy (e.g., above a threshold).

In embodiments, network adaptation of the ANN by one or both of the training system and the retraining system may include a number of defined network functions, knowledge, and intuition-like behavior of the ANN when subjected to new input values. In such embodiments, the retraining system may apply the new input values to the DPLF system to adjust the functional response of the ANN, thereby performing retraining of the ANN. The DPANN system 9500 may determine that retraining the ANN via network adjustment is necessary when, for example, without limitation, functional neural networks are assigned activities and assignments that require the ANN to provide a solution to a novel problem, engage in network adaptation or other higher-order cognitive activity, apply a concept outside of the domain in which the DPANN was originally designed, support a different context of deployment (such as where the use case, performance requirements, available resources, or other factors have changed), or the like. The ANN can be trained to recognize where the retraining system is needed, such as by training the ANN to recognize poor performance of the training system, high variability of input data sets relative to the historical data sets used to train the training system, novel functional or performance requirements, dynamic changes in the use case or context, or other factors. The ANN may apply reasoning to assess performance and provide feedback to the retraining system. The ANN may be trained and/or retrained to perform intuitive functions, optionally including by a combinatorial or re-combinatorial process (e.g., including genetic programming wherein inputs (e.g., data sources), processes/functions (e.g., neural network types and structures), feedback, and outputs, or elements thereof, are arranged in various permutations and combinations and the ANN is tested in association with each (whether in simulations or live deployments), such as in a series of rounds, or evolutionary steps, to promote favorable variants until a preferred ANN, or preferred set of ANNs is identified for a given scenario, use case, or set of requirements). This may include generating a set of input “ideas” (e.g., combinations of different conclusions about cause-and-effect in a diagnostic process) for processing by the retraining system and subsequent training and/or by an explicit reasoning process, such as a Bayesian reasoning process, a casuistic or conditional reasoning process, a deductive reasoning process, an inductive reasoning process, or others (including combinations of the above) as described in this disclosure or the documents incorporated herein by reference.

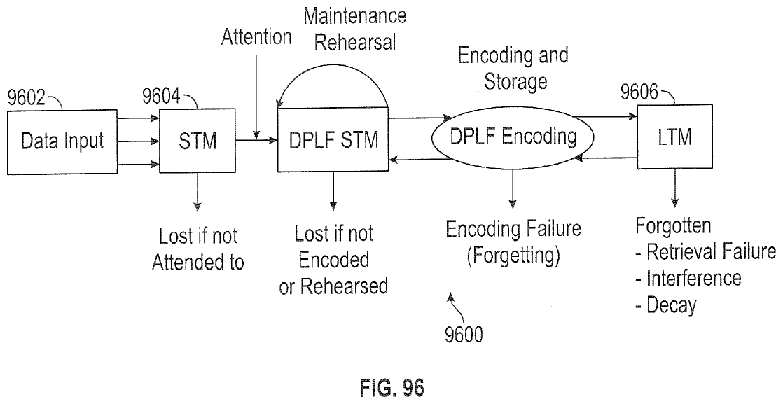

Referring to FIG. 96, in embodiments, the DPLF may perform an encoding process 9600 of the DPLF to process datasets into a stored form for future use, such as retraining of the ANN by the retraining system. The encoding process enables datasets to be taken in, understood, and altered by the DPLF to better support storage in and usage from the memory. The DPLF may apply current functional knowledge and/or reasoning to consolidate new input values. In the example provided, data is taken in as data input 9602. The memory can include short-term memory (STM) 9604, long-term memory (LTM) 9606, or a combination thereof. The datasets may be stored in one or both of the STM and the LTM. The STM may be implemented by the application of specialized behaviors inside the ANN (such as recurrent neural network, which may be gated or un-gated, or long-term short-term neural networks). The LTM may be implemented by storing scenarios, associated data, and/or unprocessed data that can be applied to the discovery of new scenarios. The encoding process may include processing and/or storing, for example, visual encoding data (e.g., processed through a Convolution Neural Network), acoustic sensor encoding data (e.g., how something sounds, speech encoding data (e.g., processed through a deep neural network (DNN), optionally including for phoneme recognition), semantic encoding data of words, such to determine semantic meaning, e.g., by using a Hidden Markov Model (HMM); and/or movement and/or tactile encoding data (such as operation on vibration/accelerometer sensor data, touch sensor data, positional or geolocation data, and the like). While datasets may enter the DPLF system through one of these modes, the form in which the datasets are stored may differ from an original form of the datasets and may pass-through neural processing engines to be encoded into compressed and/or context-relevant format. For example, an unsupervised instance of the ANN can be used to learn the historic data into a compressed format.

In embodiments, the encoded datasets are retained within the DPLF system. Encoded datasets are first stored in short-term DPLF, i.e., STM. For example, sensor datasets may be primarily stored in STM, and may be kept in STM through constant repetition. The datasets stored in the STM are active and function as a kind of immediate response to new input values. The DPANN system 9500 may remove datasets from STM in response to changes in data streams due to, for example, running out of space in STM as new data is imported, processed and/or stored. For example, it is viable for short-term DPLF to only last between 15 and 30 seconds. STM may only store small amounts of data typically embedded inside the ANN.

In embodiments, the DPANN system 9500 may measure attention based on utilization of the training system, of the DPANN system 9500 as a whole, and/or the like, such as by consuming various indicators of attention to and/or utilization of outputs from the ANN and transmitting such indicators to the ANN in response (similar to a “moment of recognition” in the brain where attention passes over something and the cognitive system says “aha!”). In embodiments, attention can be measured by the sheer amount of the activity of one or both of the systems on the data stream. In embodiments, a system using output from the ANN can explicitly indicate attention, such as by an operator directing the ANN to pay attention to a particular activity (e.g., to respond to a diagnosed problem, among many other possibilities). The DPANN system 9500 may manage data inputs to facilitate measures of attention, such as by prompting and/or calculating greater attention to data that has high inherent variability from historical patterns (e.g., in rates of change, departure from norm, etc.), data indicative of high variability in historical performance (such as data having similar characteristics to data sets involved in situations where the ANN performed poorly in training), or the like.

In embodiments, the DPANN system 9500 may retain encoded datasets within the DPLF system according to and/or as part of one or more storage processes. The DPLF system may store the encoded datasets in LTM as necessary after the encoded datasets have been stored in STM and determined to be no longer necessary and/or low priority for a current operation of the ANN, training process, retraining process, etc. The LTM may be implemented by storing scenarios, and the DPANN system 9500 may apply associated data and/or unprocessed data to the discovery of new scenarios. For example, data from certain processed data streams, such as semantically encoded datasets, may be primarily stored in LTM. The LTM may also store image (and sensor) datasets in encoded form, among many other examples.

In embodiments, the LTM may have relatively high storage capacity, and datasets stored within LTM may, in some scenarios, be effectively stored indefinitely. The DPANN system 9500 may be configured to remove datasets from the LTM, such as by passing LTM data through a series of memory structures that have increasingly long retrieval periods or increasingly high threshold requirements to trigger utilization (similar to where a biological brain “thinks very hard” to find precedent to deal with a challenging problem), thereby providing increased salience of more recent or more frequently used memories while retaining the ability to retrieve (with more time/effort) older memories when the situation justifies more comprehensive memory utilization. As such, the DPANN system 9500 may arrange datasets stored in the LTM on a timeline, such as by storing the older memories (measured by time of origination and/or latest time of utilization) on a separate and/or slower system, by penalizing older memories by imposing artificial delays in retrieval thereof, and/or by imposing threshold requirements before utilization (such as indicators of high demand for improved results). Additionally or alternatively, LTM may be clustered according to other categorization protocols, such as by topic. For example, all memories proximal in time to a periodically recognized person may be clustered for retrieval together, and/or all memories that were related to a scenario may be clustered for retrieval together.

In embodiments, the DPANN system 9500 may modularize and link LTM datasets, such as in a catalog, a hierarchy, a cluster, a knowledge graph (directed/acyclic or having conditional logic), or the like, such as to facilitate search for relevant memories. For example, all memory modules that have instances involving a person, a topic, an item, a process, a linkage of n-tuples of such things (e.g., all memory modules that involve a selected pair of entities), etc. The DPANN system 9500 may select sub-graphs of the knowledge graph for the DPLF to implement in one or more domain-specific and/or task-specific uses, such as training a model to predict robotic or human agent behavior by using memories that relate to a particular set of robotic or human agents, and/or similar robotic or human agents. The DPLF system may cache frequently used modules for different speed and/or probability of utilization. High value modules (e.g., ones with high-quality outcomes, performance characteristics, or the like) can be used for other functions, such as selection/training of STM keep/forget processes.

In embodiments, the DPANN system 9500 may modularize and link LTM datasets, such as in various ways noted above, to facilitate search for relevant memories. For example, memory modules that have instances involving a person, a topic, an item, a process, a linkage of n-tuples of such things (such as all memory modules that involve a selected pair of entities), or all memories associated with a scenario, etc., may be linked and searched. The DPANN system 9500 may select subsets of the scenario (e.g., sub-graphs of a knowledge graph) for the DPLF for a domain-specific and/or task-specific use, such as training a model to predict robotic or human agent behavior by using memories that relate to a particular set of robotic or human agents and/or similar robotic or human agents. Frequently used modules or scenarios can be cached for different speed/probability of utilization, or other performance characteristics. High value modules or scenarios (ones where high-quality outcomes results) can be used for other functions, such as selection/training of STM keep/forget processes, among others.

In embodiments, the DPANN system 9500 may perform LTM planning, such as to find a procedural course of action for a declaratively described system to reach its goals while optimizing overall performance measures. The DPANN system 9500 may perform LTM planning when, for example, a problem can be described in a declarative way, the DPANN system 9500 has domain knowledge that should not be ignored, there is a structure to a problem that makes the problem difficult for pure learning techniques, and/or the ANN needs to be trained and/or retrained to be able to explain a particular course of action taken by the DPANN system 9500. In embodiments, the DPANN system 9500 may be applied to a plan recognition problem, i.e., the inverse of a planning problem: instead of a goal state, one is given a set of possible goals, and the objective in plan recognition is to find out which goal was being achieved and how.

In embodiments, the DPANN system 9500 may facilitate LTM scenario planning by users to develop long-term plans. For example, LTM scenario planning for risk management use cases may place added emphasis on identifying extreme or unusual, yet possible, risks and opportunities that are not usually considered in daily operations, such as ones that are outside a bell curve or normal distribution, but that in fact occur with greater-than-anticipated frequency in “long tail” or “fat tail” situations, such as involving information or market pricing processes, among many others. LTM scenario planning may involve analyzing relationships between forces (such as social, technical, economic, environmental, and/or political trends) in order to explain the current situation, and/or may include providing scenarios for potential future states.

In embodiments, the DPANN system 9500 may facilitate LTM scenario planning for predicting and anticipating possible alternative futures along with the ability to respond to the predicted states. The LTM planning may be induced from expert domain knowledge or projected from current scenarios, because many scenarios (such as ones involving results of combinatorial processes that result in new entities or behaviors) have never yet occurred and thus cannot be projected by probabilistic means that rely entirely on historical distributions. The DPANN system 9500 may prepare the application to LTM to generate many different scenarios, exploring a variety of possible futures to the DPLM for both expected and surprising futures. This may be facilitated or augmented by genetic programming and reasoning techniques as noted above, among others.

In embodiments, the DPANN system 9500 may implement LTM scenario planning to facilitate transforming risk management into a plan recognition problem and apply the DPLF to generate potential solutions. LTM scenario induction addresses several challenges inherent to forecast planning. LTM scenario induction may be applicable when, for example, models that are used for forecasting have inconsistent, missing, unreliable observations; when it is possible to generate not just one but many future plans; and/or when LTM domain knowledge can be captured and encoded to improve forecasting (e.g., where domain experts tend to outperform available computational models). LTM scenarios can be focused on applying LTM scenario planning for risk management. LTM scenarios planning may provide situational awareness of relevant risk drivers by detecting emerging storylines. In addition, LTM scenario planning can generate future scenarios that allow DPLM, or operators, to reason about, and plan for, contingencies and opportunities in the future.

In embodiments, the DPANN system 9500 may be configured to perform a retrieval process via the DPLF to access stored datasets of the ANN. The retrieval process may determine how well the ANN performs with regard to assignments designed to test recall. For example, the ANN may be trained to perform a controlled vehicle parking operation, whereby the autonomous vehicle returns to a designated spot, or the exit, by associating a prior visit via retrieval of data stored in the LTM. The datasets stored in the STM and the LTM may be retrieved by differing processes. The datasets stored in the STM may be retrieved in response to specific input and/or by order in which the datasets are stored, e.g., by a sequential list of numbers. The datasets stored in the LTM may be retrieved through association and/or matching of events to historic activities, e.g., through complex associations and indexing of large datasets.

In embodiments, the DPANN system 9500 may implement scenario monitoring as at least a part of the retrieval process. A scenario may provide context for contextual decision-making processes. In embodiments, scenarios may involve explicit reasoning (such as cause-and-effect reasoning, Bayesian, casuistic, conditional logic, or the like, or combinations thereof) the output of which declares what LTM-stored data is retrieved (e.g., a timeline of events being evaluated and other timelines involving events that potentially follow a similar cause-and-effect pattern). For example, diagnosis of a failure of a machine or workflow may retrieve historical sensor data as well as LTM data on various failure modes of that type of machine or workflow (and/or a similar process involving a diagnosis of a problem state or condition, recognition of an event or behavior, a failure mode (e.g., a financial failure, contract breach, or the like), or many others).

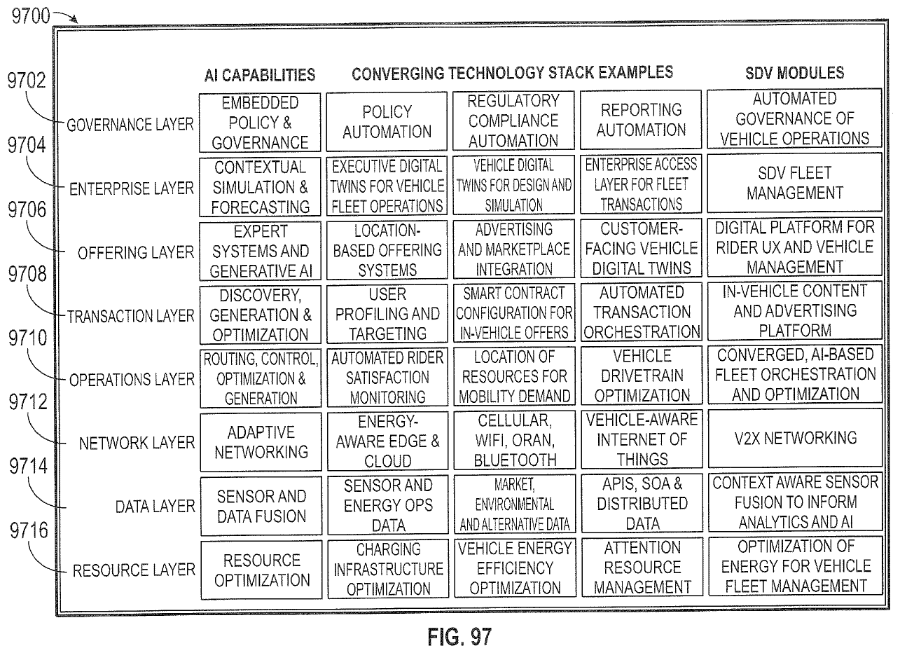

Referring to FIG. 97, in embodiments, the transportation methods and systems described herein may include AI capabilities, convergence technology stack capabilities and software-defined vehicle (SDV) modules 9700, including a governance layer 9702. The governance layer 9702 AI capabilities may include, but are not limited to, embedded policy and governance. Convergence technology stack examples of the governance layer 9702 include, but are not limited to, policy automation, regulatory compliance automation, and reporting automation. SDV module examples of the governance layer 9702 include, but are not limited to, automated governance of vehicle operations.

In embodiments, the transportation methods and systems described herein may include an enterprise layer 9704. The enterprise layer 9704 AI capabilities may include, but are not limited to, contextual simulation and forecasting. Convergence technology stack examples of the enterprise layer 9704 include, but are not limited to, executive digital twins for vehicle fleet operations, vehicle digital twins for design and simulation, and enterprise access layer for fleet transactions. SDV module examples of the enterprise layer 9704 include, but are not limited to, SDV fleet management.

In embodiments, the transportation methods and systems described herein may include an offering layer 9706. The offering layer 9706 AI capabilities may include, but are not limited to, expert systems and generative AI. Convergence technology stack examples of the offering layer 9706 include, but are not limited to, location-based offering systems, advertising and marketplace integration and customer-facing vehicle digital twins. SDV module examples of the offering layer 9706 include, but are not limited to, digital platform for rider UX and vehicle management.

In embodiments, the transportation methods and systems described herein may include a transaction layer 9708. The transaction layer 9708 AI capabilities may include, but are not limited to, discovery, generation and optimization. Convergence technology stack examples of the transaction layer 9708 include, but are not limited to, user profiling and targeting, smart contract configuration for in-vehicle offers and automated transaction orchestration. SDV module examples of the transaction layer 9708 include, but are not limited to, in-vehicle content and advertising platform.

In embodiments, the transportation methods and systems described herein may include an operations layer 9710. The operations layer 9710 AI capabilities may include, but are not limited to, routing, control, optimization, and generation. Convergence technology stack examples of the operations layer 9710 include, but are not limited to, automated rider satisfaction monitoring, location of resources for mobility demand, and vehicle drivetrain optimization. SDV module examples of the operations layer 9710 include, but are not limited to, converged, AI-based fleet orchestration and optimization.

In embodiments, the transportation methods and systems described herein may include a network layer 9712. The network layer 9712 AI capabilities may include, but are not limited to, adaptive networking. Convergence technology stack examples of the network layer 9712 include, but are not limited to, energy-aware edge and cloud, cellular, WiFi, ORAN, Bluetooth, and vehicle-aware internet of things. SDV module examples of the network layer 9712 include, but are not limited to, V2X networking.

In embodiments, the transportation methods and systems described herein may include a data layer 9714. The data layer 9714 AI capabilities may include, but are not limited to, sensor and data fusion. Convergence technology stack examples of the data layer 9714 include, but are not limited to, sensor and energy ops data, market, environmental and alternative data, APIs, SOA & distributed data. SDV module examples of the data layer 9714 include, but are not limited to, context aware sensor fusion to inform analytics and AI.

In embodiments, the transportation methods and systems described herein may include a resource layer 9716. The resource layer 9716 AI capabilities may include but are not limited to resource optimization. Convergence technology stack examples of the resource layer 9716 include, but are not limited to, charging infrastructure optimization, vehicle energy efficiency optimization, and attention resource management. SDV module examples of the resource layer 9716 include, but are not limited to, optimization of energy for vehicle fleet management.

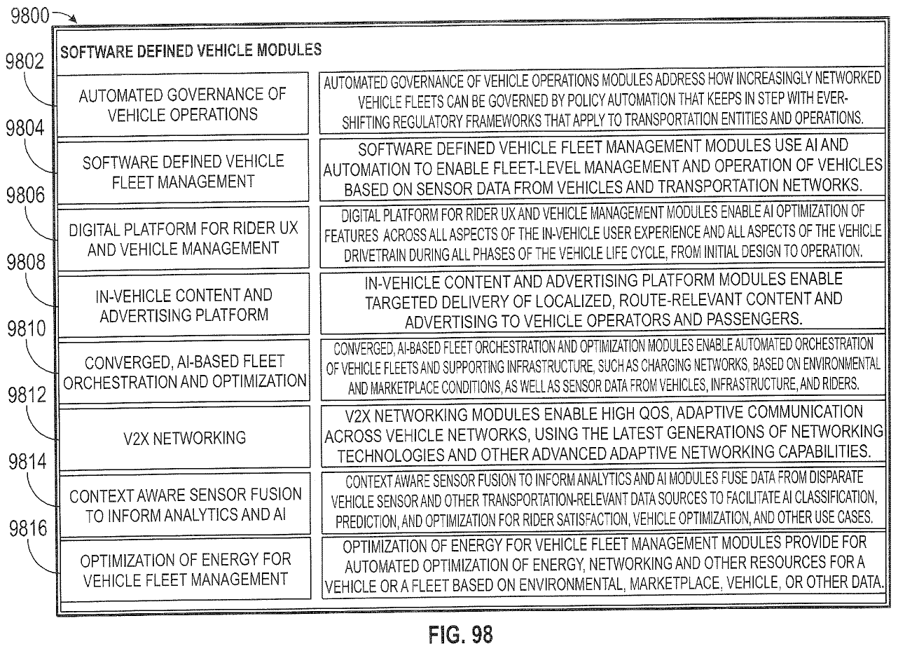

Referring to FIG. 98, in embodiments, the transportation methods and systems described herein may include software defined vehicle modules 9800 including, but not limited to, automated governance of vehicle operations 9802. In an example, automated governance of vehicle operations modules 9802 may address how increasingly networked vehicle fleets can be governed by policy automation that keeps in step with ever-shifting regulatory frameworks that apply to transportation entities and operations.

In embodiments, the transportation methods and systems described herein may include software defined vehicle modules 9800 including, but not limited to, software defined vehicle fleet management 9804. In an example, software defined vehicle fleet management modules 9804 may use AI and automation to enable fleet-level management and operation of vehicles based on sensor data from vehicles and transportation networks.

In embodiments, the transportation methods and systems described herein may include software defined vehicle modules 9800 including, but not limited to, digital platform for rider UX and vehicle management 9806. In an example, digital platform for rider UX and vehicle management modules 9806 may enable AI optimization of features across all aspects of the in-vehicle user experience and all aspects of the vehicle drivetrain during all phases of the vehicle life cycle, from initial design to operation.

In embodiments, the transportation methods and systems described herein may include software defined vehicle modules 9800 including, but not limited to, in-vehicle content and advertising platform 9808. In an example, in-vehicle content and advertising platform modules 9808 may enable targeted delivery of localized, route-relevant content and advertising to vehicle operators and passengers.

In embodiments, the transportation methods and systems described herein may include software defined vehicle modules 9800 including, but not limited to, converged, AI-based fleet orchestration and optimization 9810. In an example, converged, AI-based fleet orchestration and optimization modules 9810 may enable automated orchestration of vehicle fleets and supporting infrastructure, such as charging networks, based on environmental and marketplace conditions, as well as sensor data from vehicles, infrastructure, and riders.

In embodiments, the transportation methods and systems described herein may include software defined vehicle modules 9800 including, but not limited to, V2X networking 9812. In an example, V2X networking modules 9812 may enable high QoS, adaptive communication across vehicle networks, using the latest generations of networking technologies and other advanced adaptive networking capabilities.

In embodiments, the transportation methods and systems described herein may include software defined vehicle modules 9800 including, but not limited to, context aware sensor fusion to inform analytics and AI 9814. In an example, context aware sensor fusion to inform analytics and AI modules 9814 may fuse data from disparate vehicle sensor and other transportation-relevant data sources to facilitate AI classification, prediction, and optimization for rider satisfaction, vehicle optimization, and other use cases.

In embodiments, the transportation methods and systems described herein may include software defined vehicle modules 9800 including, but not limited to, optimization of energy for vehicle fleet management 9816. In an example, optimization of energy for vehicle fleet management modules 9816 may provide for automated optimization of energy, networking and other resources for a vehicle or a fleet based on environmental, marketplace, vehicle, or other data.

In embodiments, a software-defined vehicle may be configured for mitigating rider seat fatigue. In an example, the vehicle is equipped with a plurality of seat sensors configured for detecting physical parameters indicative of rider fatigue, such as pressure points, posture, and movement. These sensors generate real-time data that is analyzed by a generative AI engine. This engine may create personalized seat adjustment profiles by fusing the sensor data with rider preference data to construct a comprehensive model of rider comfort, such as with a digital twin. By employing advanced machine learning algorithms, the AI engine identifies patterns of rider discomfort and dynamically suggests ergonomic changes to the seating arrangement. It may generate real-time recommendations for micro-adjustments to seat positions, thereby redistributing pressure and improving circulation for the rider.

In embodiments, to ensure the security of the transmitted sensor data, an encryption module may be integrated within the vehicle, safeguarding the communication between the seat sensors, a VCU (vehicle control unit), and the generative AI engine. The VCU itself is fortified with a secure access control system, limiting modifications of the generative AI engine to authorized personnel and enabling detection and response to cybersecurity threats by initiating protective protocols. The vehicle seating system is virtually represented by a digital twin, which the generative AI engine utilizes to simulate and evaluate the effectiveness of fatigue mitigation strategies. This digital twin is capable of real-time updates with sensor data to accurately reflect the current state of the seating system and rider fatigue levels and may also be used for virtual testing of potential new seat materials and designs aimed at fatigue reduction.

In embodiments, the software-defined vehicle may feature a user-friendly interface that displays the AI-generated seat adjustment recommendations and allows the rider to provide feedback. This interface may include a haptic feedback mechanism to alert the rider about the need for a change in seating position, enhancing the interactive experience. Additionally, the interface may be designed to integrate seamlessly with a mobile application that monitors seating patterns and offers personalized fatigue mitigation advice based on output from the generative AI engine, promoting a comfortable and safe journey for the rider.

In embodiments, a software-defined vehicle may be equipped with a monitoring system that continuously observes the driver's interactions with vehicle controls and navigation systems for cognitive engagement and routing behavior analysis. This system may be designed to identify patterns in driving behavior that may indicate routine and potentially cognitively under-stimulating activities. Upon detecting such patterns, the vehicle's processor and memory, executing specialized software instructions, initiate the generation of cognitive challenges. These challenges are tailored to engage the driver's cognitive functions, such as memory recall, spatial navigation, and executive decision-making. For instance, the vehicle may present route deviation prompts that encourage the driver to navigate familiar routes without step-by-step navigation assistance, thereby stimulating the driver's spatial awareness and problem-solving skills.

In embodiments, a generative AI module within the vehicle may be configured to create a variety of cognitive tasks that stimulate key brain functions. This AI module may utilize a comprehensive database of information about the driver, including past driving experiences, to generate challenges that are both engaging and appropriate for the driver's cognitive abilities. The complexity of these challenges is dynamically adjusted by the AI based on real-time analysis of the driver's interactions with the challenges. For example, if the driver consistently performs well on certain types of tasks, the AI may increase the difficulty to provide a continuous cognitive stimulus.

In embodiments, the vehicle may include a gamification module and driver incentivization. For example, the gamification module may assign points and rewards for the successful completion of cognitive challenges, thereby introducing a competitive and rewarding element to the driving experience. The gamification module may include features such as a leaderboard, which fosters a competitive environment by allowing drivers to compare their performance with historical data or against other drivers. For example, rewards for completing challenges could range from virtual badges to unlocking new vehicle features, or even personalized messages of encouragement, all aimed at promoting regular cognitive engagement.

In embodiments, the vehicle may be designed to adapt an internal environment to create optimal conditions for cognitive function. The generative AI engine, in conjunction with environmental control systems, adjusts parameters such as cabin lighting and temperature based on factors like the time of day and the detected state of the driver. For example, the AI may increase cabin brightness during early morning drives to enhance alertness. Additionally, the vehicle may include an emergency intervention protocol that activates if the driver does not respond to cognitive challenges, potentially indicating an acute cognitive impairment. The emergency intervention protocol may take measures such as safely pulling the vehicle over and alerting emergency services.

In embodiments, recognizing the importance of physical activity in maintaining cognitive health, the software-defined vehicle may suggest periodic breaks for physical exercises during long journeys. The generative AI engine may propose a selection of exercises tailored to the driver's physical capabilities and preferences. Furthermore, the vehicle may feature a natural language processing module that enables the driver to interact with the system and the cognitive challenges using voice commands. This hands-free interaction ensures that the driver remains focused on the road while engaging with the cognitive tasks.

In embodiments, a vehicle maintenance system may utilize a data processing unit for an analysis of a comprehensive set of data that may include environmental conditions, user behavioral patterns, and vehicle diagnostic information. In an example, the environmental data encompasses variables such as weather patterns, daylight hours, and seasonal changes, which can influence a mood of a user and receptivity to vehicle maintenance activities. For instance, during winter months with shorter daylight hours, users may be less inclined to schedule maintenance due to the potential impact of seasonal affective disorder on their mood states. The emotional state detection module within the system may be engineered to discern patterns in emotional states of the user by analyzing the comprehensive data set. This module may infer mood states associated with different seasons to optimize user engagement with maintenance activities. For example, the system may detect that a user is more likely to respond positively to maintenance reminders during spring, a season sometimes associated with renewal and taking action.

In embodiments, user behavioral data may be a component of the analysis. The user behavioral data may include historical maintenance records, social media activity, and vehicle usage patterns. The emotional state detection module may leverage this data to identify periods when the user is historically more engaged in maintenance activities. For example, these periods could be times when the user has consistently scheduled maintenance in the past or periods of increased vehicle usage when maintenance becomes more pertinent.

In embodiments, a scheduling module of the system may employ generative AI algorithms to predict the most favorable times within a maintenance window to present maintenance recommendations to the user. This prediction is based on the user's emotional state patterns and historical engagement with maintenance activities. The generative AI algorithms may be, for example, similar to the AI system or the expert system/artificial intelligence features described herein, which process a wide range of parameters and inputs to inform decision-making processes.

In embodiments, a communication module uses generative AI to craft personalized maintenance notifications. These notifications are designed to resonate with the user's current mood and are seasonally adjusted to increase the likelihood of a positive response. For example, the generative AI may utilize AI systems like the hybrid neural network to process data to optimize interactions and responses.

In embodiments, the vehicle maintenance system may include a user feedback interface that allows for the collection of user responses to maintenance notifications. This feedback may be used by the scheduling module to refine and adjust future maintenance recommendations, ensuring a continuous improvement loop. The system's ability to delay maintenance recommendations during seasons associated with lower maintenance interest by the user demonstrates dynamic adaptability, as discussed herein.

In embodiments, a refueling planning system may integrate an emotional state system designed to predict changes in a user's emotional state in response to refueling decisions. For example, the refueling planning system may be a configuration of the artificial intelligence systems described herein. In embodiments, the emotional state system utilizes neural network configurations to detect and optimize for favorable emotional states of the user during the refueling process.

In embodiments, a fuel status system identifies a current fuel status of the vehicle and predicts future refueling requirements for a trip. In the context of the refueling planning system, refueling includes electrical storage charging and combustion fuel refilling.

In embodiments, a refueling recommendation engine generates a refueling plan that aligns with the user's emotional preferences and the vehicle's refueling requirements. In embodiments, the refueling recommendation engine optimizes parameters for a charging plan and uses neural networks to optimize vehicle operational states. For example, the refueling planning engine may use predictive models to generate refueling plans that consider both combustion fuel refilling and electrical energy storage refueling.

In embodiments, a generative AI module associated with the refueling recommendation engine simulates potential refueling and charging scenarios to generate the refueling plan. For example, the generative AI module may generate creative content and recommendations based on a set of inputs to simulate and evaluate various refueling scenarios to devise an optimal plan.

In embodiments, a digital twin may refer to a virtual representation that simulates vehicle operation and predicts future refueling needs. In embodiments, a user interface with graphical elements represents the impact of refueling options on emotional states. For example, the user interface may include negotiation systems and reward-negotiating systems. In embodiments, the user interface in the refueling planning system provides visual and interactive elements to engage the user and collect feedback. In embodiments, the refueling recommendation engine may analyze social media data to identify refueling locations to achieve positive emotional feedback.

In embodiments, any mobile platform can be fit with sensors in seats or to watch riders while they travel in the mobile platform. In examples, the sensors can be in the seats and experience the moving weight of the riders as the mobile platform moves along its journey. In examples, the sensors can watch the riders relative to fixed points in the mobile platform and determine the amount of motion experienced by the riders to estimate their motion in the seats. In examples, the sensors in the seats can be combined with sensors in the vehicle to determine occupant motion.

In embodiments, the sensors in the seats and/or around the mobile platform can keep track of how many hours you spent in the seat. In examples, the sensors can estimate pressure points on the riders. In examples, the sensors can detect various forms of movement. In examples, the sensors can estimate road vibrations.

In embodiments, the sensors can facilitate creation of and/or input for a digital twin that can detail the experience of one or more riders and how the journey affects the body. In examples, the transportation system can be onboard and/or accessible through a cloud facility that can connect to onboard and/or relevant mobile-connected devices and can host the digital twin. In examples, the digital twin can be used to take into account a complete (or at least more complete) journey so that exposure to vibrations on one journey on day can be determined to be cumulative and added to another journey in another vehicle or other mobile platforms.

In embodiments, the transportation system can then make recommendations as to various sources of exercise, stretching, body manipulation, or the like to mitigate any less than beneficial effects of one or more journeys as determined by the sensors that can sense the riders in the seats on their journeys.

In examples, the recommendations can include stretching and recommendations for stretching based on hours in the car, truck, or other mobile platforms.

In embodiments, there are several examples of suitable seat sensors that can determine riders' movement in seats from which to base a stretching or exercise routine. In examples, pressure sensors can measure the distribution of weight and pressure on the seat to detect movements and shifts in posture including whether a rider is sitting, leaning, or shifting position. In examples, the accelerometers can detect changes in acceleration, which can be used to infer movements and vibrations. By way of these examples, the placing of accelerometers within the seat can help identify when a rider is shifting, getting in or out of the seat, or making sudden movements. In examples, strain gauges can measure the deformation or strain on the seat caused by a rider's movement. By way of these examples, the strain gauges can detect bending or twisting of the seat, indicating changes in posture. In examples, capacitive sensors can detect changes in capacitance caused by the proximity or touch of a rider. By way of these examples, these sensors are often used in touchscreens and can also be integrated into seats to detect when a rider is sitting or moving. In examples, the ultrasonic sensors use sound waves to detect the distance between the sensor and an object (in this case, the rider). By placing these sensors under the seat, they can detect changes in distance as the rider moves. In examples, infrared sensors can detect the presence and movement of a rider based on changes in infrared radiation. They are commonly used in occupancy detection and can be applied to seats to determine when a rider is present or moving. In examples, the flex sensors are often thin, flexible strips that change resistance when bent. Placing them within the seat material can help detect when a rider is shifting or adjusting their position. In examples, the can generate an electric charge in response to mechanical stress. Placing them within the seat structure can detect vibrations caused by a rider's movements. In examples, optical sensors use light to detect changes in position or movement. Placed within the seat, they can identify when a rider is sitting, leaning, or changing position. In examples, magnetic sensors can detect changes in magnetic fields caused by the presence or movement of a rider. These sensors can be integrated into the seat structure to monitor changes in position. In examples, flex capacitive sensors can combine the principles of capacitive and flex sensors, allowing them to detect both touch and movement in a seat. In examples, force sensing resistors (FSR) change resistance based on the amount of force applied to them. Placing FSRs within the seat can detect shifts in weight and pressure. In examples, the gyroscope sensors can detect rotational movements and changes in orientation. When integrated into a seat, they can help identify when a rider is adjusting their sitting position. It will be appreciated in light of the disclosure that these sensors can be used individually or in combination to accurately detect and interpret riders' movements in seats for various applications such as automotive seats, office chairs, gaming chairs, boating chairs, and the like. The choice of the sensors can depend on the specific requirements of the application and the level of precision needed to capture the desired movements. It will be appreciated in light of the disclosure that in marine, off-road, military applications, and the like, further ruggedization of the sensors and other components can be provided to ensure durability within the given deployment.

In embodiments, the exercises that can be suggested can include deep breathing, which begins by taking deep breaths to help relax your body and reduce any tension. Inhale deeply through your nose, expanding your chest and abdomen, and then exhale slowly through your mouth. In examples, these instructions can be delivered at the vehicle or delivered to your home, place of residence, hotel, boat, or the like after the one or more journeys in the one or more mobile platforms. In examples, the exercises can include neck stretches that can include gently tilting your head to one side, bringing your ear towards your shoulder. Hold for about 15-20 seconds, then switch to the other side. You can also do forward and backward head nods to release neck tension. In examples, the exercises can include shoulder rolls that include rolling your shoulders in a circular motion, first forward and then backward. This can help release tension in your upper back and shoulders. In examples, the exercises can include a seated spinal twist that can include sitting upright and crossing one leg over the other at a 90-degree angle. Place the opposite elbow on the outside of the bent knee and gently twist your torso in that direction. Hold for about 15-20 seconds and then switch sides. In examples, the exercises can include a seated hamstring stretch that includes extending one leg straight out in front of you and flexing your foot. Lean forward slightly from your hips, keeping your back straight, and reach towards your toes. Hold the stretch for about 15-20 seconds on each leg. In examples, the exercises can include ankle circles that include lifting one foot off the ground while seated and rotate your ankle in circular motions. This helps improve blood circulation and reduce stiffness in your ankles. In examples, the exercises can include a seated cat-cow stretch that includes sitting on the edge of your seat with your feet flat on the floor. Place your hands on your knees. As you inhale, arch your back and look up (cow pose), and as you exhale, round your back and tuck your chin towards your chest (cat pose). In examples, the exercises can include a quad stretch that can include standing up and holding onto something for balance. Bend one knee and grab your ankle behind you. Gently pull your foot towards your glutes to stretch your quadriceps. Hold for about 15-20 seconds on each leg. In examples, the exercises can include calf raises that can include standing with your feet hip-width apart. Slowly rise up onto your toes, lifting your heels off the ground. Then lower them back down. Repeat this motion for about 10-15 repetitions to stretch your calf muscles. In examples, the exercises can include a seated forward fold that can include sitting on the edge of a chair with your legs extended in front of you. Hinge forward from your hips, reaching your hands towards your feet. Keep your back straight and hold the stretch for about 15-20 seconds.

In embodiments, mobile platforms in which beneficial functions of the system can be deployed can include car, buses, off-road vehicles, trucks, motorcycles, bicycles, horseback riding, boat rides, airplane rides, trains, helicopters, ski lifts, amusement park rides, and the like.

After riding a bumpy form of transportation and feeling a bit uncomfortable or stiff, a rider might want to perform some exercises to help alleviate any discomfort. By way of these examples, the instructions for exercises can be sent to mobile apps, email, text message, QR code, printed handout, website link, local audio guide, in-app notification based on one or more user selected apps, a kiosk or information booth, social media, and/or virtual assistants. In embodiments, the exercises can be done in one or more locations such as at home, outdoors, a gym, an office, a hotel room, a community center, a professional yoga or pilates studio, any beach or lake, any quiet park, and the like. It will be appreciated in light of the disclosure that the exercises can be done in various settings depending on preferences and the resources available. In embodiments, exercises can be completed in whole or portions that can or may not be carried over to following days. In examples, massage can be integrated into the suggestions so as to not always rely on individual stretching.

While only a few embodiments of the disclosure have been shown and described, it will be obvious to those skilled in the art that many changes and modifications may be made thereunto without departing from the spirit and scope of the disclosure as described in the following claims. All patent applications and patents, both foreign and domestic, and all other publications referenced herein are incorporated herein in their entireties to the full extent permitted by law.

It will be appreciated in light of the disclosure that the routine use of navigation such as turn-by-turn guidance or other regular prompts during a trip can contribute, along with other factors, to reduced neural capacity in drivers in the long term. It can be shown that can eventually lead to drivers becoming overly dependent on their navigation systems, along with potentially diminishing their memory and increasing the likelihood of developing other neurological conditions. It will further be appreciated in light of the disclosure that additional route guidance or purposeful lack of route guidance can convey many of the benefits of conventional navigation systems without the aforementioned disadvantages. Rather than providing turn-by-turn guidance in the form of visual and auditory prompts to help a driver adhere to a predetermined route, a more limited form of assistance can be provided using conventional navigation systems. Such systems are deployed in vehicles, on smartphones, via wearables, or through other types of mobile devices. The following are two example use cases that describe user-selectable levels of navigation prompts and their implied effects on driver behavior and route optimization.

### Use-Case Example 1: Route Deviation

In an example, a trip begins with the driver or other user inputting one or more destinations into their navigation system. User-selectable graphics are then presented, which could include a map, a list of turn-by-turn directions, or other route visualization. Rather than presenting prompts in advance of each turn or step of the route, reactive prompts are presented after a driver deviates from the predetermined route. These prompts can provide varying levels of assistance depending on user preference. For example: Warning—(e.g., “You've deviated from your selected route.”); Warning+Offer for Minimal Assistance—(e.g., “You've deviated from your selected route. Would you like help returning to your route?”); and Warning+Offer for Full Assistance—(e.g., “You've deviated from your selected route. Would you like turn-by-turn directions for the rest of your trip?”)

### Use-Case Example 2: Changing Conditions

In an example, a trip begins with the driver or other user inputting one or more destinations into their navigation system. User-selectable graphics are then presented, which could include a map, a list of turn-by-turn directions, or other route visualization. Rather than presenting prompts in advance of each turn or step of the route, reactive prompts are presented after the navigation system receives updated traffic, weather, road closure, or other condition information about the originally selected route. These prompts can provide varying levels of assistance depending on user preference and based on the severity of delays or other conditions that arise during a trip: Warning—(e.g., “A crash ahead has caused an estimated delay of x minutes.”); Warning+Offer for Minimal Assistance—(e.g., “A crash ahead has caused an estimated delay of x minutes on your selected route. Divert to Highway X to avoid this delay.”); and Warning+Offer for Full Assistance—(e.g., “An accident ahead has caused an estimated delay of x minutes on your selected route. Would you like to use a new route with turn-by-turn directions?)

These use cases are intended to be simplified examples of limited route guidance. Other events that could cause delays to a selected route or make it impassable may also be used as triggers for navigation system intervention. Additionally, more granular levels of intervention and subsequent assistance by the navigation system can also be included.

With the proliferation of voice command capabilities in vehicle infotainment systems and smartphones, user preference selection and responses to auditory (voice) prompts as described in these example use-cases can typically be safely performed by a driver during a trip.

Gamification may also be applied to navigation systems using limited route guidance. For example, the navigation system can keep track of which destinations or routes are new for each driver along with how many times they have driven each route or to each destination. The navigation system can award points to the driver proportional to the complexity and length of the route and inversely proportional to the amount of navigation assistance they require combined with how many times they've driven that route or to that destination. That is, a new destination or route successfully reached by a driver on the first attempt with no navigation assistance is rewarded with maximum points.

Waypoints may be added along the journey to facilitate further gamification points in play. Waypoints can also be added along the journey to facilitate the decision whether to add navigation aids or to remove them. In those examples, the navigation aids can be increased as the overall distance from not yet visited waypoints increases. Waypoints from previous trips can also be added as further data points in gamification and can be noted to increase the mental acuity of the driver.

In embodiments, the transportation methods and systems described herein may include the use of a generative artificial intelligence engine (GAIE) within a vehicle's ecosystem. The GAIE may be designed to generate data, predictions, and responses based on a multitude of inputs from vehicle sensors, user inputs, and external data sources. The GAIE is capable of learning and adapting over time, improving its functionality and the vehicle's performance and user experience.

In embodiments, the GATE may be integrated with various transportation and vehicle systems, as described herein, including, but not limited to: powertrain control—the GAIE may, in an example, optimize fuel efficiency and power output by analyzing driving patterns, road conditions, and real-time engine data, and/or generate novel engine tuning profiles for different driving conditions; autonomous driving features—the GAIE may, in an example, enhance autonomous driving capabilities by generating predictive models of traffic patterns, pedestrian behavior, and environmental conditions and/or simulate and learn from virtual driving scenarios to improve decision-making algorithms; infotainment and user interface—the GAIE may, in an example, personalize a user's experience by learning driver preferences and generating custom infotainment content and/or predict and suggest routes, music, or cabin settings based on the driver's habits and current context; maintenance and diagnostics—the GAIE may, in an example, predict vehicle maintenance needs by analyzing sensor data and historical maintenance records and/or generate maintenance schedules and proactive measures to prevent breakdowns; safety systems—the GATE may, in an example, improve vehicle safety by generating real-time responses to potential hazards, such as deploying airbags optimally or adjusting suspension settings for better control during an emergency maneuver.

In embodiments, the GATE may receive data from an array of sources, including, but not limited to, onboard sensors (e.g., LIDAR, cameras, accelerometers), user input (e.g., touch inputs, voice commands), external data sources (e.g., GPS, traffic reports, weather forecasts), and vehicle maintenance records and historical data. In an example, the GAIE may process such data, as described herein, to learn and adapt its functions, including using a feedback loop to continuously improve its predictions and outputs based on the outcomes of its previous actions.

In embodiments, users can interact with the GATE through, for example, voice commands, touch interfaces, or through a dedicated app. The GATE may generate responses and take actions based on user requests, such as adjusting the vehicle's interior environment or planning a trip itinerary.

In embodiments, the GAIE may employ a variety of machine learning algorithms to process data and generate outputs. The algorithms may include, but are not limited to, convolutional neural networks (CNNs), for example used for processing visual data from cameras and LIDAR sensors, and the like. In an example, CNNs may assist the GATE in object detection, classification, and environmental understanding crucial for autonomous driving and safety systems; recurrent neural networks (RNNs) for example utilized for temporal data analysis and in predicting time-series events such as traffic flow or driver behavior patterns over time; generative adversarial networks (GANs) for example, employed for generating new data points and/or used in the GAIE to simulate driving scenarios, design new engine tuning maps, and create personalized infotainment content; reinforcement learning (RL) for example using an algorithm to assist the GAIE in learning optimal actions through trial and error and/or to improve decision-making in autonomous driving and to optimize powertrain control for better fuel efficiency and performance; genetic algorithms (GAs) for example used for optimization problems, such as finding the best route for a trip considering current traffic conditions, or optimizing the layout of sensors and components within the vehicle for cost and performance.

In embodiments, the GATE may use a plurality of data sources to inform its learning and decision-making processes including, but not limited to, onboard sensors, including LIDAR, cameras, accelerometers, gyroscopes, thermometers, and pressure sensors. Data from such sensors may provide real-time information about the vehicle's environment and internal state; user input, for example, touch commands on the vehicle's display, voice commands captured by onboard microphones, and settings preferences set by the user may be fed into the GATE to tailor the driving experience to individual preferences; external data sources may be used for comprehensive situational awareness, for example data sources such as GPS for location tracking, real-time traffic report systems, weather forecast services, and even social media or event databases for contextual recommendations; vehicle maintenance records and historical data may be used, including in aggregated form, to predict future maintenance needs and to learn from past incidents; vehicle-to-vehicle (V2V) and vehicle-to-infrastructure (V2I) communications may be used, including data received from other vehicles and infrastructure elements, such as traffic lights and road sensors, are used to enhance the GAIE's situational awareness and decision-making capabilities.

In embodiments, the GAIE may be designed with adaptive learning capabilities, allowing it to refine its algorithms based on feedback including, but not limited to, supervised learning—the GAIE may, in an example, use labeled data to learn the correct output for given inputs for tasks like image recognition and predictive maintenance; unsupervised learning—the GAIE may, in an example, cluster and interpret unlabeled data to find patterns or anomalies for identifying novel driving conditions or diagnosing unexpected vehicle behavior; semi-supervised learning—the GAIE may, in an example, leverage a combination of labeled and unlabeled data, for example when there is a limited amount of labeled data available; reinforcement learning feedback loops—the GAIE may, in an example, use reinforcement learning to take actions and receive feedback in the form of rewards or penalties, allowing it to learn optimal strategies over time.

In example embodiments, a generative artificial intelligence engine (GAIE) may be combined with a machine learning system in a transaction environment. Input to the GAIE may include images, video, audio, text, programmatic code, data, and the like. Outputs from a GAIE may include structured and organized prose, images, video, audio content, software/programming source code, formatted data (e.g., arrays), algorithms, definitions, context-specific structures (e.g., smart contacts, transaction platform configuration data sets, and the like), machine language-based data (e.g., API-formatted content), and the like. For GAIE instances in which the models are designed to process text data, the GAIE may interface to other programmatic systems (such as traditional machine learning engines) to process other forms of data into text data. In example embodiments, the other programmatic systems, including systems executing machine learning algorithms, may produce textual based (optionally at volume) that may be consumed by GAIE. For example, consider such another system building a series of one thousand text-based observations on the other-formatted data; this may be a useful input for a GAIE model to learn and process (e.g., summarize) into text-formatted output information. In example embodiments, an interface between the GAIE and its combined machine learning system may be extended to include a dialogue between the systems, where the GAIE includes and/or accesses a capability to ask the machine learning system specific questions to facilitate the refining of its knowledge. For example, the dialogue capability may include a request of the machine learning system to provide an assessment of current market trading positions. In another example, the dialogue capability may encode numeric outputs from the machine learning engine into text (e.g., words, such as high, medium, low) that may be input for interpretation by the GAIE.

In example embodiments, the data processed by a GAIE may include one or more types of content. For example, a GAIE may receive, as input, data that represents one or more natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives and/or resources such as shaders, device configurations such as HDL specifications for programming FPGAs, databases and/or database structural definitions, or the like, including metadata associated with any such data types. Input to the GAIE may also include data that represents one or more features of another machine learning model, such as a configuration (e.g., model type, parameters, and/or hyperparameters), input, internal state (e.g., weights and biases of at least a portion of the model), and/or output of the other machine learning model. These and other forms of content may be received as various forms of data. For example, a natural-language expression received as input by a GAIE could be encoded as one or more of: encoded text, an image of a writing, a sound recording of human speech, a video of an individual exhibiting sign language, an encoding according to a machine learning model embedding, or the like, or any combination thereof. In example embodiments, an input received and processed by the GAIE can include an internal state of the GAIE, such as a partial result of a partial processing of an input, or a set of weights and/or biases of the GAIE as a result of prior processing (e.g., an internal state of a recurrent neural network (RNN)).

In some embodiments, the data and/or content received and processed by a GAIE originates from one or more individuals, such as a person speaking a natural-language expression. In some embodiments, the data and/or content received and processed by a GAIE originates from one or more natural sources, such as patterns formed by nature. In some embodiments, the data and/or content received and processed by a GAIE originates from one or more other devices, such as another machine learning model executing on another device, or from another component of the same device executing the GAIE, such as output of another machine learning model executing on the same device executing the GAIE, or a sensor in an Internet-of-Things (IOT) and/or cloud architecture. In some embodiments, the data and/or content received and processed by a GAIE is artificially synthesized, such as synthetic data generated by an algorithm to augment a training data set. In some embodiments, the data and/or content received and processed by a GAIE is generated by the same GAIE, such as an internal state of the GAIE in response to previous and/or concurrent processing, or a previous output of the GAIE in the manner of a recurrent neural network (RNN).

In some embodiments, at least some or part of the data and/or content received and processed by a GAIE is also used to train the GAIE. For example, a variational GAIE could be trained on an input and a corresponding acceptable output, and could later receive the same input in order to output one or more variations of the acceptable output. In some embodiments, at least some or part of the data and/or content received and processed by a GAIE is different than data and/or content that was used to train the GAIE. In some such embodiments, the data and/or content received and processed by the GAIE is different than but similar to the data and/or content that was used to train the GAIE, such as new inputs that are exhibit a similar statistical distribution of features as the training data. In some such embodiments, the data and/or content received and processed by the GAIE is different than and dissimilar to the data and/or content that was used to train the GAIE, such as new inputs that exhibit a significantly different statistical distribution of features than the training data. In scenarios that involve dissimilar inputs, one or more first outputs of the GAIE in response to a new input may be compared to one or more second outputs of the GAIE in response to inputs of the training data set to determine whether the first outputs and the second outputs are consistent. The GAIE may request and/or receive additional training based on the new inputs and corresponding acceptable outputs. In scenarios that involve dissimilar inputs, the GAIE may present an alert and/or description that indicates how the new inputs and/or corresponding outputs differ from previously received inputs and/or corresponding outputs.

In example embodiments, the output of a GAIE may include one or more types of content. For example, a GAIE may generate, as output, data that represents one or more natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives and/or resources such as shaders, device configurations such as HDL specifications for programming FPGAs, databases and/or database structural definitions, or the like, including metadata associated with any such data types. Output of the GAIE may also include data that represents one or more features of another machine learning model, such as a configuration (e.g., model type, parameters, and/or hyperparameters), input, internal state (e.g., weights and biases of at least a portion of the model), and/or output of the other machine learning model. These and other forms of content may be generated by the GAIE as various forms of data. For example, a natural-language expression generated as output by the GAIE could be encoded as one or more of: encoded text, an image of a writing, a sound recording of human speech, a video of an individual exhibiting sign language, an encoding according to a machine learning model embedding, or the like, or any combination thereof. In example embodiments, an output of the GAIE can include an internal state of the GAIE, such as a partial result of a partial processing of an input, or a set of weights and/or biases of the GAIE as a result of prior processing (e.g., an internal state of a recurrent neural network (RNN)).

In example embodiments, a language-based dialogue-enabled GAIE may be configured to produce (e.g., write) new machine learning models that may process various types of data to provide new and extended text input for processing by the GAIE. In example embodiments, humans may observe and interact with this ongoing dialogue between the two systems. In example embodiments, the dialogue is initiated by an expression of a conversation partner (e.g., a human or another device), and the GAIE generates one or more expressions that are responsive to the expression of the conversation partner. In example embodiments, the GAIE generates an expression to initiate the dialogue, and further responds to one or more expressions of the conversation partner in response to the initiating expression. In example embodiments, the ongoing dialogue occurs in a turn-taking manner, wherein each of the conversational partner and the GAIE generating an expression based on a previous expression of the other of the conversation partner and the GAIE. In example embodiments, the ongoing dialogue occurs extemporaneously, with each of the conversation partner and the GAIE generating expressions irrespective of a timing and/or sequential ordering of previous and/or concurrent expressions of the conversation partner and/or the GAIE.

In example embodiments, the dialogue occurs between a GAIE and a plurality of conversation partners, such as two or more humans, two or more other GAIEs, or a combination of one or more humans and one or more other GAIEs. In some such example embodiments, the GAIE and each of the other conversation partners take turns generating expressions in response to prior expressions from the GAIE and the other conversation partners. In some such embodiments, one or more sub-conversations occur among one or more subsets of the GAIE and the plurality of conversation partners. Such sub-conversations may occur concurrently (e.g., the GAIE concurrently engages in a first conversation with a first conversation partner and a second conversation with a second conversation partner) and/or consecutively (e.g., the GAIE concurrently engages in a first conversation with a first conversation partner, followed by a second conversation with a second conversation partner). Such sub-conversations may involve the same or similar topics or expressions (e.g., the GAIE may present the same or similar conversation-initiating expression to each of a plurality of conversation partners, and may concurrently engage each of the plurality of conversation partners in a separate conversation on the same or similar topic). Such sub-conversations may involve different topics or expressions (e.g., the GAIE may present different conversation-initiating expressions to each of a plurality of conversation partners, and may concurrently engage each of the plurality of conversation partners in a separate conversation on different topics). In example embodiments, a first conversation among a first subset of the GAIE and conversation partners may be related to a second conversation among a second subset of the GAIE and conversation partners (e.g., the second subset may engage in a second conversation based on content of the first conversation among a first subgroup).

In example embodiments, one or more of the GAIE and the conversation partner may embody one or more roles. For example, the GAIE may generate expressions based on a role of a conversation starter, a conversation responder, a teacher, a student, a supervisor, a peer, a subordinate, a team member, an independent observer, a researcher, a particular character in a story, an advisor, a caregiver, a therapist, an ally or enabler of a conversation partner, or a competitor or opponent of a conversation partner (e.g., a “devil's advocate” that presents opposing and/or alternative viewpoints to a belief or argument of a conversation partner). In example embodiments, at least one of the one or more conversation partner embodies one or more aforementioned roles or other rules. In example embodiments, a role of a GAIE is relative to a role of a conversation partner (e.g., the GAIE may embody a superior, peer, or subordinate role with respect to a role of a conversation partner). In example embodiments, a role of a GAIE in a first conversation among a first subset of the GAIE and a plurality of conversation partners may be the same as or similar to a role of a GAIE in a second conversation among a first subset of the GAIE and the plurality of conversation partners. In example embodiments, a role of a GAIE in a first conversation among a first subset of the GAIE and a plurality of conversation partners may differ from a role of a GAIE in a second conversation among a first subset of the GAIE and the plurality of conversation partners (e.g., the GAIE may embody a role of a teacher in a first conversation and a role of a student in a second conversation). In example embodiments, a role of a GAIE in a conversation may change over time (e.g., the GAIE may first embody a role of a student in a conversation, and may later change to a role of a teacher in the same conversation). In example embodiments, a GAIE may embody two or more roles in a conversation (e.g., the GAIE may exhibit two personalities in a conversation that respectively represent one of two characters in a story). In example embodiments, a GAIE generates expressions between two or more roles in a conversation (e.g., the GAIE may generate a dialogue between each of two characters in a story). In example embodiments, a GAIE may engage in each of multiple conversations in a same or similar modality (e.g., engaging in multiple text-based conversations concurrently). In example embodiments, a GAIE may engage in each of multiple conversations in different modalities (e.g., engaging in a first conversation via text and a second conversation via voice).

In example embodiments, a GAIE participating in a conversation is associated with an avatar (e.g., a name, color, image, two- or three-dimensional model, voice, or the like). Expressions generated by the GAIE may be presented as if originating from the GAIE (e.g., in the voice associated with the GAIE, or in a speech bubble that is displayed near a visual position of a GAIE in a virtual or augmented-reality environment). In example embodiments, an avatar of a GAIE may be based on a role of the GAIE (e.g., a GAIE embodying a role of a teacher may be associated with an avatar depicting a teacher). In example embodiments, an avatar of a GAIE may be included in a real-world actor, such as a robot in a real-world environment such as a stage performance.

In example embodiments, a GAIE may include generative pretrained transformer elements that may be configured as a language model designed to understand various types of input and produce chat commands for a chat-type interface system. These commands may include software development tasks, API calls, and the like. In example embodiments, such a language model may include input functions that support receiving images, including video, to build textual output, functions, and additional questions that may be injected into the dialogue between the two systems in the dialogue embodiment described above. In example embodiments, this multimodal support may allow for contextual analysis of images and other media formats. In an example, users/customers may upload images or other media into a GAIE enabled platform. Based on aspects of a corresponding input prompt, a multi-modal GAIE may be configured for use in a valuation workflow to identify both macro and micro attributes and their correlated effects on valuation from a plurality of perspectives. In this example, photographs/images of an old car may be input along with a valuation-related prompt. In response, the GAIE may identify one or more typical values based on detected attributes of the car, such as the make/model, etc. The GAIE may further take into account finer details in the image to suggest potential value-altering metrics. In one example, a finer detail in the image such as damaged body panels may reduce the car value below a typical value. In another example, a finer detail in the image that shows a marking consistent with a limited production run may increase the valuation.

In example embodiments, such a GAIE may facilitate workflow orchestration for a process that uses a conversational, generative AI agent and another AI-supported process in an orchestrated sequence. In example embodiments, a GAIE may generate, perform, maintain, and/or supervise one or more workflows in a robotic process automation (RPA) environment. For example, a GAIE may be trained to monitor expressions and/or actions of an individual during interaction with other individuals, and may generate similar expressions and/or perform similar actions during similar interactions between the GAIE and other individuals. In some such scenarios, the GAIE passively observes the individual during the interactions with other individuals and self-trains to behave similarly to the individual in similar interactions with other individuals. In some such scenarios, the individual actively trains and/or teaches the GAIE to generate expressions and/or actions (e.g., by creating and/or performing example or pedagogical interactions the GAIE), and based on the training and/or teaching, the GAIE behaves similarly during subsequent interactions between the GAIE and other individuals. In example embodiments, the GAIE is trained and/or taught by an individual to perform a behavior while interacting with individuals, and subsequently performs the behavior while interacting with the same individual who provided the training and/or teaching.

In example embodiments, a pretrained GAIE system may have a smart contract analysis engine that determines one or more features of a smart contract that is under consideration by a user. The GAIE may further have a conversation engine that explains the features of the smart contract to the user, including summarizing contents of smart contracts.

In example embodiments, a GAIE may be pre-trained to perform prompt generation based on a data story or a plurality of sources across systems. Example generated prompts may include instructing and/or requesting the pre-trained GAIE to tell a story about a journey of a product, a business relationship, an event, a service provider, a smart container fleet, a robotic fleet, and the like.

In example embodiments, a GAIE may be pre-trained to generate multi-modal and/or multi-media data stories. In an example of in-cabin push-narration of maintenance/repair sequence of events and locations based on a sensor reading, a sensor detects a drop in oil pressure while an automobile is in use. A data story narrative may be created based on datasets such as 1) the historical oil pressure readings for the specific car; 2) data about oil pressure issues with the make/model/year of the specific car (e.g., service reports, recalls, prevalence of given issues, points of failure etc.); 3) data regarding remediation of potential issues (timing and types of recommended remediation or repair; 4) data regarding the location of organizations qualified to inspect or repair the diagnosed issue that might be causing the drop in oil pressure, based on proximity to current location of the car, cost, quality of customer reviews, certifications of employees and so on. This may be presented to the driver or rider of the vehicle automatically in the form of a paragraph narration similar to “The oil pressure of the vehicle may be X % lower than the recommended level. This may be caused by X, Y or Z. Based on the reading from the Z sensor, it appears that the most likely cause of the oil pressure drop may be X. There are two known part points of failures known to potentially cause this pressure drop and there are 5 service facilities within 5 miles of the car's current location that are qualified to evaluate and repair this problem. Of these, Shop 1 has the highest customer satisfaction, Shop 2 has the lowest part cost and Shop 3 has the highest number of certified employees for your make and model. The phone number for Shop 1 is . . . . Please indicate if you would like to initiate a call to arrange an appointment for the car to be inspected . . . ”

In example embodiments, the GAIE may receive a plot or outcome of the story, and may generate content that is content with the plot or that produces the outcome. In example embodiments, the GAIE may generate a plot or outcome of the story, and may also generate content that is consistent with the GAIE-generated plot or outcome of the story. In example embodiments, the GAIE may receive a world or environment of a story, and may generate content that occurs within the given world or environment. In example embodiments, the GAIE may generate a world or environment of a story, and may also generate content that occurs within the GAIE-generated world or environment. In example embodiments, the GAIE may receive a character or event to be included in a story, and may generate content that includes the given character or event in the story. In example embodiments, the GAIE may generate a character or event to be included in a story, and may also generate content that includes the GAIE-generated character or event in the story. In example embodiments, the GAIE may generate a world, environment, character, event, or the like “from scratch” (e.g., based on randomized inputs). In example embodiments, the GAIE may generate a world, environment, character, event, or the like based on a given world, environment, character, event, or the like (e.g., a story that is based on a real-world public figure or event).

In example embodiments, the GAIE may receive a first story and may generate a second story that is related to the first story. For example, the GAIE may generate a second story that is an alternative retelling of the first story (e.g., a second story that includes a retelling of the first story from a perspective of a different character than a narrating character of the first story). The GAIE may generate a second story that occurs in a same or similar world or environment as the first story, or a different world or environment that is related to a world or environment of the first story. The GAIE may generate a second story that features a character or event of the first story, or a different character or event that is related to a character or event of the first story.

In example embodiments, the GAIE may generate a story from the perspective of a narrator or independent observer of the story (e.g., a third-person story). In example embodiments, the GAIE may generate a story from the perspective of a character or point of view within the story (e.g., a first-person story), including a character generated and/or embodied by the GAIE. In example embodiments, the GAIE may generate a story from the perspective of a listener or audience member to whom the story is presented (e.g., a second-person story). In example embodiments, the GAIE may generate a story from multiple perspectives, such as a first part of a story generated from a perspective of a first character, a second part of the story generated from a perspective of a second character, and a third part of a story generated from a perspective of a narrator. In example embodiments, the GAIE may generate a story involving a sequence of two or more events (e.g., a story that involves two or more events observed by a character). In example embodiments, the GAIE may generate a story involving an event that is portrayed from multiple perspectives (e.g., a story that describes an event from a perspective of a first character, and that also describes the same event from a perspective of a second character).

In example embodiments, a GAIE may generate a static story that remains the same upon retelling. In example embodiments, the GAIE may generate a dynamic story that changes upon retelling (e.g., adding more detail to a story upon each retelling). In example embodiments, a GAIE may change a story based on an input of a user (e.g., based on a choice of outcomes selected by one or more receivers of the story). In example embodiments, a GAIE may generate a story based on one or more inputs received from one or more receivers of the story (e.g., based on a prompt of a user, such as a request to create a story that includes a certain event specified by the user). In example embodiments, a GAIE may receive feedback from a receiver about a story (e.g., an expression of pleasure, displeasure, approval, disapproval, delight, dissatisfaction, confusion, or the like regarding a character, event, or property of the story), and the GAIE may update the story based on the feedback (e.g., adding, removing, or clarifying an event in the story, or switching a perspective of an event from a first character in the story to a second character in the story).

In example embodiments, a GAIE may be trained by loading data (such as structured and un-structured data that may be dominated by numerical or non-text values) to the GAIE. Examples of such training data may include one or more database schemas. Techniques for curation and integration of purpose-specific data, including curation of models as inputs to a GAIE may include curating domain-specific data, data and model discovery.

Candidate areas of innovation enabled by and/or associated with GAIE advances may include user behavior models (optionally with feedback and personalization), group clustering and similarity, personality typing, governance of inputs and process, explaining the basis of GAIE knowledge and proof points, genetic programming with feedback functions, intelligent agents, voice assistants and other user experiences, transactional agents (counterparty discovery and negotiation), agents that deal with other agents, opportunity miners, automated discovery of opportunities for agent generation and application, user interfaces that adapt to the user and context, hybrid content generation, collaboration units of humans and generative AI, purpose-specific data integration, a selected set of data sources, curation of data as models as input to generative AI, and the like.

In embodiments of a GAIE-enabled system, such as one for robotic process automation, the GAIE system may summarize a set of actions being subjected to robotic automation and describe context for the actions, such as, “I found these properties as fitting your criteria because of the following features. Which ones are most attractive?” In this way, a process automation system enabled with GAIE may solicit feedback for faster feedback-based training.

In example embodiments, emerging capabilities of GAIE technology may greatly improve upon earlier versions in terms of, for example, integration of domain-specific knowledge (e.g., math) with a chat interface. Further emerging capabilities may include being better informed about and for processing prompts of complex topics. Yet further, knowledge organization is becoming much improved as GAIE systems evolve. In example embodiments, updated GAIEs may correctly answer a prompt asking about today's date, whereas prior versions may answer that today's date (e.g., the current date) may be the date on which the GAIE was last trained.

In example embodiments, a context pretrained (e.g., subject matter focused) GAIE may provide better personalization than a base GAIE instance. In general, while a base GAIE, if explicitly informed of details of the user may attempt to personalize its responses, a subject matter focused or other pre-trained GAIE may be configured with and/or with access to structured information about users (e.g., determined based on user identification and/or prompt-based clues, and the like) to provide inherent, latent context for a dialogue that includes user personalized responses.

In example embodiments, a GAIE is configured to support interpretability and/or explainability of its outputs. In example embodiments, a GAIE provides, along with an output, a description of a basis of the output, such as an explanation of the reason for generating this particular output in response to an input. In example embodiments, a GAIE provides, along with an output, a description of an internal state of the GAIE that resulted in the output, such as a set of variational parameters of a variational encoder that were processed in combination with an input to produce an output, and/or an internal state of the GAIE due to a previous processing of the GAIE that resulted in the output (e.g., similar to a recurrent neural network (RNN)). In example embodiments, a GAIE provides, along with an output, an indication of one or more subsets of features of an input that are particularly associated with the output (e.g., in a GAIE that outputs a caption or summary of an image, the GAIE can also identify the particular portions or elements of the image that are associated with the caption or portions of the summary).

In example embodiments, an advanced GAIE, such as one pretrained for subject matter specific operation, may be trained for improved epistemology, to help determine evidence of the content that it represents as facts in responses that it provides. One example of improved epistemology may include citing sources of knowledge pertinent to facts in a response as a step toward proof of facts of a response-essentially a way of the GAIE “showing its work,” or at least where its work originates. In example embodiments, a GAIE generates output based on information received from one or more external sources (e.g., one or more messages in a message set, or one or more websites on the Internet), and the GAIE indicates one or more portions of the information that are associated with the output (e.g., one or more websites on the Internet that provided information that is included in the output of the GAIE).

An advanced GAIE as described and envisioned herein may maintain contextual awareness across chat (user-prompt/GAIE-response) interactions. Maintaining contextual awareness may help avoid the GAIE beginning each chat session from scratch, with no context as to prior chats with the same user. Maintaining contextual awareness may also enable picking up and resuming a conversation from earlier interactions between the GAIE and a user. Yet further maintaining contextual awareness and awareness of passage of time between interaction sessions may facilitate adapting responses to prompts in a later resumed chat session based on trained knowledge of the intervening passage of time and/or changing circumstances. In an example, a GAIE may determine that a deadline described in an earlier chat has expired, a consequential intervening event has occurred (your home-town team lost the big game), and the like. Further, contextual awareness across time-separate chat sessions may be highly valuable when being employed for projects that may have real-world physical constraints on time (e.g., smart contract negotiation may involve human evaluation, discussion, and decision making that may take time based, for example on other priorities seeking involvement of the human). This may determine the difference between treating each conversation as individual/compartmentalized/isolated, and treating ongoing, time-separated conversations as resumable, optionally as if (almost) no time had passed. In example embodiments, a GAIE may be configured with a contextualization module that maintains some notion of conversation sessions and interconnections that may be referred (e.g., a conversation from yesterday) for details and continuity. This contextualization may further enable avoiding repeating responses, making it more efficient to reference a previous conversation. Yet further, a contextualization module may provide context to the GAIE of other conversations between the user and the system, between other users and the system, and the like.

In such a contextually maintained instance, a context-enabled GAIE may provide a response regarding forecasted weather that references an earlier period of time. In an example, a context-enabled GAIE may provide a weather-related response such as, “On Monday, we discussed the weather, you asked if you would need an umbrella on Wednesday, and I answered ‘probably not’ based on the forecast at that time. I need to inform you that the updated weather forecast indicates that rain may be more likely on Wednesday, so you probably may need an umbrella.”

Other capabilities of emerging GAIE systems may include adapting a GAIE to the generation and operation of digital avatars. In example embodiments, digital avatars may be programmed with their own visual representations. To accomplish greater similarity between an avatar and its owner based on visual and audio interpretation of users, a GAIE training and/or pre-training data set may require information about body language and nonverbal cues, such as gaze, posture, speech pitch and volume, and the like.

Emerging GAIE systems may include determining and adapting responses with variations and nuances based on, for example, user activities. A user's physical disposition may influence content production by a GAIE (e.g., presenting different cues) based on if the user is sitting, walking, driving, exercising, and the like. Further, a GAIE system may adapt responses to prompts based on variations and nuances of real-life interactions versus voice interfaces versus virtual reality. Other aspects that may impact GAIE responding to prompts may include variations and nuances of different cultures, demographics, and the like. Yet further, in example embodiments, methods and systems for advanced GAIE training and operation may include recognition of higher-level communication features of users (humor, sarcasm, dishonesty, double entendre, etc.) and user emotional state, for example.

In example embodiments, methods and systems for enhancing GAIE platforms, such as those described herein, may include configuring a GAIE to participate in multi-user dialogue, where strict turn-taking interaction with one person might be difficult in a group setting, where the context of who may be speaking to whom matters for each expression. The more fluid multi-user conversational structure vs. turn-taking structure may indicate advances to a GAIE may include developing understanding of: social interactions and cues, such as to whom each expression may be directed; group dynamics (e.g., who may be the group leader?) and interpersonal relationships; the notion of threaded discussions with branches; concurrent discussions between various sub-groups of a group; when to chime in with input so as to avoid interrupting other users; some notion about conversational balance, to avoid dominating the conversation; tact: users' sensitivity about personal information, and when it may and cannot be shared in a group setting based on context, relationships with other users, and the like.

Independent of whether interactions are one-on-one or multi-user, it is envisioned that a GAIE may be adapted to evolve beyond a turn-taking paradigm. In an example, a GAIE may currently create media (images, music, video, and the like) based on a user prompt (that itself may be one or more types of media), and may refine the created media based on user interactions, such as changing the content in certain ways or extending the boundaries of an image with more content that may be consistent with the existing content (e.g., outpainting). A more sophisticated version of generative AI may flexibly and continuously adapt its generated content to contextual user input and interactions. In an example, generating media may be adapted by the GAIE in response user integration with the generated media content, such as in response to allowing a user to virtually walk around inside the content to interact with and/or react to content items. Such a media-adapting GAIE may generate new content or update the content based on the user input/content virtual interactions. Yet further to facilitate a user to virtually interact immersively with generated content details about the user may be considered part of the criteria for newly generating and/or updating the media.

In example embodiments, a media-output enabled GAIE without user immersive interaction and feedback may generate media (e.g., a first image) based on a prompt in which a user specifies a theme for a story. The user may then specify a series of scenes that follow, and the GAIE generates an image for each scene, leading to a storyboard series for the story.

When a media-out enabled GAIE is teamed with user immersive capabilities, the user may control, for example, an avatar that may walk around within the scene and interact with generated media objects. Based, for example, on an order and manner with which the user traverses the scene and interacts with the objects, the generative algorithm may generate new content (e.g., the user looks at a particular painting on the wall of a gallery and then opens the curtains of a window). Outside the window may be an entire world that may be consistent with the particular painting that the user viewed. If the user chooses to move the avatar into that world, the painting on the wall updates to reflect the user's interactions.

In another example of immersive user-generated media content engagement, a user may request a science fiction story. In addition to generating a story based on tropes that are generally relevant to science fiction, the GAIE may include tropes that are likely familiar to the user, such as based on the user's age, culture, other interests, etc. (such as science fiction versions of characters that are well-known in the oeuvre of myth and literature to which the user belongs). In some cases, the algorithm may even include individuals in the created story that are analogous to celebrities or public figures in the user's culture or generation, or even the user's own friends and acquaintances.

In example embodiments, a superintelligence system may be based on a pre-trained GAIE that facilitates automated discovery of relevant domain-specific knowledge and examples. The superintelligence system may further leverage pre-trained advanced GAIE to leverage domain-specific examples to generate content. Yet further the superintelligence system may include a genetic programming capability to create novel variation. In example embodiments, a superintelligence system may further include feedback systems (e.g., collaborative filtering and automated outcome tracking) to prune variation to favorable outcomes (financial, personalization, group targeting, and the like).

In example embodiments, an adapted GAIE system may improve rider satisfaction through, for example generative itineraries that facilitate automated discovery of relevant domain-specific knowledge and examples. Such an AI system may facilitate user discovery of a series of available routes to a known destination (e.g., where a tourist's next hotel reservation takes place). Such a GAIE system may discover and express to the rider content for potential waypoints on those routes, including dining, shopping, and tourism opportunities, as well as friends or potential group activities (a lesson, a hike, an exercise class).

In example embodiments, an adapted GAIE system may improve rider satisfaction by leveraging domain-specific examples to generate content. In an example, the GAIE may generate an itinerary for a day of travel from a current location (or a planned location) to the destination, including recommendations and ratings, photographs, time windows, and contingency options (if this goes quickly, you may add a side trip to that).

In example embodiments, an adapted GAIE system may improve rider satisfaction through use of genetic programming to create and present novel variation, such as by generating a variety of new itineraries and novel ways of presenting them (e.g., with a variety of styles of graphic art, introduction of humor, introduction of deep historical background (e.g., coverage of historical/indigenous people, and the like.)). Novel ways of presenting may include gamifying the content of the itinerary, ascribing rewards for hypermiling the itinerary, ascribing rewards for completion of tasks related to experiencing it, offering a scavenger hunt, setting up a content for the best photograph, funniest photograph, and the like. Other aspects of use of an adapted GAIE for novel presentation may include competing for the best addition of content for the next version of the itinerary, generating legacy content that memorializes the experience, generating varied legacy content elements for sharing to different audiences including parents, travel companions, friends, emphasizing specific areas of interest of the intended audience (e.g., deep content on birds for a birder, etc.). An adapted GAIE system may improve rider satisfaction through use of genetic programming plus feedback systems (e.g., collaborative filtering and automated outcome tracking) to prune variation to favorable outcomes (financial, personalization, group targeting, etc., etc.), tracking financial impact on local businesses (spending), tracking user satisfaction as reported, tracking user satisfaction as indicated by physiological monitoring, tracking time at each destination as an indicator of enjoyment, adjusting future itineraries based on feedback functions, and the like.

In example embodiments, other features may include an in-cabin voice interface for processing of information regarding objects in proximity of a current location; allow querying the transportation-pretrained GAIE by voice for everything from physical entities in proximity to the vehicle to the history of the area, average cost of housing employment data, crime data, recommended route based on criteria specified by vehicle occupant (“take me through NYC on a route that maximizes the prior residences of well-known artists”), and the like. The GAIE system may interface with a vehicle navigation system to map a route. In this regard, an adapted GAIE system may improve rider satisfaction through deployment of a voice interface for constructing a route based upon a criterion provided by a vehicle occupant.

In example embodiments, a transportation subject matter based GAIE system may interact with a machine learning and/or AI system trained using a corpus of data relating to a defined geographic location. This system may include an in-cabin voice interface for accessing and querying the machine learning and/or AI system. The system may be configured with a processor for automatically selecting from the corpus those data that relate to a current location datum associated with a vehicle. Yet further, a navigation system interface for facilitating presentation (for presenting) of a route to a vehicle occupant, wherein the route may be selected based on a query datum provided by the vehicle occupant and the resulting output of the machine learning/AI system.

In example embodiments, a GAIE system may include a tool to query maintenance records for models of vehicles to offer a user a prospective view of the likely timing of failure and points of failure in a particular model (e.g., struts to first fail after 38 months of daily use and/or X miles); offer comparisons to other models; integrate location data into the forecast based on areas traveled, types of roads, amount of traffic, and the like. In example embodiments, a GAIE system may be adapted and/or pretrained for use in a transportation domain and may predict points of failure in a vehicle make/model based upon a criterion related to vehicle usage, and the like.

Another candidate use of a transportation-domain focused GAIE may include establishing a conversational dialogue and/or interaction with a passenger and/or driver about a topic of the user's choice, simply to maintain passenger and/or driver alertness on long routes. In example embodiments, a system may include an individual alertness sensor that determines an alertness of an individual in a vehicle, and a conversation engine that engages the individual in a conversation based on the alertness of the individual.

In example embodiments, deployment of a transportation subject matter configured GAIE may include dialogue-driven trip planning. In example embodiments, a user prompts the GAIE to plan a trip from origin to destination with stops for food and fuel along the way. In response, the GAIE may provide some initial suggestions. The user may interact via dialogue to make explicit changes and/or prompt the GAIE to provide another/alternate suggestion. For example, the user may say “I'd rather stop at a restaurant than get fast food,” or “I'd prefer not to use this highway because there may be a lot of traffic,” or “I'd like to stop for a break every 60-90 minutes.” In response to this dialogue prompt, the GAIE may update the suggestion based on the user's specific feedback; this may be much more fluid and natural than conventional, hard-coded travel planning and adjustment. In example embodiments, a system having a route planning engine may determine a suggested route for travel of a user, and a conversation engine may adjust the suggested route based on a conversation with the user about the suggested route.

In example embodiments, deployment of a transportation subject matter configured GAIE may facilitate defusing driver frustration, such as by settling down the user through calming conversation.

In example embodiments, deployment of a configured GAIE may facilitate dialogue-driven knowledge discovery about a travel condition. In an example, a high number of vehicles are stopping or performing erratically at a particular intersection. A prompted conversation may be initiated between the GAIE and drivers (perhaps just past the location of the anomaly) in which the rider may ask what was happening there and why the other vehicles were behaving as they did. This type of conversational interface may be much more fluid than conventional, facts-only information gathering processes (e.g., searching for traffic issues and the like). A more fluid conversational interaction may ultimately determine that there was an accident at the location. However, the dialogue may lead to the GAIE presenting a range of different candidate actions and/or outcomes, such as advising other users who are approaching the location, contacting first responders based on the nature of the problem, and the like. In example embodiments, a system may include a travel anomaly detector that detects a location associated with an anomalous behavior of an operator of a vehicle, and a conversation engine that determines information about the anomaly based on a conversation with the operator of the vehicle. In embodiments, the system may be GAIE-based. The GAIE may be adapted and/or pre-trained for use in a transportation deployment environment.

In example embodiments, a GAIE platform may include an interactive recommendation engine for nearby or en route options related to entertainment, dining, scenic viewing, and the like. A voice enabled user interface for a GAIE may include a recommendation engine that may be configured to provide recommendations for dining, entertainment, or scenic viewing destinations wherein the destinations are within a prescribed distance from the desired travel route.

In example embodiments, an adapted GAIE deployment may include conversational interfaces for personal assistants, such as voice-based interaction with drivers; this by itself may be a vast improvement over known interfaces, (e.g., visual/tactile input with some very simple and low-spec voice interfaces).

A pre-trained GAIE may overcome problems with current transportation system voice interfaces that may be limited in bandwidth to communicate with a driver, due to a driver's fluctuating attention span and degree of perceived safety. In example embodiments, when a driver may be driving on a familiar highway with cruise control engaged, their ability to listen, speak, and interact may be much higher than when they are driving (a) somewhere new and unfamiliar, (b) in circumstances that require fast reflexes and many decisions in a short period of time, such as stop-and-go traffic, (c) in poor weather conditions, and/or (d) in circumstances where vehicle passengers are loud or engaging in distracting behaviors. Therefore, a voice interface for a pre-trained GAIE may be adapted to be selective as to: (1) what information to present (e.g., prioritizing based on subject matter: emergency information vs. driving-related information vs. social media updates) and (2) when to present information (e.g., don't talk to the user while they are driving in tense circumstances, such as approaching a highway exit ramp; wait for a moment when the user has available attention, such as waiting at a traffic light, ask the user if now is a good time to discuss).

In example embodiments, a GAIE may be pre-trained for use by and/or in cooperative operation with a digital twin engine, such as an instance of an executive digital twin and the like. In an exemplary deployment, a GAIE may interact with a digital twin to provide a narrative about a topic of the digital twin to give to a viewer. In this example, the digital twin may interact with the GAIE (e.g., through an API and the like) to generate a narrative summary for a CEO and a detailed narrative for a CFO.

Executive digital twins may be configured for a particular role or user. Therefore, a GAIE system with a digital twin interface may improve executive digital twin capabilities by curating the data for and populating content for consumption by executive digital twins for different roles. In an example a GAIE may receive information about the executive digital twin as well as about the intended human being represented by the executive digital twin (e.g., the role of the user). The GAIE may determine a degree of narrative detail for each executive digital twin. This may be based on generic executive digital twin/user role criteria and/or refined through interaction with a particular user for the executive digital twin. In example embodiments, a CEO with a tech focus may receive more “in-depth” narrative relating to tech or R&D, whereas a CEO with a financial background may end up receiving narratives that are more focused on financial analysis but less granular on tech-related features.

In example embodiments, a GAIE system that interacts with a digital twin engine (e.g., an executive digital twin instance and/or engine) may determine of the potential universe of content on which it is trained, what may be relevant and what may be noise or unrelated for the specific narrative topic, the target human consumer, and the like. Based on this relevance determination, the GAIE system may generate the output data based on the relevant data and the determined degree of detail.

Further, the GAIE system may also select real time data sources to connect to a target/requesting executive digital twin. The GAIE may further configure consumption pipelines for those sources on the spot (e.g., data source identification, data requests for identified data sources, API configuration, and the like). Therefore, in this example the GAIE system would be identifying data sources and connecting them to an executive digital twin instance/engine.

An example use case may include an executive digital twin that has access to full financial data from a previous timeframe (e.g., a previous year/quarter/month, and the like). The executive digital twin may enable access by the GAIE to all of this data. The GAIE may determine a degree of detail of the data for the intended viewer (e.g., target consumer of a narrative regarding a topic captured in the full financial data).

In the case of a target consumer/view having a role of CEO, the GAIE may determine that the narrative for the CEO will include key insights but not full details. The GAIE may then generate a narrative of the top insights for a target time-frame (e.g., a current quarter) from at least the received data.

A pre-trained GAIE may be used to generate, manage, and/or manipulate digital twins, such as by describing attributes of a digital twin, describing interactions with other digital twins or environments, describing simulations, using digital twin simulation data to generate content, enabling context-adaptive executive digital twins, facilitating development of narratives about ongoing, real time operations, tuned to the preferred conversation style of a user represented by a digital twin, and the like. In example embodiments, a context-adaptive executive digital twin integrated with a generative conversational AI system may be configured to generate a set of narratives about operations of an enterprise based on an input data set of real-time sensor data from the operations of the enterprise. The digital twin (or human user) may prompt the GAIE and/or conversational AI system to compare financials with real-time sensor data.

A GAIE may be adapted (e.g., pre-trained) to facilitate enhancement of AI training data associated with a digital twin application. In example embodiments, a method may include using an AI conversational agent to create synthetic training data.

Further in association with digital twin technology, a GAIE may be adapted for summarizing highly granular data for consumption by an executive digital twin. In this regard, an executive digital twin system may include an intelligent agent that receives a set of customization features from a user (e.g., an executive represented by the digital twin) that include a role of the user within an organization. The intelligent agent may also determine a respective granularity level of a report based on the customization features. In example embodiments, the set of customization features include granularity designations for different types of reports. Yet further, the intelligent agent determines the granularity level of a report based on the role of the user within an organization. Further, the subject matter of the report may be generated based on the role of the user within the organization.

In example embodiments, a speech-based user interface for customizing a level of specificity for generating executive digital twin reports may be operatively coupled to a customized GAIE that processes the speech into a set of report instructions (and optionally report content) based on aspects of the user(s). An example of a speech-based request that may be processed as described may include, “I'd like an executive-summary level report on predictive maintenance” or “I'd like a detailed report on competitor analysis.” The speech-based user interface may respond to such a request by directing a corresponding executive digital twin system to feed a specificity level for parameters to a generative AI engine (e.g., GAIE) as additional input along with the data. In this example, IoT data from manufacturing facilities may be used in predictive maintenance. A response to a prompt regarding preventive maintenance may be customized with a level of specificity based on target report consumer role(s), such as for an operations-based role. A level of specificity may include what are the costs, when is the maintenance needed by, what may be the predicted downtime, how to offset and/or time the maintenance activity, and the like. For a financial-based role, specificity levels may be adapted to address what may be the disruption going to do for the bottom line in the short term; how does this impact our supply; what may the disruption do to our market-share; will it impact our stock price, and the like.

When a digital twin may be used to model an individual, a fine-tuned GAIE may be used to coordinate the digital twin with the human for improved fidelity (e.g., when the human behaves or reacts differently than the digital twin predicts, a GAIE may initiate a dialogue with the user to determine why, and the results may be used to update the digital twin model for the individual). Instead of having a human expert occasionally participate in automated digital twin model training (e.g., to correct errors or provide new examples, and the like), a corresponding GAIE may be occasionally querying the user to solicit more information to update the digital twin model of the individual. As an example, a system may include a digital twin that models an individual, and may further include a conversation engine that facilitates determining an update of the digital twin based on a conversation with the individual that is associated with a difference between an action of the individual and a corresponding action prediction by the digital twin.

In example embodiments, a GAIE system may be configured for use in an automated manufacturing environment. In one example, a user may prepare a descriptive prompt of a desired product to have it 3D printed. The GAIE system may generate a 3D printing set of instructions, such as a configuration of an automated 3D printing machine and a rendering indicative of a result of the 3D printing machine following the instructions. In another example, a user may include a photo/video of product as a prompt along with a request for instructions to 3D print an improved version, such as “I want this bike but I want different tires and I want it to be red.”

Another exemplary use of a pre-trained GAIE may include using user behavioral data to generate guiding recommendations for energy conservation, usage shifting, and the like. In particular, a recommendation system for energy conservation, usage shifting, or optimization may include an integrated generative, conversational AI system that adapts generated output based on user behavior from a user behavior data set.

In example embodiments, an adapted GAIE may facilitate management of energy resources. An energy resource management system may be enhanced to provide advanced intelligence (e.g., superintelligence) to plan, manage, and/or govern DERs and energy generation, storage, consumption, and transmission facilities. Elements of a superintelligent energy management system may include automated discovery of relevant domain-specific knowledge and examples, generative AI to leverage domain-specific examples to generate content, genetic programming to create novel variation, feedback systems (e.g., collaborative filtering and automated outcome tracking) to prune variation to favorable outcomes (financial, personalization, group targeting, etc., etc.), and the like. In an example, a superintelligent AI-enabled management system may be configured to manage a plurality of systems of an energy edge platform via automated discovery, generative AI, genetic programming, and feedback systems.

In example embodiments, a GAIE may be adapted (e.g., trained, pre-trained, and the like) for the field of patents to generate patent claims responsive to being provided a patent disclosure. An enabled GAIE may receive patent claims as a prompt and may generate a supportive patent disclosure therefrom. In example embodiments, an enabled GAIE may be trained to understand a patent structure and a claim structure for a plurality of jurisdictions.

In example embodiments, a GAIE may be pretrained (e.g., finetuned) with a private instance of an enterprise's intellectual property data (e.g., products, business goals, competitive considerations, core inventive ideas, and the like). In example embodiments, a private instance of enterprise data for patent generation may be configured (e.g., as prompt-response pairs) for finetuning the GAIE instance.

Beyond patent disclosure and figure preparation, a GAIE may be fine-tuned to generate figures, disclosure from figures, claims from figures, office action responses, evidence of use (EOU) for patent monetizing, preparing a matrix of patent claims across a portfolio, high level landscape search strings, enhancement of search strings, and the like. Finetuning may include preparation of prompt-response sets for a range of IP-related actions, such as patent claim assertion, infringement analysis and discovery, claim (term) acceptance and/or rejection, estimate of claim scope broadness, claim quality, and the like. In example embodiments, an IP-tuned GAIE may be pre-trained with information from proceedings related to infringement cases to understand the likelihood of infringement, and the like.

GAIE training and IP-integration may facilitate elaboration of broadly stated inventive concepts into disclosure that reflects robust enablement and/or support. In an example, an outline may be an input prompt for the purposes of drafting a patent application (e.g., disclosure, figures, summary, abstract, and optionally claims). A generated result may become a portion of a subsequent prompt along with a description of the general theme, category, focus area and/or other categorization or classification of innovation. In an example, one may describe a transaction environment processing platform and ask for examples of a technical implementation, system, and/or method design, such as: “In the context of a transaction environment processing platform as previously described, what types of hardware and software might be used to implement a governance engine for the transaction environment?”

Regarding an intellectual property (e.g., patent) monetization-focused development process, a GAIE may facilitate predicting, from a market development view, which domains to select and which categories within domains to emphasize based on the ability to determine where business may be shifting over a longer time (e.g., beyond short-term trends). This may include analyzing historical data and current data for one or more IP domains, optionally in near-real time. An IP-monetization-focused GAIE may tie historical and/or current data to investments and actions having occurred in the IP world for, among other things, patent sales and licensing. An IP-monetizing trained GAIE may also develop particular leads and domain categories with the highest probability of success based on previous sales and/or licensing and/or where the market may be heading. There may be risk in making these decisions but using a trained GAIE may lower this risk so that these decisions become more predictable in the future, especially with company data increasing and likely accessible through various channels.

A GAIE may be configured, trained, and/or fine-tuned for a range of functions, including, for example, ingestion of proprietary data, determination of a route, determination of an outcome, approval of release/access to data, making a prediction, pattern recognition, and the like. Yet another example application of a fine-tuned GAIE may include layering of voice and visual commands that may be graduated in sound, volume, or spacing similar to flight avionics, thereby generating scripts for voice over of data and/or presentation material. This may enable the development of synthetic speech technology that generates lifelike (AI-generated) voices for podcasts, slideshows, and professional presentations. This may mitigate needs for hiring a voice artist or using any complex recording equipment (e.g., background noise separation, dubbing, and the like).

In example embodiments, GAIE systems may be configured for facilitating news delivery from NPC-type avatars to adapt current “clickbait” content to conversationally conveyed world news/happenings. In this example, a metaverse environment may include a news-based GAIE conversation agent configured to conversationally inform users of recent events.

Further in context of metaverse technology, a generative AI conversational agent may be configured to populate the metaverse.

Yet further within a context of metaverse technology, a GAIE system may be enabled to augment training data for a customized conversational agent with real-time sensor data sets through collecting information from real-world sensors. In an example, a training data augmentation system may be configured for augmenting training of a conversational agent with data from a real-time sensor data set. Further, a metaverse-associated GAIE system may facilitate augmenting training data for a customized conversational agent with process outcome data. A training data augmentation system may be configured for augmenting training of a conversational agent with process outcome data from a process outcome data set, user behavior data, and the like. In example embodiments, a training data augmentation system based on a GAIE may be enabled (e.g., pre-trained) for augmenting training of a conversational agent with user behavior data from a user behavior data set.

In example embodiments, application of fine-tuned GAIE systems in the field of governance may facilitate advances in automation of governance, such as governing use of copyrighted material. GAIE-based governance systems may further enhance governing AI training, such as conversational AI training data sets for bias and error, governing conversational AI for contextual appropriateness and other stylistic requirements, and the like. A fine-tuned GAIE system may further improve governing secrecy, such as a progression of what elements of secret, proprietary or confidential information are allowed based on a depth of conversation. Governance may further apply to individuals. Therefore, a governance fine-tuned GAIE system may enhance and/or automate determining a measure of trustworthiness of a user that may be interacting with a generative conversational AI system. Further a governance fine-tuned GAIE system may enrich governance for a generative AI system, such as determining a measure of trustworthiness of a generative conversational AI system. In general, governance use cases may be expanded further in light of GAIE topic-targeting training capabilities.

A fine-tuned GAIE system may play a role in systematic risk identification, management, and opportunity mining. GAIE-based risk identification systems may respond to risk-related prompts, such as “What may else might we know and should be paying attention to?” by curating data sets and automating the processes of identification of systemic risks, identifying a set of likely scenarios and the risks and opportunities arising from those scenarios, identifying paths for resolution and recommending resolutions.

Yet another area of risk identification and/or management may involve security concerns with GAIE systems that are configured to generate computer executable code. At the least relying on computers to write computer code raises questions about what security measures are effective and what measures are able to be circumvented by the AI.

A further area of risk identification, management and/or opportunity harvesting may apply to copyright material. Automated computer code generation may inadvertently introduce copyrighted material, such as algorithms. A risk-finetuned copyright GAIE may assist in detecting candidate copyright violations in any programmatic code, including machine generated code.

Risk identification of visual training sets (e.g., images, graphs, and the like) may be enhanced by a fine-tuned GAIE that can process these visual training data sets for authenticity indicators that are coded as non-visual data. This may be similar to tail voltage devices providing messages on the end of sine waves. Visual training sets may be coded with non-visual indicators of authenticity that may be detectable by a fine-tuned GAIE.

Yet another risk-identification related area includes fraud detection. Integrating customer fraud reporting and questioning into pretraining data may enrich holistic scoring, which may comprise a composite score that bridges customer evidence, transactions, and environmental trends. In an example, an AI based fraud detection system may integrate customer fraud reports and questioning into a training/query data set to produce a holistic scoring system, utilizing a composite score that combines customer evidence, transaction data, and environmental trends to provide a comprehensive approach to fraud detection.

Imaging applications may benefit from fine-tuned GAIE systems. In example embodiments, optical content (e.g., screen shots and the like) may be processed by machine vision systems so that the GAIE may describe a scene in the optical content using a generative conversational AI agent. In example embodiments, a GAIE may be configured as a first AI/NN sub-system in a Dual Process Artificial Neural Network (DPANN) architecture. Such a DPANN architecture may include, as a second NN sub-system, a formal logic-based and/or fuzzy-based system. Together these DPANN systems may implement learning processes, model management, and the like. In example embodiments, a DPANN architecture may include features that describe building and managing large scale models.

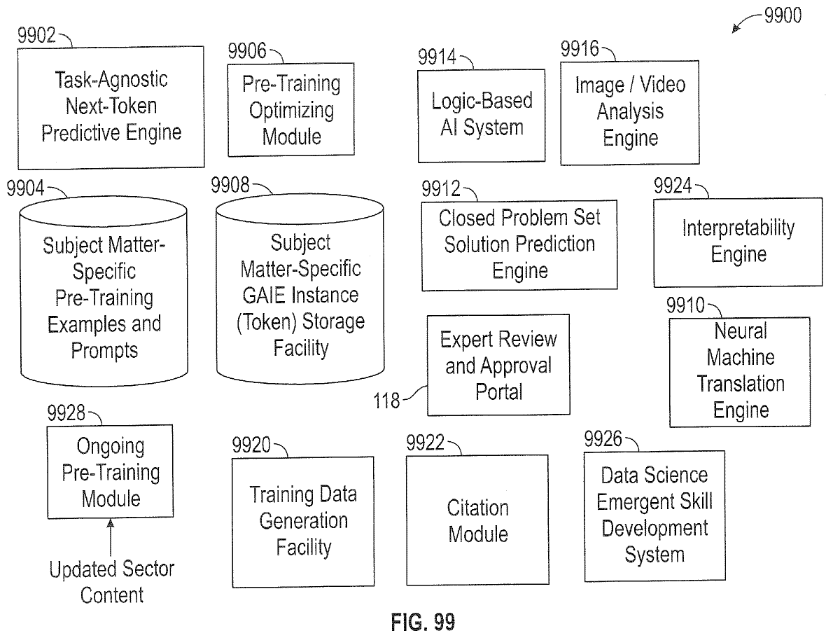

Referring to FIG. 99, a platform for the application of generative AI 9900 may include a robust task-agnostic next-token prediction artificial intelligence model 9902 that operates to predict a next token given a set of inputs encoded as embedded tokens. A robust task-agnostic next-token prediction AI engine 9902 may include deep learning models, which use multi-layered neural networks to process, analyze, and make predictions with complex data, such as language. An objective of the robust next-token prediction AI engine 9902 may include data science modeling through, among other things, use of topic-specific embeddings, attention mechanisms, and decoder-only transformer models. Capabilities of such an engine 9902 may include a pre-training capability to facilitate configuring next-token prediction for specific subject matter (e.g., marketplace item valuation), a tokenizing capability to facilitate converting complex terms into actionable tokens (e.g., converting compound chemical names into fundamental elements), access to distributed training (e.g., data-parallel training and/or model-parallel training, and the like), few-shot learning to reduce training demand for updates, such as new business intelligence data, and the like. In general the next-token prediction AI engine 9902 may combine large language modeling techniques and decoder-only transformer models to generate powerful foundation models for next-token prediction AI content generation.

In example embodiments, the next-token prediction AI engine 9902 may be structured with a machine learning (sparse Multi-Layer Perceptron) architecture configured to sparsely activate conditional computation using, for example mixture-of-experts (MoE) techniques. A machine learning architecture may be configured with expert modules that may be used to process inputs and a gating function that may facilitate assigning expert modules to process portion(s) of input tokens. A machine learning architecture may further include a combination of deterministic routing of input tokens to expert modules and learned routing that uses a portion of input tokens to predict the expert modules for a set of input tokens.

A GAIE 9900 may be trained to operate within a domain, such as written language, computer programming language, subject matter-specific domains (e.g., a software orchestrated marketplace domain), and the like to generate content (constructs) that comply with rules of the domain. In general, a GAIE may generate content for any topic for which the GAIE is trained. So, for example, a GAIE may be trained on a topic of pig farmers and may therefore generate language-based descriptions, images, contracts, breeding guidance, textual output, and the like for any of a potentially wide range of pig farmer sub-topics.

Adapting a generative AI engine for subject matter-specific applications may include pretraining a next-token prediction AI model-based system through the use of, for example, in-context (e.g., application, domain, topic-specific) examples that are responsive to a corresponding prompt. While the next-token predictive capabilities of the underlying next-token prediction AI engine may remain unaffected by this pre-training, subject matter-specific pre-trained instances may be developed/deployed.

In example embodiments, a platform for the application of generative AI 9900 may include a set of subject matter-specific pretrained examples and prompts 9904. This set 9904 may be configured by analyzing (e.g., by a human expert and/or computer-based expert and/or digital twin) information that characterizes various aspects of the domain to generate example prompts and preferred and/or correct responses. Pretraining may also include training the next-token prediction AI engine 9902 by sampling some text (e.g., prompt/response sets) from the set of subject matter-specific pretrained examples and prompts 9904 and training it to predict a next word, object, and/or term. Pretraining may also include sampling some images, contracts, architectures, and the like to predict a next token. These prompt-response sub-sets may facilitate pre-training the prediction AI engine 9902 for predicting a next token (e.g., word, object, image element, and the like) for various aspects.

When an instance is implemented for textual generation, such a GAIE instance may be referred to as a natural language generation system that constructs words (e.g., from sub-word tokens), sentences, and paragraphs for a target subject and/or domain.

In example embodiments, real-world instances of the platform 9900 may require ongoing updates to facilitate the platform 9900 being responsive as aspects of a domain (e.g., a business entity in the domain) change, such as business goals change, new products are released, competitors merge, new markets emerge, and the like. In this regard, training the platform 9900 with in-context prompts and examples may be automated and repeated as new data is released for an enterprise to prevent snapshot-in-time data aging-based errors. The platform the application of generative AI 9900 may include an ongoing pre-training module 9928 that processes new and updated content into prompt and/or response sets and interactively iterates through rounds of pre-training. New and updated data and/or information may regularly be found in various subject matter specific information sets, such as: a dataset of medical records (e.g., to assist with medical diagnoses), a dataset of legal documents and court decisions (e.g., to provide legal advice), a release of a new product (e.g., images of the product), or a financial dataset such as SEC filings or analyst reports. In example embodiments, uses of the platform 9900 may include applying the pre-training and optimizing techniques to a range of different domains (e.g., medical diagnosis, business operation, marketplace operation, and the like) to produce a fine-tuned domain specific token-predictive engine including ongoing refinement through (daily) in-context pretraining.

In example embodiments, an ongoing pre-training module 9928 may work with the next-token prediction AI engine 9902 to update a set of subject matter specific tokens that may be maintained in a subject matter specific instance token storage facility 9908. This subject matter specific instance token storage facility 9908 may be referenced by a subject matter specific instance of the next-token prediction AI engine 9902 during an operational mode (e.g., when processing inputs/prompts). In example embodiments, the platform 9900 may include a plurality of sets of subject matter specific tokens that may be maintained by corresponding ongoing pre-training modules 9928.

Training, however, may not ensure that the responses to prompts are correct every time. In general, a business entity is likely to be less interested in a tool that provides answers that are probably right and may differ from time to time. A product that can provide accurate responses (e.g., including taking actions) based on what the end-user wants vastly increases the potential use cases and product value. A high level of accuracy and integration with operational systems may enable such a tool to go beyond just generating new content to be more productive; through integration with workflows, it may facilitate automating workflow actions. In this regard, the platform for the application of generative AI 9900 may also include a pre-training optimizing module 9906 that may work cooperatively with the ongoing pre-training module 9928 to further refine accuracy of responses to prompts for a domain. The pre-training optimizing circuit 9906 may facilitate improved accuracy of in-context responses, task-specific fine-tuning, and for sparse model variants of the platform 9900, enrich few-shot learning capabilities. In example embodiments, fine tuning may further benefit the platform by reducing bias that may be present in the training data. This may be essential to ensure subject matter specific jargon is adapted as training data changes (e.g., in the digital marketing/promotional space, ensure that “influencer” is replaced with “creator”). Further, a pre-training optimizing engine 9906 may provide a wider range of prompts and responses based on user preferences (e.g., speaking styles) to enrich the platform's ability to provide user-centric responses. In example embodiments, user-centric responses may include fine tuning the platform 9900 for different roles in an organization. As an example, when a user in a financial planning role inquires about a business development topic, responses may be directed toward the financial planning role (e.g., as compared to a customer/client inquiry about that topic).

A platform for the application of generative AI 9900 may be used to produce text-based content for a multi-national entity with employees who speak different languages. While the platform 9900 may be trained (and pre-trained) to operate interactively in a plurality of languages, generating automated content may benefit from use of a neural machine translation module 9910. In example embodiments, a portion of the entity in a first jurisdiction may produce content in a first language and resulting recurring generated output (e.g., types of reports and the like) may be generated in the first language. However, employees who speak a second language may benefit from the type of report when translated into the employee's native language. Therefore, associating the neural machine translation module 9910 with the platform may prove valuable while reducing compute demand for the platform 9900.

Emerging next-token prediction AI systems feature increasingly adaptable next token prediction capabilities. These capabilities may be further adapted to assist in closed problem set solution prediction, such as allocation of resources, deployment of a robotic fleet and the like. To achieve greater prediction capabilities, a subject matter specific next-token prediction AI-based engine, such as the platform for the application of generative AI 9900, may include a solution-predictive engine 112 that leverages next-token (e.g., next word) predictive capabilities to predict a most-likely solution to a closed solution-set problem. This may be accomplished optionally through use of sets of problem domain-specific pre-training prompts and examples. Such examples may be adapted for different user preferences. In example embodiments, each user in a closed problem set environment may generate prompts and responses that may enable the platform 9900 to respond to the user based on the user's inquiry style. Alternatively, the solution prediction engine 9912 may adapt a user's prompt and/or configure a prompt based on user preferences to attempt to deliver responses that are consistent with a user's preferences (e.g., engineering-based responses for an engineer role-user and legal-based responses for a lawyer).

For more complex analysis and decision making/predicting, a formal logic-based AI system 9914 may be incorporated into and/or be referenced by the subject matter specific platform 9900.

Further, the basic concepts of next-token prediction of a generative AI engine, such as the platform for subject matter-based application of generative AI 9900 may be applied to analyzed expressions of images, audio (e.g., encoded text), video (e.g., sequences of related images), programmatic code (domain-specific text with readily understood rules), and the like. Therefore, a next-token prediction AI platform (e.g., platform 9900) may further include an image/video analysis engine 9916 (optionally NN-based) that adds a spatial aspect to the next-token predictive capabilities of a next-token prediction AI system. Images used for training may include 3D CAD images (for a domain that includes physical devices such as vehicles), radiologic images (for a medical analysis domain), business performance graphs, schematics, and the like. In example embodiments, aspects of the underlying task-agnostic next-token prediction AI engine 9902 may be adapted (e.g., different embeddings, neural network structures and the like) for different input formats, such as images, temporal-spatial content, and the like.

The platform 9900 may further include an expert review and approval portal 9918 through which an expert (e.g., human/digital twin, and the like) can review, edit, and approve content generated. Examples include review and adaptation by a subject matter specific data story expert; a data scientist, and the like. The expert review and approval portal 9918 may operate cooperatively with, for example, the pre-training optimizing module 9906 that may receive and analyze expert feedback (e.g., edits to the content and the like) for opportunities to further optimize the platform 9900.

The platform 9900 may further include a training data generation facility 9920 that may generate natural language prompts, such as subject matter specific prompts that may be applied by, for example, the pre-training optimizing engine 9906 to increase platform response accuracy and/or efficiency while fine tuning a subject matter specific instance.

In example embodiments, the platform 9900 may further be configured to access a corpus of domain and/or problem relevant content as a step in responding to a prompt. In example embodiments, the platform may be pre-trained on the content of the corpus While the content of the corpus may not be directly included in the response, such as if it provides a level of detail beyond what the platform 9900 has been trained to provide in a response, it may be cited in the response to facilitate identifying and expressing sources from which a response is derived. These external source references may be handled via a citation module 9922.

Business decisions are often context-based. Understanding both the context for a decision and aspects and/or assumptions of the decision process may prove highly valuable for evaluating, for example, competing decisions and/or recommendations. Context may include both tangible and intangible factors. An intangible factor may include historical interactions between parties involved in the evaluation process, for example. A decision process may include not only assumptions on which a decision or recommendation is based, but also criteria by which tangible factors are processed, evaluated, analyzed, and the like. To provide such context for generated output of the platform 9900, an interpretability engine 9924 may be incorporated into and/or be accessible to the platform 9900. An objective of use of the interpretability engine 9924 may be to generate additional content that reflects context for, among other things, how the next-token prediction AI instance operates and/or generates a corresponding output.

In example embodiments, the next-token predictive capabilities of a next-token prediction AI engine 9902 may be utilized for developing a set of emergent data science predictive and/or interpretive skills. While such a platform may be trained directly on various data sets, context for elements and results in such data sets may be a rich source of complementary training data. By associating data elements with descriptions thereof, the platform 9900 may gain data science capabilities, such as to group by or pivot categorical sums, infer feature importance, derive correlations, predict unseen test cases, and the like. In this regard, a data science emergent skill development system 9926 may be utilized by the platform to enhance further subject matter specific applicability and utility.

In embodiments, the transportation methods and systems described herein may include systems and methods for processing graph data, for example to represent transportation networks, using machine learning algorithms to analyze and optimize vehicle routing, traffic flow, and network efficiency. Such systems and methods may be integrated into vehicle navigation systems and transportation management infrastructures to provide real-time, adaptive routing suggestions and traffic predictions. In embodiments, graph data may be used to represent transportation networks, where nodes correspond to intersections, points of interest, or other significant locations, and edges represent the pathways, such as roads or transit lines, connecting these nodes. Attributes such as travel time, distance, traffic conditions, and road type may be further associated with the edges. In embodiments, a plurality of machine learning algorithms may process graph data and provide actionable insights including, but not limited to, graph neural networks (GNNs) may, in an example, be used to capture the spatial structure of the transportation network and to predict traffic conditions or travel times for each edge in the graph, reinforcement learning (RL) may, in an example, be used to optimize routing decisions in real-time, learning from past experiences to improve future route suggestions, clustering algorithms may, in an example, be used to segment the graph data into clusters based on traffic patterns or geographic features to identify areas of congestion or to optimize traffic signal timings; time-series forecasting models may, in an example, be employed to predict future traffic conditions based on historical data, enabling the system to anticipate and react to changing traffic patterns.

In various embodiments, one or more techniques involve the processing of graph data using one or more machine learning algorithms. In some such embodiments, the one or more machine learning algorithms include one or more graph neural networks (GNNs). The following discussion provides an overview of graph data and graph neural networks.

In a graph data set, a set of nodes is interconnected by one or more edges that respectively represents a relationship among two or more connected nodes. In many graph data sets, each edge connects two nodes. In other graph data sets that represent hypergraphs, a hyperedge can connect three or more nodes. In various graph data sets, each of the one or more edges is directed or undirected. An undirected edge represents a relationship that relates two or more nodes without any particular ordering of the related nodes. A first undirected relationship that connects a first node N1 and a second node N2 may be equivalent to a second undirected relationship that also connects a first node N1 and a second node N2. In some such graphs, the relationship represents a group to which the two or more related nodes belong. In some such graphs, the relationship represents an undirected and/or omnidirectional connection between two or more nodes. For example, in a graph representing a geographic region, each node may represent a city, and each edge may represent a road that connects two or more cities and that can be traveled in either direction. By contrast, a directed edge includes a direction of the relationship between a first node and a second node. For example, in a graph representing a genealogy or lineage, each node represents a person, and each edge connects a parent to a child. A first directed edge that connects a first node N1 to a second node N2 is not equivalent to a second directed edge that connects the second node N2 to the first node N1. Some graph data sets include one or more unidirectional edges, that is, an edge with one direction among two or more connected nodes. Some graph data sets include one or more multidirectional edges, that is, an edge with two or more directions among the two or more connected nodes. Some graph data sets may include one or more undirected edges, one or more unidirectional edges, and/or one or more multidirectional edges. For example, in a graph representing a geographic region, each node may represent a city; one or more unidirectional edges may represent a one-way road that connects a first city to a second city and can only be traveled from the first city to the second city; and one or more bidirectional or undirected edges that represent a bidirectional road between the first city and the second city that can be traveled in either direction. Some graph data may include, for two or more nodes, a plurality of edges that interconnect the two or more nodes. For example, a graph data set representing a collection of devices may include nodes that respectively correspond to each device of the collection and edges that respectively correspond to an instance of communication and/or interaction among two or more of the devices. In such a graph data set, a particular subset of two or more devices may engage in a plurality, including a multitude, of instances of communication and/or interaction, and may therefore be connected by a plurality, including a multitude, of edges.

Some directed and/or undirected graph data sets may include one or more cycles. For example, in a graph representing a social network, a first edge E1 may connect a first node N1 (representing a first person) and a second node N2 (representing a second person) to represent a relationship between the first person and the second person. A second edge E2 may connect the second node N2 and a third node N3 (representing a third person) to represent a relationship between the second person and the third person. A third edge E3 may connect the third node N3 and the first node N1 to represent a relationship between the third person and the first person. Such cycles can occur in undirected graphs (e.g., edges in a social network graph that indicate mutual relationships among two or more individuals), directed graphs (e.g., edges in a social network graph that indicate that a first person is influenced by a second person, a second person is influenced by a third person, and a third person is influenced by the first person), and/or hypergraphs (e.g., cycles of relationships among three or more clusters that respectively include three or more nodes). Some cyclic graphs may include one or more cycles that are interlinked (e.g., one or more nodes and/or edges that are included in two or more cycles). Other directed and/or undirected graph data sets may be acyclic (e.g., graphs in which nodes are strictly arranged according to a top-down hierarchy). Still other directed and/or undirected graph data sets may be partially acyclic (e.g., mostly acyclic) but may include one or more cycles among one or more subsets of nodes and/or edges.

In some graph data sets, one or more nodes includes one or more node properties. For example, in a graph representing a geographic area, each node may represent a city, and each node may include one or more node properties that correspond to one or more properties of the city, such as a size, a population, or a latitude and/or longitude coordinate. Each node property may be of various types, including (without limitation) a Boolean value, an integer, a floating-point number, a set of numbers such as a vector, a string, or the like. In some graph data sets, one or more nodes does not include a node property. For example, in a graph data set representing a set of particles, each particle may be identical to each other particle, and there may be no specific data that distinguishes any particle from any other particular. Thus, the nodes of the graph data set may not include any node properties.

In some graph data sets, one or more edges includes one or more edge properties. For example, in a graph representing a geographic area, each edge may represent a road, and each edge may include one or more edge properties that correspond to one or more properties of the road, such as a distance, a number of lanes, a direction, a speed limit, a volume of traffic, a start latitude and/or longitude coordinate, and/or an ending latitude and/or longitude coordinate. In some graph data sets, a direction of an edge may be represented as an edge property. Alternatively or additionally, in some graph data sets, a direction of an edge may be represented separately from one or more edge properties. In some graph data sets, one or more edges does not include an edge property. For example, in a graph data set representing a line drawing of a set of points, each edge may represent a line connecting two points, and the edges may be significant only due to connecting two points. Thus, the edges of the graph data sets may not include any edge properties.

In some graph data sets, the graph includes one or more graph properties. Such graph properties may be global graph properties that correspond to one or more properties of the entire graph. For example, in a graph data set representing a geographic region, the graph may include graph properties such as a total number of nodes and/or cities, a two-dimensional or three-dimensional area represented by the graph, and/or a latitude and/or longitude of a center of the graph. Such graph properties may be global graph properties that correspond to one or more properties of all of the nodes of the graph. For example, in a graph data set representing a geographic region, the graph may include graph properties such as an average population size of the cities represented by the nodes and/or an average connectedness of each city to other cities included in the graph.

Some graph data sets include a single set of data that includes all nodes and all edges. For example, a graph representing a geographic region may include a set of nodes that represent all cities in the geographic region. Some other graph data sets include one or more subgraphs, wherein each subgraph includes a subset of the nodes of the graph and/or a subset of the edges of the graph. For example, a graph representing a geographic region may include a number of subgraphs, each representing a subregion of the geographic region, and the edges that interconnect the cities within each subregion. As another example, a graph representing a geographic region may include a first subgraph representing cities (e.g., groups of people over a threshold population size and/or population density) and a second subgraph representing towns (e.g., groups of people under the threshold population size and/or population density). In some graph data sets, each node and/or each edge belongs exclusively to one subgraph. In some graph data sets, at least one node and/or at least one edge can belong to two or more subgraphs. For example, in a graph representing a geographic region that includes a number of subgraphs respectively representing different geographic subregion, each node representing a city may be exclusively included in one subgraph, while each edge may interconnect two or more cities within one subgraph (i.e., within one subregion) or may interconnect a first city in a first subgraph (i.e., within a first subregion) and a second city in a second subgraph (i.e., within a second subregion).

Graph neural networks can include features and/or functionality that are the same as or similar to the features and/or functionality of other neural networks. For example, graph neural networks include one or more neurons arranged in various configurations. Each neuron receives one or more inputs from the graph data set or another neuron, evaluates the one or more inputs (e.g., via an activation function), and generates one or more outputs that are delivered to one or more other neurons and/or as an output of the graph neural network. Examples of activation functions that can be included in various neurons of the graph neural network include (without limitation) a Heaviside or unit step activation function, a linear activation function, a rectified linear unit (ReLU) activation function, a logistic activation function, a tanh activation function, a hyperbolic activation function, or the like.

As an example, some graph neural networks include only a single neuron, or only a single layer of neurons that is configured to receive graph data as input and to provide graph data as output of the graph neural network. Some graph neural networks are arranged in a series of two or more layers, wherein input is received by neurons included in a first layer. The output of one or more neurons included in the first layer is delivered, as input, to one or more neurons included in a second layer. For example, each neuron in the first layer may include one or more synapses that respectively interconnect the neuron to one or more neurons of the second layer. In many graph neural networks, each neuron N1 of a preceding layer L1 is connected to each neuron N2 of a following layer by a synapse that includes a weight W. Neuron N2 receives, as input, the output of the neuron N1 multiplied by the weight of the synapse connecting neuron N1 and neuron N2. In many neural networks, layer L1 includes a bias B, which is added to the product of the output of neuron N1 and the weight W of the synapse connecting neuron N1 and neuron N2. As a result, the input to neuron N2 includes the sum of the bias B of layer L1 and the product of the output of neuron N1 and the weight W of the synapse connecting neuron N1 and neuron N2. The output of the neurons included in the second layer can be provided as an output of the graph neural network and/or as input to one or more neurons included in a third layer. Each layer of the graph neural network may include a same number of neurons as a preceding and/or following layer of the graph neural network, or a different number of neurons as preceding and/or following layer of the graph neural network.

As another example, some graph neural networks include one or more layers that perform particular functions on the output of neurons of another layer, such as a pooling layer that performs a pooling operation (e.g., a minimum, a maximum, or an average) of the outputs of one or more neurons, and that generates output that is received by one or more other neurons (e.g., one or more neurons in a following layer of the graph neural network) and/or as an output of the graph neural network. For example, some graph neural networks (e.g., graph convolution networks) include one or more convolutional layers, each of which performs a convolution operation to an output of neurons of a preceding layer of the graph neural network.

As another example, some graph neural networks include memory based on an internal state, wherein the processing of a first input data set causes the graph neural network to generate and/or alter an internal state, and the internal state resulting from the processing of one or more earlier input data sets affects the processing of second and later input data sets. That is, the internal state retains a memory of some aspects of earlier processing that contribute to later processing of the graph neural network. Examples of graph neural networks that include memory features and/or stateful features include graph neural networks featuring one or more gated recurrence units (GRUs) and/or one or more long-short-term-memory (LSTM) cells.

As another example, some graph neural networks feature recurrent and/or reentrant properties. For example, at least a portion of output of the graph neural network during a first processing is included as input to the graph neural network during a second or later processing, and/or at least a portion of an output from a layer is provided as input to the same layer or a preceding layer of the graph neural network. As another example, in some graph neural networks, an output of a neuron is also received as input by the same neuron during a same processing of an input and/or a subsequent processing of an input. The output of the neuron may be evaluated (e.g., weighted, such as decayed) before being provided to the neuron as input. As another example, some graph neural networks may include one or more skip connections, in which at least a portion of an output of a first layer is provided as input to a third layer without being processed by a second layer. That is, the output of the first layer is provided as input both to the second layer (which generates a second layer output) and to the third layer. In some such graph neural networks, the third layer receives, as input, either the output of the first layer or the output of the second layer. That is, the third layer multiplexes between the output of the first layer and the output of the second layer. Alternatively or additionally, in some such graph neural networks, the third layer receives, as input, both the output of the first layer and the output of the second layer (e.g., as a concatenation of the output vectors to generate the input vector for the third layer), and/or an aggregation of the output of the first layer and the output of the second layer (e.g., a sum or average of the output of the first layer and the output of the second layer). Examples of graph neural networks that include one or more skip connections include jump knowledge networks and highway graph neural networks (highway GNNs).

As another example, some graph neural networks include two or more subnetworks (e.g., two or more graph neural networks that are configured to process graph data concurrently and/or consecutively). Some graph neural networks include, or are included in, an ensemble of two or more neural networks of the same, similar, or different types (e.g., a graph neural network that outputs data that is processed by a non-graph neural network, Gaussian classifier, random forest, or the like). For example, a random graph forest may include a multitude of graph neural networks, each configured to receive at least a portion of an input graph data set and to generate an output based on a different feature set, different architectures, and/or different forms of processing. The outputs of respective graphs of the random graph forest may be combined in various ways (e.g., a selection of an output based on a minimization and/or maximization of an objective function, or a sum and/or averaging of the outputs) to generate an output of the random graph forest.

In these and other graph neural networks, the number of layers and the configuration of each layer of the graph neural network (e.g., the number of neurons and the activation function used by each neuron of each layer) can be referred to as hyperparameters of the graph neural network that are determined upon generation of the graph neural network. The weights of node synapses and/or the biases of the layers can be referred to as parameters of the graph neural network that are learned through a training or retraining process. Further explanation and/or examples of various concepts of other types of neural networks that can also apply to graph neural networks, and additional concepts that apply to other types of neural networks that can also be included in graph neural networks, are presented elsewhere in this disclosure and/or will be known to or appreciated by persons skilled in the art.

Unlike other types of neural networks, graph neural networks are configured to receive, process, generate, and/or transform one or more graph data sets. Some graph neural networks are configured to receive data representing and/or derived from a graph data set, such as an input vector that includes data representing one or more nodes of the graph (optionally including one or more node properties of one or more nodes), one or more edges of the graph (optionally including one or more edge properties of one or more edges), and/or one or more graph properties of the graph. Some graph neural networks are configured to receive an input vector comprising all of the data of a graph data set (e.g., all of the data representing all nodes, all edges, and the graph). Some graph neural networks are configured to receive an input vector comprising only a portion of the data of a graph data set (e.g., only a subset of the nodes of the graph and/or only a subset of the edges of the graph). For example, some graph data sets include a number of subgraphs, and the input vector to the graph neural network includes the data for all of the nodes and/or all of the edges included in one subgraph of the graph. The entire graph can be processed by processing (e.g., concurrently and/or consecutively) each subgraph and combining the output resulting from the processing of each subgraph. As another example, a graph data set representing a set of users of a social network may be processed by a graph neural network that receives, as input, a subset of nodes that correspond to the most influential users of the social network (e.g., those having more than a threshold number of social network connections) and a subset of edges that interconnect the nodes representing those users. Some graph neural networks are configured to receive, as input, data derived from a graph neural network. For example, a graph data set representing a social network may be processed by a graph neural network that receives, as input, data associated with messages exchanged among users of the social network, and provides, as output, an analysis of the messages. Some graph neural networks are configured to receive, as input, non-graph data (e.g., an input vector including coordinates of roads and/or cities in a geographic region) and generate graph data as output (e.g., a graph including odes that represent the cities, and edges that represent roads interconnecting the nodes representing the cities).

Some graph neural networks are configured to process input data as graph data. As an example, some graph neural networks are configured to receive, as input, data that represents each of one or more nodes of a graph data set and one or more edges that respectively interconnect two or more nodes of the graph data set. The graph neural network may process a state of each node and/or edge of the input graph data in order to generate an updated state of the node and/or edge. The term “message passing” refers to evaluating and updating the state of a node N or an edge E of a graph based on the states of one or more neighboring nodes N and/or connecting edges E. For example, for each node N1, the graph neural network may evaluate the state of node N1 and/or states of a set of nodes N that are connected to node N1 by at least one edge (e.g., a neighborhood of nodes that includes N1) and may determine an updated state of node N1 based on the state of the node N1 and/or the states of the neighboring nodes N. As another example, for each node N1, the graph neural network may evaluate the state of the node N1 and/or the states of a set of edges E that connect node N1 to one or more other nodes of the graph, and may determine an updated state of node N1 based on the state of the node N1 and/or the states of the edges E. As yet another example, for each edge E1 of the input graph, the graph neural network may evaluate a state of the edge E1 and/or the states of a set of nodes N of the graph that are connected to the edge E1 and may determine an updated state of edge E1 based on the state of the edge E1 and/or the states of the connected nodes N. As yet another example, for each edge E1 of the input graph that connects a set of nodes N of the graph, the graph neural network may evaluate the state of the edge E1 and the states of the set of edges E that are also connected at least one of the set of nodes N and may determine an updated state of edge E1 based on the state of the edge E1 and/or the states of the other edges. In these and other scenarios, each node N and/or each edge E is evaluated and updated based on a collection of “messages” corresponding to the states of neighboring nodes N and/or connecting edges E.

In some graph neural networks, each node N1 is updated based on a neighborhood of size 1, including only on the states of the edges E that are directly connected to node N1 and/or the states of the other nodes N that are directly connected to node N1 by an edge. In some other graph neural networks, each node N1 is updated based on a neighborhood of a size S greater than 1, including the states of other nodes N that are within S edge connections of node N1 and/or edges E that are connected to any such nodes N. In some graph neural networks, each edge E1 is updated based on a neighborhood of size 1, including only on the states of the nodes N that edge E1 connects and/or the edges E that are also connected to the nodes N that edge E1 connects. In some other graph neural networks, each edge E1 is updated based on a neighborhood of a size S greater than 1, including the states of other nodes N that are within S edge connections of node N1 and/or the set of edges E that are connected to any such nodes N. In some graph neural networks with a neighborhood of size greater than 1, one or more first layers of neurons process each node and/or edge based on the nodes and/or edges within a neighborhood of size 1; a second one or more following layers of neurons further process each node and/or edge based on the nodes and/or edges within a neighborhood of size 2; and so on. That is, the first one or more layers update the state of each node and/or edge based on the states of the directly connected nodes and/or edges, and each following one or more layers further updates the state of each node and/or edge additionally based on the states of indirectly connected nodes and/or edges that are one or more further connections.

In some graph neural networks, the states of nodes N and/or edges E are evaluated and updated concurrently (e.g., the graph neural network may evaluate the features relevant to each node N and/or each edge E to determine an update, and may do so for all nodes N and/or all edges E, before applying the updates to update the internal states of each node N and/or each edge E). In some graph neural networks, the states of nodes N and/or edges E are evaluated and updated consecutively (e.g., the graph neural network may evaluate the features relevant to a first node N1 and update the state of node N1 before evaluating the features relevant to a second node N2 and updating the state of node N2). In some graph neural networks, the states of the nodes N and/or the edges E are consecutively evaluated and updated according to a sequential order (e.g., the graph neural network first evaluates and updates a state of a first node N1 that is of a high priority, and then evaluates and updates a state of a first node N2 that is of a lower priority than N1). In some graph neural networks, a state of a node N2 is evaluated after updating a state of a node N1 and, further, based on the updated state of node N1. In some graph neural networks, a state of an edge E2 is evaluated after updating a state of an edge E1 and, further, based on the updated state of an edge E1. In some graph neural networks, the states of nodes N are concurrently evaluated and updated, and then the states of edges E are concurrently evaluated and updated concurrently. In some graph neural networks, the states of edges E are concurrently evaluated and updated, and then the states of nodes N are concurrently evaluated and updated concurrently. These variations in the order of updating the nodes N and/or edges E can be variously combined with the previously discussed variations in the processing of neighborhoods. For example, a graph neural network may include a first one or more layers that are configured to evaluate and concurrently update the states of all nodes and edges within a neighborhood of size 1, followed by a second one or more layers that are configured to evaluate and concurrently update the states of all nodes and edges within a neighborhood of size 2. Another graph neural network may a graph neural network may include a first one or more layers that are configured to evaluate and concurrently update the states of all nodes within a neighborhood of size 1, followed by a second one or more layers that are configured to evaluate and concurrently update the states of all nodes within a neighborhood of size 2, further followed by one or more layers that are configured to update the states of all edges within a neighborhood of size 1 or more.

Some graph neural networks are configured to evaluate and/or update one or more node properties of one or more nodes of a graph data set. For example, a graph representing a social network may include nodes that represent people, and a graph neural network may evaluate the nodes and/or edges of the graph to predict one or more node properties that correspond to attributes of the person, such as a type of the person, an age of the person, or an opinion of the person. Some graph neural networks are configured to evaluate and/or update one or more edge properties of one or more edges of a graph data set. Some graph neural networks are configured to evaluate and/or update one or more edge properties of one or more edges of a graph data set. For example, a graph representing a social network may include nodes that represent people and edges that represent relationships between people, and a graph neural network may evaluate the nodes and/or edges of the graph to predict one or more edge properties that correspond to attributes of a relationship among two or more people, such as a type of the relationship, a strength of a relationship, or a recency of the relationship. Some graph neural networks are configured to evaluate and/or update one or more graph properties of the graph data set. For example, a graph representing a social network may include nodes that represent people and edges that represent relationships between people, and a graph neural network may evaluate the nodes and/or edges of the graph to predict a feature of a social group to which all of the people belong, such as a common interest or a common demographic trait that is shared by at least many of the people of the social network.

Some graph neural networks are configured to generate graph data as output. The generated graph data may include one or more nodes (optionally including one or more node properties), one or more edges (optionally including one or more edge properties), and/or one or more graph properties. The generated graph data may be based on input graph data. Some graph neural networks may be configured to receive at least a portion of a graph data set as input, and may generate, as output, modified graph data. As an example, the input graph data set may include a number of nodes and a number of edges interconnecting the nodes, and in the output graph data set generated by the graph neural network, each of the nodes and/or edges of the graph may have been updated based on one or more nodes and/or one or more edges of the input graph data. For example, an input graph data set may represent a social network including a nodes representing people and edges representing relationships between people. A graph neural network may be configured to receive at least a portion of the input graph data set, and may output an adjusted graph data set, wherein a state at least one of the nodes and/or at least one of the edges is updated based on the processing of the input data set. For example, various edges representing relationships may be updated to include additional data (e.g., edge properties) to represent an updated relationship between two people represented by nodes. Various nodes may be updated with to include additional data (e.g., node properties) to represent updated information about corresponding people based on the relationships. Various graph properties of the at least a portion of the graph data set may be updated based on the updated edges and/or nodes, e.g., a new common interest that is shared among many of the people in the social network.

Some graph neural networks may be configured to output graph data that includes one or more newly discovered nodes based on the input graph data set. For example, an input graph data set representing travel events may include edges that include routes of travelers and nodes that represent locations of interest. A graph neural network may receive the input graph data set, and based on processing of the routes of the travelers, may output an updated graph data set that includes a new node that represents a new location of interest (e.g., a destination of a large number of recent travelers). The output of the graph neural network may include, for one or more new or existing nodes, one or more new or updated node properties (e.g., a classification of the location of interest based on the travel routes). Alternatively or additionally, some graph neural networks may be configured to output graph data that excludes one or more existing nodes of an input graph data set. For example, based on processing the input data set representing routes of travelers, a graph neural network may output an updated graph data set that excludes one of the nodes of the input graph data set representing a location that is no longer a location of interest (e.g., a destination that travelers no longer visit).

Some graph neural networks may be configured to output graph data that includes one or more newly discovered edges based on the input graph data set. For example, an input graph data set may represent a social network including nodes that represent people and edges that represent connections between people. A graph neural network may receive the input graph data set, and based on processing of the people and connections, may output an updated graph data set that includes a new connection between two people (e.g., a likely relationship based on shared traits and/or mutual relationships with a number of other people representing a social circle). The output of the graph neural network may include, for one or more new or existing edges, one or more new or updated edge properties (e.g., a classification of a relationship between two or more people). Alternatively or additionally, some graph neural networks may be configured to output graph data that excludes one or more existing edges of an input graph data set. For example, based on processing the input data set representing a social network, a graph neural network may output an updated graph data set that excludes one or more of the edges of the input data set representing a relationship that no longer exists (e.g., a lost connection based on a splitting of a social circle).

Some graph neural networks may output graph data that is based on data that does not represent an input graph data set. For example, a graph neural network may be configured to receive non-graph data, such as lists of travel routes of drivers, and may generate and output a graph data set including nodes that represent locations of interest and edges that interconnect the locations of interest. Conversely, some graph neural networks may receive input that includes at least a portion of a graph data set and that outputs non-graph data based on the input graph data. For example, a graph neural network may be configured to receive input including graph data, such as a graph of a social network including nodes that represent people and edges that represent connections, and to output non-graph data based on analyses of the input graph data, such as statistics about the people represented in the social network and activity occurring therein.

### Graph Neural Networks—Properties

Graph neural networks, including (without limitation) those described above, may be subject to various properties and/or considerations of design and/or operation. These considerations may affect their architecture, processing, implementation, deployment, efficiency, and/or performance.

As previously discussed, graph neural networks may include edges with varying directionality, such as undirected edges (e.g., edges that represent distances between pairs of nodes that represent cities in a graph that represents a region), unidirectional edges (e.g., edges that represent parent/child relationships among nodes that represent people in a graph that represents a genealogy or lineage), and/or multidirectional edges (e.g., bidirectional edges that represent bidirectional roads between nodes that represent cities in a graph that represents a region). In some graph data sets, all of the edges have a same directionality (e.g., all edges are undirected). A graph neural network can be configured to receive an input vector corresponding to the input data set and to process the edges according to the uniform directionality of the edges (e.g., processing undirected edges without regard to the order in which the nodes are represented as being connected to the edge). Other graph data sets may include edges with different directionality (e.g., in a graph that represents a region, edges can represent roads between nodes that represent cities, and each edge can be either unidirectional to represent a one-way road or bidirectional to represent a two-way road). A graph neural network can be configured to receive an input vector corresponding to the input data set and to process the edges according to the distinct directionality of each edge (e.g., processing a unidirectional edge in a different manner than a bidirectional edge). As one such example, the graph neural network can interpret a bidirectional edge connecting two nodes N1, N2 as a first unidirectional edge that connects node N1 to N2 and a second unidirectional edge that connected node N2 to node N1. The pair of unidirectional edges can share various edge properties and/or can be evaluated and/or updated in a same or similar manner (e.g., for a pair of unidirectional edges corresponding to a bidirectional road, the graph neural network can process data representing a weather condition in a same or similar manner to both unidirectional edges associated with the bidirectional road).

As previously discussed, some graph neural networks are configured to process nodes according to a “message passing” paradigm, in which the evaluation of each node N1 is based on the states and/or evaluations of other nodes within a neighborhood of the node N1 and/or the edges that connect the node N1 to other nodes in the neighborhood of the node N1. That is, the state of each node in the neighborhood of the node N1 and/or the state of each edge that connects N1 to other nodes of the neighborhood serves as a “message” that informs the evaluation and/or updating of the state of node N1 by the graph neural network. Alternatively or additionally, the evaluation of each edge E1 is based on the states and/or evaluations of other edges within a neighborhood of the edge E1. That is, the state of each node connected by edge E1, and, optionally, the states of other nodes connected to those nodes and/or other edges in such connections, serves as a “message” that informs the evaluation and/or updating of the state of edge E1 by the graph neural network. In each case, the size of the neighborhood can vary; for example, the graph neural network can evaluate each node according to a one-hop neighborhood or a multi-hop neighborhood. Graph neural networks that perform multi-hop neighborhood evaluation can include multiple layers, where a first one or more layers are configured to process a first hop between a node N1 and a one-hop neighborhood including its directly connected neighbors and/or directly connected edges, and a second one or more layers following the first one or more layers are configured to process a second hop between the nodes and/or edges of the one-hop neighborhood and additional nodes and/or edges that are directly connected to the nodes and/or edges of the one-hop neighborhood. In this manner, each node N1 is first evaluated and/or updated based on a message passing among the one-hop neighborhood, and is then evaluated and/or updated based on additional messages within the two-hop neighborhood, etc. Other architectures of graph neural networks may perform multi-hop neighborhood evaluation in other ways, e.g., by processing individual clusters of nodes and/or edges to perform message passing among the nodes and/or edges of each cluster, and then performing additional message passing between clusters to update nodes and/or edges of each cluster based on the nodes and/or edges of one or more neighboring clusters.

In some scenarios, a graph may include nodes and/or edges that are stored, represented, and/or provided as input that is not subject to any particular order (e.g., nodes representing points in a line drawing may not have any node properties, and may therefore be represented in arbitrarily different orders in the input graph data set). In such scenarios, a multitude of semantically equivalent input graph data sets may be logically equivalent to one another. That is, a first representation of a graph may include the nodes and/or edges in a particular order, while a second representation of the same graph may include the same nodes and/or edges in a different order. While both representations of the graph are logically equivalent, the different ordering in which the nodes and/or edges are provided as input to the graph neural network may cause the graph neural network to provide different output. In other scenarios, a graph comprising a set of nodes and a set of interconnecting edges may be organized, stored, and/or represented in a particular order. For example, the nodes may be ordered according to a property of the nodes, and/or edges may be ordered according to a property of the edges (e.g., in a social network, nodes representing people may be ordered according to the alphabetical order of their names, and edges representing relationships may be ordered according to the alphabetical order of the names of the related people). In such scenarios, changes to the order and/or the selected subsets of graph data may result in different input data sets that represent the same or similar (e.g., logically equivalent) graphs. Due to the manner in which a graph neural network processes the input graph data set, logically equivalent input graph data sets may result in different and logically distinct output data.

In such scenarios, it may be undesirable for the graph neural network to generate different output for different but logically equivalent representations. That is, it may be desirable for the graph neural network to provide the same or equivalent output for different but logically equivalent representations of a graph. Graph neural networks that exhibit this property can be referred to as “permutation invariant,” that is, capable of providing output that does not vary across permutations in the representation of the input graph data set. A variety of techniques may be used to achieve, improve, and/or promote permutation invariance. Some such techniques involve changing representations of the input data set. For example, before processing an input graph data set, the graph neural network may reorder the input data set (e.g., by reordering the units of an input vector) such that nodes and edges are represented in a consistent order. As one such example, an input graph data set may include nodes that represent cities, and the input graph data set may include the nodes and/or edges in varying orders. Prior to processing the input graph data set, the graph neural network may reorder the nodes based on latitude and longitude coordinates of the cities, and the edges can similarly be reordered based on the latitude and longitude coordinates of the nodes connected by each edge. Thus, any representation of the graph including nodes that represent the same set of cities is processed in a similar manner. Similar reordering may involve various node properties and/or edge properties, including (without limitation) an alphabetic ordering of names in a graph including nodes that represent people, a chronological ordering of dates in a graph including nodes that represent events, a numeric ordering of content-based hashcodes in a graph including nodes that represent objects, and/or a numeric ordering of identifiers in a graph including nodes that possess unique numeric identifiers. Other techniques for achieving, improving, and/or promoting permutation invariance involve transforming an input graph data set into a different, permutation-invariant representation that is provided as input to and processed by the graph neural network. For example, a graph data set representing a two-dimensional image or a three-dimensional point cloud may include nodes that represent pixels and edges that represent spatial relationships (e.g., distances and/or orientations) between respective pairs of pixels of the image or respective pairs of points in the point cloud. Different orderings of the pixels and/or points may result in differently ordered, but logically equivalent, graph data sets for a particular image or point cloud. Instead of processing the graph data sets as input, a graph neural network may be configured to convert the input graph data set into a spectral representation, e.g., based on a spectral decomposition of a Laplacian L of the input graph data set. Instead of encoding information about individual pixels and/or points, the spectral representation instead encodes spectral components of the input graph data sets. The spectral components can be ordered in various ways (e.g., by frequency and/or polynomial order) to generate a permutation-invariant input vector, and the processing of the permutation-invariant input vector by a graph neural network may result in invariant (e.g., identical or at least similar) output of the graph neural network for various permutations of the input graph data set.

Alternatively or additionally, some techniques for achieving, improving, and/or promoting permutation invariance may relate to the structure of the graph neural network. For example, as an alternative or addition to reordering an input graph data set, a graph neural network may include one or more layers of neurons that process an input vector and generate permutation-invariant output. As one such example, a graph neural network may include a pooling layer that receives an input vector (e.g., an input vector corresponding to an input graph data set, and/or an input vector corresponding to an output of one or more previous layers of the graph neural network) and generates output that is pooled over the input, such as a minimum, maximum, or average of the units of the input. Because operations such as a minimum, maximum, and/or average over a data set are permutation-invariant mathematical operations, the graph neural network may therefore exhibit permutation-invariance of output based on the pooling operation for differently ordered but logically equivalent representations of a particular graph data set. As another such example, a graph neural network may include a filtering layer that receives an input vector (e.g., an input vector corresponding to an input graph data set, and/or an input vector corresponding to an output of one or more previous layers of the graph neural network) and generates output that is filtered based on certain permutation-invariant criteria. For example, in a graph representing a social network that includes nodes representing people, a layer of the graph neural network may filter the nodes to limit the input data set based on the top n nodes of the graph neural network that correspond to the most influential people in the social network. Such filtering may be based, e.g., on a count of the edges of each node (i.e., a count of the number of relationships of each person to other people of the social network), or a weighted calculation based on the influence of the nodes to which each node is related and/or the strength of each such relationship. Because such filtering operation are permutation-invariant logical operations, the graph neural network may therefore exhibit permutation-invariance of output based on the filtering operation for differently ordered but logically equivalent representations of the nodes (i.e., people) and edges (i.e., relationships) of the social network. As yet another example, some graph neural networks include an encoding or “bottleneck” layer, in which an output from N neurons of a preceding layer is received as input and processed by a following layer that includes fewer than N neurons. Due to the smaller number of neurons in the following layer, the volume of data that encodes features of the output of the preceding layer is compressed into a smaller volume of data that encodes features of the output of the following layer. This compression of features, based on learned parameters and training of the graph neural network to produce expected outputs, can cause the graph neural network to encode only more significant features of the processed data, and to discard less significant features of the processed data. The reduced-size output of the neurons of the following layer can be referred to as a latent space encoding of the input feature set. For example, whereas an input graph data set may include nodes that correspond to all pixels of an image of a cat, and an output of a previous layer of the graph neural network may include partially processed information about each node (i.e., each pixel) of the image of the cat, the output of the following layer of the graph neural network may include only features that correspond to visually significant features of the cat (e.g., features that correspond to the pixels that represent the distinctively shaped ears, eyes, nose, and mouth of the cat). Thus, the latent space encoding may reduce the processed input of the graph data set into a smaller encoding of nodes that represent significant visual features of the graph data set, and may exclude data about nodes that do not represent significant visual features of the graph data set. Many such graph neural networks include one or more “bottleneck” layers as one or more autoencoder layers, e.g., layers that automatically learn to generate latent space encodings of input data sets. As one such example, deep generative models may be used to generate output graph data that corresponds to various data types (e.g., images, text, video, scene graphs, or the like) based on an encoding, including an autoencoding, of an input such as a prompt or a random seed, Additional techniques for achieving or promoting permeation-invariance are presented elsewhere in this disclosure and/or will be known to or appreciated by persons of skill in the art.

In some scenarios, a graph data set may include a large number of nodes and/or a large number of edges. For example, a graph data set representing a social network may include thousands of nodes that represent people and millions of edges that represent relationships among the people. The size of the graph data set may result in an input vector that is very large (e.g., a very long input vector), and that might require a correspondingly large graph neural network to process (e.g., a graph neural network featuring millions of weights that connect the input graph data set to the nodes of a first layer of the graph neural network). The size of the input data set may result in large and perhaps prohibitive computational resources to receive and/or process the graph data set (e.g., large and costly storage and/or processing to store the input graph data set and/or the parameters and/or hyperparameters of the graph neural network, and/or a protracted delay in completing the processing of an input graph data set by the graph neural network). Further, the graph data set may exhibit properties of sparsity that cause a large portion of the input data set to be inconsequential. For example, a graph data set representing a social network may be encoded as a vector of N units respectively representing each node (i.e., each person) followed by a vector of N×N units that respectively represent a potential relationship between each node N1 and each node N2. Edges that represent a multidimensional mapping of connections between nodes (such as an N×N mapping of edges that represent possible connections between nodes) can be referred to as an adjacency matrix. However, in the social network, most people may have only a small number of relationships (i.e., far less than N−1 relationships with all other people of the social network). Thus, in the vector encoding of the input graph data set, a large majority of the N×N units that respectively represent potential relationships between each pair of nodes N1, N2 (i.e., the adjacency matrix) may be negative or empty (representing no relationship), and only a very small minority of the N×N units that respectively represent potential relationships between each pair of nodes N1, N2 may be positive or non-empty (representing a relationship). As another example, a graph data set representing a region may include N nodes representing cities and N×N edges representing possible roads between cities. However, if each city is only directly connected to a small number of neighboring cities, then a large majority of the N×N edges representing possible roads between cities (i.e., the adjacency matrix) may be negative or empty (representing no road connection), and only a very small minority of the N×N units that respectively represent potential roads between each pair of nodes N1, N2 may be positive or non-empty (representing an existing road). In such cases, the sparsity of an input vector representing the graph neural network may inefficiently consume computational resources (e.g., inefficiently applying storage and/or computation to large numbers of negative or empty units of the input vector) and/or may unproductively delay the completion of processing of the input graph data set.

Various techniques can be applied to reduce the sparsity of graph data sets and the processing of such graph data sets by graph neural networks. As a first example, the graph neural network can be pruned to reduce the number of nodes and/or edges included as an input data set (e.g., filtering the nodes of a graph neural network to a small cluster of densely related nodes, such as a small number of highly interrelated nodes that represent the members of a social circle in a social network). As a second example, the graph neural network can be encoded in a way that reduces sparsity. For example, rather than encoding the input graph data set as an adjacency matrix, the graph neural network may be configured to receive an encoding of the input graph data set as an adjacency list, i.e., as a list of edges that respectively connect two or more nodes of the graph. Due to encoding only information about existing edges, an adjacency list can eliminate or at least reduce the encoding of nonexistent edges. As a result, the size of the adjacency list may therefore be much smaller than a size of a corresponding adjacency matrix, and can therefore eliminate or at least reduce the sparsity of the input graph data set. The adjacency list can include edge properties of the edges of the graph data set. The adjacency list can be limited to a particular size (e.g., the top N most influential connections in a social network). The nodes of the input graph data set can be limited based on the edges included in the adjacency list (e.g., excluding any nodes that are not connected to at least one of the edges included in the adjacency list). As yet another example, rather than encoding an entire set of nodes and edges, a graph neural network can be represented as an encoding of the nodes and edges. For example, a graph data set may include nodes that represent pixels of an image and edges that represent spatial representations of the pixels. However, if large areas of the image are inconsequential (e.g., dark, empty, or not associated with any notable objects in a segmented image), then large portions of the nodes and/or edges would be inconsequential. Instead, the image can be reencoded as a frequency-domain representation as coefficients associated with respective frequencies of visual features within the image. The frequency-domain representation may present greater information density than the adjacency matrix of pixels, and therefore may present an input to the graph neural network that encodes the visual features of the input graph data set with reduced sparsity.

Other techniques for eliminating or reducing sparsity, and therefore increasing efficiency, involve the architecture of the graph neural network. For example, the input graph data set may encode edges as an adjacency matrix, and a first layer of the graph neural network may reencode the edges of the input graph data set as an adjacency list for further processing by the graph neural network. As another example, the graph neural network may include a first one or more layers that is configured to process an entirety or at least a large portion of the nodes and/or edges of an input graph data set, followed by a filtering layer that is configured to limit an output of the first one or more layers of the graph neural network. For example, in a graph data set that includes nodes that represent people and edges that represent connections, a first one or more layers may process all of the nodes and/or edges, and a filtering layer can limit the further processing of the output of the first one or more layers to the nodes and/or edges for which the outputs of the first one or more layers are above a threshold (e.g., an influence and/or relationship significance threshold). As still another example, the graph neural network may receive a sparse graph input data set but may only process a portion of the input graph data set (e.g., one or more random sampling of subsets of nodes and/or edges). In some cases, the graph neural network may compare results of the processing of subsets of the input graph data set (e.g., randomly sampled subsets of the nodes and/or edges) and may aggregate such results until the results appear to converge within a confidence threshold. In this manner, the graph neural network may generate an acceptable output within the confidence threshold while avoiding processing an entirety of the sparse input graph data set. Many such techniques for eliminating and/or reducing sparsity are presented elsewhere in this disclosure and/or will be known to or appreciated by persons of skill in the art.

### Graph Neural Networks—Input, Processing, and Output

Graph data sets may represent a variety of data types, including (without limitation) maps of geographic regions, including nodes representing cities and edges representing roads that connect two or more cities; social networks, including nodes representing people and edges representing relationships between two or more people; communication networks, including nodes representing people or devices and edges representing communication connections between the nodes or edges; economies, including nodes representing companies and edges representing transactions between two or more companies; molecules, including nodes representing atoms and edges representing bonds between two or more atoms; collections of events, including nodes representing individual events and edges representing causal relationships among two or more events; and periods of time, including nodes representing events and edges representing chronological periods among two or more events. Graph data sets may also represent data types, such as passages of text, including nodes representing words and edges representing relationships among two or more words; images, including nodes representing pixels and edges representing spatial relationships among two or more pixels; object graphs, including nodes representing objects and edges representing dependencies among two or more objects; and three-dimensional spatial maps, including nodes representing three-dimensional objects and edges representing spatial relationships among two or more of the three-dimensional objects. Some graph data sets may include two or more subgraphs. In some such graph data sets, each node and/or each edge is exclusively included in one subgraph. In some other graph data sets, at least one node and/or at least one edge may be included in two or more subgraphs, or in zero subgraphs. Some graph data sets are associated with non-graph data that is also included as input to a graph neural network. For example, a graph neural network that evaluates traffic patterns within a geographic region may receive, as input, both an input graph data set that includes nodes that represent cities and edges that represent roads interconnecting the cities, and also non-graph data representing traffic and/or weather features within the geographic region (e.g., traffic volume estimates and current or forecasted weather conditions that affect the traffic patterns).

As another example, some graph data sets may include an indication of zero or more cycles occurring among the nodes and/or edges of the graph data set. For example, a directed and/or undirected graph data set may include an indication that a particular cycle exists within the graph and includes a particular subset of nodes and/or edges. Alternatively, a directed and/or undirected graph data set may include an indication that the graph is acyclic and does not include any cycles. A graph neural network may be configured to receive, as input, and process a graph data set that includes an indication of zero or more cycles.

As another example, some graph data sets may include nodes for which the edges provide spatial dimensions. As a first example, in a graph representing a geographic region, nodes that represent cities are related by edges that represent distances, wherein the nodes and interrelated edges can form a spatial map of the geographic region. As a second example, in a graph representing a molecule, nodes that represent atoms are related by edges that represent chemical bonds between the atoms, and the arrangement of atoms by the bonds forms a three-dimensional molecular structure. In some such scenarios, the spatial relationships are well-defined by the nodes and edges. In other such scenarios, the spatial relationships can be inferred based on semantic relationships among the nodes and/or edges of the graph data set. For example, in a graph representing a language, nodes that represent words are related by edges that represent semantic relatedness of the words within a high-dimensional language space. A language model can generate an embedding of the words of the language in a multidimensional embedding space, wherein nodes that are close together within the embedding space represent synonyms, closely related concepts, or words that frequently appear together in certain contexts, whereas nodes that are not close together within the embedding space represent unrelated concepts or words that do not commonly appear together in various contexts. A variety of graph embedding models may be applied to this task, including (without limitation) DeepWalk, node2vec, line, and/or GraphSAGE. A graph neural network can be configured to receive, as input, an embedding of a graph data set instead of representations of the nodes and/or edges of the graph data set. Alternatively, a graph neural network can be configured to receive an input graph data set including representations of the nodes and/or edges of the graph data set, generate an embedding based on the input graph data set, and apply further processing to the embedding instead of to the input graph data set. A graph neural network that is configured to process an embedding instead of an input graph data set may exhibit greater permutation invariance (e.g., due to the semantic associations represented by the embedding) and/or increased efficiency due to reduced sparsity of the input.

Some graph data sets include representations of each of one or more nodes and each of one or more edges. Some graph neural networks are configured to receive and process such representations of graph neural networks. For example, the graph neural network may be configured to receive an input vector including an array of data representing each of the one or more nodes followed by an array of data representing each of the one or more edges, either as an adjacency matrix of possible edges between pairs of nodes or an adjacency list of existing edges. The input vector may encode the nodes and/or edges in a particular order (e.g., a priority order of nodes and/or a weight order of edges) or in an unordered manner. Alternatively or additionally, the graph data set may include and/or encode other types of information about each of one or more nodes and/or each of one or more edges of the graph data set. For example, the graph may include a hierarchical organization of nodes and/or edges relative to one another and/or to a fixed reference point. The graph neural network may be configured to receive and process an input graph data set that includes an indication of the arrangement of one or more nodes and/or one or more edges in the hierarchical organization.

As another example, a graph may include an indication of a centrality of one or more nodes and/or edges within the graph (e.g., a graph of a social network including nodes that are ranked based on a centrality of each node to a cluster). The graph neural network may be configured to receive and process an input graph data set that includes an indication of a centrality of one or more nodes and/or one or more edges in the graph.

As another example, a graph may include an indication of a degree of connectivity of one or more nodes and/or edges within the graph (e.g., a graph of a social network including nodes that are ranked according to a count of other nodes to which each node is connected by one or more edges, and/or a degree of significance of a relationship represented by an edge based on the nature of the relationship and/or the degrees of the nodes connected by the edge). The graph neural network may be configured to receive and process an input graph data set that includes an indication of a degree of one or more nodes and/or one or more edges in the graph.

As another example, a graph may include an indication of one or more clusters occurring within the graph. For example, a graph may include a result of a clustering analysis of the graph, e.g., a determination of k clusters within the graph and an identification of the nodes and/or edges that are included in each cluster. The clusters may be determined by a k-means clustering analysis, a Gaussian mixture model of with variable numbers of clusters and variable Gaussian orders, or the like. A graph may include a clustering coefficient of one or more nodes and/or one or more edges (e.g., a measurement of a degree to which at least some of the nodes and/or edges of a subgraph of the graph are clustered based on similarity and/or activity). The graph neural network may be configured to receive and process an input graph data set that includes an indication of a clustering coefficient of one or more nodes and/or one or more edges in the graph or a subgraph thereof.

As another example, a graph may include an indication of a graphlet degree vector that indicates a graphlet that is represented one or more times in the graph. For example, in a graph representing atoms in a regular structure such as a crystal, the graph may include a graphlet degree vector that indicates and/or describes a graphlet representing a recurring atomic structure, and an encoding of the regular structure that indicates each of one or more occurrences of a graphlet, including a location and/or orientation, and/or a count of occurrences of the graphlet. The graph neural network may be configured to receive and process an input graph data set that includes a graphlet degree vector, and, optionally, features of one or more occurrences of a graphlet in the graph and/or a count of the occurrences of the graphlet in the graph.

As another example, a graph may include an indication of one or more paths and/or traversals of one or more nodes and/or one or more edges of the graph, optionally including additional details associated with a path or traversal such as a popularity, frequency, length, difficulty, cost, or the like. For example, in a graph representing a spatial arrangement of nodes, the graph may include a path or traversal of edges that connect a first node to a second node through zero or more other nodes, as well as properties of the path or traversal such as a total length, distance, time, and/or cost. The graph neural network may be configured to receive and process an input graph data set that includes additional details associated with one or more paths or traversals, including an indication (e.g., a list) of the associated nodes and/or edges and a list of one or more properties of the path and/or traversal.

As another example, a graph may include an indication of metrics or properties that relate one or more nodes and/or one or more edges. For example, in a graph including a spatial arrangement of nodes, the graph may include an indication of a shortest distance between two nodes and/or an indication of a set of nodes and/or edges that are common to two nodes. As another example, a graph representing a network of communicating devices may include a routing table of one or more routes that respectively indicate, for a particular node and a particular edge connected to the node, a list of other nodes and/or edges that can be efficiently reached by traversing based on the particular edge. As yet another example, in a graph representing a social network including nodes that represent people, the graph may indicate, for at least one pair of nodes, a measurement of similarity of the nodes based on their node properties, edges, locations in the social network, connections to other nodes, or the like (e.g., a Katz index of node similarity) and/or, for at least one pair of edges, a measurement of similarity of the edges based on their edge properties, connected nodes, locations in the social network, or the like (e.g., a Katz index of edge similarity). The graph neural network may be configured to receive and process an input graph data set that includes one or more metrics or properties that relate one or more nodes and/or one or more edges (e.g., a routing table of routes within the graph, and/or a Katz index that indicates a measurement of similarity among at least two nodes and/or at least two edges).

As another example, a graph may include an indication of various graph properties of the graph (e.g., a graph size, graph density, graph interconnectivity, graph chronological period, graph classification, a count of subgraphs within the graph, or the like). For example, in a graph including two or more subgraphs (e.g., a social network including two or more social circles), the graph data set may include a measurement of a similarity of each subset of at least two subgraphs of the graph. The measurement of the similarity may be determined based on one or more graph kernel methods (e.g., a Gaussian radial basis function that can be applied to the graph to identify one or more clusters of similar nodes that comprise a subgraph). As another example, a graph may include a measurement of similarity with respect to another graph (e.g., an indication of whether a particular social network graph resembles other social network graphs that have been classified as representing a genealogy or lineage, a set of friendships, and/or a set of professional relationships). The graph neural network may be configured to receive and process an input graph data set that includes measurements determined by one or more graph properties (e.g., one or more measurements of similarity of one or more nodes, edges, and/or subgraphs, and/or a measurement of similarity of the graph to other graphs). Further explanation and/or examples of various graph data sets that may be provided as input to graph neural networks are presented elsewhere in this disclosure and/or will be known to or appreciated by persons skilled in the art.

Graph neural networks may be configured to perform various types of processing over such graph data sets. As previously discussed, a graph neural network can be organized as a series of layers, each of which can include one or more nodes that receive input, apply an activation function, and generate output. The output of each node of a first layer can be multiplied by a weight of a connection between the node and a node of a second layer, and then added to a bias associated with the first layer, to generate an input to the node of the second layer. The graph neural network can include various additional layers that perform other types of processing, including (without limitation) pooling, filtering, and/or latent space encoding operations, memory or stateful features, and recurrent and/or reentrant processing.

Some graph neural networks may perform label propagation among the nodes and/or edges of a graph data set. For example, in an input graph data set, one or more nodes and/or one or more edges may be associated with one or more labels of a label set, while one or more other nodes and/or one or more other edges may not be associated with any labels. A graph neural network may apply a label propagation algorithm (LPA) to assign labels to one or more unlabeled nodes and/or one or more unlabeled edges. For example, the graph neural network may assign a label to an unlabeled node based on labels associated with one or more edges connected to the node, and/or with one or more other nodes that are connected to the node by the one or more edges. The graph neural network may assign a label to an unlabeled edge based on labels associated with one or more nodes connected by the edge, and/or with one or more other edges that are also connected to the nodes connected by the edge. Some graph neural networks may perform label propagation based on a voting, consensus, weighting, and/or scoring determination. For example, a graph neural network may be unable to perform a classification of an unlabeled node and/or unlabeled edge based solely on the node properties and/or edge properties, but may be able to perform the classification based on a further consideration of the labels associated with other nodes and/or edges within a neighborhood of the unlabeled node and/or unlabeled edge.

Some graph neural sets may perform a scoring and/or ranking of nodes and/or edges of a graph data set. As an example, in a graph data set that represents the World Wide Web and that includes nodes that represent web pages and directed edges that represent hyperlinks of linking web pages to linked web pages, a graph neural network may determine one or more scores of each node (i.e., each web page) based on the scores of other nodes that hyperlink to the node. Each score may further be based on the scores of the other nodes that include a directed edge to this node (e.g., the scores of other web pages that hyperlink to this page). Additionally, each score associated with a node may represent a weight of an association between the web page and a particular topic (e.g., a particular topic or keyword that is associated with the web page, hyperlinks, and/or other pages that hyperlink to this web page). In some cases, the scores may be personalized based on the activities of a particular user (e.g., based on the hyperlinks from pages that the user frequently visits). A search engine may use the scores as rankings in order to generate search results for web searches including various topics or keywords (e.g., in response to a web search for a particular search term, present search results that correspond to the nodes with the highest scores associated with the search term, and present the search results in ranked order based on the scores). As another example, for a graph data set representing a social network, a graph neural network may generate a reputation score for each node based on other nodes that are associated with the node and the reputation scores of such other nodes. The scores of the nodes may be used to recommend new connections in the social network (e.g., recommending a first person connect with a second person, based on a high reputation score of the second person by people who are closely associated with the first person).

Some graph neural networks may perform a clustering analysis of the nodes and/or edges of a graph data set. As a first example, in a graph data set representing a social network, a graph neural network may perform a clustering analysis of the nodes representing the people of the social network, based on edges representing relationships among two or more nodes, in order to identify one or more clusters that represent social circles of highly interconnected people within the social network. Based on this clustering analysis, the graph neural network may partition the social network into subgraphs that respectively represent social circles, and may perform further, finer-grained evaluation of each social circle and the people represented by the nodes in each subgraph. As a second example, in a graph data set representing a social network, a graph neural network may perform a clustering analysis of the edges representing the relationships among people of the social network, in order to identify one or more clusters that represent different types of relationships, such as familial relationships, friendships, and professional relationships. Based on this clustering analysis, the graph neural network may partition the social network into subgraphs that respectively represent different types of social networks, and may perform further analysis of relationships among two or more individuals based on the type of relationship associated with the subgraph to which the relationship belongs. In these and other scenarios, in order to perform clustering analysis, a graph neural network may utilize a variety of clustering algorithms. As one such example, a graph neural network may apply spectral clustering techniques, wherein a similarity matrix that represents similarities among nodes and/or edges is evaluated to identify eigenvalues that indicate significant similarity relationships. Based on the similarity matrix, the graph neural network may perform a dimensionality reduction of the graph data set (e.g., reducing the features of the nodes and/or edges that are evaluated to determine clusters in order to focus on features that are highly correlated with and/or indicative of significant similarities). Dimensionality reduction of the graph data set based on the similarity matrix may enable the graph neural network to determine clusters more efficiently and/or rapidly, e.g., by reducing a high-dimensionality graph data set (wherein each node and/or edge is characterized by a multitude of node properties and/or edge properties) into a lower-dimensionality graph data set of a subset of features that are highly correlated with and/or indicative of similarity and clustering.

Some graph neural networks may perform a centrality determination among nodes and/or edges of a graph data set. For example, for a graph data set representing a social network, a graph neural network may evaluate the graph data set to identify a subset of nodes based on a centrality among the edges representing the connections of the social network, e.g., people who are at the center of each of one or more social circles within the social network. Alternatively or additionally, some graph neural networks may perform a “betweenness” determination among the nodes and/or edges of the graph data set. For example, a node may be considered to be “between” two clusters of nodes, such as a member of two or more clusters representing two or more social circles. Such “between” nodes may represent a communication bridge that conducts information between clusters (e.g., a person who can convey ideas and/or influence from a first social circle to a second social circle and vice versa). Some such graph neural networks may perform “betweenness” determinations based on a betweenness centrality measurement, e.g., based on a measurement of a shortest path between all pairs of nodes in the graph data set. As another example, a graph data set may represent a collection of text documents, wherein each node represents a document and each edge represents a relationship between documents (e.g., a unidirectional or bidirectional citation between a first document and a second document). A graph neural network can perform a centrality determination and/or a betweenness determination to determine significant documents within the collection (e.g., a document that is heavily cited by one or more clusters of other documents, and/or a document that includes ideas or associations between the documents of a first cluster and the documents of a second cluster).

Some graph neural networks may perform analyses of structures occurring within a graph neural network. As an example, for a graph data set that represents a social network, a graph neural network may determine a notable sequence of relationships, such as a first relationship between node N1 and node N2 based on a shared interest, a second relationship between node N2 and node N3 based on the same shared interest, and a third relationship between node N3 and node N4 based on the same shared interest. Based on this sequence or chain of relationships, the graph neural network may recommend to a person represented by node N1 some further relationships with the people represented by nodes N3 and N4, due to the combination of shared interests and mutual relationships. In some such cases, a graph neural network may perform such structural analysis based on a traversal algorithm that traverses a sequence of nodes connected by one or more edges, and/or that traverses a sequence of edges connected by one or more nodes. As an example, a graph neural network may perform a random walk within the graph data set, such as starting with a first node (e.g., a first person of a social network) and following a limited set of edges that connect the first node to other nodes. In some cases, the traversal may be random (e.g., traversing from a node based on a random selection among the edges that connect the node to other nodes). In some other cases, the traversal may be weighted (e.g., each edge may include an edge property including a weight that represents a strength of a relationship among two or more nodes, and the traversal may be based on a weighted random selection that preferentially selects higher-weighted connections over lower-weighted connections). In some cases, the traversal can include a restart probability, e.g., a probability of retrying the traversal beginning with the original node or another node, based on a score such as a distance of the traversal with respect to the original node. In these and other cases, the results of a random walk can be used in further analyses and/or activities of the graph neural network (e.g., presenting recommendations for new social connections among the nodes of a social network).

Some graph neural networks may perform an analysis of a graph data set based on an attention model. For example, in a social network, the influence of a particular person P1 may not be determined by the connectedness of person P1 to other people in the social network, but based on a perception of person P1 by other people of the social network as being knowledgeable, skilled, influential, or the like. Thus, a graph neural network may be configured to evaluate a graph data set representing a social network in which nodes represent people and edges represent relationships, but may be unable to determine influence based only on graph concepts such as connectedness of the nodes based on the edges. Rather, the graph neural network might model influence as an attention of each node (i.e., a second person P2 of the social network) upon each other node (e.g., person P1 of the social network). Thus, a particular opinion of person P2 of the social network may depend not only on the connections of person P2 to other people of the social network (including person P1), but also upon the attention that person P2 accords to such other people of the social network (including person P1). That is, even though person P2 is closely connected to certain people of the social network by various edges, the opinion of person P2 may be heavily shaped by person P1 and other people to whom person P2 is only indirectly connected in the social network. As a second such example, in a graph data set that represents traffic flow within a region, an edge E1 (e.g., a first road) may be directly connected to other edges of the graph data set, but an edge property of the edge E1 (e.g., a traffic volume and/or congestion of the road) may be impacted more heavily by edge properties of other edges to which edge E1 is not directly connected (e.g., roads in other parts of the geographic region for which traffic volume and/or congestion is highly determinative of the traffic volume and/or congestion of this road). Thus, in order to predict and/or estimate a traffic volume and/or congestion of a particular road, a graph neural network may evaluate not only the traffic volume and/or congestion of other roads that are directly connected to the particular road, but also other roads for which traffic volume and/or congestion is highly determinative of corresponding conditions of this road. In these and other scenarios, a graph neural network may evaluate a graph data set based on an attention model, in which analyses and updates of the state of nodes and/or edges of the graph data set are based, at least in part, on an attention of each node and/or edge upon other nodes and/or edges of the graph data set. For example, the graph neural network may include an attention layer that determines, for a particular node and/or edge of an input graph data set, which other nodes and/or edges of the input graph data set are likely to be relevant to determining an updated state of the particular node and/or edge. Various attention models may be used by such graph neural networks, including multi-head attention models in which each node and/or edge is related to a plurality of other nodes and/or other edges with varying weighted attention values (e.g., by each of a plurality of attention layers). Multi-head attention models can allow a graph neural network to consider the influences upon a particular node and/or edge of a plurality of other nodes and/or edges, which may (or may not) be further related to one another by the graph structure and/or attention. Based on the attention model and the attention layers included in the graph neural network, the graph neural network can perform a more sophisticated graph analysis that is based on more than the structural relationships of the graph.

Some graph neural networks may be configured to process a graph data set in order to determine, and optionally output, various types of data (e.g., measurements, calculations, inferences, explanations, or the like) that relate to one or more nodes, one or more edges, and/or one or more subgraphs of the input graph data set and/or to the input data graph set as a whole. Some graph neural networks are configured to generate, and optionally output, various types of representations of graph neural networks. For example, the graph neural network may be configured to determine, and optionally output, an output vector including an array of data representing each of the one or more nodes followed by an array of data representing each of the one or more edges, either as an adjacency matrix of possible edges between pairs of nodes or an adjacency list of existing edges. The output vector may encode the nodes and/or edges in a particular order (e.g., a priority order of nodes and/or a weight order of edges, or corresponding to a corresponding order of the nodes and/or edges in the input graph data set) or in an unordered manner. Alternatively or additionally, the graph neural network may be configured to determine, and optionally output, other types of information about each of one or more nodes and/or each of one or more edges of the graph data set. For example, the graph neural network may be configured to determine, and optionally output, a hierarchical organization of nodes and/or edges relative to one another and/or to a fixed reference point. Alternatively or additionally, the graph neural network may be configured to determine, and optionally output, an output graph data set that includes an indication of the arrangement of one or more nodes and/or one or more edges in the hierarchical organization.

As another example, a graph neural network may be configured to determine, and optionally output, an indication of a centrality of one or more nodes and/or edges within the input graph data set (e.g., a graph of a social network including nodes that are ranked based on a centrality of each node to a cluster). Alternatively or additionally, the graph neural network may be configured to determine, and optionally output, an output graph data set that includes an indication of a centrality of one or more nodes and/or one or more edges in the graph.

As another example, a graph neural network may be configured to determine, and optionally output, an indication of a degree of connectivity of one or more nodes and/or edges of an input graph data set (e.g., a graph of a social network including nodes that are ranked according to a count of other nodes to which each node is connected by one or more edges, and/or a degree of significance of a relationship represented by an edge based on the nature of the relationship and/or the degrees of the nodes connected by the edge). Alternatively or additionally, the graph neural network may be configured to determine, and optionally output, an output graph data set that includes an indication of a degree of one or more nodes and/or one or more edges in the output graph data set.

As another example, a graph neural network may be configured to detect, identify, and/or analyze one or more clusters occurring within an input graph data set. For example, a graph neural network may be configured to perform a clustering analysis of an input graph data set to determine, and optionally output, a determination of k clusters within the input graph data set and an identification of the nodes and/or edges that are included in each cluster. The graph neural network may be configured to determine clusters based on a k-means clustering analysis, a Gaussian mixture model of with variable numbers of clusters and variable Gaussian orders, or the like. The graph neural network may be configured to determine, and optionally output, an indication of a clustering coefficient of one or more nodes and/or one or more edges of an input graph data set (e.g., a measurement of a degree to which at least some of the nodes and/or edges of a subgraph of the graph are clustered based on similarity and/or activity). Alternatively or additionally, the graph neural network may be configured to determine, and optionally output, an output graph data set that includes an indication of one or more clusters including one or more nodes and/or one or more edges in the output graph data set or a subgraph thereof (e.g., a result of a k¬-means clustering analysis of an output graph data set, a Gaussian mixture model of an output graph data set, and/or one or more clustering coefficients of an output graph data set).

As another example, a graph neural network may be configured to determine, and optionally output, an indication of a graphlet degree vector that indicates a graphlet that is represented one or more times in an input graph data set. For example, for a graph representing atoms in a regular structure such as a crystal, the graph neural network may be configured to determine, and optionally output, a graphlet degree vector that indicates and/or describes a graphlet representing a recurring atomic structure, and an encoding of the regular structure that indicates each of one or more occurrences of a graphlet, including a location and/or orientation, and/or a count of occurrences of the graphlet in the input graph data set. Alternatively or additionally, the graph neural network may be configured to determine, and optionally output, an output graph data set that includes a graphlet degree vector, and, optionally, features of one or more occurrences of a graphlet in the output graph data set and/or a count of the occurrences of the graphlet in the output graph data set.

As another example, a graph neural network may be configured to determine, and optionally output, an indication of one or more paths and/or traversals of one or more nodes and/or one or more edges of the input graph data set, optionally including additional details associated with a path or traversal such as a popularity, frequency, length, difficulty, cost, or the like. For example, for an input graph data set representing a spatial arrangement of nodes, the graph neural network may be configured to determine, and optionally output, a path or traversal of edges that connect a first node to a second node through zero or more other nodes of the input graph data set, as well as properties of the path or traversal such as a total length, distance, time, and/or cost. Alternatively or additionally, the graph neural network may be configured to determine, and optionally output, an output graph data set that includes additional details associated with one or more paths or traversals, including an indication (e.g., a list) of the associated nodes and/or edges of the output graph data set and a list of one or more properties of each such path and/or traversal.

As another example, a graph neural network may be configured to determine, and optionally output, an indication of metrics or properties that relate one or more nodes and/or one or more edges of an input graph data set. For example, for an input graph data set including a spatial arrangement of nodes, the graph neural network may be configured to determine, and optionally output, an indication of a shortest distance between two nodes and/or an indication of a set of nodes and/or edges that are common to two nodes of the input graph data set. As another example, for an input graph data set representing a network of communicating devices, the graph neural network may be configured to determine, and optionally output, a routing table of one or more routes that respectively indicate, for a particular node of the input graph data set and a particular edge connected to the node, a list of other nodes and/or edges of the input graph data set that can be efficiently reached by traversing based on the particular edge. As yet another example, for an input graph data set representing a social network including nodes that represent people, the graph neural network may be configured to determine, and optionally output, an indication for at least one pair of nodes of a measurement of similarity of the nodes of the input graph data set based on their node properties, edges, locations in the social network, connections to other nodes, or the like (e.g., a Katz index of node similarity) and/or, for at least one pair of edges of the input graph data set, a measurement of similarity of the edges based on their edge properties, connected nodes, locations in the social network, or the like (e.g., a Katz index of edge similarity). Alternatively or additionally, the graph neural network may be configured to determine, and optionally output, an output graph data set that includes one or more metrics or properties that relate one or more nodes and/or one or more edges (e.g., a routing table of routes within the graph, and/or a Katz index that indicates a measurement of similarity among at least two nodes and/or at least two edges).

As another example, a graph neural network may be configured to determine, and optionally output, an indication of various graph properties of an input graph data set (e.g., a graph size, graph density, graph interconnectivity, graph chronological period, graph classification, a count of subgraphs within the graph, or the like). For example, for an input graph data set including two or more subgraphs (e.g., a social network including two or more social circles), the graph neural network may be configured to determine, and optionally output, a measurement of a similarity of each subset of at least two subgraphs of the input graph data set. The measurement of the similarity may be determined based on one or more graph kernel methods (e.g., a Gaussian radial basis function that can be applied to the input graph data set to identify one or more clusters of similar nodes that comprise a subgraph). As another example, a graph neural network may be configured to determine, and optionally output, a measurement of similarity of an input graph data set with respect to another graph data set (e.g., an indication of whether a particular social network graph resembles other social network graphs that have been classified as representing a genealogy or lineage, a set of friendships, and/or a set of professional relationships). Alternatively or additionally, the graph neural network may be configured to determine, and optionally output, an output graph data set that includes measurements determined by one or more graph properties of an output graph data set (e.g., one or more measurements of similarity of one or more nodes, edges, and/or subgraphs, and/or a measurement of similarity of the output graph data set to the input graph data set and/or other graph data sets). Further explanation and/or examples of various types of processing that graph neural networks can determine, and optionally output, for various input graph data sets and/or output graph data sets are presented elsewhere in this disclosure and/or will be known to or appreciated by persons skilled in the art.

Graph neural networks may be configured to generate various forms of output that correspond to various tasks. For example, graph neural networks can generate output that represents node-level predictions that relate to one or more nodes of an input graph data set. The node-level predictions can include a discovery of a new node that was not included in the input graph data set. For example, in a graph data set including edges that represent travel of individuals in a region, the nodes can represent points of interest, and the graph neural network can discover a new node that corresponds to a new point of interest. The node-level predictions can include an exclusion of a node that is included in the input graph data set. For example, in a graph data set including edges that represent travel of individuals in a region, the nodes can represent points of interest, and the graph neural network can exclude an existing node that no longer represents a point of interest. The node-level predictions can include a classification of a node that is included in the input graph data set, or of a newly discovered node that was not included in the input graph data set (e.g., a classification of the node as being of a node type selected from a set of node types, as being associated with one or more labels of a classification label set, and/or as belonging to zero or more subgraphs of the graph data set). For example, in a graph data set representing locations within a geographic region, the graph neural network can generate a prediction of a classification of a location of interest as one or more particular types of locations of interest (e.g., a source of food, a source of fuel, a lodging location, and/or a tourist destination). The node-level predictions can include an identification of a node from among the nodes of the input graph data set based on various features, or of a newly discovered node. For example, in a graph data set representing a social network and including nodes that represent people, the graph neural network can identify a particular node that corresponds to a particular person, such as an influential person of the social network. The node-level predictions can include a determination and/or updating of one or more node properties of one or more existing and/or newly discovered nodes, such as a prediction of a demographic feature, opinion, or interest of a node representing a person in a social network.

As another example, graph neural networks can generate output that represents edge-level predictions that relate to one or more edges of an input graph data set. The edge-level predictions can include a discovery of a new edge that was not included in the input graph data set. For example, in a graph data set representing a social network that includes nodes that represent people, a graph neural network can output a prediction (e.g., a recommendation) of a relationship between two nodes that correspond to two people in a small social circle of highly interconnected people. The node-level predictions can include an exclusion of a node that is included in the input graph data set. For example, in a graph data set representing a social network that includes nodes that represent people, a graph neural network can output a prediction of a no-longer-existing edge that corresponds to a relationship that no longer exists (e.g., a lost connection based on a splitting of a social circle). The edge-level predictions can include a classification of an edge that is included in the input graph data set, or of a newly discovered edge that was not included in the input graph data set (e.g., a classification of an edge as being a of an edge type selected from a set of edge types, as being associated with one or more labels of a classification label set, and/or as belonging to zero or more subgraphs of the graph data set). For example, in a graph data set representing a social network, a graph neural network can generate a predicted classification of an edge as representing a relationship between two people as of one or more relationship types (e.g., a familial relationship, a friendship, or a professional relationship). The edge-level predictions can include an identification of an edge from among the edges of the input graph data set based on various features, or of a newly discovered edge. For example, in a graph data set representing a social network and including edges that represent relationships, the graph neural network can identify a particular edge that corresponds to a potential relationship to be recommended to the associated people, such as two people of the social network who are not yet connected but who share common personal or professional interests. The edge-level predictions can include a determination and/or updating of one or more edge properties of one or more existing and/or newly discovered edges, such as a prediction of a demographic feature, opinion, or interest that serves as the basis for a relationship between two people of the social network.

As another example, graph neural networks can generate output that represents graph-level predictions that relate to one or more graph properties of the input graph data set. The graph-level predictions can include a discovery of a new graph property that was not associated with the input graph data set. For example, in a graph data set representing a social network that includes nodes that represent people and edges that represent relationships, a graph neural network can output a prediction of a demographic trait, opinion, or interest that is common or popular among the people of the social network, or a relationship behavior that is exhibited in the relationships among the people of the social network. The graph-level predictions can include an exclusion of a graph property that was associated with the input graph data set. For example, in a graph data set representing a social network that includes a graph property based on a shared interest, a graph neural network can output a prediction that the interest no longer appears to be common and/or popular among the people of the social network, or of a relationship behavior that is no longer exhibited among the relationships of the people of the social network. The graph-level predictions can include a classification of the input graph data set (e.g., a classification of the graph data set, or at least a portion thereof, as being associated with one or more labels of a classification label set). For example, in a graph data set representing a social network, a graph neural network can generate a predicted classification of the graph as representing a familial social network, a friendship social network, and/or a professional social network. The graph-level predictions can include an identification of one or more subgraphs of the graph based on common features of the nodes and/or edges included in the subgraph. For example, in a graph data set representing a social network, the graph neural network can subgraphs that correspond to various social circles of highly interconnected people. The graph-level predictions can include a determination and/or updating of one or more graph properties of the graph, such as an updating of a frequency of communication and/or a strength of relationships among the people of a social network.

As another example, graph neural networks can perform graph-to-graph translation by receiving an input graph data set and generating output that represents a different graph data set. For example, a graph neural network can receive an input graph data set and can generate an output graph data set that includes one or more newly discovered nodes and/or edges; an exclusion of one or more nodes and/or edges; a classification of one or more nodes and/or edges; an identification of one or more nodes and/or edges; and/or an update of one or more node properties, edge properties, and/or graph properties. A graph neural network can receive an input graph data set and can generate an output graph data set that shares various similarities with the input graph data set. For example, a graph neural network can receive, as input, a first graph representing a first geographic region (e.g., a real geographic region) and can generate, as output, a first graph representing a different geographic region (e.g., a fictitious geographic region) that shares similarities with the first graph and that has some dissimilarities with respect to the first graph. A graph neural network can receive, as input, an input graph data set and can generate, as output, a subgraph of the input graph data set. A graph neural network can receive, as input, an input graph data set and can generate, as output, an expanded graph including a first subgraph corresponding to the input graph data set and a second subgraph that is newly generated. A graph neural network can receive, as input, a first graph that corresponds to a first time and can generate, as output, a second graph that corresponds to a different time than the first time. For example, the graph neural network can receive, as input, a graph data set that corresponds to a state of a geographic region at a current time, and can generate, as output, a graph data set that predicts the state of the geographic region at a past time or a future time.

As another example, graph neural networks can generate graphs from non-graph input data. For example, a graph neural network can receive, as input, locations of travelers within a geographic region over a period of time, and can generate, as output, graph data that includes one or more nodes that represent points of interest among the travelers and edges that represent paths between the points of interest (e.g., roads that connect the points of interest). As another example, a graph neural network can receive, as input, a description of a graph (e.g., a natural-language description of a geographic location) and can generate, as output, graph data that corresponds to the description of the graph (e.g., a graph of a region that includes one or more nodes representing locations and one or more edges representing roads that interconnect the locations). The graph neural network may receive both graph data and non-graph data (e.g., a graph representing a social network and an indication of a particular person in the social network) and can generate, as output, graph data based on the input (e.g., a subgraph of the people who consider the identified person to be influential).

As another example, graph neural networks can receive an input graph data set and can generate, as output, non-graph data. For example, a graph neural network can receive, as input, a graph representing a social network including nodes that represent people and edges that represent relationships, and can generate, as output, one or more metrics of the social network (e.g., an average number of connections among the people of the social network, an identification of a person of high influence within the social network, or a description of a relationship behavior that commonly occurs within the social network). As another example, a graph neural network can receive, as input, a graph representing a geographic region including nodes that represent locations and edges that represent roads connecting the locations, and can generate, as output, one or more predictions and/or measurements of traffic within the geographic region. The graph neural network may receive both graph data and non-graph data (e.g., a graph representing a social network and an indication of a particular person in the social network) and can generate, as output, non-graph data based on the input (e.g., a summary and/or prediction of the social behaviors of the identified person). For example, a graph neural network that evaluates traffic patterns within a geographic region may process, and optionally output, both an output graph data set that includes nodes that represent cities and edges that represent roads interconnecting the cities, and also non-graph output data representing predictions and/or inferences of traffic and/or weather features within the geographic region (e.g., traffic volume estimates and current or forecasted weather conditions that affect the traffic patterns).

As another example, some graph neural networks may be configured to determine, and optionally output, an indication of zero or more cycles occurring among the nodes and/or edges of an input graph data set. For example, for a directed and/or undirected input graph data set, a graph neural network may determine, and optionally output, an indication that a particular cycle exists within the input graph data set and includes a particular subset of nodes and/or edges. Alternatively, for a directed and/or undirected graph data set, a graph neural network may determine, and optionally output, an indication that the graph is acyclic and does not include any cycles. A graph neural network may be configured to determine, and optionally output, an output graph data set that includes an indication of zero or more cycles.

As another example, graph neural networks can receive an input graph data set and can generate, as output, an interpretation and/or explanation of the input graph data set. For example, a graph neural network can receive, as input, a graph representing a collection of devices, including nodes that respectively represent a device and edges that respectively represent an instance of communication and/or interaction among two or more devices. The graph neural network can generate, as output, an interpretation and/or explanation of the communications and/or interactions represented in the graph, such as an explanation of a set of interactions as being part of a collective and/or collaborative effort among the two or more devices and/or a related series of interactions that are associated with a particular activity. The explanation and/or interpretation may include, for example, a classification of one or more nodes, edges, patterns of activity, and/or the graph; a natural-language summary or narrative explanation of one or more nodes, edges, patterns of activity, and/or the graph; a data set that characterizes one or more nodes, edges, patterns of activity, and/or the graph; and/or a presentation (e.g., a static or motion visualization) of one or more nodes, edges, patterns of activity, and/or the graph. As one such example, a graph neural network may identify, within an input graph data set, one or more subgraphs (e.g., one or more clusters of related nodes and/or edges), and may output an interpretation and/or explanation of the subgraph (e.g., a description of the set of features that characterize the subgraph or cluster). As another example, a graph neural network may generate a visualization of a subgraph of an input graph data set, wherein the visualization depicts, highlights, and/or illustrates a structure and/or an anomalous feature of the subgraph. Some such graph neural networks may be configured to generate interpretations and/or explanations of any input graph data set, e.g., based on an identification of features of an input data set that inform such interpretations and/or explanations, such as clusters, outliers, or determinations of apparent structure and/or data relationships. Other such graph neural networks may be configured to generate domain-specific interpretations and/or explanations of domain-specific graph data sets. For example, a graph neural network may be configured to analyze a graph data set representing a social network identify both a subset of the social network corresponding to an influential cluster of people of the social network and also an interpretation and/or explanation of why this cluster of people appears to be influential within the social network. Graph neural networks can generate interpretations and/or explanations using a variety of techniques, including “white-box” analysis techniques that can be applied to various properties of graph data sets and components thereof. Examples of graph neural networks that include instance-level explanations based on gradients and/or features include, without limitation, Guided BP, class activation mapping (CAM), and GradCAM. Examples of graph neural networks that include instance-level explanations based on perturbations include, without limitation, GNNExplainer, PGExplainer, ZORRO, and Graphmask. Examples of graph neural networks that include instance-level explanations based on decomposition include, without limitation, layer-wise relevance propagation (LRP), Excitation BP, and GNN LRP. Examples of graph neural networks that include instance-level explanations based on surrogate analysis include, without limitation, GraphLIME, RelEX, and PGMExplainer. Examples of graph neural networks that include model-level explanations include XGNN. Further explanation and/or examples of various interpretable and/or explainable features of graph data sets or components thereof that may be generated by graph neural networks are presented elsewhere in this disclosure and/or will be known to or appreciated by persons skilled in the art.

### Graph Neural Networks—Architectures and Frameworks

Graph neural networks may be designed and/or organized according to various architectures. For example, a multilayer graph neural network may include a number of layers, each layer including a number of neurons. In each layer of the graph neural network, the neurons may be configured to receive, as input, at least a portion of an input data set (e.g., an input graph data set) and/or at least a portion of an output of at least one neuron of one or more layers of the graph neural network. Additionally, in each layer of the graph neural network, the neurons may be configured to generate, as output, at least a portion of an output data set of the graph neural network (e.g., an output graph data set of graph neural network) and/or at least a portion of an input to at least one neuron of one or more layers of the graph neural network.

In some graph neural networks, an architecture of the graph neural network is based on the input to the graph neural network. For example, a fixed-size graph of N nodes and E edges interconnecting the nodes may be received and processed by a graph neural network that includes an input layer featuring N neurons respectively configured to receive input from one of the N nodes and/or E neurons respectively configured to receive input from one of the E edges. A graph including an adjacency list having a maximum of E edges may be received and processed by a graph neural network that includes an input layer featuring E neurons respectively configured to receive and process one of the E edges represented in the adjacency list. A graph including two subgraphs may be received and processed by a graph neural network that includes an input layer featuring a first set of neurons that are configured to process the nodes and/or edges of the first subgraph and a second set of neurons that are configured to process the nodes and/or edges of the second subgraph. In some graph neural networks, an architecture of the graph neural network may be based on non-graph input data that is received and processed by the graph neural network. For example, a graph neural network may be configured to receive, as input, a description of a graph (e.g., a number of nodes and/or edges and one or more properties of the graph). The graph neural network may be further configured to generate a graph corresponding to the description, and to process and optionally output the graph according to various graph neural network processing techniques.

In some graph neural networks, an architecture of the graph neural network is based on an output of the graph neural network. For example, a graph neural network may be configured to determine, and optionally output, a fixed-size output graph data set including N nodes and E edges. The graph neural network may therefore include an output layer featuring N neurons respectively configured to generate output corresponding to one of the N nodes and/or E neurons respectively configured to generate output corresponding to one of the E edges. A graph neural network may be configured to determine, and optionally output, an adjacency list having a maximum of E edges. The graph neural network may therefore include an output layer featuring E neurons that respectively generate output corresponding to one of the E edges represented in the adjacency list. A graph neural network may be configured to determine, and optionally output, an output graph data set including two subgraphs. The graph neural network may therefore include an output layer featuring a first set of neurons that are configured to generate output corresponding to the nodes and/or edges of the first subgraph and a second set of neurons that are configured to process the nodes and/or edges of the second subgraph. In some graph neural networks, an architecture of the graph neural network may be based on non-graph output data that is determined, and optionally output, by the graph neural network. For example, a graph neural network may be configured to determine, and optionally output, a description of an input graph data set and/or an output graph data set (e.g., a number of nodes and/or edges and one or more properties of the input graph data set and/or the output graph data set), according to various graph neural network processing techniques.

In some graph neural networks, an architecture of the graph neural network may be based on a directionality of one or more edges included in an input data set and/or an output data set. For example, an input graph data set including a undirected edge that connects a first node N1 and a second node N2 may be received and processed by a graph neural network including a first neuron NN1 and a second neuron NN2 that are bidirectionally connected to one another, such that message passing can occur from the first node NN1 to the second node NN2 and, concurrently or consecutively, from the second node NN2 to the first node NN1. An input graph data set including a unidirectional edge that connects a first node N1 to a second node N2 may be received and processed by a graph neural network including a first neuron NN1 (e.g., a neuron in a first layer of a feed-forward graph neural network) that is unidirectionally connected to a second neuron NN2 (e.g., a neuron in a second layer of a feed-forward graph neural network), such that message passing can occur from the first node NN1 to the second node NN 2 but not from the second node NN2 to the first node NN1. An input graph data set including an edge that connects three or more nodes may be received and processed by a graph neural network in which three or more nodes are correspondingly connected.

Some graph neural networks may be configured to receive and process an input graph data set including a homogeneous set of nodes and/or a homogeneous set of edges. For example, a first neuron of the graph neural network that corresponds to a first node and/or edge of the input graph data set may include a same or similar number of inputs, a same or similar activation function, and/or a same or similar number of outputs as a second neuron of the graph neural network that corresponds to a second node and/or edge of the input graph data set.

Some graph neural networks may be configured to receive and process an input graph data set including a heterogeneous set of nodes and/or a heterogeneous set of edges. For example, different nodes of an input graph data set may be associated with different labels that respectively indicate different classifications of the nodes, and/or different edges of the input graph data set may be associated with different labels that respectively indicate different classifications of the edges. An architecture of the graph neural network may exhibit variations corresponding to the heterogeneity of the nodes and/or edges. For example, a first neuron of the graph neural network that corresponds to a first node and/or edge of the input graph data set that is associated with a first label or classification may include a different number of inputs, a different activation function, and/or a different number of outputs as a second neuron of the graph neural network that corresponds to a second node and/or edge of the input graph data set that is associated with a second label or classification. As another example, a graph neural network may include a first layer that receives and processes, as input, a first portion of an input data set that includes a first subset of neurons and/or edges that are associated with a first label or classification, and a second layer that receives and processes, as input, a second portion of an input data set that includes a second subset of neurons and/or edges that are associated with a second label or classification. The first layer and the second layer may be processed concurrently or consecutively. The first layer and the second layer may be processed independently (e.g., each layer providing a different portion of an output graph data set). Alternatively, the first layer and the second layer may be processed together (e.g., an output of the first layer may be additionally provided as input to the second layer, and/or an output of the second layer may be additionally provided as input to the first layer).

Some graph neural networks may include an architecture that is based on one or more node properties of one or more nodes of an input graph data set, one or more edge properties of one or more edges of the input graph data set, and/or one or more graph properties of the input graph data set. As an example, in some input graph data sets, one or more nodes may include a node property indicating a weight of the node (e.g., an indication of a centrality and/or betweenness of a node among at least a portion of the nodes of the input graph data set). The graph neural network may include a neuron that corresponds to the node, wherein one or more weights of synapses that connect the neuron to other neurons of the graph neural network is based on the weight of the node. As another example, in some input graph data sets, one or more edges may include an edge property indicating a weight of the edge (e.g., an indication of a significance and/or priority of a relationship among two or more nodes of the input graph data set). The graph neural network may include two or more nodes that are connected by a synapse, wherein a weight of the synapse connecting the two or more nodes is based on a weight of an edge of the input graph data set. Examples of node-based graph neural networks include, without limitation, GraphSAGE, PinSAGE, and VR-GCN. Examples of layer-based graph neural networks include, without limitation, FastGCN and LADIES. Examples of subgraph-based graph neural networks include, without limitation, ClusterGCN and GraphSAINT.

Some graph neural networks may be configured to receive and process fixed input graph data sets, wherein a number and arrangement of nodes and edges of an input data set that is received and processed by the graph neural network does not vary for different instances of processing the input data set. The architecture of such graph neural networks may be configured based on the invariance of the input graph data set. For example, the graph neural network may feature a fixed number and/or arrangement of neurons and/or layers, wherein the fixed architecture of the graph neural network corresponds to the fixed nature of the input graph data set.

Some graph neural networks may be configured to receive and process dynamic input graph data sets, wherein a number and arrangement of nodes and edges of an input data set that is received and processed by the graph neural network during a first instance of processing can differ from a number and arrangement of nodes and edges of an input data set that is received and processed by the graph neural network during a second instance of processing. As an example, a graph neural network may be configured to perform node and/or edge discovery of an input graph data set and to generate, as output, an output graph data set that includes at least one more node and/or at least one more edge than the input graph data set. Further, the graph neural network may be configured to receive the output graph data set from a first processing as input for a second processing, wherein a number of nodes and/or edges received as input during the second processing is greater than a corresponding number of nodes and/or edges received as input during the first processing. In such cases, an architecture of such graph neural networks may be fixed, but may be configured to receive and process a variety of different input graph data sets (e.g., input graph data sets with a variable number of nodes and/or connections). For example, the graph neural network may include an input layer featuring N input neurons, each corresponding to a node of an input graph data set. Such a graph neural network may be configured to use the fixed architecture to receive and process input graph data sets featuring a variable number of nodes up to, but not exceeding, N. For example, in order to receive and process an input graph data set featuring fewer than N nodes, the graph neural network may activate only a number of input neurons of the input layer that correspond to the number of nodes in the input graph data set, and to deactivate remaining neurons of the input layer that do not correspond to a node of the input graph data set (e.g., refraining from processing the remaining neurons, and/or processing the neurons but zeroing the weights of the synapses that connect the neurons to other neurons of the graph neural network). As another example, the graph neural network may perform a first processing of a first input graph data set including N nodes, and, accordingly, may deactivate one or more neurons of the input layer. The graph neural network may then perform a second processing of a second input graph data set including more than N nodes (e.g., an output of the first processing may include an output graph data set that includes one or more newly discovered nodes). During the second processing, the graph neural network may activate one or more of the previously deactivated neurons of the input layer in order to receive and process input from the additional nodes of the second input graph data set. For example, the graph neural network may enable or reenable the processing of one or more neurons of the input layer, and/or may reset (e.g., restore and/or initialize) the weights of one or more synapses that connect one or more neurons of the input layer to other neurons of the graph neural network. In some cases, an architecture of such graph neural networks may be dynamic, and may change in correspondence with a dynamic nature of the input graph data set. For example, a graph neural network may include an input layer with a variable number of neurons, and may select, adapt, and/or change the number of neurons in the input layer based on a dynamic property of an input graph data set (e.g., a number of nodes and/or edges in the input graph data set). Such graph neural networks may generate new neurons of the input layer (e.g., initializing and/or selecting weights of the synapses of the new neurons, such as copying the weights from the synapses of other neurons of the input layer) based on a larger number of nodes and/or edges of an input graph data set to be received and processed as input. Alternatively or additionally, such graph neural networks may be configured to eliminate and/or merge neurons of the input layer (e.g., initializing and/or selecting weights of the new neurons) based on a smaller number of nodes and/or edges of an input graph data set to be received and processed as input.

In some graph neural networks, an architecture of the neural network may be selected and/or adapted based on a topology of one or more input graph data sets and/or output graph data sets. For example, a bipartite input graph data set may include two more subgraphs, and a graph neural network may include two or more distinct subsets of neurons that are respectively configured to receive and process data associated with the nodes and/or edges included in one of the subgraphs. As another example, a multigraph input graph data set may include a plurality of edges connecting two or more nodes. For example, a graph representing a social network may include various types of edges that represent various types of relationships (e.g., familial relationships, friendships, and/or professional relationships), and two or more nodes may be connected by a plurality of edges (e.g., a first edge indicating a friendship among the two or more nodes and a second edge indicating a professional relationship among the two or more nodes). An architecture of the graph neural network may correspond to the multigraph nature of the input graph data set. For example, a graph neural network may include two or more distinct subsets of neurons that are respectively configured to receive and process data associated with a subset of edges of the input graph data set that are of a particular edge type (e.g., a first subset of neurons that is configured to receive and process nodes connected by edges that represent friendships, and a second subset of neurons that is configured to receive and process nodes connected by edges representing professional relationships). As yet another example, an input hypergraph data set may include one or more hyperedges that interconnect three or more nodes. An architecture of a graph neural network that is configured to receive and process the input hypergraph data set may include one or more neurons with synapses that interconnect to two or more other neurons in correspondence with one or more hyperedges of the input hypergraph data set.

As another example, an architecture of some graph neural networks include one or more layers that perform particular functions on the output of neurons of another layer, such as a pooling layer that performs a pooling operation (e.g., a minimum, a maximum, or an average) of the outputs of one or more neurons, and that generates output that is received by one or more other neurons (e.g., one or more neurons in a following layer of the graph neural network) and/or as an output of the graph neural network. Examples of graph neural networks that include one or more direct pooling layers include, without limitation, SimplePooling, Set2Set, and SortPooling. Examples of graph neural networks that include one or more hierarchical pooling layers include, without limitation, Coarsening, ECC, DiffPool, TopK, gPool, Eigenpooling, and SAGPool.

As another example, some graph neural networks (e.g., graph convolution networks) include one or more convolutional layers, each of which performs a convolution operation to an output of neurons of a preceding layer of the graph neural network.

As another example, an architecture of some graph neural networks include memory based on an internal state, wherein the processing of a first input data set causes the graph neural network to generate and/or alter an internal state, and the internal state resulting from the processing of one or more earlier input data sets affects the processing of second and later input data sets. That is, the internal state retains a memory of some aspects of earlier processing that contribute to later processing of the graph neural network. Examples of graph neural networks that include memory features and/or stateful features include graph neural networks featuring one or more gated recurrence units (GRUs) and/or one or more long-short-term-memory (LSTM) cells. In some graph neural networks, these features may be further adapted to accommodate graph processing, such as gated graph neural networks (GGRUs), tree LSTM networks, graph LSTM networks, and/or sentence LSTM networks.

As another example, an architecture of some graph neural networks includes one or more recurrent and/or reentrant properties. For example, at least a portion of output of the graph neural network during a first processing is included as input to the graph neural network during a second or later processing, and/or at least a portion of an output from a layer is provided as input to the same layer or a preceding layer of the graph neural network. As another example, in some graph neural networks, an output of a neuron is also received as input by the same neuron during a same processing of an input and/or a subsequent processing of an input. The output of the neuron may be evaluated (e.g., weighted, such as decayed) before being provided to the neuron as input.

As another example, an architecture of some graph neural networks includes two or more subnetworks (e.g., two or more graph neural networks that are configured to process graph data concurrently and/or consecutively). Some graph neural networks include, or are included in, an ensemble of two or more neural networks of the same, similar, or different types (e.g., a graph neural network that outputs data that is processed by a non-graph neural network, Gaussian classifier, random forest, or the like). For example, a random graph forest may include a multitude of graph neural networks, each configured to receive at least a portion of an input graph data set and to generate an output based on a different feature set, different architectures, and/or different forms of processing. The outputs of respective graphs of the random graph forest may be combined in various ways (e.g., a selection of an output based on a minimization and/or maximization of an objective function, or a sum and/or averaging of the outputs) to generate an output of the random graph forest.

In some cases, an architecture of a graph neural network may be designed by a user. For example, a user may choose one or more hyperparameters of a graph neural network (e.g., a number of layers, a number of neurons in each layer, an activation function used by at least some neurons, and the like) in order to process an input graph data set. In some cases, the selected one or more hyperparameters may be based on domain-specific knowledge, e.g., a specific data type, internal organization or structure, and/or task associated with an input graph data set.

Alternatively or additionally, in some cases, an architecture of a graph neural network may be selected by an automated process. For example, a hyperparameter search process may determine one or more hyperparameters of a graph neural network based on an analysis of an input graph data set to be received and processed by the graph neural network and/or an analysis of an output graph data set to be generated and provided as output by the graph neural network. The hyperparameter search process may determine various combinations of hyperparameters for variations of the graph neural network (e.g., graph neural networks with different numbers of layers, different numbers of neurons within each layer, graph neural networks including neurons with different activation functions, and/or graph neural networks with different sets of synapses interconnecting the neurons of various layers). The hyperparameter search process may process an input graph data set (e.g., a training input graph data set) using different graph neural networks that correspond to different sets of hyperparameters. The hyperparameter search process may compare the output of the different graph neural networks (e.g., determining a performance measurement for the output of each graph neural network, and comparing the performance measurements of the different graph neural networks) in order to determine and select a graph neural network that generates desirable output (e.g., output that most closely corresponds to a target output associated with the training input graph data set). The hyperparameter search process may discard the other graph neural networks and may use the selected graph neural network to process input graph data sets. In some cases, the hyperparameter search process may iteratively generate and test refined combinations of hyperparameters. For example, after selecting a graph neural network in a first hyperparameter search processing the hyperparameter search process may perform a second hyperparameter search processing by generating additional graph neural networks based on combinations of hyperparameters that are closer to the hyperparameters of the selected graph neural network, and evaluating the output of the additional graph neural networks. In some cases, the hyperparameter search process may perform a grid search over the set of valid hyperparameter combinations. Iterative refinement of the hyperparameters may enable the hyperparameter search process to determine an architecture of a graph neural network that is well-tuned to a particular task (e.g., an architecture of a graph neural network that demonstrates consistently high performance on input graph data sets within a particular domain of data and/or a particular task). In some cases, a hyperparameter search process may communicate with a user to determine combinations of hyperparameters to evaluate and/or to select for the graph neural network. For example, the hyperparameter search process may present, to a user, a result of a first hyperparameter evaluation (e.g., an output of a graph neural network that was selected through a first hyperparameter search processing). Based on an evaluation of the output by the user, the hyperparameter search process may perform a second or further hyperparameter search processing (e.g., choosing a small refinement of the hyperparameters based on a positive response of the user to the output of a selected graph neural network, and/or choosing a larger refinement of the hyperparameters based on a negative response of the user to the output of the selected graph neural network).

As another example, some graph neural networks include architectures based on graph convolutional networks (GCNs), wherein a convolutional layer applies a convolution operation to outputs of one or more filters of a previous filter layer of the graph convolutional network. Graph convolutional networks may include spectral convolutional networks that are configured to receive, as input, a spectral representation of an input graph data set, and to apply processing (including one or more convolutional operations) to various spectral components of the spectral representation of the input graph data set. Examples of spectral convolutional networks include, without limitation ChebNet and diversified graph convolutional networks (DGCNs). As another example, some graph convolutional networks include architectures based on spatial convolutional networks (SCNs) that are configured to receive, as input, spatial representations of an input graph data set (e.g., spatial information that represents one or more neighborhoods of nodes and/or edges of the input graph data set), and to apply processing (including one or more convolutional operations) to various spatial components of the spatial representation of the input graph data set. Examples of spatial convolutional networks include, without limitation, spatial convolutional neural networks (SCNNs), spatial and/or spatial-temporal GraphSAGE networks, and some deep convolutional neural networks (DCNNs).

Graph neural networks can be generated by a variety of machine learning platforms, frameworks, and/or tools, including, without limitation, PyTorch Geometroc, Deep Graph Library, TensorFlow GNN, Graph Nets, Spektral, and Jraph. Frameworks for graph convolutional networks include, without limitation, message passing neural networks (MPNNs), non-local neural networks (NLNNs), mixture model neural networks (MoNet), and Graph Networks (GN).

Further explanation and/or examples of various architectures of graph neural networks, including the design and implementation of designs and architectures of such graph neural networks, are presented elsewhere in this disclosure and/or will be known to or appreciated by persons skilled in the art.

### Graph Neural Networks—Training and Performance Evaluation

Like other types of neural networks, graph neural networks are typically generated with arbitrarily selected parameters (e.g., synaptic weights that are initially set to randomized values). Also, like other types of neural networks, an initialized graph neural network to evaluate input graph data sets through training, in which the parameters of the graph neural network are adjusted to promote desirable processing that produces expected and/or desirable outputs.

The training of graph neural networks may involve one or more training data sets. For graph neural networks that receive and process input graph data sets, the training data may include one or more training input graph data sets. Alternatively or additionally, for graph neural networks that receive and process input non-graph data, the training data may include one or more sets of training non-graph data.

The training data for a graph neural network may be based on authentic input data that was previously collected and/or analyzed, or that was collected and analyzed for the purpose of training the graph neural network. For example, in order to process graphs that represent an industrial environment, the training data may include sensor data that was previously and/or is currently received from one or more sensors associated with the industrial environment. Alternatively or additionally, the training data may include partially and/or fully synthetic data. For example, a first portion of training data may include data derived from an analysis of authentic data; authentic data that has been supplemented with synthetic data (e.g., an image of a real-world scene including an inserted artificial object); authentic data that has been modified by a suer (e.g., an image of a real-world scene that has been modified by a user); and/or data generated by one or more algorithms (e.g., other machine learning models and/or simulations of real-world processes). In some cases, the training data set may include both authentic training data and synthetic training data that is based on the authentic training data (e.g., both a real-world image and a modified version of the real-world image that has been adjusted in brightness, contrast, size, resolution, scale, shape, aspect ratio, color depth, or the like).

The training data for a graph neural network may be limited to a selected data domain. For example, training data for a graph neural network that analyzes social networks may include one or more samples of individuals from within one or more selected social networks. In other cases, the training data for a graph neural network may be generated from a variety of data domains. For example, training data for a graph neural network that analyzes geographic data may include one or more samples of locations of interest and interconnecting pathways from natural outdoor geographic regions (e.g., forests), artificial outdoor geographic regions (e.g., road networks), indoor geographic regions (e.g., caves or shopping malls), historic geographic regions (e.g., maps from ancestral eras and/or civilizations), and/or synthetic geographic regions (e.g., geographic maps from videogames).

The training data for a graph neural network may be wholly or partially unlabeled. For example, the training data set for an industrial environment may include sensor measurements collected from the industrial environment, but may not include any data indicating an analysis, classification, metadata, interpolations, extrapolations, interpretation, explanation, and/or user reaction associated with the sensor measurements. Alternatively or additionally, the training data for a graph neural network may be wholly or partially labeled. For example, the training data set for an industrial environment may include sensor measurements collected from the industrial environment, and one or more subsets of sensor measurements may be associated with one or more analyses, classification labels, metadata, interpolations, extrapolations, determinations, interpretations, explanations, and/or user reactions associated with the subset of sensor measurements. Training data may associate labels, metadata, or the like with one or more nodes and/or node properties of a training input graph data set; one or more edges and/or edge properties of a training input graph data set; one or more graph properties of the training input graph data set; and/or one or more portions of non-graph data of a training input data set. In some cases, the labels, data, metadata, or the like associated with at least a portion of a training input data set are selected by one or more users (e.g., a human classification of at least a portion of the training data set). In some cases, the labels, data, metadata, or the like associated with at least a portion of a training input data set are selected by another algorithm (e.g., a simulation or another machine learning model). In some cases, the labels, data, metadata, or the like associated with at least a portion of a training input data set are selected by a cooperation of a human and an algorithm (e.g., a determination by a simulation or another machine learning model that is verified by a reviewing human user).

Graph neural networks can be trained based on one or more training data sets and one or more learning techniques. As an example, some graph neural networks are trained through an unsupervised learning technique. For example, a training input data set may not include any labels, data, metadata, or the like associated with various portions of the training input data set. The graph neural network may be trained to identify patterns arising within the training input data sets. For example, a training input data set may include data that indicates one or more anomalies (e.g., nodes and/or edges that appear to represent outliers in a data distribution of the nodes and/or edges of the graph) and/or distinctive patterns or structures arising in the data (e.g., cycles arising in a directed and/or undirected graph). The graph neural network may be trained to detect such anomalies, patterns, and/or structure in the training input data sets. The results of unsupervised learning of a graph neural network may be evaluated based on an evaluation of the output of the graph neural network (e.g., a confusion matrix that includes determinations of true positive determinations, true negative determinations, false positive determinations, and/or false negative determinations) and/or performance scores (e.g., an F1 performance score based on ratios of true positives, false positives, true negatives, and false negatives). The weights of various parameters of the graph neural network can be automatically adjusted, corrected, refined, or the like, such that subsequent processing of the same input training data set and/or other input training data sets generates improved evaluations and/or performance scores.

As another example, some graph neural networks are trained through a supervised learning technique. For example, a training input data set may associate respective portions (e.g., respective training data samples, such as different training input graph data sets) with one or more labeled outputs that are expected and/or desirable of the trained graph neural network. As an example, a graph neural network may be trained to output a classification of a training input graph data set and/or one or more nodes and/or edges thereof. During a supervised learning process, the training input graph data set may be provided as input to the graph neural network and processed by the graph neural network to generate a predicted classification of a training input graph data set and/or one or more nodes and/or edges thereof. The predicted classifications may be compared with one or more labeled outputs associated with the training input graph data set (e.g., one or more labels associated with an expected and/or desirable classification of the training input graph data set and/or one or more nodes and/or edges thereof). Based on the comparison, the weights of various parameters of the graph neural network can be automatically adjusted, corrected, refined, or the like, such that subsequent processing of the same input training data set and/or other input training data sets generates improved evaluations and/or performance scores (e.g., more accurate predictions of one or more labels associated with an expected and/or desirable classification of the training input graph data set and/or one or more nodes and/or edges thereof). As another example, a graph neural network may be trained to generate, as output, an output graph data set that is based on a processing of a training input graph data set. During a supervised learning process, the training input graph data set may be provided as input to the graph neural network and processed by the graph neural network to generate an output graph data set. The output graph data set generated by the graph neural network may be compared with one or more expected and/or desirable output graph data sets corresponding to the training input graph data set (e.g., one or more output graph data sets that are expected and/or desired as output when the graph neural network processes the training input graph data set). Based on the comparison, the weights of various parameters of the graph neural network can be automatically adjusted, corrected, refined, or the like, such that subsequent processing of the same input training data set and/or other input training data sets generates improved evaluations and/or performance scores (e.g., more desirable and/or expected output graph data sets).

As another example, some graph neural networks are trained through a blended training process that includes both supervised and unsupervised learning. For example, a blended training process may evaluate the performance of a graph neural network in training based on both a comparison of predicted outputs of the graph neural network to expected and/or desirable outputs corresponding to an input training data set, and based on one or more automatically determined performance metrics, such as a confusion matrix and/or F1 scores. Some blended training processes may include a round of supervised learning following by a round of unsupervised learning, or may perform rounds of training that include both supervised and unsupervised learning techniques (e.g., optionally with different weights and/or performance thresholds associated with the evaluation of the graph neural network and the updating of the parameters).

As another example, some graph neural networks are trained through a semi-supervised learning process. For example, a training data set may include a large number of samples, of which only a small number of samples are labeled (e.g., associated with expected and/or desirable outputs) and a large remainder of the samples are unlabeled (e.g., not associated with expected and/or desirable outputs). The graph neural network may be trained based on the labeled and/or unlabeled training data, and a performance of the graph neural network may be evaluated based on the labels and/or other metrics. In particular, some unlabeled portions of the input training data may be identified as being incorrectly evaluated by the graph neural network (e.g., the graph neural network may generate incorrect outputs such as predictions or classifications, incorrect and/or malformed output graph data sets, or the like). At least a portion of such unlabeled portions of the input training data (e.g., training data samples that appear to be difficult to classify correctly and/or with high confidence) may be submitted to a human reviewer, and the semi-supervised learning process may receive, from the human reviewer, one or more labels that correspond to an expected and/or desirable output of the graph neural network for such portions of the input training data. Training or retraining of the graph neural network may involve the newly labeled portions of the input training data, as well as other portions of the input training data. Semi-supervised learning may enable graph neural networks to be trained based on a smaller degree of human involvement (e.g., a smaller number of labels associated with portions of the input training data set by human reviewers), and may therefore improve a speed, cost, and/or performance of training the graph neural network.

A training of a graph neural network may occur in one or more epochs. For example, for each epoch, the graph neural network may be provided with input comprising each portion of a training data set, a performance of the graph neural network may be determined based on the output of the graph neural network for each portion of the training data set. Based on the determined performance, and one or more parameters of the graph neural network may be updated. For example, weights of the synapses between neurons of the graph neural network may be adjusted such that a performance of the graph neural network over each portion of the training data set. During the training of a graph neural network, various techniques may be used to evaluate the performance of the graph neural network. As a first example, outputs of the graph neural network (e.g., output graph data sets and/or predictions, such as classifications of the graph, one or more nodes, and/or one or more edges) may be compared with expected and/or desirable outputs. Differences between the outputs and the expected and/or desirable outputs may be used to determine an entropy and/or loss of the output of the graph neural network as compared with corresponding expected and/or desirable outputs. In some variations, the entropy or loss of the graph neural network determined during or after a current epoch may be compared with an entropy or loss of the graph neural network determined during or after a previous epoch to determine a differential and/or marginal entropy or loss. A negative differential and/or marginal entropy or loss may indicate that the training of the graph neural network is productive (e.g., the performance of the graph neural network improved in the current epoch as compared with a previous epoch). A zero or positive differential and/or marginal entropy or loss may indicate that the training of the graph neural network is unproductive (e.g., the performance of the graph neural network did not improve, or diminished, in the current epoch as compared with a previous epoch). Training of the graph neural network may therefore continue as long as the differential and/or marginal entropy or loss remains negative and, optionally, exceeds a threshold magnitude that indicates significant training progress.

As another example, outputs of the graph neural network (e.g., output graph data sets and/or predictions, such as classifications of the graph, one or more nodes, and/or one or more edges) may be classified as one of a true positive, a false positive, a true negative, or a false negative. The performance of the graph neural network may be evaluated as a confusion matrix, e.g., based on a calculation of the performance over the incidence of true positive, false positive, true negative and false negative outputs. In some cases, the calculation may be weighted based on a risk matrix that applies different weights to each classification of the output. For example, in a graph neural network that generates classifications of graphs that correspond to diagnoses of medical conditions, it may be determined false negatives (e.g., missed diagnoses) are very harmful or costly, while false positives (e.g., misdiagnoses that can be corrected by further evaluation) may be determined to be comparatively harmless. Accordingly, the performance of the graph neural network may be determined based on a weighted calculation over the confusion matrix that more severely penalizes the performance based on false negatives than false positives.

As another example, the training of a graph neural network may involve an improvement of an objective function that serves as a basis for measuring the performance of the graph neural network. For example, the objective function may include (without limitation) a loss minimization, an entropy minimization, a precision maximization, a recall maximization, an error minimization, or a consistency maximization. The objective function may include a comparison of the performance of the graph neural network over various distributions of the input data set (e.g., a minimax optimization, such as minimizing a maximum loss over any portion of the input data set, or a maximin optimization, such as maximizing a minimum loss over any portion of the input data set). In some training scenarios that involve reinforcement learning, the output of a graph neural network may include and/or may be interpreted as a policy, e.g., a set of responses of an agent based on respective conditions. The performance of the graph neural network may be based on various objective functions that evaluate various properties of the generated and/or interpreted policy. For example, in a q-learning reinforcement learning process, the objective function applied to the policy may include a maximization of an action value of each behavior that may be performed in response to various conditions.

As another example, the training of graph neural networks may occur concurrently with the hyperparameter search and/or selection. For example, a hyperparameter search process may initially identify a first set of combinations of hyperparameters of graph neural networks to be evaluated using a training data set. Based on each such combination of hyperparameters, a graph neural network may be generated and at least partially trained to determine its performance. Based on the evaluation of the outputs of the graph neural networks corresponding to respective combinations of hyperparameters, the hyperparameter search process may identify a candidate graph neural network with the highest performance. The hyperparameter search process may then generate a second set of combinations of hyperparameters based on the hyperparameters of the candidate graph neural network, and may further (at least partially) train and evaluate the performance of additional graph neural networks based on the second set of combinations of hyperparameters. A comparison of the performance of the additional graph neural networks may cause the hyperparameter search process to retain the candidate graph neural network or to choose a new candidate graph neural network from among the additional graph neural networks. The hyperparameter search process may continue until additional improvements in the performance of candidate graph neural networks are not achievable and/or are below a threshold performance improvement. In this selection process, a variety of performance metrics may be used. As previously discussed, the performance metrics may include an evaluation of the outputs of the graph neural networks (e.g., a loss or entropy, a differential or marginal loss or entropy, a confusion matrix, an F1 score, or the like). Alternatively or additionally, the performance metrics may include other features of the output, such as a consistency of the output of the graph neural network over the distribution of data in the training data set and/or a bias in the performance the output of the graph neural network for selected data distributions of the training data set, and/or a smoothness or oversmoothness of the graph nodes represented in the graph neural network. Alternatively or additionally, the performance metrics may include one or more measurements of computational resource expenditures to perform training and/or inference of input data sets with the graph neural network (e.g., CPU and/or GPU utilization, memory usage, training time and/or complexity, processing latency between receiving input and generating output, or the like). Aggregate performance measurements may be based on a variety of such considerations, and may enable a human designer and/or a hyperparameter search process to perform a selection of a graph neural network based on various performance tradeoffs (e.g., a preference for a first graph neural network that produces high-accuracy, high-consistency, and/or high-confidence results but that requires a large amount of computational resources, time, and/or cost, vs. a preference for a second graph neural network that produces reasonable-accuracy, reasonable-consistency, and/or reasonable-confidence results using a smaller amount of computational resources, time, and/or cost). For example, a measurement of computational resource utilization by a particular graph neural network may correspond to a numeric penalty in various measurement of the performance of the graph neural network (e.g., a loss, entropy, and/or objective function output).

In various forms of graph neural network training based on these and other learning techniques, various training methods can be used to update the parameters of a graph neural network in training and/or to evaluate the performance of a graph neural network in training. For example, optimizers that may be used during the training of graph neural networks may include (without limitation) linear regression; root mean squared propagation (RMSprop); stochastic gradient descent; adaptive stochastic gradient descent (Adagrad); adaptive stochastic gradient descent with adaptive learning (Adadelta); adaptive moment estimation (Adam); Nesterov accelerated adaptive moment estimation (Nadam); Nesterov accelerated gradient and momentum (NAG); Monte Carlo simulations involving various variance reduction techniques, such as control variates; or the like, including variations and/or combinations thereof. Training techniques for particular types of graph neural networks may include optimizers that are specialized for such particular types of graph neural networks (e.g., graph convolutional networks may be trained using a FastGCN optimizer and/or receptive field control (RFC) optimizers).

As further examples, graph neural network training may include a variety of techniques that are also applicable to non-graph machine learning models, including non-graph neural networks. As a first such example, training may occur in batches and/or mini-batches of the training data set, wherein the graph neural network evaluates a batch (e.g., plurality of input data sets) of an input training data set, and the parameters of the graph neural network are updated based on an aggregation of the evaluation of the outputs of the graph neural network for the batch of input data sets. In various training techniques, batches may be selected at random from the training input data set or may be selected in an organized manner, e.g., as various subsets that are representative of one or more data distributions of the training input data set. For example, if the graph neural network in training exhibits good performance over some data distributions of the training input data and poor performance over other data distributions of the training input data, the continued training of the graph neural network may focus on, prioritize, and/or overweight the training based on batches of training input data that reflect the data distributions associated with poor performance. In various training techniques, a batch size of batches of training input data sets may be fixed, or the batch size may vary based on a progress of the training of the graph neural network.

As another example, in various training techniques for graph neural networks, an entire set of training input data may be partitioned into a training data set that is used only to train the graph neural network and update its parameters; a validation data set that is used only to evaluate a prospective and/or in-training graph neural network; and/or a test data set that is used to only evaluate a final performance of the fully trained graph neural network. The partitioning of the training input data may be based on one or more ratios (e.g., a 90/5/5 partitioning of the training input data into a training data set, a validation data set, and a test data set, or a 98/1/1 partitioning of the training input data into a training data set, a validation data set, and a test data set). For example, during an epoch, the performance of the graph neural network may be evaluated based on various portions of the training data set, and the parameters of the graph neural network may be adjusted based on the determined performance. However, continued training and updating of the graph neural network based on the training data set may result in overfitting, e.g., “memoization” of correct outputs that correspond to various portions of the training data set. Due to such overfitting, the performance of the graph neural network in evaluating previously evaluated input data sets may improve, but performance of the graph neural network on previously unevaluated input data sets may decline. Instead, at the conclusion of an epoch, the performance of the graph neural network may instead be evaluated based on various portions of the validation data set, which is not otherwise used to update the parameters of the graph neural network. Evaluation of the performance of the graph neural network on previously unseen data can indicate that the performance of the graph neural network is genuinely improving (e.g., based on learned principles of data evaluation that apply consistently to both previously seen and previously unseen input data sets), resulting in a continuation of training. Alternatively, evaluation of the performance of the graph neural network on previously unseen data can indicate that the performance of the graph neural network is resulting in overfitting to the training data set (e.g., based on “memoization” of correct outputs for previously seen input data sets that do not inform the correct evaluation of previously unseen input data sets), resulting in a conclusion of training. Such conclusion may be referred to as “early stopping” of training to reduce overfitting of the graph neural network to the training data set and to preserve the performance of the graph neural network on previously unsee input data sets.

As another example, various training techniques for graph neural networks may include one or more regularization techniques, in which the inputs to the graph neural network and/or the processing of the input are adjusted to reduce overfitting. As a first example, the training of a graph neural network may include a dropout regularization technique, in which some neurons of the graph neural network are disabled for some instances of processing input data sets. In various regularization techniques, neurons to be disabled are selected randomly (e.g., 5% of the neurons during each epoch) and/or can be selected in a sequence (e.g., a round-robin selection of deactivated neurons). The selected neurons may be disabled by refraining from processing the inputs of the neurons and setting the outputs of the selected neurons to zero, and/or by processing the selected neurons but temporarily setting the weights of the synapses of the neurons to zero. As a second example, the training of a graph neural network may include a dropnode and/or dropedge regularization technique, in which portions of an input graph data set that include some nodes and/or some edges of the input graph data set are disabled. In various regularization techniques, nodes and/or edges to be disabled for an instance of processing are selected randomly (e.g., 5% of the nodes and/or edges during each epoch) and/or can be selected in a sequence (e.g., a round-robin selection of deactivated nodes and/or edges). The selected nodes and/or edges may be disabled by refraining from processing portions of the input data set that correspond to the selected nodes and/or edges, and/or by deactivating neurons of an input layer of the graph neural network that are configured to receive input data from the selected nodes and/or edges. As a third example, the performance of a graph neural network may be subjected to various forms of regularization, including L1 (“lasso”) regularization and/or L2 (“ridge”) regularization. These and other forms of regularization may be used, alone or in combination, to reduce overfitting of a graph neural network to an input training data set. For example, regularization may reduce an overweighting of a subset of nodes, edges, and/or neurons in the processing of various input data sets (e.g., by reducing and/or penalizing neurons having synaptic weights with magnitudes that are disproportionately large compared to the synaptic weights of other neurons of the graph neural network).

As another example, various training techniques for graph neural networks may combine a graph neural network with one or more other machine learning models, including one or more other graph neural networks and/or one or more non-graph neural networks. For example, a bootstrap aggregation (“bagging”) training technique involves a determination of a decision tree as an ensemble of machine learning models based on different bootstrap samples of the training input data set. Each machine learning model, including one or more graph neural networks, may be trained based on a random subsample of the training input data set. For a particular input data set, many of the trained machine learning models of the ensemble, including one or more graph neural networks, may present poor or only adequate performance. However, one or a few of the trained machine learning models may generate high-performance output for the particular input data set and others like it (e.g., for input data sets that share one or more properties, such as a select graph property, a select node property, and/or a select edge property). Thus, for any particular input data set, an evaluation of the specific properties of the particular input data set may enable a selection among the available models of the ensemble that may be used to evaluate the particular input data set. That is, a machine learning model (e.g., a graph neural network) that is generally a poorly performing model on most input data sets may exhibit good performance over a small neighborhood of input data sets that includes the particular data set, and may therefore be selected to evaluate the particular data set. Alternatively or additionally, the bootstrap aggregation may involve an evaluation of an input data set by a plurality of machine learning models (optionally including one or more graph neural networks of the ensemble) and a combination of the outputs of the selected machine learning models. In such scenarios, it is possible the individual outputs of the individual machine learning models exhibit poor performance (e.g., incorrect and/or low-confidence classifications of an input data set), but a determination of a consensus over the outputs of the multiple machine learning models may exhibit high performance (e.g., accurate and/or high-confidence classifications of the input data set).

As another example, various training techniques for graph neural networks may include a boosting ensemble technique, in which an output of a first trained machine learning model (e.g., a first graph neural network) is evaluated by a second trained machine learning model (e.g., a second graph neural network) to predict an accuracy and/or confidence of the prediction of the first trained machine learning model. For example, a first trained graph neural network may be evaluated to determine that it generates accurate and/or high-confidence output for a first group of input data sets (e.g., input graph data sets that include a first graph property, a first node property, and/or a first edge property), but inaccurate and/or low-confidence output for a second group of input data sets (e.g., input graph data sets that include a second graph property, a second node property, and/or a second edge property). A particular input data set may initially be processed by the first trained graph neural network to determine a first output (e.g., an output graph neural network or a prediction, such as a classification). A second trained graph neural network may evaluate the input data set and/or the output of the first graph neural network to predict an accuracy and/or confidence of the first graph neural network over input data sets that resemble the particular input data set. If the second trained graph neural network predicts that the output of the first graph neural network is likely to be of high accuracy and/or confidence, then the second trained graph neural network may provide the output of the first trained graph neural network as its output. However, if the second trained graph neural network predicts that the output of the first graph neural network is likely to be of low accuracy and/or confidence, then the second trained graph neural network may adjust, correct, and/or discard the output of the first trained graph neural network, or preferentially select an output of a different machine learning model (e.g., a third trained graph neural network) to be provided as output instead of the output of the first trained graph neural network. In such scenarios, it is possible that the individual outputs of the individual machine learning models exhibit poor performance (e.g., incorrect and/or low-confidence classifications of an input data set), but the review and validation of the output of some machine learning models by other machine learning models may enable a determination of a consensus over the outputs of the multiple machine learning models that exhibits high performance (e.g., accurate and/or high-confidence classifications of the input data set).

As another example, following conclusion of training a graph neural network, the graph neural network may be deployed for use (e.g., transferred to one or more devices, deployed into a production environment, and/or connected to a source of production input data). The performance of the graph neural network over input data sets may continue to be evaluated and monitored to verify that the graph neural network continues to perform well over various inputs. In some cases, the performance of the graph neural network may change between training and deployment. For example, a distribution of production input data processed by the graph neural network may differ from the distribution of training input data that was used to train the graph neural network. Alternatively or additionally, a distribution of production input data may change over time, e.g., between a time of deploying the graph neural network and a later time after such deployment. Such instances of changes in the performance of a fully trained and deployed graph neural network may be referred to as “drift.” In some such cases, “drift” may be reduced or eliminated by retraining or continuing training of the graph neural network, e.g., using additional training input data that corresponds to an actual or current distribution of the production input data. Alternatively or additionally, “drift” may be reduced or eliminated by training a substitute graph neural network to replace the initially deployed graph neural network. For example, the substitute graph neural network may include a different set of hyperparameters than the initially deployed graph neural network (e.g., additional layers and/or neurons to provide greater learning capacity; additional regularization techniques to reduce overfitting to the training data set; and/or the inclusion of specialized layers, such as pooling, filtering, memory, and/or attention layers). As another example, the initially deployed graph neural network may be added to an ensemble of other machine learning models, optionally including other graph neural networks, to generate improved outputs (e.g., higher-accuracy predictions) based on a consensus determined over the outputs of a number of machine learning models.

As another example, the training and/or use of graph neural networks may be susceptible to various forms of adversarial attack. For example, in an adversarial attack scenario, a particularly designed and/or selected input to a graph neural network (an “adversarial input,” such as an unusual, malformed, and/or anomalous) may cause the graph neural network to generate output that is incorrect, inconsistent with other outputs, and/or surprising. As an example, in a form of graph modification adversarial attack that may be referred to as node injection poisoning adversarial attack (NIPA), one or more nodes of an input graph data set are selected and/or altered to shift an output of the graph neural network based on the adversarial input (e.g., altering a classification and/or prediction of the input graph data set, or altering an output graph data set based on the adversarial input graph data set). As another example, in a form of graph modification adversarial attack that may be referred to as an edge perturbing adversarial attack (NIPA), one or more edges of an input graph data set are selected and/or altered to shift an output of the graph neural network based on the adversarial input (e.g., altering a classification and/or prediction of the input graph data set, or altering an output graph data set based on the adversarial input graph data set). As another example, in a training data injection attack, one or more portions of training input data on which a graph neural network is trained are designed and/or altered to alter the training of the graph neural network (e.g., a mislabeling of a particular training data input that causes the graph neural network to misclassify other inputs that correspond to the mislabeled training data input, and/or an injection of data samples into a training data set that alter a data distribution of the training data set upon which the graph neural network is trained). As another example, in a membership inference adversarial attack, properties and/or outputs of a graph data set are evaluated to identify properties of one or more training data inputs on which the graph data set was trained (e.g., an influential property of an input data set that causes the graph data set to select a particular classification for the any input data sets that include the property). As another example, in a property inference adversarial attack, properties and/or outputs of a graph data set are evaluated to identify general properties of training data inputs on which the graph data set was trained (e.g., a distribution of data included in the training data set, which may indicate particular distributions of input data over which the graph neural network was not trained, or over which the graph neural network was incompletely and/or incorrectly trained). As another example, in a model inversion adversarial attack, outputs of a graph neural network are examined to identify properties of corresponding input data sets that cause the graph neural network to generate such outputs.

Based on these and other forms of adversarial attack, the training and/or evaluation of a graph neural network may be adjusted to protect the graph neural network from such adversarial attack. For example, before an input to a graph neural network is processed, the input may be evaluated and/or classified (e.g., by another machine learning model, including another graph neural network) in order to determine whether the input is adversarial. If so, the graph neural network may refrain from processing the adversarial input, may process the adversarial input in more limited conditions (e.g., processing only a portion of the adversarial input, and/or replacing a malformed or anomalous portion of the adversarial input with a corresponding non-malformed and/or non-anomalous portion). As another example, during processing of an input data set, the internal behavior of the graph neural network may be evaluated and/or classified (e.g., by another machine learning model, including another graph neural network) to determine whether the behavior indicates a processing of adversarial input (e.g., unusual neuron activations, unusual outputs of one or more neurons, and/or updates of internal states of memory units). If so, the processing of the adversarial input may be halted and/or an internal state of the graph neural network may be restored to a time before the adversarial input was processed. As another example, before output of a graph neural network is provided in response to an input data set, the output may be examined and/or classified (e.g., by another machine learning model, including another graph neural network) to determine whether it is incorrect, inconsistent with other inputs, and/or surprising. If so, the output of the graph neural network may be discarded and/or altered before being provided in response to the input data set. Further explanation and/or examples of various techniques for training and performance evaluation of graph neural networks are presented elsewhere in this disclosure and/or will be known to or appreciated by persons skilled in the art.

### Graph Neural Networks—Applications

Graph neural networks can be applied to input data sets (including input graph data sets and/or input non-graph data sets) in various applications, and can be configured and/or trained to generate outputs (including output graph data sets and/or output predictions, such as classifications) that are relevant to various tasks within such applications.

For example, in the field of social networking, a graph data set may represent at least a portion of a social network, including nodes that represent people and that are connected by edges that represent relationships among two or more people. The graph data set representing a social network may be provided, as input, to a graph neural network that is configured to receive and process the input graph data set. The graph neural network may generate, as output, an output graph data set. For example, the output graph data set may include one or more new nodes that correspond to one or more newly discovered people within the social network, and/or one or more new edges that correspond to one or more newly discovered relationships that connect two or more people of the social network. The output graph data set may include one or more subgraphs and/or clusters that represent highly interconnected people of the social network, e.g., a social circle. The output graph data set may include a prediction of a recommendation of a relationship among two or more nodes corresponding to two or more people of the social network who share common personal traits, interests, and/or connections to other people. The output graph data set may include a prediction of a classification of a node corresponding to a person of the social network, e.g., a prediction of a personal interest of the person or a demographic trait of the person. The output graph data set may include a prediction of a classification of an edge that connects nodes representing two or more people of the social network, e.g., a prediction of a criminal association among two or more people of the social network. The output graph data set may include a determination of a relationship within the social network based on an attention model, e.g., an identification of a first node corresponding to a first person of the social network that appears to be influential to a second person of the social network represented by a second node of the graph. The output graph data set may include a prediction of a graph property of the graph, e.g., a classification of the social network as one or more types (e.g., a genealogy or familial social network, a friendship social network, and/or a professional relationship social network).

As another example, in the field of pharmaceuticals, a graph data set may represent at least a portion of a molecule (e.g., a protein or a DNA sequence), including nodes that represent atoms of the molecule and that are connected by edges that represent bonds and/or spatial relationships among two or more atoms. The graph data set representing a molecule may be provided, as input, to a graph neural network that is configured to receive and process the input graph data set. The graph neural network may generate, as output, an output graph data set. For example, the output graph data set may include one or more new nodes that correspond to one or more newly discovered atoms that may be added to the molecule, and/or one or more new edges that correspond to one or more newly discovered atoms of the molecule. The output graph data set may include one or more subgraphs and/or clusters that represent highly interconnected subregions of the molecule, such as carbon atoms that form a benzene ring or a binding site for a protein. The output graph data set may include a prediction of a classification of one or more nodes corresponding to one or more atoms of the molecule, e.g., a prediction that a subset of atoms of the molecule include a binding site for an enzyme that may active and/or deactivate a protein. The output graph data set may include a prediction of a classification of an edge that connects nodes representing atoms of the molecule, e.g., a prediction of a chemically reactive bond that can be altered to alter a property of the molecule. The output graph data set may include a prediction of a graph property of the graph, e.g., a prediction of a shape or organization of the molecule, a classification of the molecule as an enzyme, and/or a prediction of a potential side-effect of a drug due to an undesirable interaction with another drug.

As another example, in the field of software, a graph data set may represent at least a portion of a marketplace, including nodes that represent products and that are connected by edges that represent relationships between products. The graph data set representing a marketplace may be provided, as input, to a graph neural network that is configured to receive and process the input graph data set. The graph neural network may generate, as output, an output graph data set. For example, the output graph data set may include one or more new nodes that correspond to one or more newly discovered product, and/or one or more new edges that correspond to one or more newly discovered products. The output graph data set may include one or more subgraphs and/or clusters that represent highly interconnected products (e.g., two or more products that are often purchased and/or used together, or that compete in a particular market sector). The output graph data set may include a prediction of a recommendation of a relationship among two or more nodes corresponding to two or more products. The output graph data set may include a prediction of a classification of a node corresponding to a product, e.g., a prediction of an appeal, value, and/or demand of a product in a particular market segment, such as a particular subset of users. The output graph data set may include a prediction of a classification of an edge that connects nodes representing products, e.g., a prediction of a functional relationship between two or more products. The output graph data set may include a prediction of a graph property of the graph, e.g., a classification of the marketplace as increasing and/or decreasing in terms of supply, demand, size, prognosis, and/or public interest.

As another example, in the field of logistics, a graph data set may represent at least a portion of a supply chain, including nodes that represent locations where resources are generated, manufactured, stored, exchanged, and/or consumed and that are connected by edges that represent means of transport of resources between two or more locations. The graph data set representing a supply chain may be provided, as input, to a graph neural network that is configured to receive and process the input graph data set. The graph neural network may generate, as output, an output graph data set. For example, the output graph data set may include one or more new nodes that correspond to one or more newly discovered location of interest, and/or one or more new edges that correspond to one or more newly discovered locations of interest. The output graph data set may include one or more subgraphs and/or clusters that represent highly interconnected locations of interest, such as locations between which certain resources are frequently transported. The output graph data set may include a prediction of a recommendation of a relationship among two or more nodes corresponding to two or more locations of interest. The output graph data set may include a prediction of a classification of a node corresponding to a location of interest, e.g., a prediction of an availability, supply, demand, value, and/or appeal of a resource in the location of interest. The output graph data set may include a prediction of a classification of an edge that connects nodes representing locations of interest, e.g., a prediction of a volume of utilization of a mode of transport between two locations of interest. The output graph data set may include a prediction of a graph property of the graph, e.g., a classification of a stability of the supply chain based on social, economic, political, and/or environmental changes.

As another example, in the field of energy, a graph data set may represent at least a portion of an energy grid, including nodes that represent energy generators, stores, distributors, and/or consumers, and that are connected by edges that represent relationships among energy generators, stores, distributors, and/or consumers. The graph data set representing an energy grid may be provided, as input, to a graph neural network that is configured to receive and process the input graph data set. The graph neural network may generate, as output, an output graph data set. For example, the output graph data set may include one or more new nodes that correspond to one or more newly discovered energy generators, stores, distributors, and/or consumers, and/or one or more new edges that correspond to one or more newly discovered energy generators, stores, distributors, and/or consumers. The output graph data set may include one or more subgraphs and/or clusters that represent highly interconnected energy generators, stores, distributors, and/or consumers. The output graph data set may include a prediction of a recommendation of a relationship among two or more nodes corresponding to two or more energy generators, stores, distributors, and/or consumers. The output graph data set may include a prediction of a classification of a node corresponding to energy generators, stores, distributors, and/or consumers, e.g., a prediction of a current or future state or property of the energy generator, store, distributor, and/or consumer. The output graph data set may include a prediction of a classification of an edge that connects nodes representing energy generators, stores, distributors, and/or consumers, e.g., a prediction of a transaction between two or more energy generators, stores, distributors, and/or consumers. The output graph data set may include a prediction of a graph property of the graph, e.g., a classification of a stability of the energy grid to sustain energy generation and to support energy demands based on social, economic, political, and/or environmental changes.

As another example, in the field of civil engineering, a graph data set may represent at least a portion of a geographic region, including nodes that represent locations of interest and that are connected by edges that represent roads. The graph data set representing a geographic region may be provided, as input, to a graph neural network that is configured to receive and process the input graph data set. The graph neural network may generate, as output, an output graph data set. For example, the output graph data set may include one or more new nodes that correspond to one or more newly discovered locations of interest, and/or one or more new edges that correspond to one or more newly discovered locations of interest. The output graph data set may include one or more subgraphs and/or clusters that represent highly interconnected locations of interest. The output graph data set may include a prediction of a recommendation of a relationship among two or more nodes corresponding to two or more locations of interest. The output graph data set may include a prediction of a classification of a node corresponding to location of interest, e.g., a prediction of a current or future volume of visitors to a location of interest and/or a volume of traffic at or through the location of interest. The output graph data set may include a prediction of a classification of an edge that connects nodes representing locations of interest, e.g., a prediction of a volume of traffic on a road that connects two or more locations of interest. The output graph data set may include a prediction of a graph property of the graph, e.g., a classification of a sufficiency of a road network of the geographic region to support a current or future volume of traffic.

As another example, in the field of industrial systems, a graph data set may represent at least a portion of an industrial plant, including nodes that represent machines of the industrial plant and that are connected by edges that represent functional relationships among the machines. The graph data set representing the industrial plant may be provided, as input, to a graph neural network that is configured to receive and process the input graph data set. The graph neural network may generate, as output, an output graph data set. For example, the output graph data set may include one or more new nodes that correspond to one or more newly discovered machines, and/or one or more new edges that correspond to one or more newly discovered machines. The output graph data set may include one or more subgraphs and/or clusters that represent highly interconnected machines. The output graph data set may include a prediction of a recommendation of a relationship among two or more nodes corresponding to two or more machines. The output graph data set may include a prediction of a classification of a node corresponding to a machine, e.g., a prediction of a current or future maintenance state of a machine. The output graph data set may include a prediction of a classification of an edge that connects nodes representing machines, e.g., a prediction of a functional relationship between a first machine and a second machine that may significantly impact an efficiency, output, cost, or the like of the industrial plant. The output graph data set may include a prediction of a graph property of the graph, e.g., a classification of the industrial plant as belonging to a particular industry, such as raw material processing, semiconductor fabrication, tool manufacturing, vehicle manufacturing, textile manufacturing, and/or pharmaceuticals manufacturing. The output graph data set may include a prediction of a future and/or optimized state of the industrial plant, e.g., a reorganization of the machines of the industrial plant to optimize machine placement and/or floor planning.

As another example, in the field of cybersecurity, a graph data set may represent at least a portion of a device network, including nodes that represent devices and that are connected by edges that represent communication and/or interactions among two or more devices. The graph data set representing the device network may be provided, as input, to a graph neural network that is configured to receive and process the input graph data set. The graph neural network may generate, as output, an output graph data set. For example, the output graph data set may include one or more new nodes that correspond to one or more newly discovered devices, and/or one or more new edges that correspond to one or more newly discovered devices. The output graph data set may include one or more subgraphs and/or clusters that represent highly interconnected devices. The output graph data set may include a prediction of a recommendation of a relationship among two or more nodes corresponding to two or more devices. The output graph data set may include a prediction of a classification of a node corresponding to a device, e.g., a prediction of a security status of the device as being safe, vulnerable, or corrupted. The output graph data set may include a prediction of an activity occurring among the nodes of the graph data set, e.g., an occurrence of an intrusion or an attack based on anomalous activities represented by the edges of the graph data set. The output graph data set may include a prediction of a classification of an edge that connects nodes representing devices, e.g., a prediction that a particular interaction between two or more devices is associated with a security vulnerability or attack. The output graph data set may include a prediction of a graph property of the graph, e.g., a classification of the set of devices as safe from security flaws or vulnerable to one or more attack mechanisms, such as denial-of-service (DOS) attacks, distributed-denial-of-service (DDOS) attacks, social engineering attacks such as phishing, eavesdropping attacks such as man-in-the-middle attacks, or the like. The output graph data set may include a prediction of a theoretical state of the graph data set, e.g., a security state of the device network in response to a particular type of attack, and/or a security state of the device network based on the inclusion of additional devices in the future. The output graph data set may include a recommendation to modify the graph neural network based on one or more security considerations, e.g., a recommendation to reorganize the device network to reduce susceptibilities to one or more security risks. The output graph data set may include a technique to defend the graph neural network from various types of adversarial attack, e.g., training-time attacks that affect the manner in which the graph neural network learns to evaluate and/or classify the graph data set, one or more nodes, and/or one or more edges. For example, the message passing operations of the graph neural network may be modified to reduce a susceptibility of the graph neural network to adversarial perturbation during training, while preserving the learning capabilities of the graph neural network.

Examples of additional applications of various graph neural networks to various graph data sets include, without limitation: graph mining applications (e.g., graph matching and/or clustering); physics (e.g., physical systems modeling and/or evolution over time); chemistry (e.g., molecular fingerprints and/or chemical reaction predictions); biology (e.g., protein interface predictions, side effects predictions, and/or disease classification); knowledge graphs (e.g., knowledge graph completion and/or knowledge graph alignment); generation (e.g., output graph data set generation that corresponds to an expression, an image, a video, a music sample, or a scene graph); combinatorial optimization; traffic networks (e.g., traffic state prediction); recommendation systems (e.g., user-item interaction predictions and/or social recommendations); economic networks (e.g., stock markets); software and information technology (e.g., software defined networks, AMR graph-to-text tasks, and program verification); text processing (e.g., text classification, sequence labeling, machine translation, relation extraction, event extraction, fact verification, question answering, and/or relational reasoning); and image processing (e.g., social relationship understanding, image classification, visual question answering, object detection, interaction detection, region classification, and/or semantic segmentation). Further examples of applications for processing various graph data sets by various graph neural networks are presented elsewhere in this disclosure and/or will be known to or appreciated by persons skilled in the art.

### Attention

In embodiments, an artificial intelligence system, machine learning model, or the like, of any of the types disclosed herein, may comprise, integrate, link to, or include an attention feature. Attention may be generally described as a determination, among a set of inputs, of the relatedness of each input to the other inputs in the set of inputs. In “self-attention,” the input includes a sequence of elements, and attention is determined between each pair of elements in the sequence. As a first example, the set of inputs includes a sequence of words in a language, and attention is applied to determine, for each word in the sequence, the relatedness of the word to each other word in the sequence. As a second example, an input includes an image comprising a set of pixels, and attention is applied to determine, for each group of pixels in the image, the relatedness of the group of pixels to each other group of pixels in the image. Attention can also be applied between sets of input, wherein attention is determined between each element of a first set of input and each element of a second set of input. For example, the set of inputs can include a first sequence of words in a first language and a second sequence of words in a second language, and attention can be determined to indicate how each word in the first sequence is related to each word in the second sequence.

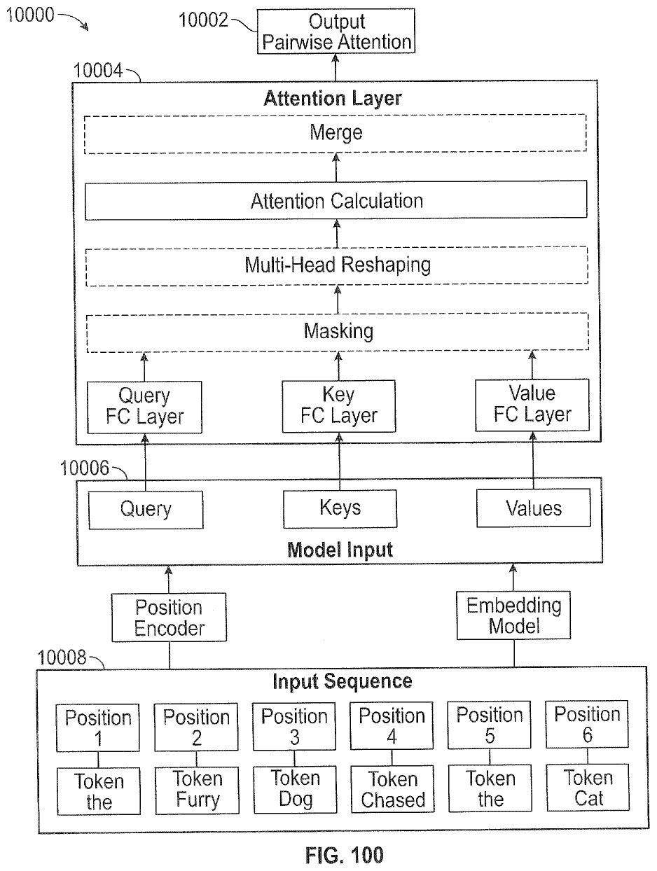

FIG. 100 presents an example of a determination of attention by a machine learning model 10000. In the example of FIG. 100, an input sequence 10008 includes a set of tokens, each representing a word (“The”, “Furry”, “Dog”, “Chased”, “The”, “Cat”). Each token includes an indicator of a position of the token in the sequence. In various embodiments, the tokens of the input sequence 10008 may include complete words, portions of words (e.g., a first token indicating a word root and a second token indicating a modifier of the word root), punctuation, or the like. Some tokens may indicate metadata, such as a start-of-sequence token, an end-of-sequence token, or a null token indicating a padding of the sequence or a mask that hides a token of the sequence.

The input sequence 10008 is processed by a position encoder that determines, for each token, an encoding of the position. In some embodiments, the position encoding may include an ordinal numerical value that indices the ordinal position of each token in the sequence, such as an index beginning at zero or one. In some embodiments, the position encoding may include a relative numerical value that indicates a position of each token in the sequence relative to a fixed position, such as a current word (encoded position 0), an immediately preceding word (encoded position −1), or an immediately following word (encoded position 1). In some embodiments, the position encoding may include non-integer values and/or multiple values, such as a first index indicating a sine calculation (with a given frequency) of the position of each token and a second index indicating a cosine calculation (with a same or different frequency) of the position of each token.

The input sequence 10008 is also processed by an embedding model. The embedding model determines, for each token in the input sequence 10008, a mapping of the token into a latent space representation of the input (e.g., a latent space representation of a language). The latent space may position each token along a plurality of n dimensions, wherein each dimension represents a distinct type of relationship among the elements of the language. The embedding model clusters the tokens such that related tokens are positioned closer to each other within the latent space. For example, along one dimension of the latent space, the words “Cat” and “Dog” may be positioned close together as being words that describe animals, while also being positioned apart from words that do not describe animals, such as “Baseball” and “School.” Along another dimension of the latent space, the words “Dog” and “Furry” may be positioned close together as words that commonly occur in the context of dogs, while also being positioned apart from words that do not describe dogs, including “Cat.” For each token of the input sequence 10008, the embedding model generates one or more values that indicate the position of the token within the latent space. In some embodiments, the values are encoded as a vector, and the proximity of two tokens within the latent space may be determined based on vector proximity calculations, such as cosine similarity.

Based on the positions encoded by the position encoder and the embeddings determined by the embedding model, a model input 10006 can be generated for the input sequence 10008. As shown in FIG. 100, the model input 10006 includes a query, a set of keys, and a set of values. As an example, the query may include an indicator of a particular token in the input sequence 10008, such as the sixth token (“Cat”). The keys may include the position encodings of respective tokens of the input sequence 10008, as determined by the position encoder, and a corresponding embedding of the respective token as determined by the embedding model. The values may indicate additional data features of the tokens. As an example, the values may indicate, for each token of the input sequence 10008, a determined sentiment (e.g., a ranking between −1, indicating very negative words, and +1, indicating very positive words). In some embodiments, no additional data features are available, and the values are identical to the keys.

The model input 10006 is received and processed by an attention layer. In FIG. 100, the attention layer 10004 first includes a set of fully connected layers: a first fully connected layer processes the query of the model input 10006; a second fully connected layer processes the keys of the model input 10006; and a third fully connected layer processes the values of the model input 10006. Each fully-connected layer includes a bias and a set of weights that adjust the values of the query, key, or value, respectively. The bias and weights of each fully-connected layer are model parameters that are initialized (e.g., to random values) and then incrementally adjusted during training.

Optionally, in some embodiments, the outputs of the fully-connected layers are further processed by a masking layer. The masking layer removes one or more values from the model input 10006 adjusted by the fully connected layers. As a first example, the masking layer can reduce to zero the values of the key and/or value at a given position, such as a token at a current position to be predicted, or a token at a position following the current position that is to be hidden from the model. As a second example, the masking layer can reduce to zero the values of particular keys and/or values, such as padding values that are provided to adapt the size of the model input 10006 to a size of input that the attention layer 10004 is configured to receive and process. The masking layer can produce output for certain tokens (e.g., reduced to zero) for the indicated tokens (e.g., the current token, future tokens, and/or padding tokens) and that is the same as the input for the remaining tokens.

Optionally, in some embodiments, the outputs of the masking layer are further processed by a multi-head reshaping layer. The multi-head reshaping layer can reshape an input vector comprising the weighted and/or masked model input 10006 such that subsets of the input can be processed in parallel by different attention heads. As an example, an attention layer 10004 may include two attention heads, and the input can be reshaped such that each attention head is applied to only half of the inputs. The multi-head attention model can enable attention determinations over different subsets of the input (e.g., a first attention head can determine the relatedness of a first token to a first subset of tokens of the input sequence 10008, and a second attention head can determine the relatedness of the same first token to a second subset of tokens of the input sequence 10008). Alternatively or additionally, the multi-head attention model can enable different types of attention determinations among the tokens of the input sequence 10008 (e.g., a first attention head can determine a first type of relatedness of a first token to a subset of tokens of the input sequence 10008, and a second attention head can determine a second type of relatedness of the same first token to the same or different subset of tokens of the input sequence 10008). The multi-head attention model may enable parallel processing of the input sequence 10008 (e.g., the input for each attention head can be processed by a different processing core).

The attention layer 10004 includes an attention calculation that determines, based on the model input 10006, the attention of a token of the input sequence 10008 with respect to other tokens of the input sequence 10008. In some embodiments, the attention calculation includes an additive attention (“Bahdanau Attention”) calculation, in which attention is determined as a sum of weighted calculations of the distances of the tokens along each dimension of the latent space. In some embodiments, the attention calculation includes a dot product determination, as a comparison of the distances between the vectors of the tokens within the latent space. In some embodiments, the attention calculation is performed over the query, keys, and values of the model input 10006, optionally after processing with a masking layer. In some embodiments, the attention calculation is performed for each of a plurality of attention heads, each of which processes a particular subset of the tokens of the input sequence 10008.

In embodiments that include multi-head reshaping, the output of the attention calculation is further processed by a merge operation that merges the attention calculations for the respective attention heads. In some embodiments, the merge operation includes a concatenation and/or interleaving of the attention calculations of the attention heads. In some embodiments, the merge operation includes an arithmetic operation applied to the attention calculations of the attention heads, such as an arithmetic mean, median, min, and/or max calculation.

The attention layer 10004 outputs, for at least one token of the input sequence 10008, a determination of attention between the token and at least one other token of the input sequence 10008. The output of the attention calculation may include a vector that indicates, for at least one token of the input sequence 10008, the determinations of attention between the token and a set of other tokens of the input sequence 10008. The output of the attention calculation may include a set of vectors that indicate, for respective tokens of the input sequence 10008, the determinations of attention between the respective token and at least one other token of the input sequence 10008. The output of the attention calculation may indicate, for a token of a first sequence, the attention of the token to one or more tokens of a second sequence. As shown in FIG. 100, the output of the attention layer 10004 includes pairwise determinations of relatedness between pairs of tokens (e.g., each pair including a current token in an input sequence 10008 and each preceding token in the input sequence 10008). In some embodiments, the pairwise determinations may be further processed. For example, a softmax calculation can be applied to normalize the pairwise attention 10002 determinations based on a desired range of output values (e.g., probability values between 0.0 and 1.0, with a 1.0 sum overall output values).

The attention layer 10004 may be trained by providing sets of training input sequence 10008s and comparing the outputs of the attention layer 10004 with expected outputs. Alternatively or additionally, the attention layer 10004 may be trained by incorporating the attention layer 10004 into a larger model (e.g., a transformer model) and adjusting the parameters of the attention layer 10004 (e.g., the parameters of the fully-connected layers) for a given training input sequence 10008 in order to adjust the output of the attention layer 10004 toward a desired output for the training input sequence 10008. As an example, in a backpropagation training process, the output of the attention layer 10004 is provided as input to a succeeding layer. The output of the model including the attention layer 10004 and the succeeding layer may be compared with a desired output for the training input sequence 10008. Based on this comparison, adjustments of the output of the succeeding layer (e.g., based on an error calculation) may inform a determination of desired adjustments of the input of the succeeding layer, which correspond to adjustments of the output of the attention layer. The adjustments of the output may be achieved by internally adjusting the parameters of the attention layer 10004 (e.g., the weights and/or biases of the fully connected layers shown in FIG. 100) such that the attention layer 10004 subsequently generates output for the training input sequence 10008 that more closely corresponds to the desired input for the succeeding layer. Incremental training over a set of training input sequence 10008s can cause the attention layer 10004 to generate output that corresponds to the desired output for the training input sequence 10008s. As an example, if the input sequence 10008s are sentences in a language and the desired output of the model includes the probabilities of words in the language that could follow a given set of input words, the attention layer 10004 can be incrementally adjusted to indicate the attention (e.g., relatedness) between the next word in the input sequence 10008 and the preceding words in the input sequence 10008.

It is to be appreciated that the attention layer 10004 shown in FIG. 100 presents only one example, and that attention layers may include a variety of variations with respect to the example of FIG. 100. For example, attention layers may include, without exception, additional layers or sub-layers that perform one or more of: normalization; randomization; regularization (e.g., dropout); one or more sparsely-connected layers; one or more additional fully-connected layers; additional masking; additional reshaping and/or merging; pooling; sampling; recurrent or reentrant features, such as gated recurrence units (GRUs), long short-term memory (LSTM) units, or the like; and/or alternative layers, such as skip layers. Alternatively or additionally, the architecture of the attention layer 10004 shown in FIG. 100 may vary in numerous respects. For example, masking may be applied to the model input 10006 instead of to the outputs of the fully connected layers. One or more fully-connected layers may be omitted, replaced with a sparsely-connected layer, and/or provided as multiple fully-connected layers, including a sequence of two or more fully-connected layers; or the like. Model parameters (e.g., weights and biases) and/or hyperparameters (e.g., layer counts, sizes, and/or embedded calculations) may be modified and/or replaced with variant parameters and/or hyperparameters. Many such variations may be included in attention layers that are incorporated in a variety of machine learning models to process a variety of types of input sequence 10008s.

### Transformer Models

In embodiments, an artificial intelligence system, machine learning model, or the like, of any of the types disclosed herein, may comprise, integrate, link to, or include a transformer model, that is, a neural network that learns context and meaning by tracking relationships in a set of sequential data inputs. Transformer models may include one or more attention layers, including (but not limited to) the attention layer 10004 shown in FIG. 100.

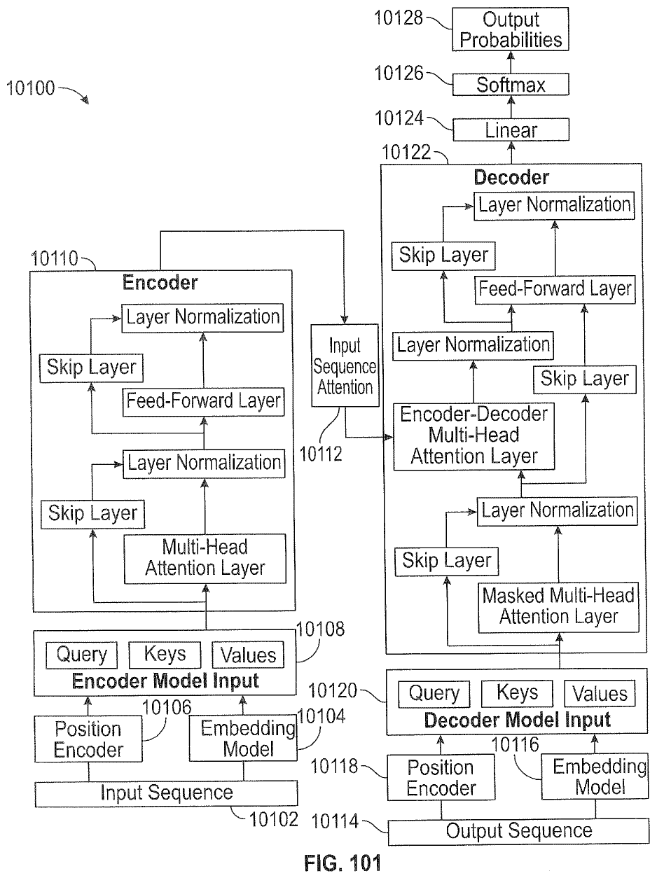

FIG. 101 presents an example of a transformer model. The transformer model of FIG. 101 is based on an encoder-decoder architecture in which an encoder 10110 processes an input sequence 10102 and a decoder processes an output sequence to generate output probabilities. As a first example, the input sequence may include a sequence of words in a first language; the output sequence may include a sequence of words in a second language corresponding to a translation of the input sequence; and the output probabilities may include the probabilities of words in the second language for a particular position in the translation. As a second example, the input sequence may include a sequence of words in a language that represent a query or prompt; the output sequence may include a sequence of words in the same language that represent a response to the query or prompt; and the output probabilities may include the probabilities of words in the second language for a particular position in the response. In some cases, the output sequence includes only the tokens up to a particular position (e.g., the first n−1 tokens of the output sequence), and the output probabilities represent the probabilities of tokens in the language of the output sequence that could follow the output sequence (e.g., the nth token in the output sequence). In some cases, the output sequence includes all of the tokens except the token a particular position (e.g., all of the tokens except the nth token of the output sequence), and the output probabilities represent the probabilities of tokens in the language of the output sequence that could represent the missing token in the output sequence (e.g., the nth token in the output sequence).

The encoder 10110 receives an input sequence comprising a set of tokens. The input sequence may be padded to a given length corresponding to a configured input size for the encoder 10110. The input sequence is processed by a position encoder 10106 to encode the positions of the respective tokens of the input sequence. The input sequence is also processed by an embedding model 10104 to determine the embeddings of the tokens of the input sequence 10112. The encoded positions and embeddings are used to generate an encoder model input 10108, including a query (e.g., a position of one or more tokens in the input sequence), a set of keys (e.g., the encoded positions and embeddings for each token of the input sequence), and a set of values (e.g., additional language features of the tokens such as outputs of sentiment analysis). The set of values may be a copy of the set of keys if no additional data features are available. The encoder model input 10108 is processed by a multi-head attention layer, such as an instance of the attention layer shown in FIG. 1. The multi-head attention layer determines self-attention within the input sequence (e.g., the relatedness of a respective token of the input sequence to each other token of the input sequence). The output of the multi-head attention layer is received and processed by a layer normalization component. Additionally, a skip layer is provided that passes the encoder model input 10108 through to the layer normalization component. The layer normalization component combines the output of the multi-head attention layer with the encoder model input 10108 (e.g., via arithmetic mean, median, min, max, addition, multiplication, or the like) and normalizes the combined output to within a desired range. In some embodiments, the encoder includes a sequence of two or more instances of this combination of multi-head attention layers, skip layer, and layer normalization components. The encoder also includes a feed-forward layer (e.g., a fully-connected layer and/or a sparsely-connected layer) including a set of trainable parameters. The output of the feed-forward layer is provided to another layer normalization component, along with the output of the preceding layer normalization component via a skip layer. The encoder outputs an input sequence attention, which indicates, for each of one or more tokens of the input sequence, the relatedness of each other token of the input sequence.

The decoder 10122 features an architecture that is similar to the encoder, but that includes additional components to incorporate the input sequence attention generated by the encoder. The decoder receives an output sequence 10114 comprising a set of tokens. The output sequence may be padded to a given length corresponding to a configured input size for the decoder. The output sequence is processed by a position encoder to encode the positions of the respective tokens of the output sequence. The output sequence is also processed by an embedding model 10116 to determine the embeddings of the tokens of the output sequence. The encoded positions and embeddings are used to generate a decoder model input 10120, including a query (e.g., a position of one or more tokens in the output sequence), a set of keys (e.g., the encoded positions and embeddings for each token of the output sequence), and a set of values (e.g., additional language features of the tokens such as outputs of sentiment analysis). The set of values may be a copy of the set of keys if no additional data features are available. The decoder model input 10006 is processed by a masked multi-head attention layer, such as an instance of the attention layer shown in FIG. 1. In addition to determining attention, the masked multi-head attention layer masks the input values of a current token of the output sequence and any tokens of the output sequence that follow the current token. The masked multi-head attention layer determines self-attention within the output sequence (e.g., the relatedness of a respective token of the output sequence to each preceding token of the output sequence). The output of the multi-head attention layer is received and processed by a layer normalization component. Additionally, a skip layer is provided that passes the encoder model input 10108 through to the layer normalization component. The layer normalization component combines the output of the multi-head attention layer with the encoder model input 10108 (e.g., via arithmetic mean, median, min, max, addition, multiplication, or the like) and normalizes the combined output to within a desired range. In some embodiments, the encoder includes a sequence of two or more instances of this combination of multi-head attention layers, skip layer, and layer normalization components. The decoder further includes an encoder-decoder multi-head attention layer that receives both the output of the preceding layer normalization component and the input sequence attention generated by the encoder. The encoder-decoder multi-head attention layer does not determine self-attention within the output sequence, but, rather, determines the attention between the tokens of the output sequence and the corresponding tokens of the input sequence. The output of the encoder-decoder multi-head attention unit is also received and processed by a second layer normalization component. Additionally, a skip layer is provided that passes the input to the encoder-decoder multi-head attention layer through to the second layer normalization component. The second layer normalization component combines the output of the multi-head attention layer with the input to the encoder-decoder multi-head attention unit (e.g., via arithmetic mean, median, min, max, addition, multiplication, or the like) and normalizes the combined output to within a desired range. The decoder also includes a feed-forward layer (e.g., a fully-connected layer and/or a sparsely-connected layer) including a set of trainable parameters. The output of the feed-forward layer is provided to a third layer normalization component, along with the output of the preceding layer normalization component via a skip layer. The output of the decoder is processed by a fully connected layer and a softmax normalization layer 10126 based on a cross-entropy determination.

The output of the softmax normalization layer 10126 includes a set of probabilities for each possible token of a language of the output sequence for the current token. As a first example, the input sequence may include a sequence of words in a first language; the output sequence may include a sequence of words in a second language corresponding to a translation of the input sequence, up to a current (nth) word in the translation; the output probabilities 10128 may include the probabilities of words in the second language for the nth word in the translation. As a second example, the input sequence may include a sequence of words in a language that represent a query or prompt; the output sequence may include a sequence of words in the same language that represent a response to the query or prompt, up to a current (nth) word in the response; and the output probabilities may include the probabilities of words in the language for the nth word in the response.

During training, the transformer model may be provided with a set of input sequences and complete corresponding output sequences. As a first example involving language translation, the transformer model may be provided with a training data set including a first corpus of sentences in a first language and a second corpus of sentences in a second language that respectively correspond to the sentences in the first language. As a second example involving a generative model, the transformer model may be provided with a training data set including a first corpus of queries or prompts in a language and a second corpus of responses in the language that correspond to the respective queries or prompts. For each training data input, a pair of sentences of the first corpus and second corpus are selected. The encoder is provided with the first (input) sentence, and the model is processed to determine the first word in the second (output) sentence. In this case, the output sequence provided to the decoder is completely masked so that the decoder cannot make predictions based on the expected words in the second sentence. The word probabilities determined by the decoder are compared with the actual first word in the output sequence, and backpropagation is applied through the decoder and encoder to increase the likelihood of outputting the expected word. The backpropagation includes adjusting the parameters of the attention layers to increase the attention between the first word and related words of the input sequence. The encoder is then provided again with the first (input) sentence, and the model is processed to determine the second word in the second (output) sentence. In this case, the output sequence provided to the decoder includes the unmasked first word, but masks all words after the first word. The word probabilities determined by the decoder are compared with the actual second word in the output sequence, and backpropagation is applied through the decoder and encoder to increase the likelihood of outputting the expected word. The backpropagation includes adjusting the parameters of the attention layers to increase the attention between the second word, the known first word of the output sequence, and related words of the input sequence. In this manner, the transformer model performs an autoregressive prediction, wherein the output probability of each nth token of the output sequence is based on the input sequence, the previously predicted tokens of the output sequence, and the encoder-decoder attention therebetween. Training continues over the entirety of the first and second corpora to improve the output predictions.

In many cases, the training of the transformer model occurs in batches. For example, the previous (simplified) training example described an incremental training of the transformer model over each corresponding pair of sentences of the first and second corpora, wherein the parameters of the transformer model are adjusted via backpropagation after each instance of processing. In batch training, the input and output sequences are vectorized, as are the layers of the transformer model, such that predictions over each word of the output sequence are predicted in parallel. Backpropagation parameter adjustment is performed for each batch of the training data set, based on the outputs for all of the pairwise inputs of each batch of the training data set.

After training, the transformer model can be used to predict an output sequence based on an input sequence. First, the input sequence is processed by the encoder, while the decoder processes a null output sequence (e.g., an output sequence in which all outputs are initially nulled and/or masked by the masked multi-head attention layer). The output probability of the decoder is used to determine a first token of the output sequence. In some embodiments, the first token is chosen as the token having the highest probability. In other embodiments, the first token is chosen based on a random sampling over the output probabilities. In either case, the transformer is then applied to the same input sequence and an output sequence including only the determined first token of the output sequence, and the output of the decoder determines the second token of the output sequence. This process continues until reaching an output token cap and/or upon determining, as the output of the decoder, an end-of-sequence token. In this manner, the transformer model is applied over the input sequence to determine, in serial and autoregressive manner, the tokens of the output sequence.

It is to be appreciated that the transformer model shown in FIG. 2 presents only one example, and that transformer models may include a variety of variations with respect to the example of FIG. 2. For example, the architecture of the encoder and/or decoder may include, without exception, additional layers or sub-layers that perform one or more of: normalization; randomization; regularization (e.g., dropout); one or more sparsely-connected layers; one or more additional fully-connected layers; additional masking; additional reshaping and/or merging; pooling; sampling; recurrent or reentrant features, such as gated recurrence units (GRUs), long short-term memory (LSTM) units, or the like; and/or alternative layers, such as skip layers. Alternatively or additionally, the architecture of the encoder and/or decoder shown in FIG. 2 may vary in numerous respects. For example, masking may be applied directly to the output sequence instead of within the multi-head attention models. One or more fully-connected layers may be omitted, replaced with a sparsely-connected layer, and/or provided as multiple fully-connected layers, including a sequence of two or more fully-connected layers; or the like. Model parameters (e.g., weights and biases) and/or hyperparameters (e.g., layer counts, sizes, and/or embedded calculations) may be modified and/or replaced with variant parameters and/or hyperparameters. Many such variations may be included in transformer models to process a variety of types of input and output sequences.

Transformer models, including the example shown in FIG. 2, may be applied in a variety of circumstances. As an example, transformer models may be trained on and/or configured to process a variety of types of input sequences and/or output sequences. Sequential data inputs and/or outputs can include a wide variety of types described herein, such as strings of text, sequences of sensor data from or about an entity, sequences of steps in a process (e.g., chemical, physical, biological, and many others) or flow (e.g., a human workflow, information technology traffic flow, physical traffic flow, sequences of user behavior (e.g., attention to content, clickstream behavior, shopping behavior (digital and real world), and many others. Any of these, and others can be provided as inputs to train a transformer model, which may be alternatively described herein as a self-attention model, a foundation model, or the like. A range of mathematical self-attention techniques can be applied to detect how data elements in sequential data mutually affect each other (such as in feed forward, feedback, and other forms of influence and dependency). In various embodiments described herein and in the documents incorporated by reference herein, a set of transformer models may be deployed for a wide range of use cases, including for predictive text applications (e.g., generating a next token of text based on a previous set of tokens, such as for intelligent agent dialog, responses to queries, and the like); for extraction of information (such as extraction of meaningful elements from sensor data, signal data, and the like, such as analog signal data from sensors on machines, wearable devices, infrastructure sensors, edge and IoT devices, and many others); for analysis of human factors, such as emotional response, sentiment, satisfaction, opinion, and the like; for summarizing data (such as providing summaries of text, images, video, sensor data, and many other streams of data of the type collected and processed as described herein); for trend detection, prediction and forecasting (and hence also for anomaly detection, such as fraud in financial transactions), including for a wide range of trends, including health (human, animal, mental, financial, machine condition, and others), performance (wellness, financial, physical, and many others), and many others; for recognition of entities and behaviors (such as objects appearing in video or image data, objects captured in LIDAR and other point-cloud rendering systems, objects located by SLAM systems, and many others); for generation and execution of instructions (e.g., recipes, control instructions, rules, regulations, governance instructions, and many others); and for many other uses.

In embodiments, an input data set, such as an analog or digital sensor data stream, a body of text, a set of images, a set of structured data (such as data from a graph database or other form of database noted herein, a sequence of blockchain or distributed ledger entries (or other ledger data, such as accounting, financial, health or other data), a set of signals (of the various types noted herein), is provided in order to train a transformer model. In embodiments, initial training may include a step of facilitating compression of the input data, such as by constraining the size of the transformer neural network and/or its outputs, to dimensionality that is significantly smaller (or less granular, etc.) than that of the input data. By requiring the output of the constrained transformer model to match, within a required metric of fidelity, the input data, the transformer model is caused to generate an “embedding” of the input data into a more compressed, efficient format. A decoding neural network may then be trained to operate on the output of the constrained, embedding transformer model, such that it can reproduce the input data from the output of the constrained model within the required metric, thereby assuring that the data is compressed without losing critical meaning.

Once the embedding transformer model is so trained, the decoding neural network can be removed and replaced by one or more of a set of use-case driven decoding models, each of which is trained to operate on the output of the embedding model to produce a target outcome, such as performing any of the use cases noted above to a satisfactory degree. These use-case decoding models can be fine-tuned iteratively over time with feedback from users, outcomes, or the like. Thus, a trained embedding foundation/transformer model, once created, can be used across many different use cases that may benefit from understanding the meaning of the input data set.

In embodiments, one type of use-case decoder can be trained to allow the embedding transformer model to operate on lower quality data than was originally supplied to train the model. To accomplish this, both low quality and high quality data (such as high granularity sensor data and low granularity sensor data, or high dimensionality signal data and low dimensionality signal data, or noisy acoustic data and filtered acoustic data, or the like) can be simultaneously fed to a pair or more of instances of the trained, embedding transformer model, and a decoder for the instance of low quality data can be trained to generate an output that matches, within a metric of fidelity, the output of the instance of the embedding transformer model that is fed the high quality data. As an example, gap-free analog waveform data from a three-axis vibration sensor on a machine component can be captured simultaneously with less granular data from a single- or two-axis accelerometer on the same component, and a decoder, operating on the output of the instance of the embedding transformer model that takes the single- or two-axis input, can be trained to match (within a tolerance) the output of the instance of the embedding transformer model that takes the more granular data as an input. Once created, the resulting decoder, coupled with the embedding transformer model, serves as a projection transformer model, effectively projecting lower quality data into higher quality data, which can then be used by other decoders to enable use cases. This class of projecting transformer models can be applied to a wide range of use cases where high quality data can be obtained during a training phase (often at higher expense), but lower quality data can be used as an input during a deployment phase (such as where lower quality data is more widely or cheaply available, such as in the case of vibration data noted above). Among other things, these projecting transformer models allow powerful, real-time, low latency use cases for AI even when input data is sparse, noisy, of low dimensionality, or the like.

In embodiments, feedback from various decoder models can be used to improve instances of an embedding foundational or transformer model. In embodiments, a set of transformer models, a set of decoders, or both, can be arranged in a workflow, which may be directed/acyclical or with processing loops, to create higher-level use cases that benefit from multiple applications of AI. For example, one model may be used to classify a condition, another used to generate a recommendation, and another used to generate a control instruction, among a huge range of possible embodiments. This may include serial, parallel, iterative, feed forward, feedback and other configurations.

In embodiments, a set of models may be trained to generate instructions for configuration of other models.

In embodiments, transformer models may be deep learning, self-learning, self-organizing, or the like, and may be used for any of the embodiments of self-learning, self-organization, or other self-referential capabilities noted throughout this disclosure or the documents incorporated by reference herein. They may also be supervised, semi-supervised, or the like. Transformer models may be coupled with, integrated with, linked to, or the like, in series, parallel or other more complex workflows, with other AI types, such as other neural network types (e.g., CNNs, RNNs, and others). For example, in embodiments, a transformer model operating on sequential data may be coupled with a model suited to operate on non-sequential data (e.g., for pattern recognition) to achieve a use case.

In embodiments, transformer models discover patterns in large bodies of data by application of a set of mathematical functions, optionally operating in parallel processing configurations, thereby eliminating or reducing the need for human labeling (and thereby greatly expanding the set of available data that can be used to train a model).

Self-attention may be accomplished in a transformer model by introducing a set of positional encoders that tag data elements entering and exiting a neural network and inserting a set of attention units at appropriate places in the encoding and decoding framework of an AI system. The attention units generate a mathematical map of interrelationships among data elements. In embodiments multi-headed attention units are deployed, executing a matrix of equations in parallel to determine the interrelationships. Transformer models, using self-attention, have displayed strong capabilities to provide outputs that are consistent with how humans find patterns and meaning in data.

In embodiments, transformer models may be embodied with very large numbers of parameters (e.g., hundreds of millions, billions, trillions, or more) operating on very large sets of parallel processors. For example, the Megatron-Turing Natural Language Generation Model by NVIDIA and Microsoft is reported to have 530 billion parameters. As noted above, from a foundational model, various use-case specific models (decoders, projections, and the like) can be purpose-built for specific applications. Accordingly, in embodiments a set of transformer models may be deployed using advanced computational techniques and/or processing architectures, such as ones that simplify or converge processors, simplify I/O, and the like. For example, 3D chipset or chiplet architectures may facilitate much higher density, faster computation, making transformer models more cost-effective. Quantum computation may also facilitate massively parallel processing in form factors that are faster, more energy efficient, or the like. Similarly, embodiments may use a tensor-engine GPU chip with a specific transformer engine, such as the NVIDIA H100 Tensor Core GPU. Another example of a transformer model is Google's switch transformer model, a trillion-parameter model that uses sparsity and a mixture-of-experts architecture to enable gains in performance and reductions in training speed.

As noted above, in embodiments smaller or more constrained transformer models may be trained to generate embeddings, particularly for very complex data sets, such as granular analog data.

In embodiments a set of transformer models may be configured to operate on structured data processing systems, such as on results from queries that are directed to a database, results of inputs directed to a set of APIs, or the like. This may facilitate better understanding of what meaning a transformer model is recognizing in a data pattern, which can be critical to ensuring quality (e.g., where a model may, due to flaws in underlying data, generate poor conclusion, such as replicating historical racial bias, missing critical balancing information, failing to understand formal logical constructs, or the like). As noted elsewhere in this disclosure and the documents incorporated herein, governance of AI in general, is a need, and the scale and complexity of transformer models likely compounds problems recognized with other neural networks, including their “black box” nature, uncertainty about input quality, and the like. Thus, governance concepts disclosed herein and in documents incorporated by reference should be understood to apply to various embodiments that use transformer models, as with other types of AI. One example is in the training of models, where models may be trained, in embodiments, in various disciplines, optionally similar to the educational frameworks by which humans are trained not just to sense pattern meaning, but also how to test and govern those abilities with formal reasoning and logic, mathematics, probability, and frameworks of ethics and morality.

Throughout this disclosure and the documents incorporated by reference herein, various embodiments are provided of digital twin platforms and systems that leverage sensors and other information sources, robust connectivity, and intelligence systems to allow users to experience accurate representations of the states and activities of the many entities that are involved in the workflows of an individual, group or enterprise (e.g., a company, business unit, department, government, household, non-profit, or other enterprise). These include, among others, role-based digital twins that can be configured, or that self-configure, how data is collected, stored, processed and/or presented in ways that account for the roles of respective users (e.g., ones directed to financial users, strategic users, operational users, many others). Digital twins also include adaptive digital twins that leverage intelligence systems, such as artificial intelligence, analytic systems, expert systems, or hybrids involving various permutations and combinations thereof, to adapt how data is collected, stored, processed and/or presented based on context, such as based on the content of the information that is collected and processed. Among these adaptive digital twins, a subset, AI-driven digital twins, may use component artificial intelligence systems at any of the stages of the pipeline of information from a sensor or other basic information source to the presentation of content to a user. Artificial intelligence systems can provide outputs along a spectrum of autonomy, including: a) presenting reports, alerts, classifications, predictions, recommendations, analyses and other outputs for human review and action; b) undertaking human-supervised control of one or more aspects of a workflow, where the artificial intelligence system (acting as a co-pilot, assistant, intelligent agent, or the like to a human user) outputs a prediction and/or a recommendation for an action (which may be embodied in an instruction that can be processed by a system), and a human confirms, or adjusts, the nature of the action before it is implemented; and c) undertaking autonomous control of one or more systems or subsystems, where the artificial intelligence processes relevant information, completes necessary classifications, predictions and other decision-making steps (including where applicable, confirming risk management, governance, self-reflection or other steps) and triggers an action (such as by providing an instruction, control signal, or the like) to a system or component.

Along this spectrum from basic reporting to full autonomy, there is a varying extent to which there is a human being in the decision-making loop. Artificial intelligence systems have enormous promise to automate individual, group and enterprise workflows, providing more reliable, seamless monitoring of ongoing activities, faster response times to unexpected events, and more efficient execution of many types of tasks, among many other benefits. However, the extent to which AI systems can be trusted can vary widely, such as based on: a) the stakes involved (e.g., are there risks to human life, health or property in making a wrong decision?); b) how the AI system was trained (e.g., are there reasons to believe that there is bias in the training data that will be carried forward into the outputs of the AI system); c) how the AI system is governed or supervised (e.g., is in compliance with regulatory, legal or other governance frameworks embedded in the workloads of the system as contemplated in this disclosure and the documents incorporated by reference herein, or is there a need for separate governance or supervision?); d) how the AI system performs, in absolute terms and relative to other available systems, including other AI systems, analytic systems, or human beings (experts, other individuals, groups, or crowds, for example); e) the quality, type and/or availability of data (which can include factoring in the cost of the data); f) the quality, type and/or availability of connectivity (which can include factoring in the cost of the connectivity); g) the quality, type and/or availability of computational resources (which can include factoring in the cost of the computational resources); h) the quality, type and/or availability of other necessary resources (e.g., energy); i) environmental or contextual parameters of the workflow to which the AI system will be applied (such as the complexity of a physical environment, the presence of human beings in proximity, or the like); and other factors. As an example among many, a well-trained AI system may be highly capable of driving a vehicle down a highway during daylight, doing so more safely than a human being who could be prone to sleepiness or distraction, but if computational, networking, or other resources are uncertain, it may be decided that the AI system should not be trusted to perform the task. Decisions about the extent to which one can trust an artificial intelligence system can be very difficult, and the extent of trust is a major factor in determining whether or not AI systems, and their many benefits, can be unlocked.

A major benefit of the various digital twin systems disclosed herein is that a digital twin platform, particularly one that is adaptive and self-configuring, can provide an ideal environment for decision making. Good decisions usually need a combination of a) fresh, accurate, relevant information; b) application of some degree of expertise; c) use of judgment to consider tradeoffs of risks; and/or d) leadership to cause implementation (which may encompass, among other things, taking on the consequences when outcomes are unfavorable). Each of these attributes can be supported by the data collection, storage and processing systems, connectivity systems, computational systems and intelligence systems described throughout this disclosure and the documents incorporated by reference herein. For example, a pipeline of IOT and edge devices and high QoS networks (adaptive networking) can pass granular, real-time sensor data about all entities in an operating environment (machines, components, humans, infrastructure, etc.), which manifests in visibility, such as for big data analytics and consulting use cases, as well as data for machine learning. Data architectures (e.g., adaptive sensing and data collection; edge query language; intelligent data storage and processing layers) and advanced computational architectures (hybrid cloud, edge, and quantum computing) can be used to optimize conditions for application of human and machine intelligence. For example, data architectures can adapt visual representations for human cognitive processing (including based on the skillset, role, experience, expertise, or cognitive parameters of a human, such measured by neurometrics, psychometrics, or other systems) and/or prepare and stage data for artificial intelligence systems (including by cleansing, deduplication, generation of synthetic data, entity resolution, normalization and other processing, generation of various embeddings that use one AI system (e.g., a trained neural network) to transform and/or compressed input data into outputs that are suitable for efficient processing by AI systems, and the like). Computational architectures can be adapted to use an appropriate mix of cloud, edge and on-device processing systems (including various chipsets described herein, such as AI chipsets and hybrid chipsets involving AI and other functions integrated together). This can include quantum computing where beneficial. Systems integration, including various configurations of systems, systems-of-systems and the like into platform and infrastructure solutions (including PaaS and IaaS configurations), with various architectures, including service-oriented architectures, microservices architectures, and the like, can integrate all relevant systems across an individual's or group's set of activities, an enterprise, or an entire business ecosystem, such that a digital twin can have access to current state and activity parameters for many relevant entities. Data and sensor fusion, such as involving sensor data and many other data sets can assist in tracking or predicting outcomes (environmental data, market data, transaction data and many others). Advanced artificial intelligence techniques can combine with human insight to generate expert systems and models that understand and predict operational states, flows and more complex behaviors reflected in data (big data analytics and advanced artificial intelligence techniques), including compact models that are capable of operating effectively on sparse data and/or constrained computational architectures at the edge, as well as generative AI outputs that provide summaries, creative content, instructions, reports, and many other outputs from various inputs, including text, image, video, audio and multi-modal generative AI systems. AI-driven stakeholder interfaces can adaptively filter, prioritize, and distribute information for planning, simulation, decision making and operational action to appropriate stakeholders across an entire enterprise.

With the above stack of integrated systems, taking the form of the many embodiments disclosed herein and in the document incorporated herein by reference, distribution of control, of the various disparate systems, systems-of-systems, components, platforms, infrastructure elements, and other entities involved in the activities of an individual, group, or various levels and roles of enterprise can be enabled, with consideration being given, as noted above, to factors such as latency, security, safety, operational efficiency, reliability and trust.

The untapped power of the digital twin is its ability to enable collaboration, and to distribute decision making, to the right mix of human beings, artificial intelligence systems and other systems, whether in an enterprise or in the activities of an individual or group. The digital twin allows incremental change, experimentation, and easily reversible implementation, removing fear of closing the loop. For example, a digital twin can include a simulation environment that simulates, based on actual historical and current data, what outcomes most likely ensue from deployment of particular configurations of human and artificial intelligence elements in decision making and control loops. The digital twin can also provide a planning environment for deployment of artificial intelligence systems, as well as the data collection, data processing, networking, connectivity, energy, and computational systems and architectures that support them; for example, an enterprise can, using the digital twin, plan various scenarios for obtaining resources to enable more powerful AI systems, comparing projected outcomes at various resource levels and mixes. The digital twin can enable graceful migration among humans, human-AI mixes (e.g., with agents and co-pilots) and autonomous AI systems, including deploying them in ways that can be rapidly adjusted, or reversed, such as based on changing performance capabilities, contextual and environmental factors, and events; for example, an AI system might be permitted to control transactions during normal daily operations, but it could be removed from the loop, or provided with greater human supervision, in the case of major shifts in an environment, such as during severe swings in the market, after an environmental catastrophe, or the like. Thus, provided herein is a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity. Also provided herein is a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations. The resources may include ones for data collection, data processing, networking, connectivity, energy, and computational systems and architectures that support them.

As noted throughout this disclosure and the documents incorporated by reference herein disclose the training of machine learning systems in various configurations, including deep learning, supervised learning, semi-supervised learning, and the like. In many such embodiments, a human expert provides input data that is used to train the AI system, such as by tagging data sets to assist in AI classification systems; by producing code, text, images, audio, video and other inputs that are used to train generative AI systems to predict a set of outputs from a prompt; by undertaking activities and behaviors that indicate preferences to train AI systems to generate recommendations; by configuring systems, platforms and architectures that can be used to train AI systems to generate similar configurations and recommendations; by undertaking decisions in various contexts and environments that are used to train AI systems to produce recommendations, make decisions and/or output control signals in similar contexts and environments, among others. In embodiments, any of the machine learning systems or other artificial intelligence systems disclosed herein or in the documents incorporated by reference herein may be embedded in a digital twin for the purpose of enabling training of the digital twin. This may include designating a set of users (such as domain experts, managers, operational supervisors, executives, or the like) as trainers for the AI system, including based on the role, core competency, expertise, experience, or other aspects of the set of users. In embodiments, this may include designating one set of users to provide input data for initial training of a particular AI system and another set of users (possibly overlapping in part with the first set) to supervise the outputs of the AI system. Thus, disclosed herein is a digital twin system with an interface system for designating a set of users as trainers for the creation of an artificial intelligence system that is represented in the digital twin, wherein the artificial intelligence system operates on the data that is used to populate the digital twin. Also disclosed herein is a digital twin system with an interface system for designating a set of users as supervisors for an artificial intelligence system that is represented in the digital twin, wherein the artificial intelligence system operates on the data that is used to populate the digital twin.

In embodiments, provided herein is a digital twin system that displays a set of options for distribution of decision-making authority or control across various systems, systems-of-systems or components across a set of entities and workflows. This may be implemented at the level of an individual component or system, such as by allowing a user to configure, within the digital twin, the conditions under which a human (or group of humans, a combined system (human and AI co-pilot, for example), or an AI system alone will be designated as the authority for making a decision. This can include permanent settings (“never” or “always”), semi-permanent settings (e.g., ones that are reviewed on a systematic or episodic basis) and dynamic settings (i.e., where contextual conditions, environmental conditions, or other factors are processed in real time to determine what set of entities will be designed at the decision-making authority). In embodiments, decision making authority may be distributed within the digital twin based on a broader decision making framework, such as a hierarchical framework (such as an enterprise hierarchy in which individual workers are organized into groups, with lines of reporting and supervision), a rules-based framework (such as a set of voting rules by which disputes about a decision are resolved), a collaborative framework (such as where prospective alternatives are presented and discussed by a set of contributors seeking a consensus recommendation, optionally involving simulations and planning capabilities noted above), a simulation framework (where, as noted above, the digital twin can simulate outcomes based on historical and real-time data), an enterprise planning framework (which may include integration of the digital twin with enterprise planning systems and dashboard), a competitive framework (such as where alternative options are configured to compete with each other to determine which is superior, optionally involving genetic programming or other evolutionary computing systems, as noted elsewhere in this disclosure), a peer-to-peer framework (e.g., where decisions are negotiated bi-laterally or multi-laterally among entities involved); an algorithmic framework (such as where decisions are reached by a defined set of stages, possibly involving various other frameworks as hybrids in parallel, in series, in iterative loops, or the like), a principles-based framework (such as where a set of personal, group, or enterprise principles (e.g., ethical principles, values, mission statements, or the like) are codified for use when certain contextual decisions are presented), or others. As an example, many daily operational decisions might be configured to be executed autonomously by AI systems, but if those decisions are determined to have an aggregate impact on an element of the mission of an enterprise (such as a mission to continue to develop and employ a set of individuals), then the digital twin can highlight the need to bring an appropriate set of human decision makers into the loop. Thus, in embodiments, provided herein is a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework.

In embodiments, a digital twin may display various metrics to facilitate decisions about what sets and configurations of human and AI systems should be selected for a given system, system-of-systems, component, or the like. These metrics may be calculated using the data available to the digital twin through its processing functions (such as real time information about the user, available human workers, resource availability for AI systems, contextual and environmental information, information about states and activities of the entities involved in various workflows and the like) as well as by using external data sources, such as data indicating performance metrics for individuals (which may include the general population or domain experts, groups (which may include expert groups, crowds (including by crowdsourcing as disclosed elsewhere herein)) or for AI systems (including how the systems perform under various resource conditions). Metrics may include indicators of training history, such as educational experience, work experience, and job reviews, among many others, for humans. Metrics may include training data or metadata for artificial intelligence systems, including the size of the training data set, the vintage of the training data set, the configuration of neural networks used in training, the presence or absence of synthetic data in the training data set, metrics indicating the quality of the training data set (including indicators of bias, autocorrelation, heteroskedasticity or other statistical or econometric indicators), metrics about the expertise or capabilities of the human beings used to seed and/or supervise the AI systems, and many others. As an example, two similar generative AI systems may be presented along with indicators of the time period over which they were trained, allowing a user to evaluate whether the AI systems are likely to miss important context (e.g., where training data from a time period outside one of the sets is likely to have a major influence on the outcome) or generate hallucinations (such as where a spike in unusual training data during a training period may have unduly swayed results). Thus, in embodiments, provided herein is a digital twin system that displays a set of training metrics for a set of humans that are available to perform a set of decision-making tasks for a set of entities presented in the digital twin. Also provided herein, in embodiments, is a digital twin system that displays a set of training metrics for a set of hybrid human-AI systems that are available to perform a set of decision-making tasks for a set of entities presented in the digital twin. Also provided herein, in embodiments, is a digital twin system that displays a set of training metrics for a set of AI systems that are available to perform a set of decision-making tasks for a set of entities presented in the digital twin.

In embodiments, metrics provided within the digital twin may include performance metrics for one or more sets of human and AI entities. Human performance metrics may include metrics for individuals, experts, and groups (including crowds) of the many types, and collected by the many methods and systems, disclosed herein and in the documents incorporated by reference. For individuals, these may include various cognitive, neurometric, psychometric, emotional, attention and other metrics, including ones disclosed herein and in the documents incorporated herein, including collected by neuro-metric measurement systems (e.g., EEG, fMRI and other scanning systems), genomic and transportomics systems, psychometric testing, physiological monitoring systems (including wearable sensors, cameras, IoT systems and many others as disclosed throughout this disclosure), systems for detecting emotional state (e.g., anxiety, distress, anger, calm and others, and others), systems for measuring attention, and others. Human performance metrics may also include metrics of task performance, including quality metrics, output metrics, job assessment metrics, indicators of specific skills, expertise or competencies (e.g., educational credentials, publications and certifications), indicators of success (e.g., rates of return of a business led by the individual) and many others. Human metrics can include metrics for groups, including crowds; for example, outcome metrics from a crowdsourcing system that accumulates the “wisdom of the crowd” for a set of predictions, ideas, solutions, or the like can be compared to those of individual experts and those of various AI systems (including standalone systems and human-AI combinations). AI performance metrics may include a wide range of metrics, including metrics of predictive accuracy, metrics indicating outcomes from use of the systems (including those accounting for context of use), metrics of computational speed and latency, metrics of resource utilization (e.g., computation, energy, network resources, and the like), and many others. In embodiments, the digital twin may present comparative metrics across human, human-AI combinations and autonomous AI systems (including multiple options for each), so that a user of the digital twin can select, accounting for context of use, an appropriate configuration. Thus, provided herein, in embodiments, is a digital twin system that displays a set of performance metrics for a set of humans that are available to perform a set of decision-making tasks for a set of entities presented in the digital twin. Also provided herein, in embodiments, is a digital twin system that displays a set of performance metrics for a set of hybrid human-AI systems that are available to perform a set of decision-making tasks for a set of entities presented in the digital twin. Also provided herein, in embodiments, is a digital twin system that displays a set of performance metrics for a set of AI systems that are available to perform a set of decision-making tasks for a set of entities presented in the digital twin. Also provided herein, in embodiments, is a digital twin system that displays a set of comparative performance metrics among one or more of a set of individual humans, a human-led enterprise, a crowd of humans, a human-AI combination system, or a set of AI systems that are available to perform a set of decision-making tasks for a set of entities presented in the digital twin.

It should be noted that an intelligent agent (referred to in some cases herein as an opportunity miner) can be used to discover sets of available sets of humans, human-AI combinations, and/or artificial intelligence systems that may be capable of improving outcomes of one or more systems, systems-of-systems or other entities represented in the digital twin. In embodiments, a user of a digital twin may configure a set of intelligent agents to undertake discovery based on prioritization by the user, such as where a user flags elements of an enterprise workflow that are perceived (or determined by metrics) to be most in need of improvement, or most likely to benefit from artificial intelligence. Thus, a digital twin system may be used as a tool for exploration of applications of artificial intelligence as well as for configuring decisions around deployment of artificial intelligence once discovered. Thus, provided herein is an intelligent agent that automatically discovers sets of available systems, among human systems, combined human-AI systems and standalone artificial intelligence systems that are capable of performing a desired function. Also provided herein is a digital twin system having an embedded intelligent agent system that automatically discovers sets of available systems, among human systems, combined human-AI systems and standalone artificial intelligence systems that are capable of performing a desired function.

In embodiments, a user of a digital twin may configure a set of intelligent agents to undertake discovery based on prioritization by the user, such as where a user flags elements of an enterprise workflow that are perceived (or determined by metrics) to be most in need of improvement, or most likely to benefit from artificial intelligence.

In embodiments, an artificial intelligence system may be trained, such as based on a set of human decisions, a set of outcomes, or the like, and used to configure (or recommend configuration of) deployment of one or more appropriate sets of human, human-AI combinations and autonomous AI systems. This deployment configuration system for artificial intelligence may be integrated or embedded as an enabling service or utility within a digital twin, or it may be a standalone system used to determine what options are to be presented to a user of a digital twin. Thus, provided herein is an intelligent agent that operates as a deployment configuration system to at least one of recommend a set of deployment configuration parameters for or automatically configure a set of deployment parameters for a set of human, human-AI combinations or autonomous AI systems. Also provided herein is a digital twin system having an integrated intelligent agent that operates as a deployment configuration system to at least one of recommend a set of deployment configuration parameters for or automatically configure a set of deployment parameters for a set of human, human-AI combinations or autonomous AI systems.

In embodiments, the various discovery and configuration systems noted above may be based on general metrics of performance (e.g., comparing how humans in general perform relative to artificial intelligence systems at performing particular tasks). In other embodiments, the comparison may be highly contextual and situational, such as comparing the capabilities of specific sets of individuals that will be available at the time of decision making and the capabilities of artificial intelligence systems that will be available, either to operate as standalone systems or to work in human-AI combinations (including the general performance capabilities of the AI systems, and also the available computational, networking, energy and other resources that will be needed to run them). Situational comparison can include contextual factors, such as time of day, workforce availability, market and environmental data, and many others, such that a discovery or configuration system can recommend an appropriate configuration for a particular system, at a given place and time. For example, a moderately expensive AI system that performs well autonomously may be recommended or selected for an overnight control task, where human experts are not likely to be available and where computational, energy, or other resources are less constrained (and less expensive). An intelligent agent, as noted above, may be configured to generate a recommendation, or a configuration, based on multi-factor optimization, using various decision frameworks noted above, including being trained on a set of human decisions and/or on feedback of outcomes from past configuration actions.

Thus, provided herein is an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed.

In embodiments, as noted throughout this disclosure, smart contracts can be integrated with one or more systems of a digital twin, such that they operate on input data (e.g., detection of various events) and produce outputs that reflect transactional terms embedded in the smart contract. This may include, for example, a set of smart contracts that set liability terms relating to the consequences of the outputs of a system to which the smart contract relates. For example, a smart contract may be configured such that the provider of an AI system embedded in the digital twin (or in a system to which the digital twin has access) agrees to provide indemnification, proof of insurance, acceptance of liability, or the like for some set of consequences of using the AI system. Such terms can also include various limitations (e.g., constraints on permitted use; limitations of liability), exclusions, restrictions, and the like, thus providing, in the digital twin, a mechanism for expressly allocating the consequences of selection of a particular mix of human and AI systems to the appropriate person or organization. By referencing the performance metrics noted above, operating in real time on operational and other data, a decision maker can be aided to make a rational decision about implementation of AI, guided by a more reliable estimation of the expected value of implementing a particular mix of human and AI systems, rather than being governed by emotional factors. Thus, provided herein are methods and systems having a smart contract system embedded in a digital twin that sets terms and conditions for liability resulting from the output of a system that is displayed in the digital twin. The system displayed in the digital twin may be an artificial intelligence system.

As good decisions made within a digital twin environment or other decision-making platform lead to better outcomes, trust in the reliability of machine recommendations increases, which can be tested and validated by outcome metrics. Individuals, groups and enterprises can gradually migrate decision making from centralized authority to the operating environment and from human action through various degrees of supervision to autonomy, with appropriate checks and balances at all stages (automated governance), reversing direction when the situation calls for it. Over time as trust builds in the capabilities of artificial intelligence, or human-AI combinations, to outperform humans alone, an enterprise can increasingly close loops among information technology, operations technology, and artificial intelligence technologies, enabling low-latency, highly efficient, well governed autonomous response to changing conditions at the operational level. Operators that don't ultimately close the loop will be slower than their competitors to respond to changing conditions, less efficient in their operations, and less effective in their decision making.

Individuals, groups and enterprises can unlock great benefits by properly distributing decision making and control where and when it is most effective throughout an enterprise, enabled by the integrated stack of technologies that enable a digital twin, each enhanced by artificial intelligence as described throughout this disclosure and the documents incorporated by reference herein. The true power of the convergence of information technology and operations technology (IT/OT convergence) can be realized when decision making is optimally distributed across humans and machines, an outcome that is achieved by progressively building trust in intelligence technologies and the people who supervise them. Organizations that progress more rapidly to a more optimal state will have significant competitive advantages in operational efficiency (particularly through closed loop automation) and agility to respond to shifting market and competitive dynamics.

In embodiments, various embodiments of digital twins, intelligent agents for discovery and configuration, decision making frameworks and other methods and systems disclosed herein may be used to facilitate configuration and allocation of decision making across the various resources, entities, activities, operations, transactions, offerings and workflows involved in various vehicle and transportation environments, including software-defined vehicles, that comprise the value chain networks described throughout this disclosure and the documents incorporated by reference herein.

### Trust and Distributing Decisions in Digital Twins

Throughout this disclosure and the documents incorporated by reference herein, various embodiments are provided of digital twin platforms and systems that leverage sensors and other information sources, robust connectivity, and intelligence systems to allow users to experience accurate representations of the states and activities of the many entities that are involved in the workflows of an individual, group or enterprise (e.g., a company, business unit, department, government, household, non-profit, or other enterprise). These include, among others, role-based digital twins that can be configured, or that self-configure, how data is collected, stored, processed and/or presented in ways that account for the roles of respective users (e.g., ones directed to financial users, strategic users, operational users, many others). Digital twins also include adaptive digital twins that leverage intelligence systems, such as artificial intelligence, analytic systems, expert systems, or hybrids involving various permutations and combinations thereof, to adapt how data is collected, stored, processed and/or presented based on context, such as based on the content of the information that is collected and processed. Among these adaptive digital twins, a subset, AI-driven digital twins, may use component artificial intelligence systems at any of the stages of the pipeline of information from a sensor or other basic information source to the presentation of content to a user. Artificial intelligence systems can provide outputs along a spectrum of autonomy, including: a) presenting reports, alerts, classifications, predictions, recommendations, analyses and other outputs for human review and action; b) undertaking human-supervised control of one or more aspects of a workflow, where the artificial intelligence system (acting as a co-pilot, assistant, intelligent agent, or the like to a human user) outputs a prediction and/or a recommendation for an action (which may be embodied in an instruction that can be processed by a system), and a human confirms, or adjusts, the nature of the action before it is implemented; and c) undertaking autonomous control of one or more systems or subsystems, where the artificial intelligence processes relevant information, completes necessary classifications, predictions and other decision-making steps (including where applicable, confirming risk management, governance, self-reflection or other steps) and triggers an action (such as by providing an instruction, control signal, or the like) to a system or component.

Along this spectrum from basic reporting to full autonomy, there is a varying extent to which there is a human being in the decision-making loop. Artificial intelligence systems have enormous promise to automate individual, group and enterprise workflows, providing more reliable, seamless monitoring of ongoing activities, faster response times to unexpected events, and more efficient execution of many types of tasks, among many other benefits. However, the extent to which AI systems can be trusted can vary widely, such as based on: a) the stakes involved (e.g., are there risks to human life, health or property in making a wrong decision?); b) how the AI system was trained (e.g., are there reasons to believe that there is bias in the training data that will be carried forward into the outputs of the AI system); c) how the AI system is governed or supervised (e.g., is in compliance with regulatory, legal or other governance frameworks embedded in the workloads of the system as contemplated in this disclosure and the documents incorporated by reference herein, or is there a need for separate governance or supervision?); d) how the AI system performs, in absolute terms and relative to other available systems, including other AI systems, analytic systems, or human beings (experts, other individuals, groups, or crowds, for example); e) the quality, type and/or availability of data (which can include factoring in the cost of the data); f) the quality, type and/or availability of connectivity (which can include factoring in the cost of the connectivity); g) the quality, type and/or availability of computational resources (which can include factoring in the cost of the computational resources); h) the quality, type and/or availability of other necessary resources (e.g., energy); i) environmental or contextual parameters of the workflow to which the AI system will be applied (such as the complexity of a physical environment, the presence of human beings in proximity, or the like); and other factors. As an example among many, a well-trained AI system may be highly capable of driving a vehicle down a highway during daylight, doing so more safely than a human being who could be prone to sleepiness or distraction, but if computational, networking, or other resources are uncertain, it may be decided that the AI system should not be trusted to perform the task. Decisions about the extent to which one can trust an artificial intelligence system can be very difficult, and the extent of trust is a major factor in determining whether or not AI systems, and their many benefits, can be unlocked.

A major benefit of the various digital twin systems disclosed herein is that a digital twin platform, particularly one that is adaptive and self-configuring, can provide an ideal environment for decision making. Good decisions usually need a combination of a) fresh, accurate, relevant information; b) application of some degree of expertise; c) use of judgment to consider tradeoffs of risks; and/or d) leadership to cause implementation (which may encompass, among other things, taking on the consequences when outcomes are unfavorable). Each of these attributes can be supported by the data collection, storage and processing systems, connectivity systems, computational systems and intelligence systems described throughout this disclosure and the documents incorporated by reference herein. For example, a pipeline of IoT and edge devices and high QoS networks (adaptive networking) can pass granular, real-time sensor data about all entities in an operating environment (machines, components, humans, infrastructure, etc.), which manifests in visibility, such as for big data analytics and consulting use cases, as well as data for machine learning. Data architectures (e.g., adaptive sensing and data collection; edge query language; intelligent data storage and processing layers) and advanced computational architectures (hybrid cloud, edge, and quantum computing) can be used to optimize conditions for application of human and machine intelligence. For example, data architectures can adapt visual representations for human cognitive processing (including based on the skillset, role, experience, expertise, or cognitive parameters of a human, such measured by neurometrics, psychometrics, or other systems) and/or prepare and stage data for artificial intelligence systems (including by cleansing, deduplication, generation of synthetic data, entity resolution, normalization and other processing, generation of various embeddings that use one AI system (e.g., a trained neural network) to transform and/or compressed input data into outputs that are suitable for efficient processing by AI systems, and the like). Computational architectures can be adapted to use an appropriate mix of cloud, edge and on-device processing systems (including various chipsets described herein, such as AI chipsets and hybrid chipsets involving AI and other functions integrated together). This can include quantum computing where beneficial. Systems integration, including various configurations of systems, systems-of-systems and the like into platform and infrastructure solutions (including PaaS and IaaS configurations), with various architectures, including service-oriented architectures, microservices architectures, and the like, can integrate all relevant systems across an individual's or group's set of activities, an enterprise, or an entire business ecosystem, such that a digital twin can have access to current state and activity parameters for many relevant entities. Data and sensor fusion, such as involving sensor data and many other data sets can assist in tracking or predicting outcomes (environmental data, market data, transaction data and many others). Advanced artificial intelligence techniques can combine with human insight to generate expert systems and models that understand and predict operational states, flows and more complex behaviors reflected in data (big data analytics and advanced artificial intelligence techniques), including compact models that are capable of operating effectively on sparse data and/or constrained computational architectures at the edge, as well as generative AI outputs that provide summaries, creative content, instructions, reports, and many other outputs from various inputs, including text, image, video, audio and multi-modal generative AI systems. AI-driven stakeholder interfaces can adaptively filter, prioritize, and distribute information for planning, simulation, decision making and operational action to appropriate stakeholders across an entire enterprise.

With the above stack of integrated systems, taking the form of the many embodiments disclosed herein and in the document incorporated herein by reference, distribution of control, of the various disparate systems, systems-of-systems, components, platforms, infrastructure elements, and other entities involved in the activities of an individual, group, or various levels and roles of enterprise can be enabled, with consideration being given, as noted above, to factors such as latency, security, safety, operational efficiency, reliability and trust.

The untapped power of the digital twin is its ability to enable collaboration, and to distribute decision making, to the right mix of human beings, artificial intelligence systems and other systems, whether in an enterprise or in the activities of an individual or group. The digital twin allows incremental change, experimentation, and easily reversible implementation, removing fear of closing the loop. For example, a digital twin can include a simulation environment that simulates, based on actual historical and current data, what outcomes most likely ensue from deployment of particular configurations of human and artificial intelligence elements in decision making and control loops. The digital twin can also provide a planning environment for deployment of artificial intelligence systems, as well as the data collection, data processing, networking, connectivity, energy, and computational systems and architectures that support them; for example, an enterprise can, using the digital twin, plan various scenarios for obtaining resources to enable more powerful AI systems, comparing projected outcomes at various resource levels and mixes. The digital twin can enable graceful migration among humans, human-AI mixes (e.g., with agents and co-pilots) and autonomous AI systems, including deploying them in ways that can be rapidly adjusted, or reversed, such as based on changing performance capabilities, contextual and environmental factors, and events; for example, an AI system might be permitted to control transactions during normal daily operations, but it could be removed from the loop, or provided with greater human supervision, in the case of major shifts in an environment, such as during severe swings in the market, after an environmental catastrophe, or the like. Thus, provided herein is a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity. Also provided herein is a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations. The resources may include ones for data collection, data processing, networking, connectivity, energy, and computational systems and architectures that support them.

As noted throughout this disclosure and the documents incorporated by reference herein disclose the training of machine learning systems in various configurations, including deep learning, supervised learning, semi-supervised learning, and the like. In many such embodiments, a human expert provides input data that is used to train the AI system, such as by tagging data sets to assist in AI classification systems; by producing code, text, images, audio, video and other inputs that are used to train generative AI systems to predict a set of outputs from a prompt; by undertaking activities and behaviors that indicate preferences to train AI systems to generate recommendations; by configuring systems, platforms and architectures that can be used to train AI systems to generate similar configurations and recommendations; by undertaking decisions in various contexts and environments that are used to train AI systems to produce recommendations, make decisions and/or output control signals in similar contexts and environments, among others. In embodiments, any of the machine learning systems or other artificial intelligence systems disclosed herein or in the documents incorporated by reference herein may be embedded in a digital twin for the purpose of enabling training of the digital twin. This may include designating a set of users (such as domain experts, managers, operational supervisors, executives, or the like) as trainers for the AI system, including based on the role, core competency, expertise, experience, or other aspects of the set of users. In embodiments, this may include designating one set of users to provide input data for initial training of a particular AI system and another set of users (possibly overlapping in part with the first set) to supervise the outputs of the AI system. Thus, disclosed herein is a digital twin system with an interface system for designating a set of users as trainers for the creation of an artificial intelligence system that is represented in the digital twin, wherein the artificial intelligence system operates on the data that is used to populate the digital twin. Also disclosed herein is a digital twin system with an interface system for designating a set of users as supervisors for an artificial intelligence system that is represented in the digital twin, wherein the artificial intelligence system operates on the data that is used to populate the digital twin.

In embodiments, provided herein is a digital twin system that displays a set of options for distribution of decision making authority or control across various systems, systems-of-systems or components across a set of entities and workflows. This may be implemented at the level of an individual component or system, such as by allowing a user to configure, within the digital twin, the conditions under which a human (or group of humans, a combined system (human and AI co-pilot, for example), or an AI system alone will be designated as the authority for making a decision. This can include permanent settings (“never” or “always”), semi-permanent settings (e.g., ones that are reviewed on a systematic or episodic basis) and dynamic settings (i.e., where contextual conditions, environmental conditions, or other factors are processed in real time to determine what set of entities will be designed at the decision making authority). In embodiments, decision making authority may be distributed within the digital twin based on a broader decision making framework, such as a hierarchical framework (such as an enterprise hierarchy in which individual workers are organized into groups, with lines of reporting and supervision), a rules-based framework (such as a set of voting rules by which disputes about a decision are resolved), a collaborative framework (such as where prospective alternatives are presented and discussed by a set of contributors seeking a consensus recommendation, optionally involving simulations and planning capabilities noted above), a simulation framework (where, as noted above, the digital twin can simulate outcomes based on historical and real-time data), an enterprise planning framework (which may include integration of the digital twin with enterprise planning systems and dashboard), a competitive framework (such as where alternative options are configured to compete with each other to determine which is superior, optionally involving genetic programming or other evolutionary computing systems, as noted elsewhere in this disclosure), a peer-to-peer framework (e.g., where decisions are negotiated bi-laterally or multi-laterally among entities involved); an algorithmic framework (such as where decisions are reached by a defined set of stages, possibly involving various other frameworks as hybrids in parallel, in series, in iterative loops, or the like), a principles-based framework (such as where a set of personal, group, or enterprise principles (e.g., ethical principles, values, mission statements, or the like) are codified for use when certain contextual decisions are presented), or others. As an example, many daily operational decisions might be configured to be executed autonomously by AI systems, but if those decisions are determined to have an aggregate impact on an element of the mission of an enterprise (such as a mission to continue to develop and employ a set of individuals), then the digital twin can highlight the need to bring an appropriate set of human decision makers into the loop. Thus, in embodiments, provided herein is a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework.

In embodiments, a digital twin may display various metrics to facilitate decisions about what sets and configurations of human and AI systems should be selected for a given system, system-of-systems, component, or the like. These metrics may be calculated using the data available to the digital twin through its processing functions (such as real time information about the user, available human workers, resource availability for AI systems, contextual and environmental information, information about states and activities of the entities involved in various workflows and the like) as well as by using external data sources, such as data indicating performance metrics for individuals (which may include the general population or domain experts, groups (which may include expert groups, crowds (including by crowdsourcing as disclosed elsewhere herein)) or for AI systems (including how the systems perform under various resource conditions). Metrics may include indicators of training history, such as educational experience, work experience, and job reviews, among many others, for humans. Metrics may include training data or metadata for artificial intelligence systems, including the size of the training data set, the vintage of the training data set, the configuration of neural networks used in training, the presence or absence of synthetic data in the training data set, metrics indicating the quality of the training data set (including indicators of bias, autocorrelation, heteroskedasticity or other statistical or econometric indicators), metrics about the expertise or capabilities of the human beings used to seed and/or supervise the AI systems, and many others. As an example, two similar generative AI systems may be presented along with indicators of the time period over which they were trained, allowing a user to evaluate whether the AI systems are likely to miss important context (e.g., where training data from a time period outside one of the sets is likely to have a major influence on the outcome) or generate hallucinations (such as where a spike in unusual training data during a training period may have unduly swayed results). Thus, in embodiments, provided herein is a digital twin system that displays a set of training metrics for a set of humans that are available to perform a set of decision making tasks for a set of entities presented in the digital twin. Also provided herein, in embodiments, is a digital twin system that displays a set of training metrics for a set of hybrid human-AI systems that are available to perform a set of decision making tasks for a set of entities presented in the digital twin. Also provided herein, in embodiments, is a digital twin system that displays a set of training metrics for a set of AI systems that are available to perform a set of decision making tasks for a set of entities presented in the digital twin.

In embodiments, metrics provided within the digital twin may include performance metrics for one or more sets of human and AI entities. Human performance metrics may include metrics for individuals, experts, and groups (including crowds) of the many types, and collected by the many methods and systems, disclosed herein and in the documents incorporated by reference. For individuals, these may include various cognitive, neurometric, psychometric, emotional, attention and other metrics, including ones disclosed herein and in the documents incorporated herein, including collected by neuro-metric measurement systems (e.g., EEG, fMRI and other scanning systems), genomic and transportomics systems, psychometric testing, physiological monitoring systems (including wearable sensors, cameras, IoT systems and many others as disclosed throughout this disclosure), systems for detecting emotional state (e.g., anxiety, distress, anger, calm and others, and others), systems for measuring attention, and others. Human performance metrics may also include metrics of task performance, including quality metrics, output metrics, job assessment metrics, indicators of specific skills, expertise or competencies (e.g., educational credentials, publications and certifications), indicators of success (e.g., rates of return of a business led by the individual) and many others. Human metrics can include metrics for groups, including crowds; for example, outcome metrics from a crowdsourcing system that accumulates the “wisdom of the crowd” for a set of predictions, ideas, solutions, or the like can be compared to those of individual experts and those of various AI systems (including standalone systems and human-AI combinations). AI performance metrics may include a wide range of metrics, including metrics of predictive accuracy, metrics indicating outcomes from use of the systems (including ones accounting for context of use), metrics of computational speed and latency, metrics of resource utilization (e.g., computation, energy, network resources, and the like), and many others. In embodiments, the digital twin may present comparative metrics across human, human-AI combinations and autonomous AI systems (including multiple options for each), so that a user of the digital twin can select, accounting for context of use, an appropriate configuration. Thus, provided herein, in embodiments, is a digital twin system that displays a set of performance metrics for a set of humans that are available to perform a set of decision making tasks for a set of entities presented in the digital twin. Also provided herein, in embodiments, is a digital twin system that displays a set of performance metrics for a set of hybrid human-AI systems that are available to perform a set of decision making tasks for a set of entities presented in the digital twin. Also provided herein, in embodiments, is a digital twin system that displays a set of performance metrics for a set of AI systems that are available to perform a set of decision making tasks for a set of entities presented in the digital twin. Also provided herein, in embodiments, is a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin.

It should be noted that an intelligent agent (referred to in some cases herein as an opportunity miner) can be used to discover sets of available sets of humans, human-AI combinations, and/or artificial intelligence systems that may be capable of improving outcomes of one or more systems, systems-of-systems or other entities represented in the digital twin. In embodiments, a user of a digital twin may configure a set of intelligent agents to undertake discovery based on prioritization by the user, such as where a user flags elements of an enterprise workflow that are perceived (or determined by metrics) to be most in need of improvement, or most likely to benefit from artificial intelligence. Thus, a digital twin system may be used as a tool for exploration of applications of artificial intelligence as well as for configuring decisions around deployment of artificial intelligence once discovered. Thus, provided herein is an intelligent agent that automatically discovers sets of available systems, among human systems, combined human-AI systems and standalone artificial intelligence systems that are capable of performing a desired function. Also provided herein is a digital twin system having an embedded intelligent agent system that automatically discovers sets of available systems, among human systems, combined human-AI systems and standalone artificial intelligence systems that are capable of performing a desired function.

In embodiments, a user of a digital twin may configure a set of intelligent agents to undertake discovery based on prioritization by the user, such as where a user flags elements of an enterprise workflow that are perceived (or determined by metrics) to be most in need of improvement, or most likely to benefit from artificial intelligence.

In embodiments, an artificial intelligence system may be trained, such as based on a set of human decisions, a set of outcomes, or the like, and used to configure (or recommend configuration of) deployment of one or more appropriate sets of human, human-AI combinations and autonomous AI systems. This deployment configuration system for artificial intelligence may be integrated or embedded as an enabling service or utility within a digital twin, or it may be a standalone system used to determine what options are to be presented to a user of a digital twin. Thus, provided herein is an intelligent agent that operates as a deployment configuration system to at least one of recommend a set of deployment configuration parameters for or automatically configure a set of deployment parameters for a set of human, human-AI combinations or autonomous AI systems. Also provided herein is a digital twin system having an integrated intelligent agent that operates as a deployment configuration system to at least one of recommend a set of deployment configuration parameters for or automatically configure a set of deployment parameters for a set of human, human-AI combinations or autonomous AI systems.

In embodiments, the various discovery and configuration systems noted above may be based on general metrics of performance (e.g., comparing how humans in general perform relative to artificial intelligence systems at performing particular tasks). In other embodiments, the comparison may be highly contextual and situational, such as comparing the capabilities of specific sets of individuals that will be available at the time of decision making and the capabilities of artificial intelligence systems that will be available, either to operate as standalone systems or to work in human-AI combinations (including the general performance capabilities of the AI systems, and also the available computational, networking, energy and other resources that will be needed to run them). Situational comparison can include contextual factors, such as time of day, workforce availability, market and environmental data, and many others, such that a discovery or configuration system can recommend an appropriate configuration for a particular system, at a given place and time. For example, a moderately expensive AI system that performs well autonomously may be recommended or selected for an overnight control task, where human experts are not likely to be available and where computational, energy, or other resources are less constrained (and less expensive). An intelligent agent, as noted above, may be configured to generate a recommendation, or a configuration, based on multi-factor optimization, using various decision frameworks noted above, including being trained on a set of human decisions and/or on feedback of outcomes from past configuration actions.

Thus, provided herein is an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed.

In embodiments, as noted throughout this disclosure, smart contracts can be integrated with one or more systems of a digital twin, such that they operate on input data (e.g., detection of various events) and produce outputs that reflect transactional terms embedded in the smart contract. This may include, for example, a set of smart contracts that set liability terms relating to the consequences of the outputs of a system to which the smart contract relates. For example, a smart contract may be configured such that the provider of an AI system embedded in the digital twin (or in a system to which the digital twin has access) agrees to provide indemnification, proof of insurance, acceptance of liability, or the like for some set of consequences of using the AI system. Such terms can also include various limitations (e.g., constraints on permitted use; limitations of liability), exclusions, restrictions, and the like, thus providing, in the digital twin, a mechanism for expressly allocating the consequences of selection of a particular mix of human and AI systems to the appropriate person or organization. By referencing the performance metrics noted above, operating in real time on operational and other data, a decision maker can be aided to make a rational decision about implementation of AI, guided by a more reliable estimation of the expected value of implementing a particular mix of human and AI systems, rather than being governed by emotional factors. Thus, provided herein are methods and systems having a smart contract system embedded in a digital twin that sets terms and conditions for liability resulting from the output of a system that is displayed in the digital twin. The system displayed in the digital twin may be an artificial intelligence system.

As good decisions made within a digital twin environment or other decision making platform lead to better outcomes, trust in the reliability of machine recommendations increases, which can be tested and validated by outcome metrics. Individuals, groups and enterprises can gradually migrate decision making from centralized authority to the operating environment and from human action through various degrees of supervision to autonomy, with appropriate checks and balances at all stages (automated governance), reversing direction when the situation calls for it. Over time as trust builds in the capabilities of artificial intelligence, or human-AI combinations, to outperform humans alone, an enterprise can increasingly close loops among information technology, operations technology, and artificial intelligence technologies, enabling low-latency, highly efficient, well governed autonomous response to changing conditions at the operational level. Operators that don't ultimately close the loop will be slower than their competitors to respond to changing conditions, less efficient in their operations, and less effective in their decision making.

Individuals, groups and enterprises can unlock great benefits by properly distributing decision making and control where and when it is most effective throughout an enterprise, enabled by the integrated stack of technologies that enable a digital twin, each enhanced by artificial intelligence as described throughout this disclosure and the documents incorporated by reference herein. The true power of the convergence of information technology and operations technology (IT/OT convergence) can be realized when decision making is optimally distributed across humans and machines, an outcome that is achieved by progressively building trust in intelligence technologies and the people who supervise them. Organizations that progress more rapidly to a more optimal state will have significant competitive advantages in operational efficiency (particularly through closed loop automation) and agility to respond to shifting market and competitive dynamics.

In embodiments, various embodiments of digital twins, intelligent agents for discovery and configuration, decision making frameworks and other methods and systems disclosed herein may be used to facilitate configuration and allocation of decision making across the various resources, entities, activities, operations, transactions, offerings and workflows involved in various vehicle and transportation environments, including software-defined vehicles, that comprise the value chain networks described throughout this disclosure and the documents incorporated by reference herein.

In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system with an interface system for designating a set of users as trainers for the creation of an artificial intelligence system that is represented in the digital twin, wherein the artificial intelligence system operates on the data that is used to populate the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system with an interface system for designating a set of users as supervisors for an artificial intelligence system that is represented in the digital twin, wherein the artificial intelligence system operates on the data that is used to populate the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of options for distribution of decision making authority or control across various systems, systems-of-systems or components across a set of entities and workflows. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of training metrics for a set of humans that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of training metrics for a set of hybrid human-AI systems that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of training metrics for a set of AI systems that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of performance metrics for a set of humans that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of performance metrics for a set of hybrid human-AI systems that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of performance metrics for a set of AI systems that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and an intelligent agent that automatically discovers sets of available systems, among human systems, combined human-AI systems and standalone artificial intelligence systems that are capable of performing a desired function. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a smart contract system embedded in a digital twin that sets terms and conditions for liability resulting from the output of a system that is displayed in the digital twin.

In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system with an interface system for designating a set of users as trainers for the creation of an artificial intelligence system that is represented in the digital twin, wherein the artificial intelligence system operates on the data that is used to populate the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system with an interface system for designating a set of users as supervisors for an artificial intelligence system that is represented in the digital twin, wherein the artificial intelligence system operates on the data that is used to populate the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of options for distribution of decision making authority or control across various systems, systems-of-systems or components across a set of entities and workflows. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of training metrics for a set of humans that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of training metrics for a set of hybrid human-AI systems that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of training metrics for a set of AI systems that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of performance metrics for a set of humans that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of performance metrics for a set of hybrid human-AI systems that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of performance metrics for a set of AI systems that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and an intelligent agent that automatically discovers sets of available systems, among human systems, combined human-AI systems and standalone artificial intelligence systems that are capable of performing a desired function. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a smart contract system embedded in a digital twin that sets terms and conditions for liability resulting from the output of a system that is displayed in the digital twin.

In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system with an interface system for designating a set of users as supervisors for an artificial intelligence system that is represented in the digital twin, wherein the artificial intelligence system operates on the data that is used to populate the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of options for distribution of decision making authority or control across various systems, systems-of-systems or components across a set of entities and workflows. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of training metrics for a set of humans that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of training metrics for a set of hybrid human-AI systems that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of training metrics for a set of AI systems that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of performance metrics for a set of humans that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of performance metrics for a set of hybrid human-AI systems that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of performance metrics for a set of AI systems that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a smart contract system embedded in a digital twin that sets terms and conditions for liability resulting from the output of a system that is displayed in the digital twin.

In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of options for distribution of decision making authority or control across various systems, systems-of-systems or components across a set of entities and workflows. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of training metrics for a set of humans that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of training metrics for a set of hybrid human-AI systems that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of training metrics for a set of AI systems that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of performance metrics for a set of humans that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of performance metrics for a set of hybrid human-AI systems that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of performance metrics for a set of AI systems that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a smart contract system embedded in a digital twin that sets terms and conditions for liability resulting from the output of a system that is displayed in the digital twin.

In embodiments, provided herein is an AI-based platform having a digital twin system that displays a set of options for distribution of decision making authority or control across various systems, systems-of-systems or components across a set of entities and workflows. In embodiments, provided herein is an AI-based platform having a digital twin system that displays a set of options for distribution of decision making authority or control across various systems, systems-of-systems or components across a set of entities and workflows and a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework. In embodiments, provided herein is an AI-based platform having a digital twin system that displays a set of options for distribution of decision making authority or control across various systems, systems-of-systems or components across a set of entities and workflows and a digital twin system that displays a set of training metrics for a set of humans that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and a digital twin system that displays a set of training metrics for a set of hybrid human-AI systems that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and a digital twin system that displays a set of training metrics for a set of AI systems that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and a digital twin system that displays a set of performance metrics for a set of humans that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and a digital twin system that displays a set of performance metrics for a set of hybrid human-AI systems that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and a digital twin system that displays a set of performance metrics for a set of AI systems that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of options for distribution of decision making authority or control across various systems, systems-of-systems or components across a set of entities and workflows and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of options for distribution of decision making authority or control across various systems, systems-of-systems or components across a set of entities and workflows and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of options for distribution of decision making authority or control across various systems, systems-of-systems or components across a set of entities and workflows and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of options for distribution of decision making authority or control across various systems, systems-of-systems or components across a set of entities and workflows and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of options for distribution of decision making authority or control across various systems, systems-of-systems or components across a set of entities and workflows and a smart contract system embedded in a digital twin that sets terms and conditions for liability resulting from the output of a system that is displayed in the digital twin.

In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of training metrics for a set of humans that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of training metrics for a set of hybrid human-AI systems that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of training metrics for a set of AI systems that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of performance metrics for a set of humans that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of performance metrics for a set of hybrid human-AI systems that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of performance metrics for a set of AI systems that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and an intelligent agent that automatically discovers sets of available systems, among human systems, combined human-AI systems and standalone artificial intelligence systems that are capable of performing a desired function. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a smart contract system embedded in a digital twin that sets terms and conditions for liability resulting from the output of a system that is displayed in the digital twin.

In embodiments, provided herein is an AI-based platform having a digital twin system that displays a set of training metrics for a set of humans that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and a digital twin system that displays a set of training metrics for a set of hybrid human-AI systems that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and a digital twin system that displays a set of training metrics for a set of AI systems that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and a digital twin system that displays a set of performance metrics for a set of humans that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and a digital twin system that displays a set of performance metrics for a set of hybrid human-AI systems that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and a digital twin system that displays a set of performance metrics for a set of AI systems that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of training metrics for a set of humans that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of training metrics for a set of humans that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of training metrics for a set of humans that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of training metrics for a set of humans that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of training metrics for a set of humans that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having a digital twin system that displays a set of training metrics for a set of hybrid human-AI systems that are available to perform a set of decision making tasks for a set of entities presented in the digital twin. In embodiments, provided herein is an AI-based platform having a digital twin system that displays a set of training metrics for a set of hybrid human-AI systems that are available to perform a set of decision making tasks for a set of entities presented in the digital twin and a digital twin system that displays a set of training metrics for a set of AI systems that are available to perform a set of decision making tasks for a set of entities presented in the digital twin. In embodiments, provided herein is an AI-based platform having a digital twin system that displays a set of training metrics for a set of hybrid human-AI systems that are available to perform a set of decision making tasks for a set of entities presented in the digital twin and a digital twin system that displays a set of performance metrics for a set of humans that are available to perform a set of decision making tasks for a set of entities presented in the digital twin. In embodiments, provided herein is an AI-based platform having a digital twin system that displays a set of training metrics for a set of hybrid human-AI systems that are available to perform a set of decision making tasks for a set of entities presented in the digital twin and a digital twin system that displays a set of performance metrics for a set of hybrid human-AI systems that are available to perform a set of decision making tasks for a set of entities presented in the digital twin. In embodiments, provided herein is an AI-based platform having a digital twin system that displays a set of training metrics for a set of hybrid human-AI systems that are available to perform a set of decision making tasks for a set of entities presented in the digital twin and a digital twin system that displays a set of performance metrics for a set of AI systems that are available to perform a set of decision making tasks for a set of entities presented in the digital twin. In embodiments, provided herein is an AI-based platform having a digital twin system that displays a set of training metrics for a set of hybrid human-AI systems that are available to perform a set of decision making tasks for a set of entities presented in the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of training metrics for a set of hybrid human-AI systems that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of training metrics for a set of hybrid human-AI systems that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of training metrics for a set of hybrid human-AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of training metrics for a set of hybrid human-AI systems that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of training metrics for a set of hybrid human-AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of training metrics for a set of hybrid human-AI systems that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having a digital twin system that displays a set of training metrics for a set of AI systems that are available to perform a set of decision making tasks for a set of entities presented in the digital twin. In embodiments, provided herein is an AI-based platform having a digital twin system that displays a set of training metrics for a set of AI systems that are available to perform a set of decision making tasks for a set of entities presented in the digital twin and a digital twin system that displays a set of performance metrics for a set of humans that are available to perform a set of decision making tasks for a set of entities presented in the digital twin. In embodiments, provided herein is an AI-based platform having a digital twin system that displays a set of training metrics for a set of AI systems that are available to perform a set of decision making tasks for a set of entities presented in the digital twin and a digital twin system that displays a set of performance metrics for a set of hybrid human-AI systems that are available to perform a set of decision making tasks for a set of entities presented in the digital twin. In embodiments, provided herein is an AI-based platform having a digital twin system that displays a set of training metrics for a set of AI systems that are available to perform a set of decision making tasks for a set of entities presented in the digital twin and a digital twin system that displays a set of performance metrics for a set of AI systems that are available to perform a set of decision making tasks for a set of entities presented in the digital twin. In embodiments, provided herein is an AI-based platform having a digital twin system that displays a set of training metrics for a set of AI systems that are available to perform a set of decision making tasks for a set of entities presented in the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of training metrics for a set of AI systems that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of training metrics for a set of AI systems that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of training metrics for a set of AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of training metrics for a set of AI systems that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of training metrics for a set of AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of training metrics for a set of AI systems that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having a digital twin system that displays a set of performance metrics for a set of humans that are available to perform a set of decision making tasks for a set of entities presented in the digital twin. In embodiments, provided herein is an AI-based platform having a digital twin system that displays a set of performance metrics for a set of humans that are available to perform a set of decision making tasks for a set of entities presented in the digital twin and a digital twin system that displays a set of performance metrics for a set of hybrid human-AI systems that are available to perform a set of decision making tasks for a set of entities presented in the digital twin. In embodiments, provided herein is an AI-based platform having a digital twin system that displays a set of performance metrics for a set of humans that are available to perform a set of decision making tasks for a set of entities presented in the digital twin and a digital twin system that displays a set of performance metrics for a set of AI systems that are available to perform a set of decision making tasks for a set of entities presented in the digital twin. In embodiments, provided herein is an AI-based platform having a digital twin system that displays a set of performance metrics for a set of humans that are available to perform a set of decision making tasks for a set of entities presented in the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of performance metrics for a set of humans that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of performance metrics for a set of humans that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of performance metrics for a set of humans that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of performance metrics for a set of humans that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of performance metrics for a set of humans that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of performance metrics for a set of humans that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having a digital twin system that displays a set of performance metrics for a set of hybrid human-AI systems that are available to perform a set of decision making tasks for a set of entities presented in the digital twin. In embodiments, provided herein is an AI-based platform having a digital twin system that displays a set of performance metrics for a set of hybrid human-AI systems that are available to perform a set of decision making tasks for a set of entities presented in the digital twin and a digital twin system that displays a set of performance metrics for a set of AI systems that are available to perform a set of decision making tasks for a set of entities presented in the digital twin. In embodiments, provided herein is an AI-based platform having a digital twin system that displays a set of performance metrics for a set of hybrid human-AI systems that are available to perform a set of decision making tasks for a set of entities presented in the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of performance metrics for a set of hybrid human-AI systems that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of performance metrics for a set of hybrid human-AI systems that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of performance metrics for a set of hybrid human-AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of performance metrics for a set of hybrid human-AI systems that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of performance metrics for a set of hybrid human-AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of performance metrics for a set of hybrid human-AI systems that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having a digital twin system that displays a set of performance metrics for a set of AI systems that are available to perform a set of decision making tasks for a set of entities presented in the digital twin. In embodiments, provided herein is an AI-based platform having a digital twin system that displays a set of performance metrics for a set of AI systems that are available to perform a set of decision making tasks for a set of entities presented in the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of performance metrics for a set of AI systems that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of performance metrics for a set of AI systems that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of performance metrics for a set of AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of performance metrics for a set of AI systems that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of performance metrics for a set of AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of performance metrics for a set of AI systems that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having an intelligent agent that automatically discovers sets of available systems, among human systems, combined human-AI systems and standalone artificial intelligence systems that are capable of performing a desired function. In embodiments, provided herein is an AI-based platform having an intelligent agent that automatically discovers sets of available systems, among human systems, combined human-AI systems and standalone artificial intelligence systems that are capable of performing a desired function and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having an intelligent agent that automatically discovers sets of available systems, among human systems, combined human-AI systems and standalone artificial intelligence systems that are capable of performing a desired function and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having an intelligent agent that automatically discovers sets of available systems, among human systems, combined human-AI systems and standalone artificial intelligence systems that are capable of performing a desired function and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having an intelligent agent that automatically discovers sets of available systems, among human systems, combined human-AI systems and standalone artificial intelligence systems that are capable of performing a desired function and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having an intelligent agent that automatically discovers sets of available systems, among human systems, combined human-AI systems and standalone artificial intelligence systems that are capable of performing a desired function and a smart contract system embedded in a digital twin that sets terms and conditions for liability resulting from the output of a system that is displayed in the digital twin.

In embodiments, provided herein is an AI-based platform having a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system having an embedded intelligent agent system that automatically discovers sets of available systems, among human systems, combined human-AI systems and standalone artificial intelligence systems that are capable of performing a desired function, and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system having an embedded intelligent agent system that automatically discovers sets of available systems, among human systems, combined human-AI systems and standalone artificial intelligence systems that are capable of performing a desired function, and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system having an embedded intelligent agent system that automatically discovers sets of available systems, among human systems, combined human-AI systems and standalone artificial intelligence systems that are capable of performing a desired function, and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system having an embedded intelligent agent system that automatically discovers sets of available systems, among human systems, combined human-AI systems and standalone artificial intelligence systems that are capable of performing a desired function, and a smart contract system embedded in a digital twin that sets terms and conditions for liability resulting from the output of a system that is displayed in the digital twin.

In embodiments, provided herein is an AI-based platform having an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having an intelligent agent that operates as a deployment configuration system to at least one of recommend a set of deployment configuration parameters for or automatically configure a set of deployment parameters for a set of human, human-AI combinations or autonomous AI systems and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having an intelligent agent that operates as a deployment configuration system to at least one of recommend a set of deployment configuration parameters for or automatically configure a set of deployment parameters for a set of human, human-AI combinations or autonomous AI systems and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having an intelligent agent that operates as a deployment configuration system to at least one of recommend a set of deployment configuration parameters for or automatically configure a set of deployment parameters for a set of human, human-AI combinations or autonomous AI systems and a smart contract system embedded in a digital twin that sets terms and conditions for liability resulting from the output of a system that is displayed in the digital twin.

In embodiments, provided herein is an AI-based platform having a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system having an integrated intelligent agent that operates as a deployment configuration system to at least one of recommend a set of deployment configuration parameters for or automatically configure a set of deployment parameters for a set of human, human-AI combinations or autonomous AI systems, and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system having an integrated intelligent agent that operates as a deployment configuration system to at least one of recommend a set of deployment configuration parameters for or automatically configure a set of deployment parameters for a set of human, human-AI combinations or autonomous AI systems, and a smart contract system embedded in a digital twin that sets terms and conditions for liability resulting from the output of a system that is displayed in the digital twin.

In embodiments, provided herein is an AI-based platform having an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed and a smart contract system embedded in a digital twin that sets terms and conditions for liability resulting from the output of a system that is displayed in the digital twin.

In embodiments, provided herein is an AI-based platform having a smart contract system embedded in a digital twin that sets terms and conditions for liability resulting from the output of a system that is displayed in the digital twin.

Visual Search within Digital Twin

In embodiments, a visual search engine may be embedded within a digital twin, wherein a user may enter an image-based query (such as by pasting an image, a set of image metadata, or the like, by drawing or otherwise creating the image, or by describing the image with a set of keywords), and the visual search engine will process the query and a set of data structures supporting the digital twin to find a set of potentially matching elements in the digital twin (such as by finding matching image identifying information, matching tags, matching or correlated metadata, or the like, or by finding images having characteristics (such as shape, color, semantic or symbolic meaning, or other attributes) that match or are correlated to the query. In embodiments, matching elements may be listed (such as in a menu bar) and/or highlighted in the visual representation of the digital twin, such as by changes in font, color, brightness, or the like. In one non-limiting example, a user of a digital twin of a building, such as an architect, designer, builder, owner, operator, tenant, visitor, or other users, may enter a picture of a space that is believed to be within the building, containing elements such as fixtures, furnishings, equipment and the like, and the visual search engine may parse the picture, find matching elements in the digital twin of the building, and present one or more options that represent likely location of the space, along with other data or representations of the space, including guidance how to reach the space, additional data on contents, and the like. For example, a visiting maintenance professional may enter a picture of a machine that was captured on an earlier visit by a colleague or by a customer, and the visual search engine may find where the machine is now located in the digital twin and route the professional to the current location. In embodiments, the visual search engine may use artificial intelligence, in one of the many forms described herein or in the documents incorporated by reference, such as to parse queries (in natural language or in image formats); to recognize and classify objects, faces, spaces, and other visual elements, to match or correlate images and image content, text, or the like; to rank results or recommendations, such as based on the likelihood of relevance, including based on past user responses, ratings, utilization, or other measures of feedback; to optimize the presentation of results; and many other elements.

In embodiments, a digital twin of an environment, such as the interior of a home, may be automatically constructed from an arbitrary set of photos that are taken over time, such as snapshots of people, pets, and other subjects contained in the photo library of a consumer, whereby common elements within the photographs are linked by a set of artificial intelligence systems, such as object recognition systems, subsequent to which the comment elements enable a user to orient, resize, and otherwise manipulate image elements to provide a stitched view of the environment. In embodiments, a large training data set may be captured as expert users stitch view of multiple environments, such that a robotic process automation system may be trained to automatically stitch a digital twin of an environment upon receiving an input data set. In embodiments, incremental information may be added to the digital twin, such as additional images as they are captured and other content, such as information from other data sources about the environment, including data about or from IoT devices in the environment, about objects purchased for the environment, about workflows in the environment, about individuals in the environment (such as user behavior data) and the like. In embodiments, image information and other information about the environment may be captured in a blockchain. The blockchain may support a distributed ledger of transactions or events related to the environment. The blockchain may support a smart contract as described elsewhere in this disclosure. The blockchain may be augmented by a set of interfaces, such as for controlling access to the information, such as to enable private portions and public portions. In embodiments, public portions may allow third parties, such as vendors, suppliers, service providers, technology providers and others to obtain sufficient relevant information from the digital twin to meet specific needs of an owner or operator of the environment, or a worker within it, without providing access to the entire set of information contained in the digital twin.

The background description is presented simply for context, and is not necessarily well-understood, routine, or conventional. Further, the background description is not an admission of what does or does not qualify as prior art. In fact, some or all of the background description may be work attributable to the named inventors that is otherwise unknown in the art. Physical (such as spatial and/or electrical) and functional relationships between elements (for example, between modules, circuit elements, semiconductor layers, etc.) are described using various terms. Unless explicitly described as being “direct,” when a relationship between first and second elements is described, that relationship encompasses both (i) a direct relationship where no other intervening elements are present between the first and second elements and (ii) an indirect relationship where one or more intervening elements are present between the first and second elements. Example relationship terms include “adjoining,” “transmitting,” “receiving,” “connected,” “engaged,” “coupled,” “adjacent,” “next to,” “on top of,” “above,” “below,” “abutting,” and “disposed.” The detailed description includes specific examples for illustration only, and not to limit the disclosure or its applicability. The examples are not intended to be an exhaustive list, but instead simply demonstrate possession by the inventors of the full scope of the currently presented and envisioned future claims. Variations, combinations, and equivalents of the examples are within the scope of the disclosure. No language in the specification should be construed as indicating that any non-claimed element is essential or critical to the practice of the disclosure. The term “exemplary” simply means “example” and does not indicate a best or preferred example. The term “set” does not necessarily exclude the empty set—in other words, in some circumstances a “set” may have zero elements. The term “non-empty set” may be used to indicate exclusion of the empty set—that is, a non-empty set must have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements. The phrases “at least one of A, B, and C” and “at least one of A, B, or C” should both be construed to mean a logical (A OR B OR C), using a non-exclusive logical OR, and should not be construed to mean “at least one of A, at least one of B, and at least one of C.” The use of the terms “a,” “an,” “the,” and similar referents in the context of describing the disclosure and claims encompasses both the singular and the plural, unless contradicted explicitly or by context. Unless otherwise specified, the terms “comprising,” “having,” “with,” “including,” and “containing,” and their variants, are open-ended terms, meaning “including, but not limited to.” Each publication referenced in this disclosure, including foreign and domestic patent applications and patents, is hereby incorporated by reference in its entirety. Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of multiple embodiments remain within the scope of this disclosure. One or more elements (for example, steps within a method, instructions, actions, or operations) may be executed in a different order (and/or concurrently) without altering the principles of the present disclosure. Unless technically infeasible, elements described as being in series may be implemented partially or fully in parallel. Similarly, unless technically infeasible, elements described as being in parallel may be implemented partially or fully in series. While the disclosure describes structures corresponding to claimed elements, those elements do not necessarily invoke a means plus function interpretation unless they explicitly use the signifier “means for.”

While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. In the drawings, reference numbers may be reused to identify identical elements or may simply identify elements that implement similar functionality. Numbering or other labeling of instructions or method steps is done for convenient reference, not to indicate a fixed order. In the drawings, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. As just one example, for information sent from element A to element B, element B may send requests and/or acknowledgements to element A. Unless otherwise indicated, recitations of ranges of values are merely intended to serve as a shorthand way of referring individually to each separate value falling within the range, and each separate value is hereby incorporated into the specification as if it were individually recited.

A special-purpose system includes hardware and/or software and may be described in terms of an apparatus, a method, or a computer-readable medium. In various embodiments, functionality may be apportioned differently between software and hardware. For example, some functionality may be implemented by hardware in one embodiment and by software in another embodiment. Further, software may be encoded by hardware structures, and hardware may be defined by software, such as in software-defined networking or software-defined radio. In this application, including the claims, the term module refers to a special-purpose system. The module may be implemented by one or more special-purpose systems. The one or more special-purpose systems may also implement some or all of the other modules. In this application, including the claims, the term module may be replaced with the terms controller or circuit. In this application, including the claims, the term platform refers to one or more modules that offer a set of functions. In this application, including the claims, the term system may be used interchangeably with module or with the term special-purpose system. The special-purpose system may be directed or controlled by an operator. The special-purpose system may be hosted by one or more of assets owned by the operator, assets leased by the operator, and third-party assets. The assets may be referred to as a private, community, or hybrid cloud computing network or cloud computing environment. For example, the special-purpose system may be partially or fully hosted by a third party offering software as a service (SaaS), platform as a service (PaaS), and/or infrastructure as a service (IaaS). The special-purpose system may be implemented using agile development and operations (DevOps) principles. In embodiments, some or all of the special-purpose system may be implemented in a multiple-environment architecture. For example, the multiple environments may include one or more production environments, one or more integration environments, one or more development environments, etc.

A special-purpose system may be partially or fully implemented using or by a mobile device. Examples of mobile devices include navigation devices, cell phones, smart phones, mobile phones, mobile personal digital assistants, palmtops, netbooks, pagers, electronic book readers, tablets, music players, etc. A special-purpose system may be partially or fully implemented using or by a network device. Examples of network devices include switches, routers, firewalls, gateways, hubs, base stations, access points, repeaters, head-ends, user equipment, cell sites, antennas, towers, etc. A special-purpose system may be partially or fully implemented using a computer having a variety of form factors and other characteristics. For example, the computer may be characterized as a personal computer, as a server, etc. The computer may be portable, as in the case of a laptop, netbook, etc. The computer may or may not have any output device, such as a monitor, line printer, liquid crystal display (LCD), light emitting diodes (LEDs), etc. The computer may or may not have any input device, such as a keyboard, mouse, touchpad, trackpad, computer vision system, barcode scanner, button array, etc. The computer may run a general-purpose operating system, such as the WINDOWS operating system from Microsoft Corporation, the MACOS operating system from Apple, Inc., or a variant of the LINUX operating system. Examples of servers include a file server, print server, domain server, internet server, intranet server, cloud server, infrastructure-as-a-service server, platform-as-a-service server, web server, secondary server, host server, distributed server, failover server, and backup server.

The term hardware encompasses components such as processing hardware, storage hardware, networking hardware, and other general-purpose and special-purpose components. Note that these are not mutually-exclusive categories. For example, processing hardware may integrate storage hardware and vice versa. Examples of a component are integrated circuits (ICs), application specific integrated circuit (ASICs), digital circuit elements, analog circuit elements, combinational logic circuits, gate arrays such as field programmable gate arrays (FPGAs), digital signal processors (DSPs), complex programmable logic devices (CPLDs), etc. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an artificial intelligence (AI) system-on-chip, a video processing system-on-chip, an organ-on-chip, a quantum algorithm system-on-chip, etc. The hardware may integrate and/or receive signals from sensors. The sensors may allow observation and measurement of conditions including temperature, pressure, wear, light, humidity, deformation, expansion, contraction, deflection, bending, stress, strain, load-bearing, shrinkage, power, energy, mass, location, temperature, humidity, pressure, viscosity, liquid flow, chemical/gas presence, sound, and air quality. A sensor may include image and/or video capture in visible and/or non-visible (such as thermal) wavelengths, such as a charge-coupled device (CCD) or complementary metal-oxide semiconductor (CMOS) sensor.

Examples of processing hardware include a central processing unit (CPU), a graphics processing unit (GPU), an approximate computing processor, a quantum computing processor, a parallel computing processor, a neural network processor, a signal processor, a digital processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an artificial intelligence (AI) co-processor.

The processor may enable execution of multiple threads. These multiple threads may correspond to different programs. In various embodiments, a single program may be implemented as multiple threads by the programmer or may be decomposed into multiple threads by the processing hardware. The threads may be executed simultaneously to enhance the performance of the processor and to facilitate simultaneous operations of the application. A processor may be implemented as a packaged semiconductor die. The die includes one or more processing cores and may include additional functional blocks, such as cache. In various embodiments, the processor may be implemented by multiple dies, which may be combined in a single package or packaged separately.

The networking hardware may include one or more interface circuits. In some examples, the interface circuit(s) may implement wired or wireless interfaces that connect, directly or indirectly, to one or more networks. Examples of networks include a cellular network, a local area network (LAN), a wireless personal area network (WPAN), a metropolitan area network (MAN), and/or a wide area network (WAN). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs). Examples of cellular networks include GSM, GPRS, 3G, 4G, 5G, LTE, and EVDO. The cellular network may be implemented using frequency division multiple access (FDMA) network or code division multiple access (CDMA) network. Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN include IEEE Standard 802.15.4, including the ZIGBEE standard from the ZigBee Alliance. Further examples of a WPAN include the BLUETOOTH wireless networking standard, including Core Specification versions 3.0, 4.0, 4.1, 4.2, 5.0, and 5.1 from the Bluetooth Special Interest Group (SIG). A WAN may also be referred to as a distributed communications system (DCS). One example of a WAN is the internet.

Storage hardware is or includes a computer-readable medium. The term computer-readable medium, as used in this disclosure, encompasses both nonvolatile storage and volatile storage, such as dynamic random access memory (DRAM). The term computer-readable medium only excludes transitory electrical or electromagnetic signals propagating through a medium (such as on a carrier wave). A computer-readable medium in this disclosure is therefore non-transitory, and may also be considered to be tangible.

Examples of storage implemented by the storage hardware include a database (such as a relational database or a NoSQL database), a data store, a data lake, a column store, a data warehouse. Example of storage hardware include nonvolatile memory devices, volatile memory devices, magnetic storage media, a storage area network (SAN), network-attached storage (NAS), optical storage media, printed media (such as bar codes and magnetic ink), and paper media (such as punch cards and paper tape). The storage hardware may include cache memory, which may be collocated with or integrated with processing hardware. Storage hardware may have read-only, write-once, or read/write properties. Storage hardware may be random access or sequential access. Storage hardware may be location-addressable, file-addressable, and/or content-addressable. Example of nonvolatile memory devices include flash memory (including NAND and NOR technologies), solid state drives (SSDs), an erasable programmable read-only memory device such as an electrically erasable programmable read-only memory (EEPROM) device, and a mask read-only memory device (ROM). Example of volatile memory devices include processor registers and random access memory (RAM), such as static RAM (SRAM), dynamic RAM (DRAM), synchronous DRAM (SDRAM), synchronous graphics RAM (SGRAM), and video RAM (VRAM). Example of magnetic storage media include analog magnetic tape, digital magnetic tape, and rotating hard disk drive (HDDs). Examples of optical storage media include a CD (such as a CD-R, CD-RW, or CD-ROM), a DVD, a Blu-ray disc, and an Ultra HD Blu-ray disc. Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether. Some or all features of hardware may be defined using a language for hardware description, such as IEEE Standard 1364-2005 (commonly called “Verilog”) and IEEE Standard 1076-2008 (commonly called “VHDL”). The hardware description language may be used to manufacture and/or program hardware. A special-purpose system may be distributed across multiple different software and hardware entities. Communication within a special-purpose system and between special-purpose systems may be performed using networking hardware. The distribution may vary across embodiments and may vary over time. For example, the distribution may vary based on demand, with additional hardware and/or software entities invoked to handle higher demand. In various embodiments, a load balancer may direct requests to one of multiple instantiations of the special purpose system. The hardware and/or software entities may be physically distinct and/or may share some hardware and/or software, such as in a virtualized environment. Multiple hardware entities may be referred to as a server rack, server farm, data center, etc.

Software includes instructions that are machine-readable and/or executable. Instructions may be logically grouped into programs, codes, methods, steps, actions, routines, functions, libraries, objects, classes, etc. Software may be stored by storage hardware or encoded in other hardware. Software encompasses (i) descriptive text to be parsed, such as HTML (hypertext markup language), XML (extensible markup language), and JSON (JavaScript Object Notation), (ii) assembly code, (iii) object code generated from source code by a compiler, (iv) source code for execution by an interpreter, (v) bytecode, (vi) source code for compilation and execution by a just-in-time compiler, etc. As examples only, source code may be written using syntax from languages including C, C++, JavaScript, Java, Python, R, etc. Software also includes data. However, data and instructions are not mutually-exclusive categories. In various embodiments, the instructions may be used as data in one or more operations. As another example, instructions may be derived from data. The functional blocks and flowchart elements in this disclosure serve as software specifications, which can be translated into software by the routine work of a skilled technician or programmer. Software may include and/or rely on firmware, processor microcode, an operating system (OS), a basic input/output system (BIOS), application programming interfaces (APIs), libraries such as dynamic-link libraries (DLLs), device drivers, hypervisors, user applications, background services, background applications, etc. Software includes native applications and web applications. For example, a web application may be served to a device through a browser using hypertext markup language 5th revision (HTML5). Software may include artificial intelligence systems, which may include machine learning or other computational intelligence. For example, artificial intelligence may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs. Examples of the models include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformer (GPT). Training a machine-learning model may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), computer vision (CV), classification, image recognition, etc.

Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. In a client-server model, some of the software executes on first hardware identified functionally as a server, while other of the software executes on second hardware identified functionally as a client. The identity of the client and server is not fixed: for some functionality, the first hardware may act as the server while for other functionality, the first hardware may act as the client. In different embodiments and in different scenarios, functionality may be shifted between the client and the server. In one dynamic example, some functionality normally performed by the second hardware is shifted to the first hardware when the second hardware has less capability. In various embodiments, the term “local” may be used in place of “client,” and the term “remote” may be used in place of “server.” Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model. Some or all of the software may be arranged logically into layers. In a layered architecture, a second layer may be logically placed between a first layer and a third layer. The first layer and the third layer would then generally interact with the second layer and not with each other. In various embodiments, this is not strictly enforced—that is, some direct communication may occur between the first and third layers.

### AI Convergence System of Systems

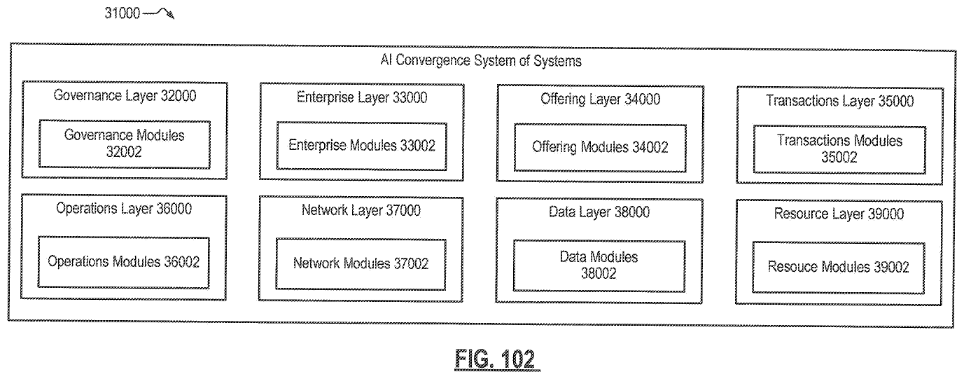

Referring to FIG. 102, an AI convergence system of systems 31000 is illustrated in accordance with some embodiments. The AI convergence system of systems 31000 represents a sophisticated multi-layered technological framework where platforms are enhanced through the deep integration of AI capabilities with other advanced technologies. This convergence fundamentally transforms how enterprise entities operate by enabling intelligent automation, data-driven decision making, and adaptive responses across all system layers. The system architecture is designed to support complex interactions between different technological components while maintaining operational efficiency and security across the enterprise environment.

The governance layer 32000 implements comprehensive automated governance and policy enforcement through specialized governance modules 32002. This layer utilizes generative AI technology to ensure proper oversight and compliance while adapting to changing regulatory requirements. The governance modules can automatically implement and enforce policies, manage digital rights infrastructure, monitor content and data flows, and ensure compliance with relevant regulations, contracts, and licensing requirements. The layer also incorporates digital twins and reporting automation capabilities to provide real-time oversight and transparency.

The enterprise layer 33000 supports various enterprise functions by integrating enterprise management and control platforms with digital infrastructure. This layer enables automated transactional processes, manages listings and user profiles, provides analytics and insights for strategic decision-making, and enforces security and compliance protocols through sophisticated permissions systems.

The offering layer 34000 leverages an intelligent systems architecture to create, manage and enable system offerings through specialized offering modules 34002. This layer employs advanced content generation intelligence, personalization capabilities, and domain-specific knowledge processing to deliver highly customized experiences. The layer can generate and adapt content based on user profiles, behaviors, current states, environmental factors, and specific requests, while maintaining coherence and quality across multiple formats and domains.

The transactions layer 35000 provides sophisticated transaction management capabilities through a set of hardware and software-defined transaction modules. This layer implements AI models for automating, optimizing, and executing digital transactions, including digital payments and asset management. It incorporates secure integration frameworks for interfacing with financial institutions, digital marketplaces, and blockchain networks, while maintaining robust authentication and security measures.

The operations layer 36000 orchestrates the comprehensive management and execution of AI systems through specialized operations modules. These modules handle critical functions including AI system generation, training data set creation, model verification, deployment optimization, and governance oversight. The layer implements sophisticated capabilities for training AI systems using supervised, unsupervised, and reinforcement learning techniques while maintaining performance metrics and simulated data validation. Through its orchestration capabilities, this layer enables dynamic resource allocation, load balancing, and automated governance of AI workloads across the enterprise ecosystem.

The network layer 37000 delivers advanced networking capabilities through intelligent adaptation to changing conditions and requirements. This layer facilitates communications among smart network-capable systems while leveraging AI to dynamically adapt network configurations and optimize data flow. It integrates edge computing with cloud services to enable data processing and workflow orchestration closer to data sources, reducing latency and enhancing real-time decision-making capabilities. The layer employs AI algorithms for intelligent routing of various data types through optimal network paths across cellular, WiFi, ORAN, Bluetooth and other protocols.

The data layer 38000 provides comprehensive data management and intelligence services through a sophisticated system of systems architecture. This layer implements machine learning systems, artificial intelligence systems, and neural networks configured to operate on fused data from diverse sources including sensors, wearables, social media, crowdsourced data, websites, APIs, edge devices, industrial systems, and enterprise platforms. It enables real-time monitoring and analysis while maintaining data sovereignty and security through federated learning techniques.

The resource layer 39000 enables automated and optimized provisioning of resources across various operational environments through AI-driven capabilities. This layer implements machine learning systems, artificial intelligence systems, and neural networks to optimize allocation of computational, networking, material, and energy resources. It provides dynamic resource management that can adapt to the specific demands of diverse environments like industrial settings, transportation infrastructure, energy facilities, and datacenters while maintaining operational efficiency.

This interconnected architecture creates a comprehensive technology stack that enables multiple scenarios and use cases across various enterprise contexts. The convergence of AI capabilities throughout these layers establishes an intelligent, adaptive system that can respond to diverse operational requirements while maintaining security, efficiency, and compliance. The system's modular design allows for continuous evolution and enhancement of capabilities across all layers, ensuring sustained value delivery to enterprise operations.

### Governance Layer—System Overview

An example system such as a multi-layered intelligent system (e.g., AI convergence system of systems 31000) may provide automated governance (e.g., using governance layer 32000 including governance modules 32002) and execution of transactions. In example embodiments, this system may use generative AI technology to provide users and/or organizations with offerings and content that may be customized and personalized based on a profile, behavior, current state (physiological, emotional, or other), environment, location, content, and/or request. For example, a user may use this system to request a particular type of experience with a preferred theme (e.g., including music, video, characters, etc.) or a particular type of organization or presentation of content may be generated to fit with the user's style, mood and current environment.

### Governance Layer Architecture

In example embodiments, the system (e.g., AI convergence system of systems 31000) may include systems for automated governance (e.g., using governance layer 32000 including governance modules 32002) and execution of transactions (e.g., using transactions layer 35000 that may include transactions modules 35002). For example, a rights infrastructure system may be included in the AI convergence system of systems 31000 (e.g., specifically in the governance layer 32000).

In some example embodiments, the system (e.g., system of systems such as SoS and more specifically AI convergence system of systems 31000) may include a governance layer 32000 that performs various governance tasks for the system. In example embodiments, the governance layer 32000 may be deployed to enforce various governance standards, workflows, or rules with respect to AI-driven tasks of the system. The types of governance standards, workflows, and rules that may be deployed in a specific configuration of the system may vary depending on the configuration of the system.

In example embodiments, the governance layer 32000 may include the set of governance modules 32002 that may be configured to perform a respective governance task. As discussed in the disclosure, governance may be configured for various purposes and in various manners. In some example embodiments, governance modules may be configured to ensure an entity is complying with a set of standards (e.g., internal standards, industry standards, recommended standards, or the like), regulations (e.g., jurisdictional regulations, professional regulations, industry regulations or the like), rules (e.g., internal rules, jurisdictional rules, international rules, or the like), or the like. Examples of the different types of analyses that a governance module may be configured to perform are described throughout the disclosure and may include risk analyses, security analyses, decision tree analyses, ethics analyses, failure mode and effects (FMEA) analyses, hazard analyses, quality analyses, safety analyses, regulatory analyses, legal analyses, and/or other suitable analyses.

In some example scenarios, a governance module may be configured to ensure an automated task is performed in a manner that complies with jurisdictional and/or governmental rules. In some example embodiments, a governance module may be configured to apply certain workflows or checklists after completion or before performance of an AI-driven task. For example, after a certain type of transaction is completed, a governance module may be configured to ensure that any required post transaction reconciliation, fulfillment, and/or reporting are completed properly. In another example, before a counterparty is transacted with, a governance module may be configured to initiate a “know-your-customer” workflow to determine whether the counterparty has a white-listed account, and if not, to determine whether to approve the counterparty transactor. In another example, a governance module may be configured and deployed to monitor a supply chain to ensure compliance with regulations relating to imported materials (e.g., tariffs are paid, regulated materials are reported, or the like).

In some example embodiments of the disclosure, a governance module may be configured and deployed to monitor the performance of an AI model (e.g., an LLM, a neural network, a machine learning model, and/or the like). In these example embodiments, a governance module may be configured to analyze the output of an AI model with respect to one or more governance parameters to determine whether the AI model is producing output that exhibits bias, drift, or the like, as described elsewhere in the disclosure. In some example embodiments, a governance module may halt use of an AI model that is determined to be exhibiting drift or bias. Additionally or alternatively, it may initiate a retraining of the model and/or alert a human user.

In some example embodiments, a governance module may be configured to analyze an input to a particular AI model. In some example embodiments, a governance module may be configured to analyze a prompt being provided to a large language model to ensure that the prompt is not requesting something that would violate a governance standard of an entity or the model. For example, a governance module may be configured to analyze a user prompt to ensure that the user is not asking the large language model to violate another party's intellectual property rights, use data sets that are not permitted to be used, or otherwise perform tasks that would put the enterprise at risk. In such example scenarios, the governance module may prevent the prompt from being processed by the LLM. Additionally or alternatively, analyzing input to an AI model may include analyzing the data being provided to the model to make a prediction or recommendation to determine whether the data is reliable data. Assuming the input data is reliable, the AI model may be provided with the input data. If, however, the data is deemed to be unreliable (e.g., fake data injection or data from a faulty sensor), a corrective measure may be initiated by the governance module (e.g., preventing the data from being used and/or alerting a human user).

### Ownership and Rights Management

In example embodiments, AI agents may be configured for identifying and tracking offerings, content, systems, and services ownership for licensing. This may involve ownership of two or more entities for providing one service or multiple services relating to particular data or content. For example, the AI agents may navigate different pathways in governing ownership of services offered. The ownership may relate, for example, to copyright of media such as software, video, photos, music, and/or scripts or based on companies or individuals that provide at least a portion of the games and/or entertainment. With other services described, the ownership may relate, for example, to the roles of an individual or organization in providing service(s). There may be other logical rules used for determining ownership of content. The AI convergence system of system of systems 31000 may include management platforms that may use fully autonomous software, such as fully autonomous AI, to proceed through steps or a co-pilot software such as an AI co-pilot with a user approving and proceeding with at least some portions of the following process manually.

### Content Analysis and Monitoring

In example embodiments, AI convergence system of systems 31000 may be configured for tracking and monitoring services or content going into a data model for identifying ownership of portions of the services across integrated system components or layers (e.g., across offering layer 34000 that may use offering modules 34002, enterprise layer 33000 that may include enterprise modules 33002, and governance layer 32000). In other examples, system 31000 may use various machine learning techniques and artificial intelligence capabilities, such as neural networks, to analyze content before the content data is inputted into a model for a source of the data (e.g., via offering layer 34000 and/or enterprise layer 33000). The source may indicate ownership of different parts of the content that may be assigned to one or more owners. In example embodiments, system 31000 may use intelligent processing (e.g., AI) to analyze the data going into the model as compared against continuously updated reference databases and knowledge models (e.g., a constantly updated Internet model such as a “world” model of all public data) for identifying source information that may be used to find ownership. System 31000 may use the intelligent analysis to identify ownership from various types of information or source information associated with the content. Alternatively, in other example embodiments, automated data collection and analysis tools (e.g., a web crawler, spider, or search engine bot with AI) may be utilized to find ownership. This source information may be based on any portion of the software being used, hardware being used, and other systems being used such as relating to services and content.

### Policy and Licensing Management

In example embodiments, system 31000 may use identified owners as a trigger to find any policies and/or licensing information (including e.g., contracts) that are associated with the content being inputted and/or the owners involved (e.g., using the governance layer 32000). The system 31000 may leverage the AI to find and/or locate the associated policies and/or licensing information by querying the continuously updated reference databases and knowledge models and/or querying publicly available web sources (e.g., using a web crawler, spider, or search engine bot). This querying process may find these policies and/or licensing information through direct or indirect associations to the owners identified and the related or associated content that is being inputted. In example embodiments, the querying process may also find policies and/or contractual information related to owners or at least partial owners of the related or associated services that may be requested by a user of system 31000 (e.g., owner or partial owner of services).

### Transaction Management

In example embodiments, automated transaction and contract management systems (e.g., using smart contracts or other similar semi-autonomous contract systems) may be triggered via intelligent processing modules to provide transactions with a particular use of the content in modeling based on, at least partially, the associated policies, contracts, and/or licensing information discovered from querying. These automated contractual arrangements may be executed through the transaction processing components (e.g., at the transactions layer 35000 of the system 31000). In some examples, the smart contracts may be configured using distributed ledger technology (e.g., blockchain). Alternatively, in other example embodiments, communications may be automated for users to review/approve and/or automated between the system 31000 and identified owners (e.g., copyright owners of content or owners based on other factors such as development of content) to obtain approval and/or contractual information (e.g., based on, at least partially, the associated policies, contractual, and/or licensing information discovered) before proceeding with particular modeling.

### Rights Compliance and Infringement

In example embodiments, system 31000 may compare results and/or output from content generation systems (e.g., generative models) against the reference knowledge bases for identifying potential rights infringement (e.g., copyright infringement) based on any substantive similarities (e.g., based on copyright law), trademark infringement, and/or infringing ownership of other rights associated with results outputted from generative models. In example embodiments, the results and/or output from generative models may be various types of services and/or other content data generated as requested via a user interface. In order to compare results, for example, system 31000 may identify similarities between a generative model result and a “world” model and/or compared against a repository of known copyrighted works (e.g., all copyrighted media stored here with fair use data being excluded from this repository). System 31000 may use AI and/or modeling of various laws and/or regulations relating to services (e.g., statutes, rules, and case law as well as copyright law statutes, rules, and case law that relate to region(s) where the generative models are being used) for determining what is considered substantive similarities. System 31000 may use AI and/or modeling to determine whether any thresholds of infringement (e.g., copyright infringement or other ownership infringement) may have been crossed (e.g., based on the legal models or data such as statutes, rules, and case law relating to relevant jurisdiction(s)). The models used to run this analysis may be based on service-related laws and/or copyright laws (e.g., statutes, rules, and case law based on jurisdiction(s) impacted) and then may use case law examples to understand the thresholds between infringement and non-infringement. System 31000 may identify owners for portions of services being infringed or potentially infringed. System 31000 may use identified copyright owners as a trigger to find any policies, contractual, and/or licensing information (including associated contracts) that are associated with the content and/or the owners involved. Identifying owners along with associated policies and/or licensing information may occur using the same or similar approaches as described elsewhere in this disclosure. In example embodiments, system 31000 may run this process across one or more services such as comparing results and/or output from generative models against the continuously updated reference databases and knowledge models for identifying potential ownership infringement through using one or more services. The models used to run this analysis may be based on various service ownership-related laws (e.g., statutes, rules, and case law based on jurisdiction(s) impacted) and then may use case law examples to understand the thresholds between infringement and non-infringement. System 31000 may identify owners for portions of services being infringed or potentially infringed. System 31000 may use identified service owners as a trigger to find any policies, contractual, and/or licensing information (including associated contracts) that are associated with the services and/or the owners involved.

In example embodiments, system 31000 (e.g., using transactions layer 35000) may trigger smart contracts (or other similar semi-autonomous contracts) to provide transactions for particular use of resulting generative media going forward (e.g., personal use, display to a company, display to friends/family, display via internet social media channels, display on cable channels, display on streaming channels, etc.) and based on a portion of the generative result potentially infringing. In some examples, the smart contracts may be configured using distributed ledger technology (e.g., blockchain). Alternatively, communications may be generated for users to review/approve and/or automated between the system 31000 and owners to obtain approval and/or contractual information to proceed with particular use of resulting generated media based on a portion potentially infringing. This may also occur with use of resulting generated or suggested services that relate to one or more owners.

In example embodiments, system 31000 may relate to transactions layer 35000 and operations layer 36000 (e.g., that may use operations modules 36002) by use of automation software technologies to execute various systems.

### Compensation and Ownership Distribution

In example embodiments, system 31000 (e.g., using enterprise layer 33000 and/or offering layer 34000) trains and deploys AI expert agents/co-pilots that can fill various artistic/creative roles within a service project. The AI expert agents may be configured to determine how to compensate rights holders that created content. For example, the AI expert agent may, when a generative work is created, determine who should be compensated and how based on identification of specific data used to train a model or similarity of the output to identified parties. In example embodiments, different components may have different licensing/compensation models. For example, gaming royalties may be different from music, video, characters, etc. For music, royalties may be awarded to individual rights holders, for example. In example embodiments, the compensation may be determined by the AI based on any combination of a potentially infringing portion of created content used, owners, as well as policies, contractual, and/or licensing information associated with the relevant owners. In some example embodiments, these ownership issues may result in fractional ownership of slot machines that may change or vary based on each instance user request as the content output may change and change during each of these instances. In example embodiments, similar processes may be executed for determining ownership percentages for services being provided especially where there may be two or more owners contributing to an offered service and/or content. Given the different ownership shares that may exist, in some example embodiments, tokenization technologies may be utilized to divide up the ownership as well as allow for the use to pay multiple owners automatically via portions of a token. In these examples, a virtual wallet may be utilized with tokens. Overall, this allows for a customized or personalized result or output based on each user's request from an interface. With services, this allows for a customized or personalized result or output based on each user's request regarding offerings, content, systems and services.

### Prediction

In some example embodiments, the generative AI may suggest and/or automatically provide services to a user based on intelligent analysis of historical data and user preferences (e.g., using a prediction model). This allows the user to use any machine that is able to connect to a personalized custom model of the user for insights on the user's preferences based on historical data of previous usage and requests. The prediction process may be able to improve its prediction based on a variety of factors such as time usage of services, number of times service(s) is/are requested, success rate with some services, selection, time of day preferences, preferred spending, biometric data (e.g., using sensors to check various data points from users that can indicate likes/dislikes such as relating to relaxation vs. stress levels and/or improved focus), etc. In example embodiments, the generative AI may also suggest and/or automatically provide suggested services to a user based on a prediction model from historical data.

### Model Selection

In example embodiments, the converging technology stack system of systems 31000 selects a model for a particular task (e.g., appropriate processing models). For example, the system 31000 may determine the genus of model to use and within the genus, which specific model to use. System 31000 may select between, for example, a diffusion model or a large language model (LLM). Once a genus is selected, then the system 31000 may select a specific model (e.g., a specific diffusion model or specific LLM) to perform the task.

### Digital Asset Management

In example embodiments, the system 31000 (e.g., via the transactions layer 35000) may provide for digital payment and asset management capabilities (e.g., using virtual wallets) that may include tokens and/or other payment options for transactions.

### Embedded Policy and Governance, Policy Automation, and Compliance Automation

In example embodiments, the governance layer 32000 of system 31000 may include a set of machine learning systems, artificial intelligence systems, and/or neural networks configured to execute intelligence tasks associated with embedded policy and governance, policy automation, and/or compliance automation. These capabilities may work in conjunction or separately with system 31000 and other subsystems (e.g., rights infrastructure system) as described in the disclosure to provide comprehensive governance across the platform. The governance layer 32000 may automatically implement and enforce policies while ensuring compliance with relevant regulations, contracts, and/or licensing requirements.

### Digital Twins and Reporting Automation

Building upon the system's ability to track ownership and manage rights, the governance layer 32000 may include and/or use digital twins (e.g., executive digital twins) and/or reporting automation capabilities that provide oversight and transparency. These digital twins may monitor governance processes in real-time, while automated reporting may ensure all stakeholders receive appropriate updates about policy implementation, compliance status, and/or system activities.

### Enterprise Layer

In embodiments, the techniques described herein relate to a computer-implemented system for managing a set of machine learning systems, a set of artificial intelligence systems, and/or set of neural networks within an enterprise ecosystem, the system including: a processor; a memory storing instructions that, when executed by the processor, cause the system to: integrate a set of machine learning systems, a set of artificial intelligence systems, and/or set of neural networks with an enterprise access layer (EAL) that interfaces with a plurality of enterprise resources; automate the collection, storage, presentation, streaming, monitoring and analysis of data, content, processing protocols and the like, and related metadata by interfacing the a set of machine learning systems, a set of artificial intelligence systems, and/or set of neural networks within workflow systems of the enterprise; utilize a data services system to manage enterprise management and control platforms; implement an intelligence system to provide predictive analytics for trends and demand forecasting within the enterprise management and control platforms; enforce security and compliance through a permissions system that controls access to functions of the enterprise management and control platforms; manage digital transactions via a wallets system that interfaces with the enterprise management and control platforms; and generate reports on platform activity through a reporting system that is communicatively coupled with the enterprise management and control platforms

In embodiments, the techniques described herein relate to a computer-implemented system for facilitating actions within enterprise management and control platforms, including: a processor; a memory storing instructions that, when executed by the processor, cause the system to: integrate enterprise management and control platforms with an enterprise's digital infrastructure; automate transactional processes by interfacing the enterprise management and control platforms with a workflow system of the enterprise; manage listings, transactions, and user profiles using a data services system; provide analytics and insights for strategic decision-making within the enterprise management and control platforms through an intelligence system; enforce security and compliance protocols via a permissions system that controls access to the enterprise management and control platforms; and facilitate digital transactions through a wallets system that interfaces with the enterprise management and control platforms.

In embodiments, the EAL may be configured to interact with the platform users (and the ecosystem(s) in which they interact) in a variety of ways. For example, the EAL may be integrated or associated with one or more marketplaces or platforms such that the EAL functions as its own market or platform participant on behalf of the enterprise. By being associated with potentially numerous marketplaces or platforms, the EAL can perform complex or multi-stage actions, including but not limited to transactions, with enterprise assets (e.g., in a series or sequence of timed stages, simultaneously in a set of parallel transactions, or a combination of both).

In addition to marketplaces, the EAL may interact with platform users via third-party systems, some or all of which may be implemented as third-party services.

In embodiments, the EAL may include a number of EAL systems (also referred to as modules or EAL modules herein) that enable the functionality of the EAL. In some examples, these EAL systems may be deployed in a container that is specific to the EAL. When deployed in a container for the EAL, this containerized instance means that the EAL may include the necessary tools and computing resources to operate (i.e., host) the EAL systems without reliance on other computing resources associated with the enterprise (e.g., computing resources such as processors and memory dedicated to the EAL). For example, the container for the EAL may include a set of one or more systems, such as software development kits, application programming interfaces (APIs), libraries, services (including microservices), applications, data stores, processors, etc. to execute the functions of the EAL systems that may enable the EAL to provide enterprise management and other functions and capabilities described throughout this disclosure. References herein to “EAL systems” should be understood to encompass any of the foregoing except where context dictates otherwise.

In some implementations, a set of the EAL systems may leverage computing resources considered to be external to the EAL (e.g., separate from computing resources that have been dedicated to the EAL, such as, in embodiments, computing resources shared with other enterprise applications or systems). In these implementations, the set of EAL systems leveraging external computing resources may be in communication with computing resources specific to the EAL. This type of arrangement may be advantageous when one or more of the EAL systems are computationally expensive and would increase the computational requirements for an entirely contained EAL, such as when one or more of the EAL systems causes the EAL to be a relatively expensive EAL deployment. For instance, an arrangement leveraging external (e.g., shared) systems may be beneficial for EAL systems that are infrequently utilized. To illustrate, a first enterprise may rarely use an EAL system, such as a reporting system. Here, instead of ensuring that the EAL has the computational capacity to support a reporting system by itself, the enterprise may configure the reporting system to be hosted by and/or supported by computing resources external to the EAL to deploy a relatively lean form of the EAL (i.e., an EAL container that does not include resources dedicated to a reporting system or that includes only limited resources dedicated to the reporting system with the capability to access additional, external resources as needed).

In some configurations, the EAL or a set of the EAL systems may leverage computing resources considered to be external to the EAL for support. An example of this support may be that the EAL or the set of EAL systems demands greater computing resources at some point in time (e.g., over a resource intensive time period)—for instance, greater may mean more computing resources than a normal or baseline operation state. In this example, for instance, an enterprise resource not dedicated to the EAL or EAL systems can assist or augment the services provided by some aspect of the EAL.

In embodiments, the deployment of the EAL may be configurable. For example, the enterprise or some associated developer can function as a type of architect for the EAL that best serves the particular enterprise. Additionally, or alternatively, the deployed location of the EAL may influence its configuration. For instance, the EAL may be embedded within an enterprise (e.g., non-dynamically) where it can be specifically configured using various module libraries, interface tools, etc. (e.g., as described in later detail). In some examples, the configuring entity is able to select what EAL systems will be included in its EAL. For instance, the enterprise selects from a menu of EAL systems. Here, when an EAL system is selected by the configuring entity, a configuration routine may request the appropriate resources for that EAL system including SDKs, computing resources, storage space, APIs, graphical elements (e.g., graphical user interface (GUI) elements), data feeds, microservices, etc. In some implementations, in response to the request, the configuring entity can dedicate the identified resources of each selected EAL system. For instance, the configuring entity associates the dedicated resources to a containerized deployment of the EAL that includes the selected EAL systems.

In embodiments, the EAL may include a set of EAL systems. The set may include an interface system, a data services system, an intelligence system, a scoring system, a data pool system, a workflow system, a transaction system (also referred to as a wallet system or a digital wallet system), a governance system, a permissions system, a reporting system, and a digital twin system. Additionally, although particular types of EAL systems are described herein, the functionality of one or more EAL systems is not limited to only that particular EAL system but may be shared or configured to occur at another EAL system. For instance, in some configurations, some functionality of a transaction system may be performed by the data services system or functionality of the governance system may be incorporated with an intelligence system. In this respect, the EAL systems may be representative of the capabilities of the EAL more broadly. In embodiments, the set of EAL systems involved in any particular configuration of the EAL may include any of the systems described throughout this disclosure and the documents incorporated by reference herein, such as systems for counterparty discovery, opportunity mining, automated contract configuration, automated negotiation, automated crowdsourcing, automated facilitation of robotic process automation, one or more intelligent agents, automated resource optimization, resource tracking, and others.

In some embodiments, one or more of these systems may be configurable. The configurations may be done by selecting pre-defined configurations/plugins, by building customized modules, and/or by connecting to third party services that provide certain functionalities.

In some embodiments, aspects of a configured EAL may be dynamically reconfigured/augmented. In some examples, reconfiguration/augmentation may include updating certain data pool configurations, redefining certain workflows, changing scoring thresholds, or the like. Reconfiguration may be initiated autonomously (for example, the EAL periodically tests configurations of certain aspects of the EAL configuration using the digital twin simulation system and analytics system) or may be expert-driven (e.g., via interactions between an EAL “expert” and an interactive agent via a GUI of the interface system).

In embodiments, the data services system may perform data services for the EAL, which may include a data processing system and/or a data storage system. This may range from more generic data processing and data storage to specialty data processing and storage that demands specialty hardware or software. In some examples, the data services system includes a database management system to manage the data storage services provided by the data services system. In some configurations, the database management system may be able to perform management functions such as querying the data being managed, organizing data for, during, or upon ingestion, coordinating storage sequences (e.g., chunking, blocking, sharding), cleansing the data, compressing or decompressing the data, distributing the data (including redistributing blocks of data to improve performance of storage systems), facilitating processing threads or queues, etc. In some examples, the data services system couples with other functionality of the EAL. As an example, operations of the data services system, such as data processing and/or data storage, may be dictated by decision-making or information from other EAL systems such as an intelligence system, a workflow system, a transaction system, a governance system, a permissions system, a reporting system, and/or some combination thereof.

It is appreciated that workflows may be deployed in any number of scenarios. Examples of scenarios where workflows may be deployed by an EAL include permission workflows, access workflows, data collection workflows, data pool workflows, machine learning workflows, artificial intelligence workflows, governance workflows, scoring workflows, transaction workflows, governance workflows, industry or vertical-specific workflows, enterprise-specific workflows, and other suitable workflows. It is appreciated that the example types of workflows provided above may overlap (e.g., a governance workflow may be an industry-specific and/or enterprise-specific workflow). Furthermore, some workflows may trigger one or more other workflows. For example, when a certain type of transaction is executed by a transaction system of an EAL, a transaction workflow corresponding to the type of transaction may define a series of tasks that are performed before the transaction is executed. In another example, as part of a data pool workflow that establishes a data pool that is accessible by third-parties, the data processing workflow may trigger a governance workflow that ensures that any enterprise data being added to the data pool confirms with certain data sharing rules (e.g., obfuscation of sensitive data, complying with privacy rules, scrubbing metadata, and/or the like) and may trigger a scoring workflow that scores each third-party that will access the data pool. Furthermore, EAL workflows may share a common framework for respective EAL functions and scenarios; however, individual workflows deployed with respect to respective EAL instances may vary in complexity from very basic workflow implementations (e.g., configured to execute on a user device or sensor device) to complex workflows with multiple dependencies and/or embedded “sub-workflows” (e.g., configured to execute by a central server system and/or by multiple enterprise devices).

In embodiments, a digital twin system may perform simulations of the enterprise's products and services that incorporate real-time data obtained from the various entities of the enterprise or third parties. In some of these embodiments, the digital twin system may recommend decisions to a user interacting with the enterprise digital twins.

In embodiments, an artificial intelligence module may include and/or provide access to a digital twin module. The digital twin module may encompass any of a wide range of features and capabilities described herein In embodiments, a digital twin module may be configured to provide, among other things, execution environments for and different types of digital twins, such as twins of physical environments, twins of robot operating units, logistics twins, executive digital twins, organizational digital twins, role-based digital twins, and the like. In example embodiments, a digital twin module may be configured to generate digital twins that are requested by intelligence clients. Further, the digital twin module may be configured with interfaces, such as APIs and the like for receiving information from external data sources. For instance, the digital twin module may receive real-time data from sensor systems of a machinery, vehicle, robot, or other device, and/or sensor systems of the physical environment in which a device operates. In embodiments, the digital twin module may receive digital twin data from other suitable data sources, such as third-party services (e.g., weather services, traffic data services, logistics systems and databases, and the like). In embodiments, the digital twin module may include digital twin data representing features or states, as well as demand entities, such as customers, merchants, stores, points-of-sale, points-of-use, and the like. The digital twin module may be integrated with or into, link to, or otherwise interact with an interface (e.g., a control tower or dashboard), for coordination of supply and demand, including coordination of automation within supply chain activities and demand management activities.

In embodiments, a digital twin module may provide access to and manage a library of digital twins. A plurality of artificial intelligence modules may access the library to perform functions, such as a simulation of actions in a given environment in response to certain stimuli.

In example embodiments, the digital twin(s) may be implemented with smart contracts, such as for digital twin transactions enabled by smart contracts (e.g., using smart contract orchestration engines).

In embodiments, an enterprise access layer system of systems (ELS) may manage and integrate EAL methods and systems, technological systems, data streams, platforms, and operational processes. Current enterprises face challenges in coordinating across different business units and technology stacks, creating a need for an intelligent enterprise access layer capable of parallel task execution and advanced analytics capabilities. The ELS, as described herein, implements a comprehensive architecture that enables parallel processing of intelligence tasks across multiple domains while maintaining data consistency and security protocols. The system's core architecture comprises processing unit(s) integrated with memory system(s) storing executable instructions, multiple machine learning systems, artificial intelligence engines, and neural network arrays, supported by data storage systems, communication interfaces, security modules and connections or associations with third party systems, platforms or operations.

### Simulation

In embodiments, the ELS may execute system simulations utilizing neural network models to provide predictive analytics for business forecasting. In example embodiments, the system may continuously update simulations in real-time based on, for example, operational data, enabling dynamic scenario modeling and analysis for enhanced decision-making processes.

### Digital Twins

In embodiments, the ELS may implement digital twin and management capabilities, generating Metaverse environments, such as industrial Metaverse environments, that enable real-time synchronization between physical and digital assets. In example embodiments, these digital representations may facilitate virtual testing and validation of industrial systems before physical implementation.

### Data Integration/IoT

In embodiments, the ELS may incorporate big data processing and analytics capabilities, seamlessly integrating with Industrial Internet of Things platforms. In example embodiments, this integration may include real-time sensor data analysis and predictive maintenance optimization across industrial operations.

### Process Optimization

In embodiments, the ELS may deliver automated industrial operational control through AI-driven process optimization systems. In example embodiments, the ELS may continuously perform real-time adjustments of manufacturing parameters while maintaining comprehensive quality control and compliance monitoring protocols.

### Transactions

In embodiments, the ELS may enable enterprise system integration through AI-enhanced transaction processing capabilities. In example embodiments, this integration may facilitate automated workflow management and ensures precise cross-system data synchronization across the enterprise environment.

### Forecasting

In embodiments, the ELS may implement intelligent supply chain optimization algorithms coupled with sophisticated demand shaping and forecasting capabilities. In example embodiments, the system may provide comprehensive inventory management optimization while facilitating effective supplier relationship management processes.

### Executive Digital Twins

In embodiments, the ELS may deploy executive digital twins for fleet management, enabling vehicle simulation and design optimization. In example embodiments, the ELS may manage complex fleet transaction processing while integrating with software-defined vehicle systems for enhanced operational control.

### Energy Management/Digital Twins

In embodiments, the ELS may incorporate energy operations digital twins within a system of systems integration framework for comprehensive energy management. In example embodiments, the system may process energy transactions while performing AI-based energy optimization across the enterprise.

### Machine/Deep Learning

In embodiments, the ELS may implement multiple machine learning approaches, including supervised learning algorithms for pattern recognition and unsupervised learning systems for anomaly detection. In example embodiments, the ELS may utilize reinforcement learning for optimization processes and deep learning capabilities for complex analysis tasks.

### CNNs

In embodiments, the ELS may deploy specialized neural network architectures, including convolutional neural networks for image processing applications and recurrent neural networks for sequence analysis. In example embodiments, the system may utilize transformer networks for natural language processing tasks and implements graph neural networks for relationship analysis.

### Process Optimization

In embodiments, the ELS may coordinate multiple AI systems through a hierarchical task distribution framework, implementing parallel processing optimization and resource allocation management. In example embodiments, the ELS may enable cross-system learning integration for enhanced operational efficiency.

### Security/Authentication

In embodiments, the ELS may implement comprehensive security measures including role-based access control systems and multi-factor authentication protocols. In example embodiments, the system may maintain detailed activity monitoring and logging while enforcing robust security policies.

### Security/Encryption

In embodiments, the ELS may implement end-to-end encryption protocols and secure data transmission mechanisms. In example embodiments, the system may incorporate privacy preservation techniques while maintaining compliance monitoring and reporting capabilities.

### Enterprise Platform Integration

In embodiments, the ELS may integrate with existing enterprise resource planning systems, customer relationship management platforms, manufacturing execution systems, and supply chain management systems. In example embodiments, this integration may enable data flow and process coordination across the enterprise environment.

### Remote Third-Party Connectivity

In embodiments, the ELS may maintain connections with cloud services, partner networks, and external data sources while enabling integration with third-party applications. In example embodiments, this connectivity may ensure data access and process coordination across the extended enterprise ecosystem.

### Dynamic Resource Allocation

In embodiments, the ELS may implement horizontal and vertical scaling capabilities supported by dynamic resource allocation mechanisms. In example embodiments, the ELS may maintain load balancing capabilities while performing continuous performance monitoring to ensure optimal system operation.

### Fault Tolerance/Redundancy

In embodiments, the ELS may incorporate fault tolerance mechanisms and redundancy management systems. In example embodiments, the implementation may include disaster recovery capabilities and continuous system health monitoring to ensure sustained operational reliability.

### Production Optimization

In embodiments, in manufacturing operations, the ELS may enable production optimization through real-time monitoring and adjustment of manufacturing parameters. In example embodiments, the system may continuously analyze production data to automatically optimize resource allocation and scheduling, while maintaining quality control standards. For example, in an automotive manufacturing facility, the ELS may monitor assembly line operations in real-time, automatically adjusting robotic systems and process parameters to maintain optimal production efficiency and product quality.

### Maintenance Scheduling

In embodiments, the ELS may implement predictive maintenance scheduling by analyzing equipment sensor data through its IoT integration capabilities. In example embodiments, this may allow manufacturing facilities to prevent unexpected downtime by identifying potential equipment failures before they occur. The ELS may coordinate maintenance activities across multiple production lines while optimizing resource utilization and minimizing operational disruptions.

### Supply Chain Optimization

In embodiments, in supply chain applications, the ELS may implement optimization through real-time monitoring and analysis of stock levels, demand patterns, and supplier performance. In example embodiments, the system may utilize its forecasting capabilities to predict demand fluctuations and automatically adjust inventory levels across multiple distribution centers. For instance, in a consumer goods supply chain, the system may continuously analyze point-of-sale data, weather patterns, and seasonal trends to optimize stock levels and distribution patterns. The system's value chain network control capabilities may enable logistics planning through its centralized control tower operations. The ELS may coordinate multiple distribution nodes, optimizing delivery routes and transportation resources while maintaining real-time visibility of all shipments. The system may automatically adjust logistics plans based on real-time conditions, such as weather disruptions or transportation delays, ensuring efficient delivery operations.

In embodiments, the ELS may create digital twin representations of manufacturing facilities and supply chain networks, enabling virtual testing and optimization before physical implementation. For example, in a pharmaceutical manufacturing environment, the system may simulate production processes and supply chain operations, allowing operators to test different scenarios and optimize procedures without disrupting actual operations. In example embodiments, these digital twins may maintain real-time synchronization with physical assets, providing accurate representations of current operational states.

In embodiments, the ELS may implement AI-driven process optimization across manufacturing and supply chain operations through its machine learning and neural network architectures. For example, in a chemical manufacturing facility, the ELS may continuously analyze process parameters and product quality data, automatically adjusting production variables to maintain optimal output while ensuring compliance with quality standards. In these example embodiments, the system's reinforcement learning capabilities may enable continuous improvement of operational parameters based on historical performance data.

In embodiments, within manufacturing environments, the ELS may optimize energy consumption patterns through its energy management capabilities. In example embodiments, the system may analyze production schedules, energy pricing, and operational requirements to optimize energy usage while maintaining production efficiency. For example, in an industrial processing facility, the system may automatically adjust production scheduling to take advantage of off-peak energy rates while ensuring production targets are met.

In embodiments, the ELS may demonstrate integration capabilities by connecting manufacturing execution systems, supply chain management platforms, and enterprise resource planning systems. This integration may enable data flow and coordination across all operational aspects. For instance, in a consumer electronics manufacturing operation, the system may coordinate production planning with supply chain logistics and inventory management, ensuring efficient resource utilization and timely delivery of finished products.

In embodiments, the ELS may implement a multi-layered neural network architecture that combines multiple specialized networks for different processing tasks. In example embodiments, the system may utilize convolutional neural networks specifically designed for image processing applications, while implementing recurrent neural networks for analyzing sequential data patterns. Additionally, transformer networks may handle natural language processing tasks, and graph neural networks process relationship analysis across the system. In these example embodiments, the ELS may coordinate these neural networks through a machine learning integration framework that implements multiple advanced approaches. For example, the system may utilize supervised learning algorithms for pattern recognition tasks, while simultaneously deploying unsupervised learning systems for anomaly detection, and/or vice versa. Reinforcement learning capabilities may be implemented for continuous optimization processes, while deep learning systems may handle complex analysis tasks requiring sophisticated pattern recognition. In embodiments, the ELS may manage the practical implementation of these systems through a hierarchical task distribution framework that enables efficient parallel processing optimization. The system may implement sophisticated resource allocation management protocols to ensure optimal utilization of computing resources across different AI subsystems. This framework facilitates cross-system learning integration, allowing different AI components to share and leverage insights across various operational domains.

In embodiments, the ELS may include a central processing unit that coordinates various AI and machine learning components through integrated memory systems storing executable instructions. In these embodiments, the system architecture may enable parallel processing of intelligence tasks across different domains while maintaining data consistency through synchronization protocols. The implementation may include dedicated data storage systems and communication interfaces that facilitate interaction between different neural network and machine learning components.

In embodiments, the ELS may implement real-time processing capabilities through its neural network arrays and AI engines. In example embodiments, these components may work in concert to process operational data, enabling continuous updates to simulations and forecasting models. In these example embodiments, the system may maintain real-time synchronization between physical and digital assets through its digital twin implementation, allowing for immediate feedback and adjustment of operational parameters.

In embodiments, the ELS may include neural network and machine learning systems that operate within a comprehensive security framework that implements end-to-end encryption and secure data transmission protocols. In example embodiments, the system may maintain privacy preservation techniques while enabling the AI components to process and analyze data without compromising security protocols.

In embodiments, the ELS may enable enterprise system integration through dedicated communication interfaces that connect with ERP systems, CRM platforms, manufacturing execution systems, and supply chain management systems. For external connectivity, the ELS may maintain connections with cloud services, partner networks, external data sources, and third-party applications through its communication interfaces and integration modules. In these example embodiments, the system-of-systems architecture may include communication interfaces and security modules that enable data synchronization while maintaining security protocols. This may include end-to-end encryption for data transmission and privacy preservation techniques for sensitive information exchange.

In embodiments, the ELS may include an integration framework that supports automated workflow management and cross-system data synchronization capabilities to ensure consistent data flow across connected enterprise systems. For performance optimization, the system may implement horizontal and vertical scaling capabilities along with dynamic resource allocation and load balancing to maintain efficient system integration and data exchange. In these example embodiments, the system's reliability features may include fault tolerance mechanisms and redundancy management to ensure consistent integration performance, while system health monitoring maintains stable connectivity with integrated enterprise systems.

Example embodiments include, but are not limited to the ELS having a set of machine learning systems, a set of artificial intelligence systems, and/or set of neural networks configured to 1) execute a set of intelligence tasks associated with a set of simulations, and 2) execute a set of intelligence tasks associated with forecasting, and 3) execute a set of intelligence tasks associated with a set of digital twins, and 4) execute a set of intelligence tasks associated with the Industrial Metaverse, and 5) execute a set of intelligence tasks associated with a value chain network control tower, and 6) execute a set of intelligence tasks associated with a set of value chain network mini control towers, and 7) execute a set of intelligence tasks associated with big data and/or analytics, and 8) execute a set of intelligence tasks associated with a set of executive digital twins, and 9) execute a set of intelligence tasks associated with an industrial internet of things (IIoT) platform, and 10) execute a set of intelligence tasks associated with AI-based industrial operational control, and 11) execute a set of intelligence tasks associated with an AI-driven Industrial Metaverse, and 12) execute a set of intelligence tasks associated with a set of financial executive digital twins, and 13) execute a set of intelligence tasks associated with enterprise transaction systems integration, 14) execute a set of intelligence tasks associated with an enterprise access layer, and 15) execute a set of intelligence tasks associated with AI-based enterprise transactional decision support, and 16) execute a set of intelligence tasks associated with a set of supply chains, and 17) execute a set of intelligence tasks associated with demand shaping integration, and 18) execute a set of intelligence tasks associated with a value chain network system of systems, and 19) execute a set of intelligence tasks associated with a set of executive digital twins for vehicle fleet operations, and 20) execute a set of intelligence tasks associated with a set of vehicle digital twins for design and simulation, and 21) execute a set of intelligence tasks associated with an enterprise access layer for fleet transactions, and 22) execute a set of intelligence tasks associated with software defined vehicle management, and 23) execute a set of intelligence tasks associated with a set of executive digital twins for enterprise energy operations, and 24) execute a set of intelligence tasks associated with enterprise energy system of systems integration, and 25) execute a set of intelligence tasks associated with an enterprise access layer for energy transactions, and 26) execute a set of intelligence tasks associated with AI-based enterprise transactional decision support for energy management.

### Offering Layer—General Systems

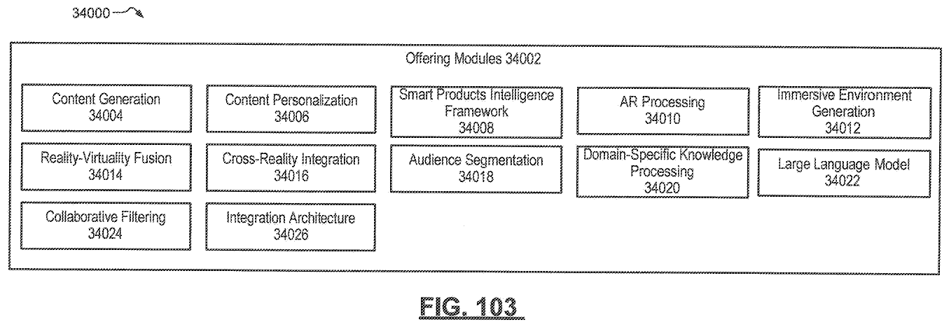

In embodiments, the system of systems 31000 includes an offering layer 34000 configured to create, manage, and enable offerings of the system of systems 31000 via a plurality of offering modules 34002. The offering layer includes an intelligent systems architecture that includes multiple sophisticated components configured to work together to deliver advanced capabilities across various domains. Referring to FIG. 103, the offering layer may include one or more of a content generation intelligence module 34004, a content personalization module 34006, a smart products intelligence framework module 34008, an AR processing module 34010, an immersive environment generation module 34012, a reality-virtuality fusion module 34014, a cross-reality integration module 34016, an audience segmentation module 34018, a domain-specific knowledge processing module 34020, a large language model (LLM) module 34022, a collaborative filtering module 34024, or an integration architecture module 34026.

### Content Generation

In embodiments, the content generation intelligence module 34004 is configured to leverage natural language processing (NLP) models that enable automated creation of diverse content types. The NLP models employ advanced transformer architectures to understand context, maintain coherence, and generate human-like text across multiple domains and styles. One or more deep learning networks dedicated to image and video generation may utilize generative adversarial networks (GANs) and diffusion models to create high-fidelity visual content, incorporating style transfer capabilities and content-aware generation features. One or more transformer-based architectures for multi-modal content synthesis enable seamless integration of text, images, audio, and video, creating cohesive multi-format content. One or more quality assurance and content validation mechanisms employ specialized neural networks that evaluate generated content against predefined quality metrics, ensuring consistency, accuracy, and appropriateness of all outputs.

### Content Personalization

In embodiments, the content personalization module 34006 implements sophisticated collaborative filtering neural networks that analyze user interactions and preferences across multiple dimensions. These networks utilize matrix factorization techniques enhanced with deep learning capabilities to identify complex patterns in user behavior. The user behavior analysis models incorporate both explicit and implicit feedback mechanisms, processing real-time interaction data to continuously refine user profiles. Real-time content adaptation engines employ reinforcement learning algorithms to dynamically adjust content presentation based on user responses and contextual factors. The personalization optimization algorithms utilize multi-armed bandit approaches combined with deep learning to balance exploration and exploitation in content recommendations.

In embodiments, the smart products intelligence framework module 34008 includes product behavior prediction models that utilize recurrent neural networks to forecast usage patterns and potential issues before they arise. The usage pattern recognition systems employ unsupervised learning techniques to identify clusters of similar usage behaviors and anomaly detection to flag unusual patterns. Adaptive learning mechanisms continuously update product parameters based on real-world usage data, optimizing performance through reinforcement learning approaches. The real-time performance monitoring neural networks process sensor data streams to maintain optimal product functionality and predict maintenance needs.

### Augmented Reality

In embodiments, the AR processing module 34010 includes one or more computer vision neural networks configured to utilize advanced convolutional architectures for real-time object recognition and tracking. Spatial mapping and tracking algorithms combine SLAM (Simultaneous Localization and Mapping) techniques with deep learning to create accurate environmental models. Real-time environment understanding models process multiple sensor inputs to maintain consistent AR experiences across varying conditions. The AR content placement optimization engines use sophisticated algorithms to determine optimal positioning of virtual elements within the physical space, considering both spatial and contextual factors.

### Virtual Reality

In embodiments, the immersive environment generation module 34012 includes one or more models within the VR intelligence layer configured to create photorealistic virtual spaces using advanced rendering techniques combined with neural radiance fields. Physics simulation neural networks ensure realistic object behavior and interactions within virtual environments. User interaction prediction systems anticipate user actions to reduce latency and improve responsiveness. Experience optimization algorithms continuously adjust rendering parameters and content delivery based on hardware capabilities and user preferences.

### Mixed Reality

In embodiments, the reality-virtuality fusion module 34014 enables seamless integration of virtual elements with physical environments through sophisticated scene understanding and rendering techniques. Environmental understanding neural networks process multiple sensor inputs to create accurate representations of physical spaces. Real-time scene analysis systems continuously update environmental models to maintain consistent mixed reality experiences. Interactive element placement algorithms optimize the positioning and behavior of virtual objects within the physical space.

### Extended Reality

In embodiments, the cross-reality integration module 34016 includes one or more models configured to enable consistent experiences across different reality platforms through unified representation models. Universal XR content adaptation networks automatically optimize content for different display types and interaction methods. Experience synchronization algorithms maintain temporal and spatial consistency across multiple users and devices. Multi-modal interaction processing systems handle various input methods including gesture, voice, and traditional controls.

### Targeted Advertising

In embodiments, the audience segmentation module 34018 includes one or more neural networks configured to utilize deep learning techniques to identify and categorize user groups based on behavioral and demographic data. Ad performance prediction models employ ensemble learning approaches to forecast campaign effectiveness across different channels. Real-time bidding optimization systems use reinforcement learning to maximize advertising ROI. Campaign effectiveness learning algorithms continuously update targeting strategies based on performance data.

In embodiments, the domain-specific knowledge processing module 34020 includes one or more models configured to utilize sophisticated knowledge representation schemes combined with neural networks for efficient information retrieval and processing. Decision support neural networks combine traditional rule-based systems with modern deep learning approaches for improved accuracy. Inference engine optimization systems employ probabilistic reasoning techniques enhanced by machine learning. Rule-based learning algorithms automatically extract and update domain rules from new data.

### Generative AI

In embodiments, the LLM module 34022 includes one or more models configured to incorporate transformer architectures with multiple (e.g., billions) of parameters for sophisticated text generation capabilities. Diffusion models for media creation utilize advanced noise prediction networks for high-quality image and video generation. Multi-modal synthesis networks enable coordinated generation of content across different modalities. Output quality validation systems employ specialized neural networks to ensure generated content meets quality and safety standards.

### Recommendation Systems

In embodiments, the collaborative filtering neural networks module 34024 includes one or more models configured to implement hybrid approaches combining memory-based and model-based techniques for accurate recommendations. Content-based recommendation models utilize deep learning for feature extraction and similarity computation. Hybrid recommendation systems combine multiple approaches through sophisticated ensemble techniques. Real-time preference learning algorithms continuously update user models based on interaction data.

In embodiments, the integration architecture module 34026 is configured to implement components through a microservices-based deployment model, where each intelligence component operates as an independent service with clearly defined interfaces. Container orchestration manages resource allocation and scaling, while the API-first design ensures consistent interaction patterns across all components. The event-driven architecture enables real-time processing and communication between components through a sophisticated message broker system.

### Transactions Layer

In some example embodiments, a system-of-systems (SOS) (e.g., system of systems 31000) may include a transaction layer 35000 that includes a set of hardware and/or software-defined transaction modules that may interact with one another and/or other layers of the SOS to automate, optimize, execute, and/or otherwise facilitate digital transactions on behalf of an entity, such as an enterprise. In example embodiments, a transaction layer 35000 may deploys and/or leverages various types of AI models (e.g., generative AI models, neural networks, machine-learning models, and/or other types of models) to perform various tasks associated with a transaction (e.g., transaction execution, transaction fulfillment, transaction reconciliation, opportunity discovery, and/or the like).

In example embodiments, the transaction layer 35000 may interfaces with other layers of a system of systems 31000. In these example embodiments, the transaction layer 35000 may provide a set of services to one or more layers modules of the SOS and/or request services from the other layers. For example, an enterprise layer 33000 may initiate a transaction in response to receiving an invoice from a third-party service or goods provider by requesting a transaction from the transaction layer. In a related example, the transaction layer 35000 may request approval services from a governance layer 32000 before the transaction layer 35000 executes a requested transaction on behalf of the enterprise using a digital wallet controlled by the transaction layer. Other examples relating to the transaction layer 35000 are discussed below.

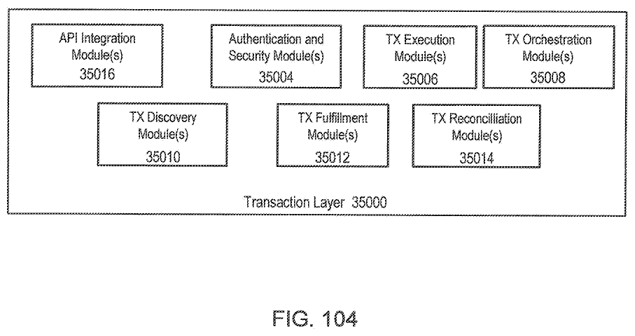

FIG. 104 illustrates an example set of modules of an example transaction layer 35000. These may include API integrations modules 35016, authentication and security modules 35004, transaction execution modules 35006, transaction orchestration modules 35008, transaction discovery modules 35010, transaction fulfillment modules 35012, transaction reconciliation modules 35014, and/or other suitable modules.

In example embodiments, the transaction layer modules may can include and/or leverage cloud-based virtualized containerization capabilities and services, such as without limitation a container deployment and operation controller, such as Kubernetes or the like. Cloud-based virtualized containers may provide for data layers to be deployed close to source data, thereby potentially reducing network bandwidth consumption or the potential for network disturbances in a data workflow, especially when addressing voluminous local situations such as in industrial and commercial environments.

In example embodiments, technologies may be provided by and/or enabled by the data layer system of systems 38000 include intelligence services 38606, such as artificial intelligence, machine learning and the like. These intelligence services 38606 may be provided by the data layer SoSs 38000, or accessed (e.g., as third-party services) via one or more. The data layer control 38560 may be provided access to the intelligence services 38606. In example embodiments, the data layer control 38560 may provide its own set of intelligence services.

### Interfaces and Security

In example embodiments, the transaction layer 35000 may implement a secure integration framework for interfacing with external systems, such as financial institutions, digital marketplaces, and/or blockchain networks. In example embodiments, the secure integration framework may include one or more authentication and security module(s) 35004 that manage and facilitate secure connections with external systems. In example embodiments, an authentication and security module 35004 may implement respective security capabilities such as, but not limited to, multi-factor authentication, public key infrastructure (PKI) based certificate management, hardware security modules (HSMs) for cryptographic key storage and management, encrypting communication channels (e.g., using TLS 1.3 or higher), OAuth 2.0 and OpenID Connect for API authorization, IP address whitelisting, API key rotation mechanisms, and/or the like. It is appreciated that the authentication and security module 35004 may implement other respective security capabilities.

In example embodiments, the transaction layer 35000 may implements an API integration framework that may provide standardized interfaces for connecting to different types of external systems (e.g., 3^{rd} party data sources, financial institution platforms, digital marketplaces, blockchains, user devices, IoT devices, and/or the like). In these example embodiments, the transaction layer 35000 may include one or more API integration modules 35016 that implement various types of APIs and protocols including RESTful APIs for financial institution connections, WebSocket implementations for real-time market data streams, FIX protocol integration for trading systems, ISO 20022 message formats for financial transactions, GraphQL interfaces for flexible data querying, webhook handlers for asynchronous transaction notifications, and/or the like.

### Transaction Execution

In example embodiments, the transaction layer 35000 may include one or more transaction execution modules 35006. In example embodiments, a transaction execution module 35006 may be configured to execute transactions on behalf of an entity. In these example embodiments, a transaction execution module 35006 may be configured to control one or more accounts of the entity. In some of these example embodiments, a transaction execution module 35006 may control one or more entity digital wallets, where each digital wallet may be configured to execute transactions from an entity account and/or one or more marketplaces. For example, a digital wallet may be configured to facilitate blockchain transactions on behalf of the entity using the credentials (e.g., private key and/or public key) of a blockchain account of the entity. In another example, a second digital wallet may be configured to securely interface with the virtual infrastructure of a respective financial institution (e.g., using an API of the financial institution and account credentials of a respective entity) to transfer funds from an account of the entity to another entity (e.g., via a bank-to-bank wire, an account transfer within the bank, or the like). In another example, a digital wallet may interface with one or more digital marketplaces or exchanges (e.g., using an API of the marketplace/exchange). In these example embodiments, the digital wallet may be configured to transact for assets. Examples of assets that may be transacted for via a marketplace may include financial assets (e.g., foreign currencies, stocks, bonds, commodities, and/or the like), physical items (e.g., real estate, fungible goods, collectible items, and/or the like), resources (e.g., energy resources, computing resources, network resources, and/or the like). Examples of the types of transactions (or related actions) that may be performed by a digital wallet on a marketplace may include selling an asset of the entity, purchasing an asset, offering an asset for sale, making a bid on an asset, and/or the like.

In example embodiments, a transaction execution module 35006 may causes a digital wallet to perform a specific transaction (e.g., instructing a financial institution to transfer a specific amount from a specific account of the entity to a specific recipient/account; instructing a crypto wallet to generate and digitally sign a transfer request for a specific amount of cryptocurrency on a blockchain using the public key and/or private key corresponding to a specific account of the entity on the blockchain; instructing a digital wallet to purchase a specific amount of stock on an exchange; instructing a digital wallet to purchase an amount of a resource on a future or spot resource market; and/or the like).

In example embodiments, a transaction execution module 35006 may implement specialized digital wallet capabilities that execute different types of transactions using respective transaction channels. For example, blockchain transactions, a transaction execution module 35006 may implement multi-signature wallet capabilities with configurable M-of-N schemes, transaction signing (e.g., using elliptic curve cryptography), gas optimization algorithms, smart contract interaction through Application Binary Interface (ABI) encoding/decoding, and/or the like. For traditional financial transactions, a transaction execution module 35006 may implement Automated Clearing House (ACH) transaction processing with NACHA file format support, Society for Worldwide Interbank Financial Telecommunication (SWIFT) message generation for international wire transfers, real-time payment system integration, automated reconciliation using ISO 20022 messages, and/or payment card processing through tokenization services. For example, digital marketplace transactions, a transaction execution module 35006 may implement order book management systems, price discovery algorithms, automated trading interfaces, position management and risk monitoring capabilities, market making functionality with configurable spreads, and/or liquidity aggregation across multiple venues.

In example embodiments, a security module 35004 may allow a transaction execution module to interface with a respective transaction channel. In these example embodiments, when a transaction execution module 35006 receives a request to execute a transaction, the security module 35004 may authenticate the transaction request and establish a secure connection with the respective transaction channel corresponding to the transaction request. For example, when executing a blockchain transaction, the authentication and security module 35004 may retrieve the private key of the respective blockchain account from a secure credential vault, which may allow a transaction execution module to digital sign the requested transaction that may be provided to a blockchain network to complete the transaction. In another example, when executing a bank transfer, the security module 36006 may retrieve the account credentials from the secure credential vault, verify the authenticity of the transaction request using various authentication protocols, and establish a secure connection with the bank's API. In example embodiments, a secure credential vault may store and manages authentication credentials used by the transaction execution modules 35006. The credential vault may implement hardware-backed key storage, an encrypted credential database, key rotation policies, access control lists, audit logging of credential usage, and/or secure credential injection into API calls.

In example embodiments, the transaction execution module 35006 may receive an instruction to perform a transaction from another transaction module, another layer of the SoS, and/or from a user associated with the entity. In example embodiments, the transaction execution module 35006 may receive a set of transaction parameters that specify information needed to execute the transaction, such as the account/digital wallet involved in the transaction, the type of transaction (e.g., sending funds, requesting funds, bidding on an item, and/or the like), the transaction amount, the account and/or digital wallet to use for the transaction, and/or any other suitable information. In response, the transaction execution module 35006 may generate an instruction to a selected enterprise digital wallet based on the transaction parameters. In response, the digital wallet may attempt to execute the transaction. In example embodiments, the digital wallet may return an outcome of the transaction (e.g., whether the transaction was successful or unsuccessful) as well as any other relevant metadata (e.g., timestamp, a receipt, an amount transferred, etc.). In response, the transaction execution module 35006 may provide the transaction outcome to various modules of the transaction layer and/or another layer of the SoS.

### Transaction Orchestration

In example embodiments, the transaction layer 35000 may include one or more transaction orchestration modules 35008 that may be configured and trained to automate and/or manage one or more tasks of a transaction workflow on behalf of an enterprise. In example embodiments, the transaction orchestration module 35008 may be configured to determine a transaction orchestration workflow, initiate various tasks within a transaction orchestration workflow (which may be performed by other transaction modules of the transaction layer 35000), monitor outcomes of those tasks, and/or selectively initiate subsequent tasks based on the outcomes. In example embodiments, a transaction orchestration module 35008 may be configured to deploy an intelligent agent that may be configured and trained to orchestrate the tasks of a transaction on behalf of an enterprise, which may be referred to as a transaction orchestration agent. For example, a transaction orchestration agent transaction orchestration module 35008 may initiate a transaction discovery task that identifies a potential transaction and/or one or more potential counterparties for the potential transaction. In this example, the transaction orchestration agent may be granted authority to selectively initiate a next stage of a transaction workflow based on an outcome of the transaction discovery task or the transaction orchestration agent may be instructed by a user to initiate the next stage. In either scenario, the intelligent transaction orchestration agent may then initiate the generation of a transaction. In some transaction workflows, the generation of a transaction may include determining a set of transaction parameters corresponding to the transaction. For example, if the transaction involves cryptocurrencies and/or a smart contract, the transaction parameters may include the blockchain address of the accounts and/or smart contract involved in the transaction (e.g., the recipient and/or sender of the cryptocurrency and/or the smart contract that is facilitating the blockchain transaction), an amount of cryptocurrency to be sent, a transaction request that is generated for digital signature, an object of the transaction (e.g., an identifier of the digital or real-world asset being transacted for, an identifier of a service being paid for, and/or the like), and/or other suitable transaction parameters. In an example of a real estate transaction, the transaction parameters may include an identifier of the property being transferred, purchaser information, seller information, a purchase price, and/or other supplemental information that may be used to generate documents relating to the real estate transaction and/or transfer of ownership of the property from one entity to a purchasing entity, and/or the like. In some example embodiments, the transaction orchestration agent may automate a contract negotiation with a counterparty to the transaction to determine the set of transaction parameters. Additionally or alternatively, a user of the system may provide some or all of the transaction parameters (e.g., via a user interface).

In some example embodiments and some types of transaction workflows, the user may designate (e.g., via a user interface) an enterprise account and/or digital wallet to perform the transaction. Alternatively, a transaction orchestration agent may be trained to select appropriate accounts for particular transactions. In some of these example embodiments, a transaction orchestration agent may be trained to determine which accounts to use for a particular transaction by analyzing various transaction parameters and conditions. For example, the transaction orchestration agent may analyze the marketplace and/or location (e.g., country, state, city) where the transaction will take place to determine whether specialized accounts are needed (e.g., accounts that are pre-approved or whitelisted for the location or are compatible with the marketplace). The transaction orchestration agent may also analyze whether the transaction involves blockchain or traditional financial transaction rails to select an account that may be configured for the respective transaction channel. The transaction orchestration agent may also analyze the transaction amount to determine whether the selected account has sufficient funds or whether the transaction amount exceeds predefined transaction limits for the account. The transaction orchestration agent may also analyze the purpose of the transaction (e.g., whether it is for operational expenses, investment purposes, or other business purposes) to select an account that may be designated for that type of transaction. The transaction orchestration agent may also analyze historical transaction patterns, risk parameters, compliance requirements, and/or enterprise policies to ensure the selected account aligns with enterprise guidelines and risk tolerance levels. In response to determining which account/digital wallet to use, the transaction orchestration module 35008 may then instruct a transaction execution module 35006 to generate and execute the transaction.

It is appreciated that a transaction orchestration agent may be trained to orchestrate other types of tasks within a transaction workflow. For example, in some example embodiments a transaction orchestration agent may initiate transaction discovery tasks. In this example, the orchestration agent may be deployed to initiate a transaction discovery task (e.g., using a transaction discovery module), and in response to being provided a transaction opportunity, determine whether to proceed with the transaction. In another example, a transaction orchestration agent may initiate post-transaction tasks, such as fulfillment and reconciliation.

### Transaction Discovery

In example embodiments, the transaction layer 35000 may include one or more transaction discovery modules. In example embodiments, a transaction discovery module 35010 may be configured to analyze data from disparate data sources for purposes of identifying potential transactions on behalf of an entity. For instance, the transaction discovery module 35010 may be configured and trained to discover potential in-bound transactions that align with an asset class or a strategy/transaction profile provided by a user. Additionally or alternatively, the transaction discovery module 35010 may be configured and trained to discover potential outbound transactions for an asset or class of assets in response to receiving an indicator of the asset or class of asset. It is appreciated that a transaction discovery module 35010 may be configured to discover different types of transactions that involve different types of asset classes. For example, in some example implementations, a transaction discovery module 35010 may be configured to identify potentially distressed assets that may be potential transaction targets. In another example, a transaction discovery module 35010 may monitor various marketplaces to identify potential arbitrage opportunities and/or opportunities to purchase energy, raw materials, and/or other resources that an enterprise may require in the future.

In example embodiments, the transaction discovery module 35010 may request or subscribe to data feeds and/or event notifications from the data layer—which may deploy intelligent agents that monitor a large number of data sources from which the data feeds and/or event notifications are mined and/or curated. The transaction discovery module 35010 may include one or more intelligence models (e.g., a set of machine learning models, neural networks, and/or other types of artificial intelligence models) and/or may interface with an intelligence system that may collectively process the data feeds and/or event notifications received from the data layer and may identify potential in-bound or outbound transactions based on the monitored data feeds and/or event notifications. In some of these example embodiments, the transaction discovery module 35010 may parse, structure, vectorize, and analyze the curated data feeds and/or event data. The transaction discovery module 35010 may then feed this data into its intelligence models, which may output potential transactions that may align with a requested asset class or transaction profile.

In example embodiments, the transaction discovery module 35010 may utilizes data from disparate sources to identify potential transactions. For example, in the context of arbitrage opportunities on decentralized cryptocurrency exchanges, the transaction discovery module 35010 may monitor real-time price feeds and order book data from multiple decentralized exchanges to identify price discrepancies that may present arbitrage opportunities. In these example embodiments, the transaction discovery module 35010 may analyze liquidity pools, calculate potential arbitrage spreads while accounting for transaction costs (e.g., gas fees, slippage), identify optimal routing paths between exchanges, monitor pending transactions in a memory pool that may impact arbitrage opportunities, and track historical price correlations and volatility patterns. The transaction discovery module 35010 may feed this data into its intelligence models to identify and score potential arbitrage opportunities.

In another example focused on discovery of real estate transaction opportunities, the transaction discovery module 35010 may monitor multiple data sources including property listings, foreclosure notices, tax records, satellite imagery, property condition reports, building permits, construction activity, comparable sales data, demographic data, and economic indicators. The transaction discovery module 35010 may analyze this data to identify properties that may match specific investment criteria (e.g., distressed properties, properties in developing areas, properties with potential for value appreciation). The transaction discovery module 35010 may use its intelligence models to parse and structure the raw data feeds, vectorize text and numerical data, apply natural language processing to unstructured content, identify patterns and correlations across data sources, generate opportunity scores and risk assessments, and rank potential transactions based on their alignment with enterprise investment criteria, etc. In identifying a potential property, the transaction discovery module 35010 may also determine an estimated value of the property and/or a proposed purchase price. In some example embodiments, the transaction discovery module 35010 may output the potential transaction opportunity to a transaction orchestration module 35008, which in turn may notify a decision maker regarding the opportunity, configure an offer to purchase the property, submit a bid on the property (e.g., if for sale or being auctioned), and/or the like.

### Transaction Fulfillment and Reconciliation

In example embodiments, the transaction layer 35000 may include one or more transaction fulfillment modules 35012 that may be configured to manage and automate post-execution requirements of a transaction. In example embodiments, a transaction fulfillment module 35012 may be configured to monitor the status of a transaction after the transaction has been initiated by a transaction execution module 35006. For example, after a transaction execution module 35006 initiates a transfer of funds via a financial institution, the transaction fulfillment module 35012 may monitor the status of the transfer to determine whether the transfer was successful. In another example, after a transaction execution module 35006 initiates a blockchain transaction, the transaction fulfillment module 35012 may monitor the status of the blockchain transaction (e.g., by monitoring the number of block confirmations) to determine whether the transaction has been confirmed on the blockchain. In example embodiments, the transaction fulfillment module 35012 may generate notifications regarding the status of transactions and/or may trigger subsequent actions based on transaction status. For example, the transaction fulfillment module 35012 may generate a notification when a transaction is confirmed or may trigger the generation of transaction documentation (e.g., receipts, confirmations, transfer records, settlement instructions) when a transaction is completed.

In example embodiments, the transaction layer 35000 may include one or more transaction reconciliation modules 35014 that may be configured to verify and validate completed transactions across multiple systems of record. In example embodiments, a transaction reconciliation module 35014 may compare transaction records across internal and external systems to identify and flag any discrepancies. For example, a transaction reconciliation module 35014 may compare transaction records in an enterprise accounting system with transaction records from a financial institution to ensure that the records match. In another example, a transaction reconciliation module 35014 may compare blockchain transaction records with internal transaction records to verify that blockchain transactions were executed as intended. In example embodiments, the transaction reconciliation module 35014 may implement one or more machine learning models that may be configured and trained to detect patterns in transaction data, identify potential reconciliation issues, automate the classification of transaction exceptions, and/or suggest resolution actions for common reconciliation scenarios.

In example embodiments, the transaction reconciliation module 35014 may interface with enterprise accounting systems, financial reporting systems, and/or regulatory compliance systems to ensure accurate transaction recording and reporting. The transaction reconciliation module 35014 may implement standardized reconciliation protocols (e.g., ISO 20022) and may support various data formats (e.g., MT940, BAI2, SWIFT) for automated reconciliation processes. In example embodiments, the transaction reconciliation module 35014 may maintain audit trails of reconciliation activities and may generate exception reports for transactions that require manual review.

### Transaction Discovery System

In example embodiments, transaction layer 35000 may implement multiple specialized transaction systems that work together to form a comprehensive transaction management framework. The transaction discovery system may leverage artificial intelligence capabilities to identify and analyze potential transaction opportunities across multiple data sources. This system may process real-time market feeds, historical patterns, and/or other data to identify opportunities like arbitrage or resource acquisition needs, while providing automated compliance checks through integration with the governance layer 32000.

In example embodiments, a transaction discovery system may leverage artificial intelligence capabilities across multiple layers to identify and analyze potential transaction opportunities. The system may employ contextual simulation and forecasting capabilities from the enterprise layer to evaluate transaction scenarios and predict outcomes, while utilizing expert systems and generative AI from the offering layer to customize and configure transaction parameters. The system may process data from various sources (e.g., real-time market feeds, books, and historical transaction patterns) to identify opportunities such as arbitrage, distressed assets, or resource acquisition needs. Deep learning networks may analyze market trends and transaction patterns while reinforcement learning algorithms may optimize transaction routing and execution strategies. The system may interface with the governance layer to ensure automated compliance checks and regulatory adherence for discovered transactions, while leveraging the operations layer for automated monitoring and execution workflows. For financial use cases, the system may monitor multiple marketplaces simultaneously to identify price discrepancies, analyze liquidity pools, calculate potential spreads while accounting for transaction costs, and determine optimal routing paths between exchanges. The system may also employ predictive analytics to forecast resource needs and market conditions, enabling proactive transaction discovery for enterprise resource planning and strategic asset acquisition. Implementation may utilize distributed computing resources at both edge and cloud levels to ensure real-time processing capabilities, with AI-driven anomaly detection systems monitoring network health and transaction patterns for potential opportunities or risks.

### Transaction Generation System

Building on discovery capabilities, a transaction generation system may employ smart contract orchestration engines and generative AI to create and configure digital transactions. This system may automatically configure transaction parameters, including blockchain addresses, cryptocurrency amounts, and/or digital signatures, while implementing security protocols through AI-driven authentication systems.

In example embodiments, a transaction generation system may integrate multiple layers of AI capabilities to create and configure digital transactions. The system may employ smart contract orchestration engines to automate transactional workflows and may leverages generative AI to propose transaction parameters and configurations. The system may utilize deep learning models to analyze transaction parameters, determine optimal routing paths, and generate appropriate transaction documentation. The system may interface with enterprise wallets and digital infrastructure to execute transactions across multiple platforms, marketplaces, and exchanges through a common point of access. For financial transactions, the system may automatically configure transaction parameters including blockchain addresses, cryptocurrency amounts, digital signatures, and/or smart contract interactions. The system may employ natural language processing for automated extraction of transaction requirements from unstructured communications, while implementing security protocols through AI-driven authentication systems that may ensure secure access while enabling rapid response to market opportunities. In example embodiments, the transaction generation system may differ from the transaction discovery system by focusing on the creation and configuration of transaction parameters and documentation rather than opportunity identification, utilizing distinct AI capabilities such as smart contract orchestration and automated parameter generation rather than market monitoring and opportunity analysis. The system may also tokenize digital assets to digitally represent transactions within the enterprise ecosystem and may employ blockchain technology to manage and secure the generated transactions. Implementation may include integration with governance systems to ensure automated compliance checks during transaction generation, while maintaining audit trails through immutable transaction recording.

### Transaction Optimization System

In example embodiments, a transaction optimization system may integrate AI capabilities across multiple layers to maximize efficiency and effectiveness of transaction execution. The transaction optimization system may maximize efficiency by employing resource optimization AI to dynamically allocate processing power and may optimize transaction parameters. For financial transactions, the system may analyze liquidity pools, calculate optimal transaction costs, and/or determine efficient routing paths between exchanges, leveraging the intelligence system for model-based market predictions. The system may employ resource optimization AI to dynamically allocate processing power and optimize transaction parameters while analyzing leverage ratios in real-time to balance returns against risk exposure. The system may utilize predictive analytics and machine learning models to optimize transaction routing, fee management, and/or timing across multiple networks and marketplaces. For financial transactions, the system may analyze liquidity pools, calculate optimal transaction costs including gas fees and slippage, and determine the most efficient routing paths between exchanges. The system may leverage the intelligence system to provide model-based market predictions, including currency exchange rates, future prices, transaction volumes, and/or interest rates to optimize transaction timing and execution. The optimization system may specifically concentrate on enhancing transaction efficiency through real-time analytics and dynamic parameter adjustment. The system may employ deep learning networks for pattern recognition and predictive analytics, while utilizing distributed ledger technology for transparent tracking of optimization decisions. Implementation may include integration with the operations layer for automated monitoring and the resource layer for computational resource optimization, while maintaining compliance through automated governance checks. The system may also optimize multi-step trading workflows while reducing error rates and may employ AI-driven models to predict market volatility and credit risk, enabling proactive optimization of transaction parameters.

### Transaction Reconciliation System

In example embodiments, a transaction reconciliation system may leverage multiple layers of AI capabilities to verify and validate completed transactions across multiple systems of record. The system may implement machine learning models configured and trained to detect patterns in transaction data, identify potential reconciliation issues, automate the classification of transaction exceptions, and suggest resolution actions for common reconciliation scenarios. Working with the transaction optimization system, the transaction reconciliation system may verify completed transactions across multiple systems of record using machine learning models trained to detect patterns and identify potential reconciliation issues. This system may interface with enterprise accounting systems and may implement standardized reconciliation protocols while maintaining detailed audit trails. The system may interface with enterprise accounting systems, financial reporting systems, and/or regulatory compliance systems to ensure accurate transaction recording and reporting, while implementing standardized reconciliation protocols and supporting various data formats for automated reconciliation processes. For financial transactions, the system may compare transaction records across internal and external systems, such as comparing enterprise accounting records with financial institution records or blockchain transaction records with internal transaction records to verify execution accuracy. The reconciliation system specifically may concentrate on post-execution verification and validation. The system may employ the intelligence system's capabilities for pattern recognition and anomaly detection, while leveraging the governance layer to ensure compliance with regulatory requirements during reconciliation. Implementation may include maintaining detailed audit trails of reconciliation activities and generating exception reports for transactions requiring manual review, while utilizing the operations layer for automated monitoring and workflow orchestration. The system may also interface with digital wallets and blockchain systems to verify cryptocurrency transactions and smart contract executions, ensuring comprehensive reconciliation across both traditional and digital asset transactions.

### Transaction Fulfillment System

In example embodiments, a transaction fulfillment system may integrate AI capabilities across multiple layers to manage and automate post-execution requirements of transactions. The system may monitor transaction status after initiation, such as tracking fund transfers through financial institutions or monitoring blockchain transaction confirmations, while generating automated notifications regarding transaction statuses and triggering subsequent actions based on completion milestones. The transaction fulfillment system may manage post-execution requirements by monitoring transaction status and generating automated notifications. The system may track fund transfers, verify blockchain confirmations, and/or automatically generate transaction documentation, while interfacing with payment service providers and banks to facilitate execution. For financial transactions, the system may monitor the status of transfers, verify block confirmations for blockchain transactions, and automatically generate transaction documentation including receipts, confirmations, transfer records, and/or settlement instructions when transactions are completed. In an example embodiment, the fulfillment system specifically may concentrate on post-execution monitoring and documentation management. The system may leverage the operations layer for automated monitoring and workflow orchestration, while utilizing the intelligence system for predictive analytics to anticipate potential fulfillment issues. Implementation may include integration with enterprise digital wallets and blockchain interfaces to monitor cryptocurrency transactions and smart contract executions, while maintaining compliance through automated governance checks. The system may also interface with payment service providers (PSPs), acquirers, and banks to communicate appropriate information for facilitating and executing transaction fulfillment, while employing AI-driven anomaly detection to identify potential fulfillment issues requiring attention.

### Counterparty Discovery System

In example embodiments, a counterparty discovery system may integrate AI capabilities across multiple layers to identify and evaluate potential transaction partners. The system may leverage model-based counterparty predictions and discovery capabilities from the intelligence system to predict liquidity of counterparties and identify parties likely to buy or sell given assets. The counterparty discovery system may identify and evaluate potential transaction partners using model-based predictions to assess liquidity and compatibility. The system may analyze market behaviors and transaction histories while leveraging scoring systems to assess reliability through know-your-customer technology. For financial transactions, the system may analyze market behaviors, transactional histories, and compatibility metrics to recommend optimal transactional matches, while utilizing deep learning networks to assess various parameters including counterparty risk profiles and transaction volumes. The counterparty discovery system may specifically focus on identifying and/or evaluating potential transaction partners. The system may employ natural language processing for analyzing unstructured data about potential counterparties, while leveraging the scoring system to assess reliability through know-your-customer technology and determine counterparty identities. Implementation may include integration with blockchain scoring systems to assess the reliability of potential counterparties on distributed ledgers, while maintaining compliance through automated governance checks and risk management protocols. The system may also interface with social data and IoT data sources to gather additional insights about potential counterparties, while utilizing predictive analytics to forecast the likelihood of successful transaction execution with identified parties.

### Transaction Orchestration System

In example embodiments, a transaction orchestration system may integrate AI capabilities across multiple layers to automate and manage transaction workflows within the transaction layer. The system may employ transaction orchestration agents configured and trained to determine transaction orchestration workflows, initiate various tasks within those workflows, monitor outcomes, and selectively initiate subsequent tasks based on those outcomes. The transaction orchestration system may coordinate various components by employing AI-configured agents to determine workflows, initiate tasks, and/or monitor outcomes. The system may manage end-to-end orchestration of transactions while interfacing with multiple transaction rails and digital wallets. For financial transactions, the system may manage end-to-end orchestration of payment transactions, including payment authorization, transaction routing, transaction settlement/execution, and/or post-transaction tasks. In example embodiments, the transaction orchestration system may specifically coordinates the entire transaction lifecycle across multiple systems and processes. The system may leverage the intelligence system to obtain model-based market predictions, counterparty predictions, and/or transaction recommendations, while utilizing content generation services for customized offer generation and document review. Implementation may include integration with payment service providers, acquirers, and/or banks to communicate appropriate information for facilitating transactions, while maintaining compliance through automated governance checks. The system may interface with multiple transaction rails and digital wallets, selecting optimal transaction methods based on factors such as transaction type, volume, format, location, financing, and associated costs. The system may employ AI-driven models to analyze currency needs and automate currency conversion tasks when transactions require conversion to target currencies.

### Contract Configuration System

In example embodiments, a contract configuration system may integrate AI capabilities across multiple layers to automate and manage the creation, customization, and configuration of transaction-related contracts. The system may employ expert systems and generative AI from the offering layer to analyze transaction parameters and automatically generate appropriate contract terms, while utilizing natural language processing for automated extraction of contract requirements from unstructured communications and documents. The contract configuration system may automate the creation and management of transaction-related contracts using expert systems and generative AI. The system may analyze parameters to generate appropriate contract terms while ensuring compliance through automated checks and maintaining detailed audit trails. For financial transactions, the system may automatically configure contract parameters including payment terms, interest terms, licensing terms, and other contractual obligations, while dynamically adjusting terms based on changes in regulatory requirements or enterprise policies. In example embodiments, the contract configuration system may specifically concentrate on contract creation and management. The system may leverage the intelligence system to provide content generation services for customized contract generation and document review, while utilizing the governance layer to ensure automated compliance checks during contract configuration. Implementation may include integration with enterprise document management systems and workflow systems to manage contract versions and approval processes, while maintaining detailed audit trails of contract modifications. The system may also employ AI-driven models to analyze historical contract data and propose optimal terms based on enterprise objectives and risk parameters, while utilizing federated learning techniques to share contract intelligence across enterprise systems while preserving confidentiality.

### Market Orchestration System

In example embodiments, a market orchestration system may integrate AI capabilities across multiple layers to manage and coordinate market activities within the transaction layer. The system may employ AI-based market predictions and analytics to provide insights for strategic decision-making within marketplaces, while utilizing intelligence services to optimize market operations and transaction flows. The market orchestration system may coordinate market activities using AI-based predictions and analytics for strategic decision-making. The system may manage various transactional systems including asset valuation, collateralization, and/or market governance while leveraging intelligence services to optimize market operations. For financial transactions, the system may manage various transactional systems including asset valuation, collateralization, tokenization, market making, and market governance and trust systems, while leveraging the functionality of configured intelligence services to execute market-related tasks. In example embodiments, the market orchestration system may specifically focus on market-level coordination and management. The system may leverage configured intelligence service systems to process intelligence requests and generate responses including decisions, recommendations, reports, instructions, classifications, pattern recognition, predictions, and optimizations. Implementation may include integration with various market types, such as lending marketplaces, where the system performs tasks requiring external information for functions like asset valuations, inventory access, business profile management, and market analysis. The system may employ AI-driven models to analyze market conditions, automate market-making activities, and manage market governance through automated compliance checks and risk management protocols. The system may utilize federated learning techniques to share market intelligence across enterprise systems while preserving confidentiality and implement market orchestration workflows that define sets of tasks performed given specific market parameters.

### Automated Transaction Orchestration System

In example embodiments, an automated transaction orchestration system may integrate AI capabilities across multiple layers to provide end-to-end automation of transaction processes within the transaction layer. The system may employ robotic process automation (RPA) modules configured to automate procurement processes based on inventory levels and predictive demand analysis, while interfacing with vendor management systems to streamline supply chain operations. The automated transaction orchestration system may provide end-to-end automation using robotic process automation modules for processes such as procurement and payment authorization. The system may interface with vendor management systems and may implement automated governance through embedded policy capabilities. For financial transactions, the system may automate payment processes including payment authorization, transaction routing, and settlement tasks, while coordinating with payment service providers, acquirers, and banks to communicate appropriate transaction information. In example embodiments, the automated transaction orchestration system may specifically concentrate on fully autonomous execution of transaction workflows. The system may leverage the intelligence system to implement automated targeting and customized offer configuration, while utilizing AI algorithms to predict user needs and proactively present relevant marketplace services. Implementation may include integration with enterprise resource planning (ERP) systems to identify procurement needs, customer relationship management (CRM) systems to tailor marketplace services based on customer profiles, and IoT devices to offer maintenance and repair services based on sensor data. The system may employ AI-driven models for automated spot market testing and arbitrage transaction execution, while utilizing artificial intelligence capabilities for routing, control, optimization, and generation to manage the entire lifecycle of financial transactions. The system may implement automated governance through embedded policy and governance AI capabilities, ensuring continuous compliance monitoring and automated reporting.

### Transaction System-of-Systems

In example embodiments, a transaction system-of-systems may integrate multiple specialized transaction subsystems to create a comprehensive transaction management framework within the transaction layer. The system may coordinate and manage interactions between transaction discovery, generation, optimization, reconciliation, fulfillment, counterparty discovery, smart contract orchestration, market orchestration, and automated transaction orchestration subsystems, while leveraging AI capabilities across multiple layers to ensure seamless integration and operation. The transaction system-of-systems may integrate all of the systems of the transaction layer into a comprehensive framework that may enable enterprises to interface with multiple markets through a common access point. The system may implement converged AI-based workflow orchestration while maintaining comprehensive reporting capabilities and may enable distributed transactions through intelligent edge capabilities. For financial transactions, the system may provide a unified framework that enables enterprises to interface with multiple markets, marketplaces, exchanges, and platforms through a common point of access, while simplifying bilateral or multilateral transactions involving the enterprise. In example embodiments, the transaction system of systems specifically provides comprehensive orchestration and coordination across all transaction-related functions. The system may leverage the intelligence system to implement AI-based enterprise transactional decision support through contextual simulation and forecasting, while utilizing embedded policy and governance AI capabilities for automated compliance monitoring. Implementation may include integration with enterprise access layers that interface with enterprise resources, workflow systems, data services systems, permissions systems, and wallets systems, while maintaining comprehensive reporting capabilities. The system may implement converged AI-based transaction workflow orchestration at the operations layer and intelligent edge capabilities for distributed transactions at the network layer, enabling comprehensive transaction management across the enterprise ecosystem.

### Operations Layer

In embodiments, the techniques described herein relate to a computer-implemented system for managing operations of a set of artificial intelligence systems. In embodiments, the computer-implemented system includes a processor and a memory storing instructions that, when executed by the processor, cause the system to store a set of operations, wherein each operation of the set of operations is associated with at least one artificial intelligence system of the set of artificial intelligence systems, and initiate at least one operation of the stored set of operations with at least one artificial intelligence system of the set of artificial intelligence systems that is associated with the least one operation.

In embodiments, the AI convergence system of systems 31000 includes an operations layer 36000 that causes the AI convergence system of systems 31000 to store a set of operations. For example, each operation may include a description of the operation to be performed. The description may include computer-readable instructions that are executable by one or more processors of one or more devices (e.g., a server, a workstation, a mobile device, an edge device, a virtual device, or the like, or a combination thereof), which may be internal to and/or external to the AI convergence system of systems 31000. The description may include human-readable instructions that describe an operation in a natural language, such as English. The description may be provided at a high level of detail and/or a low level of abstraction (e.g., a sequence of computer-executable instructions in machine language or a compilable programming language, a script of computer-interpretable expressions in an interpreted programming language, a declarative description of the operation in a declarative language such as XML, a flowchart, a mathematical description of an algorithm, or the like) that a processor may follow to perform the operation. The description may be provided at a low level of detail and/or a high level of abstraction (e.g., a summary or overview of an operation that the AI convergence system of systems 31000 may interpret, design, generate, and execute). The description may include an indication of one or more artificial intelligence systems that may be associated with the operation, such as artificial intelligence systems that may perform the operation, upon which the operation may be performed, and/or that may participate in the design, development, generation, execution, monitoring, and/or refinement of the operation. The description may include an indication of one or more resources associated with the operation (e.g., data sources that provide or receive data associated with the operation, storage devices or locations where data associated with the operation may be stored, and/or processing devices that may participate in the operation). The description may include an indication of one or more conditions under which an operation is to be initiated, performed, and/or stopped (e.g., a schedule for initiating the operation on a periodic basis; a trigger condition that causes a device to initiate, perform, and/or stop the operation; and/or types of artificial intelligence systems that may be included and/or associated with a performance of the operation). The description may include an indication of one or more outcomes of the operation (e.g., an expected outcome when the operation is performed in certain conditions, and/or a log of outcomes of one or more previous performance of the operation). The set of operations may include one or more pregenerated operations that are available to be initiated in various contexts. The set of operations may include one or more ad-hoc operations that are generated for a particular instance, context, circumstance, device, artificial intelligence system, or the like. Following initiation and/or completion of an ad-hoc operation, the operation layer 36000 may continue storing the operation with the set of operations (e.g., converting the ad-hoc operation into a pregenerated operation for future execution) or may discard the ad-hoc operation. The set of operations may include one or more operation templates to serve as a basis for other operations (e.g., a set of device-specific stored operations that are based on a common device-independent operation template, or an ad-hoc operation that adapts an operation template for a particular instance).

In embodiments, the operations layer 36000 causes the AI convergence system of systems 31000 to initiate at least one operation of the set of operations with at least one artificial intelligence system. For example, the initiating may involve initiating execution of the operation on an artificial intelligence system (e.g., a training operation that trains the artificial intelligence system, or an optimization operation that modifies the artificial intelligence system to optimize at least one feature). The initiating may involve invoking an artificial intelligence system to initiate the operation on another aspect of the AI convergence system of systems 31000, such as another artificial intelligence system, software based on a closed-form algorithm, an operating process, a device, a user, or the like. The initiating may involve invoking an artificial intelligence system to generate the operation (e.g., invoking an artificial intelligence system to translate a description of an operation at a low level of detail/high level of abstraction into an executable operation at a high level of detail/low level of abstraction, such as an interpretable script or an executable binary). The initiating may involve invoking an artificial intelligence system to adapt an operation template into an ad-hoc operation based on a set of circumstances, which may be provided as input to the artificial intelligence system and/or may be generated by the artificial intelligence system. The initiating may involve invoking an artificial intelligence system to perform the operation, such as a robotic process automation (RPA) artificial intelligence system that is capable of performing a learned sequence of steps comprising a task. The initiating may involve invoking an artificial intelligence system to monitor a performance of the operation (e.g., an artificial intelligence system that serves as a watchdog over the operation to ensure progress and to detect and address problems). The initiating may involve invoking an artificial intelligence system to validate a performance of the operation (e.g., an artificial intelligence system that evaluates one or more outcomes of the operation to ensure that the operation has met one or more objectives for which the operation was initiated). The initiating may involve invoking an artificial intelligence system to record a performance of the operation (e.g., an artificial intelligence system that records the performance of the outcome, documents one or more features of the performance of the operation, and/or summarizes a performance of an operation, one or more measures).

In embodiments, the operations layer 36000 associates resources of the AI convergence system of systems 31000 with a performance of an operation. For example, the operations layer 36000 may identify one or more artificial intelligence systems, devices, processors, storage locations, data sources, or the like that are to be included in a performance of an operation. The operations layer 36000 may secure the availability of the one or more artificial intelligence systems, devices, processors, storage locations, data sources, or the like to be included in the operation, such as reserving resources from the set of available resources of the AI convergence system of systems 31000 and/or executing transactions to acquire resources for the AI convergence system of systems 31000 for the performance of the operation. The operations layer 36000 may schedule the performance of the operation (e.g., choosing a time to perform the operation in view of the execution of other planned and/or unplanned operations by the AI convergence system of systems 31000). The operations layer 36000 may organize the resources to cause the operation to be performable and/or performed (e.g., communicating with a set of devices to notify the devices of their participation in the performance of the operation, and/or exchanging data among the devices that is involved in the operation). The operations layer 36000 may measure the allocation of resources to operations (e.g., as a high-level planning feature to allocate the resources of the AI convergence system of systems 31000 to perform all of the planned and/or unplanned operations, to load-balance the operations in view of the resources of the AI convergence system of systems 31000, and to acquire additional resources as may be needed or desired to perform the operations).

In embodiments, the operations layer 36000 may include a set of operations modules 36002, each of which may be configured to perform and/or capable of performing one or more operations for the operations layer 36000. For example, each operations module 36002 may be specialized for various types of operations, such as a first operations module 36002 that generates artificial intelligence models; a second operations module 36002 that evaluates artificial intelligence models; a third operations module 36002 that deploys artificial intelligence models; and a fourth operations module 36002 that invokes artificial intelligence modules to perform various operations. The operations modules 36002 may be specialized for particular types of artificial intelligence modules (e.g., a first operations module 36002 may be specialized for operations involving traditional artificial neural networks such as perceptron networks, a second operations module 36002 may be specialized for operations involving convolutional neural networks that include convolutional layers, and a third operations module 36002 may be specialized for operations involving large language models that include transformer layers). The operations modules 36002 may be specialized for particular types of artificial intelligence tasks (e.g., a first operations module 36002 may be specialized for performing operations that involve data classification, a second operations module 36002 may be specialized for performing operations that involve computer vision, and a third operations module 36002 may be specialized for performing operations that involve content generation). The operations modules 36002 may be specialized for particular types of data and/or use cases (e.g., a first operations module 36002 may be specialized for performing operations that involve healthcare data or healthcare-related use cases, a second operations module 36002 may be specialized for performing operations that involve information technology data or information technology use cases, and a third operations module 36002 may be specialized for performing operations that involve industrial data and/or industrial use cases). In embodiments, the operations modules 36002 of the operations layer 36000 may interoperate to perform operations involving artificial intelligence systems (e.g., two or more operations modules 36002 may each perform a portion of an operation involving an artificial intelligence system, such as a first operations module 36002 that trains the artificial intelligence system and a second operations module 36002 that evaluates an outcome of the training of the artificial intelligence system).

### Operations Layer—Example Operations Modules

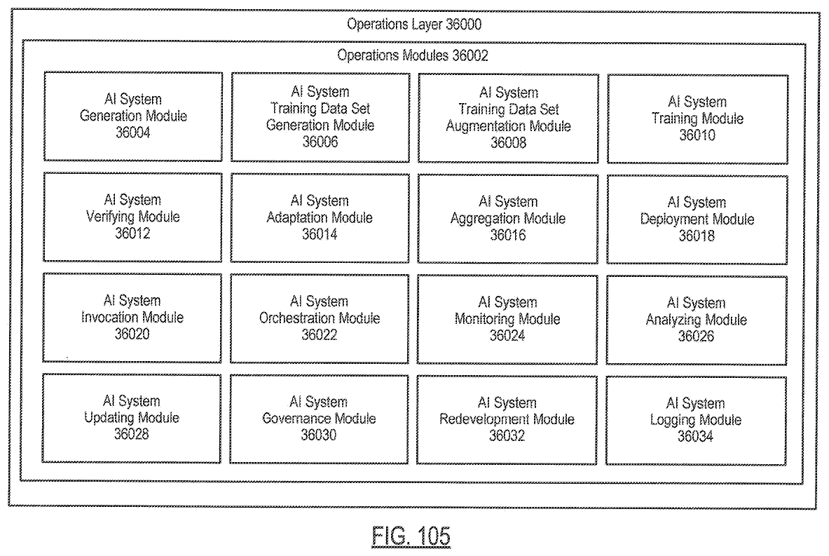

FIG. 105 is an illustration of an example operations layer 36000 that includes a set of operations modules 36002. In the example operations layer 36000 of FIG. 105, each operations module 36002 is provided to perform one set and/or type of operations. Each operations module 36002 may be implemented as one or more artificial intelligence systems, algorithms, devices, processors, data sets, or the like. Although the example operations layer 36000 of FIG. 105 depicts a particular factoring of operations to discrete modules, it is to be appreciated that some embodiments may include a different factoring of the operations to operations modules 36002. For example, in various embodiments, the operations modules 36002 of the operations layer 36000 may be merged, combined, omitted, factored into multiple modules, duplicated, repurposed, or the like. In various embodiments, the operations modules 36002 may be organized based on a different factoring principle, such as operations modules 36002 that each perform various sets of operations for particular types of artificial intelligence systems, and/or operations modules 36002 that each perform various sets of operations for particular use cases. In various embodiments, the operations modules 36002 may be organized for the operations layer 3600 in various ways, such as a centralized set of operations modules 36002 in a data center, a distributed set of operations modules 36002 provided in data centers in different geographic regions, and/or a decentralized set of operations modules 36002 that respectively perform some of the operations of the operations layer 36000 for various subsets of the AI convergence system of systems 31000, such as on behalf of different geographic regions and/or for different clients.

In embodiments, the operations modules 36002 include an AI system generation module 36004 that is configured and/or provided to generate and store artificial intelligence systems. For example, the AI system generation module 36004 may be configured and/or provided to generate artificial intelligence systems of different types and/or architectures. For example, the AI system generation module 36004 may generate artificial neural networks (ANNs) including various layers, each layer including a number of neurons and a set of interconnections to other neurons. The AI system generation module 36004 may determine the hyperparameters of the artificial neural networks, such as the number and types of inputs received by the artificial neural network, numbers and types of neural layers, the numbers and interconnections of neurons, the features of the neurons such as activation functions, additional layer features such as per-layer biases, and the number and types of outputs of the artificial neural network. For an artificial intelligence system including a random forest, the AI system generation module 36004 may determine the number and types of inputs to the random forest, the number of decision trees included in the random forest, the sequence of features to be processed by each decision, a manner of combining the outputs of the decision trees, and the number and types of outputs of the random forest. For an artificial intelligence system including a reinforcement learning (RL) network, the AI system generation module 36004 may determine the number and types of inputs to the reinforcement learning network, the organization and capacity of the reinforcement learning network, an optimization policy to guide the functioning of the reinforcement learning network, and the number and types of outputs to the reinforcement learning network. In embodiments, the AI system generation module 36004 generates and stores artificial intelligence systems in advance of a need or use of the generated artificial intelligence systems, such as a pregenerated set of foundation artificial intelligence systems that are available for future tasks. In embodiments, the AI system generation module 36004 generates and stores artificial intelligence systems in response to a determination of a need for an artificial intelligence system to perform a task, such as determination that a software architecture in development could include an artificial intelligence system to perform a particular task such as data classification or pattern recognition. In embodiments, the AI system generation module 36004 generates and stores artificial intelligence systems in response to a request from another component of the AI convergence system of systems 31000, a processor, a device, a user, or the like, such as a request for an artificial neural network. In embodiments, the AI system generation module 36004 receives a set of hyperparameters describing a type of artificial intelligence system and generates the artificial intelligence system according to the received set of hyperparameters. In embodiments, the AI system generation module 36004 receives or determines a high-level description of an artificial intelligence system (e.g., a convolutional neural network that is capable of detecting images of a selected size, resolution, bit depth, or the like), determines a set of hyperparameters of an artificial intelligence system that matches the high-level description, and generates the artificial intelligence system based on the determined set of hyperparameters. In embodiments, the AI system generation module 36004 generates a set of artificial intelligence systems that are capable of performing a task in different ways (e.g., a set of convolutional neural networks configured to perform a same or similar type of computer vision task, wherein each convolutional neural network is configured to operation on images of a particular size, resolution, bit depth, or the like). In embodiments, the AI system generation module 36004 stores, in a data store of the AI convergence system of systems 31000 or elsewhere, the resources of a generated artificial intelligence system (e.g., as a model file including a set of hyperparameters and parameters that comprise an artificial neural network). In embodiments, the AI system generation module 36004 provisionally reserves, in a data store of the AI convergence system of systems 31000 or elsewhere, storage capacity for the resources of an artificial intelligence system that may be generated in the future (e.g., a reservation of data storage that may be sufficient for an artificial intelligence system of a particular type). In embodiments, the AI system generation module 36004 stores, in a data store of the AI convergence system of systems 31000 or elsewhere, resources for generating one or more artificial intelligence systems in the future (e.g., an interpretable script, a compilable source code repository, an executable code module, or a declarative set of hyperparameters), wherein an occurrence of a future need or desire for an artificial intelligence system may be fulfilled using the resources stored by the AI system generation module 36004. In embodiments, the AI system generation module 36004 curates a set of stored artificial intelligence systems (e.g., reorganizing the stored artificial intelligence systems based on use or demand, discarding unused or underperforming artificial intelligence systems, and/or generating new artificial intelligence systems to replace less performant artificial intelligence systems).

In embodiments, the AI system generation module 36004 may generate one or more generative AI systems that are configured to generate content. For example, in response to a request to generate content of a particular type (e.g., text, an image, a video, a sound, a data file, or the like) and/or having certain subjects (e.g., one or more entities such as people or animals, one or more objects, one or more scenes such as a story, one or more events such as a timeline, and/or one or more interactions such as a conversation), the AI system generation module 36004 may select one or more generative AI systems that correspond to the requested content type and/or subjects. In embodiments, the AI system generation module 36004 generates a plurality of generative AI systems that produce content that is to be combined (e.g., an audio generative AI system that generates audio such as music, speech, and/or sound effects, and a video generative AI system that generates still images and/or motion video, wherein the output of the combined AI systems includes a video with corresponding audio). In embodiments, the AI system generation module 36004 generates one or more AI systems to generate primary content (e.g., speech) and one or more AI systems to generate supplemental content for the primary content (e.g., captions and/or a transcript of the speech). In embodiments, the AI system generation module 36004 generates one or more AI systems to generate content (e.g., an image) and one or more AI systems to generate metadata associated with the content (e.g., a description of the content of the image). In embodiments, the AI system generation module 36004 generates one or more AI systems to generate content (e.g., an image) and one or more AI systems to modify, extend, and/or otherwise further process the content (e.g., one or more image filters applied to the image). In embodiments, the AI system generation module 36004 generates one or more AI systems to generate a description of content to be generated (e.g., a narrative of a story) and one or more AI systems to generate content based on the description (e.g., images, videos, and/or sounds that convey the story according to the narrative). In embodiments, the AI system generation module 36004 generates one or more AI systems to generate content (e.g., an image) and one or more AI systems to review (e.g., critique, rate, score, rank, analyze, compare, and/or verify) the content (e.g., a discriminator network that identifies artifacts of the content that indicate its synthetic provenance). The AI system generation module 36004 may further configure the one or more generative AI systems to alter the content to address one or more issues indicated in the review; to generate replacement content that replaces initially generated content; and/or to be retrained to address issues identified in the review. In these and other scenarios, the AI system generation module 36004 may generate AI systems, including combinations of AI systems that operate independently and/or together, to plan, generate, supplement, review, and/or present content.

In embodiments, the AI system generation module 36004 may generate one or more AI agents that are configured to act in an autonomous manner. For example, the AI system generation module 36004 may generate an AI agent that is configured to monitor a set of conditions (e.g., rules, heuristics, reflexes, or the like) and to take responsive actions based on a detected fulfillment of the conditions, even if the AI agent has not received a request, instruction, prompt, or the like to perform the responsive action. In embodiments, the AI system generation module 36004 generates an AI agent that includes a policy, heuristic, objective, goal, or the like, that identifies actions that may be taken to promote and/or maintain the policy, heuristic, objective, goal, or the like, and to initiate and/or perform the actions to promote and/or maintain the policy, heuristic, objective, goal, or the like, even if the AI agent has not received a request, instruction, prompt, or the like to perform the responsive action. The policy, heuristic, objective, goal, or the like may be specified by the AI system generation module 36004; may be specified by one or more users; and/or may be received from a data source (e.g., a law, regulation, or policy defined by a government, organization, the AI convergence system of systems 31000, or the like). In embodiments, the AI system generation module 36004 configures the AI agent to learn a policy, heuristic, objective, goal, or the like based on experience (e.g., by monitoring an environment such as the AI convergence system of systems 31000; by monitoring the actions of a human and the consequences of such actions (e.g., robotic process automation (RPA)); by monitoring the actions of AI agents, including itself, and the consequences of such actions; or the like. In embodiments, the AI system generation module 36004 configures an AI agent to reflect on one or more policies, heuristics, objectives, goals, or the like to identify synergy (e.g., actions that promote two or more policies); positive feedback loops (e.g., a first policy that, if achieved, positively affects or promotes a second policy); conflicts and/or negative feedback loops (e.g., a first policy that, if achieved, negatively affects or interferes with a second policy). In embodiments, the AI system generation module 36004 configures an AI agent to modify a policy, heuristic, objective, goal, or the like (e.g., reducing or discarding a policy that negatively affects another policy). The AI system generation module 36004 may configure the AI agent to identify, alter, and/or operate according to priorities among two or more policies, heuristics, objectives, goals, or the like (e.g., determining that a first policy is of higher priority than a second policy, and preferentially selecting actions that promote the first policy over actions that promote the second policy). In embodiments, the AI system generation module 36004 configures an AI agent to communicate about policies, heuristics, objectives, goals, or the like with AI systems or other AI agents (e.g., sharing and/or comparing experiences and/or learned features) and/or to adapt policies, heuristics, objectives, goals, or the like based on information received from AI systems or other AI agents. In embodiments, the AI system generation module 36004 configures an AI agent to report on its policies, heuristics, objectives, goals, or the like, and/or about actions taken and/or not taken based on policies, heuristics, objectives, goals, or the like, to one or more AI systems (e.g., supervising AI systems that occasionally review the autonomous actions of an AI agent for verification, correction, auditing, logging, or the like).

In embodiments, the operations modules 36002 include an AI system training data set generation module 36006 that is configured and/or provided to generate training data sets for training artificial intelligence systems. For example, the AI system training data set generation module 36006 may be configured and/or provided to collect data from one or more data sources for inclusion in a training data set. In embodiments, the AI system training data set generation module 36006 collects data for training data sets from one or more other modules or resources of the AI convergence system of systems 31000 (e.g., from the transaction layer 35000, the network layer 37000, the data layer 38000, or the like). In embodiments, the AI system training data set generation module 36006 collects data for training data sets from other entities, facilities, or resources associated with the AI convergence system of systems 31000 (e.g., from edge devices included in an industrial facility that is managed by the AI convergence system of systems 31000). In embodiments, the AI system training data set generation module 36006 collects data for training data sets from one or more external data repositories, such as news services, information repositories such as libraries, public data sources such as public databases, social networks including social media networks, communication channels, and/or the Internet. In embodiments, the AI system training data set generation module 36006 organizes and/or routes collected data into one or more training data sets. For example, the training data sets may be organized to serve the training of one or more artificial intelligence systems (e.g., a first training data set for traditional artificial neural networks, a second training data set for random forests, and a third training data set for graph neural networks). The training data sets may be organized by data types (e.g., a first training data set including text, a second training data set including mathematical equations or numeric measurements, and a third training data set including images). The training data sets may be organized by sources (e.g., a first training data set for data collected from other modules of the AI convergence system of systems 31000, a second training data set for data collected from a local area network or a facility, a third training data set for data collected from the Internet). The training data sets may be organized by trust or reliability (e.g., a first training data set of verified reliable data, a second training data set of verified unreliable data, and a third training data set of unverified data). The training data sets may be organized by provenance (e.g., a first training data set of authentically generated content, a second training data set of synthetically generated content, and a third training data set of data of unknown provenance). The training data sets may be organized by use cases (e.g., a first training data set including data associated with industrial manufacturing, a second training data set including data associated with healthcare, and a third training data set including data associated with a service industry). In embodiments, the AI system training data set generation module 36006 curates the training data included in each training data set (e.g., normalizing, regularizing, standardizing, anonymizing, and/or cleaning the data to be included in each training data set). In embodiments, the AI system training data set generation module 36006 partitions each training data set into one or more partitions (e.g., a training data set, a validation data set for periodic evaluation during training, and a test data set for use in a tiered training regimen). In embodiments, the AI system training data set generation module 36006 analyzes the training data sets for training issues (e.g., underrepresentation, overrepresentation, bias, and/or inconsistency). In embodiments, the AI system training data set generation module 36006 requests and/or directs a collection and/or creation of data to address one or more training issues associated with one or more training data sets (e.g., a request or instruction to collect more data related to a particular class that is underrepresented in a training data set). In embodiments, the AI system training data set generation module 36006 generates training data sets for use with a particular training regimen, such as bootstrap aggregation (“bagging”) training data sets that are partitioned in different ways for combinatorial training of an AI system In embodiments, the AI system training data set generation module 36006 stores training data sets for various training uses (e.g., a first training data set for training mobile devices to perform computer vision tasks, a second training data set for training workstations to perform computer vision tasks, and a third training data set for training supercomputers to perform computer vision tasks).

In embodiments, the operations modules 36002 include an AI system training data set augmentation module 36008 that is configured and/or provided to augment training data sets for training artificial intelligence systems. For example, the AI system training data set augmentation module 36008 may be configured and/or provided to generate synthetic data to augment one or more training data sets. In embodiments, the AI system training data set augmentation module 36008 generates synthetic data in response to a request or instruction from an AI system training data set generation module 36006 (e.g., based on a determination that a particular class is underrepresented in a training data set, the AI system training data set augmentation module 36008 may receive some data samples of the particular class and may generate additional synthetic data samples of the class that are similar to the received data samples of the class). In embodiments, the AI system training data set augmentation module 36008 generates synthetic data to address a particular issue with a training data set (e.g., in response to a determination that a training data set of images includes too few images in low-light-level environments, the AI system training data set augmentation module 36008 may synthetically modify some existing high-light-level images to simulate low-light-level conditions). In embodiments, the AI system training data set augmentation module 36008 generates synthetic data using various augmentation techniques. For example, for training data sets including text, the AI system training data set augmentation module 36008 may generate synthetic text that modifies words and/or word ordering of authentic text; that modifies passages of text by generating replacement text; that supplements the text with generated text; and/or that combines two or more authentic passages of text to generate a synthetic text. For training data sets including images, the AI training data set augmentation module 36008 may crop, mirror, scale, shear, adjust colors, increase or decrease noise, insert or remove objects, and/or distort an authentic image to produce one or more synthetic images. For training data sets including data collected from sensors connected to industrial machines, the AI training data set augmentation module 36008 may generate synthetic data based on simulation of the sensors and/or industrial machines. The AI system training data set augmentation module 36008 may evaluate synthetic data for hallmarks of synthetic data (e.g., using a discriminator network of a generative adversarial network (GAN) to determine whether synthetic data can be distinguished from authentic data) and may adapt the augmentation techniques to reduce artifacts of synthetic data. The AI system training data set augmentation module 36008 may transmit synthetic and/or augmented data to the AI system training data set generation module 36006 for inclusion in one or more training data sets.

In embodiments, the operations modules 36002 include an AI system training module 36010 that is configured and/or provided to train artificial intelligence systems. For example, the AI system training module 36010 may be configured and/or provided to train one or more artificial intelligence systems for a particular task, such as classification, pattern recognition, object detection, and/or content generation. The AI system training module 36010 may be configured to pretrain standard models for common tasks (e.g., pretraining a convolutional neural network to detect generic objects, and/or pretraining a large language model to understand common features of a natural language such as English). The AI system training module 36010 may be configured to train a generated artificial intelligence system for a particular task (e.g., in response to the AI system generation module 36004 receiving a request for an artificial neural network to perform a particular classification task, the AI system generation module 36004 may generate the artificial neural network with a suitable set of hyperparameters, and the AI system training module 36010 may train the generated artificial neural network to perform the classification task). The AI system training module 36010 may be configured to train a generated artificial intelligence system using a particular training data set (e.g., in response to the AI system training data set generation module 36006 receiving and/or collecting data for a particular training data set, such as a corpus of text in a particular language, the AI system training module 36010 may initiate training of a large language model train using the corpus of text). The AI system training module 36010 may be configured to adapt a pretrained model to perform a particular task (e.g., upon receiving a request for a large language model that can generate a specialized type of text in a natural language, the AI system training module 36010 may identify a large language model that has previously been pretrained on the natural language and may conduct additional training of the pretrained large language model using examples of the specialized type of text). The AI system training module 36010 may use one or more types of training techniques to train AI systems, such as backpropagation, zero-shot and/or few-shot learning, supervised learning, semi-supervised learning, unsupervised learning, bootstrap aggregation (“bagging”) of training data sets, reinforcement learning, genetic training, or the like. The AI system training module 36010 may evaluate a performance of an AI system during training to detect progression of the training, completion of the training, mistraining (e.g., loss of performance during training), and/or training problems such as overtraining, and may adapt the training according to the evaluation (e.g., ending training when the AI system exhibits performance that at least satisfies a minimum performance threshold). The AI system training module 36010 may restart training to address problems (e.g., reinitiating training with a different training regimen, and/or with a different training data set, to address mistraining or overtraining of an AI system). The AI system training module 36010 may test a performance of a trained AI system (e.g., validating performance of the trained models using a validation data set, and/or verifying a trained performance of an AI system using a test data set). The AI system training module 36010 may holistically allocate the resources of the AI convergence system of systems 31000 (e.g., planning, scheduling, and/or adapting training of the AI systems based on performance, demand, the availability and/or costs of compute and/or storage, or the like) to meet the need to train a set of AI systems for the set of operations of the AI convergence system of systems 31000.

In embodiments, the operations modules 36002 include an AI system verifying module 36012 that is configured and/or provided to verify generated artificial intelligence systems. For example, the AI system verifying module 36012 may be configured and/or provided to test one or more trained and/or untrained AI systems based on various criteria, such as accuracy, precision, recall, F1 score, bias, consistency, efficiency, latency, or the like. For generative AI systems such as large language models and diffusion networks, the AI system verifying module 36012 may be configured to evaluate content generated by the AI system based on features such as coherence, creativity, and variance. In embodiments, the AI system verifying module 36012 compares, scores, ranks, or otherwise considers the output of multiple AI systems (e.g., to determine comparative strengths and weaknesses of the respective AI systems for performing various operations, such as generating content for particular uses). In embodiments, the AI system verifying module 36012 generates recommendations for saving, using, modifying, combining, and/or discarding various AI systems based on the verifying (e.g., a first recommendation for an AI system generation module 36004 to store a first AI system that is verified as performing well; a second recommendation for an AI system training module 36010 to train or retrain a second AI system that is performing inadequately; and a third recommendation for an AI system generation module 36004 to discard and/or replace an AI system that is performing poorly). In embodiments, the AI system verifying module 36012 identifies one or more deficiencies in various AI models (e.g., poor performance of the AI systems on a particular type of data, or poor performance of the AI systems in satisfying a particular task) and generates recommendations for addressing the identified deficiencies (e.g., recommending an AI system training data set generation module 36006 to include additional data that is associated with an underrepresented and/or inconsistently represented class; recommending an AI system training data set augmentation module 36008 to generate certain types of augmented data, or to refrain from augmenting data in a certain way, for inclusion in training data sets; and/or recommending an AI system training module 36010 to adjust a training regimen and/or scoring model to focus on a particular issue exhibited by the AI systems).

In embodiments, the operations modules 36002 include an AI system adaptation module 36014 that is configured and/or provided to adapt a set of artificial intelligence systems to perform various operations and/or tasks. The adapting may include optimizing one or more AI systems in the performance of various operations and/or tasks, such as performing with improved accuracy, precision, recall, F1 scores, bias, consistency, efficiency, latency, or the like. Herein, the term “optimizing” may mean an improvement either to a globally optimal or best state, locally optimal or best state within a given domain, improving relative to a previous state, or the like. For example, the AI system adaptation module 36014 may be configured and/or provided to receive a request to adapt a pretrained AI system (e.g., a partially trained large language model) for a specific task, device, data type, deployment, use case, or the like. For example, the AI system adaptation module 36014 may be configured to adapt an AI system that is configured to receive, process, and output a first type of data (e.g., images of a first size, resolution, bit depth, or the like) so that the AI system can process a second type of data (e.g., images of a second size, resolution, bit depth, or the like). The AI system adaptation module 36014 may be configured to adapt an AI system that is configured to receive, process, and output data in a first context (e.g., text associated with documents of a first type) so that the AI system can process a second type of data (e.g., text associated with documents of a second type). The AI system adaptation module 36014 may be configured to adapt an AI system that is configured to receive, process, and output data in a first context (e.g., data received from sensors in an industrial environment) so that the AI system can process data in a second context (e.g., data received from sensors in a healthcare environment). The AI system adaptation module 36014 may be configured to adapt an AI system that is configured to receive, process, and output data on a first type of device (e.g., a workstation including a graphics processing unit (GPU)) so that the AI system can process data on a second type of device (e.g., an embedded device featuring only a traditional central processing unit (CPU) and/or a field-programmable gate array (FPGA)). The AI system adaptation module 36014 may be configured to adapt an AI system that is configured to receive, process, and output data to perform a first task on a data set (e.g., data classification) so that the AI system can process data on a second task on the same data set (e.g., pattern detection). In view of these and other types of adaptations, the AI system adaptation module 36014 may identify one or more AI systems stored by an AI system generation module 36004 and one or more adaptations of the one or more AI systems that may adapt the AI system according to a request or instruction. The adaptation may include preprocessing an input to an AI system to alter the input received by the AI system, such as adding a preprocessing denoising filter to the input of an AI system to reduce noise and improve the processing, output, and performance of the denoised data. The adaptation may include altering an AI system to receive a different type of input, such as adapting a convolutional neural network to receive and process images of a different size, resolution, color depth, or the like than the images on which the convolutional neural network was previously trained. The adaptation may include reconfiguring an architecture of an AI system, such as adding one or more architectural features (e.g., a long short-term memory (LSTM) unit, a gated recurrence unit (GRU), a transformer layer, a filter layer, a pooling layer, or the like), removing one or more architectural features, replacing one or more architectural features with a different architectural feature, or the like. The adaptation may include altering an AI system to process data differently, such as appending one or more fine-tuning layers to a pretrained artificial neural network to provide additional processing for a specific set of data. The adaptation may include altering an AI system to generate different output, such as adapting an artificial neural network that processes input to select a class from a first set of classes, such that the artificial neural network performs the same or similar processing of the input to select a class from among a second, different set of classes. The adaption may include postprocessing an output generated by the AI system to alter an output of the AI system, such as adding a postprocessing denoising feature to reduce noise in content generated by a generative AI system. The adaptation may include selectively limiting a processing of input by the AI system to a subset of input for which the AI system is determined to perform well. The adaptation may include requesting a continued training or retraining of an AI system by the AI system training module 36010, comparing a performance of the additionally trained AI system with the original AI system, and determining one or more adaptations of the AI system based on the comparison. The adaptation may include altering a set of resources provided to the AI system (e.g., altering an amount of memory allocated for the AI system, an amount or type of computation performed by or for the AI system, such as to reduce latency of a time-sensitive model and/or a context window size of a time series model or a large language model to improve memory and/or performance). In embodiments, the AI system adaptation module 36014 may consider a set of possible adaptations of an AI system for addressing one or more issues or problems of the AI system (e.g., poor accuracy, poor consistency, poor coherence, high latency, or the like), comparing the predicted and/or determined effects of various adaptations and combinations thereof of the AI system, selecting one or more adaptations to apply to the AI system based on the comparison, and adapting the AI system based on the selection.

In embodiments, the operations modules 36002 include an AI system aggregation module 36016 that is configured and/or provided to aggregate artificial intelligence systems. The AI system aggregation module may combine two or more AI systems into a hybrid AI system that combines the heterogeneous processing capabilities of AI systems with different architectures. For example, the AI system aggregation module 36016 may combine an AI system with one or more other AI systems to produce a hybrid system that generates aggregated and improved output as compared with the individual AI systems (e.g., a “boosted” ensemble of inadequately performing AI systems, from which a consensus output may be derived that presents higher-performance output than from any of the individual AI systems). The aggregation may include adding an AI system to a set of AI systems, each of which may be determined to perform well over a subset of input, wherein a particular input to the set of AI systems may be selectively processed by a particular AI system that is recognized to perform well over the subset of input that includes the particular input. In embodiments, the AI system aggregation module combines two or more AI systems into an ensemble AI system that features a collection of homogeneous or heterogeneous AI systems that together generate an output (e.g., by consensus). In embodiments, the AI system aggregation module combines two or more AI systems into a sequence or chain of AI systems, wherein an output of a first AI system is received as input by a second AI system. The aggregation may include connecting at least one output of a first AI system to at least one input of a second AI system (e.g., a chain-of-processing generative system in which data generated by a generative AI system is refined, expanded, reformatted, verified, analyzed, augmented, edited, or otherwise further processed by a second AI system). In some embodiments, the AI system aggregation module 36016 generates a swarm of AI systems that operate independently of one another but collectively to achieve a task, such as a set of AI agents that are configured to operate individually but that interact with other AI agents and shared resources to achieve the task. In some embodiments, the AI system aggregation module 36016 aggregates AI systems by inserting at least a portion of a first AI system into a second AI system (e.g., inserting one or more layers of a classifier network between two layers of a convolutional neural network to inform further processing of the convolutional neural network based on the classification of the partially-processed input data). The aggregation may include conditioning the processing of data by a first AI system based on the processing of the data by a second AI system (e.g., partially generating content by a generative AI system, and then conditioning a completion of the generated content on an initial assessment of the partially generated content by a second AI system, such as a discriminator network). The aggregation may include combining a first AI system to select, design, and/or validate a processing of data by a combination of one or more other AI systems (e.g., an expert determining AI system that determines, from a set of AI systems that are respectively experts in various domains, one or more AI systems that are to be invoked to process input data that is relevant to one or more domains). The aggregation may include attaching a first AI system as an administrator, regulator, controller, or the like of a second AI system (e.g., a content moderation AI system that determines whether a generative AI system is permitted to process certain kinds of prompts and/or generate certain kinds of data, and that controls the processing of the generative AI system based on the determined permission). In embodiments, the AI system aggregation module 36016 identifies one or more aggregations of pregenerated AI systems for various contexts (e.g., combinations of pregenerated AI systems that may be specialized and/or proficient at certain types of processing, such as generating certain forms of content, generating classifications above a classification threshold, and/or completing processing within a latency window). In embodiments, the AI system aggregation module 36016 generates and stores one or more descriptions of techniques for selecting and aggregating AI systems for various contexts (e.g., an interpretable script for selecting and combining AI systems to generate chain-of-thought reasoning for various contexts), wherein a particular task or invocation of the AI systems may be fulfilled by applying one of the aggregation techniques generated by the AI system aggregation module 36016 to select and aggregate AI systems for the indicated context. Such aggregating may be advantageous, for example, for ad-hoc aggregations of AI systems for unusual, specialized, and/or previously unseen processing tasks (e.g., a request to aggregate AI systems to generate a hybrid large language model for execution on a particular device and/or over a particular type of data).

In embodiments, the operations modules 36002 include an AI system deployment module 36018 that is configured and/or provided to deploy artificial intelligence systems. For example, the AI system deployment module 36018 may be configured and/or provided to deploy one or more AI systems generated by the AI system generation module 36004 to one or more devices, such as a set of workstations, servers, or mobile devices. For example, the AI system deployment module 36018 may receive a request to deploy a large language model to a device having a certain set of computational resources, such as processing cores operating at a defined clock rate, memory, and storage. The AI system deployment module 36018 may review a set of AI systems generated by the AI system generation module 36004 to identify a suitable large language model in view of the computational resources of the device. The AI system deployment module 36018 may select the large language model for deployment, determine a location of the resources of the selected large language model, package the resources of the large language model for deployment (e.g., retrieving and compressing a description of the architecture of the large language model and a set of parameters of the large language model), and transmit the packaged resources for deployment on the device. In embodiments, the AI system deployment module 36018 is configured to deploy an AI system for a particular type of task, such as a particular classification task, pattern recognition task, computer vision task, or content generation task. The AI system deployment module 36018 may select a particular AI system from the set of AI systems generated by the AI system generation module 36004 to identify an AI system that is suitable for the identified task. The AI system deployment module 36018 may package the identified AI system for deployment to the device and/or environment for the identified task, and may transmit the packaged AI system to the device and/or environment. In embodiments, the AI system deployment module 36018 is configured to deploy an AI system to include a particular feature set, such as a large language model that supports a particular natural language and features a particular context window size, and may deploy a pregenerated or adapted AI system to fulfill the deployment that features the indicated feature set. In embodiments, the AI system deployment module 36018 is configured to deploy an AI system for execution in a particular execution environment, such as within a defined memory space, using a particular AI framework such as TensorFlow or Torch, and/or using a particular set of hardware that is available to the device, such as a particular graphics processing unit (GPU), neural processing unit (NPU), tensor processing unit (TPU), or the like. In embodiments, the AI system deployment module 36018 is configured to adapt an AI system for deployment to a particular device and/or context (e.g., identifying an AI system that is suitable for a particular task but that is based on a TensorFlow environment, adapting the AI system for execution in a Torch environment, and transmitting a packaged version of the Torch-based AI system to a device featuring a Torch execution environment). To achieve the adapting for the deployment, the AI system deployment module 36018 may transmit a request to the AI system adaptation module 36014 to adapt a stored AI system in view of the details of a particular deployment, may receive an adapted AI system from the AI system adaptation module 36014 based on the request, and may package and deploy the adapted AI system to satisfy the deployment. In embodiments, the AI system deployment module 36018 may transmit the resources of one or more AI systems to one or more devices that are intended to execute the AI systems. In embodiments, the AI system deployment module 36018 may transmit the resources of an AI system to two or more devices for redundant and/or distributed execution of the AI system (e.g., as a primary system and a failover system, as two or more devices that provide scalable capacity for execution of the AI systems, as a distributed system in which a first system executes a first AI system that transmits an output to a second device for input to a second AI system, and/or as a federated system in which respective devices execute a portion of the AI system). In embodiments, the AI system deployment module 36018 may deploy an AI system within the AI convergence system of systems 31000, such as by reserving resources (e.g., processing capacity, storage, one or more dedicated devices, or the like) for the execution of an AI system to serve a particular context, and/or by transmitting the resources of an AI system (e.g., the parameters of an artificial neural network) to one or more devices within the AI system deployment module 36018. In embodiments, the AI system deployment module 36018 may deploy an AI system by transmitting an interface to the AI system to one or more devices, such as end-user devices that are configured to collect input, transmit input through the interface to one or more AI systems executed on other devices, and/or receive and present output received from one or more AI systems. For example, the AI system deployment module 36018 may retrieve, generate, and/or transmit an application programming interface (API) to the one or more devices in order to interconnect the one or more devices with the AI system. The AI system deployment module 36018 may reserve one or more communication endpoints to enable one or more devices to communicate with the AI system. The AI system deployment module 36018 may configure permissions and/or security tokens to enable one or more external devices to communicate securely with one or more AI systems.

In embodiments, the operations modules 36002 include an AI system invocation module 36020 that is configured and/or provided to invoke artificial intelligence systems to perform various operations and/or tasks. For example, the AI system invocation module 36020 may be configured and/or provided to receive one or more requests to perform a task. The request may be initiated by another component of the AI convergence system of systems 31000; by a device, software process, or entity that is served by the AI convergence system of systems 31000; and/or by an external device, software process, or entity. The request may be spontaneously initiated by the AI system invocation module 36020 (e.g., based on a set of conditions monitored by the AI system invocation module 36020, wherein fulfillment of a condition instructs the AI system invocation module 36020 to invoke an AI system). The request may indicate one or more AI systems that are to be invoked to execute the request. Alternatively or additionally, the request may indicate one or more tasks, and the AI system invocation module 36020 may determine one or more AI systems that may be invoked to fulfill the task. In some cases, the request may specify a request that includes one or more non-AI systems (e.g., a hardware component or a traditional software component, such as a graphics rendering or simulation system), and the AI system invocation module 36020 may identify one or more AI systems that may be invoked to perform the task in place of the one or more non-AI systems. In embodiments, the AI system invocation module 36020 verifies a permission and/or security of a request to invoke an AI system before initiating the invocation of the AI system. In embodiments, the AI system invocation module 36020 initiates the invocation of the AI system in response to the request (e.g., by instantiating the AI system, by transmitting input to the AI system, and/or by securing the resources for the invocation of the AI system). In embodiments, the AI system invocation module 36020 notifies a requester of the status of a request to invoke an AI system (e.g., indicating a status, progress, estimated completion time, and/or outcomes of the processing of the request by the AI systems). In embodiments, the AI system invocation module 36020 mediates communication between the AI system and the requester (e.g., by transmitting the request and/or input received from the requester and/or another source to the AI system to invoke the AI system for the request, and/or by transmitting one or more outputs of the AI system to the requester and/or another destination to fulfill the request). In embodiments, the AI system invocation module 36020 translates the request and/or one or more inputs received from the requester and/or another source for intake and processing by the AI system, and/or translates one or more output of the AI system for transmission to the requester and/or another destination).

In embodiments, the AI system invocation module 36020 may invoke one or more generative AI systems that are configured to generate content in response to a request. For example, in response to a request to generate content of a particular type (e.g., text, an image, a video, a sound, a data file, or the like) and/or having certain subjects (e.g., one or more entities such as people or animals, one or more objects, one or more scenes such as a story, one or more events such as a timeline, and/or one or more interactions such as a conversation), the AI system invocation module 36020 may select and invoke one or more generative AI systems that correspond to the requested content type and/or subjects. In embodiments, the AI system invocation module 36020 invokes a plurality of generative AI systems that produce content that is to be combined (e.g., an audio generative AI system that generates audio such as music, speech, and/or sound effects, and a video generative AI system that generates still images and/or motion video, wherein the output of the combined AI systems includes a video with corresponding audio). In embodiments, the AI system invocation module 36020 invokes one or more AI systems to generate primary content (e.g., speech) and one or more AI systems to generate supplemental content for the primary content (e.g., captions and/or a transcript of the speech). In embodiments, the AI system invocation module 36020 invokes one or more AI systems to generate content (e.g., an image) and one or more AI systems to generate metadata associated with the content (e.g., a description of the content of the image). In embodiments, the AI system invocation module 36020 invokes one or more AI systems to generate content (e.g., an image) and one or more AI systems to modify, extend, and/or otherwise further process the content (e.g., one or more image filters applied to the image). In embodiments, the AI system invocation module 36020 invokes one or more AI systems to generate a description of content to be generated (e.g., a narrative of a story) and one or more AI systems to generate content based on the description (e.g., images, videos, and/or sounds that convey the story according to the narrative). In embodiments, the AI system invocation module 36020 invokes one or more AI systems to generate content (e.g., an image) and one or more AI systems to review (e.g., critique, rate, score, rank, analyze, compare, and/or verify) the content (e.g., a discriminator network that identifies artifacts of the content that indicate its synthetic provenance). Based on the review, the AI system invocation module 36020 may invoke one or more AI systems to alter the generated content to address one or more issues indicated in in the review; to generate replacement content that replaces initially generated content; and/or to retrain the generative AI systems to address issues identified in the review. In these and other scenarios, the AI system invocation module 36020 may invoke AI systems, including combinations of AI systems that operate independently and/or together, to plan, generate, supplement, review, and/or present content.

In embodiments, the operations modules 36002 include an AI system data set orchestration module 36022 that is configured and/or provided to orchestrate a set of artificial intelligence systems to perform various operations and/or tasks. For example, the AI system orchestration module 36022 may be configured and/or provided to orchestrate operation of at least a portion of the set of AI systems of the AI convergence system of systems 31000 to fulfill a set of requests. In embodiments, the AI system orchestration module 36022 interconnects two or more AI systems to perform a particular task (e.g., interconnecting the output of a first AI system, such as a pattern recognition system, to the input of a second AI system, such as a large language model that can generate summaries and/or descriptions of the detected patterns). In embodiments, the AI system orchestration module 36022 performs scheduling of the invocation of AI systems (e.g., based on processing loads or queues and/or throughput of the AI systems and/or the urgency and/or priority of the requests to invoke the AI systems). In embodiments, the AI system orchestration module 36022 performs load-balancing of the requests to invoke AI systems for various tasks (e.g., by monitoring a processing load and/or processing queue of each of the AI systems, and by routing requests to AI systems that have available capacity based on the load-balancing). In embodiments, the AI system orchestration module 36022 maps or remaps requested tasks to AI systems based on load-balancing, scheduling, or the like (e.g., remapping a task from a first AI system that is overloaded to a second AI system that is capable of equivalently performing the task and that has available capacity). In embodiments, the AI system orchestration module 36022 adjusts allocations, provisions, and/or reservations of resources of the AI convergence system of systems to enable the AI systems to fulfill the requested invocations (e.g., by acquiring more computational capacity, storage, devices such as servers or processing cores, or the like to handle an increased number of requests and/or an increased computational load of the requests, and/or by reallocating computational capacity, storage, devices such as servers or processing cores, or the like to handle a decreased number of requests and/or a decreased computational load of the requests). In embodiments, the AI system orchestration module 36022 plans and/or manages the acquisition, retention, location, installation, use, maintenance, reallocation, and/or decommissioning of the resources of the AI convergence system of systems 31000 in view of future scheduled and/or predicted demands, volumes of requests, and/or computational loads. In embodiments, the AI system orchestration module 36022 reorganizes the resources of the AI convergence system of systems 31000 based on changes in the demand for processing by the AI systems (e.g., based on new types of requests that the AI systems are capable of handling, such as low-latency AI system processing requests in particular real-time contexts and/or the processing of new types of data, such as LIDAR point-cloud data). In embodiments, the AI system orchestration module 36022 reorganizes the resources of the AI convergence system of systems 31000 based on changes in the available and/or feasible AI systems (e.g., allocating increased computation and/or storage for large language models and hybrid systems of increased size and/or computational complexity).

In embodiments, the AI system orchestration module 36022 may include routing data and/or interactions between and/or among data sources, clients, AI systems, hardware and/or software components, or the like. In embodiments, the AI system orchestration module 36022 determines and implements a route between a source of a request or task (e.g., a client, user, requesting device, or the like) to one or more AI systems that are capable of fulfilling the request and/or performing the task (e.g., AI systems that exhibit capabilities that correspond to requirements of the request and/or task). the AI system orchestration module 36022 determines and implements a route from a first AI system (e.g., a generative AI system that outputs generated content) as input to a second AI system (e.g., a reviewing AI system that reviews content generated by the generative AI system). In embodiments, the AI system orchestration module 36022 determines and implements a route between a data source of data (e.g., a sensor, a database, a camera, or the like) and one or more AI systems that are configured to process the data (e.g., a convolutional neural network that is configured to analyze images generated by camera). In embodiments, the AI system orchestration module 36022 determines and implements a route between one or more AI systems that generate output (e.g., a classifier network) and a consumer of the output (e.g., a client, database, or another AI system that stores, uses, or otherwise consumes the output). In embodiments, the AI system orchestration module 36022 partitions data into portions and determines and implements routes between a source of the data and a plurality of AI systems that respectively process a portion of the data (e.g., two or more AI systems that operate in parallel and/or in tandem), which may reduce latency of processing the data. In embodiments, the AI system orchestration module 36022 routes data to each of two or more AI systems, each of which may perform a same or similar type of processing (e.g., redundant processing of the data by redundant AI systems) and/or different types of processing (e.g., performing different tasks on the data, such as a first task of verifying the data and a second task of supplementing the data). In embodiments, the AI system orchestration module 36022 determines and implements routes between and/or among AI systems to enable interoperation to complete the task (e.g., a communication path between two or more AI agents that operate independently to perform different portions of a task, such as a transaction negotiating AI agent that identifies and negotiates transactions and a transaction execution AI agent that generates and executes smart contracts to complete the transactions). In embodiments, the AI system orchestration module 36022 determines and implements routes between and/or among AI systems based on a set of available routes, such as a set of candidate communication paths by which the AI systems may communicate (e.g., various network paths in a wide-area network, and/or different communication modalities such as Bluetooth, Wi-Fi, cellular, infrared, wired connections such as Ethernet, or the like). In embodiments, the AI system orchestration module 36022 determines and implements routes based on an evaluation of the requirements of a request and/or task (e.g., a priority, a deadline, an amount of data, a budget, a security consideration, or the like) and corresponding features of candidate routes (e.g., throughput, availability, cost, reliability, security, or the like, of various communication modalities such as Bluetooth, Wi-Fi, cellular, infrared, wired connections such as Ethernet, or the like). In embodiments, the AI system orchestration module 36022 determines and implements routes between and/or among AI systems by acquiring, purchasing, developing, reserving, provisioning, dedicating, and/or allocating one or more routes or the like (e.g., reserving a communication path between two or more AI systems that are intended to communicate with high performance).

In embodiments, the operations modules 36002 include an AI system monitoring module 36024 that is configured and/or provided to analyze the performance of artificial intelligence systems while performing various operations and/or tasks. For example, the AI system monitoring module 36024 may be configured and/or provided to analyze a performance of one or more AI systems of the AI convergence system of systems 31000 to measure and compare various performance metrics, such as accuracy, precision, recall, F1 score, bias, consistency, efficiency, latency, or the like. The AI system monitoring module 36024 may perform such evaluation using training data on which an AI system was previously trained, new training data that the AI system has not previously processed (e.g., a test data set), live data that is associated with a deployment of the AI system, and/or synthetic data generated for the monitoring. The AI system monitoring module 36024 may perform such evaluation using data that is the same as or similar to data that the AI system was deployed to process and/or based on new data that the AI system was not deployed to process (e.g., based on new data types that are different than those associated with the training and/or initial deployment of the AI system). The AI system monitoring module 36024 may compare the performance of an AI system at a current time with a performance of the same or similar AI system at a previous time (e.g., at a time of completion of training and/or deployment). The AI system monitoring module 36024 may compare the performance of an AI system operating under a first set of conditions (e.g., on a first device and/or with a first set of computational resources) with a performance of the same or similar AI system under a second set of conditions (e.g., on a second device and/or with a second set of computational resources). The AI system monitoring module 36024 may compare the performance of an AI system at a current time with a simulated performance of the AI system at the current time (e.g., a digital twin of the AI system). The AI system monitoring module 36024 may compare the performance of an AI system on a first data set (e.g., a first set of images depicting items of a first class) with the performance of the AI system on a second data set (e.g., a second set of images depicting items of a second class) The AI system monitoring module 36024 may compare the performance of an AI system with the performance of another AI system of the same or similar type (e.g., comparing a performance of an artificial neural network classifier trained with a first training data set with a performance of an artificial neural network classifier trained with a second training data set). The AI system monitoring module 36024 may compare the performance of an AI system with the performance of another AI system of a different type (e.g., comparing a performance of an artificial neural network classifier on a data set with a performance of a Bayesian classifier on the same data set). In embodiments, the AI system monitoring module 36024 performs comparisons using two or more performance metrics (e.g., accuracy, precision, and recall) and, optionally, based on relative priorities of the performance metrics (e.g., associating different relative weights and/or penalties to measurements of accuracy, precision, and recall). In embodiments, the AI system monitoring module 36024 tracks changes in the performance metrics over time and identifies trends in the performance metrics (e.g., the development of AI system “drift” due to trends in the features of the data processed by the AI system, changes in the execution of the AI system, and/or the continued training of the AI system). In embodiments, the AI system monitoring module 36024 invokes a first AI system to evaluate a second AI system, and receives, from the first AI system, an indication of the performance of the second AI system. In embodiments, the AI system monitoring module 36024 monitors each AI system according to a schedule (e.g., periodically testing the AI system and recording performance measurements for each period). In embodiments, the AI system monitoring module 36024 collects information from one or more other components or systems that are associated with an AI system (e.g., a sensor whose functionality depends upon the performance of an AI system) and determines a performance measurement of the AI system based on the performance of the other components or systems. In embodiments, the AI system monitoring module 36024 solicits, collects, and/or receives information from one or more entities that are associated with an AI system (e.g., feedback from users or clients) and determines a performance of an AI system based on the solicited, collected, and/or received information. In embodiments, the AI system monitoring module 36024 monitors each AI system in response to a detected event or condition (e.g., upon receiving an indication that a performance of an AI system may have changed, such as when an execution context of the AI system changes, or when another system detects a change in a performance of the AI system). In embodiments, the AI system monitoring module 36024 records measurements, changes, trends, and the like of the AI systems. In embodiments, the AI system monitoring module 36024 stores the measurements, changes, trends, or the like in one or more data stores or repositories, such as a database or a performance log. In embodiments, the AI system monitoring module 36024 stores the measurements, changes, trends, or the like, such as to an AI system analyzing module 36028 of the operations modules 36002.

In embodiments, the operations modules 36002 include an AI system analyzing module 36026 that analyzes the performance of the AI systems. For example, the AI system analyzing module 36026 may be configured and/or provided to analyze the performance metrics collected stored by the AI system monitoring module 36024 for various AI systems. In embodiments, in response to a detected or determined change in a performance of an AI system, the AI system analyzing module 36026 initiates a further evaluation of the AI system to determine a cause for the change in the performance (e.g., a change in the data provided as input to the AI system; a change in an execution environment of the AI system; and/or a change in a performance of the AI system due to continued training). The AI system analyzing module 36026 may use a variety of techniques to determine a cause of a change in performance, such as simulation of the AI system by one or more digital twins, Monte Carlo analysis based on sampling the effects of changes to the operation of the AI system, and/or root cause analysis that involves a determination of causal relationships among various elements of the AI system and the AI convergence system of systems 31000. In embodiments, in response to a detected or determined change in a performance of an AI system, the AI system analyzing module 36026 changes an execution environment of the AI system to improve performance (e.g., increasing computational resources allocated to the AI system, such as computational load, memory, and/or storage to improve performance). In embodiments, in response to a detected or determined change in a performance of an AI system, the AI system analyzing module 36026 adjusts an allocation of AI systems of the AI convergence system of systems 31000 to the requests for invocations of the AI systems (e.g., optionally by interoperating with the AI system orchestration module 36022) such that requests are handled by AI systems that are capable of meeting performance requirements of the requests. In embodiments, in response to a detected or determined change in a performance of an AI system, the AI system analyzing module 36026 initiates a redevelopment of the AI system by an AI system redevelopment module 36034 (e.g., a retraining and/or replacement of the AI system with another AI system).

In embodiments, the operations modules 36002 include an AI system updating module 36028 that is configured and/or provided to update deployed artificial intelligence systems. In embodiments, in response to a detected or determined change in a performance of an AI system, the AI system updating module 36028 causes input to the AI system to be changed (e.g., reformatting, annotating, curating, editing, or otherwise changing the input to the AI system to improve the performance of the AI system). In embodiments, in response to a detected or determined change in a performance of an AI system, the AI system updating module 36028 causes an architecture of an AI system to be changed to improve the performance of the AI system (e.g., increasing a context window size of an AI system to process more data, and/or increasing a number of layers of the AI system to increase learning capacity). In embodiments, in response to a detected or determined change in a performance of an AI system, the AI system updating module 36028 causes output of the AI system to be changed (e.g., reformatting, annotating, curating, editing, or otherwise changing the output to the AI system to improve the performance of the AI system). In embodiments, the AI system updating module 36028 experimentally evaluates potential updates to an AI system to determine effects of the updates on the performance of the AI system (e.g., experimentally increasing the computational resources allocated to AI system and measuring an effect of the increased computational resources on one or more performance metrics of the AI system). In embodiments, the AI system updating module 36028 experimentally adjusts the inputs and/or processing of an AI system, or of a simulation of the AI system (e.g., of a digital twin), to determine the effect of the adjustments on the AI system. If the adjustments result in improved performance of the AI system, the AI system updating module 36028 may apply and/or commit the update to the AI system to realize and/or maintain the improvement in performance. In embodiments, in response to a detected or determined improvement in a performance of an AI system, the AI system updating module 36028 applies one or more features of the AI system that is associated with the improved performance to at least one other AI system, thereby enabling the at least one other AI system to exhibit a same or similar performance improvement.

In embodiments, the operations modules 36002 include an AI system governance module 36030 that is configured and/or provided to maintain governance of deployed artificial intelligence systems. For example, the AI system governance module 36030 may be configured and/or provided to govern one or more AI systems based on legal, social, practical, and/or regulatory policies (e.g., policies relating to truthfulness and/or avoidance of harm). In embodiments, the AI system governance module 36030 monitors invocations of one or more AI systems to detect and prevent unauthorized, unintended, and/or harmful uses of the AI systems (e.g., requests that are not permitted or that may contribute to harm and/or the violation of policies). In embodiments, the AI system governance module 36030 monitors input to one or more AI systems to detect and prevent unauthorized, unintended, and/or harmful inputs to the AI systems (e.g., inputs that include or are associated with objectionable and/or harmful content). In embodiments, the AI system governance module 36030 monitors the processing of one or more AI systems to detect and prevent unauthorized, unintended, and/or harmful processing by the AI systems (e.g., the avoidance of reasoning that may be considered deceptive or illegal). In embodiments, the AI system governance module 36030 monitors output of one or more AI systems to detect and prevent unauthorized, unintended, and/or harmful outputs of the AI systems (e.g., outputs that include or are associated with objectionable and/or harmful content). In embodiments, the AI system governance module 36030 monitors uses of the output of the AI systems by requesters and/or systems to determine unauthorized, unintended, and/or harmful uses of the AI systems (e.g., malicious use of the processing capabilities and/or output of the AI systems). In embodiments, the AI system governance module 36030 responds to detected requests, inputs, processing, outputs, and/or uses of the AI systems in various ways, such as modifying, censoring, editing, redacting, and/or blocking a request, input, processing, output, and/or use of the AI system. In embodiments, the AI system governance module 36030 receives, generates, adjusts, and/or reports policies based on the monitoring and governance, such as generating guidelines and/or tests to evaluate the requests, inputs, processing, outputs, and/or uses of the AI systems that may be associated with malicious, unauthorized, unintended, and/or harmful content or activities. In embodiments, the AI system governance module 36030 generates, adapts, and/or monitors one or more governance mechanisms applied to an AI system, such as monitoring an effectiveness of a rule set applied to the requests and/or inputs of an AI system to ensure that the processing and/or outputs of the AI system do not include unauthorized, unintended, and/or harmful content. In embodiments, the AI system governance module 36030 is configured to detect attempts to circumvent, subvert, remove, or otherwise avoid governance mechanisms applied to one or more AI systems (e.g., attempts to present input that is unauthorized, unintended, and/or harmful, but that is disguised to avoid detection by a governance rule set) and to update the policies and/or governance mechanisms of the AI systems to detect, reduce, alleviate, prevent, report, and/or penalize such avoidance. In embodiments, the AI system governance module 36030 is configured to detect attempts to violate the security, integrity, and/or availability of the AI systems (e.g., denial-of-service attacks, AI system “poisoning” attacks, and/or AI system exploration, eavesdropping, or data exfiltration) and to take steps to reduce, alleviate, prevent, report, and/or penalize such attacks.

In embodiments, the AI system governance module 36030 configures and/or provides supervision of one or more AI systems. For example, the AI systems may include one or more generative AI systems, and the AI system governance module 36030 may supervise the generation of content to promote positive features (e.g., quality, accuracy, coherence, or the like) and/or to reduce or prevent negative features (e.g., inaccuracy, incoherence, harmfulness, or the like). The AI system governance module 36030 may apply such supervision to the inputs to the generative AI systems (e.g., prompts and/or content sources provided as input), to the processing of the generative AI systems (e.g., to particular forms of information and/or reasoning used by the generative AI system), to the output of the generative AI systems (e.g., to content generated based on prompts and/or input), and/or to the uses of the generative AI systems (e.g., to the purposes for which generated content is used). The AI system governance module 36030 may apply such supervision based on rules, guidelines, heuristics, principles, comparisons with positive and negative content and/or processing, or the like. The AI system governance module 36030 may apply such supervision by generating and/or applying a supervising AI system to another AI system (e.g., a classifier network that classifies the output of a generative AI system as potentially negative). AI system governance module 36030 may apply such supervision with input from human reviewers (e.g., the AI system governance module 36030 may involve humans for spot-checking content, for scoring or rating content, for reviewing content generated by the AI systems that has been flagged as potentially negative, and/or for responding to reports of negative content generated by the AI systems). The AI system governance module 36030 may use the results of automated and/or human supervision to modify generated content; to modify the AI systems (e.g., training, retraining, and/or replacing the AI systems); to create, modify, and/or refine the supervision (e.g., modifying the rules, heuristics, principles, or the like to prevent the generation of further negative content by the AI systems); to create, modify, and/or refine supervising AI systems that are connected to other AI systems (e.g., training, retraining, and/or replacing a supervising AI system with an improved supervising AI system); and/or to generate reports about the AI systems (e.g., reports of the prompts, performance, types, and/or uses of content generated by the AI systems).

In embodiments, the operations modules 36002 include an AI system redevelopment module 36032 that is configured and/or provided to redevelop deployed artificial intelligence systems. For example, in response to the AI system analyzing module 36026 detecting reduced performance of an AI system, the AI system redevelopment module 36032 may be configured and/or provided to initiate retraining of the AI system using additional training data (e.g., additional synthetic training data generated by the AI system training data set augmentation module 36008 corresponding to new data that the AI system has not previously been trained to receive and process). In embodiments, in response to the AI system analyzing module 36026 detecting reduced performance of an AI system, the AI system redevelopment module 36032 causes the AI system training module 36010 to train a replacement AI system, and causes the AI system verifying module 36012 to verify that the replacement AI system addresses the reduced performance of the AI system. Based on such verifying, the AI system redevelopment module 36032 may cause the AI system deployment module 36018 to deploy the replacement AI system to substitute for the original AI system. In embodiments, the AI system redevelopment module 36032 may experimentally task the AI system training module 36010 with developing candidate AI systems that might replace an existing AI system. As compared with an existing AI system, a candidate AI system may be trained on different training data, with a different training regimen, with a different AI system type and/or architecture. A candidate AI system may be trained in a same or similar manner as an existing AI system, but may result in different and possibly improved performance due to the stochastic nature of AI system training. The AI system redevelopment module 36032 may initiate the redevelopment and/or experimental testing of candidate AI systems in response to a change of priority of tasks related to an AI system (e.g., an updated indication that a particular type of error is more harmful and/or more common than was previously initiated). The AI system redevelopment module 36032 may initiate the redevelopment and/or experimental testing of candidate AI systems in response to a change in the resources of the AI convergence system of systems 31000 (e.g., increased computational capacity may enable a candidate AI system with greater learning capacity to outperform an existing AI system). The AI system redevelopment module 36032 may initiate the redevelopment and/or experimental testing of candidate AI systems in response to advances in AI systems research or technology (e.g., a development of new model types, a new training regimen, new types of AI system hardware and/or software, or scientific discoveries relating to AI system performance and/or performance optimization techniques). Based on a candidate AI system exhibiting improved performance relative to an existing AI system, the AI system redevelopment module 36032 may initiate a deployment of the candidate AI system to replace the existing AI system.

In embodiments, the operations modules 36002 include an AI system logging module 36034 that is configured and/or provided to log the activities of artificial intelligence systems and/or operations modules 36002 while performing various operations and/or tasks. In embodiments, the AI system logging module 36034 is configured and/or provided to detect and log the operations of the AI system generation module 36004 in generating and/or storing new AI systems. In embodiments, the AI system logging module 36034 is configured and/or provided to detect and log the operations of the AI system training data set generation module 36006 in generating training data sets for the training of various AI systems. In embodiments, the AI system logging module 36034 is configured and/or provided to detect and log the operations of the training data set augmentation module 36008 in the number, kinds, sources, techniques, and examples of synthetic data generated for various training data sets, as well as the circumstances for such augmentation (e.g., the issues with a training data set that synthetic data was generated to address). In embodiments, the AI system logging module 36034 is configured and/or provided to detect and log the operations of the AI system training module 36010 in selecting, initiating, monitoring, validating, and completing the training of the AI systems of the AI convergence system of systems 31000, as well as the resulting performance of the trained AI systems (e.g., the performance, accuracy, recall, F1 score, bias, consistency, efficiency, and/or latency of respective trained AI systems). In embodiments, the AI system logging module 36034 is configured and/or provided to detect and log the operations of the AI system verifying module 36012 in verifying the generated AI systems (e.g., measurements of the performance of trained AI models on test data sets). In embodiments, the AI system logging module 36034 is configured and/or provided to detect and log the operations of the AI system adaptation module 36014 in adapting AI systems for particular devices, execution environments, data types, tasks, contexts, use cases, or the like. In embodiments, the AI system logging module 36034 is configured and/or provided to detect and log the operations of the AI system aggregation module 36016 in aggregating AI systems to generate and interconnect two or more AI systems to form hybrids, ensembles, sequences or chains, managed AI systems, AI system swarms, or the like. In embodiments, the AI system logging module 36034 is configured and/or provided to detect and log the operations of the AI system deployment module 36018 to deploy AI systems in response to various requests, which may originate within the AI convergence system of systems 31000 or external to the AI convergence system of systems 31000. In embodiments, the AI system logging module 36034 is configured and/or provided to detect and log the operations of the AI system invocation module 36020 to invoke one or more AI systems to fulfill one or more requests. In embodiments, the AI system logging module 36034 is configured and/or provided to detect and log the operations of the AI system orchestration module 36022 to organize the invocations of the AI systems of the AI convergence system of systems 31000 to meet the requirements of the requests and/or tasks, such as changes due to load-balancing or scheduling. In embodiments, the AI system logging module 36034 is configured and/or provided to detect and log the operations of the AI system monitoring module 36024 to monitor the performance of the AI systems of the AI convergence system of systems 31000, such as the planned and/or completed schedule of measuring and monitoring the performance of the AI systems and/or the results of the performance measurements. In embodiments, the AI system logging module 36034 is configured and/or provided to detect and log the operations of the AI system analyzing module 36026 to analyze the measured performance of the AI systems and the steps taken by the AI system analyzing module 36026 or other modules to respond to changes in performance (e.g., retraining AI systems, replacing AI systems, and/or adapting some AI systems to include features that resulted in performance improvements of other AI systems). In embodiments, the AI system logging module 36034 is configured and/or provided to detect and log the operations of the AI system updating module 36028 to update various AI systems in response to the analyses performed by the AI system analyzing module 36028. In embodiments, the AI system logging module 36034 is configured and/or provided to detect and log the operations of the AI system governance module 36030 to manage and/or govern the AI systems based on legal, social, practical, and/or regulatory policies (e.g., policies relating to truthfulness and/or avoidance of harm). In embodiments, the AI system logging module 36034 is configured and/or provided to detect and log the operations of the AI system redevelopment module 36032 to redevelop the AI systems based on the performance of the AI systems, the resources of the AI convergence system of systems 31000, and/or the development of new AI systems. In embodiments, the AI system logging module 36034 correlates the activities of various modules to determine causal relationships between the operations modules 36002 (e.g., a first event involving a deployment of an AI system in an environment that is associated with a second event involving a performance measurement of another AI system in the same environment; a first event involving an adaptation of an AI system followed by a second event involving a performance measurement of the adapted AI system; or a first event involving a reorganization of the AI convergence system of systems 31000 by the AI system orchestration module 36022 followed by a second event involving a change in a performance measurement of an AI system by the AI system monitoring module 36024). In embodiments, the AI system logging module 36034 logs the operations of the AI models and/or the operations modules 36002 in one or more event logs.

In embodiments, the operations modules 36002 are configured to serve one or more smart product operations. For example, a product such as a machine, appliance, vehicle, educational apparatus, or toy may be designed, configured, and/or provided to perform certain functions or roles. Such products may be made “smart” by supplementing the operation of the products with intelligent functions that resemble cognition and that improve the operation of the products. For example, a kitchen appliance may perform a task such as food preparation, storage, and/or cleaning, while a “smart” version of such a kitchen appliance may include cognitive features that improve the functions of the appliance, such as proactively initiating the functions, predicting and avoiding problems, adapting the functionality based on detected features and/or changing circumstances, communicating with users, and/or coordinating with other kitchen appliances. In such contexts, and in embodiments, the operations modules 36002 are configured to generate and/or invoke one or more AI systems to provide “smart” features for such products. For example, the operations modules 36002 may generate and/or invoke an AI system that adds a predictive “smart” feature to a product, such as a kitchen appliance that begins preparing food in anticipation of a need of a person for a meal. In embodiments, the operations modules 36002 generate and/or invoke one or more AI systems to add an adaptive “smart” feature to a product, such as a kitchen appliance that adapts a preparation of food based on detected food preferences of a user. In embodiments, the operations modules 36002 generate and/or invoke one or more AI systems to add an interactive “smart” feature to a product, such as a kitchen appliance that engages in a dialogue with a user to determine a type and/or manner of preparing food for the user. In embodiments, the operations modules 36002 generate and/or invoke one or more AI systems to add a coordinating “smart” feature to a product, such as a kitchen appliance that coordinates with other kitchen appliances to plan and/or execute a preparation of food for the user. In embodiments, the operations modules 36002 generate and/or invoke one or more AI systems to add a maintenance “smart” feature to a product, such as a kitchen appliance that detects maintenance problems with the appliance, diagnoses causes of the maintenance problems, identifies solutions to the maintenance problems, determines a plan for solving the maintenance problems, and/or executes solutions to the maintenance problems.

In embodiments, the operations modules 36002 are configured to serve one or more smart asset operations. For example, an asset may comprise a fund, an amount of currency such as an accumulation of cryptocurrency, a digital contract, a valuable object, or the like. Such assets may be made “smart” by supplementing the asset with intelligent functions that resemble cognition and that improve the features of the asset, such as value, security, and/or longevity. For example, a fund may be made “smart” by predicting or detecting events that may positively or negatively affect the value of the fund, identifying steps that may be taken responsive to the events, and/or executing the steps. A digital contract may be made “smart” by predicting or detecting events that may positively or negatively affect the execution of the smart contract by one or more parties, identifying steps that may be taken responsive to the events, and/or executing the steps. A valuable object may be made “smart” by predicting or detecting events that may positively or negatively affect the value of the object, identifying steps that may be taken responsive to the events, and/or executing the steps. In such contexts, and in embodiments, the operations modules 36002 are configured to generate and/or invoke one or more AI systems to provide “smart” features for such assets. In embodiments, the operations modules 36002 generate and/or invoke one or more AI systems to add a predictive “smart” feature to an asset, such as an AI system that monitors social, political, economic, scientific, and/or technical events and extrapolates positive and/or negative effects of the current events on a current and/or future value of the asset. In embodiments, the operations modules 36002 generate and/or invoke one or more AI systems to add a reactive “smart” feature to an asset, such as an AI system that identifies actions that can be taken regarding the asset in response to social, political, economic, scientific, and/or technical events. In embodiments, the operations modules 36002 generate and/or invoke one or more AI systems to add an executive “smart” feature to an asset, such as an AI system that executes actions to promote the value, security, and/or longevity of the asset in response to social, political, economic, scientific, and/or technical events.

In embodiments, the operations modules 36002 are configured to serve one or more deployments of smart infrastructure. For example, the infrastructure of an organization such as a government, a university, a hospital, or the like may include a set of interconnected infrastructure systems, such as power, communication, information technology, inventory management, transportation, maintenance, cleaning, and auditing. Each infrastructure system may include a set of resources, such as power infrastructure including power storage, wiring, regulation such as circuit breakers, switches for failover and load-balancing, and the like. The infrastructure may be made “smart” by supplementing the infrastructure with intelligent functions that resemble cognition and that improve the functionality of the infrastructure, such as availability, security, efficiency, and/or maintenance. For example, power infrastructure may be made “smart” by predicting and proactively addressing potential power failures due to events such as weather patterns, climate change, events in energy markets, and/or changes in the availability of energy-related supplies such as wiring and batteries. In such contexts, and in embodiments, the operations modules 36002 are configured to generate and/or invoke one or more AI systems to provide “smart” features to infrastructure. In embodiments, the operations modules 36002 generate and/or invoke one or more AI systems to add a predictive “smart” feature to infrastructure, such as an AI system that monitors social, political, economic, scientific, and/or technical events and extrapolates positive and/or negative effects of the current events on a current and/or future operation of various systems of the infrastructure. In embodiments, the operations modules 36002 generate and/or invoke one or more AI systems to add a reactive “smart” feature to the infrastructure, such as an AI system that identifies actions that can be taken to promote and/or maintain the availability, security, efficiency, and/or maintenance of the infrastructure system. In embodiments, the operations modules 36002 generate and/or invoke one or more AI systems to add an executive “smart” feature to the infrastructure, such as an AI system that executes actions to promote the availability, security, efficiency, and/or longevity of the infrastructure in response to social, political, economic, scientific, and/or technical events.

In embodiments, the operations modules 36002 are configured to serve one or more smart machines. For example, an industrial machine in a mining facility may include a number of mining-related functions, such as extracting a mineral, refining a mineral, and assessing the refined mineral for quality, quantity, purity, and/or value. The machine may be made “smart” by supplementing the machine with intelligent functions that resemble cognition and that improve the functionality of the machine, such as performance, efficiency, and/or longevity. For example, the machine may be made “smart” by adapting the manner of extracting minerals to promote the speed, efficiency, completeness, security, and/or integrity of the extraction process. In such contexts, and in embodiments, the operations modules 36002 are configured to generate and/or invoke one or more AI systems to provide “smart” features to the machine. In embodiments, the operations modules 36002 generate and/or invoke one or more AI systems to add a predictive “smart” feature to the machine, such as an AI system that predicts how changes in the mine and/or other machines of the mine may impact the current and/or future operation of the machine. In embodiments, the operations modules 36002 generate and/or invoke one or more AI systems to add a reactive “smart” feature to the machine, such as an AI system that identifies actions that can be taken to promote and/or maintain the performance, efficiency, and/or longevity of the machine (e.g., physical changes or upgrades of the machine, changes to the manner and/or timing of operation of the machine, and/or maintenance actions regarding various components of the machine). In embodiments, the operations modules 36002 generate and/or invoke one or more AI systems to add an executive “smart” feature to the machine, such as an AI system that executes actions to promote the performance, efficiency, and/or longevity of the machine (e.g., automatically arranging maintenance of components of the machine that are at risk of wear and/or failure).

In embodiments, the operations modules 36002 are configured to serve one or more smart containers. For example, a shipping container may store cargo such as machines, raw materials, fuel, food, chemicals, electronics, plants, livestock, or the like, and may provide a number of features for the cargo, such as physical isolation and protection of the cargo from outside elements, physical organization and cushioning of the cargo inside the container, and physical security to prevent unauthorized access. The container may be made “smart” by supplementing the container with intelligent functions that resemble cognition and that improve the functionality of the container, such as protection, maintenance, and monitoring of the cargo. For example, the container may be made “smart” by adding features such as tracking and reporting of the status and/or location of the cargo, and/or of servicing the cargo, such as physically manipulating the cargo and supplying water, oxygen, or nutrients. In such contexts, and in embodiments, the operations modules 36002 are configured to generate and/or invoke one or more AI systems to provide “smart” features to the container. In embodiments, the operations modules 36002 generate and/or invoke one or more AI systems to add a predictive “smart” feature to the container, such as an AI system that predicts how changes in the location, orientation, environment, climate, and/or physical status of the container and/or cargo may impact the current and/or future operation of the container and/or cargo. In embodiments, the operations modules 36002 generate and/or invoke one or more AI systems to add a reactive “smart” feature to the container, such as an AI system that identifies actions that can be taken to promote and/or maintain the protection, security, and/or maintenance of the container and/or cargo. In embodiments, the operations modules 36002 generate and/or invoke one or more AI systems to add an executive “smart” feature to the container, such as an AI system that executes actions to promote the protection, security, and/or maintenance of the container and/or cargo (e.g., communicating with transportation services to arrange for a change of location, orientation, or environment of the container to protect the container and/or cargo).

In embodiments, the operations modules 36002 are configured to serve one or more smart container ports. For example, a port such as a warehouse, a transport exchange point, a marketplace, or the like may store, organize, transport, and/or exchange containers that include various kinds of cargo, and may provide a number of features for the containers, cargo, transportation vehicles (e.g., ships, aircraft, trains, and trucks), and equipment of the port, such as physical isolation and protection of the containers, cargo, transportation vehicles, and resources of the ports from weather elements, physical organization of the containers in the port and/or during transport, and physical security to prevent unauthorized access to the containers, cargo, transportation vehicles, and resources of the port. The port may be made “smart” by supplementing the port with intelligent functions that resemble cognition and that improve the functionality of the port, such as protection, maintenance, and monitoring of the containers, cargo, transportation vehicles, and resources of the port. For example, the container may be made “smart” by adding features such as tracking and reporting of the status and/or location of the containers, cargo, transportation vehicle, and/or resources of the port, such as physical integrity, capacity, and fuel status. In such contexts, and in embodiments, the operations modules 36002 are configured to generate and/or invoke one or more AI systems to provide “smart” features to the port. In embodiments, the operations modules 36002 generate and/or invoke one or more AI systems to add a predictive “smart” feature to the port, such as an AI system that predicts how changes in the location, orientation, environment, climate, and/or physical status of the port may impact the containers, cargo, transportation vehicles, and/or resources of the port. In embodiments, the operations modules 36002 generate and/or invoke one or more AI systems to add a reactive “smart” feature to the port, such as an AI system that identifies actions that can be taken to promote and/or maintain the protection, security, and/or maintenance of the containers, cargo, transportation vehicles, and/or resources of the port. In embodiments, the operations modules 36002 generate and/or invoke one or more AI systems to add an executive “smart” feature to the port, such as an AI system that executes actions to promote the protection, security, and/or maintenance of the containers, cargo, transportation vehicles, and/or resources of the port (e.g., communicating with owners of the containers, cargo, and/or transportation vehicles to arrange the arrival, pickup, transportation, and/or maintenance of the containers, cargo, and/or transportation vehicles).

In embodiments, the operations modules 36002 are configured to serve one or more shipping operations. For example, a shipping operation may include a number of transportation vehicles, such as ships, aircraft, trains, and/or trucks, as well as resources such as warehouses, drivers, cargo handlers, and auditors. The shipping operation may coordinate these resources to arrange the receipt, transportation, storage, delivery, and maintenance of cargo and containers thereof, and may provide a number of features for the cargo and containers, such as physical isolation and protection from weather elements, physical organization of the cargo and containers during shipping, and physical security to prevent unauthorized access to the cargo and containers. The shipping operation may be made “smart” by supplementing the shipping operation with intelligent functions that resemble cognition and that improve the functionality of the shipping operation, such as the selection of delivery routes that improve the speed, safety, and efficiency of shipping and delivery of the cargo and containers. In such contexts, and in embodiments, the operations modules 36002 are configured to generate and/or invoke one or more AI systems to provide “smart” features to the shipping operation. In embodiments, the operations modules 36002 generate and/or invoke one or more AI systems to add a predictive “smart” feature to the shipping operation, such as an AI system that predicts how changes in the location, orientation, environment, climate, cargo, and/or containers of the shipping operation may impact the containers, cargo, transportation vehicles, and/or resources of the shipping operation, including the storage, transportation, and delivery of the cargo and containers. In embodiments, the operations modules 36002 generate and/or invoke one or more AI systems to add a reactive “smart” feature to the shipping operation, such as an AI system that identifies actions that can be taken to promote and/or maintain the protection, security, and/or maintenance of the containers, cargo, transportation vehicles, and/or resources of the shipping operation, including the storage, transportation, and delivery of the cargo and containers. In embodiments, the operations modules 36002 generate and/or invoke one or more AI systems to add an executive “smart” feature to the shipping operation, such as an AI system that executes actions to promote the protection, security, and/or maintenance of the containers, cargo, transportation vehicles, and/or resources of the port, including the storage, transportation, and delivery of the cargo and containers (e.g., communicating with owners of the cargo and containers to coordinate the arrival, pickup, transportation, and/or maintenance of the cargo and containers).

In embodiments, the operations modules 36002 are configured to serve one or more robotic operations. For example, a robotic operation may include a fleet of robots, each having a set of capabilities (e.g., sensors, modes of transportation, tools, end effectors, and the like) and requirements (e.g., fuel or power storage, protection from elements such as water or electrical shock, and periodic maintenance), and each being assigned to perform one or more tasks (e.g., transporting materials, monitoring a location, and/or serving a user). The robotic operation may be made “smart” by supplementing the robotic operation with intelligent functions that resemble cognition and that improve the functionality of the robotic operation, such as the assignment of robots to tasks, the maintenance and upgrading of the robotic fleet, and the performance of tasks by the robots. In such contexts, and in embodiments, the operations modules 36002 are configured to generate and/or invoke one or more AI systems to provide “smart” features to the robotic operation. In embodiments, the operations modules 36002 generate and/or invoke one or more AI systems to add a predictive “smart” feature to the robotic operation, such as an AI system that predicts how changes in the location, orientation, environment, climate, cargo, and/or containers of the robotic operation may impact the performance of the tasks by the robotic fleet, such as obstacles or interruptions of service that might prevent the robots from completing one or more tasks. In embodiments, the operations modules 36002 generate and/or invoke one or more AI systems to add a reactive “smart” feature to the robotic operation, such as an AI system that identifies actions that can be taken to promote the performance, reliability, efficiency, and/or completion of the tasks by the robotic fleet, including adapting the assignment, scheduling, and/or prioritization of the robots of the robotic fleet to the set of available tasks. In embodiments, the operations modules 36002 generate and/or invoke one or more AI systems to add an executive “smart” feature to the robotic operation, such as an AI system that executes actions to promote the performance, reliability, efficiency, and/or completion of the tasks by the robotic fleet, such as automatically deploying, assigning, reassigning decommissioning, and/or upgrading robots to perform the tasks of the robotic operation, and/or automatically maintaining and/or upgrading the robotic fleet to preserve and/or add capabilities to the robotic fleet.

In embodiments, the operations modules 36002 are configured to serve one or more autonomous vehicle operations. For example, an autonomous vehicle operation may include a number of autonomous vehicles, such as taxis, buses, ambulances, trucks, trains, monorails, trolleys, aircraft, ferries, and cargo ships, as well as resources such as garages, fuel depots, roads, waterways, railways, and airspaces. The autonomous vehicle operation may coordinate the autonomous vehicles and resources to arrange the pickup, transport, and delivery of drivers, operators, passengers, clients, and/or cargo, and may provide a number of features for the drivers, operators, passengers, clients, and/or cargo, such as physical isolation and protection from weather elements, comfort and privacy of the drivers, operators, passengers, clients, and/or cargo, and physical security of the drivers, operators, passengers, clients, and cargo during transit. The autonomous vehicle operation may be made “smart” by supplementing the autonomous vehicle operation with intelligent functions that resemble cognition and that improve the functionality of the autonomous vehicle operation, such as the selection of transportation routes that improve the speed, safety, and efficiency of transporting the drivers, operators, passengers, clients, and/or cargo. In such contexts, and in embodiments, the operations modules 36002 are configured to generate and/or invoke one or more AI systems to provide “smart” features to the autonomous vehicle operation. In embodiments, the operations modules 36002 generate and/or invoke one or more AI systems to add a predictive “smart” feature to the autonomous vehicle operation, such as an AI system that predicts how changes in the environment, population, and/or maintenance of transit resources (e.g., roads or railways), autonomous vehicles, drivers, operators, passengers, clients, and/or cargo may impact the safe and/or timely transportation of the drivers, operators, passengers, clients, and/or cargo, such as an arrival time at a destination and/or a condition of the drivers, operators, passengers, clients, and/or cargo upon arrival. In embodiments, the operations modules 36002 generate and/or invoke one or more AI systems to add a reactive “smart” feature to the autonomous vehicle operation, such as an AI system that identifies actions that can be taken to promote and/or maintain the protection, security, and/or maintenance of the autonomous vehicles, drivers, operators, passengers, clients, and/or cargo (e.g., scheduling a stop along a route for the rest, relaxation, maintenance, and/or fulfillment of needs of the drivers, operators, passengers, clients, and/or cargo). In embodiments, the operations modules 36002 generate and/or invoke one or more AI systems to add an executive “smart” feature to the autonomous vehicle operation, such as an AI system that executes actions to protection, security, and/or maintenance of the autonomous vehicles, drivers, operators, passengers, clients, and/or cargo (e.g., automatically updating a route of an autonomous vehicle to improve an estimated arrival time at a destination and/or to promote the rest, relaxation, maintenance, and/or fulfillment of needs of the drivers, operators, passengers, clients, and/or cargo).

In embodiments, the operations modules 36002 are configured to serve one or more UAV operations. For example, a UAV operation may include a fleet of unmanned aerial vehicles, such as drones, light aircraft, helicopters, balloons, dirigibles, airships, rockets, satellites, or the like. The unmanned aerial vehicles may be autonomously controlled by onboard or remote AI systems to perform the takeoff, route selection and correction, airborne maneuvers, status monitoring, and landing of the aircraft. The UAV operation may assign various UAVs of the UAV fleet to various tasks, such as monitoring or measuring a particular geographic region or a subject such as a field of crops, livestock, or an industrial or military operation; deploying substances such as water, fire suppression substances, fertilizer, or pesticide; transporting cargo between various locations; delivering fuel and/or power to other UAVs; or providing first-responder services such as transporting first responders or equipment to address health emergencies or public safety events. In such contexts, and in embodiments, the operations modules 36002 are configured to generate and/or invoke one or more AI systems to provide “smart” features to the UAV operation. In embodiments, the operations modules 36002 generate and/or invoke one or more AI systems to add a predictive “smart” feature to the UAV operation, such as an AI system that predicts how changes in the environment, climate, traffic, wildlife, population, and/or equipment may impact the performance of the tasks by the UAV fleet, such as obstacles or interruptions of service that might prevent the UAVs from completing one or more tasks. In embodiments, the operations modules 36002 generate and/or invoke one or more AI systems to add a reactive “smart” feature to the UAV operation, such as an AI system that identifies actions that can be taken to promote the performance, reliability, efficiency, and/or completion of the tasks by the UAV fleet, including adapting the assignment, scheduling, and/or prioritization of the UAVs of the UAV fleet to the set of available tasks. In embodiments, the operations modules 36002 generate and/or invoke one or more AI systems to add an executive “smart” feature to the UAV operation, such as an AI system that executes actions to promote the performance, reliability, efficiency, and/or completion of the tasks by the UAV fleet, such as automatically deploying, assigning, reassigning decommissioning, and/or upgrading UAVs to perform the tasks of the UAV operation, and/or automatically maintaining and/or upgrading the UAV fleet to preserve and/or add capabilities to the UAV fleet.

In embodiments, the operations modules 36002 are configured to serve one or more human-machine cooperative operations. For example, a human-machine cooperative operation may involve one or more tasks that are performed by one or more humans cooperating with one or more machines in fields such as mining, manufacturing, surveying, construction, healthcare, education, emergency response, or the like. A human and a machine may cooperate to perform a physical task together, such as carrying a piece of equipment, furniture, or a material such as a pane of glass. A human and a machine may cooperate to choose a plan for completing a task, such as surveying a geographic region to measure a population of wildlife. A human and a machine may cooperate by the human supervising the performance of a task by a machine, such as a robot engaging in a manufacturing or construction operation while a human monitors the operation of the robot to detect and address problems. A human and a machine may cooperate by the robot observing the human during the performance of a task to learn how to perform the task, such as a robotic process automation (RPA) task that enables the robot to perform the task autonomously in the future. A human and a machine may cooperate by the human observing the robot during the performance of a task to learn how to perform the task, such as a skill-sharing operation where a robot teaches a human to perform a task, which may have been learned from another human. The human-machine cooperative operation may be made “smart” by supplementing the human-machine cooperative operation with intelligent functions that resemble cognition and that improve the functionality of the human-machine cooperative operation, such as the mapping of tasks to combinations of one or more humans and one or more machines. In such contexts, and in embodiments, the operations modules 36002 are configured to generate and/or invoke one or more AI systems to provide “smart” features to the human-machine cooperative operation. In embodiments, the operations modules 36002 generate and/or invoke one or more AI systems to add a predictive “smart” feature to the human-machine cooperative operation, such as an AI system that predicts which humans and which machines will cooperate well together to perform a particular task. In embodiments, the operations modules 36002 generate and/or invoke one or more AI systems to add a reactive “smart” feature to the human-machine cooperative operation, such as an AI system that identifies the occurrence and/or causes of current and/or future disagreements between a human cooperating with a machine. In embodiments, the operations modules 36002 generate and/or invoke one or more AI systems to add an executive “smart” feature to the human-machine cooperative operation, such as an AI system that executes actions to address disagreements between a human cooperating with a machine, such as conversations, mediation by the AI system or by another human and/or machine, clarification of communication between the human and the machine, review and analysis of previous interaction between the human and the machine that resulted in the disagreement, and/or adjustments of the assignment of humans and machines to various cooperative tasks.

In embodiments, the operations modules 36002 are configured to serve one or more maintenance operations. For example, a maintenance operation may involve surveying, testing, resupplying, repairing, reprogramming, refreshing, cleaning, and/or replacing a machine or one or more components of a machine. The maintenance operation may be made “smart” by supplementing the maintenance operation with intelligent functions that resemble cognition and that improve the functionality of the maintenance operation, such as refining the maintenance operations for improved efficiency, speed, availability, reliability, completion, and/or recordation of the maintenance operations. In such contexts, and in embodiments, the operations modules 36002 are configured to generate and/or invoke one or more AI systems to provide “smart” features to the maintenance operation. In embodiments, the operations modules 36002 generate and/or invoke one or more AI systems to add a predictive “smart” feature to the maintenance operation, such as an AI system that predicts how changes to the machine or an environment of the machine may positively or negatively impact the relevance, urgency, timeliness, extent, and/or completeness of maintenance operations for the machine.

In embodiments, the operations modules 36002 generate and/or invoke one or more AI systems to add a reactive “smart” feature to the maintenance operation, such as an AI system that improves the diagnostic accuracy, reliability, and/or efficiency of the maintenance operations of the machine in view of changes to the machine, uses of the machine (e.g., the materials and/or tasks for which the machine is used), and/or an environment of the machine. In embodiments, the operations modules 36002 generate and/or invoke one or more AI systems to add an executive “smart” feature to the maintenance operation, such as an AI system that executes actions to improve the diagnostic accuracy, reliability, and/or efficiency of the maintenance operations, such as automatically adjusting a maintenance schedule in response to changes to the machine, uses of the machine (e.g., the materials and/or tasks for which the machine is used), and/or an environment of the machine.

In embodiments, the operations modules 36002 are configured to serve one or more payment operations. For example, a payment operation may involve a determination of one or more payment obligations, such as payments associated with payroll, purchasing, investment distribution, and/or lottery or gambling operations. The payment operation may involve determining and verifying a payment event, determining an availability of funds in a fund source, verifying a recipient and/or destination of the payment, initiating a payment event such as a transfer of currency, verifying receipt and/or execution of the payment, and logging and/or auditing the payment. The payment operation may be made “smart” by supplementing the payment operation with intelligent functions that resemble cognition and that improve the functionality of the payment operation, such as improving the security, accuracy, efficiency, and/or auditing of such payments. In such contexts, and in embodiments, the operations modules 36002 are configured to generate and/or invoke one or more AI systems to provide “smart” features to the payment operation. In embodiments, the operations modules 36002 generate and/or invoke one or more AI systems to add a predictive “smart” feature to the payment operation, such as an AI system that predicts security issues that might arise in the payment operation such as fraudulent inducement, impersonation, interception, redirection, fabrication, manipulation, duplication, obscuring, and/or illegality of payments. In embodiments, the operations modules 36002 generate and/or invoke one or more AI systems to add a reactive “smart” feature to the payment operation, such as an AI system that recommends additional security processes to reduce, detect, and/or prevent fraudulent inducement, impersonation, interception, redirection, fabrication, manipulation, duplication, obscuring, and/or illegality of payments. In embodiments, the operations modules 36002 generate and/or invoke one or more AI systems to add an executive “smart” feature to the payment operation, such as an AI system that executes actions to monitor, verify, block, audit, record, audit, and/or report occurrences of payments and/or problems related thereto, such as fraudulent inducement, impersonation, interception, redirection, fabrication, manipulation, duplication, obscuring, and/or illegality of payments

### Network Layer—Network Modules

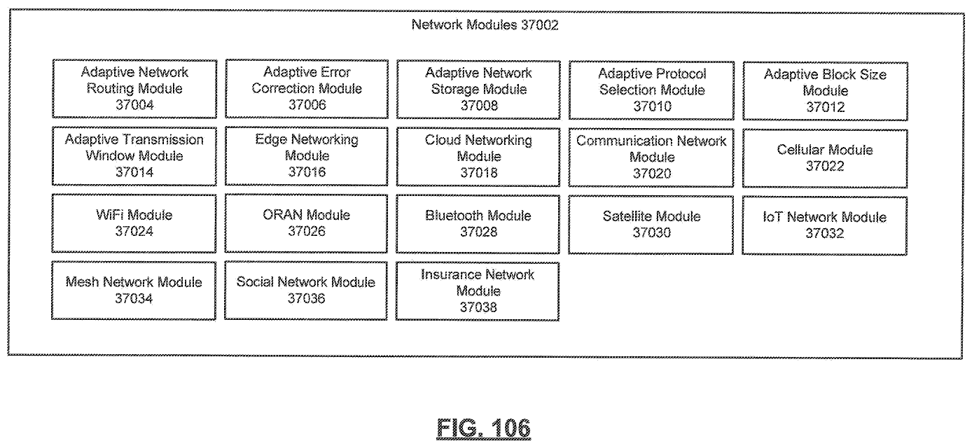

Referring to FIG. 102 and FIG. 106, the AI convergence system of systems 31000 may include a network layer 37000 having a set of network modules 37002. In embodiments, the network modules 37002 may include an adaptive network routing module 37004, an adaptive error correction module 37006, an adaptive network storage module 37008, an adaptive protocol selection module 37010, an adaptive block size module 37012, an adaptive transmission window module 37014, an edge networking module 37016, a cloud networking module 37018, a communication network 37020, a cellular module 37022, a WiFi module 37024, an ORAN module 37026, a Bluetooth module 37028, a satellite module 37030, an IoT network module 37032, a mesh network module 37034, a social network module 37036, and an insurance network module 37038. In embodiments, the set of network modules 37002 may further include a power grid module, a shipping network module, a delivery network module, a distributed energy network module, a healthcare network module, an IoT-in-a-box module, an industrial IT/OT module, a transaction network module, a financial network module, a payments network module, a transportation network module, a value chain network module, and a supply chain network module.

In some embodiments, each network module of the network layer 37000 may include one or more processors and one or more memories storing computer-executable instructions that, when executed by the one or more processors, cause the one or more processors to implement a set of machine learning systems, a set of artificial intelligence systems, and/or a set of neural networks configured to perform an intelligence task related to that particular network module. Such intelligence tasks may relate to optimization tasks, generative tasks, predictive tasks, detection and/or identification tasks, decision support tasks, automation tasks, configuration and/or control tasks, and the like.

The machine learning systems may be trained using supervised, unsupervised, or reinforcement learning techniques on diverse types of data, including simulated data (e.g., data generated from a simulation engine, a foundation world model, a set of digital twins, or the like). The neural networks may comprise multiple layers including, but not limited to, convolutional layers, recurrent layers, and fully connected layers. The artificial intelligence systems may implement various algorithms including decision trees, random forests, and gradient boosting machines. The network layer 37000 may further include a simulation engine or set of foundation world models operating in parallel with the machine learning systems, artificial intelligence systems, and/or neural networks, wherein the simulation engine and/or set of foundation world models are configured to generate real-time simulations of scenarios associated with each intelligence task, validate decisions, and provide feedback to the machine learning models for continuous improvement and adaptation to changing conditions. In embodiments, the simulation engine may employ physics-based modeling, discrete event simulation, or agent-based modeling techniques to accurately represent the dynamics of real-world behavior.

### Adaptive Network Routing Module

For example, an adaptive network routing module 37004 of the network layer 37000 may implement a set of machine learning systems, a set of artificial intelligence systems, and/or a set of neural networks configured to optimize network routing paths in real time. Additional and/or alternative intelligence tasks may involve predictive tasks like forecasting traffic patterns across nodes, detection and identification tasks to recognize network bottlenecks or anomalies, automation tasks to dynamically adjust routing configurations based on current network conditions, decision support tasks by recommending optimal paths for high-priority data and configuration tasks to enforce changes across the network infrastructure to ensure efficient data flow and minimized latency, and the like.

### Adaptive Error Correction Module

In another example, an adaptive error correction module 37006 of the network layer 37000 may implement a set of machine learning systems, a set of artificial intelligence systems, and/or a set of neural networks configured to identify, predict, and/or correct errors in network communication in real time. Additional and/or alternative intelligence tasks may involve predictive tasks like anticipating potential error-prone scenarios based on historical data, detection and identification tasks to isolate and classify errors in data packets or transmissions, automation tasks to dynamically apply error correction protocols or retransmission strategies, decision support tasks to recommend optimal recovery mechanisms for maintaining data integrity, and configuration tasks to adjust system parameters to prevent future errors, among many others.

### Adaptive Network Storage Module

In yet another example, an adaptive network storage module 37008 of the network layer 37000 may implement a set of machine learning systems, a set of artificial intelligence systems, and/or a set of neural networks configured to optimize the allocation, retrieval, and management of storage resources across the network. Additional and/or alternative intelligence tasks may involve predictive tasks like forecasting storage capacity requirements based on historical usage patterns, detection and identification tasks to monitor and address storage bottlenecks or underutilized resources, automation tasks to dynamically allocate or reallocate storage to maintain optimal performance, decision support tasks to recommend data replication or tiering strategies for improved efficiency and reliability, configuration tasks to enforce policies for storage redundancy and access control, and the like.

### Adaptive Protocol Selection Module

In yet another example, an adaptive protocol selection module 37010 of the network layer 37000 may implement a set of machine learning systems, a set of artificial intelligence systems, and/or a set of neural networks configured to dynamically select the most appropriate communication protocols based on real-time network conditions and requirements. Additional and/or alternative intelligence tasks may involve predictive tasks like forecasting protocol performance under varying loads, detection and identification tasks to assess protocol compatibility or inefficiencies, automation tasks to switch protocols during transmission, decision support tasks to recommend protocols for specific scenarios, configuration tasks to optimize protocol settings for maximum efficiency, and the like.

### Adaptive Block Size Module

In yet another example, an adaptive block size module 37012 of the network layer 37000 may implement a set of machine learning systems, a set of artificial intelligence systems, and/or a set of neural networks configured to determine and adjust block sizes dynamically to optimize data transfer efficiency. Additional and/or alternative intelligence tasks may involve predictive tasks like estimating optimal block sizes based on network latency and bandwidth, detection and identification tasks to flag inefficiencies caused by suboptimal block sizes, automation tasks to adjust block sizes in real time during data transfers, decision support tasks to recommend configurations for specific network conditions, configuration tasks to enforce block size policies across the network, and the like.

### Adaptive Transmission Window Module

In yet another example, an adaptive transmission window module 37014 of the network layer 37000 may implement a set of machine learning systems, a set of artificial intelligence systems, and/or a set of neural networks configured to dynamically adjust transmission windows to optimize data flow and minimize congestion. Additional and/or alternative intelligence tasks may involve predictive tasks like forecasting optimal transmission windows based on traffic patterns, detection and identification tasks to identify bottlenecks or excessive retransmissions, automation tasks to modify transmission windows in real time to balance throughput and reliability, decision support tasks to suggest window sizes for specific workloads, configuration tasks to apply policies for transmission efficiency, and the like.

### Edge Networking Module

In yet another example, an edge networking module 37016 of the network layer 37000 may implement a set of machine learning systems, a set of artificial intelligence systems, and/or a set of neural networks configured to enable localized data processing and communication at the network edge. Additional and/or alternative intelligence tasks may involve predictive tasks like anticipating traffic loads at edge nodes, detection and identification tasks to monitor edge device performance or connectivity issues, automation tasks to redistribute workloads between edge and central resources, decision support tasks to recommend edge deployment strategies, configuration tasks to manage edge resource allocation, and the like.

### Cloud Networking Module

In yet another example, a cloud networking module 37018 of the network layer 37000 may implement a set of machine learning systems, a set of artificial intelligence systems, and/or a set of neural networks configured to optimize the connectivity and resource utilization of cloud-based infrastructures. Additional and/or alternative intelligence tasks may involve predictive tasks like forecasting bandwidth demands for cloud applications, detection and identification tasks to diagnose cloud network performance issues, automation tasks to balance traffic between virtual network nodes, decision support tasks to optimize network configurations for cloud workloads, configuration tasks to manage cloud network policies, and the like.

### Communication Network

In yet another example, a communication network module 37020 of the network layer 37000 may implement a set of machine learning systems, a set of artificial intelligence systems, and/or a set of neural networks configured to manage and optimize end-to-end data communication across the network. Additional and/or alternative intelligence tasks may involve predictive tasks like forecasting communication delays or outages, detection and identification tasks to locate and resolve data packet loss, automation tasks to reroute traffic for maximum efficiency, decision support tasks to enhance network configurations for specific use cases, configuration tasks to implement fault tolerance strategies, and the like.

### Cellular Module

In yet another example, a cellular module 37022 of the network layer 37000 may implement a set of machine learning systems, a set of artificial intelligence systems, and/or a set of neural networks configured to optimize the performance and reliability of cellular network communication. Additional and/or alternative intelligence tasks may involve predictive tasks like estimating cellular network load during peak times, detection and identification tasks to monitor signal quality or interference, automation tasks to adjust handover mechanisms between cells, decision support tasks to improve frequency allocation, configuration tasks to enhance network scalability, and the like.

### WiFi Module

In yet another example, a WiFi module 37024 of the network layer 37000 may implement a set of machine learning systems, a set of artificial intelligence systems, and/or a set of neural networks configured to optimize wireless local area network (WLAN) connectivity and performance. Additional and/or alternative intelligence tasks may involve predictive tasks like forecasting WiFi congestion in high-density areas, detection and identification tasks to analyze signal strength or interference sources, automation tasks to dynamically adjust channel allocations or access point settings, decision support tasks to enhance network configurations for specific environments, configuration tasks to enforce security protocols, and the like.

### ORAN Module

In yet another example, an ORAN (Open Radio Access Network) module 37026 of the network layer 37000 may implement a set of machine learning systems, a set of artificial intelligence systems, and/or a set of neural networks configured to optimize and manage ORANs. Additional and/or alternative intelligence tasks may involve predictive tasks like forecasting traffic loads across base stations, detection and identification tasks to monitor ORAN performance, automation tasks to adjust radio resource allocations dynamically, decision support tasks to enhance multi-vendor ORAN configurations, configuration tasks to optimize spectrum usage, and the like.

### Bluetooth Module

In yet another example, a Bluetooth module 37028 of the network layer 37000 may implement a set of machine learning systems, a set of artificial intelligence systems, and/or a set of neural networks configured to optimize short-range wireless communication for connected devices. Additional and/or alternative intelligence tasks may involve predictive tasks like anticipating device pairing or traffic patterns, detection and identification tasks to analyze signal interference or connectivity issues, automation tasks to adjust device priorities dynamically, decision support tasks to enhance Bluetooth mesh configurations, configuration tasks to manage device security, and the like.

### Satellite Module

In yet another example, a satellite module 37030 of the network layer 37000 may implement a set of machine learning systems, a set of artificial intelligence systems, and/or a set of neural networks configured to optimize satellite communication. Additional and/or alternative intelligence tasks may involve predictive tasks like forecasting weather-related signal degradation, detection and identification tasks to monitor satellite link performance, automation tasks to reroute traffic dynamically between satellites, decision support tasks to recommend satellite placement strategies, configuration tasks to optimize bandwidth utilization, and the like.

### IoT Network Module

In yet another example, an IoT network module 37032 of the network layer 37000 may implement a set of machine learning systems, a set of artificial intelligence systems, and/or a set of neural networks configured to manage and optimize connectivity for Internet of Things (IOT) devices. Additional and/or alternative intelligence tasks may involve predictive tasks like estimating device activity patterns, detection and identification tasks to flag malfunctioning or compromised devices, automation tasks to dynamically allocate network resources for IOT traffic, decision support tasks to improve IoT gateway configurations, configuration tasks to enforce security measures, and the like.

### Mesh Network Module

In yet another example, a mesh network module 37034 of the network layer 37000 may implement a set of machine learning systems, a set of artificial intelligence systems, and/or a set of neural networks configured to optimize and manage a set of decentralized and/or mesh networks. Additional and/or alternative intelligence tasks may involve predictive tasks like forecasting node connectivity or load imbalances, detection and identification tasks to locate failing or underperforming nodes, automation tasks to reroute traffic dynamically within the mesh, decision support tasks to improve network scalability and resilience, configuration tasks to optimize node configurations, and the like.

### Social Network Module

In yet another example, a social network module 37036 may implement a set of machine learning systems, a set of artificial intelligence systems, and/or a set of neural networks configured to optimize user engagement, content delivery, and network connectivity across a social network. Additional and/or alternative intelligence tasks may involve predictive tasks like forecasting user activity patterns or viral content trends, detection and identification tasks to flag illegal content, automation tasks to curate personalized content feeds dynamically, decision support tasks to recommend moderation or community management strategies, configuration tasks to enforce privacy and security policies, and the like.

### Delivery Network Module

In yet another example, a delivery network module may implement a set of machine learning systems, a set of artificial intelligence systems, and/or a set of neural networks configured to optimize last-mile logistics, package tracking, and delivery efficiency across a delivery network. Additional and/or alternative intelligence tasks may involve predictive tasks like estimating delivery times and forecasting traffic patterns, detection and identification tasks to monitor delivery route bottlenecks or failed deliveries, automation tasks to dynamically reroute delivery vehicles for improved efficiency, decision support tasks to enhance fleet management strategies, configuration tasks to prioritize high-value or time-sensitive deliveries, and the like.

### Transportation Network Module

In yet another example, a transportation network module may implement a set of machine learning systems, a set of artificial intelligence systems, and/or a set of neural networks configured to manage and optimize the flow of goods and/or people across a transportation network. Additional and/or alternative intelligence tasks may involve predictive tasks like forecasting traffic congestion or vehicle demand, detection and identification tasks to monitor delays or route inefficiencies, automation tasks to dynamically adjust schedules or routes, decision support tasks to recommend fleet optimization strategies, configuration tasks to implement sustainable transportation policies, and the like.

### Adaptive Networking and QoS Platform

At the network layer 37000, AI capabilities for adaptive networking enable a platform for providing integrated, adaptive networking and quality of service (QOS) (“the adaptive networking and QoS platform”) for various enterprise and/or operational environments (in some implementations having various sets of facilities and/or environments contained therein). For example, enterprise and/or operational environments may include industrial environments, manufacturing environments, warehouse environments, shipping environments (e.g., container ports, shipping containers, shipyards, and the like), energy environments (e.g., fossil fuel energy environments such as oil rigs, pipelines, and refineries or nuclear energy environments such as nuclear power plants), retail environments, transportation environments (e.g., airports, train stations, bus stops, airplanes, train cars, and the like), transaction and banking environments, datacenter environments, compute environments, hospitality environments, gaming environments, and entertainment environments, among many others.

The adaptive networking and QoS platform may include, without limitation, caching of AI content and generative AI content (e.g., pre-generated instructions for operating machinery, customer risk assessments, pre-generated customer support responses, pre-generated explanations of medical conditions, optimal delivery routes for recurring logistics paths, path optimization results for robot pickers in commonly used zones, workload distribution recommendations, predictions for server failure risks, customer preference data, product recommendation results for repeat customers, pre-generated personalized marketing emails, and pre-generated maintenance instructions or escalation workflows for hardware issues, among many others); caching of AI models (e.g., predictive AI models such as predictive maintenance models for specific machinery, recommendation models, optimization models such as for optimizing factory floor layouts, credit risk assessment models, fraud detection models, load forecasting models, anomaly detection models, diagnostic models, inventory tracking models, pathfinding models, workload balancing models, pricing optimization models, resource allocation models, and the like) and generative AI models (such as for efficient, localized generation of AI content based on localized, contextual inputs and/or for localized, customized use); handling via edge capabilities of transaction events (including point-of-sale transactions, fraud detection, payment processing, energy trading, toll collection, bet placement, payouts, buy-ins, room booking, food and beverage purchases, event ticket purchases, loyalty and rewards transactions (e.g., points earning, points redemption, and membership upgrades), promotional transactions, reporting, payment resolution, and other transaction functions); execution by edge capabilities of gaming engine functions (such as enabling efficient, localized generation of AI-driven environments (e.g., large-scale foundation models for training intelligent agents), simulations, characters or personnel (including physical robots as well as software-based personnel for customer-facing interactions and/or other operations, as well as AI-based attributes, behaviors, and interactions for virtual or augmented systems, including AR/VR-enabled simulations, training modules, operational overlays, and the like); execution by edge capabilities of experience orchestration (such as generating immersive and interactive experiences tailored to localized context, operational needs, and/or personalization of generative content based on real-time understanding of target cohorts, operational conditions, or individual user preferences across various environments, including AR/VR simulations, dynamic visualizations, and situationally adaptive content delivery); and/or the like.

In embodiments, edge capabilities may be provided in edge systems, devices, switches, chipsets and other embodiments. Edge capabilities may include converged capabilities where a set of artificial intelligence capabilities, such as generative or other AI capabilities, are integrated with other networking capabilities, such as by providing them as part of the same device or system, providing them with shared or coordinated input/output channels, providing them with coordinated access to the same data, or the like.

### Adaptive Network Capabilities

In embodiments, the adaptive networking and QoS platform includes caching of AI models for operations and use cases for various environments. In embodiments, the foregoing capabilities are enabled by adaptive networking capabilities as described in this disclosure and the documents incorporated by reference herein, such as by adapting a networking capability based on one or more of network conditions, based on a set of prioritization parameters, based on the content to be generated by a sender (e.g., an edge device) and or delivered over the network from a sender, based on the capabilities of a receiver, and/or based on the nature of usage by a receiver, among others. Such adaptive networking capabilities, based on such factors, may include, without limitation: a) adaptive selection of a networking protocol (e.g., a physical layer, transport layer, media access control layer, or other networking protocol); b) adaptive generation of content by an edge or other networking device that is capable of content generation, such as by generation of content of a suitable format, file type, size (e.g., by adaptive chunking of generative content into suitable block sizes or the like); c) adaptive storage of data on a network storage device, including caching for rapid access and/or long term storage; d) adaptive routing of network traffic, including based on QoS or channel conditions, cost of routing, and other factors; e) adaptive network coding, including setting of random linear network coding or other coding parameters; f) adaptive block sizing; g) adaptive data rate (including dynamically adjusting data rate according to a linear, convex, or concave adjustment curve); h) adaptive error correction, including adaptive setting of forward error correction parameters; i) adaptive session management, including setting timing of session initiative, termination and duration; j) adaptive and/or dynamic spectrum access management, including slicing usage available cellular or other spectrum based on any of the factors noted above; k) adaptive setting of mesh networking parameters; l) adaptive setting of software filters for repeaters, switches, routers and other software-defined transmission devices; m) adaptive configuration of mobile ad hoc network parameters; and others. Any one or more of these capabilities may be provided in an adaptive networking device or system that further includes a set of other AI capabilities, including generative AI capabilities for generation of content that is to be handled by the converged device or system.

In embodiments, the network layer 37000 may be configured to facilitate communications among smart network-capable systems, their users, and the like while leveraging AI to dynamically adapt network configurations and optimize data flow. The integration of edge computing with cloud services ensures that data processing and transaction and workflow orchestration can occur closer to the data source, reducing latency and enhancing real-time decision-making capabilities. AI algorithms may be capable of intelligently routing data (e.g., IoT data, sensor data, edge data, transaction data, behavior data, social data, web data, crowdsourced data, media data, vector data, distributed data, and the like) through the most efficient network paths, whether they be cellular, WiFi, Open Radio Access Network (ORAN), Bluetooth, IoT communication protocols, and other communication protocols. For implementation, the network modules 37002 may utilize AI for predictive network traffic management, ensuring bandwidth is allocated where it is needed most, and cryptographic techniques for securing data at the edge. AI-driven anomaly detection systems may be employed to monitor network health and preemptively address potential disruptions.

In embodiments, the network layer 37000 may provide advanced computing capabilities at the edge of the network to process and manage transactions locally to improve response times, conserve bandwidth, enhance security, and the like. The network layer 37000 may be supported by edge devices, edge data centers, edge computing platforms, and the like. In embodiments, blockchain may be used to handle distributed transactions across multiple edge devices, offering security and transparency of transactions. AI may be used at the edge to make intelligent decisions based on the data processed, which may be particularly useful for personalized user experiences.

At the network layer 37000, caching of generative AI may be used for reducing the computational resources and energy consumption required for AI workloads, benefits that may optimize down to the resource layer 39000. In implementations, caching of AI workloads may involve output caching, feature caching, model state caching, and the like. Output caching may refer to storing outputs previously generated by the AI model. For example, output caching may involve caching previously generated output. Feature caching may refer to input data that has been pre-processed and transformed into a format suitable for model training or inference. Model state caching may refer to caching the state of the model at different points during its operation. Outputs, features, model states, and the like may be stored in a readily accessible storage layer, allowing for quick retrieval of information. In implementations, caching of AI workloads at the network layer 37000 may be enabled by a cache management system.

In embodiments, network layer 37000 may provide a content delivery network (CDN) for enabling the delivery of generative AI content. The integration of generative AI with CDNs can significantly enhance the functionality of CDNs with respect to content optimization, personalization, real-time content generation, and the like. For example, generative AI models may be configured to utilize user preferences, user behavior, and others to generate personalized content in real-time at the edge and/or demographic data, location data, and others to generate targeted content in real-time at the edge. In embodiments, each CDN may be configured as a network of distributed servers that are designed to deliver content. The CDNs may support caching of generative AI content, serving cached content from edge servers closest to users. The CDNs may be configured to perform load balancing during periods of high traffic. In embodiments, the CDNs may restrict access to content based on geographic locations in compliance with state laws and regulations. In some embodiments, the CDNs may use token authentication to control access to content (e.g., validating user's request to access content based on time restrictions, IP address limitations, the number of times content can be accessed, and the like).

In embodiments, content distribution may be significantly enhanced through the use of smart network-capable devices. Smart network-capable devices may include smart sensors, smart products, connected robotics, wearables, programmable logic controllers (PLCs), 3D printers, smart conveyors, smart containers, smart shelving systems, drones, distributed energy resources (DERs), smart machines, smart cooling systems, smart point-of-sale (POS) systems, smart TVs, and smart streaming devices, among many others. In embodiments, the smart network-capable devices can leverage AI functionalities for operations by analyzing user preferences, user behavior, user interactions, historical data, and the like. In embodiments, generative AI models may modify or generate content based on viewing conditions or user feedback. For example, AI can dynamically adjust video quality based on available bandwidth. In embodiments, the smart network-capable devices may use geolocation data to enforce geographic restrictions on activities, and the like.

### AI Model-Driven Gaming Engine Edge System

In embodiments, an AI model integrated with or supporting a gaming engine or other gaming system may be integrated with edge networking capabilities, such as for caching relevant content and/or producing generative AI content relevant to efficient, localized, personalized and/or or customized digital twin, virtual reality, augmented reality, metaverse or similar content experiences. This may include various edge networking device embodiments, such as by integrating the generative AI and gaming capabilities into a network box, router, switch, edge device, IoT system, mesh networking node, networking chip or chipset, networking system on chip (SoC), FPGA, or the like. Collectively these may be referred to herein, for simplified reference, as an AI model-driven gaming engine edge system.

In embodiments, the AI model-driven gaming engine edge system may be integrated with financial infrastructure systems, such as to enable embedded marketplaces and transactions, as described elsewhere in this disclosure and the documents incorporated by reference herein.

In embodiments, the AI model-driven gaming engine edge system may be configured to integrate with data handling systems that are capable of sensor and data fusion, i.e., receiving and processing content that provides an understanding of the context in which the information handled by the AI model-driven gaming engine edge system is used. This may include sensor data that provides information about a set of users (e.g., data detected from wearable devices or physiological data, data from IoT devices or cameras indicating information about the user or the user's environment, or the like); behavioral data about the user (e.g., clickstream data indicating the user's navigation patterns, transactional data, user purchases of content or other items, and other sources); demographic, psychographic and geographic data about populations users (including as determined by various similarity and clustering algorithms) and the like; and/or user-generated content data, including explicit indications of preferences, such as ratings, collaborative filtering and surveys and indirect indications, such as tastes, preferences and styles indicated by user-generated content, such as social media content (e.g., showing a style of dress or preference for a genre of music or content), written content, such as reflecting interests in particular content and/or indicators of user personality, and user interaction content, such as user interactions within interactive game play (e.g., user dialog, navigation and other choices), with digital twins, and/or within virtual reality, augmented reality and/or metaverse environments. In embodiments, data and sensor fusion provide a holistic understanding of user content that can be used to train AI models (either at the edge or in the cloud) to have an accurate understanding of a user's position, duties, status, condition, preferences, personality, or the like. Once trained, the AI models can be deployed in the AI model-driven gaming engine edge system to generate content that is highly tuned to the context and preferences of the user.

In embodiments, the AI model-driven gaming engine edge system may be configured and trained to understand a user profile across different platforms, such as traditional linear media, enterprise platforms, entertainment platforms (e.g., music, film, television, streaming, and the like), and/or interactive platforms (e.g., sports betting, gaming, digital twin, social media, metaverse, virtual reality, augmented reality, and many others). Once the profile is understood, a resulting set of models may be deployed in the AI model-driven gaming engine edge system to provide highly tuned content and experiences to the user across all such channels. Such AI models may include long-term models that provide a general understanding of stable characteristics of the user (e.g., personality, long-term interests, relationships with other users, affinity for subjects, relationships with organizations) and short-term models that provide an understanding of immediate context and interests (e.g., content that is highly relevant to the user's current location).

In embodiments, different forms of content may be cached for efficient delivery to the user at the AI model-driven gaming engine edge system, and they may be presented in a set of integrated content-access interfaces that make different content forms available. As an understanding of an individual user (stable/long-term and/or immediate/contextual) is embedded in a set of AI models as noted above (aided by data and sensor fusion), that understanding can be linked to suites of content of any and all types, which can be gathered and cached by the AI model-driven gaming engine edge system and used to organize suites of content for presentation to the user, either in a unified “home screen” type interface or in forms where links to any one type of content are embedded into the other forms of content. Once content is gathered, it may be used both to configure content offerings and to generate, locally at the AI model-driven gaming engine edge system, generative content, such as text, images, videos, audio, offers, promotions, and many others. The AI model-driven gaming edge system may thus serve as an important enabling component for a broader platform as described herein that links various multiplatform content experiences, models that are trained on a holistic understanding of the user, including based on cross-platform interactions, are deployed at the edge to configure offerings and to generate relevant content for the user.

As implied by the above, the AI model-driven gaming engine edge system may include a set of distinct models, a set of hybrid models, or the like. For example, one AI model (or component) may be used to understand a long-term profile of a user, another AI model may be used to understand a short-term context of a user, another AI model may be used to discover, gather and/or configure a set of content for the user, other models may be used to generate highly personalized or customized generative content (such as involving text, voice, music, images, videos, offers, promotions, or mixed modes of the above), and other models may be used to resolve transactions. In one such configuration, a set of models is used to predict a set of immediate preferences of the user and another set of models is used to generate a configuration of content or other content that is designed to satisfy those preferences.

In embodiments, an instance of an AI model-driven gaming engine edge system may be configured, provisioned and deployed for a single specific user, a defined set of similar users, or a defined specific group of users (such as a family or workgroup). The system may then be trained over time to learn the profile of the user or set, to gather and configure content and other content, and/or to generate highly relevant generative works.

In embodiments, the AI model-driven gaming engine edge may be trained to learn the personality of a user by observation of the user's cross-platform behavior (including various aspects noted in the discussion of sensor and data fusion above). By observing behavior (e.g., by machine vision), transactions, content consumption, interactions, and generated content, as well as by driving interactions that are designed to elicit indicators of personality (such as collaborative filtering, surveys and dialog), the AI model can classify the user according to psychometric or neurometric measures of personality (e.g., a Jungian, Myers-Briggs, or Keirsey Temperament type, other the like). These can be augmented by other indicators, such as social media and writing content by the individual, content preferences, and the like. With an understanding of personality embedded into an AI model, the personality can be used as an input to a content discovery and/or configuration system and/or a generative AI system to produce content that is appealing to the personality.

By integrating these technical features, the network layer 37000 is capable of supporting the complex networking requirements of various operational environments.

### Data Layer

In embodiments, an artificial intelligence-enabled system of systems can have a data layer system of systems, a set of machine learning systems, a set of artificial intelligence systems, and/or a set of neural networks configured to operate on fused data that can be the output of a sensor and/or data fusion system.

In embodiments, the data layer system of systems having a set of machine learning systems, a set of artificial intelligence systems, and/or a set of neural networks can be configured to operate on fused data that can include sensor data.

In embodiments, the data layer system of systems having a set of machine learning systems, a set of artificial intelligence systems, and/or a set of neural networks can be configured to operate on fused data that can include wearable device data.

In embodiments, the data layer system of systems having a set of machine learning systems, a set of artificial intelligence systems, and/or a set of neural networks can be configured to operate on fused data that can include social media data.

In embodiments, the data layer system of systems having a set of machine learning systems, a set of artificial intelligence systems, and/or a set of neural networks can be configured to operate on fused data that can include crowdsourced data.

In embodiments, the data layer system of systems having a set of machine learning systems, a set of artificial intelligence systems, and/or a set of neural networks can be configured to operate on fused data that can include website data.

In embodiments, the data layer system of systems having a set of machine learning systems, a set of artificial intelligence systems, and/or a set of neural networks can be configured to operate on fused data that can include distributed data.

In embodiments, the data layer system of systems having a set of machine learning systems, a set of artificial intelligence systems, and/or a set of neural networks can be configured to operate on fused data that can include API data.

In embodiments, the data layer system of systems having a set of machine learning systems, a set of artificial intelligence systems, and/or a set of neural networks can be configured to operate on fused data that can include edge data.

In embodiments, the data layer system of systems having a set of machine learning systems, a set of artificial intelligence systems, and/or a set of neural networks can be configured to operate on fused data that can include mobile data collector data.

In embodiments, the data layer system of systems having a set of machine learning systems, a set of artificial intelligence systems, and/or a set of neural networks can be configured to operate on fused data that can include industrial data.

In embodiments, the data layer system of systems having a set of machine learning systems, a set of artificial intelligence systems, and/or a set of neural networks can be configured to operate on fused data that can include transactional data.

In embodiments, the data layer system of systems having a set of machine learning systems, a set of artificial intelligence systems, and/or a set of neural networks can be configured to operate on fused data that can include transportation data.

In embodiments, the data layer system of systems having a set of machine learning systems, a set of artificial intelligence systems, and/or a set of neural networks can be configured to operate on fused data that can include value chain network data.

In embodiments, the data layer system of systems having a set of machine learning systems, a set of artificial intelligence systems, and/or a set of neural networks can be configured to operate on fused data that can include supply chain data.

In embodiments, the data layer system of systems having a set of machine learning systems, a set of artificial intelligence systems, and/or a set of neural networks can be configured to operate on fused data that can include demand data.

In embodiments, the data layer system of systems having a set of machine learning systems, a set of artificial intelligence systems, and/or a set of neural networks can be configured to operate on fused data that can include shipping data.

In embodiments, the data layer system of systems having a set of machine learning systems, a set of artificial intelligence systems, and/or a set of neural networks can be configured to operate on fused data that can include energy data.

In embodiments, the data layer system of systems having a set of machine learning systems, a set of artificial intelligence systems, and/or a set of neural networks can be configured to operate on fused data that can include enterprise data.

In embodiments, the data layer system of systems having a set of machine learning systems, a set of artificial intelligence systems, and/or a set of neural networks can be configured to operate on fused data that can include public data.

In embodiments, the data layer system of systems having a set of machine learning systems, a set of artificial intelligence systems, and/or a set of neural networks can be configured to operate on fused data that can include market data.

In embodiments, the data layer system of systems having a set of machine learning systems, a set of artificial intelligence systems, and/or a set of neural networks can be configured to operate on fused data that can include news data.

In embodiments, the data layer system of systems having a set of machine learning systems, a set of artificial intelligence systems, and/or a set of neural networks can be configured to operate on fused data that can include weather data.

In embodiments, the data layer system of systems having a set of machine learning systems, a set of artificial intelligence systems, and/or a set of neural networks can be configured to operate on fused data that can include contextual data.

In embodiments, the data layer system of systems having a set of machine learning systems, a set of artificial intelligence systems, and/or a set of neural networks can be configured to operate on fused data that can include health data.

In embodiments, the data layer system of systems having a set of machine learning systems, a set of artificial intelligence systems, and/or a set of neural networks can be configured to operate on fused data that can include demographic data.

In embodiments, the data layer system of systems having a set of machine learning systems, a set of artificial intelligence systems, and/or a set of neural networks can be configured to operate on fused data that can include insurance data.

In embodiments, the data layer system of systems having a set of machine learning systems, a set of artificial intelligence systems, and/or a set of neural networks can be configured to operate on fused data that can include simulation data.

In embodiments, the data layer system of systems having a set of machine learning systems, a set of artificial intelligence systems, and/or a set of neural networks can be configured to operate on fused data that can include experimental data.

In embodiments, the data layer system of systems having a set of machine learning systems, a set of artificial intelligence systems, and/or a set of neural networks can be configured to operate on fused data that can include synthetic data.

In embodiments, the data layer system of systems having a set of machine learning systems, a set of artificial intelligence systems, and/or a set of neural networks can be configured to operate on fused data that can include echoed data.

In embodiments, the data layer system of systems having a set of machine learning systems, a set of artificial intelligence systems, and/or a set of neural networks can be configured to operate on fused data that can include communication data.

In embodiments, the data layer system of systems having a set of machine learning systems, a set of artificial intelligence systems, and/or a set of neural networks can be configured to operate on fused data that can include behavioral data.

In embodiments, the data layer system of systems having a set of machine learning systems, a set of artificial intelligence systems, and/or a set of neural networks can be configured to operate on fused data that can include location data.

In embodiments, the data layer system of systems having a set of machine learning systems, a set of artificial intelligence systems, and/or a set of neural networks can be configured to operate on fused data that can include pricing data.

In embodiments, the data layer system of systems having a set of machine learning systems, a set of artificial intelligence systems, and/or a set of neural networks can be configured to operate on fused data that can include sales data.

In embodiments, the data layer system of systems having a set of machine learning systems, a set of artificial intelligence systems, and/or a set of neural networks can be configured to operate on fused data that can include tax data.

In embodiments, the data layer system of systems having a set of machine learning systems, a set of artificial intelligence systems, and/or a set of neural networks can be configured to operate on fused data that can include historical data.

In embodiments, the data layer system of systems having a set of machine learning systems, a set of artificial intelligence systems, and/or a set of neural networks can be configured to operate on fused data that can include physiological data.

In embodiments, the data layer system of systems having a set of machine learning systems, a set of artificial intelligence systems, and/or a set of neural networks can be configured to operate on fused data that can include environmental data.

In embodiments, the data layer system of systems having a set of machine learning systems, a set of artificial intelligence systems, and/or a set of neural networks can be configured to operate on fused data that can include key performance indicator (KPI) data.

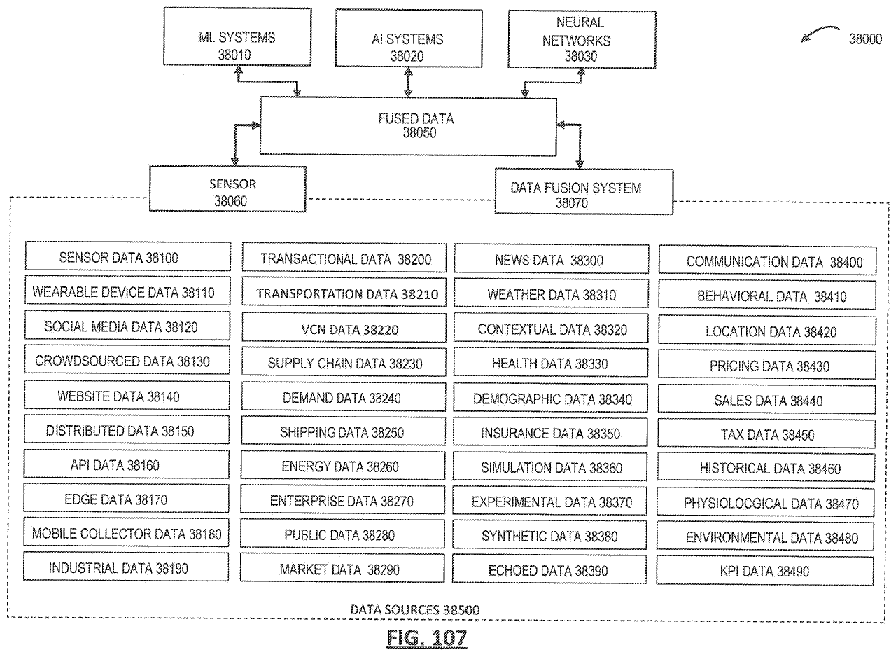

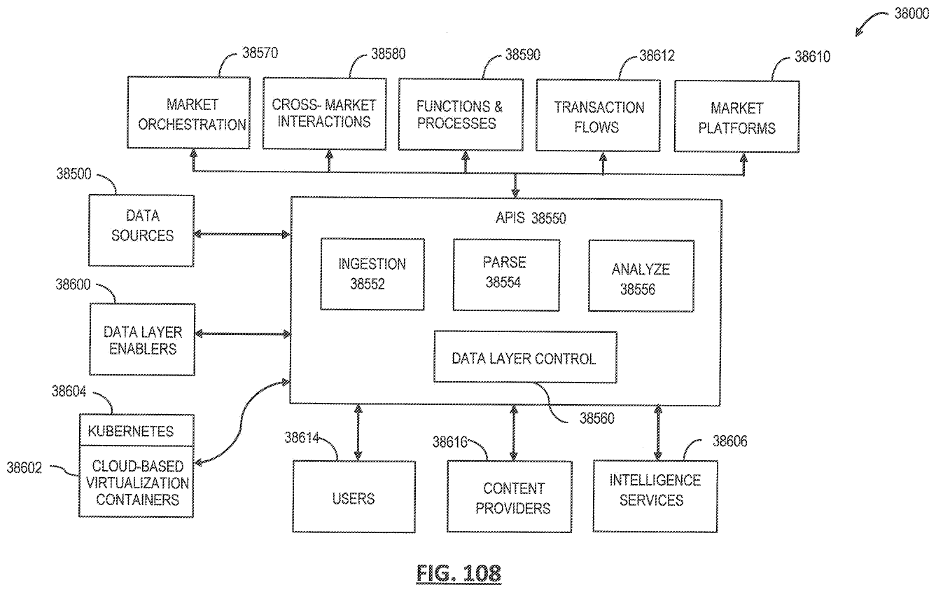

In embodiments, an artificial intelligence-enabled system of systems 31000 can have a data layer system of systems 38000. With continuing reference to FIG. 107, the data layer system of systems 38000 can incorporate data modules 38002. The data layer system of systems 38000 can cooperate with a set of machine learning systems 38010, a set of artificial intelligence systems 38020, and/or a set of neural networks 38030 configured to operate on fused data 38050. By way of these examples, the fused data 38050 can be formed from the output of a sensor 38060 and/or a data fusion system 38070 each of which can be associated with one or more data sources 38500. The one or more data sources 38500 can include sensor data 38100, wearable device data 38110, social media data 38120, crowdsourced data 38130, website data 38140, and distributed data 38150. The one or more data sources 38500 can also include API data 38160 that can be accessed through various APIs at 38550 in FIG. 108. With continuing reference to 107, the one or more data sources 38500 can also include edge data 38170, mobile data collector data 38180, and industrial data 38190. In further examples, one or more data sources 38500 can include transactional data 38200 in a financial infrastructure environment. In additional examples, one or more data sources 38500 can include transportation data 38210, which can be used to support transportation systems, self-driving vehicles, software-defined vehicles, and software-enabled vehicles. In yet more examples, one or more data sources 38500 can include value chain network data 38220, supply chain data 38230, demand data 38240, and/or shipping data 38250, which can be used to further the understanding of entity demand and supply management. In additional examples, one or more data sources 38500 can include energy data 38260, which can be used to further facilitate energy delivery, compute power, and data management at various edge applications. In further examples, one or more data sources 38500 can include enterprise data 38270, public data 38280, market data 38290, news data 38300, and weather data 38310. In additional examples, one or more data sources 38500 can include contextual data 38320 in various settings. In yet further examples, one or more data sources 38500 can include health data 38330 in support of various digital health and healthcare platforms. In additional examples, one or more data sources 38500 can include demographic data 38340, insurance data 38350, simulation data 38360, experimental data 38370, synthetic data 38380, echoed data 38390, communication data 38400, behavioral data 38410, location data 38420, pricing data 38430, sales data 38440, tax data 38450, historical data 38460, physiological data 38470, environmental data 38480, and key performance indicator data 38490.

FIG. 108 depicts additional exemplary features, capabilities, and interfaces of exemplary embodiments of a data layer system of systems 38000. In embodiments, the API data 38160 can be accessed by multiple APIs at 38550. By way of these examples, the APIs at 38550 can include one each of an ingestion 38552, parse 38554, analyze 38556, and elements that can be interconnected for providing intelligence-based and other derivatives of data sources, such as the multitude of data sources 38500. These elements may be controlled, configured and adjusted by a data layer control 38560.

In embodiments, data sources may be retrieved and/or received through the APIs 38550. In embodiments, the APIs may be an open/standardized APIs that, among other things, may equip the data layer system of systems 38000 for integration with and into current and emerging ecosystems. By way of these examples, APIs can further enable data layers to integrate into a wide range of data workflows and access the API data 38160 and various data sources 38500, such as corporate internal workflows, metadata for visual content, source data, inter-jurisdiction data workflows, digital rights management and the like.

In embodiments, the data layer system of systems 38000 can include, reference, and/or provide market orchestration elements 38570 that may facilitate use of data layer capabilities for various aspects of market orchestration, including, without limitations, software orchestrated transactions, software orchestrated marketplaces, and the like. Market orchestration elements 38570 may facilitate deployment of a data layer, such as a web service embodiment, as an integrated function of a market orchestration platform, such as an automated market orchestration system of systems as described herein. In embodiments, the data layer system of systems 38000 may provide data and network pipeline capabilities for market orchestration.

The data layer system of systems 38000 can include, reference and/or provide cross-market interaction capabilities 38580 that may enable leveraging various types of intelligence data layer, computation capabilities, and storage and data sourcing capabilities, as well as intelligence capabilities for cross-market interactions. Cross-market interaction capabilities 38580 may include interfaces to one or more marketplaces, transaction environments, and the like, so that, among other things, a data layer supportive of a system of systems (SoSs) may be configured with one market in a cross-market integration deployment as a source of data and with another market in the cross-market integration deployment as a consumer of the data layer. In embodiments, a similar arrangement may be constructed between two or more markets so that data in either market can be used as one or more data sources and can be influenced by data from another market. By way of these examples, cross-market interactions 38580 may be accomplished through one or more market-to-market data layers that form data pipelines for intelligent exchange of data among markets, such as data about buyers in one market and about sellers in another.

The data layer system of systems 38000 can include functions and processes 38590, for an exemplary market-oriented deployment may include software-oriented transaction functions and processes, automatic transaction transactions and processes, and the like. Functions and processes 38590 for the data layer system of systems 38000 may include signaling availability of data (e.g., emergence of an occurrence of source data) that impacts data produced by the data layer of the platform. Other exemplary functions and processes 38590 may include embedding into smart contracts, tokens, or other occurrence (e.g., an initiation of a smart contract and the like). Yet other functions and processes may include payments between/among machines and the like.

In embodiments, the data layer system of systems 38000 may include and/or be associated with data layer technology enablers 38600, such as 5G networking, artificial intelligence, visualization technology (e.g., VR/AR/XR), distributed ledger, and the like.

In embodiments, the data layer system of systems 38000 can include and/or leverage cloud-based virtualized containerization capabilities and services 38602, such as without limitation a container deployment and operation controller, such as Kubernetes 38604 and the like. Cloud-based virtualized containers 38602 provide for data layers to be deployed close to source data, thereby potentially reducing network bandwidth consumption or the potential for network disturbances in a data workflow, especially when addressing voluminous local situations such as in industrial and commercial environments.

In embodiments, technologies may be provided by and/or enabled by the data layer system of systems 38000 include intelligence services 38606, such as artificial intelligence, machine learning and the like. These intelligence services 38606 may be provided by the data layer SoSs 38000, or accessed (e.g., as third-party services) via one or more. The data layer control 38560 may be provided access to the intelligence services 38606. In embodiments, the data layer control 38560 may provide its own set of intelligence services.

In embodiments, the data layer system of systems 38000 may include transaction/market-oriented capabilities, and services that may include market platforms 38610, transaction flows 38612, users 38614, and content providers 38616. For multi-party transaction environments, the data layer SoSs 38000 may be configured and operated to satisfy a range of consumer needs for market analysis, transaction efficiencies, cost containment, buy/sell decisions and the like.

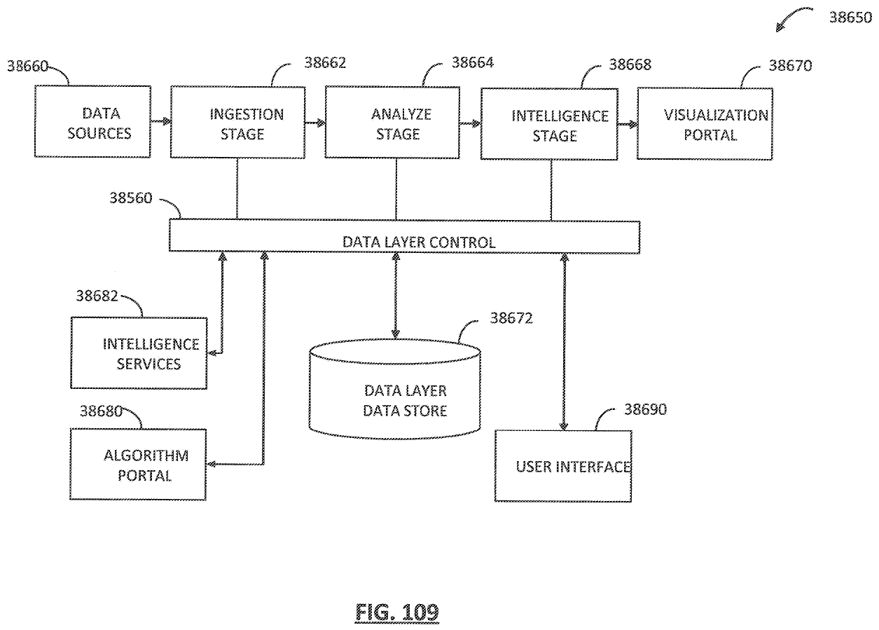

In embodiments, the data layer system of systems 38000 may include an exemplary intelligent data layer architecture 38650, as depicted in FIG. 109. The exemplary intelligent data layer architecture 38650 can include a controlled pipeline of data processing stages that process data from one of multiple data sources 38660. The controlled pipeline includes an ingestion stage 38662, an analysis stage 38664, a derived intelligence stage 38668, and a consumer visualization portal 38670. By way of these examples, the ingestion stage 38662 can receive and/or harvest data from one or more of the plurality of sources 38660. Processing at the ingestion stage 38662 may include parsing content of data sources, such as to determine structure, content, relationships among data elements, intended meaning of the data elements, relationships between data, structure, and meaning, and the like. In embodiments, an ingestion facility that may operate at the ingestion stage 38662 may be configured to be aware of data source aspects, such as structure, etc. Ingestion stage 38662 may be configured or adjusted by an operator of the layer, a platform controller, the data layer control 38560, and the like. Configuration of the ingestion stage 38662 may be based on one or more data structures that represent aspects of one or more of the data sources 38660. One such aspect is a location of the data source, such as an Internet or other type of address (e.g., URL, port number, stream identifier, publication and/or broad channel, sensor output location, and the like) from which data may be accessed, queried, pulled, downloaded, streamed or otherwise accessed. Further aspects of a data source may include interface methods and/or protocols, such as through data transfer handshakes, Internet Protocols, and/or query languages. Data block size, access rate (e.g., maximum, frequency, or other timing-related parameter related to accessing the data source), and the like may also be adjusted or configured. Yet other aspects of data source 38660 and the data layer architecture 38650 may include one or more meanings of data from the data source, such as may be represented through a data source ontology and the like. Information such as units, scalars and the like for numerical values may be provided. In an example of data sources providing measurement data, a first source may provide numerical values in inches, a second source may provide values in meters, and a third source may provide values in light years. This local data source context may prove useful for relating data sources. In an example of data sources providing reputation rating values, an ontology for each source that establishes a minimum value, maximum value, and adjustable increments between the two provide a way of establishing meaning of a data element from such a source.

In further examples, the data sources may impose or be arranged with a geometry/structure that may imbue meaning on data values, relationships among data values, and the like. Exemplary embodiments of structures that can impact the meaning and relationships of data value from a data source can be a hierarchical arrangement of the data.

In embodiments, the data layer system of systems 38000 can be configured to receive/retrieve and process data that is configured as a hierarchy and can be configured to assign a relationship attribute to a pair of data values that are configured as parent/child in the hierarchy. Likewise, a rule that may be applied in the hierarchy, such as certain types of changes to a parent data value impacting a corresponding child data value establish an immutable relationship between the data values as they are processed through the ingestion processing pipeline (e.g., ingestion, analysis, and intelligence).

In embodiments, automation can be introduced through programmatic configuration of data values in an ingestion stage execution data structure. These data values may be retrieved from, for example, an ingestion parameter portion of a data layer control data store 38672. Machine learning may facilitate training an artificial intelligence system to identify aspects of a data source that are relevant for configuring the ingestion stage 38662 to receive and process its data.

In embodiments, the data layer control 38560 may develop an understanding of data sources, such as meaning of data values. In embodiments, developing an understanding may be in context of an expected use of data from one or more data sources, such as use of the data for determining a status of a term of a smart contract, a result of a software orchestrated transaction, and the like. Further data from data sources may be understood within a context of other data sources. In an example of such understanding, a plurality of marketplace monitors may capture data regarding activity within a marketplace.

In embodiments, the data layer control 38560 may further be configured to maintain a schedule of collection activity for one or more of the data sources 38560. A collection schedule may be one of a plurality of aspects associated with ingestion that may be influenced by data sources and by data layer pipeline processing needs (e.g., to satisfy needs of a user of the data layer). Such a collection schedule may be based on a rate or occurrence of availability of new or revised data from a source. In embodiments, some data sources may produce new/updated data on a schedule determined from activities associated with the data source, such as a sample schedule of the sensor 38060, the data fusion 38062, and the like. In an example, a rule for a system that produces data available through a data source may limit data releases periodically (e.g., such as at the end of a work shift, once per day, and the like). In another example of data source-dependent collection activity may be motivated by events, such as completion of marketplace transactions and the like. In embodiments, the data layer control 38560 may monitor a port on a data network for an indication of data availability at a data source. When an indication is detected (e.g., a change in a data value of the port), an ingestion process may commence.

By way of these examples, other information of processes related to ingestion may include costs, such as costs to perform data source access, ingestion processing and the like. Cost for data collection may include access fees charged by a data source (e.g., subscription costs, access event costs, demand-based costs, and the like). Costs for data collection may be based at least in part on an amount that a consumer (e.g., a user of capabilities and output from a data layer) pays for access to information produced by the data layer that is based at least in part on data from the data source. By way of these examples, there may be a range of cost structures for source data access, at least some of which may be based on data source reputation, relevance of data from the data source, timeliness of updates of the data from the data source, and the like. In embodiments, a data layer may access data from a data source and utilize it a plurality of times to produce layer intelligence for a plurality of users of the data layer. Costs for access and for the occurrences of use of the accessed data may be different from each other, such as a cost to access may be a multiple of (e.g., 2-time, 10-times and the like) of a cost for each subsequent occurrence of use of the accessed data.

In embodiments, the data layer system of systems 38000 may be configured as a producer of source data, so that a corresponding ingestion facility may be owned (and optionally operated) by the data producer. In an example of data source closely held within the data layer system of systems 38000, a data source may retain privacy of its source data by exposing, such as through publication and the like, an output of the owned data, which may include information derived from the source data or select portions of the source data, such as non-confidential information associated with marketplace transactions and the like.

In embodiments, further operation of the data layer architecture 38650 can include ingestion operation that may also be based on a method of data collection. In embodiments, the data sources 38660 may be part of a data supply chain. Exemplary embodiments of a data supply chain may include a physical chain, such as may be embodied by a set of physical sensors (e.g., industrial internet of things sensors) that capture physical activity (e.g., of an industrial machine, and the like) and provide a representation of that activity as a form of data. A physical connection, such as a set of networked devices (e.g., the Internet), may convey the representation of the activity produced by the sensor(s) to, for example, a physical access port (e.g., a networked computer and the like) from which a data layer may ingest this data. Other types of data collection may include logical supply chains, such as data marts, data marketplaces, aggregated data publishers, and the like. In embodiments, data representative of a physical activity, such as a production machine in an enterprise, may be provided through a physical interface that presents the data from a corresponding sensor as it changes in near real time. That same data may be provided through a logical interface, such as a data base that facilitates access to a plurality of values of data from the sensor, optionally with a capture time, capture sequence and the like to enable batched or delayed use of data from the data source.

In embodiments, the data layer control 38560 may execute in virtual containers on, for example, cloud computing systems that are distinct from a physical embodiment of the data layer control 38560.

In embodiments, the data layer architecture 38650 may include the analyze stage 38664 that may receive data from the ingestion stage 38662. The analyze stage 38664 may receive raw ingestion data, adapted ingestion data (e.g., contextually adjusted), data derived from ingestion data (e.g., differences between sequential accesses of a single data source), metadata associated with the ingestion data (e.g., validity window, units, access costs, and the like), and the like.

In embodiments, the analyze stage 38664 may perform various operations on ingestion stage parsing and other ingestion activity results based on a range of factors, such as comparing data from a plurality of sources for similarity, fitness to a purpose, differences, based on types of data within or across data sources and the like. In embodiments, analysis may include comparing sources against a target use of intelligence derived from a data source. Analysis of ingestion results may attempt to determine if one or more data elements from a data source may meet consumption target requirements, such as meeting a validity time constraint, an accuracy constraint, a frequency of update constraint, relevance to a consumption subject matter focus, and the like. In embodiments, a data layer may target providing intelligence for buyers of services in a software orchestrated transaction marketplace. The data layer architecture 38650 may include functionality to publish or otherwise convey requests for data, such as types of data, and the like that one or more data sources may attempt to meet. The data layer control 38560 may determine if ingested data meets requirements of the published request for data, such as if the data complies with one or more parameters in the request.

In embodiments, the data layer control 38560 may facilitate configuring data in the layer for publication, such as configuring one or more advertisements that characterize the ingested data in terms of potential intelligence value, relevance and the like. Examples include making data, such as derived intelligence data available on a marketplace (e.g., configuring indexing schemes and the like), making the content searchable (e.g., identifying keywords, terms, values, or the like that may facilitate discovery of intelligence derived from the ingested data through use of a search capability. The data layer control 38560 may facilitate access visibility to information of the data layer by publishing, communicating, or broadcasting samples of the data over a network, directly to potential consumers and the like.

In embodiments, the analyze stage 38664 may suggest, predict, and/or estimate value of data for a plurality of different consumers. These estimates may be used by the data layer control to impact intelligent data layer functions, such as data layer intelligence pricing and the like that may be differentiated for different users. Further, such analysis may indicate that intelligence derived from a first data source may be more or less valuable to different target consumers.

In embodiments, the data layer control 38560 may use feedback from intelligent data layer users regarding, among other things, usefulness of intelligence derived from one or more data sources 38660 to facilitate ingestion and analysis activities and the like. In an example, positive feedback on intelligence derived from a data source may result in the data layer control 38560 to make use of the data source for deriving other types of intelligence and the like.

In embodiments, the data layer control 38560 may ingest data from a plurality of data sources; each such set of data may be individually analyzed. In embodiments, data from a plurality of data sources may be parsed, so that data with similar characteristics (e.g., data that is indicative of a buyer reputation) may be aggregated and analyzed. Examples of multiple data sources that may provide data with similar characteristics include mobile devices, types of sensors, media-focused transaction systems (e.g., content buying, advertising placement, rights management and the like). As noted above, the data layer control 38560 may communicate configuration data (e.g., sets of data that enable the analyze stage 38664 to perform various analysis functions). In embodiments, the data layer control 38560 may provide a set of analysis algorithms that may execute on one or more processors.

In embodiments, the data layer architecture 38650 may include the intelligence stage 38668. By way of many examples, an intelligence stage 38668 may utilize artificial intelligence capabilities to develop an understanding about data sources including, among things, uses of data, values of data, applicability of data, collection patterns and relevance to intelligence consumption and the like. Additional intelligence that may be derived by intelligence stage may include, without limitation, layer specific data relevance, relevance of data from one layer to another, value of intelligence to a consumer, such as to a transactor. By way of many examples, intelligence stage may derive intelligence useful for forming new marketplaces from transactional data gathered from an existing marketplace.

In embodiments, the data layer architecture 38650 may include a consumer visualization portal 38670 that may communicate with elements of the data layer pipeline, such as the intelligence stage 38668 from which the consumer visualization portal may receive derived intelligence. In embodiments, the consumer visualization portal 38670 may facilitate access to derived intelligence (and optionally to other data of the data layer architecture 38650). The consumer visualization portal may announce availability of derived intelligence to a preconfigured set of consumers and candidate consumers through use of a messaging channel (e.g., SMS messaging and the like). The consumer visualization portal may announce derived intelligence through various other techniques including, broadcasting across one or more communication channels (e.g., TWITTER™, X™, and the like). The consumer visualization portal may deliver at least select derived intelligence to intelligent data layer consumers based on a subscription or similar arrangement between the consumer(s) and the data layer. In embodiments, the consumer visualization portal may reference publication configuration data that may identify which consumers are to receive which portion(s) of intelligence derived from which data source and cause the derived intelligence to be provided to (and/or made available to) one or more consumers based on this intelligence publication data. The consumer visualization portal may also communicate with the data layer control 38560, such as to receive configuration, access intelligence data, analyzed data, ingested data and the like.

In embodiments, the consumer visualization portal 38670 may further receive from one or more data layer data consumers, consumer preferences for interfacing with the consumer, requests for updates to previously communicated derived intelligence data, requests for onboarding, feedback on uses of derived intelligence data and the like. In embodiments, a consumer may communicate a derived intelligence delivery schedule to the consumer visualization portal where it may be combined with other intelligence delivery data, such as other consumer delivery schedules, and the like and utilized by the consumer visualization portal and/or the data layer control when performing derived intelligence delivery and communication functions.

In embodiments, the data layer control 38560 may provide configuration, control, storage, and processing capabilities, such as for providing access to algorithms from an algorithm portal 38680, facilitating access by the data layer control 38560 to intelligence services 38682, managing storage of a data store, managing storage of intelligent data layer ingestion data and outcomes, analysis outcomes, derived intelligence and the like in a data store 38672, and without limitation providing a mechanism by which a user, such as an owner and/or operator of the data layer architecture 38650 can configure and otherwise interface with system of the data layer system of systems 38000.

In another exemplary embodiment, the data layer control 38560 may facilitate access to analysis algorithms by the analyze stage 38664. Further the data layer control 38560 may work cooperatively with an algorithm portal 38680 to receive algorithms for analysis, ingestion, deriving intelligence, and the like. By way of many examples, the data layer control 38560 and the data source 38500 may identify and/or provide one or more ingestion algorithms for performing ingestion actions on data provided. The algorithm may be provided through the algorithm portal 38680 received and optionally vetted by the data layer control 38560 and stored in the data store 38672. In another exemplary embodiment of use of the algorithm portal 38680, a consumer may provide an algorithm for deriving intelligence from data under the consumer's control, such as in a marketplace transaction environment in which a seller provides transaction data as a source of data to the data layer for processing, optionally with other relevant data, for deriving intelligence associated with seller marketplace activities. In embodiments, deployment of a data layer as part of a data workflow for an enterprise may involve adapting existing workflow steps with intelligent data layer capabilities. By way of many examples, a purchasing department of an enterprise may have a set of algorithms that are used to process sales forecast data for generating purchasing guidelines. A data layer may be constructed for the enterprise that produces intelligence regarding the generated purchasing guidelines by utilizing sales forecast processing algorithms that have been uploaded through, for example, the algorithm portal 38680.

In embodiments, the intelligence services 38682 may include a range of intelligence functions and capabilities including, without limitation artificial intelligence functions, machine learning functions, neural network functions, prediction capabilities, and many others. In an example of intelligence services 38682 for the data layer system of systems 38000, an ingestion stage 38662 may provide data from the data sources 38660, along with associated descriptive information (e.g., metadata, structural data, ontology data and the like) to a self-learning neural network capability of the intelligence services 38682 to aid in determining an approach to parsing the data source.

In embodiments, the intelligence services 38682 may further have access to subject matter associated intelligence, such as cross-market intelligence gathered through processing, optionally external to the data layer architecture 38650, marketplace configuration, operational, and transaction outcomes for different sets of cross-market offerings. By way of further examples using intelligence services for ingestion, this subject matter intelligence can be applied when a data source is determined to be related to a product or other offering that is similar to products or offerings on which the subject matter intelligence is based. In such instances when a source of data relates to a product (e.g., mobile device) and subject matter intelligence known to the intelligence services 38682 is based on or associated with mobile device technology, the corresponding intelligence services may be utilized for enhancing/optimizing pipeline operations being performed on the source data.

In embodiments, the exemplary data layer architecture 38650 can include a user interface 38690 through which a user, such as an operator and the like, may interface with systems of the data layer and the like (e.g., query and maintain data in the data layer data store 38672). The user interface 38690 may facilitate configuring portions of the data layer, such as the algorithm portal, data retention rules for accessed by the data layer control 38560, prioritization of use of the data layer resources by data consumers, and the like.

The data layer system of systems 38000 may serve as a flexible and scalable infrastructure designed to enable the seamless integration, ingestion, and analysis of data from an extensive range of sources positioned within the artificial intelligence convergence system of systems 31000. The data layer system of systems 38000 can be positioned within the multi-layered architectures artificial intelligence convergence system of systems 31000 and can support the generation of actionable intelligence and foster integration across diverse ecosystems. The data layer system of systems 38000 supports a modular design to support corporate operations, market orchestration, and cross-functional workflows, as these systems of systems become important for organizations navigating both established and emerging technologies.

### Sensor Data 38100

Sensor data may include real-time readings from devices monitoring environmental, industrial, or physical conditions. These sensors can provide valuable inputs for applications such as manufacturing quality control, environmental monitoring, and smart city management. For example, in an industrial setting, sensors might monitor machinery vibrations to predict maintenance needs. In environmental monitoring, air quality sensors may track pollution levels, enabling responsive public health measures. The data layer system of systems may process such high-frequency inputs, ensuring timely integration into decision-making frameworks.

### Wearable Device Data 38110

Wearable devices may generate diverse datasets ranging from health metrics, such as heart rate and activity levels, to geolocation tracking. These devices often serve applications in healthcare, fitness, and workforce management. A healthcare provider, for instance, might leverage wearable data to monitor chronic conditions and deliver personalized care plans. The data layer system of systems can analyze this data in real-time, identifying trends and generating predictive insights to improve health outcomes.

### Social Media Data 38120

Social media platforms may produce vast volumes of unstructured and structured data, including text, images, and videos. Businesses can use this data to gauge public sentiment, analyze trends, and optimize marketing strategies. For instance, a retail brand might monitor customer feedback on social platforms to refine its offerings. The data layer system of systems may enable sentiment analysis and predictive modeling to help businesses adapt to market demands effectively.

### Crowdsourced Data 38130

Crowdsourced data may encompass information contributed by a distributed network of individuals, such as reviews, surveys, and collaborative maps. This data can be crucial for applications requiring diverse perspectives, such as urban planning or product development. For example, transportation authorities might use crowdsourced traffic reports to optimize routes and reduce congestion. The data layer system of systems can aggregate and contextualize such data to provide actionable insights.

### Website Data 38140

Website data may include user interactions, clickstreams, and behavioral patterns. This data is invaluable for e-commerce, digital marketing, and user experience optimization. For instance, an online retailer might analyze browsing habits to recommend products, enhancing customer satisfaction and sales. The data layer system of systems can process large volumes of web traffic data, while its intelligence services may identify patterns to improve user engagement.

### Distributed Data 38150

Distributed data may refer to datasets stored across multiple locations, such as cloud services or decentralized networks. This type of data is essential for global enterprises and blockchain applications. For example, a supply chain management system might rely on distributed data to track goods across international borders. The data layer system of systems may harmonize distributed datasets, ensuring consistency and enabling comprehensive analysis.

### API Data 38160

API data may provide programmatic access to external systems, enabling the integration of third-party services and real-time data retrieval. Applications may include weather forecasting, financial market analysis, and social media monitoring. For example, a fintech platform might use API data to retrieve real-time stock prices and integrate them into portfolio management tools. The data layer system of systems may seamlessly ingest and process API data, supporting dynamic and responsive applications.

### Edge Data 38170

Edge data may originate from devices operating at the periphery of a network, such as IoT devices in remote locations. This data is often used in scenarios requiring low-latency processing, such as autonomous vehicles or industrial automation. For instance, edge devices in a factory might monitor production line conditions and trigger immediate adjustments. The data layer system of systems may process edge data locally or in the cloud, enabling rapid responses and enhanced operational efficiency.

### Mobile Data Collector Data 38180

Mobile data collectors may gather information from field operations, such as surveys, inspections, or environmental sampling. This data is vital for industries like agriculture, construction, and utilities. For example, agricultural researchers might use mobile devices to record soil conditions and crop health. The data layer system of systems may aggregate and analyze this data, providing actionable insights for field operations.

### Industrial Data 38190

Industrial data may encompass metrics from manufacturing processes, such as temperature, pressure, and production rates. This data is critical for optimizing operations, ensuring quality, and predicting maintenance needs. For instance, a factory might use the data layer system of systems to monitor and analyze machine performance, reducing downtime and improving efficiency.

### Transactional Data 38200

Transactional data may include records of financial or operational exchanges, such as purchases, sales, or payments. This data is foundational for industries like retail, finance, and logistics. A retail chain might use the data layer system of systems to analyze point-of-sale transactions, identifying trends and informing inventory strategies.

### Transportation Data 38210

Transportation data may include vehicle telemetry, traffic patterns, and logistics tracking. This data is essential for optimizing supply chains and improving urban mobility. For example, a logistics provider might analyze transportation data to reduce delivery times and fuel consumption. The data layer system of systems may process this data in real-time, enhancing decision-making capabilities.

### Value Chain Network Data 38220

Value chain network data may map relationships and dependencies across suppliers, manufacturers, and distributors. This data can support strategic planning and risk management. For instance, a manufacturer might use the data layer system of systems to visualize its supply chain and identify bottlenecks, improving overall efficiency.

### Supply Chain Data 38230

Supply chain data may track the movement of goods, inventory levels, and supplier performance. This data is critical for ensuring timely deliveries and managing costs. A retailer might use the data layer system of systems to monitor supply chain performance and predict potential disruptions, enabling proactive measures.

### Demand Data 38240

Demand data may capture customer preferences, market trends, and purchasing patterns. This data is vital for forecasting and aligning production with market needs. A consumer goods company might use the data layer system of systems to analyze demand data, optimizing product availability and marketing strategies.

### Shipping Data 38250

Shipping data may include information about freight movements, carrier performance, and delivery timelines. This data is crucial for logistics and e-commerce. For instance, an online retailer might use the data layer system of systems to track shipments and provide real-time updates to customers.

### Energy Data 38260

Energy data may capture metrics from utilities, such as consumption rates, production levels, and grid performance. This data supports sustainability initiatives and operational efficiency. A smart grid operator might use the data layer system of systems to balance supply and demand, reducing energy waste.

### Enterprise Data 38270

Enterprise data may encompass internal records, such as HR files, financial statements, and operational metrics. This data is essential for decision-making and regulatory compliance. A corporation might use the data layer system of systems to integrate and analyze enterprise data, supporting strategic planning.

### Public Data 38280

Public data may include datasets from government agencies, NGOs, and other public entities. This data can inform policy-making, research, and community initiatives. For example, a city planner might use the data layer system of systems to analyze public transportation data, improving service delivery.

### Market Data 38290

Market data may capture financial metrics, stock prices, and commodity trends. This data is crucial for investment and trading strategies. A hedge fund might use the data layer system of systems to analyze market data, identifying opportunities and mitigating risks.

### News Data 38300

News data may include headlines, articles, and broadcasts. This data can inform sentiment analysis, trend detection, and crisis management. A public relations firm might use the data layer system of systems to monitor news coverage, shaping communication strategies.

### Weather Data 38310

Weather data may include forecasts, historical records, and real-time observations. This data supports agriculture, logistics, and disaster response. A logistics company might use the data layer system of systems to optimize routes based on weather conditions.

### Contextual Data 38320

Contextual data may provide situational awareness by integrating multiple data sources. This data supports decision-making in dynamic environments. A retailer might use the data layer system of systems to combine sales data with demographic insights, tailoring marketing efforts.

### Health Data 38330

Health data may include patient records, diagnostic results, and public health statistics. This data supports personalized medicine and population health management. A healthcare provider might use the data layer system of systems to analyze health data, improving care delivery.

### Demographic Data 38340

Demographic data may capture information about populations, such as age, income, and education levels. This data informs marketing, policy-making, and resource allocation. A non-profit organization might use the data layer system of systems to target programs effectively.

### Insurance Data 38350

Insurance data may include claims, risk assessments, and policy details. This data supports underwriting, fraud detection, and customer service. An insurance company might use the data layer system of systems to analyze claims data, reducing losses and improving customer satisfaction.

### Simulation Data 38360

Simulation data may model hypothetical scenarios, such as financial projections or disaster response plans. For example, an organization planning for disasters from weather can continue its preparations by using simulation data processed through the data layer system of systems 38000. This data can allow the modeling of potential impacts and the development of optimized response strategies. A financial institution may also employ simulation data to project future market trends or assess the implications of new investment strategies. By integrating simulation outputs, the data layer system of systems can enable informed decision-making and facilitate the testing of complex hypotheses across diverse industries.

### Experimental Data 38370

Experimental data may originate from controlled tests and research activities, capturing observations, measurements, and results. For instance, pharmaceutical companies may conduct clinical trials and generate experimental data related to drug efficacy. This data can then be processed and analyzed by the data layer system of systems 38000 to identify patterns and support regulatory submissions. Similarly, an automotive company might analyze experimental data from vehicle safety tests to enhance design standards. The flexibility of the data layer system allows for integration of experimental data into broader analytical frameworks, fostering innovation and development.

### Synthetic Data 38380

Synthetic data may refer to artificially generated datasets that mimic real-world data patterns. These datasets are often used in scenarios where privacy concerns limit the availability of real data, such as training machine learning models. For example, a financial institution may generate synthetic transaction data to test fraud detection algorithms. The data layer system of systems 38000 can synthesize, store, and validate such datasets, enabling organizations to derive insights while adhering to privacy regulations. This capability is particularly valuable for advancing AI and machine learning applications.

### Echoed Data 38390

Echoed data may involve data derived from repetitions or feedback loops, often used to validate or enhance existing datasets. For instance, a recommendation system may use echoed data to refine its predictions by analyzing user responses to previous suggestions. The data layer system of systems 38000 can seamlessly manage echoed data streams, incorporating them into real-time analytics to improve service delivery and user experience.

### Communication Data 38400

Communication data may include emails, messages, and voice recordings, providing insights into interpersonal or organizational interactions. For example, businesses may analyze communication data to identify collaboration patterns and improve team productivity. The data layer system of systems 38000 can process such data while ensuring compliance with privacy and security standards. Applications in customer service, for instance, may benefit from sentiment analysis of customer interactions to enhance support experiences.

### Behavioral Data 38410

Behavioral data may capture individual or group actions and preferences, often derived from online activities, app usage, or consumer interactions. A retail company might analyze behavioral data to personalize marketing campaigns or optimize product recommendations. The data layer system of systems 38000 can integrate behavioral data with other sources, enabling organizations to uncover trends and enhance customer engagement strategies.

### Location Data 38420

Location data may include GPS coordinates, geofencing insights, and spatial movement patterns. This data can support applications in transportation, urban planning, and retail. For instance, logistics companies may use location data to optimize delivery routes, while urban planners may analyze it to improve public infrastructure. The data layer system of systems 38000 provides a robust framework for processing and integrating location data to support geospatial analytics and decision-making.

### Pricing Data 38430

Pricing data may encompass historical price points, market comparisons, and promotional effects. Retailers may use this data to optimize pricing strategies, ensuring competitiveness and profitability. The data layer system of systems 38000 can process large volumes of pricing data, integrating it with demand and market data to enhance predictive pricing models.

### Sales Data 38440

Sales data may include transaction records, customer purchase histories, and revenue trends. Businesses can analyze sales data to identify growth opportunities and optimize inventory management. For instance, a retailer might use the data layer system of systems 38000 to track sales performance across regions and refine marketing campaigns accordingly.

### Tax Data 38450

Tax data may involve records of tax filings, liabilities, and regulatory compliance. Corporations can use this data to ensure accuracy in financial reporting and minimize audit risks. The data layer system of systems 38000 may facilitate the integration of tax data with financial and enterprise data, streamlining compliance processes.

### Historical Data 38460

Historical data may provide context by capturing trends and events from the past. This data is invaluable for forecasting, policy-making, and research. A financial institution might use historical market data to identify cycles and predict future trends. The data layer system of systems 38000 can enable efficient storage and retrieval of historical data, enhancing long-term analysis and strategic planning.

### Physiological Data 38470

Physiological data may include metrics such as heart rate, blood pressure, and respiratory rate, often collected through medical devices or wearables. Healthcare providers may use this data for personalized treatment plans and remote monitoring. The data layer system of systems 38000 can process physiological data in real-time, supporting advanced health analytics and early detection of medical conditions.

### Environmental Data 38480

Environmental data may encompass metrics related to air quality, temperature, and water levels, often used in sustainability and disaster response efforts. For example, environmental monitoring organizations might analyze this data to predict and mitigate climate impacts. The data layer system of systems 38000 can integrate environmental data with simulation and public datasets to support comprehensive environmental management strategies.

### Key Performance Indicator Data 38490

Key performance indicator KPI data may track metrics aligned with organizational objectives, such as customer satisfaction scores or operational efficiency rates. Businesses can use this data to evaluate performance and inform strategic initiatives. The data layer system of systems 38000 may enable real-time monitoring and analysis of KPIs, ensuring that organizations remain agile and focused on their goals.

### Resource Layer—Resource Modules

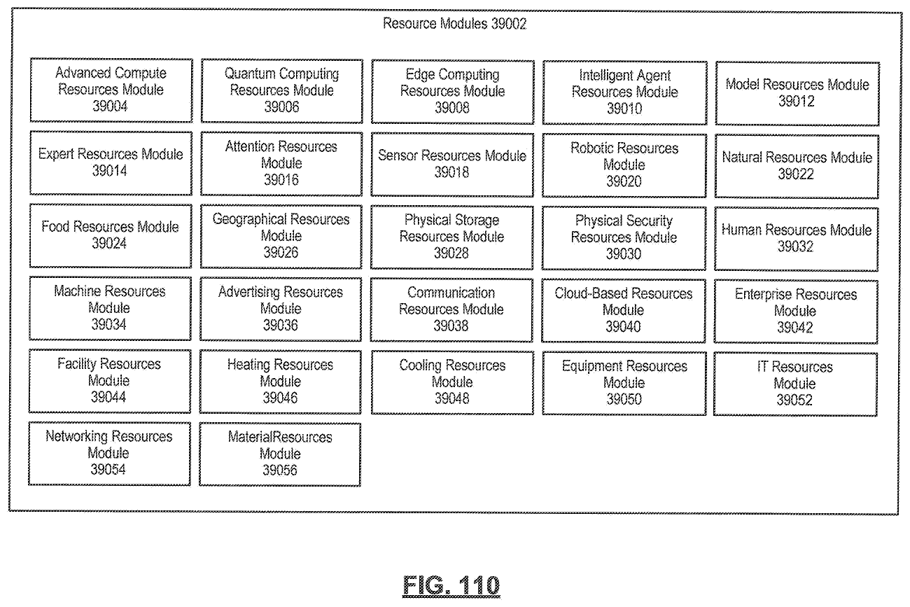

Referring to FIG. 102 and FIG. 110, the AI convergence system of systems 31000 may comprise a resource layer system of systems (“resource layer”) 39000 having a set of resource modules 39002. In embodiments, the set of resource modules 39002 may include an advanced compute resources module 39004, a quantum computing resources module 39006, an edge computing resources module 39008, an intelligent agent resources module 39010, a model resources module 39012, an expert resources module 39014, an attention resources module 39016, a sensor resources module 39018, a robotic resources module 39020, a natural resources module 39022, a food resources module 39024, a geological resources module 39026, a physical storage resources module 39028, a physical security resources module 39030, a human resources module 39032, a machine resources module 39034, an advertising resources module 39036, a communication resources module 39038, a cloud-based resources module 39040, an enterprise resources module 39042, a facility resources module 39044, a heating resources module 39046, a cooling resources module 39048, an equipment resources module 39050, an information technology (IT) resources module 39052, a networking resources module 39054, and/or a material resources module 39056. In some embodiments, the resource modules 39002 of the resource layer 39000 may further include an energy resources module, a distributed energy resources module, and/or a renewable energy resources module. In some embodiments, the resource modules 39002 of the resource layer 39000 may further include a healthcare resources module. In implementations, the resource modules 39002 of the resource layer 39000 may include an industrial resources module. In embodiments, the resource modules 39002 may include a financial resources module and/or a transactional resources module. In some implementations, the resource modules 39002 may further include a transportation resources module, a physical delivery resources module, and/or a vehicular resources module. In some embodiments, the resource modules 39002 of the resource layer 39000 may further comprise a shipping container resources module, a shipping resources module, and/or an additive manufacturing resources module.

In embodiments, the resource layer 39000 enables the automated and optimized provisioning of resources used to support various systems and services of an enterprise and/or operational environment. For example, operational environments may include industrial environments, manufacturing environments, warehouse environments, shipping environments (e.g., container ports, shipping containers, shipyards, and the like), energy environments (e.g., fossil fuel energy environments such as oil rigs, pipelines, and refineries or nuclear energy environments such as nuclear power plants), retail environments, transportation environments (e.g., airports, train stations, bus stops, airplanes, train cars, and the like), research environments, transaction and banking environments, datacenter environments, compute environments, hospitality environments, gaming environments, and entertainment environments, among many others.

Each resource module of the resource layer 39000 may include one or more processors and one or more memories storing computer-executable instructions that, when executed by the one or more processors, cause the one or more processors to implement a set of machine learning systems, a set of artificial intelligence systems, and/or a set of neural networks configured to optimize the provisioning of the set of resources corresponding to that particular module. The machine learning systems may be trained using supervised, unsupervised, or reinforcement learning techniques on historical resource allocation data, usage patterns, performance metrics, and simulated data (e.g., data generated from a simulation engine, a foundation world model, a set of digital twins, or the like). The neural networks may comprise multiple layers including, but not limited to, convolutional layers, recurrent layers, and fully connected layers, wherein the layers are configured to process input data and generate output predictions for resource optimization. The artificial intelligence systems may implement various algorithms including decision trees, random forests, and gradient boosting machines to analyze resource utilization patterns and make real-time optimization decisions. The resource layer 39000 may further include a simulation engine or set of foundation world models operating in parallel with the machine learning systems, artificial intelligence systems, and/or neural networks, wherein the simulation engine and/or set of foundation world models are configured to generate real-time simulations of resource allocation scenarios, validate optimization decisions, and provide feedback to the machine learning models for continuous improvement and adaptation to changing conditions. In embodiments, the simulation engine may employ physics-based modeling, discrete event simulation, or agent-based modeling techniques to accurately represent the dynamics of resource utilization and system behavior. In some embodiments, each resource module of the resource layer 39000 may include one or more processors and one or more memories storing computer-executable instructions that, when executed by the one or more processors, cause the one or more processors to implement a set of machine learning systems, a set of artificial intelligence systems, and/or a set of neural networks configured to perform an intelligence task related to that particular resource module. Such intelligence tasks may include other types of optimizations, as well as predictive intelligence tasks, detection and/or identification intelligence tasks, decision support tasks, automation tasks, configuration and/or control intelligence tasks, and the like.

### Advanced Compute Resource Module

For example, the advanced compute resource module 39004 may implement a set of machine learning systems, a set of artificial intelligence systems, and/or a set of neural networks configured to optimize, by computing hardware, the provisioning of the set of advanced compute resources. In embodiments, advanced compute resources may include high-performance computing (HPC) systems, graphics processing units (GPUs), tensor processing units (TPUs), field-programmable gate arrays (FPGAs), AI accelerators, distributed computing systems, and the like.

### Quantum Computing Resources Module

In another example, the quantum computing resources module 39006 may implement a set of machine learning systems, a set of artificial intelligence systems, and/or a set of neural networks configured to optimize, by computing hardware, the provisioning of the set of quantum computing resources. In embodiments, quantum computing resources may include quantum processing units (QPUs), quantum annealers, gate-based quantum processors, quantum error correction systems, and the like.

### Edge Computing Resources Module

In another example, the edge computing resources module 39008 may implement a set of machine learning systems, a set of artificial intelligence systems, and/or a set of neural networks configured to optimize, by computing hardware, the provisioning of the set of edge computing resources. In embodiments, edge computing resources may include Internet of Things (IOT) gateways, edge servers, edge AI accelerators, real-time analytics platforms, and the like.

### Intelligent Agent Resources Module

In another example, the intelligent agent resources module 39010 may implement a set of machine learning systems, a set of artificial intelligence systems, and/or a set of neural networks configured to optimize, by computing hardware, the provisioning of the set of intelligent agent resources. In embodiments, intelligent agent resources may include autonomous agents, chatbot frameworks, multi-agent systems, decision-making algorithms, and the like.

### Model Resources Module

In another example, the model resources module 39012 may implement a set of machine learning systems, a set of artificial intelligence systems, and/or a set of neural networks configured to optimize, by computing hardware, the provisioning of the set of model resources. In embodiments, model resources may include predictive models, prescriptive analytics models, simulation models, and the like.

### Expert Resources Module

In another example, the expert resources module 39014 may implement a set of machine learning systems, a set of artificial intelligence systems, and/or a set of neural networks configured to optimize, by computing hardware, the provisioning of the set of expert resources. In embodiments, expert resources may include rule-based systems, decision-support systems, expert knowledge bases, and the like.

### Attention Resources Module

In another example, the attention resources module 39016 may implement a set of machine learning systems, a set of artificial intelligence systems, and/or a set of neural networks configured to optimize, by computing hardware, the provisioning of the set of attention resources. In embodiments, attention resources may refer to the human, computational, and/or AI-driven focus allocated to specific tasks, processes, or decision-making. For example, AI models may be trained to focus on anomalies in sensor data or prioritize alerts in high-traffic environments. In embodiments, attention resources may be hybrid attention resources, such as a combination of human and AI focus, where AI filters or highlights critical information for human review.

### Sensor Resources Module

In another example, the sensor resources module 39018 may implement a set of machine learning systems, a set of artificial intelligence systems, and/or a set of neural networks configured to optimize, by computing hardware, the provisioning of the set of sensor resources. In embodiments, sensor resources may include environmental sensors, motion sensors, imaging sensors, health sensors, and the like.

### Robotic Resources Module

In another example, the robotic resources module 39020 may implement a set of machine learning systems, a set of artificial intelligence systems, and/or a set of neural networks configured to optimize, by computing hardware, the provisioning of the set of robotic resources. In embodiments, robotic resources may include industrial robots, collaborative robots (cobots), autonomous mobile robots (AMRs), material handling robots, pick-and-place robots, robotic arms, robotic dock workers, maintenance robots, hospitality robots, cleaning robots, pipeline inspection robots, baggage handling robots, security robots, cargo loading robots, and the like.

### Natural Resources Module

In another example, the natural resources module 39022 may implement a set of machine learning systems, a set of artificial intelligence systems, and/or a set of neural networks configured to optimize, by computing hardware, the provisioning of the set of natural resources. In embodiments, natural resources may include water resources, mineral resources, forest resources, and the like.

### Food Resources Module

In another example, the food resources module 39024 may implement a set of machine learning systems, a set of artificial intelligence systems, and/or a set of neural networks configured to optimize, by computing hardware, the provisioning of the set of food resources. In embodiments, food resources may include agricultural produce, processed foods, perishable items, and the like.

### Geological Resources Module

In another example, the geological resources module 39026 may implement a set of machine learning systems, a set of artificial intelligence systems, and/or a set of neural networks configured to optimize, by computing hardware, the provisioning of the set of geological resources. In embodiments, geological resources may include minerals, fossil fuels, underground water reserves, and the like.

### Physical Storage Resources Module

In another example, the physical storage resources module 39028 may implement a set of machine learning systems, a set of artificial intelligence systems, and/or a set of neural networks configured to optimize, by computing hardware, the provisioning of the set of physical storage resources. In embodiments, physical storage resources may include warehouses, cold storage facilities, data storage units, and the like.

### Physical Security Resources Module

In another example, the physical security resources module 39030 may implement a set of machine learning systems, a set of artificial intelligence systems, and/or a set of neural networks configured to optimize, by computing hardware, the provisioning of the set of physical security resources. In embodiments, physical security resources may include surveillance systems, access control systems, alarm systems, locking systems, and the like.

### Human Resources Module

In another example, the human resources module 39032 may implement a set of machine learning systems, a set of artificial intelligence systems, and/or a set of neural networks configured to optimize, by computing hardware, the provisioning of the set of human resources.

### Machine Resources Module

In another example, the machine resources module 39034 may implement a set of machine learning systems, a set of artificial intelligence systems, and/or a set of neural networks configured to optimize, by computing hardware, the provisioning of the set of machine resources.

### Advertising Resources Module

In another example, the advertising resources module 39036 may implement a set of machine learning systems, a set of artificial intelligence systems, and/or a set of neural networks configured to optimize, by computing hardware, the provisioning of the set of advertising resources. In embodiments, advertising resources may include digital ad placements, social media campaigns, targeted marketing systems, and the like.

### Communication Resources Module

In another example, the communication resources module 39038 may implement a set of machine learning systems, a set of artificial intelligence systems, and/or a set of neural networks configured to optimize, by computing hardware, the provisioning of the set of communication resources. In embodiments, communication resources may include email systems, messaging platforms, telecommunication networks, and the like.

### Cloud-Based Resources Module

In another example, the cloud-based resources module 39040 may implement a set of machine learning systems, a set of artificial intelligence systems, and/or a set of neural networks configured to optimize, by computing hardware, the provisioning of the set of cloud-based resources. In embodiments, cloud-based resources may include virtual machines, containerized services, distributed databases, and the like.

### Enterprise Resources Module

In another example, the enterprise resources module 39042 may implement a set of machine learning systems, a set of artificial intelligence systems, and/or a set of neural networks configured to optimize, by computing hardware, the provisioning of the set of enterprise resources. In embodiments, enterprise resources may include financial systems, operational workflows, customer relationship management (CRM) platforms, and the like.

### Facility Resources Module

In another example, the facility resources module 39044 may implement a set of machine learning systems, a set of artificial intelligence systems, and/or a set of neural networks configured to optimize, by facility management systems, the provisioning of the set of facility resources. In embodiments, facility resources may include factories, textile mills, assembly plants, manufacturing facilities, distribution centers, fulfillment centers, storage facilities, warehouse facilities, container ports and terminals, shipyards, freight forwarding facilities, oil rigs and offshore platforms, refineries, natural gas processing plants, pipeline pump stations, coal mining facilities, nuclear power plants, uranium enrichment facilities, retail facilities, airport facilities, bus terminal facilities, platforms and waiting areas, ticketing facilities, maintenance facilities, banking facilities, ATMs and kiosks, call center facilities, office facilities, datacenters, high-performance computing (HPC) facilities, cloud computing facilities, hospitality facilities, and entertainment facilities, among many others.

### Heating Resources Module

In another example, the heating resources module 39046 may implement a set of machine learning systems, a set of artificial intelligence systems, and/or a set of neural networks configured to optimize, by computing hardware, the provisioning of the set of heating resources. In embodiments, heating resources may include boilers, geothermal heating systems, district heating networks, and the like.

### Cooling Resources Module

In another example, the cooling resources module 39048 may implement a set of machine learning systems, a set of artificial intelligence systems, and/or a set of neural networks configured to optimize, by computing hardware, the provisioning of the set of cooling resources. In embodiments, cooling resources may include HVAC systems, liquid cooling systems, evaporative cooling units, and the like.

### Equipment Resources Module

In another example, the equipment resources module 39050 may implement a set of machine learning systems, a set of artificial intelligence systems, and/or a set of neural networks configured to optimize, by computing hardware, the provisioning of the set of equipment resources. In embodiments, equipment resources may include industrial tools, construction equipment, diagnostic machines, and the like.

### Information Technology Resources Module

In another example, the information technology (IT) resources module 39052 may implement a set of machine learning systems, a set of artificial intelligence systems, and/or a set of neural networks configured to optimize, by computing hardware, the provisioning of the set of IT resources. In embodiments, IT resources may include servers, data management systems, and the like.

### Networking Resources Module

In another example, the networking resources module 39054 may implement a set of machine learning systems, a set of artificial intelligence systems, and/or a set of neural networks configured to optimize, by computing hardware, the provisioning of the set of networking resources. In embodiments, networking resources may include switches, routers, hubs, bridges, network interface cards (NICs), access points (APs), modems, firewalls, network management software, virtual private networks (VPNs), network operating systems, software-defined networking (SDN) platforms, load balancers, wireless networking resources (e.g., Wi-Fi networks, cellular networks, and satellite networks), edge networking devices, IoT gateways, content delivery networks (CDNs), traffic analyzers, and many others.

### Material Resources Module

In another example, the material resources module 39056 may implement a set of machine learning systems, a set of artificial intelligence systems, and/or a set of neural networks configured to optimize, by computing hardware, the provisioning of the set of material resources. In embodiments, material resources may include raw materials (e.g., metals and minerals), natural resources, processed materials, energy-related materials (e.g., fuels), construction materials, 3D printing materials, components and parts, agricultural products, biomaterials, recycled materials, and many others.

### Energy Resources Module

In another example, the energy resources module may implement a set of machine learning systems, a set of artificial intelligence systems, and/or a set of neural networks configured to optimize, by computing hardware, the provisioning of the set of energy resources. In embodiments, energy resources may include power grids, fossil fuel power plants, and the like.

### Distributed Energy Resources Module

In another example, the distributed energy resources module may implement a set of machine learning systems, a set of artificial intelligence systems, and/or a set of neural networks configured to optimize, by computing hardware, the provisioning of the set of distributed energy resources. In embodiments, distributed energy resources may include solar panels, wind turbines, battery storage systems, and the like.

### Renewable Energy Resources Module

In another example, the renewable energy resources module may implement a set of machine learning systems, a set of artificial intelligence systems, and/or a set of neural networks configured to optimize, by computing hardware, the provisioning of the set of renewable energy resources. In embodiments, renewable energy resources may include solar farms, wind farms, hydroelectric systems, and the like.

### Health Resources Module

In another example, the health resources module may implement a set of machine learning systems, a set of artificial intelligence systems, and/or a set of neural networks configured to optimize, by computing hardware, the provisioning of the set of health resources. In embodiments, health resources may include diagnostic tools, patient records systems, telemedicine platforms, and the like.

### Industrial Resources Module

In another example, the industrial resources module may implement a set of machine learning systems, a set of artificial intelligence systems, and/or a set of neural networks configured to optimize, by computing hardware, the provisioning of the set of industrial resources. In embodiments, industrial resources may include assembly lines, heavy machinery, manufacturing systems, and the like.

### Financial Resources Module

In another example, the financial resources module may implement a set of machine learning systems, a set of artificial intelligence systems, and/or a set of neural networks configured to optimize, by computing hardware, the provisioning of the set of financial resources. In embodiments, financial resources may include trading platforms, risk management tools, credit scoring systems, and the like.

### Transactional Resources Module

In another example, the transactional resources module may include a set of machine learning systems, a set of artificial intelligence systems, and/or a set of neural networks configured to optimize, by computing hardware, the provisioning of the set of transactional resources. In embodiments, transactional resources may include payment gateways, point-of-sale systems, blockchain networks, and the like.

### Transportation Resources Module

In another example, the transportation resources module may implement a set of machine learning systems, a set of artificial intelligence systems, and/or a set of neural networks configured to optimize, by computing hardware, the provisioning of the set of transportation resources. In embodiments, transportation resources may include trains, buses, logistics platforms, autonomous vehicles, and the like.

### Physical Delivery Resources Module

In another example, the physical delivery resources module may implement a set of machine learning systems, a set of artificial intelligence systems, and/or a set of neural networks configured to optimize, by computing hardware, the provisioning of the set of physical delivery resources. In embodiments, physical delivery resources may include delivery trucks, drones, parcel sorting systems, and the like.

### Vehicular Resources Module

In another example, the vehicular resources module may implement a set of machine learning systems, a set of artificial intelligence systems, and/or a set of neural networks configured to optimize, by computing hardware, the provisioning of the set of vehicular resources. In embodiments, vehicular resources may include electric vehicles, autonomous vehicles, taxis, forklifts, trucks, utility vehicles, material transport vehicles, automated guided vehicles (AGVs), refrigerated trucks, oil tanker trucks, emergency response vehicles, armored vehicles, and the like), ships, tugboats, smart containers, trains, buses, aircraft, unmanned aerial vehicles (UAVS), electric bikes, electric scooters, and the like.

### Shipping Container Resources Module

In another example, the shipping container resources module may implement a set of machine learning systems, a set of artificial intelligence systems, and/or a set of neural networks configured to optimize, by computing hardware, the provisioning of the set of shipping container resources. In embodiments, shipping container resources may include smart containers, container tracking systems, container storage systems, and the like.

### Shipping Resources Module

In another example, the shipping resources module may implement a set of machine learning systems, a set of artificial intelligence systems, and/or a set of neural networks configured to optimize, by computing hardware, the provisioning of the set of shipping resources. In embodiments, shipping resources may include cargo ships, freight tracking systems, shipping schedules, and the like.

### Additive Manufacturing Resources Module

In another example, the additive manufacturing resources module may implement a set of machine learning systems, a set of artificial intelligence systems, and/or a set of neural networks configured to optimize, by computing hardware, the provisioning of the set of additive manufacturing resources. In embodiments, additive manufacturing resources may include 3D printers, 3D printer subsystems, and the like.

### Multi-Factor Resource Optimization Platform

At the resource layer 39000, AI capabilities for resource optimization enable a platform for providing multi-factor optimization of resources (“the multi-factor resource optimization platform”). Multi-factor resource optimization may refer to the process of achieving the best possible resource allocation outcome and/or solution that meets several objectives simultaneously. Multi-factor resource optimization objectives for operations may include profitability, cost reduction, improved customer experience and satisfaction, employee satisfaction, sustainability, market expansion, innovation, operational efficiency, risk management, fraud prevention, safety, corporate social responsibility, and the like.

In some implementations, the resource layer 39000 may have AI capabilities for financial resource optimization associated with the use of AI workloads, including generative AI workloads in various applications. Generative AI workloads may refer to a set of tasks and/or processes that are handled or augmented by generative intelligence technologies. These workloads may comprise a range of activities where generative AI systems generate, enhance, or modify offerings and communications, content, experiences, and the like. Generative AI media workloads may also include personalization and/or localization workloads, such as when generative AI is used for tailoring content or experiences to individual or regional preferences, editing workloads, visual effects workloads, marketing generation workloads, or any other workloads described throughout this disclosure.

For example, generative AI may be utilized to generate maintenance instructions, reports, product designs, production plans, marketing materials, training materials, simulations, AR/VR experiences and the like; simulate process flows, vehicle routes, foot traffic, layouts, product demand scenarios, and the like; and many others. In embodiments, generative AI may be used to provide personalized and/or localized content, offers, promotions, experiences, and many others. In embodiments, financial costs for the use of generative AI workloads may include compute costs associated with generative AI, licensing costs associated with the use of generative AI (such as for the use of generative AI models trained on copyrighted data sets), and the like.

In embodiments, the compute costs may refer to the expenses associated with the computational resources needed to train and run AI models, including generative AI models. These costs may vary depending on model complexity, training data volume, training duration, hardware requirements (e.g., GPUs, TPUs, or the like), and cloud services/infrastructure, energy consumption, maintenance, scaling, software and/or development tools (e.g., such as software and development tools that facilitate generative AI model training and deployment), and the like.

In embodiments, the resource layer 39000 may have AI capabilities for computational resource optimization of generative AI workloads. In embodiments, the computational resources for generative AI media workloads may include hardware resources such as graphics processing units (GPUs), tensor processing units (TPUs), central processing units (CPUs), high-performance computing (HPC) clusters, and the like; software and frameworks such as machine learning frameworks, AI development platforms, data processing software, and the like; data storage solutions; networking infrastructure (e.g., high bandwidth networks); cloud computing platforms; and energy resources; among others.

In some implementations, the resource layer 39000 may have AI capabilities for computational resource optimization for workloads involving other types of computation, including, but not limited to HPC, quantum computing, distributed computing, gaming engines (e.g., the Unreal Engine), cloud computing, edge computing, other types of artificial intelligence models, neural networks, deep learning, and many others. In embodiments, these computational resources may be used in tandem with generative AI computational resources. For instance, generative AI models may be used with the Unreal Engine to generate casino gaming experiences and/or content.

Strategies for computational resource optimization (e.g., for advanced computation) at the resource layer 39000 may include the use of parallelization (e.g., data parallelization, model parallelization, pipeline parallelization, and hybrid parallelization), efficient algorithms (e.g., optimization algorithms, data sampling techniques, dimensionality reduction, quantization and pruning, sparse representations and the like), dynamic resource allocation based on computational load, optimization based on energy efficiency, load balancing, caching, and many others.

In embodiments, quality of service (QOS) optimization may converge with AI capabilities of resource layer 39000 to enable resource optimization for AI workloads. Performance optimization may ensure that the AI models meet speed and responsiveness requirements, which may involve model simplification, efficient algorithms, hardware acceleration (e.g., using GPUS and TPUs), load balancing, and resource allocation. To achieve scalability, techniques such as elastic scaling may be leveraged to dynamically adjust computational resources based on demand. Failover mechanisms, redundancy, and error handling may be used to ensure the reliability and availability of the AI models. Latency management may be utilized to minimize delays in AI processing to meet real-time requirements. Techniques such as computational resource scheduling, job queue management, caching, and the like may be used to optimize the use of AI and other computational resources. Monitoring and analytics tools, AI model management techniques, and load testing and simulation may also be used to optimize the use of computational resources for AI workloads.

In some implementations, blockchain risk management may converge with AI capabilities of resource layer 39000 to enable resource optimization for generative AI workloads. Blockchain can facilitate the use of decentralized computational resources and decentralized computational resource marketplaces. Further, smart contracts can be used to automatically manage the allocation of computational resources based on predefined requirements and/or real-time needs. Computational resource usage and computational resource-related transactions may be recorded on a blockchain, providing a record of how resources are being used.

At the resource layer 39000, AI capabilities for resource optimization may utilize AI-driven predictive analytics, machine learning algorithms, AI-driven optimization algorithms, AI-driven digital twins that use simulations to test different scenarios or strategies, AI-driven autonomy, and any of the AI capabilities discussed throughout this disclosure.

In embodiments, the resource layer 39000 may manage and optimize a common set of resources that are used across different sets of enterprise and/or operational applications and/or use cases. This may include dynamic resource allocation and optimization strategies applicable to complex and varied environments such as industrial settings (e.g., manufacturing plants and warehouses), transportation infrastructures (e.g., airports and shipping ports), energy facilities (e.g., oil rigs and nuclear power plants), retail operations, datacenters, hospitality venues, and the like. By implementing a flexible resource management approach, the resource layer 39000 can dynamically adjust computational, logistical, and operational resources to meet the specific demands of these diverse environments.

The core functionality of the resource layer 39000 involves intelligent resource provisioning, which enables adaptability across different operational contexts. For instance, in a manufacturing environment, it might optimize machine utilization and energy consumption, while in a shipping context, it could manage container tracking, logistics routing, and real-time inventory management. Similarly, in datacenter and compute environments, the resource layer 39000 would focus on workload distribution, server resource allocation, and energy efficiency.

### AI Subsystem Integrator System

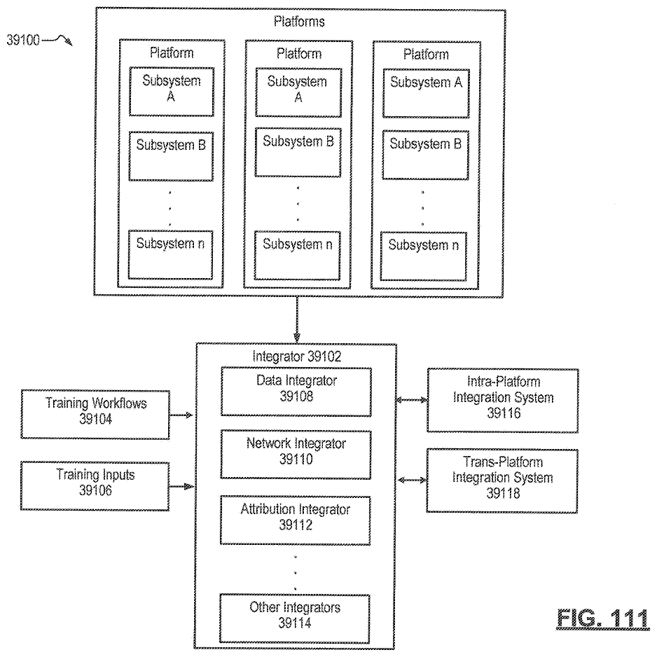

Referring now to FIG. 111, an AI subsystem integrator system 39100 is illustrated in accordance with embodiments described herein. Artificial intelligence (AI) and machine learning (ML) systems disclosed herein may be used to facilitate the automation of data integration, networking integration and other technology integration by system 39100. For example, the AI subsystem integrator system 39100 may train an integrator 39102 that includes at least one AI/ML system trained according to training workflows 39104 and training inputs 39106 to integrate a plurality of platforms and their respective subsystems A-n. For example, the training workflows 39104 and training inputs 39106 may utilize various methods and inputs disclosed herein and in the documents incorporated by reference (e.g., based on technical data sets, existing models, human supervision, deep learning on outcomes and/or robotic process automation learning on human execution of tasks, among others), across both the internal subsystems A-n within each of the platforms and across the different platforms and their subsystems. In the example provided, integrator 39102 includes a data integrator 39108, a network integrator 39110, an attribution integrator 39112, and other integrators 39114. For example, a set of AI systems may be trained to generate an intra-platform integration system 39116 that integrates various subsystems A-n within each of the platforms. Similarly, a set of AI systems may be trained with reference to the intra-platform integration system 39116 to generate a trans-platform integration system 39118 that facilitates interaction between the platforms. For example, integrator 39102 may learn the interfaces of a subsystem of a first platform and a subsystem of a second platform and to generate a data and network connection among them, as well as an interface by which a user, or an AI agent, may manage the data and network connection. Thus, disclosed herein is an artificial intelligence system that is configured and trained to generate a set of configurable integration capabilities across the internal subsystems and services of a set of platforms. Such an artificial intelligence system may be referred to herein as the “AI subsystem integrator system” and may integrate data and/or network communication, data storage (local and/or network), management interfaces, energy resources, and other capabilities. It may be noted that at scale an AI subsystem integrator system may generate a fully integrated or converged system that has massively parallel connectivity across the internal subsystems of the respective platforms, translating them from isolated platforms into a converged platform. This may evolve from various pairwise converged platforms among the various members of the platforms into a fully converged platform that encompasses subsystem elements of all of them.

In each case, a cross-service resource optimization system, which may comprise or employ a set of AI agents trained in ways noted above, may be used to manage, configure, deploy, provision, and/or optimize the respective subsystems or services that operate within a linked, integrated or converged system (the respective subsystems and/or services having previously been isolated to their respective standalone platform(s)).

For example, across any two or more subsystems or services across platforms may be optimized by measuring and allocating the energy that is used across the platforms, such as use of battery storage by devices, use of energy by GPUs in cloud computing or data centers (such as for generative AI workloads), and the like. Thus, in embodiments, methods and systems are provided for measuring and/or optimizing energy resources across the subsystems and services of at least two platforms.

As another example, across any two or more subsystems or services across platforms may be optimized by measuring and allocating the data storage resources that are used across the platforms, such as use of storage by devices, by cloud computing or data centers (such as for generative AI workloads), and in particular by network resources, such as use of network storage for caching content to reduce latency and improve efficiency of use of network connectivity resources. Thus, in embodiments, methods and systems are provided for measuring and/or optimizing data storage resources across the subsystems and services of at least two platforms.

As another example, across any two or more subsystems or services across platforms may be optimized by measuring and allocating the networking resources that are used across the platforms, such as use of bandwidth of network resources by devices, by cloud computing or data centers, and the like to reduce latency and improve efficiency of use of the network or connectivity resources. Thus, in embodiments, methods and systems are provided for measuring and/or optimizing network resources across the subsystems and services of at least two platforms.

As another example, across any two or more subsystems or services across platforms may be optimized by measuring and allocating the computation storage resources that are used across the platforms, such as use of computation resources by devices, by cloud computing or data centers (such as for generative AI workloads), and the like. Thus, in embodiments, methods and systems are provided for measuring and/or optimizing computation resources across the subsystems and services of at least two platforms.

In embodiments, higher level management systems may collectively optimize across multiple factors, such as energy, computation and network resources, including use of artificial intelligence systems (alone or in combination with analytic models) that are trained as noted herein to achieve multifactor optimization across resource types.

### Multiplatform Attention Management System

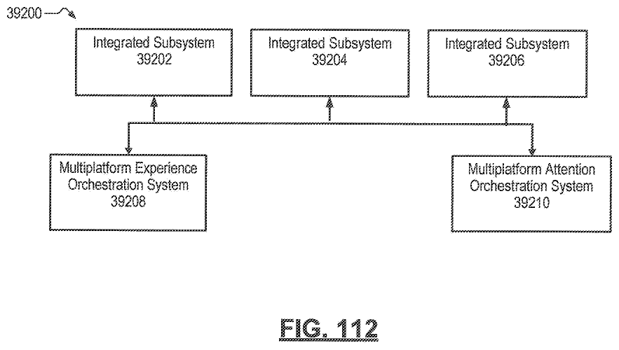

Referring now to FIG. 112, a higher-level multiplatform attention management system 39200 may be used to track and optimize attention across platforms (e.g., across integrated subsystems 39202, 39204, and 39206), such as by understanding where overall attention by customers (or by intelligent agents that operate on their behalf) may be increased by encouraging transitions across platforms, rather than maximizing only within a platform. This may include a multiplatform experience orchestration system 39208 for orchestrating experiences that are intentionally designed to encourage a user to move from platform to. The multiplatform attention management system 39200 may be used to monitor attention and provide input to a multiplatform attention orchestration system 39210 in order to improve the overall attention by users across the respective platforms. This may include any two platforms, or a converged platform among two or more platforms, or an overall converged platform in which the respective subsystems or services are fully integrated (including by AI as noted above).

In embodiments, a higher-level multiplatform revenue management system may be used to track and optimize revenue across platforms, such as by understanding where overall revenue by customers (or by intelligent agents that operate on their behalf) may be increased by encouraging transitions across platforms, rather than maximizing only within a platform. This may include the multiplatform experience orchestration system for orchestrating experiences (such as VR, entertainment, and other experiences) that are intentionally designed to encourage a user to move from platform to platform. The revenue management system may be used to monitor attention and other factors that drive short-term revenue and long-term customer value and provide input to the orchestration system in order to improve the overall revenue from users across the respective platforms. This may include any two platforms, or a converged platform among two or more platforms, or an overall converged platform in which the respective subsystems or services are fully integrated (including by AI as noted above).

### Hardware, Software, and Special-Purpose Systems

Special-purpose systems include hardware and/or software and may be described in terms of an apparatus, a method, or a computer-readable medium. In various embodiments, functionality may be apportioned differently between software and hardware. For example, some functionality may be implemented by hardware in one embodiment and by software in another embodiment. Further, software may be encoded by hardware structures, and hardware may be defined by software, such as in software-defined networking or software-defined radio.

The methods and/or processes described in the disclosure, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

In this application, including the claims, the term module refers to a special-purpose system. The module may be implemented by one or more special-purpose systems. The one or more special-purpose systems may also implement some or all of the other modules. In this application, including the claims, the term module may be replaced with the terms “controller” or “circuit.” In this application, including the claims, the term platform refers to one or more modules that offer a set of functions. In this application, including the claims, the term system may be used interchangeably with module or with the term special-purpose system.

The special-purpose system may be directed or controlled by an operator. The special-purpose system may be hosted by one or more of assets owned by the operator, assets leased by the operator, and third-party assets. The assets may be referred to as a private, community, or hybrid cloud computing network or cloud computing environment. For example, the special-purpose system may be partially or fully hosted by a third party offering software as a service (SaaS), platform as a service (PaaS), and/or infrastructure as a service (IaaS). The special-purpose system may be implemented using agile development and operations (DevOps) principles. In example embodiments, some or all of the special-purpose system may be implemented in a multiple-environment architecture. For example, the multiple environments may include one or more production environments, one or more integration environments, one or more development environments, etc.

A special-purpose system may be partially or fully implemented using or by a mobile device. Examples of mobile devices include navigation devices, cell phones, smart phones, mobile phones, mobile personal digital assistants, palmtops, netbooks, pagers, electronic book readers, tablets, music players, etc. A special-purpose system may be partially or fully implemented using or by a network device. Examples of network devices include switches, routers, firewalls, gateways, hubs, base stations, access points, repeaters, head-ends, user equipment, cell sites, antennas, towers, etc.

A special-purpose system may be partially or fully implemented using a computer having a variety of form factors and other characteristics. For example, the computer may be characterized as a personal computer, as a server, etc. The computer may be portable, as in the case of a laptop, netbook, etc. The computer may or may not have any output device, such as a monitor, line printer, liquid crystal display (LCD), light emitting diodes (LEDs), etc. The computer may or may not have any input device, such as a keyboard, mouse, touchpad, trackpad, computer vision system, barcode scanner, button array, etc. The computer may run a general-purpose operating system, such as the WINDOWS operating system from Microsoft Corporation, the MACOS operating system from Apple, Inc., or a variant of the LINUX operating system. Examples of servers include a file server, print server, domain server, internet server, intranet server, cloud server, infrastructure-as-a-service server, platform-as-a-service server, web server, secondary server, host server, distributed server, failover server, and backup server.

The term hardware encompasses components such as processing hardware, storage hardware, networking hardware, and other general-purpose and special-purpose components. Note that these are not mutually-exclusive categories. For example, processing hardware may integrate storage hardware and vice versa.

Examples of a component are integrated circuits (ICs), application specific integrated circuit (ASICs), digital circuit elements, analog circuit elements, combinational logic circuits, gate arrays such as field programmable gate arrays (FPGAs), digital signal processors (DSPs), complex programmable logic devices (CPLDs), etc.

Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an artificial intelligence (AI) system-on-chip, a video processing system-on-chip, an organ-on-chip, a quantum algorithm system-on-chip, etc.

The hardware may integrate and/or receive signals from sensors. The sensors may allow observation and measurement of conditions including temperature, pressure, wear, light, humidity, deformation, expansion, contraction, deflection, bending, stress, strain, load-bearing, shrinkage, power, energy, mass, location, temperature, humidity, pressure, viscosity, liquid flow, chemical/gas presence, sound, and air quality. A sensor may include image and/or video capture in visible and/or non-visible (such as thermal) wavelengths, such as a charge-coupled device (CCD) or complementary metal-oxide semiconductor (CMOS) sensor.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In example embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, an approximate computing processor, a quantum computing processor, a parallel computing processor, a neural network processor, a signal processor, a digital processor, a data processor, an embedded processor, a microprocessor, and a co-processor. The co-processor may provide additional processing functions and/or optimizations, such as for speed or power consumption, or other type of processor. Examples of co-processors include a math co-processor, a graphics co-processor, a communication co-processor, a video co-processor, and an artificial intelligence (AI) co-processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code.

The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like. The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

A processor may include one or more cores that may enhance speed and performance of a multiprocessor. In example embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server, and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The processor may enable execution of multiple threads. These multiple threads may correspond to different programs. In various embodiments, a single program may be implemented as multiple threads by the programmer or may be decomposed into multiple threads by the processing hardware. The threads may be executed simultaneously to enhance the performance of the processor and to facilitate simultaneous operations of the application. A processor may be implemented as a packaged semiconductor die. The die includes one or more processing cores and may include additional functional blocks, such as cache. In various embodiments, the processor may be implemented by multiple dies, which may be combined in a single package or packaged separately.

The networking hardware may include one or more interface circuits. In some examples, the interface circuit(s) may implement wired or wireless interfaces that connect, directly or indirectly, to one or more networks. Examples of networks include a cellular network, a local area network (LAN), a wireless personal area network (WPAN), a metropolitan area network (MAN), and/or a wide area network (WAN). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs).

Examples of cellular networks include GSM, GPRS, 3G, 4G, 5G, LTE, and EVDO. The cellular network may be implemented using frequency division multiple access (FDMA) network or code division multiple access (CDMA) network. Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN include IEEE Standard 802.15.4, including the ZIGBEE standard from the ZigBee Alliance. Further examples of a WPAN include the BLUETOOTH™ wireless networking standard, including Core Specification versions 3.0, 4.0, 4.1, 4.2, 5.0, and 5.1 from the Bluetooth Special Interest Group (SIG). A WAN may also be referred to as a distributed communications system (DCS). One example of a WAN is the internet.

Storage hardware is or includes a computer-readable medium. The term computer-readable medium, as used in this disclosure, encompasses both nonvolatile storage and volatile storage, such as dynamic random access memory (DRAM). The term computer-readable medium only excludes transitory electrical or electromagnetic signals propagating through a medium (such as on a carrier wave). A computer-readable medium in this disclosure is therefore non-transitory, and may also be considered to be tangible.

Examples of storage implemented by the storage hardware include a database (such as a relational database or a NoSQL database), a data store, a data lake, a column store, and a data warehouse. Examples of storage hardware include nonvolatile memory devices, volatile memory devices, magnetic storage media, a storage area network (SAN), network-attached storage (NAS), optical storage media, printed media (such as bar codes and magnetic ink), and paper media (such as punch cards and paper tape). The storage hardware may include cache memory, which may be collocated with or integrated with processing hardware. Storage hardware may have read-only, write-once, or read/write properties. Storage hardware may be random access or sequential access. Storage hardware may be location-addressable, file-addressable, and/or content-addressable.

Examples of nonvolatile memory devices include flash memory (including NAND and NOR technologies), solid state drives (SSDs), an erasable programmable read-only memory device such as an electrically erasable programmable read-only memory (EEPROM) device, and a mask read-only memory device (ROM). Examples of volatile memory devices include processor registers and random access memory (RAM), such as static RAM (SRAM), dynamic RAM (DRAM), synchronous DRAM (SDRAM), synchronous graphics RAM (SGRAM), and video RAM (VRAM). Examples of magnetic storage media include analog magnetic tape, digital magnetic tape, and rotating hard disk drive (HDDs). Examples of optical storage media include a CD (such as a CD-R, CD-RW, or CD-ROM), a DVD, a Blu-ray disc, and an Ultra HD Blu-ray disc.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether. Some or all features of hardware may be defined using a language for hardware description, such as IEEE Standard 1364-2005 (commonly called “Verilog”) and IEEE Standard 1076-2008 (commonly called “VHDL”). The hardware description language may be used to manufacture and/or program hardware.

A special-purpose system may be distributed across multiple different software and hardware entities. Communication within a special-purpose system and between special-purpose systems may be performed using networking hardware. The distribution may vary across embodiments and may vary over time. For example, the distribution may vary based on demand, with additional hardware and/or software entities invoked to handle higher demand. In various embodiments, a load balancer may direct requests to one of multiple instantiations of the special purpose system. The hardware and/or software entities may be physically distinct and/or may share some hardware and/or software, such as in a virtualized environment. Multiple hardware entities may be referred to as a server rack, server farm, data center, etc.

Software includes instructions that are machine-readable and/or executable. Instructions may be logically grouped into programs, codes, methods, steps, actions, routines, functions, libraries, objects, classes, etc. Software may be stored by storage hardware or encoded in other hardware. Software encompasses (i) descriptive text to be parsed, such as HTML (hypertext markup language), XML (extensible markup language), and JSON (JavaScript Object Notation), (ii) assembly code, (iii) object code generated from source code by a compiler, (iv) source code for execution by an interpreter, (v) bytecode, (vi) source code for compilation and execution by a just-in-time compiler, etc. As examples only, source code may be written using syntax from languages including C, C++, JavaScript, Java, Python, R, etc. The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the devices described in the disclosure, as well as heterogeneous combinations of processors, processor architectures, or combinations of different hardware and software, or any other machine capable of executing program instructions. Computer software may employ virtualization, virtual machines, containers, dock facilities, portainers, and other capabilities. In example embodiments, methods described in the disclosure and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described in the disclosure may include any of the hardware and/or software described in the disclosure. All such permutations and combinations are intended to fall within the scope of the disclosure.

The elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described in the disclosure may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

Software also includes data. However, data and instructions are not mutually-exclusive categories. In various embodiments, the instructions may be used as data in one or more operations. As another example, instructions may be derived from data. The functional blocks and flowchart elements in this disclosure serve as software specifications, which can be translated into software by the routine work of a skilled technician or programmer. Software may include and/or rely on firmware, processor microcode, an operating system (OS), a basic input/output system (BIOS), application programming interfaces (APIs), libraries such as dynamic-link libraries (DLLs), device drivers, hypervisors, user applications, background services, background applications, etc. Software includes native applications and web applications. For example, a web application may be served to a device through a browser using hypertext markup language 5th revision (HTML5).

Software may include artificial intelligence systems, which may include machine learning or other computational intelligence. For example, artificial intelligence may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

Examples of the models include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), computer vision (CV), classification, image recognition, etc.

Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc.

In a client-server model, some of the software executes on first hardware identified functionally as a server, while other of the software executes on second hardware identified functionally as a client. The identity of the client and server is not fixed: for some functionality, the first hardware may act as the server while for other functionality, the first hardware may act as the client. In different embodiments and in different scenarios, functionality may be shifted between the client and the server. In one dynamic example, some functionality normally performed by the second hardware is shifted to the first hardware when the second hardware has less capability. In various embodiments, the term “local” may be used in place of “client,” and the term “remote” may be used in place of “server.”

Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

Some or all of the software may be arranged logically into layers. In a layered architecture, a second layer may be logically placed between a first layer and a third layer. The first layer and the third layer would then generally interact with the second layer and not with each other. In various embodiments, this is not strictly enforced—that is, some direct communication may occur between the first and third layers.

In embodiments, the integration of the transportation system with an AI convergence system of systems, as described herein, represents a multi-layered system for intelligent automation and data-driven decision making across operational aspects of a transportation system. The architecture may support complex interactions between different technological components while maintaining operational efficiency and security across the enterprise environment. A transportation system includes mechanical and electrical components that form the foundation of vehicles, including, but not limited to, powertrains, suspension systems, integrated steering and braking mechanisms, fuel and charging systems, and in-cabin amenities for vehicle occupants, such as climate control, sound, lighting, noise dampening, user interfaces and the like. Vehicle user interfaces may provide interaction between the driver and vehicle systems, complemented by a network of sensors and cameras that provide continuous environmental and operational data. Artificial intelligence integration forms a component of a transportation system, implementing expert systems and AI components that control various vehicle functions. The system may utilize hybrid neural networks for specialized tasks, such as powertrain optimization, where different parts of the neural network may be dedicated to optimizing distinct components. AI integration, and the convergence of AI-enable systems, within an AI convergence system of systems, may provide, in an example, real-time sensor data processing and fusion, allowing for continuous state monitoring and adaptive response to changing conditions.

In embodiments, a governance layer of a transportation systems with AI convergence system of systems may implement a comprehensive framework for automated oversight and compliance. Through specialized governance modules, it may utilize generative AI technology to ensure proper oversight while adapting to evolving regulatory requirements. The system may automatically implement and enforce policies, manage digital rights infrastructure, monitor content and data flows, and ensure compliance with relevant regulations, contracts, licensing requirements, and the like.

In embodiments, an enterprise layer may provide support for various organizational functions through integration of enterprise management and control platforms with digital infrastructure. This layer may provide automated transactional processes, manage user profiles and listings, provide analytics for strategic decision-making, and maintain security protocols through advanced permissions systems.

In embodiments, a value chain integration with a transportation system may provide project management through AI-driven workflow orchestration. The transportation system and AI convergence system of systems may coordinate various components by employing AI-configured agents to determine workflows, initiate tasks, and monitor outcomes. This integration may allow for more efficient resource allocation, comprehensive progress tracking, and continuous optimization of project outcomes through intelligent automation and adaptive response mechanisms. The coordination capabilities of the transportation system and AI convergence system of systems may facilitate communication between different components and external entities. The transportation system and AI convergence system of systems may enable task delegation, continuous progress monitoring, and optimization of resource utilization through the use of AI algorithms and/or converged AI systems with a transportation system, as described herein. This coordination may include both internal systems and external partners, creating a cohesive and efficient operational environment.

In embodiments, the transportation system may include an architecture designed to support continuous evolution and enhancement of capabilities across all layers. Through sophisticated machine learning algorithms and adaptive systems, it enables ongoing performance optimization and capability expansion. The transportation system and AI convergence system of systems may learn from operational data and outcomes to improve its functionality and effectiveness over time and provide support for new technology adoption and system scalability, providing integration of emerging technologies while maintaining operational efficiency and security. The modular design may allow for continuous feature enhancement and performance improvement, ensuring the system remains current with technological advances.

In embodiments, the transportation system having AI convergence system of systems technologies may be combined through a plurality of integration points.

In embodiments, the transportation system having AI convergence system of systems technologies may provide vehicle systems integration. The transportation system's mechanical and electrical components, including powertrains, suspension systems, and vehicle interfaces, may be enhanced through integration with AI convergence capabilities. This combination may provide intelligent control and optimization of vehicle operations through expert systems and hybrid neural networks that can optimize distinct parts of vehicle systems simultaneously.

In embodiments, the transportation system having AI convergence system of systems technologies may provide sensor and data integration. A vehicle's sensor systems and cameras may be integrated with the AI convergence system's data layer, enabling sensor and data fusion capabilities. This integration may allow for context-aware sensor fusion to inform analytics and AI processing, while supporting APIs, service-oriented architecture, and distributed data processing.

In embodiments, the transportation system having AI convergence system of systems technologies may provide network layer convergence. The transportation system's communication infrastructure may converge with the AI system's network layer through, for example, V2X networking capabilities. This integration may implement energy-aware edge and cloud computing, cellular, WiFi, ORAN, and Bluetooth connectivity, creating a vehicle-aware Internet-of-things network.

In embodiments, the transportation system having AI convergence system of systems technologies may provide operations layer integration. The combined system may implement converged, AI-based fleet orchestration and optimization. This integration may enable automated rider satisfaction monitoring, intelligent location of resources for mobility demand, and sophisticated vehicle drivetrain optimization.

In embodiments, the transportation system having AI convergence system of systems technologies may provide transaction layer fusion. The integration may enable transaction management through automated transaction orchestration, including user profiling and targeting, smart contract configuration for in-vehicle offers, and automated transaction execution.

In embodiments, the transportation system having AI convergence system of systems technologies may provide offering layer combination. The combined system may create a digital platform for rider user experience and vehicle management, implementing, for example, location-based offering systems, advertising and marketplace integration, and customer-facing vehicle digital twins.

In embodiments, the transportation system having AI convergence system of systems technologies may provide enterprise layer integration. The system may implement executive digital twins for vehicle fleet operations, vehicle digital twins for design and simulation, and enterprise access layer for fleet transactions, creating a comprehensive fleet management system.

In embodiments, the transportation system having AI convergence system of systems technologies may provide governance layer convergence. The combined technologies may implement automated governance of vehicle operations through policy automation, regulatory compliance automation, and reporting automation, ensuring proper oversight of the entire integrated system.

In embodiments, the transportation system having AI convergence system of systems technologies may provide resource layer integration. The combined system may enable optimization of energy for vehicle fleet management through charging infrastructure optimization, vehicle energy efficiency optimization, and attention resource management.

In embodiments, the transportation system having AI convergence system of systems technologies may provide AI system integration. The integration may include AI capabilities across multiple layers, including routing, control, optimization, and generation capabilities. These AI systems may be aggregated and deployed across the combined system to handle specialized processing tasks and generate chain-of-thought reasoning for various operational contexts.

In embodiments, the combination of transportation systems and digital twins within an AI convergence system of systems ecosystem may create a framework that enables intelligent monitoring, optimization, and control of transportation operations. This integration may leverage advanced technologies to create virtual representations of physical assets while enabling real-time adaptation and decision-making capabilities. The digital twin system, as described herein, may generate and maintain digital representations of transportation systems and their constituent entities, using sensor data to maintain accurate states of the respective systems. The digital twin architecture includes a plurality of components: a digital twin management system, I/O system, simulation system, dynamic model system, cognitive intelligence system, and environment control system. These components work together through APIs, brokers, connectors, and other integration systems to facilitate seamless data transfer between physical transportation assets and their digital counterparts. A digital twin may serve as a comprehensive digital representation of transportation entities, including physical objects, devices, sensors, and even human operators. This representation may exist simultaneously with the physical entities being replicated, providing real-time virtual representation and enabling simulation of possible future states. The digital twin can simulate both physical elements and properties of the transportation entities, as well as their dynamics throughout their lifecycle. This capability extends to hypothetical simulations during design phases, allowing for extrapolation of sensor data to simulate various operational states and conditions. The integration with transportation systems may include vehicle operations. For example, digital twins may interact with nearby vehicles, pedestrians, traffic lights, tollbooths, street signs, refueling systems, and charging systems to determine their behavior, coordinate traffic, and obtain comprehensive environmental awareness. This interaction may utilize a combination of dedicated short-range communication protocols and, for example, cellular V2X communication to enable infrastructure element interaction. The digital twin may provide critical safety features, such as warning drivers about upcoming sharp turns based on the behavior of other digital twins in the virtual operating environment or identifying instances of rapid deceleration or lane changes from nearby vehicles.

In embodiments, the AI convergence ecosystem of the transportation system, as described herein, may include digital twins in enterprise operations through executive digital twins for vehicle fleet operations and vehicle digital twins for design and simulation. The transportation system and AI convergence system of systems may implement digital twin neural networks to create high-fidelity virtual representations of physical industrial assets, processes, and facilities, enabling immersive industrial operations. This integration may allow for sophisticated monitoring of IoT data sources to determine transaction timing and attributes while coordinating resource allocation across industrial systems. The combination may also provide advanced optimization capabilities through simulation and testing. The digital twin system may evaluate effects of simulated elements within a digital twin of a transportation system to efficiently determine costs and benefits of including, excluding, or substituting real-world elements. These evaluations may consider factors such as machinery costs, process optimization for reduced waste or increased throughput, footprint optimization, lifespan extension, and minimization of component faults and downtime. This capability may allow organizations to test and validate changes virtually before implementing them in the physical world, reducing risk and improving operational efficiency.

In embodiments, the combination of a transportation system and AI convergence system of systems may enable capabilities for modifying vehicle performance and operating characteristics through multiple integrated layers of technology and intelligence. This integration may create a framework for dynamic vehicle optimization and control. The transportation system may utilize hybrid neural networks to optimize distinct parts of a vehicle's powertrain and operating parameters. For example, one neural network may optimize gear shifting operations while another neural network simultaneously optimizes other aspects like braking, clutch engagement, or energy discharge and recharging. This may allow for granular control and optimization of specific vehicle subsystems while maintaining overall system coordination. The transportation system and AI convergence system of systems may implement sensor integration and real-time state monitoring to inform these optimizations. Sensors and cameras may provide input to expert system/artificial intelligence features, including neural networks, which can track vehicle operating states, user experience states, and various vehicle parameters from onboard diagnostic and telemetry systems. This sensor data may enable the AI system to make informed decisions about modifying vehicle performance based on current conditions and desired outcomes.

In embodiments, for continuously variable powertrains, the transportation system and AI convergence system of systems may employ an approach where one portion of a hybrid neural network classifies the vehicle's state (such as operating in high-traffic or adverse weather conditions) while another portion optimizes transmission operating parameters based on the classified state. For instance, when the transportation system and AI convergence system of systems classifies a high-traffic and bad weather state through inputs like LIDAR, radar, vision systems, and environmental sensors, it may automatically adjust the vehicle into a safe-driving mode with modified forward-sensing alerts, braking parameters, and other performance characteristics.

In embodiments, the operations layer of the AI convergence system may enable orchestration and optimization of vehicle performance through multiple mechanisms. For example, it may implement routing, control, optimization, and generation capabilities that can modify vehicle drivetrain operation and other performance parameters. The transportation system and AI convergence system of systems may optimize energy usage through automated charging infrastructure optimization and vehicle energy efficiency management. Additionally, it may enable attention to resource management to ensure optimal allocation of system resources for vehicle control and performance modification. This integration may be supported by a network layer that enables high-quality, adaptive communication across vehicle networks using advanced networking technologies. The data layer may provide context-aware sensor fusion to inform analytics and AI systems, allowing for intelligent adaptation of vehicle parameters based on environmental conditions, marketplace factors, and other relevant data streams. The transportation system and AI convergence system of systems may also leverage digital twins to create virtual representations of vehicles and their components, enabling sophisticated simulation and testing of performance modifications before implementation in the physical vehicle.

In embodiments, the combination of the transportation system and AI convergence system of systems may enable capabilities for modifying and optimizing a vehicle's interior environment and in-cabin characteristics through multiple integrated technological layers. This integration may create an adaptive and personalized passenger experience. The transportation system and AI convergence system of systems may utilize sensor integration and real-time state monitoring to inform cabin optimizations. For example, the transportation system and AI convergence system of systems can process a voice of a rider to determine their emotional state and optimize vehicle parameters to improve that state. Through voice-analysis modules and machine learning systems trained on labeled emotional state data, the transportation system and AI convergence system of systems can classify a rider's emotional state and adjust various cabin parameters accordingly. When detecting stress through voice analysis, the transportation system and AI convergence system of systems may recommend or automatically implement changes like modifying audio content or adjusting climate controls to create a more relaxing environment.

In embodiments, the transportation system and AI convergence system of systems may further enhance the in-cabin experience through an intelligent agent module configured to engage in dialog with riders. This capability may allow the transportation system and AI convergence system of systems to obtain detailed feedback about the rider's emotional state, identify specific sources of discomfort or stress, and determine appropriate mitigation strategies. The transportation system and AI convergence system of systems may then selectively adjust various vehicle parameters including route options, entertainment settings, ride configurations, and communication options to optimize the rider experience. For personalization of the in-cabin environment, the transportation system and AI convergence system of systems may leverage AI capabilities across multiple layers to deliver customized content and experiences. The offering layer may implement expert systems and generative AI to provide location-based offerings, advertising integration, and customer-facing vehicle digital twins. This may enable the transportation system and AI convergence system of systems to customize and personalize offerings based on a rider's profile, behavior, current state, environment, location, and specific requests. For example, a rider can request particular types of experiences with preferred themes including music, video, and other entertainment content that matches their style and current mood.

In embodiments, the transportation system and AI convergence system of systems may also implement attention management and user interface optimization. Through the operations layer, the transportation system and AI convergence system of systems may monitor rider satisfaction in real-time and make dynamic adjustments to the cabin environment. The transaction layer may enable smart contract configuration for in-vehicle offers, while the data layer provides context-aware sensor fusion to inform analytics about rider preferences and states. This comprehensive integration may allow for intelligent adaptation of cabin parameters based on individual rider characteristics and environmental conditions. Additionally, the transportation system and AI convergence system of systems may optimize the in-cabin experience through automated randomization of experience parameters to improve user states that benefit from variation. This may include control over aspects like seat positioning (including lumbar support, leg room, seatback angle, seat height), climate control (ventilation, window/moonroof state, temperature, humidity, fan speed, air motion), sound systems (volume, bass, treble, individual speaker control, focus area of sound), and content delivery (audio, video, news, advertising). The transportation system and AI convergence system of systems may automatically undertake actions based on objectives or feedback functions, with artificial intelligence systems trained on outcomes to improve health, satisfaction, mood, safety and other metrics.

In embodiments, the combination of the transportation system and AI convergence system of systems may enable capabilities for modifying and optimizing user interfaces for drivers of software-defined vehicles through multiple integrated technological layers. This integration may create an adaptive and personalized driving experience through intelligent interface management.

In embodiments, the architecture of a vehicle in the transportation system may include various user interfaces, including steering systems, buttons, levers, touch screen interfaces, and audio interfaces. These interfaces may be enhanced through integration with sensor systems and cameras that provide input to expert system/artificial intelligence features, including neural networks, which can track vehicle operating states and user experience states. This comprehensive sensing and monitoring capability may enable the AI system to make informed decisions about modifying interface characteristics based on current conditions and desired outcomes. The transportation system and AI convergence system of systems may implement interface adaptation through multiple mechanisms. For example, the vehicle may have a game interface, navigation interface, entertainment interface, vehicle settings interface, search interface, and ecommerce interface. These interfaces may be governed by one or more AI systems/expert systems that process various inputs to optimize the driver experience. The transportation system and AI convergence system of systems may also leverage voice interfaces for processing information regarding objects in proximity to the current location, allowing drivers to query the transportation-pretrained AI for everything from physical entities near the vehicle to historical area information, housing costs, employment data, crime statistics, and customized routing options.

In embodiments, the AI convergence system's offering layer may provide capabilities for interface optimization through expert systems and generative AI. This may enable location-based offering systems, advertising and marketplace integration, and customer-facing vehicle digital twins. The transaction layer may implement smart contract configuration for in-vehicle offers, while the operations layer enables automated satisfaction monitoring and optimization. These capabilities may allow the transportation system and AI convergence system of systems to deliver personalized interface experiences based on driver preferences, behavior patterns, and current operating context. The transportation system and AI convergence system of systems may employ cognitive engagement and routing behavior analysis through a monitoring system that continuously observes the driver's interactions with vehicle controls and navigation systems. When the system detects patterns indicating routine or potentially under-stimulating activities, it may generate cognitive challenges tailored to engage the driver's cognitive functions, including memory recall, spatial navigation, and executive decision-making. For example, the transportation system and AI convergence system of systems might present route deviation prompts that encourage drivers to navigate familiar routes without step-by-step navigation assistance, thereby stimulating spatial awareness and problem-solving skills.

In embodiments, the transportation system and AI convergence system of systems may adapt interface characteristics based on a driver's emotional state through sensing and analysis capabilities. For example, by processing feature vectors from facial images or voice analysis, the transportation system and AI convergence system of systems may determine the driver's emotional state and optimize interface parameters accordingly. This might include adjusting display characteristics, modifying audio feedback, or adapting the presentation of information to improve the driver's emotional state. The transportation system and AI convergence system of systems can also employ neural networks that include perceptrons mimicking human senses to facilitate determining emotional states based on the extent to which the driver's senses are stimulated, enabling more nuanced and effective interface adaptations.

In embodiments, the combination of the transportation system and AI convergence system of systems may enable simulation and prediction capabilities for software-defined vehicles through multiple integrated technological layers. This integration may create a comprehensive framework for modeling and forecasting vehicle characteristics and usage patterns. The enterprise layer of the transportation AI convergence system may implement executive digital twins for vehicle fleet operations and vehicle digital twins for design and simulation. These digital twins may create high-fidelity virtual representations of physical vehicles and their components, enabling sophisticated testing and validation of vehicle characteristics before implementation. The transportation system and AI convergence system of systems may evaluate the effects of simulated elements within a digital twin to efficiently determine costs and benefits of including, excluding, or substituting real-world elements. The transportation system and AI convergence system of systems may leverage sophisticated sensor integration and real-time state monitoring to inform its simulations and predictions. Sensors and cameras may provide input to expert system/artificial intelligence features, including neural networks, which can track vehicle operating states, user experience states, and various vehicle parameters from onboard diagnostic and telemetry systems. This comprehensive data collection may enable the AI system to create accurate models for predicting vehicle behavior and performance under various conditions.

In embodiments, for powertrain systems, the transportation system and AI convergence system of systems may employ hybrid neural networks where different parts optimize distinct components. For example, one neural network can process inputs relating to charge or fuel states of vehicles while another processes inputs relating to charging or refueling infrastructure. The first neural network may process vehicle route and stored energy state information to predict target energy renewal regions, while the second neural network processes vehicle energy renewal infrastructure usage and demand information to determine optimal charging or refueling plans. This may enable prediction of energy needs and optimization of resource allocation. The transportation system and AI convergence system of systems may simulate and predict user experiences through monitoring and analysis capabilities. It may process various inputs including voice patterns, facial expressions, and physiological data to predict changes in user emotional states in response to vehicle configurations. These predictions may enable proactive adjustments to vehicle parameters to maintain optimal user experiences. The transportation system and AI convergence system of systems may also employ neural networks that include perceptrons mimicking human senses to facilitate predicting how users will respond to different vehicle configurations.

In embodiments, the transportation system and AI convergence system of systems may implement contextual simulation and forecasting capabilities through its enterprise layer. This may enable modeling of fleet operations, vehicle design scenarios, and enterprise-level transactions. The transportation system and AI convergence system of systems may leverage these simulations to predict outcomes of various operational configurations, optimize resource allocation, and forecast maintenance needs. Through continuous learning and adaptation, the transportation system and AI convergence system of systems may refine its predictive models based on actual outcomes, improving the accuracy of future simulations and predictions.

In embodiments, the combination of the transportation system and AI convergence system of systems may enable data analysis and modeling capabilities through multiple integrated technological layers that process and analyze vehicle characteristics and usage patterns. The transportation system and AI convergence system of systems may implement comprehensive data collection and analysis through its data layer, which provides context-aware sensor fusion to inform analytics and AI processing. This may include, but is not limited to, processing sensor and energy operations data, market data, environmental data, and alternative data sources through APIs and service-oriented architecture. The data layer's AI capabilities, in an example, may focus on sensor and data fusion to create a holistic understanding of vehicle operations and usage patterns. The transportation system and AI convergence system of systems may leverage machine learning algorithms to analyze transportation networks and optimize vehicle operations. These algorithms may include graph neural networks that capture the spatial structure of transportation networks and predict traffic conditions, reinforcement learning to optimize routing decisions in real-time, clustering algorithms to segment data based on traffic patterns or geographic features, and time-series forecasting models to predict future conditions based on historical data. This multi-faceted approach may enable analysis of vehicle movement patterns and infrastructure utilization.

In embodiments, for analyzing rider experiences and behavior, the transportation system and AI convergence system of systems may employ AI capabilities to process multiple data streams. It may analyze feature vectors of facial images to determine emotional states, process voice patterns to assess rider satisfaction, and evaluate physiological data from wearable devices to understand user comfort levels. This data analysis may enable the system to model and predict user responses to different vehicle configurations and adapt accordingly. The transportation system and AI convergence system of systems may also analyze patterns in driving behavior to identify routine activities and generate appropriate cognitive challenges, demonstrating its ability to model and respond to complex user behaviors.

In embodiments, the operations layer may enable analysis of vehicle performance and resource utilization through automated rider satisfaction monitoring, intelligent resource location for mobility demand, and vehicle drivetrain optimization. This layer may implement routing, control, optimization, and generation capabilities that leverage collected data to create sophisticated models of vehicle operation and usage patterns. The transportation system and AI convergence system of systems may analyze patterns in energy consumption, maintenance needs, and operational efficiency to optimize vehicle performance and resource allocation.

In embodiments, the enterprise layer may further enhance data analysis capabilities through executive digital twins for vehicle fleet operations and vehicle digital twins for design and simulation. These digital twins may create detailed models of vehicle operations that can be analyzed to identify patterns, predict maintenance needs, and optimize performance. The transportation system and AI convergence system of systems may employ deep learning models to analyze user interaction patterns and dynamically adjust interface layouts and workflows for optimal efficiency. Through continuous data collection and analysis, the transportation system and AI convergence system of systems may refine its models and improves its understanding of vehicle characteristics and usage patterns, enabling increased optimization and prediction capabilities.

In embodiments, the combination of the transportation system and AI convergence system of systems may enable capabilities for analyzing and modeling routing and navigation characteristics through multiple integrated technological layers that process both real and simulated traffic environments. The transportation system and AI convergence system of systems may implement data processing through its data layer, which provides context-aware sensor fusion to inform analytics and AI processing. This may include processing sensor data, environmental data, traffic data, and alternative data sources through APIs and service-oriented architecture. The transportation system and AI convergence system of systems may process data from various sources including social media data, weather data, road profile sources, traffic data sources, media data sources, and sensor sets. The data processing system may be configured to extract data, transform it to suitable formats, normalize it, cleanse it, and store it to enable sophisticated queries for routing and navigation analysis.

For routing optimization, the transportation system and AI convergence system of systems may employ cognitive systems that can facilitate negotiation among designated sets of vehicles. The system may accept inputs relating to the value attributed by riders to various route parameters and can optimize combinations of offers to provide rewards or undertake behavior in response to rewards. This may enable the system to optimize route selection based on multiple factors including traffic conditions, weather conditions, and user preferences. The system may implement game-based interfaces that provide rewards for undertaking actions that provide ancillary benefits, such as routing vehicles to points of interest off highways to reduce congestion.

In embodiments, the transportation system and AI convergence system of systems may use machine learning algorithms to analyze transportation networks and optimize routing decisions. These may include graph neural networks that capture the spatial structure of transportation networks and predict traffic conditions, reinforcement learning to optimize routing decisions in real-time based on past experiences, clustering algorithms to segment data based on traffic patterns or geographic features, and time-series forecasting models to predict future traffic conditions based on historical data. This multi-faceted approach may enable analysis of traffic patterns and infrastructure utilization for both real and simulated environments.

In embodiments, the operations layer may enable analysis of routing patterns and resource utilization through automated monitoring and intelligent resource location for mobility demand. This layer may implement routing, control, optimization, and generation capabilities that leverage collected data to create sophisticated models of traffic patterns and navigation behaviors. The transportation system and AI convergence system of systems may analyze patterns in traffic flow, congestion points, and route efficiency to optimize navigation recommendations and resource allocation. Additionally, the system may coordinate with infrastructure elements like traffic lights, toll booths, and automated parking facilities to optimize routing based on real-time conditions.

In embodiments, the enterprise layer may further enhance routing analysis capabilities through executive digital twins for vehicle fleet operations and vehicle digital twins for design and simulation. These digital twins may create models of vehicle movements and traffic patterns that can be analyzed to identify optimal routes, predict congestion, and optimize fleet operations. The system may simulate both physical elements and their dynamics throughout various operational states and conditions. This may enable testing and validation of routing strategies in virtual environments before implementation in real-world conditions, allowing for optimization of navigation parameters while minimizing risk and improving operational efficiency.

In embodiments, the combination of the transportation system and AI convergence system of systems may enable capabilities for optimizing vehicle charging system performance and usage through multiple integrated technological layers that work together to create an intelligent charging ecosystem. The transportation system and AI convergence system of systems may implement a cognitive collective charging plan through an artificial intelligence system that takes inputs relating to multiple vehicles and determines charging plan parameters based on those inputs. This may include a network-enabled vehicle information ingestion port that provides real-time gathering of operational state and energy consumption information from network-enabled vehicles. The inputs may include battery charge states, route plans, indicators of charging value, and predicted traffic conditions. The charging infrastructure control system may include both cloud-based computing systems remote from charging infrastructure and local charging infrastructure systems integrated with charging kiosks. The artificial intelligence system may interface with both cloud and local systems to optimize charging operations. For example, the cloud-based system may set charging rates that facilitate highly parallel vehicle charging, while local systems can adapt these plans to accommodate specific situations like temporary increases in charging rates to handle accumulated vehicles at particular locations.

In embodiments, the transportation system and AI convergence system of systems may employ a hybrid neural network approach where different neural networks handle distinct aspects of charging optimization. For example, a first neural network may process inputs relating to charge states of vehicles and predicts target energy renewal regions, while a second neural network processes charging infrastructure usage and demand information to optimize charging infrastructure operations within those regions. This may enable optimization of both vehicle-side and infrastructure-side charging parameters. For charging plan optimization, the transportation system and AI convergence system of systems may implement a recharging plan update facility that interacts with the artificial intelligence system to apply and adjust charging plan parameters based on feedback. The AI system may optimize various aspects including electricity usage, recharging time, location selection, and charging amounts. The system may predict vehicle geolocations within geographic regions to optimize charging infrastructure allocation and can automate negotiation of charging duration, quantity, and pricing.

In embodiments, the resource layer of the AI convergence system may provide additional optimization capabilities through charging infrastructure optimization and vehicle energy efficiency management. This may include automated optimization of energy resources based on environmental conditions, marketplace factors, vehicle data, and other inputs. The system may coordinate charging operations across entire fleets while maintaining individual vehicle optimization, enabling both macro and micro-level charging optimization. Through continuous data collection and analysis, the system may refine its optimization models and improves charging efficiency across the entire transportation network.

In embodiments, the combination of the transportation system and AI convergence system of systems may enable capabilities for optimizing powertrain performance through multiple integrated technological layers that work together to create an intelligent vehicle control ecosystem. The transportation system and AI convergence system of systems may implement hybrid neural networks specifically designed for optimizing powertrain components, where different parts of the neural network are configured to optimize distinct aspects of the powertrain. For example, one neural network may focus on gear shifting operations while another simultaneously optimizes other aspects like braking, clutch engagement, or energy discharge and recharging. This specialized approach may allow for granular control and optimization of specific powertrain subsystems while maintaining overall system coordination. For continuously variable powertrains, the system may employ an approach where one portion of the hybrid neural network classifies the vehicle's state while another portion optimizes transmission operating parameters based on that classified state. The first portion may classify states such as high-traffic conditions or adverse weather (detected through LIDAR, RADAR, vision-based systems, or other sensors), while the second portion optimizes vehicle operating parameters accordingly. For instance, when bad weather is detected, the system may adjust transmission parameters to enable safer driving characteristics with modified braking and acceleration profiles.

In embodiments, the operations layer may enable powertrain optimization through automated monitoring and intelligent control systems. This layer may implement routing, control, optimization, and generation capabilities that leverage collected sensor data to create sophisticated models of powertrain performance. The system may process inputs from various vehicle sensors including cameras and diagnostic systems to track vehicle operating states, powertrain parameters, and environmental conditions. This comprehensive data collection may enable the AI system to make informed decisions about modifying powertrain performance based on current conditions and desired outcomes. The transportation system and AI convergence system of systems may optimize powertrain operation through state classification and parameter adjustment. Vehicle states that can be classified and optimized include, but are not limited to, vehicle maintenance state, vehicle health state, vehicle operating state, vehicle energy utilization state, vehicle component state, vehicle sub-system state, and vehicle powertrain system state. For each classified state, the system may optimize corresponding operating parameters to achieve desired performance characteristics while maintaining safety and efficiency. The transportation system and AI convergence system of systems may leverage digital twins to create virtual representations of powertrain components, enabling simulation and testing of performance modifications before implementation. These digital twins may simulate both physical elements and their dynamics throughout various operational states, allowing for validation of powertrain optimizations in a virtual environment before deployment to the physical vehicle. Through continuous data collection and analysis, the system may refine its optimization models and improve powertrain efficiency across various operating conditions.

### FURTHER INFORMATION AND USE OF TERMS

The background description is presented simply for context, and is not necessarily well-understood, routine, or conventional. Further, the background description is not an admission of what does or does not qualify as prior art. In fact, some or all of the background description may be work attributable to the named inventors that is otherwise unknown in the art.

While only a few embodiments of the disclosure have been shown and described, it will be obvious to those skilled in the art that many changes and modifications may be made thereunto without departing from the spirit and scope of the disclosure as described in the following claims. All patent applications and patents, both foreign and domestic, and all other publications referenced herein are incorporated herein in their entireties to the full extent permitted by law. While the disclosure has been disclosed in connection with the preferred embodiments shown and described in detail, various modifications and improvements thereon will become readily apparent to those skilled in the art. Accordingly, the spirit and scope of the disclosure is not to be limited by the foregoing examples, but is to be understood in the broadest sense allowable by law.

The detailed description includes specific examples for illustration only, and not to limit the disclosure or its applicability. The examples are not intended to be an exhaustive list, but instead simply demonstrate possession by the inventors of the full scope of the currently presented and envisioned future claims. Variations, combinations, and equivalents of the examples are within the scope of the disclosure. No language in the specification should be construed as indicating that any non-claimed element is essential or critical to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

Each publication referenced in this disclosure, including foreign and domestic patent applications and patents, is hereby incorporated by reference in its entirety as if fully set forth herein.

The terms “comprising,” “with,” “including,” and “containing” are to be construed as open-ended terms (i.e., meaning “including, but not limited to”) unless otherwise noted. Unless otherwise specified, the terms “comprising,” “having,” “with,” “including,” and “containing,” and their variants, are open-ended terms, meaning “including, but not limited to.”

The term “exemplary” simply means “example” and does not indicate a best or preferred example. The use of any and all examples, or exemplary language (e.g., “such as”) provided herein, is intended merely to better illuminate the disclosure and does not pose a limitation on the scope of the disclosure unless otherwise claimed.

The use of the terms “a,” “an,” “the,” and similar referents in the context of describing the disclosure (especially in the context of the following claims) is to be construed to cover both the singular and the plural, unless otherwise indicated herein or clearly contradicted by context.

Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The phrase “at least one of A, B, and C” should be construed to mean a logical (A OR B OR C), using a non-exclusive logical OR, and should not be construed to mean “at least one of A, at least one of B, and at least one of C.”

The term “set” may include a set with a single member. The term “set” does not necessarily exclude the empty set—in other words, in some circumstances a “set” may have zero elements. The term “non-empty set” may be used to indicate exclusion of the empty set—that is, a non-empty set must have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

Physical (such as spatial and/or electrical) and functional relationships between elements (for example, between modules, circuit elements, semiconductor layers, etc.) are described using various terms. Unless explicitly described as being “direct,” when a relationship between first and second elements is described, that relationship encompasses both (i) a direct relationship where no other intervening elements are present between the first and second elements and (ii) an indirect relationship where one or more intervening elements are present between the first and second elements. Example relationship terms include “adjoining,” “transmitting,” “receiving,” “connected,” “engaged,” “coupled,” “adjacent,” “next to,” “on top of,” “above,” “below,” “abutting,” and “disposed.”

Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of multiple embodiments remain within the scope of this disclosure.

One or more elements (for example, steps within a method, instructions, actions, or operations) may be executed in a different order (and/or concurrently) without altering the principles of the present disclosure. Unless technically infeasible, elements described as being in series may be implemented partially or fully in parallel. Similarly, unless technically infeasible, elements described as being in parallel may be implemented partially or fully in series.

While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited.

While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure.

In the drawings, reference numbers may be reused to identify identical elements or may simply identify elements that implement similar functionality. Numbering or other labeling of instructions or method steps is done for convenient reference, not to indicate a fixed order. In the drawings, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. As one example, for information sent from element A to element B, element B may send requests and/or acknowledgements to element A.

1-311. (canceled)

312. A transportation system having an AI convergence system of systems comprising:
a data layer configured to:
implement context-aware sensor fusion;
process sensor and energy operations data;
analyze market and environmental data; and
optimize vehicle operations based on analyzed data.

313-950. (canceled)

951. The system of claim 312, wherein the context-aware sensor fusion fuses data from disparate vehicle sensor and other transportation-relevant data sources to facilitate AI classification, prediction, and optimization for vehicle optimization.

952. The system of claim 312, wherein the data layer implements the context-aware sensor fusion by multiplexing data from multiple sensors into a fused data stream stored on a device.

953. The system of claim 952, wherein the multiplexing comprises combining a plurality of sensor data types into a time series in a byte-like structure such that the sensor data types remain linked in time without requiring separate processing of the streams.

954. The system of claim 312, wherein the AI convergence system of systems comprises a hybrid neural network having a first portion configured to classify a vehicle state and a second portion configured to optimize vehicle operating parameters based on the classified vehicle state.

955. The system of claim 954, wherein the vehicle state is classified from inputs comprising at least one of LIDAR, radar, vision system, or environmental sensor data.

956. The system of claim 954, wherein optimizing the vehicle operating parameters comprises adjusting the vehicle into a safe-driving mode having modified forward-sensing alerts and braking parameters when a high-traffic or adverse-weather state is classified.

957. The system of claim 312, wherein the data layer processes vehicle state data tracked from onboard diagnostic and telemetry systems.

958. The system of claim 312, wherein optimizing vehicle operations comprises optimizing vehicle energy efficiency.

959. The system of claim 958, wherein the AI convergence system of systems comprises a resource layer configured to optimize energy through charging infrastructure optimization and vehicle energy efficiency management.

960. The system of claim 958, wherein optimizing vehicle energy efficiency comprises a hybrid neural network having a first neural network that predicts a target energy renewal region from vehicle route and stored energy state information and a second neural network that determines a charging plan from charging infrastructure usage and demand information.

961. A method for optimizing vehicle operations in a transportation system having an AI convergence system of systems, the method comprising:
implementing context-aware sensor fusion of data from a plurality of vehicle sensors and transportation-relevant data sources;
processing sensor and energy operations data;
analyzing market and environmental data; and
optimizing vehicle operations based on the analyzed data.

962. The method of claim 961, wherein implementing context-aware sensor fusion comprises fusing data from disparate vehicle sensor and transportation-relevant data sources to facilitate AI classification, prediction, and optimization.

963. The method of claim 961, wherein implementing context-aware sensor fusion comprises multiplexing data from multiple sensors into a fused data stream, wherein a plurality of sensor data types are combined into a time series in a byte-like structure such that the sensor data types remain linked in time.

964. The method of claim 961, wherein optimizing vehicle operations comprises classifying a vehicle state using a first portion of a hybrid neural network and optimizing vehicle operating parameters based on the classified vehicle state using a second portion of the hybrid neural network.

965. The method of claim 964, wherein classifying the vehicle state comprises processing inputs comprising at least one of LIDAR, radar, vision system, or environmental sensor data, and adjusting the vehicle into a safe-driving mode when a high-traffic or adverse-weather state is classified.

966. The method of claim 961, wherein optimizing vehicle operations comprises optimizing vehicle energy efficiency through charging infrastructure optimization.

967. The method of claim 966, wherein optimizing vehicle energy efficiency comprises predicting a target energy renewal region from vehicle route and stored energy state information and determining a charging plan from charging infrastructure usage and demand information.

968. The method of claim 961, wherein analyzing comprises applying at least one of a graph neural network to predict traffic conditions, reinforcement learning to optimize routing, a clustering algorithm to segment data, or time-series forecasting to predict future conditions.

969. The method of claim 961, wherein optimizing vehicle operations comprises adapting vehicle parameters in real time based on feedback data.
